(19) United States
(12) Patent Application Publication
(10) Pub. No.: US 2018/0285840 A1
(43) Pub. Date: Oct. 4, 2018

(54) UNIVERSAL BCHAIN E3A CONNECTIONS (UBEC)

(71) Applicant: SYED KAMRAN HASAN, Great Falls, VA (US)

(72) Inventor: SYED KAMRAN HASAN, Great Falls, VA (US)

(21) Appl. No.: 15/878,214

(22) Filed: Jan. 23, 2018

Related U.S. Application Data
(60) Provisional application No. 62/449,313, filed on Jan. 23, 2017.
(60) Provisional application No. 62/464,156, filed on Feb. 27, 2017.
(60) Provisional application No. 62/468,202, filed on Mar. 7, 2017.
(60) Provisional application No. 62/489,309, filed on Apr. 24, 2017.
(60) Provisional application No. 62/504,057, filed on May 10, 2017.
(60) Provisional application No. 62/530,197, filed on Jul. 8, 2017.
(60) Provisional application No. 62/549,714, filed on Aug. 24, 2017.

(51) Int. Cl. G06Q 20/06; H04L 29/06; G06Q 50/00; H04L 9/08

(52) U.S. Cl. CPC G06Q 20/0655; H04L 9/08; G06Q 50/01; H04L 63/0861

(57) ABSTRACT

A Universal BCHAIN Everyone/Everything/Everywhere Connections (UBEC) system comprises UBEC applications that operate in accordance with the BCHAIN Protocol, BCHAIN network that comprises a plurality of BCHAIN Nodes, which operate software in accordance with the BCHAIN Protocol, Appchains, which comprise data storing, serving and computational programs that operate directly upon the BCHAIN Network and Legislated UBEC Independent Governing Intelligence (LUIGI) that comprise an artificially intelligent control mechanism in a UBEC Platform.

### CROSS REFERENCE TO RELATED APPLICATIONS

The present application claims priority on Provisional Application No. 62449313 filed on 23 Jan. 2017, entitled Universal BCHAIN Everything Connections (UBEC); Provisional Application No. 62464156 filed on 27 Feb. 2017, entitled Universal BCHAIN Everything Connections (UBEC); Provisional Application No. 62/468,202 filed on 7 Mar. 2017, entitled Universal BCHAIN Everything Connections (UBEC); Provisional Application No. 62/489,309 filed on 24 Apr. 2017, entitled Universal BCHAIN Everything Connections (UBEC); Provisional Application No. 62/504,057 filed on 10 May 2017, entitled Universal BCHAIN Everything Connections Neuroeconomic Metaphysical Contentment (UBEC NMC); Provisional Application No. 62/530,197 filed on 8 Jul. 2017, entitled Neuroeconomic Metaphysical Contentment (NMC); and Provisional Application No. 62549714 filed on 24 Aug. 2017, entitled Self Programming Self Innovation (SPSI); the disclosures of which are incorporated by reference as if they are set forth herein.

Related applications include Patent Application No. 15145800 filed on 4 May 2016, entitled METHOD AND DEVICE FOR MANAGING SECURITY IN A COMPUTER NETWORK; patent application Ser. No. 15/264,744 filed on 14 Sep. 2016, entitled SYSTEM OF PERPETUAL GIVING; and patent application Ser. No. 15/413,666 filed on 24 Jan. 2017, entitled COMPUTER SECURITY BASED ON ARTIFICIAL INTELLIGENCE, the disclosures of which are incorporated by reference as if they are set forth herein.

### FIELD OF THE INVENTION

The invention is titled, Universal/Ubiquitous BCHAIN Everyone/Everything/Everywhere, All the Time (E3A) Connections (UBEC). UBEC achieves efficient collaboration via synchronized yet separate instances of algorithmic criteria.

### BACKGROUND OF THE INVENTION

The digital domain using smart devices (e.g. smartphones, PC, IoT device) require a platform to connect with one another. Such platform should enable smart devices to perform digital activities in secure and efficient manner. Blockchain is a technology adequate to build such platform. Artificial intelligence is an emerging field to enhance the platform and the digital activities performed thought the platform.

### SUMMARY OF THE INVENTION

The present invention provide a Universal BCHAIN Everyone/Everything/Everywhere Connections (UBEC) system comprising: a) UBEC applications that operate in accordance with the BCHAIN Protocol; b) BCHAIN network that comprises a plurality of BCHAIN Nodes, which operate software in accordance with the BCHAIN Protocol; c) Appchains, which comprise data storing, serving and computational programs that operate directly upon the BCHAIN Network; d) Legislated UBEC Independent Governing Intelligence (LUIGI) that comprise an artificially intelligent control mechanism in a UBEC Platform, wherein in the paradigm of Node interaction that exists within the BCHAIN Network, the Metachain is a Customchain which contains metadata that all nodes on the BCHAIN Network connect to for essential and primary referencing, wherein the Metachain tracks fundamental information which contains node/sector locations, content demand tendencies and hop routing to streamline the infrastructure setup, wherein it is required for every single BCHAIN Node to participate in reading the Metachain, wherein Appchains are Customchains which act as advanced smart contracts for delivering information via the infrastructure that has been organized by the Metachain, wherein Appchains can reference each other for input/output in parallel and nested Customchain Ecosystem, wherein Microchains are Appchains that are automatically converted to a Customchain that does not depend nor connect to the Metachain.

In BCHAIN Protocol, Queued Information Broadcast (QIB) manages Content Claim Requests (CCRs) or Content Claim Fulfillment (CCFs) that are due for broadcasting to other nodes, wherein packets of information CCR and CCF are forwarded to Communications Gateway (CG) which is the exclusive layer of interface between the BCHAIN Protocol (BP) and the Node's Hardware Interface, wherein CG forwards information concerning surrounding Nodes to Node Statistical Survey (NSS), wherein NSS tracks surrounding Node behavior which causes the formation of four indexes to be calculated: Node Escape Index, Node Saturation Index, Node Consistency Index, Node Overlap Index, wherein the Node Escape Index tracks the likelihood that a Node neighbor will escape a Perceiving Node's vicinity, wherein the Node Saturation Index tracks the amount of Nodes in a Perceiving Node's range of detection, wherein the Node Consistency Index tracks the quality of Nodes services as interpreted by a Perceiving Node, wherein the Node Overlap Index tracks the amount of overlap Nodes have with one another as interpreted by a Perceiving Node, wherein the Perceiving Node is the one that executes the instance of NSS.

The resultant four variables are sent to Strategy Corroboration System (SCS), which enforces Protocol consensus amongst the Nodes, wherein Dynamic Strategy Adaptation (DSA) receives the NSS variables to dynamically alter the Strategy Deployment which are based off of the calculated Strategy Criteria Composition, wherein the Strategy Criteria Composition contains a wide array of variables that inform core, important, and supplemental elements of the BCHAIN Protocol how to operate, wherein Registered Appchains contain cryptographic access keys of various Appchains, wherein when an update to an Appchain is announced on the Metachain's Appchain Updates, their device will download the newest updates to the Appchain, which will manifest as a Cryptographic Proof of Entitlement which originates from the cryptographic keys stored in Registered Appchains.

LUIGI is granted a hardcoded permanent and irrevocable level of administrative and executive privilege from within the UBEC Platform; LUIGI is programmed and maintained exclusively by SPSI; LUIGI is exclusively hosted on the distributed BCHAIN Network; wherein Self Programming Self Innovation (SPSI) is an Appchain that automatically programs itself and other Appchains within the UBEC Platform that are granted official designation.

Lexical Objectivity Mining (LOM) attempts to reach as close as possible to the objective answer to a wide range of questions and/or assertions, LOM engages with the UBEC User to allow them to concede or improve their argument against the stance of LOM, wherein Automated Research Mechanism (ARM) attempts to constantly supply CKR with new knowledge to enhance LOM's general estimation and decision making capabilities.

LOM Container Appchain houses the core modules in the format of an Appchain, wherein the Appchain has it's Execution Segments extracted via ESC to output the Execution Stream, which manifests as the core modules that operate LOM, wherein Initial Query Reasoning (IQR) receives the initial question/assertion provided by the UBEC User and subsequently leverages Central Knowledge Retention (CKR) to decipher missing details that are crucial in understanding and answering/responding to the question/assertion, wherein Assertion Construction (AC) receives a proposition in the form of an assertion or question and provides output of the concepts related to such proposition, wherein Hierarchical Mapping (HM) maps associated concepts to find corroboration or conflict in question/assertion consistency and calculates the benefits and risks of having a certain stance on the topic, wherein Rational Appeal (RA) criticizes assertions whether it be self-criticism or criticism of human responses by using CTMP technology, wherein Knowledge Validation (KV) receives highly confident and pre-criticized knowledge which needs to be logically separated for query capability and assimilation into CKR, wherein with Cross Reference Analysis (CRA), information received is compared to and constructed considering pre-existing knowledge from CKR, wherein the Execution Stream manifests in reality once executed by ESE, wherein Data Segments arrive from UBEC Systemwide Logic to the LOM Container Appchain, wherein the Data Segments are processed by ESE in conjunction with the core logic of LOM defined by the Execution Stream and enumerated as the Modular Manifestation of Execution Stream, wherein the input Data Segments manifest as LOM Question/Assertion Input, wherein the execution of ESE outputs Data Segments which are returned back to the UBEC Systemwide Logic as LOM's formal response to the LOM Question/Assertion Input.

Personal Intelligence Profile (PIP) stores the UBEC User's personal information via multiple potential end-points and front-ends.

Automated deployment mechanism is adapted to deploy the UBEC Platform as an Application to hardware devices, wherein SPSI submits software, firmware and hardware updates to UBEC/BCHAIN Hybridized Core Logic, in which the UBEC Platform has its own distinct Codebase, which collaborates with the BCHAIN Protocol Codebase, wherein both Codebases directly connect to the Modular Interface Plugin, which ensures compatible execution of Codebases upon differing hardware and operating system makeups of BCHAIN Nodes, wherein the Hybridized Core Logic is thereafter deployed via one of different Deployment Routines, which is selected in accordance with the correlating hardware and operating system makeup of the selected BCHAIN Node.

UBEC Passthrough receives information traffic that is occurring from UBEC as an Appchain, wherein upon analysis of the passing information, the information is returned to UBEC as an Appchain via UBEC Comprehensive Return to continue it's onwards journey and to reach it's intended destination within the UBEC Platform, wherein the incoming information from UBEC Passthrough is forwarded to LUIGI Task Delegation (LTD) which determines if the data should be processed by LOM, LIZARD or both, wherein LUIGI Corrective Action (LCA) is invoked to appropriately manage information access events and transactions that are occurring within the UBEC Platform.

When a new application, or an update to an already existing application, is submitted LUIGI uses LIZARD technology to identify correct jurisdiction patterns so that it can understand if an application is needed in UBEC or not, wherein LUIGI either Blocks or Approves the application submission, which is an execution which manifests in LUIGI Corrective Action (LCA).

User Node Interaction (UNI) uses direct biometric data for authentication and does not reference any user names nor account containers, wherein Nodes, data and services are directly tied to the user's biometric data, wherein biometric data is then transferred to Biometric Band Categorization (BBC), which creates a rounded off version of the data which eliminates variations of biometric data measurement due to error margins in biometric data measuring equipment, wherein for each biometric data input into BBC a corresponding Band Authorization Token (BAT) is produced as output, wherein comparison is made between the newly generated BATs and Authentication Tokens stored in the Band Association Appchain, wherein the amount of biometric data provided is measured and checked if sufficient for the authentication process.

Within BBC, Granular Separation of the received Generic Biometric Input is created, wherein the Granulator Separation represents the Generic Biometric Input in a format that quantifies scopes of magnitude found within the input, wherein varying compositions of Biometric Data are assembled in the same format which highlights data points of high and low magnitude, wherein the scope of the data points are broadened to create a Format that is intended to be greater than the expected error of margin, wherein Band Categories produced in the Format is stored as a Band Authorization Token (BAT).

Customchain Ecosystem is a complex interaction of Appchains, Microchains, along with the single Metachain to produce a dynamically adaptable system of data retention and service along with program/routine execution which makes up the BCHAIN Network, wherein the UBEC App Store exists within the Customchain Ecosystem to host, list and service UBEC Applications, wherein the UBEC Enabled Device selects and downloads UBEC Application A from the UBEC App Store, wherein the Execution Segments are collected from the Appchain A0 which correlates with the UBEC Application A, wherein the Execution Segments collected are sent to Execution Stream Collection (ESC) which assembles them into Execution Stream A0, wherein the assembly performed by ESC considers the correct order which the Execution Segments need to be aligned into, wherein the execution of the Execution Segments of Execution Stream A0 occurs at the module Execution Stream Execution (ESE), wherein in parallel to the processing and assembly of the Execution Stream A0 is the processing and assembly of Data Streams A0 and Z3, which is accomplished via Stage which collects the Data Segments from Appchain A0 and submits them for sorting at Data Stream Sorting (DSS), wherein the Data Streams A0 and Z3 are referenced by ESE to correctly execute the commands listed in Execution Stream A0.

Multiple Customchain Ecosystems make up the BCHAIN Network, wherein UBEC Application A and UBEC Application B each makeup their own Customchain Ecosystem, wherein or each Customchain Ecosystem that correlates with an application, there is a Container Appchain, wherein the Container Appchain makes reference to Execution Streams and Data Streams that are stored in Supplement Appchains.

Customchain Ecosystems contain Independent Appchains that do not belong nor represent a specific UBEC Application, wherein separate Execution Streams or Data Streams can be extracted from Independent Appchains.

UBEC User inputs Creativity and decision to the Logistics Manager Interface (LMI), wherein LMI outputs Logistics Layer, which is a generic information format that defines the Application logistics designed by UBEC User via LMI, wherein the Logistics Layer is sent as input to the Customchain Ecosystem Builder (CEB), wherein the CEB automatically constructs the Logistical Application, as perceived by the UBEC User, by using the fundamental building blocks that consist of a Customchain Ecosystem, wherein within Customchain Ecosystem Builder Logic Flow, initially the Current State of the Appchain is interpreted to interpret the relevant positions that Execution Segments and Data Segments exist in, wherein the Execution Segments are assembled into an Execution Stream, in the correct order to ensure the correct execution of the program by ESE, wherein the Data Segments are collected and assembled into a Data Stream via DSS processing, wherein the Internal CEB Logic Processing outputs Execution+Data Supplements, which become stored in the newest block of the Appchain, wherein new Execution and Data Supplements to the Appchain begin processing within BCHAIN Network via New Content Announcement (NCA), wherein the content is submitted to the Mempool Data Storage (MDS) of the miners, where it is eventually mined into the next block of the Appchain 602 via the Customchain Interface Module (CIM), wherein the content of the newly mined block is cut into cache parts and is transferred to caching nodes via Mining Nodes Supplying Cache Seeding, wherein the cache parts gradually and automatically migrate to service optimized areas which ensures the best uptime and download speed possible to nodes requesting the data, wherein nodes claim the content from the caching nodes via Content Claim Generator, wherein once downloaded the nodes execute the Execution Stream via ESE which leads to the manifestation of the intended application.

A Watt Unit is a cryptographic currency that is algorithmically pegged to the value of electricity, wherein Watt Units are directly created and destroyed by LUIGI as liquidity enters and exits the UBEC Economy, wherein Distributed Energy Price Survey (DEPS) surveys BCHAIN Nodes that can authentically report the current fiat currency price of electricity, wherein Third Party Currency Exchange (TPCE) acts as the logistical layer to manage buying and selling of fiat currency that allows liquidity to flow into and out of the Watt Economy of the Metachain, wherein in TPCE, UBEC Users that are seeking to selling and buying Watt Units are essentially paired together in an exchange, wherein the fiat currency value of a Watt Unit is pegged to the value reported by DEPS, wherein upon an UBEC User buying an amount of Watt Units, a Verified Transaction Report that details the amount purchased is sent to LUIGI, wherein upon LUIGI's approval of the transaction, a User buying Watt Units leads to Watt Unit Creation in the LUIGI Economy Interface (LEI), wherein upon an UBEC User selling an amount of Watt Units, a Verified Transaction Report that details the amount purchased is sent to LUIGI, wherein upon LUGI's approval of the transaction, a User buying Watt Units leads to Watt Unit Destruction in the LUIGI Economy Interface, wherein the functions of LEI require knowledge and access to the User Private Fund Allocation (UPFA), wherein Allocation of funds in UPFA are intelligently distributed across nodes according to their type whereby mitigating risk of a node getting damaged/stolen.

The UBEC User can selects Economic Personalities, wherein Economic Personality (Equalizer) is when node resources are consumed to only match what the UBEC User consumes, wherein Personality B (Profit) is when the node consumes as many local resources as possible as long as the profit margin is greater than X, wherein Personality C (Consumer) is when the UBEC User pays for work units via a traded currency so that content can be consumed while spending less node resources, wherein Personality D (Altruistic) when node resources are spent as much as possible and without any restriction of expecting anything in return, wherein Economically Considered Work Imposition (ECWI) references the Watt Economy of the Metachain to determine the current Surplus/Deficit of this node with regards to work done credit, wherein Current Work Surplus/Deficit is forwarded to ECWI, which considers the selected Economic Personality and the Surplus/Deficit to evaluate if more work should currently be performed.

If the criteria defined in Strategy Deployment known as Parallel Hop Spread Criteria has been met, then the Node invokes Parallel Hop Logic (PHL), wherein this leads to the specific Nodes initiating more Parallel Hop Paths than they received, which leads to a redundancy in Hop Paths concerning the traveling CCR or CCF, wherein Redundant Parallel Hop Pathways mitigates the risk presented by chaos by increasing the chances that at least the minimum amount of required pathways reaches the Final Target without a significant interruption from chaos, wherein the Final Target can receive a confirmation originating from a decentralized consensus due to the redundant Parallel Hop Paths being initiated by PHL, wherein for a CCR or CCF packet to be accepted at it's destination Node, it must arrive from at least predetermined number of separate Parallel Hop Paths, wherein Over-Parallelized Hop Path Reduction (OPHPR) detects Parallel Hop Pathways that have become an inefficient burden on the system and should be ceased from continuing their onwards journey, wherein the amount of redundant Parallel Hop Pathways that are spawned depends on the size of the Watt Unit fee that was pre-authorized for the CCR's or CCF's Economic Authorization Token (EAT), wherein functionality of leveraging the physical movement of Nodes is processed by the modules Physical Data Migration Layer (PDML) and Physical Data Migration Usage (PDMU), wherein Physical Migration functionality allows for overall increased throughput in the system, as physical movements of Nodes are made to work in favor of the efficiency of the Network rather than against it.

Sectors are clusters of BCHAIN Nodes that logistically facilitate orientation and travel routing within the BCHAIN Network, wherein at any given time any BCHAIN Node falls under the jurisdiction of exactly two Sectors, wherein definitions of Sectors are derived from the Dual Scope Hash generated by Traffic Scope Consensus (TSC), wherein Optimized Sector Route Discovery (OSRD) interprets the geographical state of the BCHAIN Network as defined on the Metachain and produces Optimized Sector Routes which are effectively highways of information, wherein the information is submitted to Optimized Sector Routing of the Metachain, Statistical information including Pathway Strength (effectiveness) and Pathway Saturation (demand/usage) are included in Optimized Sector Routing of the Metachain.

A BCHAIN Node uses CCG to generate CCR which is ultimately sent to the Final Target Node, wherein the CCR is equipped with the Proposed Baseline Hop Path (PBHP) and Trail Variable Suite (TVS), wherein the PBHP contains routing information concerning the proposed sequence of nodes to hop to, to eventually reach the Final Target, wherein the TVS contains dynamic information concerning logistics management of delivering the CCR, wherein the elements of logistics management include the Economic Authorization Token (EAT) and a Strategy Deployment instance that is referenced throughout travel within a specific Sector, wherein the CCR travels via Nodes that exist within Intermediate Nodes, wherein upon the CCR successfully arriving the Final Target Node, the Node executes Content Claim Delivery (CCD) to attempt to fulfill the content request made by the requesting Node, wherein a Content Claim Fulfillment (CCF) packet is sent in return, which travels via the Intermediate Node to the requesting Node, wherein the CCF is processed by Content Claim Rendering (CCR), wherein CCR makes use of Stagger Release Content Cache (SRCC) to hold content parts until the entire content unit can be fully rendered.

The Live Stream Content mechanism does not make use of (CCRs), wherein Content needs are filled via CCFs to Nodes that request such Content according to the implication of their description and jurisdiction, wherein the module Jurisdictionally Implied CCF Submission (JIGS) operates at a BCHAIN Node that perceives the jurisdictional need of content delivery of another Node, wherein a CCF is submitted via Intermediate Nodes without an accompanying CCR, wherein the CCF is received and validated at the Final Target Node by Jurisdictionally Accepted CCF Reception (JACR) and thereafter rendered by CCR.

The Strategy Corroboration System (SCS) uses the Traffic Scope Consensus (TSC) module to derive a Dual Scope Hash collection, wherein the makeup of the Dual Scope Hash is ultimately derived from the four variables produced by Node Statistical Survey (NSS); Node Escape Index, Node Saturation Index, Node Consistency Index, and Node Overlap Index, wherein the variables are derived by NSS from External Traffic Behavior, wherein the Hash Announcements are exchanged between different traffic areas known as Sectors, wherein each Node perceives of two hashes due to the algorithm that is executed in Traffic Scope Consensus (TSC), wherein the Dual Hash Recognition Logic requires that at least one of the two hashes matches for two nodes to be able to communicate with each other, wherein due to the rounding down/rounding up logic employed in TSC, a node is able to traverse to different network environments while maintaining consensus with other nodes because just one hash is able to change at a time, hence the node is bound to have an overlap with at least one hash with surrounding Nodes under BCHAIN Protocol.

Node Statistical Survey (NSS) gathers information concerning the behavior of surrounding Nodes to calculate four major indexes, which in turn informs modules that operate the core functions of the BCHAIN Protocol about the state of the BCHAIN Network in regards to Node activity and behavior, wherein Node Interaction Logic (NIL) module operates as a subset of Communications Gateway (CG) and interacts with the Hardware Interface via Operating System and API Endpoints, wherein all of the pings related to Nodes in the immediate vicinity of the Node that is executing the instance of NSS are forwarded to Node Ping Processing (NPP), wherein Node Activity DB (NAD) is a local database that retains raw data in regards to Node ping activity, wherein NAD is a primary source of information for NPP to perform Operational Queries that leads to the Index Calculation of the Node Index Variables collection, wherein Node Ping Records are initially received at Incoming Traffic, wherein Each Node Ping Record contains the identity concerning the relevant Node as well as an Expiration Timestamp, wherein the Timestamp causes NSS to report up to date information that reflects the current state of the local vicinity of the BCHAIN Network, wherein Operational Queries processes the Node Ping Records in batches whilst considering the Expiration Timestamp, wherein the Records are finally calculated according to the criteria of the four Node Index Variables at Index Calculation.

Regarding Strategy Corroboration System (SCS), Traffic Scope Consensus (TSC) produces a Dual Scope Hash set by referencing NSS variables and static definitions from Static Hardcoded Policy (SHP), wherein SCS invokes Sector Identity Derivation (SID) to use the Dual Scope Hashes to act as a base for defining the Current Sector Identifications, wherein each Node at any given time exists within the jurisdiction of exactly two Sectors, each one defined by Hash 1 and Hash 2, wherein with Hash Corroboration the Hashes that are announced from surrounding Neighbors are checked against the locally produced Hashes, wherein if neither of the hashes match, then the Neighbor Node is added to the Node Block List, wherein with Specific Node Traffic Perception Nodes that are recognized as legitimate due to their matching Hash Announcement can inform other Nodes about Nodes they suspect to be Rogue and operating from beyond the BCHAIN Protocol limits defined in Static Hardcoded Policy (SHP).

TSC invokes NVP to receive Node Statistical Survey (NSS) variables and produce an NSS Variables Composite Average (NVCI), wherein with NVP Nodes from within the same Sectors announce their perception of the NSS Variables to each other to build consensus on the Sector's characteristics whereby the local and remote NSS variables are pooled together to create a composite average known as NVCI, wherein NVCI is used to maintain consensus on the scope and definition of this Sector, and hence where it's physical boundaries lie, wherein the pooled version of Node Escape Index is rounded downwards to the nearest multiple X, wherein the pooled version of Node Saturation Index is rounded downwards to the nearest multiple X, wherein the pooled version of Node Consistency Index is rounded downwards to the nearest multiple X, wherein the pooled version of Node Overlap Index is rounded downwards to the nearest multiple X at Stage, wherein all of the variables thus produced within Stage are merged into a single variable.

Performance Factors are produced by NSS Variable Pooling (NVP) and are also rounded down to the nearest multiple X, wherein the Performance Factors are measurements of performance concerning the Network traffic within the relevant Sector, wherein the value X used within the rounding Stage comes from the Traffic Consensus Rounding Multiple from Strategy Deployment, wherein to Strategy Deployment is extracted from a Trail Variable Suite (TVS) that is processed by Sector Crossing Event Processing (SCEP), wherein the Multiple is expected to be different within each Sector, yet remains the same for all Nodes within the same Sector whereby the results of the merging becomes the base for Hash 1 of the Dual Scope Hash, wherein for the base for Hash 2, the same NVCI are referenced from the rounding down process, except that the process rounds upwards from the same multiple X that is taken from the Traffic Consensus Rounding Multiple, wherein the same Performance Factors from NVP are processed albeit rounded upwards.

Dynamic Strategy Adaptation (DSA) acts as the framework for creating dynamic variables that control processing factors within the BCHAIN Network, wherein the variables are packaged and transferred via Strategy Deployment which is carried within a Trail Variable Suite (TVS), wherein DSA constantly maintains and adjusts variables that control Network operations according to the state of the physical network as reported by NSS variables via Field Chaos Interpretation (FCI), wherein FCI interprets the overall level of Node availability chaos throughout the entire BCHAIN Network, wherein Strategy Deployment is a packaged set of criteria that sets operational values within modules of the BCHAIN Protocol, wherein Optimized Strategy Selection Algorithm (OSSA) selects the best suited and most Ideal Strategy that operates the best under the environmental conditions that have been declared by NSS, wherein the Current Preferred Strategy (SCM) is used as input for Strategy Creation Module (SCM) to tweak the strategy with experimentation, wherein SCM uses the Creativity Module to hybridize the form of the Current Preferred Strategy with the current interpretation of Field Chaos from FCI.

Priority Assignment and Proof (PAP) modifies the Strategy Deployment Criteria to perform with extended priority according to the extra amount paid by the UBEC User, wherein the Strategy Deployment which is subsequently produced contains a relatively high value for Parallel Hop Spread Criteria and a relatively low value for Parallel Hop Reduction Criteria whereby more Parallel Hop Paths are initiated which leads to lower latency, lower packet loss, higher reliability, wherein Strategy Deployments are packaged in Trail Variable Suites (TVS) of a CCR or CCF, wherein Strategy Performance Tracking (SPT) is a database Appchain that tracks the perceived performance of Deployed Strategies within the Network, which enables OSSA to select the one that is considered the Current Preferred Strategy considering local vicinity Network conditions.

Strategy Performance Tracking (SPT) operates as a Data Segment heavy Appchain, SPT stores units of Strategies, wherein each Strategy has a base Strategy Criteria Composition, which acts as the core identity of the Strategy, wherein all of the other variances within the Strategy unit act as logistical measurements of performance and time to enable OSSA to choose what it considers to be the Current Preferred Strategy, wherein each Strategy unit has an Expiration Timestamp, which gets extended every time an update to the Strategy is provided by Strategy Performance Interpretation (SPI), wherein associated with each Strategy are multiple Performance Tracking Units, which are reported by SPT, wherein a Tracking Unit contains an NSS Makeup and a Performance Index, wherein the NSS Makeup captures the NSS Variables that existed at the time this Tracking Unit was captured, wherein the Performance Index records performance measurements including hops per second, megabytes.

Strategy Performance Tracking (SPT) indirectly connects to Multiple Variable Selection Algorithm (MVSA), wherein MVSA selects the most appropriate Strategy from data within SPT, wherein Data from SPT is used to derive a Strategy Performance Index which is a composite average of all of the individual performance indices listed within a single Strategy, wherein the Strategy Confidence Ranking indicates how much precedence/evidence is available to justify the perception on the Strategy Performance Index, wherein MVSA makes reference to Static Hardcoded Policy (SHP) to discern the criteria by which to select the appropriate Strategy, wherein all of the Strategies that haven't expired from SPT are retrieved, wherein all of the NSS makeups from All Active Strategies that are within range of the Local NSS Makeup are retrieved, whereby producing NSS Makeups Within Range, which contain selected Performance Tracking Units from various Strategies, wherein the Performance Tracking Units are organized according to Strategy Criteria Composition, wherein Strategy Containers contains selected Strategies which contain the Performance Tracking Units that were initially selected, wherein the Strategy Containers are referred to calculate the average Performance Index per Strategy which outputs as Strategy Performance Index whereby the Strategy Confidence Ranking is calculated per Strategy, wherein the preferred strategy is selected according to both Performance and Assessment Confidence via MVSA.

Strategy Creation Module (SCM) is invoked by Dynamic Strategy Adaptation (DSA), wherein SCM intelligently varies compositions of Strategies via the Creativity Module to create low risk experimental Strategies that build off of the strengths of prior iterations, wherein Field Chaos Interpretation (FCI) submits its Chaos Interpretation output to Creativity as an Input Form, wherein Creativity's Static Criteria are based on the Agreed Upon Strategy Scope Limits and the Watt Unit amount that has been pre-authorized in the Economic Authorization Token (EAT), wherein the Current Preferred Strategy is received by OSSA and is unpacked to retrieve the Strategy Criteria Composition.

The Criteria that makeup Strategy Criteria Composition comprises:

a) Hop Witness Expiration that indicates how much time must have passed for a Hop Witness Entry in Recent Hop History (RHH) to be ignored whereby removing potentially useless Parallel Hop Paths from being spawned;
b) Parallel Hop Spread Criteria that indicates how wide should the Parallel Hops be spread and at what trigger variable values;
c) Parallel Hop Reduction Criteria that indicates when Parallel Hop Paths should be removed due to redundancy;
d) Content Saturation Required to Cache that is the minimum amount of occurrences at which an Appchain has been recently witnessed by this node in Recent Hop History (RHH);
e) Minimum Hop Travel Required to Cache that is the minimum amount of progress that needs to have been completed for the node to cache the content whereby only Nodes that participate in the journey after the halfway point will be eligible to cache the content;
f) Demand Declaration Hop Point that is the hop point along the CCR or CCF journey at which the Node declares to the Metachain the Appchain Demand and Sector Demand, wherein Appchain Demand is tracked to decide Appchain caching and locations, whilst Sector Demand is tracked to calculate the different prices of different Sectors;
g) Minimum Node Reliability for Path Deployment that is the minimum reliability level of a Node as adjudicated by the NSS variables for a node to be included in a Hop Pathway;
h) Self Imposed Mining Criteria that is the minimum amount of relative computing resources required to mine an Appchain, wherein the amount is proportional to the resource load of mining that Appchain;
i) Chaotic Environment Avoidance Criteria that defines characteristics of nodes that indicate them to be sporadic and unreliable as understood by the variables provided by NSS;
j) CCFs to Retain in Clash Cache that defines the percentage amount of the local Node's storage that should be allocated to retaining CCFs that do not exist in Primary Node Content Cache (PNCC);
k) Route Reliability/Distance Tradeoff that defines the perceived zone of efficiency concerning the selection tradeoff between reliability of selected Nodes and expected distance travelled;
l) ITII Microchain Trigger that defines the value of Information Transfer Isolation Index (ITII) required to merit a node voting to switch an Appchain to a Microchain format;
m) Traffic Consensus Rounding Multiple that is the multiple of which NVCI and performance variables are rounded upwards or downwards, wherein if this value increases, the relative size of Sectors that are influenced by this variable will gradually increase in size and if this value decreases, Sectors will shrink in size and Node count;
n) NSS Variable Pooling Interval that defines how often should Nodes announce to each other within Sectors they share an overlap with, the NSS variables they perceive;
o) Work Payout Multiplier that defines the intensity of discrepancy in payment between the lowest and highest paying Sectors;
p) Minimum Cache Retention Time that defines the minimum amount of time a Caching Node is required to retain a cache it has elected to adopt;
q) Mining to Caching Payment Ratio that allocates a division of payment between Passive Work done via the Mining Selection Algorithm (MSA) and Passive Work done via the Cache Selection Algorithm (CSA);
r) Cache Part Deletion Threshold that defines when it is safe for Miners in a Sector that is rescuing data via Data Refuge Processing (DRP) to delete such Data in Danger;
s) Sector Tax Magnitude that acts as a multiplier for the value size of the Tax Consequence Unit that is to be imposed onto the Node of the relevant Sector.

SCM's processing its modular input and out begins with the Current Preferred Strategy as the initial input, wherein Strategy is extracted into an intermediate format to make it available for manipulation and processing by the parent module SCM whereby Strategy Criteria Composition is generated from input Current Preferred Strategy, wherein logic updates the Strategy Criteria Composition to a new low risk experimentation version of the Strategy that ends up becoming the output Strategy Deployment, wherein upon completion of the update process, the Strategy Syntax Assembly (SSA) module repacks the information into the format that is understandable to the other modules that operate the BCHAIN Protocol.

The Creativity Module is used to update the Strategy Criteria Composition considering the NSS variables reflecting the state of the local BCHAIN Network environment, wherein Creativity is given the Mode of the currently selected criteria from Strategy Creation, which is a Predefined Template to manage dynamic strategy creation and variation, wherein Creativity processes two inputs; Form A and Form B, wherein every single Criteria from the Strategy Criteria Composition is selected for individual processes as Form A with Creativity, wherein Form B is the overall interpretation of Field Chaos from Field Chaos Interpretation (FCI), wherein upon completion of Creativity processing Output Form AB is produced as the new proposed variations of the Criteria.

The UBEC User accesses the UBEC Platform via biometric recognition performed at User Node Interaction (UNI), whereby an Authenticated User Session is produced from which the Associated Nodes List is extracted, wherein the Authenticated User Session is also used to access the Front-End User Interface which leads to an Economic Personality Selection, wherein the UBEC User selects an Economic Personality which is referenced by Computation and Network Resource Availability of the BCHAIN Protocol, wherein CNRA references the Economic Personality Selection from the UBEC Platform as a methodology of measuring any surplus available resource of a Node that is associated with the UBEC User via the Associated Nodes List, wherein CNRA grants reference to the Economic Incentive Selection (EIS) module, wherein EIS recommends for the Node to perform Other Node Work or a work session of Diagnostic Log Submission (DLS), wherein the local execution of EIS on a Node triggers that Node to become a self-imposed Diagnostic Node via the execution of DLS, wherein the Node declares itself to be a Diagnostic Node to Diagnostic Node Location of the Metachain, wherein because of the initially declared status of the Node from the execution of Stage, the Node is marked as unconfirmed until other Nodes can corroborate that it is performing the declared function, wherein updates made to the Diagnostic Node Location of the Metachain are sent to Customchain Interface Module (CIM) to be mined and committed to the actual Metachain.

Due to the Node's declaration on the Metachain concerning being a Diagnostic Node, other Nodes from within the same Sector send it Diagnostic Logs via Jurisdictionally Implied CCF Submission (JICS) and Jurisdictionally Accepted CCF Reception (JACR), wherein the Diagnostic Logs are validated for authenticity by the self-declared Diagnostic Node, wherein Log Units that are tagged with an Official System Token are submitted to SPSI Indirect Development (SID), wherein the Official System Token is cryptographic proof that the Log Unit originates from an Official Appchain, wherein Appchains are tagged as Official if they contribute core functionality to the UBEC Platform.

Other BCHAIN Nodes in the Same Sector process the Diagnostic Log Collection (DLC) module to record relevant Logs that are intended to be submitted to the relevant locations via Diagnostic Log Submission (DLS), wherein the Logs from DLC are forwarded to JIGS, which submits a CCF with no accompanying CCR to an instance of JACR that invoked DLS on the self-declared Diagnostic Node, wherein because of the Node's declaration of being a Diagnostic Node on Diagnostic Node Location of the Metachain, it must accept the CCF packets sent by JIGS due to the elected jurisdiction, wherein LIZARD monitors and justifies CCF packets without an accompanying CCR whereby LIZARD's jurisdiction tracking technology is implemented at the lowest layers of the BCHAIN Network traffic.

In Economic Incentive Selection (EIS) and Work Payment Claim Processing (WPCP), EIS acts as a supply/demand arbitration mechanism for the BCHAIN Network, wherein Nodes seeking Active Node Work invoke EIS to select the best type of work available that is the most likely to yield that Node the best return on investment, wherein local and remote variables concerning the Metachain are analyzed to understand current supply demand trends, wherein Supply Demand Arbitration (SDA) module is invoked, wherein SDA references the Metachain to create a logical representation of supply/demand vectors within the BCHAIN Network, wherein SDA submits Supply Demand Makeup to represent the findings of its calculations, wherein resource availability is checked by invoking Computation and Network Resource Availability (CNRA), wherein the Economic Personality designation is designed from within the UBEC Platform Interface (UPI), wherein if resources are not available, operation of EIS is terminated, wherein if resources are available, EIS invokes Node Job Selection (NJS) that makes reference to Supply Demand Makeup and the availability of Node resources in selecting an appropriately profitable work job.

In the transition between Economic Incentive Selection (EIS) and Work Payment Claim Processing (WPCP). once Active or Passive work is completed, a claim to revenue is made to WPCP which verifies and processes payment to the Watt Economy of the Metachain, wherein Passive Node Work is work that is implicated by the BCHAIN Protocol due to needs of the Network, wherein Active Node Work is done out of selfish motives of the Node on behalf of its owner the UBEC User, whilst in accordance with the selected Economic Personality, wherein EIS only invokes Active Node Work via Node Job Selection, whilst Passive Node Work is implicated due to compliance of the Protocol, wherein if WPCP was invoked by a Node's completion of Passive or Active Work; then the Validated Work Payment is submitted to Pending Yet Validated Work Payments of the Metachain, wherein if WPCP was invoked by a Solved New Block Announcement, Pending Payments are submitted to the Watt Economy, wherein upon modular invocation of WPCP via Solved Work New Block Announcement, Pending Yet Validated Work Payments is retrieved from the Appchain associated with the newly solved block whereby Pending Payments is produced as output.

In a UBMA processor two voltage regulators control the voltage input which leads to two separate subsections of the UBMA Processor, wherein two separate voltages can be adjusted in parallel, which leads to dynamic prioritization of resources according to signals received from the BCHAIN Protocol, wherein for BCHAIN Nodes to be able to communicate with each other via Radio there are several meet up frequencies that each Node occasionally broadcasts it's Identity, Hash Announcement and Personal Frequency to, wherein thereafter for two Nodes to establish a peer-to-peer communication channel, they can meet at each other's Personal Frequencies and exchange information, wherein Wireless all operate on different frequencies to avoid collision and interference, and are diversified by short, medium and long range communication, wherein the BCHAIN Protocol prioritizes the information that should be transferred in situations of scarcity, wherein I/O Management recognizes Execution Segments and General Processing Instructions and hence assigns them to the correct Microchip and returns the data to the rest of the Node.

In the structure of Subsection A, Appchain Logistics Microchip is able to process retention and execution of Appchains and Microchains within the BCHAIN Network, wherein LIZARD as a microchip does not rely on a database for operation and instead judges and estimates measures of risk and compliance in the moment due to its complex a-priori intelligence (no prior reference), wherein the UBMA Processor is able to change its own microprocessor assembly dynamically via dynamic conductive structures, wherein Routing Logic Microchip increases energy efficiency and lowers latency for Routing Logic (RL), wherein the most repeatedly used of LOM's submodules, including Assertion Construction (AC) and Hierarchical Mapping (HM), are made optimized in LOM Core Logic as a Microchip, whereby the entire Modular Manifestation of Execution Stream of LOM is made efficient to execute, wherein Creativity Module as a Microchip optimizes the execution of the Creativity Module within the UBEC Platform, which increases computational efficiency across the UBEC Platform and BCHAIN Network due to many Appchains depending on Creativity including I2GE, CTMP, MPG, SPSI.

In Subsection B of the UBMA Processor, the Cryptographic Processing Unit (CGPU) executes the functions that operate within Cryptography Core (CC), which are invoked throughout the entire BCHAIN Protocol, wherein the Secure Hardware Certificate Generating Unit (SHCG) securely retains the Security Sensitive Unique Private Key that is used to manipulate Node's funds within the Watt Economy of the Metachain, whereby a Node Generated Public Address can be efficiently and quickly generated by SHCG without liability and risk of the Security Sensitive Unique Private Key becoming exposed, wherein by forcefully coupling Watt Units on the Watt Economy with the physical Hardware of a Node via the UBMA Processor, management and manipulation of Watt Units becomes more predictable and safe within the UBEC Platform and BCHAIN Network, wherein the SHCGU Microchip contains a hardcoded Node Unique Identification string that was randomly generated at the time of the manufacturing of the UBMA Processor.

In SHCGU, Permanent Identity Association with Hardware (PIAH) produces the Node Unique Identification that was defined at the time of manufacturing, wherein with Hardware Locked Private Key (HLPK), the Security Sensitive Unique Private Key is permanently observed behind a Hardware Lock Layer, wherein the only exception for a copy of the Private Key intentionally leaving the Hardware Lock Layer is via the Exclusive Backdoor Channel for submission to LUIGI, wherein Public Address Generation (PAG) is the Subsection that generates a Public Address that is derived from the Private Key without transferring any instance of the Private Key outside of the Hardware Lock Layer.

In Fund Recovery Mechanism (FRM), the UBEC User authenticates themselves via User Node Interaction (UNI) which produces an Authenticated User Session, wherein initiation of the process to recover lost funds is invoked by the UBEC User via the UBEC Front-End, wherein the Associated Nodes List is unpacked from the Authenticated User Session, wherein a Fund Recovery Verification Session is initiated with the UBEC User via the UBEC Front-End, wherein the Fund Recovery Verification (FRV) module manages the Fund Recovery Verification Session.

In interaction between the Fund Recovery Mechanism (FRM) and LUIGI, wherein FRM is a submodule that belongs within the jurisdiction of LUIGI, wherein the Retention Decryption Key is accessed from the LUIGI Secure Enclave (LSE), wherein the Retention Decryption Key is used to decrypt and access the Security Sensitive Unique Private Key which is used to manipulate funds from the Watt Economy of the Metachain via Fund Manipulation Mechanism (FMM), whereby LUIGI has access to the entire UBEC/BCHAIN Economy stored in the Watt Economy due to its duplicate copies of the Private Keys in the Encrypted Retention of Private Keys.

LUIGI is programmed once and the first time directly by humans and once the UBEC Platform and BCHAIN Network are live and operational for the first time, all cryptographic access to modify LUIGI's codebase is exclusively retained by Self Programming Self Innovation (SPSI), wherein SPSI is an Appchain that uses LIZARD technology to program other Appchains within the UBEC Platform, wherein programming by SPSI includes refining, bug/error fixing, scheduled maintenance, Diagnostic Log Unit analysis, new feature innovation, wherein SPSI is able to program itself, yet receives elements of Programming Guidance from SPSI Indirect Development (SID).

SPSI is granted, according to the permanent BCHAIN Protocol, exclusive access to manipulate the codebase of all of the major functions of the UBEC Platform, including UBEC Application, LUIGI, Creativity, I2GE, SPSI, LOM, LIZARD, CTMP, MPG, MC and I2CM, wherein LOM receives Diagnostic Log Units from Automated Research Mechanism (ARM), wherein LOM characterizes and understands routine malfunctions with Currently Existing Features and proposes Solutions for the received Log Units, wherein Currently Existing Features are features of the selected Appchain that has been targeted for programming/refinement/innovation, wherein Proposed Solutions are output to Existing Feature Malfunctions, wherein LOM inspects the selected Appchain and estimates proposed new features which it expects will enhance the Appchain's ability and efficiency in performing its primary function, wherein the Proposed Features and Proposed Solutions are defined in purpose, and are transferred to LIZARD to be programmed into functional codes via the Purpose and Syntax Modules.

LIZARD outputs Executable Code Sets which represent the ideas originally conceived of by LOM, wherein the Executable Code Sets are transferred to I2GE along with Successful Execution and Failed Execution Scenarios from LIZARD, I2GE evolves and tweaks via Creativity the software over multiple evolutionary pathways by using the CPU and storage resources made available by the BCHAIN Network, wherein by referencing the Successful and Failed Execution Scenarios I2GE is able to distinguish variations of the Code Sets that are ultimately stable and functional with those that are not, wherein LOM verifies that the resultant software is in accordance with its perception of stability and means of achieving functionality.

Symbiotic Recursive Intelligence Advancement (SRIA), is Artificial Intelligence algorithm that is primarily manifested in the operation of Self Programming Self Innovation (SPSI), SRIA is related to LIZARD, I2GE and SPSI, wherein LIZARD improves an algorithm's Source Code by understanding Code Purpose, wherein I2GE emulates generations of virtual program iterations, hence selecting the strongest program version, wherein BCHAIN is a vast Network of chaotically connected Nodes that can run Appchains in a decentralized manner, wherein SPSI maintains the same Appchains that grant it its functionality and capabilities, wherein the layout of the feedback-loop based system ensures that gradual incremental progress in Artificial Intelligence cognitive and problem solving capabilities increase, wherein Virtual Emulation is when I2GE executes the code of the Target Appchain in a virtual environment which is hosted by the BCHAIN Network, wherein BCHAIN acts as a Hosting Resource Provider for I2GE, LIZARD, LOM, CTMP, NC and 12CM.

Status Quo generically represents the overall functionality, efficiency and design of a target system, wherein LOM is invoked by the Design Principle Invocation Prompt (DPIP) to produce System Design Principles, wherein refinement to the Design Principles is enabled by LIZARD which converts the relevant data into purpose format which acts as the crucial intermediate stage for accurately performing system modifications, wherein LIZARD uses its programming abilities to perform experimental modifications to the Refined Status Quo, wherein the new Status Quo is virtualized and evolved by I2GE, whereby the intelligence cycle has reset and potential of the next cycle becoming available increases as the relevant Appchain Algorithms discover new information, functionality, and techniques.

In regards to Intelligence Pooling, CTMP acts as the central location of intelligence retention, as it gradually usurps the intelligence of algorithms, wherein CTMP interprets all artificially based decisions made by Appchain Algorithms including LIZARD, LOM and I2GE and receives their raw processing logs which act as Objective Facts concerning the decision being made, whereby the aggregate intelligence of multiple Appchain Algorithms is recycled by CTMP and any collected/pooled intelligence eventually benefits all of the Appchain Algorithms that interact with CTMP.

In regards to Hardware, Framework, and Functionality feedback and influence, an ideal system design is produced at Abstract Target System Generator (ATSG), wherein Required User Functionality is related to and informs the definition of New User Functionality, wherein the Syntax of Functionality is inherited by Application Functionality, which in turn becomes a layer of Operation Enablement for New User Functionality, wherein Application Functionality enhancement is manifested in SPSI's submodule New Appchain Development (NAD), wherein the core practice of logistical layer tension is the enhancement of Code Efficiency, Quality, Security and Stability and the Process is undertaken by SPSI via its submodules Appchain Security Hardening (ASH), Innate Error Correction (IEC), Automated Appchain Refinement (A2R), Automated Appchain Maintenance (A2M), Appchain Regulatory Compliance (ARC) and Diagnostic Log Unit Analysis (DLUA), wherein Enhanced Code Quality enables the Operation of Application Functionality, which in turn Enables New User Functionality, wherein said aspects of the software are Enabled by Framework Adaption, wherein the Adaption represents the changes performed to the underlying Framework which allows for User Space Applications to Operate, wherein the Framework Adaption is practically performed by SPSI's Enhanced Framework Development (EFD) whereby Hardware Changes are performed according to the Framework syntax that is Inherited, which in turn enables the Framework and its User Space to Operate.

Regarding intelligence trickling from interaction of the UBEC User across multitiered cycles, Long Term Cycle represents large scale Guiding Principles of SPSI Direction whereby capabilities, methodologies, and tendencies of SPSI are gradually informed at a slow and Long Term basic via Human interaction of LOM and SPSI Indirect Development (SID), wherein LOM acts as a rational director of SPSI's functionality and operation makeup due to its objective reasoning which is enabled by built-in modular invocation of CTMP, wherein changes that occur via LOM and SID in the Long Term Cycle eventually Affect and Inform the Medium Term Cycle which represents the practical sustained operation of SPSI, wherein SPSI's Submodules are gradually affected by the Guiding Principles of SPSI Direction, wherein the operation of SPSI within the Medium Term Cycle leads to the general enhancement of Appchains that exist within the UBEC Platform/BCHAIN Network as well as Appchains/Legacy Programs operating within Legacy Systems via Appchain Emulation Layer (AEL), wherein Short Term adaption cycles of intelligence are enhanced by SPSI, which allows for sophisticated adaptation strategies to by deployed in the Short Term.

Within Self Programming Self Innovation (SPSI), Automated Appchain Refinement (A2R) inspects Appchains or Legacy Programs, wherein Automated Appchain Maintenance (A2M) maintains the selected Appchain or Legacy Program by deleting Expired Caches, upgrading Depreciated Functions to Usable Functions, upgrading Depreciated Modules and Dependencies with usable Modules, deleting Expired Points of Reference, and performing Economical Stability Calibration, wherein Appchain Security Hardening (ASH) automatically inspects points of intrusion and exploit in an Appchain or Legacy Program, wherein Appchain Regulatory Compliance (ARC) ensures that the selected Appchain or Legacy Program is in compliance with various and specific regulations, wherein the Diagnostic Log Unit Analysis (DLUA) receives Diagnostic Log Units (DLU) from malfunctioning routines and enacts the appropriate provisions to attempt to fix such perceived malfunctions, wherein Innate Error Correction (IEC) attempts to fix fundamental procedure flaws that can lead to a halted routine, wherein New Appchain Development (NAD) finds uses for Applications within a specified Application ecosystem that has a potential Application feature missing, which would perceivably benefit such an ecosystem, wherein Enhanced Framework Development (EFD) inspects and potentially improves existing software frameworks for both the UBEC Platform/BCHAIN Network and Legacy Systems, wherein Enhanced Hardware Development (EHD) modifies physical systems that contain Dynamic Liquid Conductive Boards (DLCB) and therefore can have their core hardware structure optimized and upgraded, wherein Appchain Targeting Mechanism (ATM) processes an intelligent selection algorithm that informs other modules for which Appchain they should select in their processing.

LIZARD operates to convert the Execution Stream of the Target Appchain, that was selected by ATM, into a Purpose Hierarchy Map, wherein the Execution Stream of the Target Appchain that is produced by Execution Stream Collection (ESC) is submitted to the Syntax Module (SM), wherein for code writing, SM receives Complex Purpose Format from the Purpose Module (PM), wherein for code reading, SM provides a syntactical interpretation of computer code for PM to derive a purpose for the functionality of such code, wherein the Target Appchain is received in Fulfilled Execution Stream format by Code Translation, wherein Code Translation converts arbitrary (generic) code which is recognized and understood by SM to chosen computation language, wherein Code Translation performs the inverse function of translating known computation languages into arbitrary syntax types, wherein the output of the completed execution of Code Translation is transferred as input to Logical Reduction, wherein Logical Reduction reduces code logic to simpler forms to produce a map of interconnected functions in accordance with the definitions of Rules and Syntax, wherein upon the completed execution of Logical Reduction, the execution of the corresponding SM instance is complete and the modular output of SM is sent to Iterative Interpretation of PM, wherein PM uses SM to derive a purpose in Complex Purpose Format from computer code, wherein Iterative Interpretation loops through all interconnected functions to produce an interpreted purpose definition by referring to Purpose Associations.

Logical Reduction from the Syntax Module SM submits it's output to Iterative Interpretation from PM, wherein Iterative Interpretation loops through all interconnected functions to produce an interpreted purpose definition by referring to Purpose Associations, wherein the purpose definition output exists in Complex Purpose Format, which is submitted as modular output for PM, wherein the output is labeled as a Purpose Hierarchy Map which is presented as the Complex Purpose Format version of the Target Appchain.

The Code Design Principles are submitted to SM which belongs to the jurisdiction of the Outer Core (OC), wherein SM provides a framework for reading and writing computer code, wherein for code writing, SM receives Complex Purpose Format from PM, wherein the Complex Purpose Format is then written in pseudocode, wherein thereafter a helper function converts the pseudocode into real executable code depending on the desired target computation syntax, wherein for code reading; SM provides a syntactical interpretation of computer code for PM to derive a purpose for the functionality of such code, wherein the Target Appchain is received in Principle Syntax format by Code Translation, wherein Code Translation converts arbitrary code which is recognized and understood by SM to any chosen computation language, wherein Code Translation performs the inverse function of translating known computation languages into arbitrary syntax types, wherein the output of the completed execution of Code Translation is transferred as input to Logical Reduction, wherein Logical Reduction reduces code logic to simpler forms to produce a map of interconnected functions in accordance with the definitions of Rules and Syntax.

Logical Reduction from SM submits it's output to Iterative Interpretation from PM, wherein Iterative Interpretation loops through all interconnected functions to produce an interpreted purpose definition by referring to Purpose Associations, wherein the purpose definition output exists in Complex Purpose Format, which is submitted as modular output for PM, wherein the output is labeled as a Purpose Hierarchy Map which is presented as the Complex Purpose Format version of the Code Design Principles.

Instruction Purpose Collection exists in Complex Purpose Format and is submitted to Iterative Expansion of PM, within the Outer Core (OC) of LIZARD, wherein Iterative Expansion adds detail and complexity to evolve a simple goal into a specific complex purpose definition, wherein therefore the maximum Purpose Association potential of the input is realized, and retained as a Complex Purpose Format, before it is submitted to Logical Derivation of the SM, wherein the input data is received in Complex Purpose Format from PM and is transferred to Logical Derivation of SM, wherein Logic Derivation derives logically necessary functions from initially simpler functions, wherein the produced result is a tree of function dependencies that are built according to the defined Complex Purpose Format data, wherein Logical Derivation operates according to the Rules and Syntax definitions which are inherited from the Core Code element of Inner Core, wherein Logical Derivation submits it's output to Code Translation, wherein therefore PM invokes SM to produce the resultant Appchain Syntax version of the input Upgraded Purpose Map via Code Translation.

Innate Error Correction (IEC) is a sub-module of SPSI, wherein the Appchain Targeting Mechanism (ATM) selects a specified Target Appchain which is then submitted as modular input to an invoked Execution Stream Collection (ESC) instance, wherein the Execution Stream that is produced as modular output from the ESC instance is submitted as modular input to a stage of IEC, which separates the Execution Stream of the Appchain to produce the Code Structure Blueprint, wherein each Selected Code Unit that exists within the Code Structure Blueprint is cycled through a programming Loop, wherein LIZARD is invoked to produce a Purpose Hierarchy Map of the entire Code Structure Blueprint, wherein both Purpose Hierarchy Maps are submitted as modular input to the Purpose to Purpose Symmetry Processing (P2SP) module, wherein upon completion of P2SP's processing, Symmetry Processing Result is produced as the modular output.

The Selected Code Unit is submitted to SM, wherein the Selected Code Unit is received in Fulfilled Execution Stream format by Code Translation, wherein the output of the completed execution of Code Translation is transferred as input to Logical Reduction, wherein Logical Reduction reduces code logic to simpler forms to produce a map of interconnected functions in accordance with the definitions of Rules and Syntax, wherein Logical Reduction submits it's output to Iterative Interpretation, wherein the Code Structure Blueprint is submitted to SM.

Once Execution Stream Collection (ESC) has submitted the Execution Stream as modular input of IEC, Execution Stream Rendering is invoked to interpret and build all the relevant dependences from supplement Appchains, producing the Fulfilled Execution Stream, wherein the selected Fulfilled Execution Segment is isolated and stored in the Code Unit Buffer Pool (CUBP), wherein CUBP is submitted to SM.

CUBP is processed in a Loop (of each potential Code Unit), wherein the Purpose Hierarchy Map of the entire CUBP and the Purpose Hierarchy Map of the Selected Code Unit is submitted to Purpose to Purpose Symmetry Processing (P2SP) whereby producing the Symmetry Processing Result, wherein the modular output of the corresponding P2SP instance is Symmetry Processing Result, which result is submitted as modular input to the Symmetry Processing Result Validation (SPRV), wherein each Alignment Integration Detection (AID) instance is separated, wherein a Loop for each AID instance result is invoked, wherein looping is performed through each Misaligned Code Unit Purpose and derives a suitable purpose via invocation of Suitable Purpose Replacement (SPR) that conforms with the Purpose Hierarchy Map of the Code Structure Blueprint, wherein LIZARD is invoked to convert the Purpose Replacements produced by the corresponding SPR instance into Execution Segments, wherein each Syntax Replacement Unit is associated with it's relevant place in the Code Structure Blueprint, wherein LIZARD is invoked to convert Purpose Replacements into Execution Segments producing and submitting results to Syntax Replacement Unit Retention (SRUR), wherein each Syntax Replacement Unit is associated with it's corresponding place in the Code Structure Blueprint, wherein the Unit Blueprint Lookup (UBL) is invoked, wherein UBL produces it's output to the Code Structure Streamline Processing (CSSP), which arranges the input data into an Upgraded Appchain output, wherein a Deployment Patch, which contains the Syntax Replacement Units and instructions for what part of the Appchain they will replace, is created.

The Misaligned Code Unit Purpose Retention (MCUPR) is submitted as modular input to SPR, wherein a Loop through each Misaligned Code Unit Purpose from MCUPR is initiated, wherein LOM is invoked to produce a Purpose Replacement for the Selected Misaligned Code Unit, which is congruent and compatible with the Code Structure Blueprint, wherein the individual Purpose Replacement within the Loop is processed by LIZARD.

The Code Structure Blueprint, Misaligned Code Unit, and Compliance Design Principles are supplied as initial input to the Replacement Invocation Prompt (RIP), wherein RIP produces a Prompt that interacts directly with LOM to invoke the production of the Purpose Replacement with consideration of the input criteria Code Structure Blueprint, Misaligned Code Unit and Compliance Design Principles, wherein the Prompt is submitted to the Initial Query Reasoning (IQR) module of LOM, wherein this instance of LOM is automatically invoked by RIP, wherein the provided Prompt is analyzed via invocation of Central Knowledge Retention (CKR) to decipher Missing Details from the Prompt that are crucial to complete the correct virtual understanding by LOM, wherein the resultant Missing Details produced by IQR are submitted as modular input to Survey Clarification (SC), wherein SC engages with the origin of the Prompt to retrieve supplemental information, wherein the fully formed and refined version of the Prompt is produced from SC and submitted as modular input to Assertion Construction (AC), wherein AC attempts to form a coherent response to the Prompt by referencing CKR directly and also via Hierarchical Mapping (HM).

AC provides a Response Presentation to Rational Appeal (RA), wherein the produced assertion is directly submitted to the CTMP as a Subjective Opinion input, and also to Context Construction (CC) which provides the Objective Fact input to CTMP, wherein CC references metadata from AC and potential evidence provided via RIP to submit raw facts to CTMP, wherein the input metadata is represented by the LOM Log Aggregate file, which contains a collection of relevant log files that are produced from the primary operating functions of LOM, wherein after CTMP concludes it's operation, a Post-Criticized Decision is produced as modular output, wherein the initial Pre-Criticized Decision and Post-Criticized Decision are submitted to the Decision Comparison (DC) which determines the scope of potential overlap between the two inputs, wherein the unified output provided by DC can either indicate CTMP's Concession or a perceived Improvement on behalf, wherein Argument Responses can be classified as either Low Confidence Results or High Confidence Results, wherein Modular outputs produced IQR, SC, AC, Hierarchical Mapping (HM) and Knowledge Validation (KV) are submitted to the LOM Modular Log Collection (LMLC), wherein LMLC combines the input log data into a single readable file referenced as LOM Log Aggregate.

The Pre-Criticized Decision is presented as modular output from AC, wherein the Decision is then marked as a Subjective Opinion, wherein the Subjective Opinion is submitted to Input System Metadata, which acts as the primary modular input for CTMP and an internal representation of the Selected Pattern Matching Algorithm (SPMA), wherein for this instance configuration; the SPMA is LOM, wherein Input System Metadata is submitted for processing to Reason Processing and to Raw Perception Production (RP2), wherein Reason Processing will logically understand the assertions being made by comparing property attributes, wherein RP2 parses the Input System Metadata from LOM to produce a perception in Perception Complex Format (PCF) that represents the algorithmic perception of LOM, wherein the produced Perception is submitted to the Perception Observer Emulator (POF), wherein Reason Processing invokes Rule Processing, wherein the results produced by both thinking Branches are transferred to Critical Decision Output (CDO), which evaluates any fundamental elements of conflict or corroboration between the results.

LOM produces the Purpose Replacement by invoking AC, wherein the Purpose Replacement is submitted to RP2 which unpacks the data to produce instances of a Debugging Trace and Algorithm Trace within the Input System Metadata which originates from the corresponding AC instance, wherein Debugging Trace is a coding level trace that provides variables, functions, methods and classes that are used along with their corresponding input and out variable type and content, wherein Algorithm Trace is a software level trace that provides security data coupled with algorithm analysis, wherein the resultant security decision is provided along with a logistics trail of how it reached the Decision, wherein RP2 transfers the data concerning the produced perception result to Perception Observer Emulator (POE) for processing.

The operation of Metric Processing and System Metadata Separation (SMS) lead to the production of Perceptions, which represent LOM's modular response of producing the Purpose Replacement via AC, wherein RP2 produces a Comparable Variable Format datapoint which is fed into Storage Search (SS) as search criteria, wherein SS performs a lookup of Perception Storage (PS) to find matches with already existing Perceptions stored in PS, wherein the Results of the execution SS are produced which leads to a Weight Calculation, which attempts to find the correct distribution of corresponding Perceptions from PS to replicate and match the Comparable Variable Format which represents the execution of the LOM algorithm that produced Purpose Replacement.

The Memory Web process operates in parallel to the execution of POE, wherein the Purpose Replacement produced by LOM is submitted as modular input to Reason Processing that processes how LOM achieved the decision to produce the Purpose Replacement in response to the Prompt provided by RIP, wherein the processing conclusion of Reason Processing defines the rules that are consistent with LOM's execution behavior, wherein if any inconsistencies are found in rule behavior with regards to LOM's execution behavior, then currently existing rules are modified or new rules are added, wherein Critical Rule Scope Extender (CRSE) leverages known Perceptions to expand the ‘critical thinking’ scope of the rulesets, in effect enhancing the rulesets to produce Correct Rules that are submitted as modular input to Rule Syntax Format Separation (RSFS) from within the operating jurisdiction of Memory Web, wherein RSFS separates and organizes Correct Rules by type, wherein. Chaotic Field Parsing (CFP) combines and formats the LOM Log Aggregate into a single scannable unit referenced as the Chaotic Field, wherein the Chaotic Field is submitted as modular input to Memory Recognition (MR), wherein MR also receives the Original Rules which is the execution result from RSFS, wherein MR scans the Chaotic Field provided by CFP to recognize knowable concepts defined in Original Rules.

PS contains four subsets of Perceptions: Deduced Unknown Angles of Perception, All Angles of Perception, Implied Angles of Perception, and Applied Angles of Perception, wherein Applied Angles of Perception are directly imported by studying algorithmic behavior of the Selected Pattern Matching Algorithm (SPMA), wherein Implied Angles of Perception are derived from Applied Angles of Perception via modular execution of Implication Derivation (ID) and APDM, wherein All Angles of Perception represents the entire scope of known Perceptions to the CTMP that have not been included by Applied Angles of Perception and Implied Angles of Perception, wherein Deduced Unknown Angles of Perception represents the scope of Perceptions that is expected to exist yet the CTMP has yet to discover according to the Self-Critical Knowledge Density (SCKD), wherein ID analyzes the individual metrics of Applied Angles of Perception to deterministically derive Implied Angles of Perception, whilst APDM creatively varies compositions of Angles of Perception via the Creativity Module to produce a New Iteration that combines the initial two input Weights, wherein all of the Angles of Perception involved with APDM processing correspond with and represent the Purpose Replacement that is produced by AC.

Rational Appeal (RA) operates within LOM and invokes Context Construction (CC) to process the LOM Log Aggregate to Chaotic Field Parsing (CFP) that produces a Chaotic Field from the modular output of CC which is referenced by Memory Recognition (MR), wherein Current Rules exhibits rulesets that are indicative of the current functioning state of the Selected Pattern Matching Algorithm (SPMA), wherein Current Rules is submitted as modular input to the Rule Syntax Derivation (RSD) where logical ‘black and white’ rules are converted to metric based perceptions, wherein the output of RSD is provided as input to Perception Matching (PM), wherein at PM, a Comparable Variable Format (CVF) unit is formed from the Perception received from RSD, wherein the newly formed CVF is used to lookup relevant Perceptions in PS, wherein the potential matches are submitted as modular input to Rule Syntax Generation (RSG, wherein RSG receives previously confirmed perceptions which are stored in Perception format and accesses the Perception's internal metric makeup, wherein the Perceptions are received from PS which contains Previously Confirmed Perceptions, wherein such gradient-based measures of metrics are converted to binary and logical rulesets that emulate the input/output information flow of the original perception, wherein therefore RSG produces Perceptive Rules that are considered relevant, popular and have been converted into logical rules, wherein if a Perception had many complex metric relationships that defined many ‘grey areas’, the ‘black and white’ local rules encompass such ‘grey’ areas by expanding on the ruleset complexity, wherein Perceptive Rules are stored by a collection of Rule Syntax Format (RSF) definitions, wherein Perceptive Rules are submitted as input to MR, where they are scanned against the Chaotic Field which was produced by CFP, wherein MR produces Extra Rules which complete Correct Rules in their validity.

The Applied Angles of Perception from PS are submitted as input to ID to produce more Perceptions that belong to Implied Angles of Perception, wherein the Applied Angles of Perception are specifically sent to Metric Combination of ID, wherein Metric Combination separates the received Angles of Perception into categories of metrics: Scope, Type, Consistency, Intensity, wherein the input Angles of Perception are related to the Purpose Replacement that was produced by AC, wherein the Metric Complexity Set A is submitted as input to Metric Expansion (ME), wherein with ME the metrics of multiple and varying Angles of Perception are stored categorically, wherein ME enhances the current batch of received metrics with details/complexity extracted from previously known/encountered metrics, wherein upon enhancement and complexity enrichment completion, the metrics are returned as ME output as Metric Complexity Set B and thereafter converted back into Angles of Perception to be stored in Implied Angles of Perception.

Critical Decision Output (CDO) of CTMP receives output from POE and RE, wherein each Branch submits it's respective Critical Decision as well as corresponding the Meta-metadata, which provides contextual variables that justify why the initial critical decision was reached, wherein both Decision Sets that represent the Perceptions of POE and the Fulfilled Rules of RE are submitted to the Metadata Categorization Module (MCM), which separates the Debugging and Algorithm Traces into distinct categories using traditional syntax based information categorization, wherein the Internal Processing Logic of Direction Decision Comparison (DDC) checks for corroboration or conflict between the Intuitive Decision and the Thinking Decision, wherein Terminal Output Control (TOC) initiates with Prompt, which checks if DDC was able to provide a Final Decision Output, wherein if the response to Prompt is Yes, then the combined final decision provided by DDC at Final Decision Output is submitted as output of TOC, wherein if the response to Prompt is No, PM is executed to fetch the corresponding results, wherein Fulfilled Rules are extracted from the Critical Decision+Meta-metadata of RE, wherein the Rules are converted to Perceptions by Rule Syntax Derivation (RSD), wherein PM then references Meta-metadata to determine if there was a strong internal overlap and corroboration of Perceptions used.

The Purpose Replacement exists in Complex Purpose Format and is submitted to Iterative Expansion of PM, wherein Iterative Expansion adds detail and complexity to evolve a simple goal (indirectly defined within the Purpose Replacement) into a specific complex purpose definition whereby the maximum Purpose Association potential of the input is realized, and retained as a Complex Purpose Format, before it is submitted to Logical Derivation of SM, wherein the Core Code element of IC contains Fundamental Frameworks and Libraries, Thread Management and Load Balancing scripts, Communication and Encryption protocols, and Memory Management systems, whereby enabling general operation and functionality to SM and PM, wherein the System Objectives of IC defines Security Policy and Enterprise Goals.

Regarding the operation and functionality of the Unit Blueprint Lookup (UBL) of IEC, input from Syntax Replacement Unit Retention (SRUR) is received, therefore initiated a Loop that cycles through all the Syntax Replacement Units, wherein the Associated Code Unit ID is unpacked from the Syntax Replacement Unit, wherein on a separate parallel thread within the same instance of UBL the Code Structure Blueprint is submitted as input and the Code Structure Blueprint is installed into the New Code Structure Blueprint Retention (NCSBR), wherein the Fulfilled status of the Execution Segments is reversed via Code Structure Streamline Processing (CSSP) producing the Upgraded Appchain as output, which represents the original syntactical structure but with the Misaligned Code Units replaced with Suitable Purpose Replacements, wherein the Upgraded Appchain is submitted to Deployment Patch Assembly (DPA) to produce the Appchain Correction Patch, wherein the Target Appchain is processed by Execution Stream Collection (ESC), therefore submitting the original Execution Stream to DPA enabling DPA to have access to the Target Appchain in it's original form, wherein the Appchain Correction Patch is deployed to Customchain Ecosystem Builder (CEB), which manipulates the Target Appchain so that it converts in content to the Upgraded Appchain.

Regarding the internal operation of LOM and CTMP in regards to Appchain Security Hardening (ASH), the Theory of Security, Unconfirmed Security Information, and Confirmed Security Knowledge are supplied as initial input to the Deduction Invocation Prompt (DIP) that produces a Prompt that interacts directly with LOM to invoke the production of the Confident Security Assertion with consideration of the input criteria Theory of Security, Unconfirmed Security Information, and Confirmed Security Knowledge, wherein the Prompt is submitted to the Initial Query Reasoning (IQR), wherein the provided Prompt is analyzed via invocation of Central Knowledge Retention (CKR), wherein the resultant Missing Details produced by IQR are submitted as input to Survey Clarification (SC) that engages with the origin of the Prompt to retrieve supplemental information, SC engages with DIP to retrieve supplemental information concerning the Prompt, wherein the refined version of the Prompt is produced from SC and submitted as input to AC that attempts to form a coherent response to the Prompt by referencing CKR directly and also via Hierarchical Mapping (HM), wherein RA uses CTMP to criticize assertions in the form of self-criticisms or external criticisms to the origin of the question/assertion processed by IQR, wherein if an assertion produced from AC fails a significant measure of the self-criticism test processed by RA; then a new instance of AC is invoked to account for any valid criticisms, wherein if a high confidence assertion is produced by AC that consistently passes self-criticism tests processed by RA; then the assertion is produced as LOM's output, referenced as the Confident Security Assertion in context of the initial Prompt provided by DIP.

Regarding the internal operation procedure of RA in regards to ASH, AC provides a Response Presentation to RA concerning the assertion produced by AC in regards to the corresponding input Prompt, the produced assertion is directly submitted to CTMP as a Subjective Opinion input, and also to Context Construction (CC) which provides the Objective Fact input to CTMP, wherein CC references metadata from AC and potential evidence provided via RIP to submit raw facts to CTMP for critical thinking, wherein such input metadata is represented by the LOM Log Aggregate file, wherein outputs produced from Initial Query Reasoning (IQR), SC, AC, HM and KV are submitted to the LOM Modular Log Collection (LMLC) that combines the input log data into a single readable file referenced as LOM Log Aggregate, which is submitted to CC of Rational Appeal (RA).

Concerning the invocation of RP2 within CTMP, LOM produces the Confident Security Assertion by invoking AC, wherein the Confident Security Assertion is then submitted to RP2 which unpacks the data to produce instances of a Debugging Trace and Algorithm Trace within the Input System Metadata which originates from the corresponding AC instance, wherein Metric Processing reverse engineers the variables from LOM to extract perceptions from the artificial intelligence exhibited by LOM, wherein thereafter Input System Metadata is separated into meaningful security cause-effect relationships via System Metadata Separation (SMS).

The Purpose Replacement produced by LOM and corresponding LOM Log Aggregate undergo Data Parsing which causes Data Enhanced Logs to be derived which are applied in the Application to achieve an Interpretation Dichotomy of a Positive Sentiment (Approve) or Negative Sentiment (Block) with regards to the input Purpose Replacement, wherein successful conclusion of the execution of Application leads to an Override Corrective Action which is processed by Critical Decision Output (CDO) in parallel to the modular output of Rule Execution (RE), wherein Self-Critical Knowledge Density (SCKD) estimates the scope and type of potential unknown knowledge that is beyond the reach of the reportable LOM Log Aggregate.

Regarding the logic flow interaction between PS and the Automated Perception Discovery Mechanism (APDM), PS contains four subsets of Perceptions: Deduced Unknown Angles of Perception, All Angles of Perception, Implied Angles of Perception and Applied Angles of Perception, wherein Applied Angles of Perception are directly imported by studying algorithmic behavior of SPMA, Implied Angles of Perception are derived from Applied Angles of Perception via execution of Implication Derivation (ID) and APDM, wherein All Angles of Perception represents the entire scope of known Perceptions to the CTMP that have not been included by Applied Angles of Perception and Implied Angles of Perception, wherein Deduced Unknown Angles of Perception represents the scope of Perceptions that is expected to exist yet the CTMP has yet to discover according to SCKD, wherein ID analyzes the individual metrics of Applied Angles of Perception to deterministically derive Implied Angles of Perception, whilst APDM creatively varies compositions of Angles of Perception via the Creativity Module to produce a New Iteration that combines the initial two input Weights whereby all of the Angles of Perception involved with APDM processing correspond with and represent the Confident Security assertion that is produced by LOM's AC.

Regarding Critical Rule Scope Extender (CRSE) of CTMP, an RA instance operates within LOM and invokes Context Construction (CC) to process the LOM Log Aggregate to Chaotic Field Parsing (CFP), which produces a Chaotic Field from the modular output of CC which is referenced by Memory Recognition (MR), wherein Current Rules exhibits rulesets that are indicative of the current functioning state of the Selected Pattern Matching Algorithm (SPMA) which in this instance is LOM, wherein Current Rules is submitted as modular input to the Rule Syntax Derivation (RSD), which is where logical ‘black and white’ rules are converted to metric based perceptions, wherein the output of RSD is provided as input to Perception Matching (PM), wherein at PM; a Comparable Variable Format (CVF) unit is formed from the Perception received from RSD, wherein the newly formed CVF is used to lookup relevant Perceptions in the Perception Storage (PS) with similar indexes, wherein the potential matches are submitted as input to Rule Syntax Generation (RSG), wherein RSG receives previously confirmed perceptions which are stored in Perception format and accesses the Perception's internal metric makeup, wherein the Perceptions are received from PS which contains Previously Confirmed Perceptions whereby such gradient-based measures of metrics are converted to binary and logical rulesets that emulate the input/output information flow of the original perception and therefore RSG produces Perceptive Rules which are Perceptions that are considered relevant, popular and have been converted into logical rules, wherein the Perceptive Rules are stored by a collection of Rule Syntax Format (RSF) definitions, wherein Perceptive Rules are submitted as input to Memory Recognition (MR) where they are scanned against the Chaotic Field which was produced by CFP whereby MR producing Extra Rules which complete Correct Rules in their validity.

Regarding ID of CTMP, the Applied Angles of Perception from PS are submitted as input to ID to produce more Perceptions that belong to Implied Angles of Perception, wherein the Applied Angles of Perception are specifically sent to Metric Combination of ID, wherein Metric Combination separates the received Angles of Perception into categories of metrics: Scope, Type, Consistency, Intensity, wherein the input Angles of Perception are related to the Purpose Replacement that was produced by AC.

CDO receives modular output from both major branches of CTMP: POE and RE, wherein Each Branch submits it's respective Critical Decision as well as corresponding Meta-metadata, wherein both Decision Sets are submitted to the Metadata Categorization Module (MCM) which separates the Debugging and Algorithm Traces into distinct categories using traditional syntax based information categorization.

Concerning the operation of LIZARD to convert the System Regulations and Guidelines into a Purpose Hierarchy Map, the System Regulations and Guidelines is submitted from LUIGI to SM, wherein the System Regulations and Guidelines is received in Data Stream A0 format by Code Translation that converts arbitrary code to chosen computation language and so performs the inverse function of translating known computation languages Into arbitrary syntax types.

The Upgraded Purpose Map exists in Complex Purpose Format and is submitted to Iterative Expansion that adds detail and complexity to evolve a simple goal into a specific complex purpose definition, wherein the input data is received in Complex Purpose Format from PM and is transferred to Logical Derivation of SM, wherein PM invokes SM to produce the resultant Appchain Syntax version of the input Upgraded Purpose Map via Code Translation, wherein the resultant Upgraded Appchain that is terminally produced by Code Translation is the modular output of SM, Outer Core and LIZARD.

Concerning the operation of LIZARD to convert the full contents of Error Related Log Retention (ERLR) into a Purpose Hierarchy Map, the contents of ERLR is submitted to SM, wherein Logical Reduction from SM submits it's output to Iterative Interpretation from PM, wherein Iterative Interpretation loops through all interconnected functions to produce an interpreted purpose definition by referring to Purpose Associations, wherein the output is labeled as a Purpose Hierarchy Map which is presented as the Complex Purpose Format version of ERLR.

Concerning the operation of LIZARD to convert the Contextualized Error Log into a Purpose Hierarchy Map, the Contextualized Error Log is submitted to SM, wherein Logical Reduction from SM submits it's output to Iterative Interpretation from PM, wherein Iterative Interpretation loops through all interconnected functions to produce an interpreted purpose definition by referring to Purpose Associations, wherein the output is labeled as a Purpose Hierarchy Map which is presented as the Complex Purpose Format version of the Contextualized Error Log.

Concerning the operation of LIZARD to convert the Refined Execution Segment into a Purpose Hierarchy Map, the Refined Execution Segment is submitted to SM, wherein Logical Reduction from SM submits it's output to Iterative Interpretation from PM, wherein Iterative Interpretation loops through all interconnected functions to produce an interpreted purpose definition by referring to Purpose Associations, wherein the output is labeled as a Purpose Hierarchy Map which is presented as the Complex Purpose Format version of the Refined Execution Segment.

Concerning the operation of LIZARD to convert the entire Customchain Ecosystem of the UBEC Platform into a Purpose Hierarchy Map, the UBEC Platform is submitted to SM, wherein Logical Reduction from SM submits it's output to Iterative Interpretation from PM, wherein Iterative Interpretation loops through all interconnected functions to produce an interpreted purpose definition by referring to Purpose Associations, wherein the output is labeled as a Purpose Hierarchy Map which is presented as the Complex Purpose Format version of the UBEC Platform.

Concerning the operation of LIZARD to convert the Purpose Hierarchy Map into a series of Purpose Bands, the Purpose Hierarchy Map exists in Complex Purpose Format and is submitted to Iterative Expansion of PM, wherein Iterative Expansion adds detail and complexity to evolve a simple goal into a specific complex purpose definition whereby the maximum Purpose Association potential of the input is realized, and retained as a Complex Purpose Format, before it is submitted to Logical Derivation of SM, wherein the input data is received in Complex Purpose Format from the PM and is transferred to Logical Derivation of SM, wherein Logic Derivation derives logically necessary functions from initially simpler functions, wherein the produced result is a tree of function dependencies that are built according to the defined Complex Purpose Format data.

Concerning the operation of LIZARD to convert the New Proposed Changes into a Purpose Hierarchy Map, the UBEC Platform is submitted to SM, wherein Logical Reduction from SM submits it's output to Iterative Interpretation from PM, wherein Iterative Interpretation loops through all interconnected functions to produce an interpreted purpose definition by referring to Purpose Associations, wherein the output is labeled as a Purpose Hierarchy Map which is presented as the Complex Purpose Format version of the New Proposed Changes.

Concerning the operation of LIZARD to convert System Design Principles into a Purpose Hierarchy Map, the System Design Principles is submitted to SM, wherein Logical Reduction from SM submits it's output to Iterative Interpretation from PM, wherein Iterative Interpretation loops through all interconnected functions to produce an interpreted purpose definition by referring to Purpose Associations, wherein the output is labeled as a Purpose Hierarchy Map which is presented as the Complex Purpose Format version of the System Design Principles.

Concerning the operation of LIZARD to convert Appchain Jurisdictions into a Purpose Hierarchy Map, the Appchain Jurisdictions is submitted to SM, wherein Logical Reduction from SM submits it's output to Iterative Interpretation from PM, wherein Iterative Interpretation loops through all interconnected functions to produce an interpreted purpose definition by referring to Purpose Associations, wherein the output is labeled as a Purpose Hierarchy Map which is presented as the Complex Purpose Format version of the Appchain Jurisdictions.

Concerning the operation of LIZARD to convert the Upgraded Purpose Map into New Proposed Changes, the Upgraded Purpose Map exists in Complex Purpose Format and is submitted to Iterative Expansion of PM, wherein the input data is received from PM, and is transferred to Logical Derivation of SM, wherein Logic Derivation derives logically necessary functions from initially simpler functions and the produced result is a tree of function dependencies that are built according to the defined Complex Purpose Format data, wherein PM invokes SM to produce the resultant Appchain Syntax version of the input Upgraded Purpose Map via Code Translation.

Concerning the operation of LIZARD to convert Appchains to Create into a Logistics Layer, wherein Appchains to Create is submitted SM, wherein Logical Reduction from SM submits it's output to Iterative Interpretation from PM, wherein Iterative Interpretation loops through all interconnected functions to produce an interpreted purpose definition by referring to Purpose Associations, wherein the output is labeled as a Logistics Layer which is presented as the Complex Purpose Format version of Appchains to Create and further codified into a Logistics Layer format, wherein the Logistics Layer is a macro arrangement of the syntax whilst the Complex Purpose Format defines the micro arrangement of the syntax.

Concerning the operation of LIZARD to convert the OC3 Map into an Appchain Syntax Map, the OC3 Map exists in Complex Purpose Format and is submitted to Iterative Expansion of PM, wherein Iterative Expansion adds detail and complexity to evolve a simple goal into a specific complex purpose definition, wherein the input data is received in Complex Purpose Format from PM and is transferred to Logical Derivation of SM, wherein Logic Derivation derives logically necessary functions from initially simpler functions and the produced result is a tree of function dependencies that are built according to the defined Complex Purpose Format data, wherein the resultant Appchain Syntax Map unit that is terminally produced by Code Translation is the modular output of SM, OC and LIZARD.

Concerning the operation of LIZARD 120 to convert Fulfilled Appchain into the Purpose Hierarchy Map, Fulfilled Appchain is submitted to SM, wherein Logical Reduction from SM submits it's output to Iterative Interpretation from PM, wherein the output is labeled as a Logistics Layer which is presented as the Complex Purpose Format version of Fulfilled Appchain.

Concerning the operation LOM and CTMP in regards to New Appchain Development (NAD), the Creative Design Principles, Selected Map Segment, and OC3 Map are supplied as initial input to the Creative Variance Invocation Prompt (CVIP), which produces a Prompt that interacts directly with LOM to invoke the production of the Confident Security Assertion with consideration of the input criteria Theory of Security, Unconfirmed Security Information, and Confirmed Security Knowledge, wherein the Prompt is submitted to the Initial Query Reasoning (IQR) module of LOM, wherein the Prompt is analyzed via invocation of Central Knowledge Retention (CKR), wherein the resultant Missing Details produced by IQR are submitted as modular input to Survey Clarification (SC) that engages with the origin of the Prompt to retrieve supplemental information, wherein SC engages with DIP to retrieve supplemental information concerning the Prompt, wherein the version of the Prompt from SC is submitted to AC, which attempts to form a coherent response to the Prompt by referencing CKR directly and also via Hierarchical Mapping (HM), wherein AC provides a Response Presentation to RA concerning the assertion produced by AC, wherein the produced assertion is classified as a Pre-Criticized Decision, wherein CTMP produces a Post-Criticized Decision, wherein the initial Pre-Criticized Decision and Post-Criticized Decision are submitted to the Decision Comparison (DC) which determines the scope of potential overlap between the two inputs.

Modular outputs produced from IQR, SC, AC, HM and KV are submitted to the LOM Modular Log Collection (LMLC) that combines the input log data into a single readable file referenced as LOM Log Aggregate, which is submitted to CC of Rational Appeal (RA), wherein the Pre-Criticized Decision is presented as modular output from AC and marked as a Subjective Opinion, wherein Input System Metadata is submitted for processing to Reason Processing and to RP2, wherein Reason Processing will logically understand the assertions being made by comparing property attributes and RP2 parses the Input System Metadata from LOM to produce a perception in Perception Complex Format (PCF), which is submitted to POE, wherein Reason Processing invokes Rule Processing which eventually produces rulesets that reflect the SPMA algorithm.

Concerning operation of POE, the operation of Metric Processing and System Metadata Separation (SMS) both lead to the production of Perceptions, wherein the resulting Perceptions represent LOM's response of producing the Purpose Replacement via AC, wherein RP2 produces a Comparable Variable Format data point which is fed into SS as search criteria, wherein the Results of the execution SS are produced which leads to a Weight Calculation which attempts to find the correct distribution of corresponding Perceptions from PS to replicate and match the Comparable Variable Format which represents the execution of the LOM that produced Creative Potential Unit, wherein the Weight Calculation completes to lead to the Application of the Perceptions to make an active Approve or Block decision, wherein the Creative Potential Unit produced by LOM and corresponding LOM Log Aggregate undergo Data Parsing which causes Data Enhanced Logs to be derived which are applied in the Application to achieve an Interpretation Dichotomy of a Positive Sentiment (Approve) or Negative Sentiment (Block) with regards to the input Creative Potential Unit, wherein upon successful conclusion of the execution of Application leads to an Override Corrective Action which is processed by CDO in parallel to the output of RE, wherein SCKD estimates the scope and type of potential unknown knowledge that is beyond the reach of the reportable LOM Log Aggregate.

Concerning the Memory Web process that operates in parallel to the execution of POE, the Creative Potential Unit produced by LOM is submitted as modular input to Reason Processing that processes how LOM achieved the decision to produce the Creative Potential Unit in response to the Prompt provided by CVIP, wherein CRSE leverages known Perceptions to expand the ‘critical thinking’ scope of the rulesets, wherein the Correct Rules are submitted to Rule Syntax Format Separation (RSFS) from within the operating jurisdiction of Memory Web, wherein RSFS separates and organizes Correct Rules by type, wherein Chaotic Field Parsing (CFP) combines and formats the LOM Log Aggregate into a single scannable unit referenced as the Chaotic Field that is submitted to MR, wherein MR receives the Original Rules which is the execution result from RSFS and scans the Chaotic Field provided by CFP to recognize knowable concepts defined in Original Rules producing Recognized Rule Segments, wherein RFP receives individual parts of the Original Rules that have been tagged according to their recognition or lack-thereof within the Chaotic Field by MR and RFP logically deduces which whole ruleset (the combination of all of their parts) have been sufficiently recognized in the Chaotic Field to merit processing by RE, wherein conclusion of the execution of RE leads to an Override Corrective Action processed by CDO in parallel to the output of POE.

Concerning the operation of LIZARD to convert Syntactical Creative Solutions into a Purpose Hierarchy Map, wherein Syntactical Creative Solutions is submitted to SM, wherein Logical Reduction from the Syntax Module (SM) submits it's output to Iterative Interpretation from PM, wherein Iterative Interpretation loops through all interconnected functions to produce an interpreted purpose definition by referring to Purpose Associations, wherein the output is labeled as a Logistics Layer which is presented as the Complex Purpose Format version of Syntactical Creative Solutions.

Concerning Enhanced Framework Development (EFD), the Efficiency Design Principles, Stability Design Principles, and Hardware Purpose Map are supplied as initial input to the Deduction Invocation Prompt (DIP) that produces a Prompt, which is submitted to IQR, wherein the provided Prompt is analyzed by CKR to decipher Missing Details from the Prompt, wherein the resultant Missing Details are submitted to SC that engages with the origin of the Prompt to retrieve supplemental information, wherein the version of the Prompt produced from SC is submitted to AC that attempts to form a coherent response to the Prompt by referencing CKR directly and also via HM.

Concerning the invocation of RP2 within CTMP, LOM produces the Ideal Framework Structure by invoking AC, wherein the Ideal Framework Structure is then submitted to RP2 which unpacks the data to produce instances of a Debugging Trace and Algorithm Trace, wherein RP2 transfers the data concerning the produced perception result to POE.

Concerning ID of CTMP, the Applied Angles of Perception from PS are submitted ID to produce more Perceptions that belong to Implied Angles of Perception, wherein Metric Combination separates the received Angles of Perception into categories of metrics, wherein the input Angles of Perception are related to the Ideal Framework Structure, wherein the Metric Complexity Set A is submitted to ME, wherein upon enhancement and complexity enrichment completion, the metrics are returned as ME output as Metric Complexity Set B and thereafter converted back into Angles of Perception to be stored in Implied Angles of Perception, wherein the Metric Complexity Set B C737 is processed by Metric Conversion which reverses individual metrics back into whole Angles of Perception.

Concerning the operation of LIZARD to convert Refined Framework Structure Interpretation into an Ideal Framework Purpose Map, Refined Framework Structure Interpretation is submitted to SM, Logical Reduction from SM submits it's output to Iterative Interpretation from PM, wherein Iterative Interpretation loops through all interconnected functions to produce an interpreted purpose definition by referring to Purpose Associations, wherein the output is labeled as a Refined Framework Purpose Map.

Concerning Need Map Matching (NMM), the NMM instance is spawned to serve the operation of Enhanced Framework Development (EFD), wherein upon the invocation of NMM, Initial Parsing downloads each jurisdiction branch from Storage to temporarily retain for referencing within the ongoing NMM instance, wherein with Calculate Branch Needs: according to definitions associated with each branch, needs are associated with their corresponding department, wherein the Symmetry Processing Result is provided as an Input Purpose as input to the Search Algorithm of NMM, wherein the Search Algorithm references and searches through the compiled Need Index whereby determining if the Input Purpose defines a valid need according to the jurisdiction branches initially defined in Need Access Development and Storage, wherein the completed execution of the Search Algorithm via the Need Index produces an Approve/Block response which is submitted as modular output from NMM and referenced as the Need Result.

Concerning the invocation of Raw Perception Production (RP2) within CTMP, LOM produces the Ideal Framework Structure by invoking AC, wherein the Ideal Framework Structure is then submitted to RP2 which unpacks the data to produce instances of a Debugging Trace, wherein RP2 transfers the data concerning the produced perception result to POE.

Concerning the operation of LIZARD to convert Ideal Hardware Configuration into a Purpose Hierarchy Map, Ideal Hardware Configuration is submitted to SM, wherein Logical Reduction from SM submits it's output to Iterative Interpretation from PM, wherein Iterative Interpretation loops through all interconnected functions to produce an interpreted purpose definition by referring to Purpose Associations, wherein the output is labeled as Purpose Hierarchy Map which is presented as the Complex Purpose Format version of Ideal Hardware Configuration.

Concerning operation of Need Map Matching (NMM), NMM is spawned to serve the operation of External Instruction Middleware (EIM), wherein Initial Parsing downloads each jurisdiction branch from Storage to temporarily retain for referencing within the ongoing NMM instance, wherein with Calculate Branch Needs: according to definitions associated with each branch, needs are associated with their corresponding department, wherein Input Purpose is provided as input to the Search Algorithm of NMM, wherein the Search Algorithm references and searches through the compiled Need Index, whereby determining if the Input Purpose defines a valid need according to the jurisdiction branches initially defined in Need Access Development and Storage, wherein the Search Algorithm produces an Approve/Block response, wherein the Need Result is returned back within EIM processing as Instruction Isolation Readiness.

Regarding operation and functionality of the Appchain Emulation Layer (AEL) and production of a Precompiled Application Stack (PAS) via Static Appchain Processing (SAP), SAP interprets the corresponding Appchain contents, produces Static Appchain Retention and submits it to PAS, wherein AEL is compiled and embedded into PAS, therefore giving the PAS instance autonomy within Legacy Systems, wherein Target System Interpretation and Detection (TSID) of AEL executes in a preliminarily basic instruction-set and seek to detect the Operating System, Device Drivers and Hardware of the Target System, wherein AEL would invoke the adequate translation mechanism to run complex code on the Target System, enabling the Static Appchain Retention to be fully executed, wherein the Retention contains the Appchain Execution Segments and Data Segments for the targeted Appchain, along with other Appchains the targeted Appchain depends on for operation.

SAP produces a Static Appchain Retention instance that contains the targeted Appchain, wherein the Static Appchain Retention is submitted to the Execution and Data Segment Extraction (EDSE) of AEL, wherein EDSE is a container module for the invocation of Execution Stream Collection (ESC) and for the invocation of Data Stream Sorting (DSS), wherein the Target System is interpreted by the Target System Interpretation and Detection (TSID) module via consideration of the static Target System Library Collection that defines the appropriate Instruction Sets that are applicable to various System types, wherein TSID produces the Target System Instruction Set which enables the internal operation of AEL to submit the correct computational instructions to the Target System, wherein Execution Segment Translation (EST) is invoked to interpret the Target System Instruction Set which therefore translates the Appchain Syntax into the appropriate legacy instructions, wherein Data Segment Translation (DST) is invoked to interpret the Target System Instruction Set which translates the Appchain Syntax into the appropriate legacy segments of data, wherein the modular outputs of EST and DST are submitted to Legacy Instruction Unification (LIU, which invokes a live instance of Execution Stream Rendering (ESR) to render the Static Appchain Retention according to the defined Target System Instruction Set.

Regarding operation of External Instruction Middleware (EIM), the operation of the Static Appchain Retention within ESR instance of the Legacy Instruction Unification (LIU) causes LIU to produce the External Instruction Proposition and the Instruction Isolation Readiness index as modular output, wherein the Outputs are submitted to EIM, wherein LIZARD is invoked to convert the External Instruction Proposition into a Purpose Hierarchy Map, wherein Purpose Realignment Processing (PRP) in invoked for modular inputs Instruction Purpose Collection and Purpose Hierarchy Map, Wherein Master/Slave Affinity defines the Instruction Purpose Collection as the slave, wherein PRP produces the new iteration of the Instruction Purpose Collection, wherein LIU is invoked to produce Instruction Isolation Readiness via the Need Map Matching (NMM), wherein the Readiness variable defines if the Instruction Purpose Collection is isolated enough within the Target System to be executed without interference of alternate execution syntaxes, wherein Prompt is activated which evaluates if the Instruction Isolation Readiness variable indicates that the Instruction Purpose Collection can be deployed to the Target System, wherein if the response to Prompt is Deployment Not Ready, then Stage is activated which suspends execution of EIM until the next External Instruction Proposition is produced by ESR via LIU, wherein if the response to Prompt is Deployment Ready, then LIZARD in invoked to convert the Instruction Purpose Collection to the corresponding Syntax defined by TSID.

Regarding the operation of SAP, a Proposed Appchain Collection is produced from the Administrative Interface, wherein Execution and Data Segment Collections are produced from the references of the Proposed Appchain Collection, wherein the Proposed Appchain Collection is processed by ESR from within the Modified Catch Environment (MCE) which is a custom execution environment that installs trigger points for various events, so that way dependency and debugging information can be derived from the execution session, wherein the Dependency Request Fulfillment (DRF) is invoked within SAP in conjunction with MCE, wherein an Execution or Data Request is made by ESR, wherein the Execution and Data Segment Collections are evaluated to determine if the Execution or Data Request made by ESR exists in such Collections, wherein if the response to Prompt is Does Exist, then Prompt is invoked which evaluates if the corresponding Execution or Data Segment is justified according to NMM.

The Proposed Appchain Collection is submitted separated into independent Appchain References that are subsequently stored in Appchain Reference Cache Retention (ARCR), wherein a Loop that cycles through all of the Appchain Instances within ARCR is spawned, wherein the selected Appchain Instance is retrieved from a relevant Cache Node from the BCHAIN Network and via the BCHAIN Protocol, wherein the Fulfilled Appchain Instance is produced and processed via invocations of ESC and DSS.

A Content Claim Request (CCR) with a Proposed Baseline Hop Pathways (PBHP) is produced, wherein CCR is submitted on the BCHAIN Network so that it eventually reached a corresponding Cache Node that contains parts of the requested Appchain Instance, wherein the Cache Node fulfills the CCR, thereby getting eventually compensated economically via BCHAIN Protocol and by leveraging the Watt Economy of the Metachain, wherein the Cache Node produces a corresponding Content Claim Fulfillment (CCF) unit in response to the corresponding CCR, wherein the newly produced CCF travels along the BCHAIN Network to reach the Content Claim Rendering (CCR) module of the Node that is processing the SAP instance, wherein Content Decoding Instructions are referenced to render the CCF response, which produces the Fulfilled Appchain Instance.

Regarding DRF within SAP, the Does Exist response to Prompt invokes checking if the corresponding Execution or Data Segment is Justified according to NMM, wherein if the Justified response to Prompt occurs, then the Execution or Data segment is marked for inclusion in the Marked Segment Cache Retention (MSCR), wherein the Does Not Exist response, and the Not Justified response generates and submits a Diagnostic Log Unit (DLU) that contains an Official System Token, wherein the Token is included to indicate that the corresponding function or program has reached a non-ideal state if an official function within the UBEC Platform, wherein DLU is submitted to DLS, which is invoked by ARM to supply DLU to SPSI whereby SPSI is able to process the diagnostic information found in DLU with DLUA.

SAP is invoked by an UBEC User or Generic User via an Administrative Interface, wherein a Proposed Appchain Collection is received, wherein a Loop cycles through all of the Appchain Instances from Appchain Reference Cache Retention (ARCR), wherein the Fulfilled Appchain Instance is retrieved from Marked Segment Cache Retention (MSCR), Fulfilled Appchain Instances contain the full set of Execution and Data Segments required to execute the chosen Appchain, wherein all of the Fulfilled Appchain Instances are incrementally installed into the Static Appchain Retention, which each outgoing Execution or Data Segment being verified for having Marked status by MSCR, wherein Static Appchain Retention is produced as the final modular output of SAP, and is thereafter submitted as modular input to EDSE of AEL.

Regarding Cryptographic Digital Economic Exchange (CDEE) and it's dependency module LUIGI, the core module of Neuroeconomic Metaphysical Contentment (NMC) is Comprehensive State Evaluation (CSE) that monitoring and regulation, conducted via Fund Movement Oversight (FMO) of funds moving to an App Public Funds Allocation (APFA), which belongs to the designated UBEC App that has been selected for investment by the relevant Endowment Structure (ES), wherein Cryptographic access to the funds held in APFA are maintained via BCHAIN Nodes, wherein BD and ID from ES have access to the Fund Recovery Mechanism (FRM) of LUIGI.

Regarding LUIGI operating as an Appchain within the UBEC Platform, invocations of LUIGI regulates Watt Unit movement and provides assurance of Watt Unit allocation safety within CDEE, wherein UBEC Passthrough receives data transfer information from Appchains whereby traffic and activity within CDEE is inherently linked to the UBEC Passthrough hook, wherein LUIGI Task Delegation (LTD) determines if the incoming data from the UBEC Passthrough should be processed by LIZARD, LOM or both, wherein invocation of the LIZARD Appchain indicates the ‘Jurisdictional Enforcement and Intention Reader’ processing mode has been selected, wherein invocation of the LOM Appchain indicates the ‘Knowledge Inquiries and Judicial Arbitration’ processing mode has been selected, wherein the logic flow continues to Dynamic API Customization (DAC), wherein the function of DAC is to interpret the Task Type and therefore customize the interface of the selected API to the selected Task Type, wherein the corresponding algorithms LOM and LIZARD are executed as they are invoked, therefore producing analytical results which are sent to Intelligent Conclusion Unification (ICU), wherein ICU reconciles any interpretive/subjective conclusions between LOM and LIZARD.

The CSE output Ideal Investment Decision Makeup is received via the UBEC Passthrough, wherein LUIGI perceives that the Makeup acts as a Container of numerous sub-element Investment Allocations, Investment Withdrawals, Profit Allocations, and Director Notification, wherein LUIGI Task Delegation (LTD) delegates the corresponding data output Makeup to be analyzed by the appropriate LUIGI branches of analysis: Knowledge Inquiries and Judicial Arbitration (LOM), and Jurisdictional Enforcement and Intention Reader (LIZARD).

Concerning Appchains interacting with LUIGI, the UBEC Platform is manifested as an Appchain with the UBEC Appchain, which links to the UBEC Passthrough to provide modular data input to LUIGI, wherein upon LUIGI's processing conclusion, the UBEC Comprehensive Return sends the data back to the UBEC Appchain, wherein LOM acts as the core Appchain to enable processing within the Knowledge Inquires and Judicial Arbitration branch, wherein LOM and LIZARD feed API customization information to Dynamic API Customization (DAC), which has access to the appropriate API information to perform the relevant customizations of the logic process as needed depending on which Appchain is invoked, wherein SPSI monitors, maintains and upgrades the composition and operation of LUIGI.

Concerning DAC, LIZARD Usage API is provided within the operation of DAC, wherein LTD determines the Task Type which is defined in Task Reception and the provided Task Type indicates the customization scope to DAC providing Modular Instruction-Set which is provided to the selected Branch, wherein the Modular Instruction-Set is programmed in accordance with the LIZARD Usage API, wherein LIZARD is executed to fulfill the two inputs, wherein Intelligent Conclusion Unification (ICU) reconciles multiple outputs from different Module Executions to guarantee a singular unified output of the Branches whereby allowing for simplified input reception of LUIGI Corrective Action (LCA).

Concerning DAC, the LOM Usage API is provided within the operation of DAC, wherein LTD determines the Task Type which is defined in Task Reception, wherein the Task Type is interpreted within DAC producing the Modular Instruction-Set which is provided to the selected Branch, wherein the Modular Instruction-Set is programmed in accordance with the LOM Usage API, wherein LOM is executed to fulfill the two inputs, wherein ICU reconciles multiple outputs from different Module Executions to guarantee a singular unified output of the Branches allowing for simplified input reception of LCA.

Concerning currency liquidity manipulation functions that belong exclusively to LUIGI in Financial Liquidity Manipulation, wherein inside LSE is a Retention Decryption Key which allows LUIGI to decrypt the Encrypted Retention of Private Keys allowing the Fund Manipulation Mechanism (FMM) to manipulate funds on the Watt Economy of the Metachain in a fund recovery session, wherein Proof of Authority is a unique cryptographic key that is cryptographically guaranteed to be only produceable by LUIGI due to LSE logistics, wherein Proof of Authority is used to invoke an UBMA Chip to supply it's Security Sensitive Unique Private Key.

BD and ID interact with DVM via the Proposal Voting Interface (PVI), wherein an Authorized Proposal is submitted by a Director, wherein with ID, Proposals are effectively treated as commands within ES due to their being only a sole Director and no consensus dilemma, wherein New Director Admission entails the Board's potential acceptance of a new Director, wherein Proposal is only applicable to BD and not ID, wherein the applicability of New Director Admission depends on policy defined in EPR, wherein votes performed by the Directors via DVM to modify a pre-existing Policy are effective votes towards a coupled pair of Proposals, Policy Rule Addition and Policy Rule Deletion that are treated like a single unit, wherein Manual Override Measure Addition introduces a new custom rule to Override Measure Retention (OMR), which influences the Ideal Investment Decision Makeup produced by CSE, wherein if two ES were generated at the exact same time, both with an identical OMR, then they will theoretically receive the exact same Ideal Investment Decision Makeups from CSE.

Regarding Preliminary Thread Initiation (PTI), the CSE Invocation Interval is retrieved from the Established Policy Retention (EPR), wherein Interval defines how often the relevant ES intends for a CSE instance to be spawned, wherein a smaller Interval implies that the EPR indicates that more Watt Units should be spent on BCHAIN Fees to host more iterations of CSE instances, wherein the time of the CSE Last Invocation is retrieved from a store of value defined in EPR, wherein the CSE Last Invocation value is a specific variable that is related to the specified BD or ID, wherein upon the successful funding of the relevant BCHAIN Nodes from the corresponding Investment Capital (IC), whether Automated Override Measure Manipulation (AOM2) has been flagged for invocation in the corresponding EPR of the relevant ES is assessed, wherein ES can opt to have AOM2 enabled if a specified Target Mind is intended to guide the investment decisions performed by CSE.

AOM2 emulates the reactionary criteria of a Target Mind, which has been identified via AOM2 Target Mind Identity, to enact, modify, or remove Override Measures enacted from the Override Measure Retention (OMR) of a relevant ES, wherein the practical effect of the operation of AOM2 is that the relevant ES contains an OMR that is conducive to the reactions and tendencies expected of the Target Mind, wherein the resultant makeup of OMR influences the Target Investment Circumstances produced by Target Investment Circumstances Interpretation (TICI) and therefore the Ideal Investment Decision Makeup produced by CSE, wherein the TICI Results Cache is decompressed and extracted to produce the Target Investment Circumstances as originally processed by TICI, wherein Current Stake Position is retrieved from Portfolio Stake Retention (PSR), wherein all of the currently active Override Measures from OMR are retrieved and produced as Active Override Measures, wherein all of the previously processed variables Active Override Measures, Current Stake Position, Target Investment Circumstances, and AOM2 Target Mind Identity are accumulated, wherein upon accumulation, the aforementioned variables are supplied to Mind Emulation Request Module (MERM) to invoke instances of Digital Mind Tracking (DMT).

MERM is invoked to produce a Mind Emulation Request to DMT that DMT uses CTMP to emulate the Target Mind represented by the AOM2 Target Mind Identity therefore producing the Mind Perception Result, which is sent back to MERM, wherein MERM invokes multiple instances of DMT as needed to accurately produce the final result Preferred Override Measures, which represents Override Measures that are expected to be selected and hence preferred by the specified Target Mind.

Consensus based decisions to invest in intelligent investment prediction services are made an ES, wherein ES funds the prediction service, Comprehensive State Evaluation (CSE), via IC, wherein CSE is invoked according to the CSE Invocation Interval which is defined in the Established Policy Retention (EPR), wherein computational work is done across BCHAIN Nodes that operate the BCHAIN Protocol, thus forming the BCHAIN Network, wherein the manipulation of funds that are strategically allocated within the relevant IC accrues the Watt Economy of the Metachain, wherein funds never cryptographically exist directly within the IC instance itself, but instead are pledged via WUP2 by BCHAIN Nodes that hold the funds whereby all Watt Units are managed by the Watt Economy whilst cryptographically residing on physical BCHAIN Nodes.

CSR manages information reports performed by registered corporate entities that submit operational information to their corresponding Corporate Entity Tracking Appchain, which enables Comprehensive State Evaluation (CSE) to consider the operational activity of all registered corporate entities in processing ES, wherein a corporate entity is ‘registered’ in the sense that it has opted to announce key elements of recorded data relating to it's operational activities to the Corporate Entity Tracking Appchain, wherein Content Claim Generator (CCG) is a function of the BCHAIN Protocol that enables content to be retrieved from various BCHAIN Nodes, wherein Customchain Recognition Module (CRM) is a function of the BCHAIN Protocol, which automatically maintains Appchains that are defined in Registered Appchains, wherein Error Report in the form of a DLU is forwarded by ARM to SPSI) which processes the Error Report via the Diagnostic Log Unit Analysis (DLUA), wherein the Error Reporting feedback loop with SPSI leads to the programming of CSR to eventually change, to accommodate proven solution to the initial Error Report demonstrated by the DLU following the concept of SRIA, wherein MRP is initiated by the operation of CSE via RIP that invokes an instance of LOM which researches Market Activity and Events via ARM, wherein initially ARM retrieves unconfirmed information from public and private sources and thereafter LOM and CTMP verify the unconfirmed information and expand on it to produce truthful concepts.

Regulatory/Tax Research Procedure (RTRP) is initiated by the operation of CSE via RIP that invokes an instance of LOM which researches Tax and Regulatory Codes via ARM, wherein initially ARM retrieves unconfirmed information from public and private sources and thereafter LOM and verify the unconfirmed information and expand on it to produce truthful concepts.

TICI extracts the Portfolio Stake Makeup of the relevant Portfolio Stake Retention (PSR) of the corresponding ES, wherein Override Measures are extracted from the relevant Override Measure Retention (OMR) of the corresponding ES, wherein Override Measures induce an intended customization effect to the resultant Ideal Investment Decision Makeup via DVM, wherein the information contained in Portfolio Stake Makeup and Override Measures are merged in an Abstraction Container which becomes Target Investment Circumstances, which is submitted to CSE, wherein upon completed invocation of LOM and CTMP; Ideal Investment Decision Makeup is produced by CSE, wherein LOM produces Market Activity Knowledge from CKR, wherein LOM is invoked to produce such Knowledge by the NMC Knowledge Invocation Prompt (NKIP).

Target Investment Circumstances are supplied to the Idealistic Configuration Invocation Prompt (ICIP), wherein Prompt produced by ICIP 12403 is submitted to IQR of LOM, wherein the provided Prompt is analyzed by CKR, wherein NMM is spawned to serve CSE, wherein the Wholistic Situation State is submitted for storage in Need Access and Development and Storage, wherein the Wholistic Situation State is broken down into sub-categories and retained in Storage as a series of hierarchal branches and layers, wherein Artificial Security Threat (AST) provides an Input Purpose to the Search Algorithm of NMM, which references and searches through the compiled Need Index, therefore determining if the Input Purpose defines a valid need according to the jurisdiction branches initially defined in Need Access Development and Storage.

Preliminary Thread Initiation (PTI) initiates an instance of the Target Investment Circumstances Interpretation (TICI) that produces the Target Investment Circumstances to the Internal Processing mechanism of CSE, wherein the Refined Investment Decision Makeup is unpacked to it's individual elements, wherein the Stake Makeup gets assimilated into the Target Investment Circumstances, Investment Decision Actuation (IDA) executes the provided Individual Elements to perform the intended consequences towards the relevant ES.

Concerning the operation of Digital Mind Tracking (DMT), Target Behavior Recording (TBR) receives Behavior Data Set (BDS) information directly from the specified Target Mind, and also neurological mapping associations made by the Neurologic Mapping Enhancement (NME), wherein BDS contains information concerning Actions, Statements and Metadata concerning the Target Mind, wherein the BDS instance is supplied DMT, and normalized via LIZARD which converts it from it's syntax format to purpose format, whereby a Behavior Purpose Map is constructed from the BDS instance by LIZARD, wherein the Behavior Purpose Map is stored and retained in a Personal Intelligence Profile (PIP) instance that is logistically associated with the Target Mind, wherein LOM is invoked to produce Personality Template Types, wherein a Personality Template Makeup is produced from the Personality Template Fulfillment (PTF), wherein a Personality Template Makeup captures personality elements that exists from Personality Template Types according to the Personality Template Criteria of the Target Mind, wherein LOM is invoked to produce the Personality Nuance Definition that corresponds with the Target Mind from the corresponding PIP instance.

PTF initiates a Loop to cycle through each of the Personality Template Criteria, wherein the Selected Personality Template Criteria from the Loop Iteration retrieves the corresponding Personality Template Types according to the Personality Template Types that are referenced within the Selected Personality Template Criteria producing the Selected Personality Template Type which is assigned according the Magnitude of presence defined in the Selected Personality Template Criteria producing the Personality Template Makeup, wherein LIZARD converts the Personality Nuance Definition into a Purpose Hierarchy Map, wherein LIZARD converts the Personality Template Makeup into a Purpose Hierarchy Map, wherein both Purpose Hierarchy Maps are processed by the Purpose to Purpose Symmetry Processing (P2SP) that determines the congruency/compatibility between both inputs, therefore producing the Symmetry Processing Result.

The Target Mind Identity of the Target Mind is retrieved and the Personality Snapshot Cache Retention (PSCR) instance which is associated with the Target Mind Identity is retrieved, wherein if there is a previous iteration of the Personality Reaction System that is stored in the PSCR instance that matches the Defined Time Era is checked, wherein the Defined Time Era is referenced from the Target Mind Identity, wherein the Defined Time Era can make distinctions between older and newer versions of people as they were, if yes, the previous iteration of the Personality Reaction System is deleted from the PSCR instance, wherein the next step converts, stores and retains the current Personality Reaction System into the PSCR instance that is associated with the Target Mind of the Defined Time Era according to the Target Mind Identity.

A Customized Command Set is submitted to ESR which instructs it to extract the Appchain contents of CTMP without any pre-existing data producing an Empty CTMP Execution Base, which is a snapshot capture of the ESR instance, wherein the Empty CTMP Execution Base is rendered in a new instance of ESR, wherein the rendered Custom CTMP Appchain interacts with the Personality Reaction System capturing the Personality of the Target Mind in the Custom CTMP instance, wherein a Customized Command Set is submitted as an instruction to the ESR instance to commit all changes to persistent storage and the Custom CTMP Instance is effectively captured to a CTMP Snapshot Appchain Retention file, wherein a set of Relevant Emulation Scenarios is produced via the Emulation Scenario Production (ESP), wherein ESP produces Relevant Emulation Scenarios that are relevant towards the scope, jurisdiction and capabilities of the Personality Reaction System, wherein a Loop is initiated which iterates through the Relevant Emulation Scenarios producing a single unit Selected Emulation Scenario per iteration of the Loop, wherein the Selected Emulation Scenario is unpacked to produce the two main variables it contains: the Emulation Proposition and the Emulation Environment, wherein the Emulation Proposition is submitted to the Custom CTMP instance as Input System Metadata and the Emulation Environment is submitted as Logs to the Custom CTMP instance with the Objective Fact classification.

Regarding Neuroeconomic Mapping Enhancement (NME) that which associates Neural Patterns of the Target Mind with physical states of existence that are captured in Target Circumstantial State, Unobtrusive Neural Scanning Device (UNSD) receives a Raw Neural Pattern from the Target Mind that is acting in it's capacity as an UBEC User, wherein the Target Mind being an UBEC User enables internal standardized API communications to be made via the BCHAIN Network to the UNSD, wherein the Raw Neural Pattern of the UBEC User is received via UNSD, wherein LOM reports on the Target Circumstantial State and Confidence of the UBEC User via the corresponding PIP and the Life Administration Automation (LAA), wherein LOM produces the Target Circumstantial State based on data provided by PIP, which retains personal information concerning the target UBEC User and LAA, which connects the digital lifestyle of the UBEC User, wherein LOM produces Neural State Association Knowledge, which represents learned correlations between potential Neural State and potential Circumstantial State, wherein Neural State Association Knowledge Confidence correlates with the algorithmic confidence LOM has in regards to the accuracy and reliability of Neural State Association Knowledge, wherein LIZARD converts Neural State Association Knowledge into a Purpose Hierarchy Map.

Regarding SPSI in addition to AEL, programming and reconfiguring Methodology of Perpetual Giving (MPG) into NMC, SPSI runs in the Legacy System via AEL) that enables SPSI to access and manipulate elements that exist and operate within the Legacy API and Framework, wherein SPSI performs efficiency and functionality upgrades, maintenance, and general modifications to MPG producing NMC, wherein SPSI is an Appchain within the BCHAIN Network, wherein SPSI converts NMC as a Legacy Program to NMC as an Appchain via invocation of the Customchain Ecosystem Builder (CEB).

### BRIEF DESCRIPTION OF THE DRAWINGS

FIG. 1 shows the information ecosystem with it's respective submodules/dependencies that make up the UBEC Platform;

FIG. 2 shows details of Third Party Applications and Services and Third Party Algorithms;

FIG. 3 shows automated deployment mechanism for deploying UBEC platform;

FIG. 4 shows Deployment Routine A, which is optimized for Apple iOS devices;

FIG. 5 shows Deployment Routine B, which is optimized for Google Play Store;

FIG. 6 shows Deployment Routine C, in which direct Hardware Specification are referenced by SPSI to produce Interface Drivers;

FIG. 7 shows a use case example of Layman User interacting with the UBEC Platform for the first time;

FIG. 8 shows the user operating a smartphone that runs the UBEC Platform natively as an Operating System;

FIG. 9 shows the detailed logic flow of the Automated Phone Call Process as performed by LOM via the UBEC Platform and the BCHAIN Network;

FIG. 10 shows LOM as an Appchain operating multiple functions to manage personal health as an artificially intelligent personal assistant;

FIGS. 11 and 12 show that UBEC Passthrough receives information traffic that is occurring from UBEC as an Appchain;

FIGS. 13 and 14 show how both the LIZARD Usage API and LOM Usage API usage specifications are defined by the Appchains themselves;

FIG. 15 shows currency liquidity manipulation functions that belong exclusively to LUIGI;

FIG. 16 shows the functionality of LUIGI to perform Verification of Submission+Maintenance of Appchains;

FIG. 17 shows the functionality of LUIGI to perform Verification of Contractual Conditions;

FIG. 18 shows the functionality of LUIGI as Conflict Resolution Appeal System;

FIG. 19 shows the capability of LUIGI concerning User Node Interaction with Virtual Obfuscation Behavior Monitoring;

FIG. 20 shows the functionality of LUIGI concerning Appchain Merge Followup Verification;

FIG. 21 shows the functionality of LUIGI concerning Lost Fund Recovery & Fraudulent Activity Reversal;

FIG. 22 shows the functionality of User Node Interaction (UNI);

FIG. 23 shows that the amount of biometric data provided is measured and checked if sufficient for the authentication process;

FIG. 24 shows that the Band and Node Association Appchains are updated to the latest version from the Customchain Ecosystem via the BCHAIN Protocol;

FIG. 25 shows that successful authentication only occurs if a sufficient amount of Band Authorization Tokens (BAT) match any single Authentication Token;

FIG. 26 shows Biometric Band Categorization (BBC);

FIG. 27 shows the base layer mechanics of Appchains which forms the Customchain Ecosystem;

FIG. 28 shows Customchain Ecosystems that are relevant to the UBEC Enabled Device in a basic form;

FIG. 29 shows the process of UBEC Application Development and Deployment;

FIG. 30 shows that the Internal CEB Logic Processing outputs Execution+Data Supplements;

FIG. 31 shows the steps that follow upon process completion of CEB;

FIG. 32 shows LOM operating as a series of Appchains known to be a Customchain Ecosystem;

FIG. 33 shows that UBEC Systemwide Logic represents the LOM Container Appchain interacting other Appchains within the UBEC Platform;

FIG. 34 shows how Central Knowledge Retention (CKR) exists as it's own independent Appchain;

FIG. 35 shows an instance of Personal Intelligence Profile (PIP) as an Appchain;

FIG. 36 shows how the LOM module Life Administration and Automation (LAA) exists as a parallel Supplemental Appchain;

FIG. 37 shows the Watt Unit Currency Algorithm;

FIG. 38 shows the mechanics of Watt Unit buying and selling with integration of user authentication via User Node Interaction (UNI);

FIG. 39 shows that FMO and the functions of LEI require knowledge and access to the User Private Fund Allocation (UPFA);

FIG. 40 shows the Cryptographic Digital Economy Exchange (CDEE);

FIG. 41 shows how UBEC Apps that are listed in the App Directory and Exploration (ADE) module can receive and send out liquidity in terms of investment;

FIG. 42 shows that UBEC App's interact directly with the UBEC User's User Private Fund Allocation (UPFA);

FIG. 43 shows the interaction between the UBEC Platform Interface (UPI) and Cache Work Acceptance (CWA);

FIG. 44 shows how CWSI references the Watt Economy of the Metachain;

FIG. 45 shows an overview of the BCHAIN Protocol (BP);

FIG. 46 shows how the BCHAIN Protocol operates with it's own hardware and the hardware of other BCHAIN Nodes;

FIG. 47 shows the paradigm of Node interaction that exists within the BCHAIN Network;

FIG. 48 shows how hash announcement exchange corroboration prevents a Rogue BCHAIN Node from participating in the BCHAIN Network;

FIG. 49 shows the basic traveling pattern of a CCR or CCF packet within the BCHAIN Network;

FIG. 50 shows two functions of the BCHAIN Network's Adaptive Intelligence in effect;

FIG. 51 shows a known ‘highway’ of recommended travel between multiple Sectors within the BCHAIN Network;

FIG. 52 shows Staggered Release Content;

FIG. 53 shows Live Stream Content;

FIG. 54 shows that Strategy Corroboration System (SCS) uses the Traffic Scope Consensus (TSC) module to derive a Dual Scope Hash collection;

FIG. 55 shows that Hash Announcements are shown being exchanged between three different traffic areas known as Sectors;

FIG. 56 shows the structure of Customchain Storage;

FIG. 57 shows that Node Statistical Survey (NSS) gathers information concerning the behavior of surrounding Nodes to calculate four major indexes;

FIG. 58 shows the details of Node Ping Processing (NPP);

FIG. 59 shows Strategy Corroboration System (SCS);

FIG. 60 shows that Traffic Scope Consensus TSC invokes NVP to receive Node Statistical Survey (NSS) variables and produce an NSS Variables Composite Average (NVCI);

FIGS. 61-63 show that Performance Factors are produced by NSS Variable Pooling (NVP) and rounded down to the nearest multiple X;

FIG. 64 shows Dynamic Strategy Adaptation (DSA);

FIG. 65 shows Strategy Performance Interpretation (SPI);

FIGS. 66 and 67 show the database structure of Strategy Performance Tracking (SPT), which operates as a Data Segment heavy Appchain;

FIGS. 68-70 show the detailed working of Optimized Strategy Selection Algorithm (OSSA);

FIG. 71 shows the Strategy Creation Module (SCM), which is invoked by Dynamic Strategy Adaptation (DSA);

FIG. 72 shows the various Criteria that makeup Strategy Criteria Composition;

FIG. 73 shows how SCM processes its modular input and out;

FIG. 74 shows how the Creativity Module is used to update the Strategy Criteria Composition;

FIG. 75 shows that the UBEC User accesses the UBEC Platform via biometric recognition performed at User Node Interaction (UNI);

FIG. 76 shows that Computation and Network Resource Availability (CNRA) is invoked, which grants reference to the Economic Incentive Selection (EIS);

FIGS. 77-79 show Diagnostic Log Submission (DLS);

FIGS. 80-83 shows Economic Incentive Selection (EIS) and Work Payment Claim Processing (WPCP);

FIGS. 84-169 demonstrate Data Integrity Management (DIM) functionality which operates with CSR, MNSCS and MFDR);

FIGS. 84-86 show logic of DIM;

FIGS. 87-88 shows Node Information Distribution;

FIGS. 89-91 show Appchain Merging;

FIGS. 92-93 show Customchain Ecosystem Version;

FIGS. 94-96 show details regarding the BCHAIN Nodes A/B/C;

FIG. 97 shows Merkle Tree Hashes;

FIGS. 98-100 show the process from contact between Appchain versions to Appchain Merge Processing (AMP);

FIGS. 101-106 show the logic for Conflicting Appchain Verification (CAV);

FIGS. 107-108 show processing within LMNV;

FIGS. 109-112 show the details on DC2;

FIGS. 113-115 show Metachain Retention Download (MRD);

FIGS. 116-118 show Information Search Sequence;

FIG. 119 shows Information Search Sequence Node Map;

FIG. 120 shows Low Priced Economic Authorization Token (EAT);

FIGS. 121-124 show Customchain Dilemma Interpretation (CDI);

FIGS. 125-127 show Proof of Dilemma Corroboration Sequence;

FIGS. 128-129 show Appchain Merge Processing (AMP);

FIG. 130 shows Block Unpacking Process (BUP);

FIG. 131 shows Retrospective Block Scope Consensus (RBSC);

FIGS. 132-136 show Appchain Merge Processing (AMP);

FIG. 137 shows Mining nodes Supplying Cache Seeding (MNCS);

FIG. 138 shows Tax Consequence Unit (TCU) Enforcement;

FIG. 139 shows Sector Tax Creation (STC);

FIG. 140 shows Tax Consequence Unit (TCU);

FIG. 141 shows Sector Tax Announcement (STA) with Jurisdictionally Implied CCF Submission (JICS);

FIGS. 142-143 show Sector Tax Reception (STR);

FIGS. 144-145 show Sector Tax Enforcement (STE);

FIG. 146 shows details Data Integrity Scanning (DIS);

FIGS. 147-150 show Data Refuge Processing (DRP);

FIGS. 151-155 show Sector Refuge Application (SRA);

FIGS. 156-158 show Self Node (Miner) process;

FIG. 159 shows Node Cache Compliance (NCC) process;

FIGS. 160-161 show Node Cache Verification (NCV);

FIG. 162 shows Seed Cache Pool Deletion (SCPD) process;

FIG. 163 shows Node Cache Provider (NCP);

FIG. 164 shows Node Cache Response (NCR);

FIGS. 165-166 show Node Cache Compliance Recording (NCCR);

FIG. 167 shows Compliance Event Log;

FIG. 168 shows NCCR;

FIG. 169 shows Data Migration Patterns FIGS. 170-358 provide details on Routing Logic which is the main core of BCHAIN Network;

FIGS. 170-173 show the process of Routing Logic (RL);

FIG. 174 shows the contents of CCF;

FIG. 175 shows Communications Gateway (CG);

FIGS. 176-180 show Cache Selection Algorithm (CSA);

FIGS. 181-184 show the process within Node Interaction Logic (NIL);

FIGS. 185-190 show the process for Legacy Network Bridging Mechanism (LNBM) and Node Interaction Logic (NIL);

FIGS. 191-193 show Customchain Interface Module (CIM);

FIGS. 194-198 show Mining Selection Algorithm (MSA);

FIGS. 199-203 show New Content Announcement (NCA);

FIGS. 204-206 show Node Storage Processing (NSP);

FIGS. 207-209 show Proposed Baseline Hop Generator (PBHG);

FIGS. 210-212 show Shortest Route Detection (SRD);

FIGS. 213-215 show Queued Information Broadcast (QIB);

FIGS. 216-218 show Broadcast Processor (BP);

FIGS. 219-221 show Best Hop Perception (BHP);

FIGS. 222-223 show Subsequent Target Advancement (STA);

FIGS. 224-228 show Hop Strategy Calculation (HSC);

FIGS. 229-232 show Proposed Baseline Hop Path Extraction (PBHPE);

FIGS. 233-235 show Recalculate Path (RP);

FIGS. 236-240 show Parallel Hop Logic (PHL);

FIGS. 241-244 show Parallel Hop Initiation (PHI);

FIGS. 245-247 show Over-Parallelized Hop Path Reduction (OPHPR);

FIGS. 248-251 show Content Claim Generator (CCG);

FIG. 252 shows Customchain Recognition Module (CRM);

FIGS. 253-254 show Cryptographic Entitlement Generator (CEG);

FIGS. 255-256 show Excluded Node Connection Discovery (ENCD);

FIGS. 256-258 show Best Node Selection (BNS);

FIGS. 259-261 show Location Association;

FIGS. 262-264 show Preliminary Target Selection (PTS);

FIGS. 265-267 show Microchain Bypass Consensus (MBC);

FIGS. 268-269 show Microchain Bypass Check;

FIGS. 270-276 show Content Claim Request (CCR);

FIG. 277 shows Economic Authorization Reversal Processing (EARP);

FIGS. 278-282 show Content Claim Fulfillment;

FIGS. 283-285 show Sector Crossing Event Processing (SCEP);

FIGS. 286-290 show TVS Creation Process (TCP) and TVS Decom-mission Process (TDP);

FIGS. 291-294 show Optimized Sector Route Discovery (OSRD);

FIGS. 295-297 show Intra-Sector Route Segment Producer (ISRSP);

FIGS. 298-299 show Wholistic Route Path Election (WRPE);

FIGS. 300-301 show Inter-Sector Route Bridge Producer (Inter-SRBP);

FIG. 302 shows Sector Interlacing Overview;

FIG. 303 shows Sector Interlacing Specified View;

FIG. 304 shows Route Segment Prioritization Logic (RSPL);

FIGS. 305-306 show Route Segment Bridging Logic (RSBL);

FIGS. 307-309 show Route Direction Orientation Designation (RDOD);

FIG. 310 shows Edge Node Barrier;

FIGS. 311-316 show Barrier Intersect Monitoring (BIM);

FIGS. 317-323 show Edge Node Detection (END);

FIGS. 324-325 show Detector Bubble Formation (DBF);

FIG. 326 shows Bubble Neighbor Elimination (BNE);

FIG. 327 shows Sector Width Dissection (SWD);

FIG. 328 shows Travel Direction Calibration (TDC);

FIGS. 329-330 show Boomerang Sequence Algorithm (BSA);

FIGS. 331-332 show Physical Data Migration Layer (PDML);

FIG. 333 shows Friction Zone Define Migration Paths;

FIGS. 334-335 show Hop Pathway Clash Optimization (HPCO);

FIG. 336 shows Abandoned Packet Journey;

FIG. 337 shows Pathway Error Rectification (PER);

FIG. 338 shows Node Traffic Bottleneck;

FIG. 339 shows the conclusion of Pathway Error Rectification (PER);

FIGS. 340-343 show Sector Pricing Mechanism (SPM) and Work Settlement Mechanism (WSM);

FIG. 344 shows Node Work Payout (NWP);

FIGS. 345-346 shows Signed Economic Output Verification (SEOV);

FIGS. 347-349 show Hop Ledger Signing (HLS);

FIGS. 350-353 show NSS Variable Pooling (NVP);

FIGS. 354-356 show Jurisdictionally Implied CCF Submission (JICS) and Jurisdictionally Accepted CCF Reception (JACR);

FIGS. 357-358 show Call Initiation Parts;

FIGS. 359-365 show the structure of the Custom Processor designed from the UBEC/BCHAIN Microchip Architecture (UBMA);

FIG. 359 shows Voltage Regulators;

FIG. 360 shows the structure of Subsection A;

FIG. 361 shows Subsection of the UBMA Processor which houses generic Microchips;

FIG. 362 shows Secure Hardware Certificate Generating Unit (SHCGU);

FIG. 363 shows interaction between SHCGU, BCHAIN Hosted Encrypted Channel and LUIGI;

FIG. 364 shows Fund Recovery Mechanism (FRM);

FIG. 365 shows interaction between FRM and LUIGI;

FIG. 366 shows details of Deployment Patch Assembly (DPA) module, details of Logistics Layer and their interaction with Customchain Ecosystem Builder (CEB);

FIG. 367 shows the process for Correction Patch Block Addition (CPBA);

FIG. 368 to FIG. 371 show Appchain Swap Mechanism (ASM) sequence;

FIG. 372 to FIG. 373 show Logistics Layer Interpretation (L2I) sequence;

FIG. 374 to FIG. 375 show LIZARD process for converting the Logistics Layer of the Target Appchain into Appchain;

FIG. 376 shows Raw Appchain Manipulation (RAM) process from Logistics Layer input;

FIG. 377 to FIG. 378 show the process for LIZARD converts the Executable Logic Elements of the Logistics Layer into Execution;

FIG. 379 to FIG. 381 show the process for LIZARD converts the Static Data Elements of the Logistics Layer into Data;

FIG. 382 shows the sequence for the Execution Stream being processed by ESR in MCE;

FIG. 383 shows that a preliminary instance of ESR finds the Potential Environmental Scope;

FIG. 383 to FIG. 385 show LIZARD converting Initial Rendering State to Initial Rendering Purpose;

FIG. 386 to FIG. 387 show LIZARD converting the Final Rendering State to Final Rendering Purpose;

FIG. 388 to FIG. 402 show details where A Preliminary instance of ESR finds the Potential Environmental Scope utilizing CTMP and LOM;

FIG. 403 and FIG. 404 show Raw Appchain Manipulation (RAM) Dependency Request Fulfillment (DRF);

FIG. 405 to FIG. 407 show LIZARD converting the Execution Request into Purpose;

FIG. 408 shows RAW with DRF;

FIG. 409 shows DPA with Upgraded Execution Stream and Original Execution Stream;

FIG. 410 shows EDSM with ESC and Upgraded Execution Stream;

FIG. 411 to FIG. 412 show DSDL with Upgraded Data Stream and Original Data Stream;

FIG. 413 to FIG. 416 show ESDL receiving Upgraded Execution Stream A0;

FIG. 417 to FIG. 418 shows ESR;

FIG. 419 and FIG. 420 show Command Types with Conditional Command Reference and Execution Sequence;

FIG. 421 to FIG. 424 show MEL Execution based on Command Types;

FIGS. 425-429 show Data Stream A0 processing;

FIG. 430 shows NCA;

FIG. 431 shows ESR) and Rendered Result Processing (R2P);

FIG. 432 to FIG. 436 show ESC;

FIG. 437 to FIG. 439 show DSS;

FIG. 440 to FIG. 442 show NSA;

FIG. 443 to FIG. 445 show P2SP;

FIG. 446 and FIG. 447 show PRP;

FIGS. 448-452 show Symbiotic Recursive Intelligence Advancement (SRIA);

FIG. 600 to FIG. 603 show SPSI;

FIG. 604 shows Official Appchains interacting with each other within a Customchain Ecosystem;

FIG. 605 shows an overview of the various sub-modules that operate within SPSI;

FIGS. 606-609 show ATM;

FIGS. 610-616 show A2R;

FIG. 617 and FIG. 618 show LIZARD converting the Upgraded Purpose Map into an Upgraded Appchain;

FIGS. 619-652 show IEC;

FIG. 619 shows the operation and functionality of IEC;

FIGS. 620-621 show the operation of LIZARD to convert the Selected Code Unit into a Purpose Hierarchy Map;

FIGS. 622-623 shows the operation of LIZARD to convert the Code Structure Blueprint into a Purpose Hierarchy Map;

FIGS. 624-625 show IEC;

FIGS. 626-627 show the operation of LIZARD to convert the Code Unit Buffer Pool (CUBP) into a Purpose Hierarchy Map;

FIGS. 628-631 show IEC;

FIGS. 632-633 show Suitable Purpose Replacement (SPR);

FIGS. 634-636 show Rational Appeal (RA);

FIGS. 637-638 show Raw Perception Production (RP2);

FIGS. 639-640 show Perception Observer Emulator (POE);

FIG. 641 shows Memory Web;

FIG. 642 shows interaction between Perception Storage (PS) and Automated Perception Discovery Mechanism (APDM);

FIG. 643 shows Critical Rule Scope Extender (CRSE) of CTMP;

FIGS. 644 and 645 show Implication Derivation (ID) of CTMP;

FIGS. 646 and 647 show Critical Decision Output (CDO) of CTMP;

FIGS. 648-649 show the operation of LIZARD to convert the Purpose Replacement into Execution Segments;

FIGS. 650-652 show Unit Blueprint Lookup (UBL);

FIGS. 653 and 654 show ASH;

FIGS. 655-659 show the internal operation procedure of LOM and CTMP in regards to ASH;

FIG. 660 shows RP2 from within CTMP;

FIGS. 661-662 elaborate on POE;

FIG. 663 shows the Memory Web process that operates in parallel to the execution of POE;

FIG. 664 elaborates on the logic flow interaction between PS and APDM;

FIG. 665 elaborates on the operational details concerning CRSE;

FIGS. 666-667 elaborate on ID;

FIGS. 668-669 elaborate on CDO;

FIG. 670 shows ARM processing based on Security Threat Scope;

FIG. 671 shows ASH and CKR;

FIG. 672 shows ASH with elaboration of ARM and CKR;

FIGS. 673 and 674 show LOM producing Security Threat Knowledge which is submitted to AST;

FIGS. 675-676 show ASH with details on LIZARD processing AST;

FIG. 677 show ASH with details on I2GE processing AST;

FIG. 678 shows ASH with LIZARD receiving the Execution Stream of the Target Appchain from ESC;

FIG. 679 shows ASH with LIZARD performing Execution of the Target Appchain received through ESC;

FIG. 680 shows ASH with I2GE performing Iterative Evolution;

FIG. 681 shows ASH under attack of AST;

FIG. 682 shows ASH with I2GF performing Iterative Evolution;

FIG. 683 shows conclusion of ASH process;

FIG. 684 shows Appchain Regulatory Compliance (ARC);

FIGS. 685-686 show LIZARD converting the System Regulations and Guidelines into a Purpose Hierarchy Map;

FIG. 687 shows utilizing Purpose Hierarchy Map;

FIG. 688 shows determining if LUIGI has independently confirmed that the Appchain in question is in violation of the System Regulations and Guidelines;

FIG. 689 shows Adjusting the Purpose Hierarchy Map of Target Appchain;

FIGS. 690-692 show LIZARD converting the Upgraded Purpose Map into an Upgraded Appchain;

FIGS. 693-697 show DLUA;

FIGS. 698-699 show LIZARD converting ERLR into a Purpose Hierarchy Map;

FIGS. 700-705 show DLUA;

FIGS. 706-707 show LIZARD converting Contextualized Error Log into a Purpose Hierarchy Map;

FIGS. 708-709 show LIZARD converting Refined Execution Segment into a Purpose Hierarchy Map;

FIG. 710 shows DLUA;

FIG. 711 shows NAD;

FIGS. 712-713 show LIZARD converting the entire Customchain Ecosystem of the UBEC Platform into a Purpose Hierarchy Map;

FIG. 714 shows Overlap Co-operation and Conflict Check (OC3);

FIGS. 715-716 show LIZARD converting the Purpose Hierarchy Map into a series of Purpose Bands;

FIG. 717 shows OC3;

FIGS. 718-719 show operation of CTMP, LOM and I2GE to develop the OC3 Map;

FIGS. 720-721 show LIZARD converting New Proposed Changes into a Purpose Hierarchy Map;

FIGS. 722-724 show Overlap Co-operation and Conflict Check (OC3);

FIGS. 725-726 show LIZARD converting System Design Principles into a Purpose Hierarchy Map;

FIGS. 727-728 show LIZARD converting Appchain Jurisdictions into a Purpose Hierarchy Map;

FIGS. 729-730 show Overlap Co-operation and Conflict Check (OC3);

FIGS. 731-732 show LIZARD converting the Upgraded Purpose Map into New Proposed Changes;

FIG. 733 shows Principled Modification Actuation (PMA);

FIGS. 734-735 show LIZARD converting Appchains to Create into a Logistics Layer;

FIG. 736 shows Principled Modification Actuation (PMA);

FIGS. 737-740 show New Appchain Development (NAD);

FIGS. 741-742 show LIZARD converting the OC3 Map into an Appchain Syntax Map;

FIG. 743 shows NAD;

FIGS. 744-745 show LIZARD converting Fulfilled Appchain into the Purpose Hierarchy Map;

FIGS. 746-754 show NAD;

FIGS. 755-756 show POE;

FIG. 757 shows the Memory Web;

FIG. 758 elaborates on the logic flow between PS and APDM;

FIG. 759 shows CRSE;

FIGS. 760-761 show ID;

FIGS. 762-763 show CDO;

FIGS. 764-765 show NAD;

FIGS. 766-767 show LIZARD converting Syntactical Creative Solutions into a Purpose Hierarchy Map;

FIG. 768-769 show including the Purpose Hierarchy Map of Syntactical Creative Solutions;

FIGS. 770-771 show LIZARD converting the Upgraded Purpose Map into a Logistics Layer;

FIGS. 772-773 show Automated Appchain Maintenance (A2M);

FIG. 774 shows Enhanced Framework Development (EFD);

FIGS. 775-776 show LIZARD converting Hardware Structure Interpretation into a Hardware Purpose Map;

FIGS. 777-778 show LIZARD converting Framework Structure Interpretation into a Framework Purpose Map;

FIGS. 779-780 show EFD;

FIGS. 781-784 show operation of LOM and CTMP in regards to EFD;

FIGS. 785-786 show RP2;

FIGS. 787-788 show POE;

FIG. 789 shows Memory Web process that operates in parallel to the execution of POE;

FIG. 790 elaborates on the logic flow between PS and APDM;

FIG. 791 shows CRSE;

FIGS. 792-793 show ID;

FIGS. 794-795 show CDO;

FIGS. 796-797 show EFD;

FIGS. 798-799 show LIZARD converting Refined Framework Structure Interpretation into an Ideal Framework Purpose Map;

FIG. 800 shows EFD;

FIG. 801 shows NMM;

FIGS. 802-803 show EFD;

FIGS. 804-806 show Enhanced Hardware Development (EHD);

FIGS. 807-815 show LOM and CTMP in regards to EHD;

FIG. 816 elaborates on interaction between PS and APDM;

FIG. 817 shows CRSE;

FIGS. 818-819 show ID;

FIGS. 820-821 show CDO;

FIGS. 822-823 show LIZARD converting Ideal Hardware Configuration into a Purpose Hierarchy Map;

FIGS. 824-825 show EHD;

FIGS. 826-827 show LIZARD converting Electrical Engineering Principles into a Purpose Hierarchy Map;

FIGS. 828-829 show EHD;

FIGS. 830-832 show UBEC Automated Deployment (UAD);

FIGS. 833-834 show LIZARD converting Interface Drivers into a Purpose Hierarchy Map;

FIGS. 835-836 show LIZARD converting Interface Specifications into a Purpose Hierarchy Map;

FIGS. 837-840 show UBEC Automated Deployment (UAD);

FIGS. 841-842 show LIZARD converting Modular Interface Plugin Referenced Part into a Purpose Hierarchy Map;

FIGS. 843-844 show LIZARD converting Interface Drivers Referenced Part into a Purpose Hierarchy Map;

FIGS. 845-847 show UAD;

FIGS. 848-849 show Stages of Appchain Adoption (SA2);

FIGS. 850-851 show Legacy to RCHAIN Deployment (LBD);

FIG. 852 shows Emulation Layer Deployment (ELD);

FIG. 853 shows Deployment Interface (DI);

FIGS. 854-855 show LIZARD converting Modular Appchain Dependencies into a Purpose Hierarchy Map;

FIGS. 856-857 show LIZARD converting Modular Appchain Dependencies into a Purpose Hierarchy Map;

FIG. 858 shows DI;

FIGS. 859-860 show LIZARD converting the Upgraded Purpose Map into a Pre-Compiled Binary;

FIG. 861 shows DI;

FIGS. 862-879 show the operation and functionality of the Appchain Emulation Layer (AEL);

FIG. 862 shows production of a Precompiled Application Stack (PAS);

FIG. 863 shows the operation and functionality of AEL;

FIG. 864 shows External Instruction Middleware (EIM);

FIGS. 865-866 show the operation of LIZARD to convert the External Instruction Proposition into a Purpose Hierarchy Map;

FIG. 867 shows EIM;

FIG. 868 shows NMM;

FIGS. 869-870 show the operation of LIZARD to convert the Instruction Purpose Collection into a Deployable Instruction Stream;

FIGS. 871-873 show SAP;

FIGS. 874-875 show Dependency Request Fulfillment (DRF);

FIG. 876 shows (NMM);

FIGS. 877-878 show the operation of LIZARD to convert Execution and Data Requests into a Purpose Hierarchy Map;

FIG. 879 shows macro aspects of SAP;

FIGS. 1000-1001 show ES;

FIG. 1002 shows the security oversight functionality of CDEE;

FIGS. 1003-1005 show LUIGI;

FIGS. 1006-1007 elaborate on DAC;

FIG. 1008 shows currency liquidity manipulation functions in Financial Liquidity Manipulation;

FIGS. 1009-1011 show DVM;

FIGS. 1012-1014 show PTI;

FIGS. 1015-1026 show AOM2;

FIG. 1027 shows Liquidity Injection;

FIGS. 1028-1030 show PCP;

FIGS. 1031-1034 show CSR;

FIGS. 1035-1036 show MRP;

FIGS. 1037-1038 show RTRP;

FIGS. 1039-1087 show CSE;

FIGS. 1039-1043 show Target Investment Circumstances Interpretation (TICI);

FIG. 1044 shows that LOM produces Market Activity Knowledge from CKR;

FIG. 1045 shows that LOM produces Tax Liability Knowledge from CKR;

FIG. 1046 shows that LOM produces Regulatory Compliance Knowledge from CKR;

FIG. 1047 shows that LOM produces Corporate Operations Knowledge from CKR;

FIG. 1048 shows the internal operation procedure of LOM and CTMP in regards to CSE;

FIGS. 1049-1051 show the internal operation procedure of Rational Appeal (RA) of LOM in regards to CSE;

FIGS. 1052-1053 show invocation of Raw Perception Production (RP2) within CTMP;

FIGS. 1054-1056 show operation of Perception Observer Emulator (POE);

FIG. 1057 shows interaction between Perception Storage (PS) and the Automated Perception Discovery Mechanism (APDM);

FIG. 1058 shows Critical Rule Scope Ex-tender (CRSE) of CTMP;

FIGS. 1059-1060 show Implication Derivation (ID) of CTMP;

FIGS. 1061-1063 show Critical Decision Output (CDO) of CTMP;

FIG. 1064 shows CSE;

FIGS. 1065-1066 show the operation of LIZARD to convert Target In-vestment Circumstances into a Purpose Hierarchy Map;

FIGS. 1067-1068 show the operation of LIZARD to convert Market Activity Knowledge into a Purpose Hierarchy Map;

FIG. 1069 shows CSE;

FIGS. 1070-1071 show the operation of LIZARD to convert Tax Liability Knowledge into a Purpose Hierarchy Map;

FIGS. 1072-1073 show the operation of LIZARD to convert Regulatory Compliance Knowledge 12370 into a Purpose Hierarchy Map;

FIGS. 1074-1075 show the operation of LIZARD to convert Corporate Operations Knowledge into a Purpose Hierarchy Map;

FIGS. 1076-1080 show CSE;

FIGS. 1081-1082 show Need Map Matching (NMM);

FIGS. 1083-1087 show CSE;

FIGS. 1088-1115 show DMT;

FIGS. 1088-1092 show the logic flow of DMT;

FIGS. 1093-1094 show Personality Template Fulfillment (PTF);

FIG. 1095 shows DMT;

FIGS. 1096-1097 show the operation of LIZARD to convert Personality Nuance Definition into a Purpose Hierarchy Map;

FIGS. 1098-1099 show the operation of LIZARD 120 to convert Personality Template Makeup into a Purpose Hierarchy Map;

FIGS. 1100-1101 show Purpose to Purpose Symmetry Processing (P2SP);

FIGS. 1102-1103 show the operation of LIZARD to convert Personality Purpose Map into Personality Reaction Syntax;

FIGS. 1104-1115 show the logic flow of DMT;

FIGS. 1116-1145 show MERM;

FIG. 1116 shows the operation and functionality of the Mind Emulation Request Module (MERM);

FIG. 1117 shows Need Map Matching (NMM);

FIGS. 1118-1121 show MERM;

FIGS. 1122-1123 show the operation of LIZARD to convert the Complex Scenario Definition into a Purpose Hierarchy Map;

FIGS. 1124-1125 show the operation of LIZARD to convert the Selected Execution Sequence into a Purpose Hierarchy Map;

FIGS. 1126-1129 show MERM;

FIGS. 1130-1131 show the operation of LIZARD to convert the Mind Perception Result into a Purpose Hierarchy Map;

FIGS. 1132-1133 show the operation of LIZARD to convert the Plausible Emulation Scenario into a Purpose Hierarchy Map;

FIGS. 1134-1136 show MERM;

FIGS. 1137-1138 show the operation of LIZARD to convert the Base Purpose Hierarchy Map of Complex Scenario Definition into Appchain Syntax;

FIG. 1139 shows MERM;

FIGS. 1140-1141 show the operation of LIZARD to convert the Purpose Hierarchy Map of Complex Scenario Definition into Appchain Syntax;

FIGS. 1142-1143 show the operation of LIZARD to convert the Appchain Correction Patch into a Purpose Hierarchy Map;

FIGS. 1144-1145 show the operation of LIZARD to convert the Purpose Hierarchy Map of the Appchain Correction Patch into Scenario Syntax;

FIGS. 1146-1183 show NME;

FIGS. 1146-1147 show Neuroeconomic Mapping Enhancement (NME);

FIGS. 1148-1149 show the operation of LIZARD to convert the Neural State Association Knowledge into a Purpose Hierarchy Map;

FIGS. 1150-1153 show NME;

FIGS. 1154-1155 show the operation of LIZARD to convert Refined Neural State Association Knowledge into a Purpose Hierarchy Map;

FIG. 1156 shows NME;

FIGS. 1157-1158 show the operation of LIZARD to convert the Purpose Hierarchy Map of the Neural State Association Knowledge into Appchain Syntax;

FIGS. 1159-1160 show the operation of LIZARD to convert the Purpose Hierarchy Map of the Refined Neural State Association Knowledge into Appchain Syntax;

FIGS. 1161-1163 show NME;

FIGS. 1164-1165 show the operation of LIZARD to convert the Raw Neural Pattern into a Purpose Hierarchy Map;

FIGS. 1166-1167 show the operation of LIZARD to convert the Target Circumstantial State into a Purpose Hierarchy Map;

FIGS. 1168-1169 show NME;

FIGS. 1170-1171 show the operation of LIZARD to convert the Claimed Circumstantial State into a Purpose Hierarchy Map;

FIGS. 1172-1175 show NME;

FIGS. 1176-1177 show the operation of LIZARD to convert the Claimed Neural Pattern into a Purpose Hierarchy Map;

FIGS. 1178-1183 show NME;

FIG. 1184 shows the operation and application of Log Aggregation within ES;

FIGS. 1185-1189 illustrate usability examples of Self Programming Self Innovation (SPSI) with regards to the operation of Appchains and Legacy Programs on Legacy and BCHAIN systems;

FIG. 1190 shows an overview of the various sub-modules that operate within SPSI;

FIGS. 1191-1224 show the operation and functionality of Innate Error Correction (IEC);

FIG. 1191 shows IEC;

FIGS. 1192-1193 shows details concerning the operation of LIZARD to convert the Selected Code Unit into a Purpose Hierarchy Map;

FIG. 1194-1195 show the operation of LIZARD to convert the Code Structure Blueprint into a Purpose Hierarchy Map;

FIGS. 1196-1197 show IEC;

FIGS. 1198-1199 show the operation of LIZARD to convert the Code Unit Buffer Pool (CUBP) 8198 into a Purpose Hierarchy Map;

FIGS. 1200-1203 show IEC;

FIG. 1204 shows Suitable Purpose Replacement (SPR);

FIG. 1205 shows operation of LOM and CTMP in regards to SPR;

FIGS. 1206-1208 show the operation Rational Appeal (RA) of LOM;

FIGS. 1209-1210 show the invocation of Raw Perception Production (RP2) within CTMP;

FIGS. 1211-1212 show the operation of Perception Observer Emulator (POE);

FIG. 1213 shows Memory Web process in parallel to the execution of POE;

FIG. 1214 shows interaction between Perception Storage (PS) and the Automated Perception Discovery Mechanism (APDM);

FIG. 1215 shows Critical Rule Scope Ex-tender (CRSE) of CTMP;

FIGS. 1216-1217 show Implication Derivation (ID) of CTMP;

FIGS. 1218-1219 show Critical Decision Output (CDO) of CTMP;

FIGS. 1220-1221 show the operation of LIZARD to convert the Purpose Replacement into Execution Segments;

FIGS. 1222-1223 shows Unit Blueprint Lookup (UBL);

FIG. 1224 shows the logic flow of IEC from the invocation of CSSP;

FIGS. 1225-1242 show the operation and functionality of the Appchain Emulation Layer (AEL);

FIG. 1225 shows NMC installed in a Precompiled Application Stack (PAS) instance via Static Appchain Processing (SAP);

FIG. 1226 shows Appchain Emulation Layer (AEL);

FIG. 1227 shows External Instruction Middleware (EIM);

FIGS. 1228-1229 show the operation of LIZARD to convert the External Instruction Proposition into a Purpose Hierarchy Map;

FIG. 1230 shows EIM;

FIG. 1231 shows NMM operating as a submodule of LIZARD's Dynamic Shell;

FIGS. 1232-1233 show the operation of LIZARD to convert the Instruction Purpose Collection into a Deployable Instruction Stream;

FIGS. 1234-1236 show SAP;

FIGS. 1237-1238 shows Dependency Request Fulfillment (DRF) within SAP;

FIG. 1239 shows NMM;

FIGS. 1240-1241 show the operation of LIZARD to convert Execution and Data Requests from Execution Stream Rendering (ESR) instance of the Modified Catch Environment (MCE) into a Purpose Hierarchy Map; and

FIG. 1242 shows macro aspects of SAP.

### DETAILED DESCRIPTION OF THE INVENTION

FIGS. 1-2 show the information ecosystem with it's respective submodules/dependencies that makes up the UBEC Platform 100 which achieves efficient collaboration via synchronized yet separate instances of algorithmic criteria. Universal/Ubiquitous; BCHAIN 110 (Base Connection Harmonization Attaching Integrated Nodes); Everyone, Everything, Everywhere, All the Time (E3A) Economy, Employment, Entertainment, Education, Energy, Exchanges, etc.); Connections (a relationship in which a person, thing, or idea is linked or associated with something else: Communications, Collateral, Creativity, Constitution, Capital, Commerce, Contentment, commodities, etc.)—UBEC Platform 100. UBEC Platform 100 is a software and hardware based new platform and catalyst primarily for the digital domain (digital domain—The world of digital. When something is done in the digital domain, it implies that the original data (images, sounds, video, etc.) has been converted into a digital format and is manipulated inside the computer's memory.) using smart devices (e.g., Smartphones, Computers, Internet of Things (IoT) 102 devices, etc.). However, its uses can also be realized in other domains (e.g., analog, acoustic, etc.). UBEC Platform 100 software and hardware enables smart devices to connect with one another via wifi hotspot connectivity (without the use of the traditional mobile network) hence serving as an alternate global communications platform in order for the device and its user to participate in the digital information society (utilizing digital Information and Communications Technologies (ICT)). Thus allowing smart device owners with UBEC Platform 100 (software and hardware) to perform all digital activities (including generating income by simply allowing use of their smart device by UBEC Platform 100) in a secure, efficient, legal, private & user controlled manner. The primary defining structure of UBEC Platform 100 is Base Connection Harmonization Attaching Integrated Nodes (BCHAIN) 110. BCHAIN 110 is a distributed database that maintains a continuously growing list of ordered records called blocks. BCHAIN 110 is a framework for producing sophisticated blockchain (the core component of the digital currency bitcoin, where it serves as the public ledger for all transactions) enabled applications (for communications, collaboration, information transportation, commerce, capital, interaction, etc.) for interconnected smart devices. Hence BCHAIN is a new and innovative (customized and enhanced) blockchain based Information & Communications Technology (ICT) framework for handling exponential growth of data & devices securely & efficiently. UBEC Platform 100 offers plethora of services such as financial services through it Cryptographic Digital Economic Exchange (CDEE) 705 (similar to a stock exchange with users owning Stocks, Funds (Mutual, Index, Hedge, Exchange Traded, etc.), as well as a Crypto currency with the symbol—U—(Watt Units). The value of a single—U—(Watt Units) is derived based on a proprietary Watt Unit Currency Algorithm 666 which utilizes Artificial Intelligence (AI—the theory and development of computer systems able to perform tasks that normally require human intelligence, such as visual perception, speech recognition, decision-making, and translation between languages) and the following factors as input/value: 1. UBEC Platform 100 Services Economy; 2. BCHAIN Infrastructure Economy; 3. Energy; 4. Time; and 5. Resource (market forces, etc.). The key differentiators of—U—(Watt Units) compared to other crypto currencies are: 1. Post-quantum Cryptography; 2. Exclusive means of payment for UBEC Services; 3. Robustness of the BCHAIN 110 platform; 4. UBEC CDEE 705; 5. AI enforced smart contracts; 6. AI based Self Programming Self Innovation 130 (without the need for core programmers); 7. LUIGI 116 based auto-governance; 8. AI (algorithm) based valuation; 9. CDEE 705 interworking with other financial exchanges through World Federation of Exchanges (WFE); & 10. Automatic Financial Growth (utilizing LOM 132, MPG, UBEC NMC 114/13300 for investing in CDEE 705 portfolio of financial products/services, legitimate tax mitigation/preparation and portfolio planning/management/reporting) for all entities; 11. Self Programming Self Innovation 130 based automated perpetual enhancement; 12. Digital Mind Tracking (DMT) 12700; and Neuroeconomic/Neurological Mapping Enhancement (NME) 13090. UBEC Platform 100 utilizes Artificial Intelligence (AI), Augmented Intelligence, Cognitive Computing, Symbiotic Recursive Intelligence Advancement (SRIA) with continually increasing (programming, emulation, adaptation, & research intelligence), Digital Mind Tracking (DMT) 12700, Neuroeconomic Mapping Enhancement (NME)/Neurological Mapping Enhancement (NME) 13090, BCHAIN 110 (with Cryptography, Adaptation Intelligence, BCHAIN Nodes, BCHAIN Protocol 794, BCHAIN Data Integrity Management 1204), LUIGI (Legislated UBEC Independent Governing Intelligence) 116, Lexical Objectivity Mining (LOM) 132, Methodology for Perpetual Giving (MPG) 113, UBEC Neuroeconomic Metaphysical Contentment (NMC) 114, Self Programming Self Innovation 130, and Induction & Deduction (I2GE 122 & LIZARD 120) for enabling the global Digital Information Economy (with anticipated connections of trillions of devices & trillions of Zettabytes 1000⁷/Yottabytes 1000⁸ of data over the coming decades) in order to serve the Digital Information Society by providing universal interconnectivity between everything (connected digital things, etc.) & making everyone a Digital Citizen everywhere. UBEC Platform 100 is like a giant puzzle. All the pieces are made to interface and connect with each other, whilst there no duplicate pieces and each piece accomplishes it's part, hence pieces correlate with Appchains 836. Raw Appchain Manipulation (RAM) 6146 is a significant subset of Customchain Ecosystem Builder (CEB) 584, which is the main core of UBEC Platform 100 and Appchain puzzle piece harmony. The Ecosystem in CEB 584 is referring to the giant puzzle. Therefore Raw Appchain Manipulation (RAM) 6146 is the module that performs the most direct modifications to the puzzle pieces, whilst the modules that invoke CEB 584, in conjunction with CEB 584, decide on the mosaic setup of the Appchain ecosystem (puzzle). Strong example of that is SPSI 130 modifying the puzzle piece at a macro scale. Various methods are employed to control the composition of the puzzle, including Null Segment Adjustment (NSA) 6900 which is a module that seeks to make the updating of new information within the puzzle efficient. Internet of Things (IoT) 102 represents the ecosystem of devices which interact with each other via digital connectivity. Such devices can range from refrigerators, thermostats, cars, garages, doors, drones etc. Therefore a Hardware Device 104 that is operating the UBEC Platform 100 will operate as an IoT 102 device within the IoT Ecosystem 102. The UBEC User 106 is a person who has their biometric information registered within the UBEC Platform 100 via User Node Interaction 470. This enables the User 106 to perform digital transactions concerning information and trade within the UBEC Platform 100. Therefore the Hardware Device 104 connects to the UBEC Application/System 118, which is a series of codified routines that connects all of the various submodules to a central interface. The UBEC Application/System 118 and it's enumerated dependencies all operate on top of the BCHAIN (Base Connection Harmonization Attaching Integrated Nodes) Network 110. The BCHAIN Network 110 is a series of IoT 102 devices known as BCHAIN Nodes 786 which operate software in accordance with the BCHAIN Protocol 794. Therefore the entire UBEC Platform 100 operates with the features of Node 786 decentralization, cryptographic security and data retention/routing efficiency optimization via artificial adaptation intelligence of the BCHAIN Network 110. Efficient operation of the BCHAIN Network 110 is ideally processed by the UBMA 4260 chip. Sub-modules and dependencies within the UBEC Platform 100 operate as Appchains 836. Appchains 836 are data storing, serving and computational programs that operate directly upon the BCHAIN Network 110 infrastructure layer. Methodology for Perpetual Giving (MPG) 113 and Neuroeconomic Metaphysical Contentment (NMC) 114 are Appchains 836 that performs artificially intelligent investment decisions within the UBEC Platform 100. Such decisions are made to take advantage of stipulations within financial rulesets (e.g. taxation laws). Legislated UBEC Independent Governing Intelligence (LUIGI) 116 is an artificially intelligent enforcement mechanism for implementing fairness, equity, and justice from within the boundaries of the UBEC Platform 100. To accomplish this, LUIGI 116 is granted a hardcoded permanent and irrevocable level of administrative and executive privilege from within the UBEC Platform 100. To consolidate the centrally dense concentration of authoritative power that exists within LUIGI 116, it is programmed and maintained exclusively by SPSI 130 to absolutely deter malicious programmers from enacting exploits. It is also exclusively hosted on the distributed BCHAIN Network 110 to absolutely remove leverage from any single entity or organization from managing it's dependent hardware. Hence third parties are unable to shut it down nor compromise it. Self Programming Self Innovation (SPSI) 130 is an Appchain 836 that automatically programs itself and other Appchains within the UBEC Platform that are granted ‘official’ designation. Such an ‘official’ designation indicates that the Appchain 836 is a core functioning part of the UBEC Platform 100. LIZARD 120 is a central oversight algorithm that is able to block all potential cybersecurity threats in realtime, without the direct aid of a dynamic growing database. Lexical Objectivity Mining (LOM) 132 is a sophisticated algorithm that attempts to reach as close as possible to the objective answer to a wide range of questions and/or assertions. It engages with the UBEC User 106 to allow them to concede or improve their argument against the stance of LOM 132. Conceding or improving an argument is the core philosophy of LOM 132 as it must be able to admit when it has been wrong so that it can learn from the knowledge of the UBEC User 106, which is where it gets most of it's knowledge from in the first place. Automated Research Mechanism (ARM) 134 attempts to constantly supply CKR 648 with new knowledge to enhance LOM's 132 general estimation and decision making capabilities. Personal Intelligence Profile (PIP) 136 is where the UBEC User's 106 personal information is stored via multiple potential end-points and front-ends. Their information is highly secure and isolated from CKR 648, yet is available for LOM 132 to perform personalized decision making. Life Administration and Automation (LAA) 138 connects various BCHAIN enabled devices 786 and services on a cohesive platform that automates tasks for life routines and isolated incidents. The Behavior Monitoring (BM) 140 module monitors personally identifiable data requests from UBEC Users 106 to check for unethical and/or illegal material. Ethical Privacy Legal (EPL) 142 receives a customized blacklist from MSNP 126 and uses Assumptive Override System (AOS) 148 to block any assertions that contain unethical, privacy-sensitive, and/or illegal material. Stylometric Scanning (SS) 144 analyzes the Stylometric Signature of new foreign content (which the system has yet to be exposed to). This aides CKR 648 in tracking source expectations of data/assertions, which further helps LOM 132 detect corroborative assertions. Assertion Construction (AC) 148 receives a proposition in the form of an assertion or question and provides output of the concepts related to such proposition. Hierarchical Mapping (HM) 150 Maps associated concepts to find corroboration or conflict in question/assertion consistency. It then calculates the benefits and risks of having a certain stance on the topic. Third Party Applications and Services 152, Third Party Algorithms 154, and Information Sources 156 interface with LOM 132.

FIG. 2 expands on the details of Third Party Applications and Services 152 and Third Party Algorithms 154. Third Party Applications and Services 152 contains Commerce 156, Search 158, Medical 160, Transportation 162, Education 164 and Communications 166. Third Party Algorithms 154 is a collection of proprietary technology that is developed and maintained by UBEC Users 106 within the UBEC Platform 100 that offer technical services that enhance the operation and functionality of LOM 132 and hence UBEC 118. The Emotional Intelligence Algorithm 168 can detect various human emotions via visual camera feeds of facial expressions as well as voice patterns that have been recognized via the Voice Recognition Algorithm 172. The Voice Recognition Algorithm 172 can transcribe spoken words into text. The Retina Scan Algorithm 174 understands structures concerning the human eye which compliments security authentication usages such as with User Node Interaction (UNI) 470. The Language Translation 176 Algorithm automatically converts spoken sentences, phrases and words between a variety of languages, hence enabling trade, commerce and communication within the UBEC Platform 100. The Facial Recognition Algorithm 178 understands structures concerning the human face which compliments security authentication usages such as with User Node Interaction (UNI) 470. The DNA Sampling Algorithm 180 can process genetic sequences extracted from human specimens such as hair, skin or saliva. This compliments security authentication usages such as with User Node Interaction (UNI) 470 and for theory research processed by LOM 132 to solve mysteries, check for conspiracies etc. The Fingerprint Recognition Algorithm 182 understands structures concerning the human face which compliments security authentication usages such as with UNI 470. The ‘Predictification’ Algorithm 184 analyzes mass social behavior to assert predictions on the outcome of social event with varying degrees of confidence. Such degrees of confidence typically vary according to the richness and density of the data made available to the Algorithm 184. The Stylometry Algorithm 186 analyzed the word usage and physical handwriting traits of texts to decipher a subtle signature left by the true author of such text. This enables LOM 132 to solve mysteries, check for conspiracies etc.

FIGS. 3-6 show the automated deployment mechanism for deploying the UBEC Platform 100 as an Application 216 to various hardware devices. SPSI 130 submits Software, Firmware and Hardware Updates to the core code structure 190 of UBEC 100 at stage 188. Hardware updates makes reference to a potential future iteration of the UBEC BCHAIN Microchip Architecture (UBMA) 4260 which can change its own microprocessor assembly dynamically via dynamic conductive structures. The UBEC Platform 100 has its own distinct Codebase 192, which is distinct yet directly depends and collaborates with the BCHAIN Protocol 794 Codebase 196. Both Codebases 192 and 196 directly connect to the Modular Interface Plugin 194, which acts as middleware software to ensure a compatible execution of Codebases 192 and 196 upon differing hardware and operating system makeups of BCHAIN Nodes 786. The Hybridized Core Logic 190 is thereafter deployed via various Deployment Routines 198, 200, and 202. The appropriate Deployment Routine 198-202 is selected in accordance with the correlating hardware and operating system makeup of the selected BCHAIN Node 786.

FIG. 4 shows the detailed layout of Deployment Routine A 198, which is optimized for Apple iOS devices. At Stage 206 SPSI 130 prepares the Hybridized Core Logic for deployment in the Apple iOS App Store. This Stage 206 initiates Deployment Routing A 198 and thereafter invokes Stage 210 which invokes SPSI 130 to update Interface Drivers A 212 to be in full compliance with the relevant and up to date specifications. At Stage 208 SPSI 130 installs the Interface Drivers 212 into the Hybridized Core Logic 190. More specifically, the Interface Drivers A is installed with the Modular Interface Plugin 194, which allows the UBEC Platform 100 codebase 192 and the BCHAIN Protocol 794 codebase 196 to interface with a BCHAIN Node's 786 hardware and operating system as compiled within the UBEC/BCHAIN Application 216. This Application 216 is now ready for deployment to the Apple iOS App Store 218. Therefore SPSI 130 submits the UBEC/BCHAIN Application 216 to the Apple iOS App Store 220 at Stage 218.

At FIG. 5 SPSI 130 initiates at Stage 222 the same procedure that was used to compile and submit the UBEC/BCHAIN Application 216 to the Apple iOS App Store 220 but instead targets the Google Play Store 234. Therefore a differing set of Interface Drivers B 228 are used which are in accordance with the Android App API Specifications 230, as programmed by SPSI 130. The Interface Drivers B are plugged into the Modular Interface Plugin 194 to lead to the compilation of the UBEC/BCHAIN Application 216 which has now been optimized for execution and usage within the Google Play Store 234 ecosystem. Therefore the instance of the UBEC/BCHAIN Application 216 in Deployment Routine A 198 retains the same Codebases 192 and 196 as the instance in Deployment Routine B 200.

At FIG. 6 Deployment Routine C 202 follows a similar pattern as Routines A 198 and B 200 yet differs in that instead of Application Store Specifications 214 and 230 being used, direct Smartphone Hardware Specification 244 are referenced by SPSI 130 to produce Interface Drivers C 242. Therefore the resultant UBEC/BCHAIN Operating System 217 is a fully fledged operating system capable of direct interaction with Central Processing Units (CPUs), Graphical Process Units (GPUs), Random Access Memory (RAM), etc. SPSI submits the update to an Appchain 836 on the BCHAIN Network 110 which serves the latest version of the Operating System (OS) 217. Therefore smartphones that are already pre-installed with the UBEC OS 217 perform a traditional update mechanism of checking with a server endpoint for an official and cryptographically signed version of the OS 217. The non-traditional aspect of the OS 217 update mechanism at Stage 246 is that the OS 217 files are hosted in a decentralized manner within the BCHAIN Network 110.

FIG. 7 shows a use case example of Layman User interacting with the UBEC Platform 100 for the first time. At Stage 250 Layman User intends to join the digital economy. At this Stage 250 the Layman User's possessions are enumerated at Supplement 284 as one smartphone. At Stage 252 Layman User downloads the UBEC application from the relevant App Store that runs from his smartphone (e.g. Apple App Store, Android Play Store etc.). Therefore Supplement 286 indicates that Layman User now possesses one UBEC enabled smartphone as opposed to the regular smartphone of Supplement 284. This is a significant alteration as the execution of the UBEC Platform 100 on Layman User's smartphone enables a wide array of new capabilities and measures of interaction which enable Layman User to become a ‘digital citizen’. At Stage 254 the UBEC Application 118 asks rudimentary questions about Layman User's ambitions and assets. Upon consent, Layman User records a live video stream of his property, assets, and living condition/lifestyle which is processed by UBEC 118. At Stage 256; upon completing analysis performed by LOM 132, the UBEC Application 118 recommends to Layman User to sell xyz asset in order to buy three UBEC 100 enabled drones. At Stage 258; because Layman User does not have any electronic means of payment, UBEC orders three drones via LOM 132 backend services and opts for payment to be given by cash to the delivery personnel. At Stage 260; upon payment and receipt of the drones, Layman User follows the instructions on the UBEC Application 118 to scan the laser-etched QR codes of the drones with the UBEC Application 118. Therefore Supplement 288 indicates that Layman User now owns one UBEC enabled smartphone in addition to the recently registered three UBEC enabled drones. At Stage 262 the three drones immediately and automatically begin scanning the property of Layman User via their onboard 3D cameras (Virtual Reality Ready). This allows LOM 132 to be constantly updated as to the affairs within Layman User's property which results in a more calibrated response and experience of LOM 132 assistance. At Stage 264 the three drones immediately and automatically begin routing BCHAIN Protocol 794 packets from the neighborhood, hence granting Layman User direct access to the BCHAIN Network 110. At Stage 266; because Layman User now has connectivity to the BCHAIN Network 110, UBEC 118 recommends for him to cancel his telephone carrier plan and remove the sim card from his phone. Therefore Supplement 290 indicates that Layman User has saved money by cancelling subsequent telephone carrier payments. At Stage 268; UBEC 118 knows that Layman User would mostly use his old motorcycle to drive to the city once a month to pay for his prepaid sim card by cash. Therefore UBEC 118 recommends that he sells his motorcycle and buys a bicycle. Therefore Supplement 292 further indicates that Layman User has attained a profit after having sold his motorcycle and bought a bicycle. At Stage 270 UBEC shows how Layman User can use the BCHAIN Network 110 to make extremely affordable international phone calls to his brother which he calls every week who lives in his country of origin. Therefore Supplement 294 indicates Layman User has furthermore attained money savings by not having to spend money on international calls via legacy telephone and VoIP systems. At Stage 272 UBEC 118 notices via LOM 132 centralized data mining that Layman User's home location is relatively near a drone highway, where drone recharges and maintenance/repair are in high demand. At Stage 274 UBEC recommends to Layman User to buy a drone docking station which can house sixteen drones at a time, and a service repair kit. UBEC 118 bases this recommendation with consideration of Layman User's budget. Therefore UBEC 118 recommends to Layman User to buy the aforementioned items by using the cash made by selling his motorcycle. At Stage 276 Layman User approves and therefore UBEC 118 via LOM 132 orders the docking station and service repair kit with the best ratings, the best suited price for Layman User, and the most reliable online seller. At Stage 278 Layman User receives the items and pays in cash. He scans the laser-etched QR codes on the products with the UBEC Application 118 on his smartphone. Thereafter at Stage 280 the UBEC Platform 100 and hence BCHAIN Network 110 automatically manages communication of Layman User's drones and docking station with drones from the nearby drone highway. At Stage 282 Layman User now enjoys a profit being made by reselling his electricity and automated drone repair service to other drones. He retains the profits in—U—(Watt Units) and spends them directly on the UBEC Platform 100 for goods and services he requires, which are sometimes initiated by a recommendation of UBEC 118 via LOM 132 with consideration of his context and situation.

FIGS. 8-10 show a non-layman User interacting with UBEC 118 to manage his personal health.

In FIG. 8 Stage 296 describes the user operating a smartphone that runs the UBEC Platform 100 natively as an Operating System 217. At Stage 298 User is wearing an UBEC 100 enabled smartwatch that constantly detects body temperature, heartbeat, sweat rate etc. Stage 300 describes how all of User's personal health data from the UBEC 100 smartwatch is retained in an individual Personal Intelligence Profile (PIP) 136 Appchain 836. At Stage 302 LOM 132 cross-references the knowledge it's learned concerning medicine, which in part came from execution of the Automated Research Mechanism (ARM) 134 Appchain 836, with the personal health data stored in the PIP 136 Appchain 836. At Stage 304 LOM 132 performs such deep cross-referencing data analysis from Stage 302 by leveraging the efficiency resulting from the BCHAIN Protocol's 794 Adaptive Intelligence. At Stage 306 LOM 132 notices a pattern in User's personal health data stored in PIP 136 indicating that their is an 80% likelihood that User is catching the seasonal flu virus. At Stage 308 LOM 132 analyzes User's expected schedule for the next week to understand any potentially significant conflicts and consequences if User were to indeed get sick. At Stage 310 LOM 132 perceives that there would be strongly negative consequences if User were to get sick this week. At Stage 312 LOM 132 creates a perception of the expected location User is supposed to be in for the next three days. At Stage 314 LOM 132 finds doctor's offices near to User's expected location via several of the best and most up to date directories that exist in both the UBEC Platform 100 and the legacy internet. At Stage 316 LOM 132 eliminates all doctor's office candidates that do not support User's health insurance coverage. At Stage 318 LOM 132 checks the appointment availability for the remaining doctor's office candidates via directories from the UBEC Platform 100 and the legacy internet. At Stage 320 LOM 132 via the UBEC Platform 100 in conjunction with the BCHAIN Network 110 attempts to conduct a phone call with the candidates to confirm appointment time availability. Therefore the Automated Phone Call Process 332 is initiated. At Stage 322; considering the Learned Information 333 from the various phone calls that were performed, LOM 132 selects a candidate and time to book an appointment. At Stage 324 LOM 132 initiates a phone call to book the appointment, and securely submits insurance, payment, and pharmaceutical delivery information to the selected candidate. At Stage 326 due to the time sensitivity of the dilemma of User's potential sickness, LOM 132 booked the earliest possible appointment. At Stage 328 due to pre-existing permissions of control that were granted to the UBEC Platform 100 and User's UBEC 100 enabled devices 786, LOM 132 instructs the auto-pilot car that is currently driving User to make a detour and drive to the selected Doctor's Office to catch the appointment. Therefore LOM 132 has estimated that the higher priority is for User to immediately go to the doctor instead of to work, due to the potential consequences of not applying preventative medical measures. Upon completion of the appointment at Stage 330; LOM 132 initiates a phone call 332 to the pharmacy to arrange for medication delivery or pickup.

FIG. 9 displays the detailed logic flow of the Automated Phone Call Process 332 as performed by LOM 132 via the UBEC Platform 100 and the BCHAIN Network 110. The Process 332 initiates with a List of Candidates 334 which is subsequently iterated through via a programming Loop 336. Stage 338 checks if the selected candidate from the Loop 336 has a presence in the directory of the UBEC Platform 100. If a Yes 98 condition occurs in relation to Stage 338, then the logic flow continues to Stage 342, whilst a No 96 condition leads to Stage 340. Stage 340 does a similar check to Stage 338 except to references that exist on the legacy Internet rather than the UBEC Platform 100 and BCHAIN Network 110. If Stage 340 results in a Yes 90 condition, the logic flow continues to Stage 342. If Stage 340 results in a No 88 condition, then the logic flow continues to Stage 337. Stage 337 eliminates the selected candidate that was selected from the Candidate Loop 336 and iterates the Loop 336 to the next available candidate (if any). If there is no such candidate left available in the List of Candidates 334, then modular execution of Process 332 ends. Stage 342 checks if the selected candidate from Loop 336 has a listed phone number that operates within the UBEC Platform 100 and hence via the BCHAIN Protocol 794. If Stage 342 results in a Yes 94 condition, the logic flow continues to Stage 346. If Stage 342 leads to a No 92 condition then the logic flow continues to Stage 344. Stage 344 does a similar check for the selected candidate's reachable phone number except it checks for a phone number that operates on legacy telephone systems. If Stage 344 results in a Yes 86 condition then the logic flow continues to Stage 346, whilst a No 84 condition leads to Stage 337 which iterates the Loop 336. Stage 346 dials the selected phone number via the relevant protocol, either BCHAIN Network 110 or legacy network. Upon successful initiation of the phone call, Stage 348 conducts the phone call via algorithms and technologies made available by an array of third parties in Third Party Application Dependencies 350. Such Dependencies 350 can include voice recognition algorithms, speech synthesis algorithms, conversational linguistic analysis etc. Upon successful completion of the conducted conversation from Stage 348, Learned Information 333 concerning the contents of the call is submitted as modular output.

FIG. 10 shows LOM 132 as an Appchain 836 operating multiple functions the manage personal health as an artificially intelligent personal assistant. LOM 132 makes procedural references to Personal Intelligence Profile (PIP) 136 as well as Life Administration and Automation (LAA) 138. Case 352 is defined as “ordering future prescriptions and recommending vitamins”. PIP 136 will securely store any personal information concerning future prescriptions due to known conditions etc. LOM 132 can then make reference to such personal information, and it's generic medical knowledge stored in Central Knowledge Retention (CKR) 648, and information concerning third party suppliers to recommend available victims in Case 352. Case 354 is defined as “daily monitoring of key health parameters via interaction with third party applications”. Third Party Applications and Services 154 that connect to LOM 132 via LAA 138 can be used to monitor health parameters such as blood pressure etc. Case 356 is defined as “scheduling health/fitness exercise routine”. Personal information concerning schedules, habits and routines are stored in PIP 136, and hence LOM 132 can estimate optimal times and routines that are custom tailored for the UBEC User 106. Case 358 is defined as “Dietary recommendations and food purchase recommendations”. Information concerning the User's 106 metabolism, weight, height, health conditions are stored in an instance of PIP 136 as an Appchain 836. Therefore LOM 132 can make reference to it's medical knowledge stored in CKR 648, and LAA 138 can subsequently make food purchases via Back-End services that have been made available to it. Case 360 is defined as “scheduling future follow-on checkups”, which makes reference to PIP 136 and LAA 138, the operation of which lead to the initiation of the Automated Phone Call Process 332. Case 362 is defined as “serving as health life coach in all aspects of UBEC activities”, which makes heavy reference to personal information stored in PIP 136, generic knowledge stored in CKR 648, and interconnectivity of information, devices and services in LAA 138. Case 364 is “stress management recommendations”. Since LOM 132 has access to information concerning someone's schedule, LOM 136 can for-see stressful situations arising by interpreting multiple variables that are expected for the future. Hence LOM 132 can deliver recommendations to the UBEC User 106 via the UBEC Application 118 to manage large workloads and difficult/complex situations. Case 366 is defined as “Hobby/Work/Lifestyle Recommendations”, which makes reference to LOM's 132 ability to interpret schedules and recommend intelligent suggestions that increase the overall and longterm contentment of UBEC User 106.

FIGS. 11-21 articulate details concerning the inner mechanics of LUIGI 116. On FIGS. 11 and 12 UBEC Passthrough 368 receives information traffic that is occurring from UBEC as an Appchain 118. Upon analysis of such passing information it is returned to UBEC as an Appchain 118 via UBEC Comprehensive Return 388 to continue it's onwards journey and to reach it's intended destination within the UBEC Platform 100. The incoming information from UBEC Passthrough 368 is forwarded to LUIGI Task Delegation (LTD) 370 which determines if the data should be processed by LOM 132, LIZARD 120 or both. Such a Task Delegation 370 decision is performed with consideration of the type of incoming data as well as the abilities of LOM 132 and LIZARD 120. Therefore data processing is delegated by LTD 370 to either Knowledge Inquiries and Judicial Arbitration 372, which represents LOM 132, or Jurisdictional Enforcement and Intention Reader 376, which represents LIZARD 120. Dynamic API Customization (DAC) 384 enables the operation of modules 372 and 376 by Interpreting the Task Type 408 so that correct usage of LOM 132 and LIZARD 120 can be implemented.

FIGS. 13 and 14 contain a detailed diagram of DAC 384, which shows how both the LIZARD Usage API 402 and LOM Usage API 404 usage specifications are defined by the Appchains themselves. This allows for a Modular Instruction-Set 416 to be produced via DAC's 384 consideration of the task type at Stage 408. The Modular Instruction-Set 416 that is produced for Jurisdictional Enforcement and Intention Reader 376 informs LIZARD 120 at the LIZARD Input 414 Stage on how to process the Task Data-Set 412 accordingly. Therefore Modular Execution 418 of LIZARD occurs that leads to accurate and appropriate LIZARD Output 420. Such decisions and/or estimations reached by LIZARD 120 during Modular Execution 418 are forwarded to Intelligent Conclusion Unification (ICU) for consideration of alternate decisions and/or estimations that have been processed by LOM 132 in parallel. Thereafter LUIGI Corrective Action (LCA) 378 might be invoked to appropriately manage information access events and transactions that are occurring within the UBEC Platform 100. The same pattern of information processing that occurs for LIZARD 120 on FIG. 13 occurs for LOM 132 on FIG. 14. A similar Modular Instruction-Set 416 is provided by DAC 384 which allows for LOM Input 422 to receive and process the incoming Task Data-Set 412 from Task Reception 410. Such information processing leads to conclusion processing at ICU 374 which may lead to the enactment of corrective action at LCA 378.

FIG. 15 shows currency liquidity manipulation functions that belong exclusively to LUIGI 116 in Financial Liquidity Manipulation 382. The LUIGI Secure Enclave (LSE) 380 is a secure zone of information retention that only LUIGI 116 can access. Therefore there are no theoretically possible human observers of the contents of the LSE 380, as the permissions to write LUIGI's 116 code belongs exclusively to SPSI 130 and the permissions to execute LUIGI's 116 code belongs exclusively to LUIGI 116 itself. Inside the LSE 380 is a Retention Decryption Key 394 which allows LUIGI 116 to decrypt the Encrypted Retention of Private Keys 396. This allows the Fund Manipulation Mechanism (FMM) 400 to manipulate funds on the Watt Economy 862 of the Metachain 834 in a fund recovery session. Watt Liquidity Governor (WLG) 390 is a subset module of LUIGI 116 that monitors for and potentially blocks excessive spikes in liquidity movements going in and out of UBEC 100. This ensures a gradual and predictable economy within UBEC 100. Fund Movement Oversight (FMO) 392 is a subset module of LUIGI 116 that monitors and potentially blocks movements of liquidity that are correlated with fraud. Fund Recovery Mechanism (FRM) 398 is a subset module of LUIGI 116 that allows for the rightful owners of—U—(Watt Unit) funds to claim them from the Watt Economy 862 of the Metachain 834 if they were lost, stolen or otherwise mishandled. Proof of Authority 402 is a unique cryptographic key that is cryptographically guaranteed to be only produceable by LUIGI 116 due to LSE 380 logistics. Therefore Proof of Authority 402 is used to invoke an UBMA Chip 4260 to supply it's Security Sensitive Unique Private Key 4314 as illustrated in FIGS. 362 and 363.

FIG. 16 shows the functionality of LUIGI 116 to perform the “Verification of Submission+Maintenance of Appchains” 426. At Stage 428 a new application, or an update to an already existing application, is submitted to the UBEC App Store. Thereafter Stage 430 is executed which is when LUIGI 116 used LIZARD 120 technology to identify correct jurisdiction patterns so that it can understand if an application is needed in UBEC 110 or not. Therefore this manifests as LUIGI Task Delegation (LTD) 370 receiving such information concerning a new application commit from UBEC Passthrough 368. Jurisdictional Enforcement and Intention Reader 376, which is a logic container for the execution of LIZARD 120, can then estimate if the application commit should be Approved or Blocked. Hence Stage 432 indicates that LUIGI 116 either Blocks or Approves the application submission, which is an execution which manifests in LUIGI Corrective Action (LCA) 378.

FIG. 17 shows the functionality of LUIGI 116 to perform the “Verification of Contractual Conditions” 434. At Stage 436 LUIGI 116 processes a knowledge derived condition in a contract. At Stage 438 LUIGI 116 uses LOM 132 technology to interpret wether such a condition has been fulfilled or not. For example, this could be to verify that a certain person has passed away to therefore execute the requests listed in a digital Last Will & Testament. LOM 132 is able to perceive such condition fulfillments by leveraging it's generic knowledge in CKR 648, personal knowledge in PIP 136 instances, and external information (which is eventually integrated into CKR 648) via ARM 134. Therefore at Stage 440 LUIGI 116 processes the contract in accordance with the response given by LOM 132.

FIG. 18 shows the functionality of LUIGI 116 as a “Conflict Resolution Appeal System” 442. At Stage 444 LUIGI 116 collects and validates information concerning a transactional dispute. Thereafter at Stage 446 LUIGI 116 uses LOM 132 technology to derive a possible verdict on the matter. The execution process concerning Stage 446 occurs in Knowledge Inquiries and Judicial Arbitration 372 of FIG. 14. Therefore at Stage 448 LUIGI 116 enforces consequences concerning the dispute in accordance with a high confidence decision given by LOM 132. The execution process concerning Stage 448 occurs at LUIGI Corrective Action (LCA) 378.

FIG. 19 shows the capability of LUIGI 116 concerning “User Node Interaction with Virtual Obfuscation Behavior Monitoring”. At Stage 452 a user authenticates into the UBEC Platform 100 via User Node Interaction (UNI) 470. LUIGI 116 can thereafter seamlessly leverage LIZARD 120 technology to virtually obfuscate a User 106 from the real UBEC Platform 100 according to potential malicious behavior as indicated by Stage 454.

FIG. 20 shows the functionality of LUIGI 116 concerning “Appchain Merge Followup Verification” 456. At Stage 458 two versions of an Appchain are merged via the process defined in Customchain Synchronization & Reconciliation (CSR) 1208. At Stage 460 Merge Event Tracking (MET) 1836 tracks which BCHAIN Nodes 786 were involved with the merger. At Stage 462 the subsequent behavior of such involved nodes is tracked to potentially reverse such a merger if a conspiracy of malice is detected.

FIG. 21 shows the functionality of LUIGI 116 concerning “Lost Fund Recovery & Fraudulent Activity Reversal”. With typical blockchain currencies there is no recovery mechanism for funds that have been lost due to mishandling the key, data corruption etc.—U—(Watt units) are recoverable by appealing to an artificially intelligent LUIGI recovery system known as Fund Recovery Mechanism (FRM) 398. Initially at Stage 466 a user makes a claim of ownership concerning funds it does not have access to. Thereafter at Stage 468 LUIGI 116 uses it's internal module FRM 398 to verify the veracity of such a claim. The FRM 398 module depends on authentication technology from User Node Interaction (UNI) 470 and knowledge reconciliation technology from LOM 132.

FIGS. 22-26 show the functionality of User Node Interaction (UNI) 470. UNI 470 is the Identity and Access Management (IAM) mechanism for UBEC 118 that uses direct biometric data for authentication and does not reference any user names nor account containers. Nodes, data and services are directly tied to the user's biometric data to enhance security and simplify routines. Initially the UBEC User 106 provides streams of data to UNI 470 that contain measured biometric recognition data at Stage 472. Such biometric data can include, and is not limited to, Fingerprints 474, Eye Retina Scans 476, Voice Recognition 478, and DNA Samples of hair/skin etc. 480. With Voice Recognition, the UBEC User 106 is required to speak a randomly generated challenge sentence to mitigate attempts of a malicious actor using voice recordings to attempt to illegitimately login to the UBEC Platform 100. The provided biometric data is then transferred to Biometric Band Categorization (BBC) 482, which creates a rounded off version of the data which eliminates variations of biometric data measurement due to error margins in biometric data measuring equipment. Therefore for each biometric data input into BBC 482 a corresponding Band Authorization Token (BAT) 484 is produced as output. Thereafter a comparison is made between the newly generated BATs 484 and Authentication Tokens stored in the Band Association Appchain as indicated by Stage 486. UNI 470 inherently employs multi-factor authentication, therefore more than one biometric method of authentication is required before login permission can be granted.

FIG. 23 at Stage 490 the amount of biometric data provided is measured and checked if sufficient for the authentication process. The minimum threshold of biometric data required for authentication is defined in Static Hardcoded Policy (SHP) 488. On Condition 96 “No, amount is not enough” being fulfilled; the authentication attempt is rejected and hence the modular execution of UNI 470 ends as indicated in Stage 496. On Condition 98 being fulfilled “Yes, amount is sufficient”, the logic flow invokes Biometric Band Categorization (BBC) 482 for each instance of Biometric Data Input 472. Upon successful execution of BBC 482, the Band and Node Association Appchains are updated from the Customchain Ecosystem at Stage 494. Upon successful completion of Stage 494 a check is performed at Stage 486 to measure if a sufficient amount of BATs 484 match a single Authentication Token 514. The amount considered to be sufficient is defined in Static Hardcoded Policy (SHP) 488.

FIG. 24 continues the logic flow from Stage 494, where the Band and Node Association Appchains are updated to the latest version from the Customchain Ecosystem 540 via the BCHAIN Protocol 794. This ensures that the most accurate and up to date authentication information is available so that the authentication procedure can continue. Therefore the Band Association Appchain 500 and Node Association Appchain 502 are up to date and locally stored on the node (self) that is performing the UNI 470 procedure. Therefore Stage 486 checks if there is a single Authentication Token that exists in the Band Association Appchain 500. Upon successful matching and hence authentication, the node identities that are associated with the Authentication Token 514 are retrieved from the Node Association Appchain 502 as indicated in Stage 506.

On FIG. 25, successful authentication only occurs if a sufficient amount of Band Authorization Tokens (BAT) 484 match any single Authentication Token 514 from the Band Association Appchain 500 according to an amount defined in Static Hardcoded Policy (SHP) 488. Condition 96 indicates that not a sufficient amount of BATs 484 matched any single Authentication Token 514. Therefore Stage 512 is executed which rejects the authentication attempt and ends module execution. Condition 98 indicates that a sufficient amount BATs 484 matched any single Authentication Token 514. Therefore Stage 510 is executed which retrieves and decrypts the associated Authentication Token 514 from the Band Association Appchain 500. Therefore Stage 510 leads to Stage 506 which retrieves Associated Nodes List 518 that matches the Authentication Token 514 from the Node Association Appchain 502. Therefore Stage 506 leads to Stage 520 which packs the Authentication Token 514 and Associated Nodes List 518 into an Authenticated User Session 520. The Authenticated User Session 522 allows the UBEC User 106 to effectively login to the UBEC Platform 100 and hence UBEC Application 118 and have an associated exclusive Personal Intelligent Profile (PIP) 136 Appchain 836. Therefore the Authenticated User Session 522 is submitted as modular output at Stage 524, which concludes the execution run of UNI 470.

FIG. 26 shows a more detailed diagram of Biometric Band Categorization (BBC) 482. The purpose of BBC 482 is to make input biometric data usable for referencing by making the accuracy of such data more vague than the expected error margin of the Biometric Recognition equipment (e.g. fingerprint scanner etc.). Therefore BBC 482 initially receives Generic Biometric Input 526. A Granular Separation of the Input 530 is created at Stage 528. Such Granulator Separation 530 represents the Generic Biometric Input (data) 526 in a format the quantifies scopes of magnitude found within the Data 526. Therefore varying compositions of Biometric Data 526 that could be derived from a Fingerprint 474, Eye Retina Scan 476, Voice Recognition 478, or DNA Sample of hair/skin etc. can all be assembled in the same format 530 which highlights data points of high and low magnitude. Thereafter Stage 532 broadens the scope of such data points found in Format 530 to create Format 534. As illustrated in Reference 536 the Band Scope in Format 534 is intended to be greater than the expected error of margin that exists in typical biometric recognition devices. This leads to the ability of UBEC User 106 to authenticate themselves into the UBEC Platform 100 from any device anywhere in the world, without requiring a password to memorize nor a user account. Therefore the personal data of UBEC User 106 is inextricably tied to their biometric data and hence to the User 106 themselves. If Stage 532 were not to occur then the margin of non-calibration between various biometric devices would have prohibited UBEC User 106 from being able to constantly access their information and services from anywhere and anytime. Therefore Stage 532 leads to Stage 538 which stores the Band Categories produced in format 534 as a Band Authorization Token (BAT) 484 that is subsequently submitted as modular output.

FIGS. 27-28 show the base layer mechanics of Appchains 836 which forms the Customchain Ecosystem 540.

On FIG. 27 The Customchain Ecosystem 540 is a complex interaction of Appchains, Microchains, along with the single Metachain to produce an efficient and dynamically adaptable system of data retention and service along with program/routine execution which makes up the BCHAIN Network 110. The UBEC App Store 542 exists within the Customchain Ecosystem 540 to host, list and service UBEC Applications, such as UBEC Application A 544, that have already been vetted and approved by LUIGI 116. At Stage 546 the UBEC Enabled Device 548 selects and downloads UBEC Application A 544 from the UBEC App Store 542. Thereafter at Stage 550 the Execution Segments are collected from the Appchain A0 554 which correlates with the UBEC Application A 544. Thus the Execution Segments 551 collected from Stage 550 are sent to Execution Stream Collection (ESC) 6700 which assembles them into Execution Stream A0 556. The assembly performed by Execution Stream Collection (ESC) 6700 considers the correct order which the Execution Segments 551 need to be aligned into. This is because the order that which Execution Segments 551 exist within the chronology of the Appchain 836 (Appchain A0 554) does not necessitate the order in which the Execution Segments 551 should be executed to enact the desired program. Such execution of the Execution Segments 551 of Execution Stream A0 556 occurs at the module Execution Stream Rendering (ESR) 6400. In parallel to the processing and assembly of the Execution Stream A0 556 is the processing and assembly of Data Streams A0 and Z3 562. This is accomplished via Stage 550 leading to Stage 559 which collects the Data Segments 553 from Appchain A0 554 and submits them for sorting at Data Stream Sorting (DSS) 6800. Therefore the Data Segments 553 are sorted in a manner that leads to efficient data retrieval and retention, and thus the Data Streams A0 and Z3 562 are assembled by DSS 6800. Such Data Streams A0 and Z3 562 are referenced by ESR 6400 to correctly execute the commands listed in Execution Stream A0 556. Thus manipulation of referenced data can be accomplished by coded routines which acts as the building block for all Appchains 836 and hence modules (i.e. LOM 132, LIZARD 120 etc.) within the UBEC Platform 100.

On FIG. 28 Customchain Ecosystems 540 that are relevant to the UBEC Enabled Device 548 are shown in a basic form. Multiple Customchain Ecosystems 540 make up the greater BCHAIN Network 110. UBEC Application A 564 and UBEC Application B 566 each makeup their own Customchain Ecosystem 540. For each Customchain Ecosystem 540 that correlates with an application such as UBEC Application A 564 there is a Container Appchain as in Container Appchain A0 568. Such a Container Appchain acts as the initial source of information and instructions for rendering the Application. Therefore the Container Appchain can make reference to Execution Streams and Data Streams that are stored in Supplement Appchains, as in the Supplement Appchain Clusters 572 and 574. Therefore UBEC Application A 564 can make references to depend on Execution Streams and Data Streams that exist in UBEC Application B 566 by Supplement Appchain Cluster 572 making references to information (execution and/or data) stored in Supplement Appchain Cluster 574. Customchain Ecosystems 540 can also contain Independent Appchains that do not belong nor represent a specific UBEC Application such as Independent Appchain Cluster 576. Therefore separate Execution Streams or Data Streams can be extracted from Independent Appchains such as Independent Appchain Z3 577. Data is extracted from Independent Appchain Z3 577 by DSS 6800 according to instructions defined in Execution Stream A0 556 which leads to the assembly of Data Stream Z3 562 which leads to the correct and wholistic rendering of the selected Application in ESR 6400.

FIGS. 29-31 shows the process of UBEC Application Development and Deployment. On FIG. 29 UBEC User 106 interacts with the Logistics Manager Interface (LMI) 580 in a session that involves the User's 106 Input of Creativity 578 and decision making that constructs the overall structure of the Application. LMI 580 is a front-end interface for UBEC Users 106 to create applications and businesses via a logistics enabling toolset. Bi-directional arrows are shown between UBEC User 106, User Creativity and Input 578, and LMI 580 to indicate that LMI 580 returns design feedback to UBEC User 106 in an interactive construction session. Therefore LMI 580 outputs Logistics Layer 582, which is a generic information format that defines the Application logistics designed by UBEC User 106 via LMI 580. The Logistics Layer 582 is sent as input to the Customchain Ecosystem Builder (CEB) 584. CEB 584 automatically constructs the Logistical Application, as perceived by the UBEC User 106, by using the fundamental building blocks that consist of a Customchain Ecosystem 540. Therefore Customchain Ecosystem Builder Logic Flow 586 visually depicts the operation of CEB 584. Within the Logic Flow 586, initially the Current State of the Appchain 596 is interpreted at Stage 588. This means to interpret the relevant positions that Execution Segments 551 and Data Segments 553 exist in. Thereafter at Stage 590 the Execution Segments 551 are assembled into an Execution Stream 598, in the correct order to ensure the correct execution of the program by ESR 6400. Stage 590 is effectively processed by ESC 6700. The arrows that move from blocks of the Appchain 596 to Execution Segments of the Execution Stream 598 indicate that typically the later that an Execution Segment 551 exists in the Appchain 596 the later position it acquires for the Execution Stream 598. Despite this trend of chronological order of existence, it is still possible that a later block of the Appchain contains an Execution Segment 551 that is marked for earlier execution. The practical reason for this happening is that Applications built upon Customchain Ecosystems 540 can be incrementally updated and patched with bug fixes, new features, etc. Thereafter at Stage 592 the Data Segments 553 are collected and assembled into a Data Stream via DSS 6800 processing. Subsequently the Execution Stream 598 and Data Stream 600 are both submitted to Internal CEB Logic Processing 594, which houses and operates the main rudimentary logic that consists of CEB 584. On FIG. 30 the Internal CEB Logic Processing 594 is shown to output Execution+Data Supplements 596. Such supplements are intended to become stored in the newest block of the Appchain 602. Despite the newly added Execution Segment 551 being included in the newest block of the Appchain 602, it contains a priority flag of 2.5. This indicates to ESC 6700 to assemble the Execution Stream in a way that preserves the priority flags. This allows for CEB 584 to commit updates to the Appchain 602 to effectively modify any part or section of the Execution Stream 598 and Data Stream 600. The Data Segment 553 is also added to the Data Stream 600 with consideration of retrieval priority. CEB 584 can also add instructions to the Appchain 602 which effectively prohibits an Execution Segment 551 or Data Segment 553 from being included in the Execution Stream 598 and/or Data Stream 600. Such a prohibited Segment would still exist in the Appchain's block sequence, but would be ignored by ESC 6700 for Execution Segments 551 and DSS 6800 for Data Segments 553.

FIG. 31 shows the steps that follow upon process completion of CEB 584. Completion of CEB 584 leads to Stage 604 where new Execution and Data Supplements (as in element 596) to the Appchain begin processing within BCHAIN Network via New Content Announcement (NCA) 2544. This leads to the subsequent Stage 606 where the content is submitted to the Mempool Data Storage (MDS) 2472 of the miners, where it is eventually mined into the next block of the Appchain 602 via the Customchain Interface Module (CIM) 2470. Thereafter at Stage 608 the content of the newly mined block is cut into cache parts and is transferred to caching nodes via Mining Nodes Supplying Cache Seeding (MNSCS) 1850. Thereafter at Stage 610 the cache parts gradually and automatically migrate to service optimized areas which ensures the best uptime and download speed possible to nodes requesting the data. Stage 610 effectively occurs via the execution of the Cache Selection Algorithm (CSA) 2350. Thereafter at the final Stage 612 nodes claim the content from the caching nodes via Content Claim Generator (CCG) 3050. Once downloaded such nodes can execute the Execution Stream via ESR 6400 which leads to the manifestation of the intended application.

FIGS. 32-36 show LOM 132 operating as a series of Appchains 836 known to be a Customchain Ecosystem 540. The initial and primary element that defines LOM 132 is the LOM Container Appchain 614, which houses the core modules in the format of an Appchain 596. Such an Appchain 596 has it's Execution Segments 551 extracted via ESC 6700 to output the Execution Stream 596. This Execution Stream 596 practically manifests as the core modules that operate LOM 132. Such modules are Initial Query Reasoning (IQR) 618 which receives the initial question/assertion provided by the UBEC User 106 and subsequently leverages Central Knowledge Retention (CKR) 648 to decipher missing details that are crucial in understanding and answering/responding to the question/assertion. Survey Clarification (SC) 620 engages with UBEC User 106 to achieve supplemental information so that the assertion/question can be analyzed objectively and with all necessary context. Assertion Construction (AC) 622 receives a proposition in the form of an assertion or question and provides output of the concepts related to such proposition. Hierarchical Mapping (HM) 624 maps associated concepts to find corroboration or conflict in question/assertion consistency. HM 624 then calculates the benefits and risks of having a certain stance on the topic. Personal and General Data Merging (PGDM) 626; with any data request information is always accessed from CKR 648. If there are personal criteria in the data request then PIP 136 is referenced and builds upon main CKR 648 knowledge. Rational Appeal (RA) 628 criticizes assertions whether it be self-criticism or criticism of human responses by using CTMP 124 technology. Knowledge Validation (KV) 630 receives highly confident and pre-criticized knowledge which needs to be logically separated for query capability and assimilation into CKR 648. With Cross Reference Analysis (CRA) 632, information received is compared to and constructed considering pre-existing knowledge from CKR 648. This allows the new incoming information to be evaluated and validated according to what CKR 648 currently knows and doesn't know. Therefore the Execution Stream 596 manifests in reality once executed by ESR 6400.

On FIG. 33 UBEC Systemwide Logic 634 represent the LOM Container Appchain 614 interacting other Appchains 836 within the UBEC Platform 100. Therefore Data Segments 640 arrive from UBEC Systemwide Logic 634 to the LOM Container Appchain 614. The Data Segments 640 are processed by ESR 6400 in conjunction with the core logic of LOM 132 defined by the Execution Stream 598 and enumerated as the Modular Manifestation of Execution Stream 616. Such input Data Segments 640 manifest 636 as LOM Question/Assertion Input 638. Therefore the execution of ESR 6400, which in this instance is the effective execution of LOM 132, outputs Data Segments 642 which are returned back to the UBEC Systemwide Logic 634 as LOM's 132 formal response to the LOM Question/Assertion Input 638.

FIG. 34 shows how Central Knowledge Retention (CKR) 648 exists as it's own independent Appchain 650 as shown in Element 644. Hence CKR 648 as an Appchain 650 interacts in parallel with the LOM Container Appchain 614 to LOM 132 modules Assertion Construction (AC) 622, Hierarchical Mapping (HM) 624, Knowledge Validation (KV) 630, Personal & General Data Merging (PGDM) 626, and Cross Reference Analysis (CRA) 632. As illustrated with Appchain 650, the vast majority of the contents of the blocks are Data Segments 553 and the vast minority are Execution Segments 551, which is to be expected as CKR 648 is a complex and sophisticated database. Also shown is how Rational Appeal (RA) 628 from the LOM Container Appchain 614 interacts and depends on CTMP as an Appchain 124.

FIG. 35 shows an instance of Personal Intelligence Profile (PIP) 136 as an Appchain 654. Lesser blocks are shown in Appchain 654 to contrast it with the more blocks found in CKR's 648 Appchain 650. This is to be expected as the entire CKR 648 Appchain 650 will be much more vast in size than an instance of a PIP 136 Appchain 654. Each UBEC User 106 has their own independent PIP 136 Appchain 654. A PIP 136 Appchain 654 instance is shown to interact with the modules Cross Reference Analysis (CRA) 632 and Personal and General Data Merging (PGDM) 626 of the LOM Container Appchain 614.

FIG. 36 shows how the LOM 136 module Life Administration and Automation (LAA) 138 exists as a parallel Supplemental Appchain 658. Thus LOM's 132 Front End Services 660 and Back End Services 662 are endpoints of interaction with LAA 138 as an Appchain 658. In parallel, the LOM Container Appchain 614 provides the LOM Question/Assertion Input 638 it has received from the UBEC Systemwide Logic 634 to the Supplemental Appchain that Houses LAA 656.

FIGS. 37-39 show the Watt Unit (denoted as—U—) Currency Algorithm 666, which operates the major functions of liquidity concerning the medium of exchange used within the UBEC Platform 100 and BCHAIN Network 110. A Watt Unit is a cryptographic currency that retains intrinsic value as it is algorithmically pegged to the value of electricity, hence energy. Since energy is a precious commodity, this prevents large magnitudes of speculation and volatility to exist within the UBEC Platform's 100 economy. There is no fixed amount of Watt Units available in circulation (not deflationary model), as this would artificially limit the growth of the UBEC Platform 100 to a limited energy level. Instead, Watt Units are directly created and destroyed by it's sole governor LUIGI 116 as liquidity enters and exits the UBEC Economy. The Distributed Energy Price Survey (DEPS) 668 is a module that survey's BCHAIN Nodes 786 that can authentically report the current fiat currency price of electricity. Such Nodes 786 can be electric meters installed in houses that participate in the BCHAIN Network 110. Third Party Currency Exchange (TPCE) 672 is a module that acts as the logistical layer to manage buying and selling of fiat currency. This allows liquidity to flow into and out of the Watt Economy 862 of the Metachain 834. In TPCE 672 UBEC Users 106 that are seeking to selling and buying Watt Units are essentially paired together in an exchange. There are no lengthy delays in negotiations and market price discovery as the fiat currency value of a Watt Unit is pegged to the value reported by DEPS 668. Upon an UBEC User 106 buying an amount of Watt Units, a Verified Transaction Report 674 that details the amount purchased is sent to LUIGI 116. Upon LUIGI's 116 approval of the transaction, Stage 682 of a User buying Watt Units leads to Watt Unit Creation 688 in the LUIGI Economy Interface 686. Similarly, upon an UBEC User 106 selling an amount of Watt Units, a Verified Transaction Report 674 that details the amount purchased is sent to LUIGI 116. Upon LUGI's 116 approval of the transaction, Stage 680 of a User buying Watt Units leads to Watt Unit Destruction 690 in the LUIGI Economy Interface 686. Therefore all flows of liquidity into and out of the UBEC Platform 100 is governed by LUIGI's 116 Fund Movement Oversight (FMO) 392 module. For LUIGI 116 to Create 688 or Destroy 690 Watt Units it's module LEI 686 must receive identity information from Stage 692 concerning the nodes associated with the UBEC User 106 that are holding the funds. To maintain a functioning economy of data transferring, retention, and CPU processing within the BCHAIN Network 110, rates of various types of work that exists in the BCHAIN Protocol 794 are tracked at the Work to Watt Reporting (WWR) 670 module. Types of work that exist in the BCHAIN Protocol are mining the Metachain/Appchains/Microchains, Caching Content Parts, Network Routing (CCR/CCF), Data Refuge Finder, DC2 Emulation, Metachain Retention, Node Cache Verification, Diagnostic Log Retention. At Stage 676 a BCHAIN Node performs X work and thereafter reports the amount of watts that were consumed to perform X work to Work to Watt Tracking 860 of the Metachain 834 via WWR 670. The Watt Unit Minimum Fee Calculator (WUMFC) 684 references Work to Watt Tracking 860 of the Metachain 834 to calculate the minimum acceptable fee required to do work within the BCHAIN Network 110. At Stage 678 a BCHAIN Node 786 wants Y amount of work done (transferring data, storing data, etc.), therefore the node references the WUMFC 684 module. Any amount in excess of the minimum fee required facilitates more redundancy in data transfer and retention, hence leading to increased quality and reliability of such services.

FIG. 38 shows the same mechanics of Watt Unit buying and selling as FIG. 37 yet with integration of user authentication via User Node Interaction (UNI) 470. Upon successful authentication of the UBEC User 106, UNI 470 outputs the Authenticated User Session 522. The Authentication User Session 522 contains the Associated Nodes List 518 which is used by Stage 692. The Authenticated User Session 522 submitted by UNI 470 is also necessary for the Buying 696 and Selling 698 of Watt Units.

In FIG. 39 FMO 392 and the functions of LEI 686 require knowledge and access to the User Private Fund Allocation (UPFA) 718. Only LUIGI 116 and the UBEC User 106 can manipulate the funds held by the nodes defined in UPFA 718. Hence why the modules FMO 392 and LEI 686 operate within the jurisdiction of LUIGI 116. Allocation of funds in UPFA 718 are intelligently distributed across nodes according to their type (computer, phone, drone etc.), history, reliability etc. Such an intelligent allocation of funds is done to mitigate the risk of a node getting damaged/stolen etc. which would inadvertently cause the funds associated with the node to be lost. However the fallback mechanism is to use LUIGI's 116 Fund Recovery Mechanism (FRM). Yet FRM is a subjective process that may require a significant amount of time and may lead to the request being denied unrightfully. Due to these risks and shortcomings it is highly preferable for the UPFA system to intelligently allocate the funds to the most appropriate Nodes 786 to mitigate risk.

FIGS. 40-42 show the Cryptographic Digital Economy Exchange (CDEE), which is a marketplace for purchasing Applications as well as investing in them like public stocks. Upon successful authentication UNI 470 submits an Authenticated User Session 522 which enables automated 706 and manual 708 investment in Applications existing in the UBEC Platform 100. Stage 706 describes the UBEC User 106 authorizing Methodology for Perpetual Giving (MPG) 114 to automatically invest in appropriate Appchains. In contrast Stage 708 describes the UBEC User 106 manually exploring App Directory and Exploration (ADE) 710 to potentially select an investment. At Scenario 712 the UBEC User 106 invests in an Application by transferring from their private funds to the App Public Funds. At Scenario 714 a user withdraws an already existing investment from an App by transferring the value of their stake from the App Public Funds to their Private Funds. Private Funds are held and maintained by UPFA 718. Both Scenarios 712 and 714 lead to Stage 716 where the appropriate modifications to the App Investment Registrar (AIR) 722 are made.

FIGS. 41-42 shows how UBEC Apps that are listed in the App Directory and Exploration (ADE) 710 module can receive and send out liquidity in terms of investment. To accomplish movements of liquidity between an UBEC User 106 and an UBEC App, instances of four modules (as Appchains 836) are invoked: App Public Funds Allocation (APFA) 720, App Investment Registrar (AIR) 722, App Expenditure Tracking (AET) 724 and App Profit Distribution (APD) 726. At Scenario 712 a User 106 invests in an App by transferring from their Private Funds (UPFA) 718 to the App Public Funds via APFA 720. Thereafter Stage 716 occurs when the appropriate modifications to AIR 722 are made. Such modifications are made towards the appropriate App where an investment was made. The same pattern of events occurs when a withdrawal is made by the UBEC User 106 at Scenario 714. At Scenario 714 the UBEC User 106 withdraws an already existing investment from an App by transferring the value of their stake from the App Public Funds to their Private Funds (UPFA) 718. Like Scenario 712; Scenario 714 leads to Stage 716 occurring when the appropriate modifications to AIR 722 are made.

FIG. 42 shows the same UBEC App A 564 and UBEC App B 566, this time interacting directly with the UBEC User's 106 User Private Fund Allocation (UPFA) 718. App Expenditure Tracking (AET) 724 tracks all expenditures involved with the UBEC App and the UBEC Users 106 that manage the App. Therefore AET 724 acts as a form of public transparency for current and potential investors. AET 724 also sends expenditure information to App Profit Distribution (APD) 726. By referencing current market value and hence public funds from APFA 720, APD 726 can calculate profits and distribute them to the relevant investors (UBEC Users 106).

FIGS. 43-44 shows the interaction between the UBEC Platform Interface (UPI) 728 and Cache Work Acceptance (CWA) 742. Execution of UNI 470 leads to an Authenticated User Session 522 with UPI 728. Therefore the UBEC User 106 can use the Front-End User Interface 1148 to select an Economic Personality 740. The Economic Personalities 740 are detailed as follows: Personality A: Equalizer 732 is when Node 786 resources are consumed to only match what the UBEC User 106 consumes (if anything). Personality A 732 is ideal for a casual frugal consumer of a light to moderate amount of information transfer. Live streams such as VoIP calls (i.e Skype) and priority information transfers are minimal. Personality B: Profit 734 is when the Node 786 consumes as many local resources as possible as long as the profit margin is greater than X. Thereafter, to realize potential profits made, excess Watt Units can be traded for alternate currencies such as cryptocurrencies, fiat currencies, precious metals etc. Personality B 734 is ideal for a Node 786 that has been set up specifically to contribute to the infrastructure of the BCHAIN Network 110 for profit motives. Hence such a Node 786 would typically be a permanent infrastructure installation that runs from mains power as opposed to a battery powered device, and has powerful computer internals (wireless capabilities, CPU strength, hard disk size etc.). Personality C: Consumer 736 is when the UBEC User 106 pays for Watt Units via a traded currency (cryptocurrency, fiat currency, precious metals etc.) so that content can be consumed while spending less Node 786 resources. Personality C 736 is ideal for a heavy consumer of information transfer, or someone who wants to be able to draw benefit from the BCHAIN Network 110 but does not want the resources of their Device 786 to get depleted (i.e. smartphone drains battery fast and gets warm in pocket). Personality D: Altruistic 738 is when Node 786 resources are spent as much as possible and without any restriction of expecting anything in return, whether that be the consumption of content or monetary compensation. Personality D 738 is chosen by someone whose best interests are in the strength of the BCHAIN Network 110 (i.e. the core developers of the BCHAIN Protocol 794 can purchase and install nodes to solely strengthen the Network 110, and not to consume content nor to earn Watt Units). Therefore the selected Economic Personality 740 is submitted to Economically Considered Work Imposition (ECWI) 744 which operates within the jurisdiction of Cache Work Acceptance (CWA) 742.

FIG. 44 shows how CWSI 744 references the Watt Economy 862 of the Metachain 834 to determine the current Surplus/Deficit 746 of this Node 786 with regards to Watt Units earned. Therefore Current Work Surplus/Deficit 746 is forwarded to ECWI 744, which considers the selected Economic Personality 740 and the Surplus/Deficit 746 to evaluate if more work should currently be performed. Therefore Stage 748 assesses the resultant output of ECWI 744. Result 750 is described as: abstain from work, hence do not continue the BCHAIN processing concerning the CCR 2308 or CCF 2318. Result 752 is described as: perform more work, hence transfer the CCR 2308 or CCF 2318 to Cache Selection Algorithm (CSA) 2350 to continue with BCHAIN Processing. Node Interaction Logic (NIL) 2380 operates from the jurisdiction of Communications Gateway (CG) 2348 and provides the initial CCR 2308 or CCF 2318 which is being considered caching.

FIGS. 45-46 show an overview of the BCHAIN Protocol (BP) 794. On FIG. 45 Routing Logic (RL) 774 references major modules that handle data routing within the BCHAIN Network 110. Queued Information Broadcast (QIB) 2700 manages CCRs 2308 or CCFs 2318 that are due for broadcasting to other nodes. Such packets of information CCR 2308 and CCF 2318 are forwarded to Communications Gateway (CG) 2348 which is the exclusive layer of interface between the BCHAIN Protocol (BP) 794 and the Node's 786 Hardware Interface 762. Communications Gateway (CG) 2348 also forwards information concerning surrounding Nodes 786 to Node Statistical Survey (NSS) 778. NSS 778 tracks surrounding Node 786 behavior which causes the formation of four indices to be calculated: Node Escape Index 886, Node Saturation Index 888, Node Consistency Index 890, Node Overlap Index 892. Node Escape Index 886 tracks the likelihood that a Node 786 neighbor will escape a Perceiving Node's 786 vicinity. Node Saturation Index 888 tracks the amount of Nodes 786 in a Perceiving Node's 786 range of detection. Node Consistency Index 890 tracks the quality of Nodes 786 services as interpreted by a Perceiving Node 786. Node Overlap Index 692 tracks the amount of overlap Nodes 786 have with one another as interpreted by a Perceiving Node 786. The Perceiving Node 786 is the one that executes the instance of NSS 778 which is being envisioned in the descriptions. The resultant four variables 886, 888, 890, 892 are sent to Strategy Corroboration System (SCS) 770, which enforces Protocol 794 consensus amongst the Nodes 770. Hence rogue nodes with malicious intention or that are simply running an illegitimate alteration of the BCHAIN Protocol 794 are banned from participating in consensus and work completion. Dynamic Strategy Adaptation (DSA) 772 receives the NSS 778 variables to dynamically alter the Strategy Deployment 916 which are based off of the calculated Strategy Criteria Composition 992. The Strategy Criteria Composition 992 contains a wide array of variables that inform core, important, and supplemental elements of the BCHAIN Protocol 794 how to operate. The Strategy Deployment 916 is produced by DSA 772 and then referenced by QIB 2700 and CG 2348, amongst many other modules that operate within the BCHAIN Protocol (BP) 794. Registered Appchains 776 contain cryptographic access keys of various Appchains 836 (typically, the Appchain Container of an UBEC Application). Therefore when an update to an Appchain 836 is announced on the Metachain's 834 Appchain Updates 846, their device 786 will download the newest updates to the Appchain 836. This will manifest as a Cryptographic Proof of Entitlement 2314 which originates from the cryptographic keys stored in Registered Appchains 776. Cryptographic Core (CC) 768 contains all of the major libraries that operate all of the major cryptographic functions that operate the BCHAIN Protocol 794, such as the Merkle Tree Calculator (MTC) 1338 etc.

FIG. 46 shows how the BCHAIN Protocol 794 operates with it's own hardware and the hardware of other BCHAIN Nodes 786. The Protocol 794 is executed via API End-points 792 that interface with Communications Gateway (CG) 2348. The drivers that interface with the Hardware Interface 762 exist and are executed within the Operating System 790. Therefore CG 2348 is able to send and receive CCR 2308 and CCF 2318 packets to other BCHAIN Nodes 786. Such a transmission of information can occur via peer-to-peer communication directly between Nodes 786, or routing by centralized systems such as the legacy internet. The Hardware Interface 762 of the BCHAIN Node (BN) 786 acts as the logical layer that receives hardware instructions. Thus the physical manifestation of the hardware exists at Hardware Device 780, which houses the optional UBEC/BCHAIN Microchip Architecture (UBMA) 4260 Processor. Such a Processor 4260 increases the speed and efficiency of execution of the BCHAIN Protocol 794. This leads to better battery life performance amongst mobile devices 786, and faster execution of Appchains 836.

FIG. 47 illustrates the paradigm of Node 786 interaction that exists within the BCHAIN Network 110. The Metachain 834 is a Customchain (similar to a blockchain) which contains metadata that all nodes on the BCHAIN Network 110 connect to for essential and primary referencing. The Metachain 834 does not deliver actual content yet tracks fundamental information which contains Node 786/Sector 884 locations, content demand tendencies and hop routing to streamline the infrastructure setup. Therefore it is required for every single BCHAIN Node 786 to participate in reading the Metachain 834. Appchains 836 are Customchains which act as advanced smart contracts for delivering information via the infrastructure that has been organized by the Metachain 834. Appchains 836 can reference each other for input/output in parallel and nested structures also known as a Customchain Ecosystem 540. Microchains 838 are Appchains 836 that are automatically converted to a Customchain that does not depend nor connect to the Metachain 834. This occurs when the Nodes 786 that participate in a certain Appchain 836 are isolated in location. Microchains 838 allow for small IoT 102 devices to participate in the BCHAIN Network 110 without having to keep up with the Metachain 834, which is resource burdensome. Diagram 796 illustrates the Old Paradigm of content serving which is indicative of the legacy internet. Client only devices make requests to a single server, or cluster of servers, that can become a single bottleneck in scaling for increased content demand (e.g. web traffic). The server, or cluster of servers, represents a single point of failure and point of attack. Hence Distributed Denial of Service (DDoS) attacks have become an effective weapon throughout the legacy internet, which leads to coercion, blackmail, censorship etc. The static setup of the centralized server also leads to the inefficient geographic distribution of content, as secondary layers of geographic load balancing need to be setup which can be relatively expensive and inefficient. The New Paradigm of Decentralized Content 798 represents the base mechanics of the BCHAIN Network 110. Because the server and client have been extricably and irrevocably joined together, this leads to the high availability and distribution of content where required. Hence geographic load balancing of content serving is built into the BCHAIN Protocol 794. Since there isn't a single point of failure nor attack, high availability and redundancy are natural byproducts of the BCHAIN Network 110. Therefore any DDoS attack by Rogue Nodes 806 that possess a minority of the networking hardware will be unable to leverage a successful attack upon a targeted set of content (like a specific Appchain). Furthermore, the BCHAIN Protocol 794 prohibits Nodes 786 from selecting or banning specific Appchains 836 or Microchains from being hosted. Hence the BCHAIN Protocol 794 favors harmony and cooperation in hosting and distribution, whilst the UBEC Platform 100 layer manages judicial aspects of befitting censorship and content management via LUIGI 116.

FIG. 48 shows how hash announcement exchange corroboration prevents a Rogue BCHAIN Node 806 from participating in the BCHAIN Network 110. With Rogue Node Traffic Spam 800, the Rogue Node 806 is shown trying to pretend to be a legitimate BCHAIN Node 786 whilst spamming the legitimate Nodes 786. To prevent this from occurring, the mechanism illustrated in Node Hash Reality Verification 808 shows how Legitimate Nodes 786 can detect Rogue Node's 806 abusive behavior and therefore put it on a blacklist. Rogue Node 806 broadcasts to neighboring Nodes 786 a Hash Announcement 802 which is required for participation of the BCHAIN Network 110 and recognition by neighboring Nodes 786. The Hash Announcement 802 is derived from interpretations of Node Statistical Survey (NSS) 778 variables. Therefore, Nodes 786 only participate with each other if they have the same interpretation of the local network state. If a Rogue Node 806 should lie about it's criteria for interpreting the current state of the network and act in an abusive manner (spamming nearby Nodes 786 etc.), then it will be known to the Legitimate Nodes 786 that Rogue Node's 806 Traffic behavior is in Excess of the Declared Strategy Limit 804. Therefore as long as the majority of the Nodes 786 in a local area or Sector 884 are Legitimate Nodes 786 that operate unmodified versions of the BCHAIN Protocol 794, they will reach a consensus concerning Traffic and Operation Limits and therefore will blacklist any Nodes 786 that either exceed the limits, or do not join the consensus about such limits. The limits are cryptographically represented within the Hash Announcement 802.

FIG. 49 shows the basic traveling pattern of a CCR 2308 or CCF 2318 packet within the BCHAIN Network 110. The journey begins at the Immediate Target 2302, which means the immediately next Node 786 that the CCR 2308 or CCF 2318 packet should transfer to. The packet will keep jumping between Nodes 786 towards the Final Target 2306. Each Node 786 will consider the packet's position along it's overall journey. If the criteria defined in Strategy Deployment 916 known as Parallel Hop Spread Criteria 1002 has been met, then the Node 786 invokes Parallel Hop Logic (PHL) 2922 out of compliance to the BCHAIN Protocol 794. This leads to the specific Nodes 801, 802, and 805 initiating more Parallel Hop Paths than they received. This leads to a redundancy in Hop Paths concerning the traveling CCR 2308 or CCF 2318. This is done primarily to decrease the time it takes for the CCR 23 or CCF to reach the Final Target 2306. The reliability and confidence in expectation of the packet arriving within a predictable time frame also increases as the amount of Parallel Hop Paths increases. This is because there is an expected amount of Node 786 presence chaos that naturally occurs within the BCHAIN Network 110. Such chaos exists due to the decentralized nature of Nodes 786 that have varying characteristics and perform work upon a volunteer best-effort basis. Redundant Parallel Hop Pathways mitigates the risk presented by such chaos by increasing the chances that at least the minimum amount of required pathways reaches the Final Target 2306 without a significant interruption from chaos. If there were too few Parallel Hop Pathways then it would be expected that the chaos would delay the majority of them, hence the CCR 2308 of CCF 2318 would arrived delayed. In addition, the Final Target 2306 can receive a confirmation originating from a decentralized consensus due to the redundant Parallel Hop Paths being initiated by PHL 2922. Therefore it may be hardcoded into Static Hardcoded Policy (SHP) that for a CCR 2308 or CCF 2318 packet to be accepted at it's destination Node 786, it must arrive from at least three separate Parallel Hop Paths. This removes the already weak chance that a Rogue Node 806 sabotaged the contents of the CCR 2308 or CCF 2318 during its journey. Any number for the minimum requirement of Parallel Hop Paths that is the most productive for the BCHAIN Network 110 can be chosen. If a number too low is chosen, it increase the chance of a Rogue Node 806 sabotage attack. If the number is too high, it will add much more resource stress to the BCHAIN Network 110 as a whole. A number that is too high would also prevent Nodes 786 that are very near each other from trusting each other with information except if they were to submit the CCR 2308 or CCF 2318 packet around a long detour trip so that parallel hop paths can be initiated for corroboration purposes. Therefore the tradeoff between security/speed/reliability and resource consumption exists within the BCHAIN Network 110. Such a tradeoff also experiences what is known as the Law of Diminishing Returns. Hence an initial increase in the Redundant Parallel Hop Pathways is expected to yield a greater increase in security/speed/reliability than an increase performed on an already high number of Redundant Parallel Hop Pathways. Therefore there comes a stage when an excessive amount of Redundant Parallel Hop Pathways yield's a trace increase security/speed/reliability yet burden's the BCHAIN Network's 110 resources a lot. Hence the Over-Parallelized Hop Path Reduction (OPHPR) 3000 module is incorporated into the BCHAIN Protocol 794 to detect Parallel Hop Pathways that have become an inefficient burden on the System 110 and should be ceased from continuing their onwards journey. The illustration shows Node 807 doing this for a Parallel Hop Pathway that was initiated by Node 803. A Node 786 knows when to cease a Parallel Hop Pathway by referencing the Parallel Hop Reduction Criteria 1004 Strategy Deployment 916. Different UBEC Applications may require a higher priority for CCR 2308/CCF 2318 transmission hence a higher amount of Parallel Hop Pathways. Such an Application or usage can be live audio/video streaming, which would require the lowest latency possible hence the most Redundant Hop Pathways possible. The amount of redundant Parallel Hop Pathways that are spawned depends on the size of the Watt Unit fee that was pre-authorized for the CCR's 2308 or CCF's 2318 Economic Authorization Token (EAT) 994.

FIG. 50 shows two functions of the BCHAIN Network's 110 Adaptive Intelligence in effect. Such functions allow for the BCHAIN Protocol 794 to take advantage and caution of the physical movements of Nodes 815. The first function is for the Nodes 786 participating in the CCR 2308/CCF 2318 packet journey that was initiated by Node 809 and parallelized by Node 811 to perceive the disruptive movement of the Nodes 786 that exist on the Vehicle Road 813. Whilst forwarding the packets onwards, Nodes 786 favor Node 786 neighbors that lean on the left side of the road, to mitigate the expected movement that Nodes 815 will have in moving the data physically to the right. This function also means Node 811 substantially increases the amount of Redundant Parallel Hop Pathways before Vehicle Road 813 to increase the chances of successfully crossing the Road 813 to Node 817 that is the acting Final Target 2306. Therefore the CCR 2308/CCF 2318 packet that was sent by Node 809 is able to successfully reach it's Final Target 2306 Node 817 with minimal obstruction from the physical movement of Nodes 815 within Road 813. The second function is for the BCHAIN Protocol 794 to take advantage of the physical movements of Nodes 815 amongst the Vehicle Road 813 moving to the right. Such Nodes 815 can be smartphones running the UBEC Platform 100 being in the pocket of UBEC Users 106 that are driving their cars to work during their daily morning commute. Such functionality of leveraging the physical movement of Nodes 786 is processed by the modules Physical Data Migration Layer (PDML) 3850 and Physical Data Migration Usage (PDMU) 3851. This Physical Migration functionality allows for overall increased throughput in the system, as physical movements of Nodes 786 are made to work in favor of the efficiency of the Network 110 rather than against it. This can be of tremendous benefit to large scale movements of data, typically between large enterprises. For example, if a large company wanted to send 10 Petabytes of corporate data from their West Coast branch to their East Coast branch; PDML 3850 could heavily reduce the long term data transfer from three months to two months.

FIG. 51 shows a known ‘highway’ of recommended travel between multiple Sectors 884 within the BCHAIN Network 110. Sectors 884 are clusters of BCHAIN Nodes 786 that logistically facilitate orientation and travel routing within the BCHAIN Network 110. At any given time any BCHAIN Node 768 falls under the jurisdiction of exactly two Sectors 884. The only known exception is if a BCHAIN Node 786 has too few or zero Node 786 Neighbors. Definitions of Sectors 884 are derived from the Dual Scope Hash 4134 generated by Traffic Scope Consensus (TSC) 4090. Therefore the module Optimized Sector Route Discovery (OSRD) 3430 interprets the geographical state of the BCHAIN Network 110 as defined on the Metachain 834 and produces Optimized Sector Routes 858 which are effectively highways of information. Such information is submitted to Optimized Sector Routing 858 of the Metachain 834. An example Route of Optimized Sector Routing 858 is illustrated on FIG. 51, showing the identities of the two Sectors 884 which contain the highway between them, and how a Proposed Baseline Hop Path (PBHP) 2322 contains the routing instructions for following such a highway. Statistical information such as Pathway Strength (effectiveness) and Pathway Saturation (demand/usage) are included in Optimized Sector Routing 858 of the Metachain 834. Optimized Sector Routes 858 are used to enable efficient pathfinding throughout the BCHAIN Network 110. Therefore a Node 786 need only manually calculate, via Location Association of the Metachain 834, a pathway to and from the Optimized Sector Route 858 (highway). Hence long distance transmission of CCR 2308 and CCF 2318 packets are made highly efficient and repeatable with minimal overhead and repetition cost.

FIGS. 52-53 show Staggered Release Content 808 and Live Stream Content 814, which are two methods for transferring information across the BCHAIN Network 110. On FIG. 52 shows Staggered Release Content 808 which is the main method employed by the BCHAIN Protocol 794 to request and fulfill content requests. Hence a BCHAIN Node 786 uses Content Claim Generator (CCG) 3050 to generate a Content Claim Request (CCR) 2308 which is ultimately sent to the Final Target 2306 Node 786. Therefore the CCR 2308 is equipped with dynamically generated and altering information such as the Proposed Baseline Hop Path (PBHP) 2322 and Trail Variable Suite (TVS) 2320. The PBHP 2322 contains routing information concerning the proposed sequence of nodes to hop to, to eventually reach the Final Target 2306. The TVS 2320 contains dynamic information concerning logistics management of delivering the CCR 2308. Such elements of logistics management include the Economic Authorization Token (EAT) 994 and a Strategy Deployment 916 instance that is referenced throughout travel within a specific Sector. The CCR 2308 travels via Nodes 786 that exist within Intermediate Nodes 812. Upon the CCR 2308 successfully arriving the Final Target 2306 Node 786, such a Node 786 executes Content Claim Delivery (CCD) 3260 to attempt to fulfill the content request made by the requesting Node 786. Therefore a Content Claim Fulfillment (CCF) 2318 packet is sent in return, which travels via the Intermediate Node 812 to the requesting Node 786. Thereafter the CCF 2318 is processed by Content Claim Rendering (CCR) 3300 according to the appropriate and relevant method of rendering the fulfilled data. Content Claim Rendering (CCR) 3300 makes use of Stagger Release Content Cache (SRCC) 810 to hold content parts until the entire content unit can be fully rendered.

FIG. 53 shows Live Stream Content 814 which differs in mechanism compared to Staggered Release Content. The Live Stream Content 814 mechanism does not make use of Content Claim Requests (CCRs) 2308 so as to reduce latency and increase throughput throughout the UBEC Network 110 for specific applications (i.e. live audio calling). Hence Content needs are filled via CCFs 2318 to Nodes 786 that request such Content according to the implication of their description and jurisdiction. Therefore the module Jurisdictionally Implied CCF Submission (JICS) 4194 operates at a BCHAIN Node 786 that perceives the jurisdictional need of content delivery of another Node 786. Hence a CCF 2318 is submitted via Intermediate Nodes 812 without an accompanying CCR 2308. The CCF 2318 is received and validated at the Final Target 2306 Node 786 by Jurisdictionally Accepted CCF Reception (JACR) 4208 and thereafter rendered by Content Claim Rendering (CCR) 3300. Most Applications that make use of JICS 4194 and JACR 4208 will not require the invocation of the Stagger Release Content Cache (SRCC) 810 module as the CCF 2318 will most likely be immediately rendered as in a live audio/video call etc.

FIGS. 54-55 show how Hash Announcement 802 exchanges between BCHAIN Nodes 786 leads to Protocol 794 consensus.

On FIG. 54 from within the UBEC Application 778, the Strategy Corroboration System (SCS) 4080 uses the Traffic Scope Consensus (TSC) 4090 module to derive a Dual Scope Hash 4134 collection. The makeup of the Dual Scope Hash 4134 is ultimately derived from the four variables produced by Node Statistical Survey (NSS) 778; Node Escape Index 886, Node Saturation Index 888, Node Consistency Index 890, and Node Overlap Index 892. Such variables are derived by NSS 778 from External Traffic Behavior 816. Due to the cooperative programming of BCHAIN Nodes 786 that operate the authentic and complete version of the BCHAIN Protocol 794, the BCHAIN Network 110 in it's entirety is heavily resistant to DDoS Attacks. In a legacy DDoS attack on the internet, malicious actors spam UDP packets to selected servers which overwhelms their hardware/software capacity. In contrast, the BCHAIN Network 110 is constantly adapting to variations in supply and demand. Because all traffic within the BCHAIN Network 110 is tracked, accounted for and billed, an attempted DDoS attack to spam a node or cluster of nodes would simply contribute to the economy of the BCHAIN Network 110 rather than cripple it's infrastructure. In addition, all applications executed over the BCHAIN Network 110 operate within the UBEC Platform 100 and are assessed for meaningful purpose by LUIGI 116 via LIZARD 120 technology. Hence multiple preventative measures have been employed to mitigate against network spam and abuse.

On FIG. 55 the Hash Announcements 824, 826, 828, and 830 are shown being exchanged between three different traffic areas known as Sectors 884. Each Node 786 perceives of two hashes due to the algorithm that is executed in Traffic Scope Consensus (TSC) 4090. The Dual Hash Recognition Logic requires that at least one of the two hashes matches for two nodes to be able to communicate with each other. Due to the rounding down/rounding up logic employed in TSC 4090, a node is able to traverse to different network environments while maintaining consensus with other nodes. This is due to the fact that just one hash is able to change at a time, hence the node is bound to have an overlap with at least one hash with surrounding Nodes 786 if they are operating utilizing the legitimate BCHAIN Protocol 794 (as opposed to rogue software that attempts to hijack the Protocol 794). The correctly derived hashes for Traffic Area A 818 (Sector 884 A) are A1 and A2. The correctly derived hashes for Traffic Area AB 820 (the overlap of Sectors 884 A and B) are A1, A2, B1, B2. The correctly derived hashes for Traffic Area B 822 (Sector 884 B) are B1 and B2.

FIG. 56 shows the structure of Customchain Storage (CS) 832, which is local storage of Customchains. Customchains are advanced Blockchains that have added capabilities such as smart contract execution, referencing and dependencies of other parallel Appchains 786, and Split Customchain Merging. Split Customchain Merging is when the Customchain has split into two because of a geographic separation of nodes, and hence the [module] is able to merge them back together whilst reconciling the differences in newly mined data. The Metachain 834 is a Customchain which contains metadata that all nodes on the BCHAIN Network 110 connect to for essential and primary referencing. The Metachain 834 does not deliver actual content yet tracks fundamental information which contains Node 786/Sector 883 locations, content demand tendencies and hop routing to streamline the infrastructure setup. Hence the Metachain 834 can be described as a distributed database which manages the infrastructure allocation of the BCHAIN Network 110. Metachain 834 offers hooks of information updates to trigger relevant events concerning Appchains 836. Hence instant notification systems (i.e. phone calls, instant messaging) can be programmed into an Appchain 836 by referencing the Metachain 834 as a master synchronization layer. There is only one Metachain 834 which all Nodes 786 must participate in reading and most must participate in mining. Location Association 840 of the Metachain 834 Contains an entry from every single Node 786 that is connected to the Metachain 834. Each entry contains a declaration from such a Node 786 of what it's neighbors are. This typically indicates physical neighbors that are in proximity of that Node's 786 wireless range, but this could also mean Nodes 786 that are interconnected via BCHAIN Legacy Hosts which operate via the internet (wireline/wireless). Sector Association 842 contains an entry from every Sector 884, which is a geographical collection of Nodes 786 within set boundaries. Each Sector 884 declares it's perceived Sector 884 neighbors which allows for advanced routing algorithms to plot efficient pathways to and from Specific Nodes 786. Diagnostic Node Location 844 contains the identities of Nodes 786 that have declared themselves to be self-imposed Diagnostic Nodes. Diagnostic nodes can be either unconfirmed or confirmed in regards to the execution of their claimed role. Appchain Updates 846 contains Appchain 836 unique identifiers for each registered Appchain 836, along with a timestamp indicating the last time an update was made. This way Nodes 786 can monitor the Metachain 834 for Appchains 836 that they are registered with, like a realtime notification system, and thereafter fetch the actual content directly from Nodes 786 that contain Appchain Cache Content. Appchain Cache Location 848 contains Node 786 and Sector 884 unique identifiers for nodes that have content stored for a certain Appchain 836. Therefore if a Node 786 is seeking information that has been posted to an Appchain 836 it has registered for, it can check this section of the Metachain 834 for the whereabouts of that content. Appchain Miner Location 850 tracks the relative location of Nodes 786 that have self imposed upon themselves the jurisdiction of mining an Appchain 836. This allows nodes to broadcast information via New Content Announcement (NCA) 2544 to target Miners that validate the new information and include it in the next block of the Appchain 836. Appchain Demand 852 contains information pertaining to the popularity of an Appchain 836 according to what Sectors 884 are claiming it's content. Therefore Appchain Cache Locations 848 can be appropriately discovered. Sector Demand 854 contains information pertaining to information traffic weight within a Sector 884. This enables the Metachain 834 to track which Sectors 884 are experiencing heavy information demand and which ones are not. Therefore subsequent algorithms that operate the BCHAIN Protocol 794 can fine tune the supply of infrastructure to meet demand. Chaotic Environment Tracking 856 tracks which nodes are considered unreliable due to the NSS 778 variables that they exhibit. This could mean they have a high Node Escape Index 886, which indicates that they do not consistently reside in the same location. Optimized Sector Routing 858 contains recommended Proposed Baseline Hop Pathways (PBHP) 2322, which are the perceivably most efficient routes between Sectors 884. Hence by using this information a single Node 786 can plan an efficient route to its destination without a heavy amount of CPU resource consumption. Work to Watt Tracking 860 keeps track of various ratios concerning different types of BCHAIN Node 786 work type performed, and the amount of electric watts it took to perform them. Watt Economy 862 tracks the deficit or surplus of Watt Units (—U—) for every known Node 786. Therefore information transfer work done in the BCHAIN Network 110 is tracked, thereby each Node 786 can be properly compensated and charged for content consumption and work done. Sector Emergency Funds 864 represents funds of Watt Units that are redeemable with the Watt Economy, and can only be spent by a consensus decision amongst confirmed miners from the Sector 884 to which the funds belong to. The funds are reserved for spending on preserving data which approaches a risk of permanently losing integrity. Appchains 836 are Customchains which act as advanced smart contracts for delivering information via the infrastructure that has been organized by the Metachain 834. Appchains 836 can reference each other for input/output in parallel and nested structures known as Customchain Ecosystems 540. Therefore standard information exchanges such as email, text messaging, live calling and video streaming can be programmed into Appchains 836 with varying intervals on mining blocks due to resource load and synchronicity trade offs. An example of an Application that can be converted to an Appchain 836 is the Uber Driving Application. The management of a freelance car driving service can be completely managed in a decentralized manner with driver/passenger assignment and oversight performed via elaborate smart contracts manifested as an Appchain 836. Origination Node Tracking 870 tracks when a CCR 2308 or CCF 2318 originates from a Node 786 concerning a specific Appchain 836. This enables the Information Transfer Isolation Index (ITII) 3218 to be calculated and hence Nodes 786 can discern whether to vote for the Appchain 836 to be converted to a Microchain 838 or not at the Microchain Switch Index 872. The Microchain Switch Index 872 registers votes from Nodes 786 that have cryptographic access to this Appchain 836 on whether this Appchain 836 meets the criteria requiring conversion to a Microchain 838. When a specified majority of votes indicates a switch, the information uploading and downloading will occur on the Microchain 838 version, and hence anyone that doesn't comply with the will of the majority will be left out from the information updates. This would happen because no information updates are submitted to the Metachain 834 for Microchains 838. Microchains 838 are Appchains 836 that have been automatically converted to a Customchain that does not depend nor connect to the Metachain 834. This occurs when the nodes that participate in a certain Appchain are isolated in location. For example this conversion is expected to occur in a corporate office where an employee only Appchain 836 is being run. The BCHAIN Protocol 794 will detect that the information transfer has a high degree of geographical isolation (without referencing GPS co-ordinates), and thereafter convert the Appchain 836 to a Microchain 838 for the purpose of achieving resource consumption efficiency. The prior Metachain 834 functionality is replaced with the Metachain Emulator 882 which resides within the Microchain 838, hence the general public of Nodes 786 do not need to bear the burden of processing information that is transferred within isolated and obscure routes that they don't intend on accessing. Therefore any mention of the Appchain 836 functionality or presence within the specifications of the BCHAIN Protocol 794 is interchangeable and compatible with a Microchain 838. Origination Node Tracking 880 tracks when a CCR 2308 or CCF 2318 originates from a node concerning a specific Microchain 838. This enables the Information Transfer Isolation Index (ITII) 3218 to be calculated which in turn enables Nodes 786 to vote on whether the Microchain 838 should be converted back to an Appchain 836 or not. Metachain Emulator 882 is a placeholder for the entire Metachain 834 that is stored within the Microchain 838. This way the BCHAIN Network 110 makes the same information requests and modifications to this Metachain Emulator 882 as it would for the normal Metachain 834 when dealing with an Appchain 836 that has been converted to a Microchain 838.

FIGS. 57-58 shows Node Statistical Survey (NSS) 778.

On FIG. 57 NSS 778 gathers information concerning the behavior of surrounding Nodes 786 to calculate four major indexRs 886, 888, 890, 892. This in turn informs modules that operate the core functions of the BCHAIN Protocol 794 about the state of the BCHAIN Network 110 in regards to Node 786 activity and behavior. Therefore useful functions are derived such as consensus on Sector 884 makeup etc. The Node Interaction Logic (NIL) 2380 module operates as a subset of Communications Gateway (CG) 2348 and interacts with the Hardware Interface 762 via Operating System 790 and API Endpoints 792. A ping is a network interaction with foreign hardware. Therefore all of the pings related to Nodes 786 in the immediate vicinity of the Node 786 that is executing the instance of NSS 778 are forwarded to Node Ping Processing (NPP) 894. Node Activity DB (NAD) 896 is a local database that retains raw data in regards to Node 786 ping activity. NAD 896 becomes the primary source of information for NPP 894 to perform Operational Queries 904 that leads to the Index Calculation 906 of the Node Index Variables 912 collection. Node Escape Index 886 tracks the likelihood that a Node 786 neighbor will escape a perceiving Node's 786 range of detection. A high Escape Index 886 indicates a more chaotic environment which will require refined strategies to tackle. Examples: Smartphones in cars that are on a highway will exhibit a high Node Escape Index 886. A refrigerator in a Starbucks will exhibit a very low Node Escape Index 886. Node Saturation Index 888 tracks the amount of Nodes 786 in a perceiving Node's 786 range of detection. A higher saturation index indicates a crowded area with a lot of Nodes 786. This can have both positive and negative impacts on performance due to supply/demand trade offs, yet a higher density Node 786 area is expected to be more stable/predictable and hence less chaotic. Examples: A Starbucks in the heart of New York City has a high Node Saturation Index 888. A tent in the middle of a desert will have a very low Node Saturation Index 888. Node Consistency Index 890 tracks the quality of Node 786 services as interpreted by a perceiving Node 786. A high Node Consistency Index 890 indicates that surrounding neighbor Nodes 786 tend to have more availability uptime and consistency in performance. Nodes 786 that have dual purposes in usage tend to have a lower Consistency Index 890, while nodes that are dedicated to the BCHAIN Network 110 exhibit a higher value. Examples: Nodes 786 that have a dual purpose such as a corporate employee computer will have a low Consistency Index 890 since it has less resources available during work hours, and more resources available during lunch breaks and employee absence. Node Overlap Index 892 tracks the amount of overlap nodes have with one another as interpreted by a perceiving Node 786. While the Overlap 892 and Saturation 888 Indices tend to be correlated, they are distinct in that the Overlap Index 892 indicates the amount of common overlap between neighbors and the Saturation Index 888 only deals with physical tendency. Hence a high Saturation Index 888 with a long wireless range on each device will lead to a high Overlap Index 892. Examples: Devices start entering certain Sectors 884 of the BCHAIN Network 110 with the new UBEC/BCHAIN Microchip Architecture (UBMA) 4260 processor installed, which has a high gain directional antenna with advanced beamforming technology. Hence the Overlap Index 892 increases in those Sectors 884 due to Nodes 786 having a more overlapped communications structure. With Significant Node Detection (SND) 898, Nodes 786 with abnormal and/or informing characteristics are highlighted to facilitate the calculation of the intended indices.

On FIG. 58 the details of Node Ping Processing (NPP) 894 are shown. Node Ping Records 908 are containers of information that are submitted by Node Interaction Logic (NIL) 2380 as a subset of Communications Gateway (CG) 2348. There are initially received at Incoming Traffic 902. Each Node Ping Record 908 contains the identity concerning the relevant Node 786 as well as an Expiration Timestamp 910. Such a Timestamp 910 causes NSS 778 to report up to date information that reflects the current state of the local vicinity of the BCHAIN Network 110. If individual Node Ping Records 908 were not to expire, or to expire after a long time, the Node Index Variables 912 would not accurately reflect the current state of the local vicinity, but rather an average. The Node Ping Records 908 from Incoming Traffic 902 are eventually stored in Node Activity DB (NAD) 896. From there, Operational Queries 904 processes the Node Ping Records 908 in batches whilst considering the Expiration Timestamp 910. Therefore the Records 908 are finally calculated according to the criteria of the four Node Index Variables 912 at Index Calculation 906.

FIG. 59 shows Strategy Corroboration System (SCS) 4080, which operates an Opera system of Protocol 794 consensus building amongst BCHAIN Nodes 786. Traffic Scope Consensus (TSC) 4090 produces a Dual Scope Hash 4134 set by referencing NSS 778 variables and static definitions from Static Hardcoded Policy (SHP) 488. SHP 488 contains criteria that is hardcoded into the BCHAIN Protocol 794. Such criteria is static as opposed to the usual dynamic strategy based criteria because these criteria are used to define strategy itself. Hence if the mechanism used to produce strategies itself relied on strategies, the system is expected to eventually loop itself into an extreme state which has limited and/or abnormal functionality and effectiveness. SCS 4080 invokes Sector Identity Derivation (SID) 2092 to use the Dual Scope Hashes 4134 Hash 1 4136 and Hash 2 4138 to act as a base for defining the Current Sector Identifications 2094. Therefore each Node 786 at any given time exists within the jurisdiction of exactly two Sectors 884, each one defined by Hash 1 4136 and Hash 2 4138. With Hash Corroboration 4086 the Hashes 4134 that are announced from surrounding Neighbors 786 are checked against the locally produced Hashes 4134. If neither of the hashes match, then the Neighbor Node 786 is added to the Node Block List 4082. With Specific Node Traffic Perception 4084; Nodes 786 that are recognized as legitimate due to their matching Hash Announcement 4088 can inform other Nodes 786 about Nodes 786 they suspect to be Rogue 806 and operating from beyond the BCHAIN Protocol 794 limits defined in Static Hardcoded Policy (SHP) 488. The Node Block List 4082 contains the identities of Nodes 786 that are suspected to be Rogue 806 because they are unable to produce at least one matching Hash 4134. Therefore they are blocked from interaction and information transfer with Legitimate Nodes 786 to deter spam and network abuse.

FIGS. 60-63 detail the operation of Traffic Scope Consensus (TSC) 4090. On FIG. 60 TSC 4090 invokes NVP 4140 to receive Node Statistical Survey (NSS) 778 variables and produce an NSS Variables Composite Average (NVCI) 4108. With NVP 4140 Nodes 786 from within the same Sectors 884 announce their perception of the NSS 778 Variables to each other to build consensus on the Sector's 884 characteristics. Therefore the local and remote NSS 778 variables are pooled together to create a composite average known as NVCI 4108. This composite is used to maintain consensus on the scope and definition of this Sector 884, and hence where it's physical boundaries lie. Upon completing the production of the NVCI 4108, each one of the pooled indices 886, 888, 890, 892 is transferred to Stage 4094. The pooled version of Node Escape Index 886 is rounded downwards to the nearest multiple X at Stage 4100. The pooled version of Node Saturation Index 886 is rounded downwards to the nearest multiple X at Stage 4102. The pooled version of Node Consistency Index 890 is rounded downwards to the nearest multiple X at Stage 4104. The pooled version of Node Overlap Index 892 is rounded downwards to the nearest multiple X at Stage 4106. When Stage 4098 is also completed (as shown on FIG. 61), all of the variables produced within Stage 4094 are merged into a single variable at Stage 4094.

On FIG. 61 Performance Factors 4110 are produced by NSS Variable Pooling (NVP) 4140 and submitted to Stage 4098 so that they are also rounded down to the nearest multiple X (along with the other calculations found at Stage 4094). The Performance Factors 4110 are measurements of performance concerning the Network 110 traffic within the relevant Sector 884, such as average hops per second, average megabytes per second etc. The value X used within Stage 4094 comes from the Traffic Consensus Rounding Multiple 1024 from Strategy Deployment 916. The Strategy Deployment 916 unit itself is extracted from a Trail Variable Suite (TVS) 2320 that is processed by Sector Crossing Event Processing (SCEP) 3360. Therefore the Multiple 1024 is expected to be different within each Sector 884, yet remains the same for all Nodes 786 within the same Sector 884. Therefore the results of the merging performed at Stage 4092 becomes the base for Hash 1 4136 of the Dual Scope Hash 4134. The base for Hash 2 4138 is produced by Stage 4118 as shown in FIG. 62.

On FIG. 62, the same NVCI 4108 are referenced from the rounding down process conducted within Stage 4094, except within Stage 4120 the process rounds upwards from the same multiple X that is taken from the Traffic Consensus Rounding Multiple 1024. In addition, the same Performance Factors 4110 from NVP 4140 are processed albeit rounded upwards. Hence the merge output processed at Stage 4118 will have been derived from the same references of NVCI 4108 and Performance Factors 4110 as Stage 4094, yet a different result will be generated due to the rounding affinity difference.

On FIG. 63, both variables that have been produced by Stages 4092 and 4118 become the seed for the alphanumeric hash generation at Stage 4132. Therefore two hashes are produced; Hash 1 4136 and Hash 2 4138 of the Dual Scope Hash 4134. These become the primary defining factors for Sectors 884 which are the main orientation mechanism for data retention and motion within the BCHAIN Network 110.

FIGS. 64-65 show Dynamic Strategy Adaptation (DSA) 772.

FIG. 64 shows how DSA 772 acts as the framework for creating dynamic variables that control processing factors within the BCHAIN Network 110. Such variables are packaged and transferred via Strategy Deployment 916 which is carried within a Trail Variable Suite (TVS) 2320. DSA 772 constantly maintains and adjusts variables that control Network 110 operations according to the state of the physical network as reported by NSS 778 variables via Field Chaos Interpretation (FCI) 918. FCI interprets the overall level of Node 786 availability chaos throughout the entire BCHAIN Network 110. Strategy Deployment 916 is a packaged set of criteria that sets operational values within modules of the BCHAIN Protocol 794. Optimized Strategy Selection Algorithm (OSSA) 956 selects the best suited and most Ideal Strategy 914 that operates the best under the environmental conditions that have been declared by NSS 778. Therefore the Current Preferred Strategy (SCM) 914 is used as input for Strategy Creation Module (SCM) 984 to tweak the strategy with experimentation. SCM 984 uses the Creativity Module 112, which operates as an Execution Segment 551 heavy Appchain, to hybridize the form of the Current Preferred Strategy 914 with the current interpretation of Field Chaos from FCI 918. Therefore the BCHAIN Network 110 is in a constant state of gradual trial and error, performing low risk experimentation of variable tweaking to learn correlations of cause and effect between Strategy Criteria 992 and real work Network 110 performance. Priority Assignment and Proof (PAP) 922 modifies the Strategy Deployment 916 Criteria 992 to perform with extended priority according to the extra amount paid by the UBEC User 106. Such prioritization is an automated process, for example; UBEC User 116 dials another User 106 with the Phone Calling Appchain. The Appchain 836 then requests PAP 922 to increase the priority of the packet transmission so that a consistent and reliable phone connection can be made. The extra amount of Watt Units it costs for the phone call as opposed to standard priority data transfers is deducted from the UBEC User's 106 User Private Fund Allocation (UPFA) 718. Therefore the Strategy Deployment 916 which is subsequently produced contains a relatively high value for Parallel Hop Spread Criteria 1002 and a relatively low value for Parallel Hop Reduction Criteria 1004. Therefore more Parallel Hop Paths are initiated which leads to lower latency, lower packet loss, higher reliability etc. Strategy Deployments 916 are packaged in Trail Variable Suites (TVS) 2320 of a CCR 2308 or CCF 2318. Traffic Strategies 914, 916 are dynamic, yet there are hardcoded limits which are acknowledged by all Legitimate Nodes 786 to be the limits of normal legitimate traffic. These hardcoded limits are referenced as Agreed Upon Strategy Scope Limits 996. Hence if any Node 786 outputs traffic in excess of these limits, it's traffic is considered spam by the Legitimate Nodes 786. These limits are scalable relative to Network 110 traffic which means that the overall BCHAIN Network 110 is permitted to grow indefinitely without reaching hardcoded limits whilst maintaining abuse protections. Strategy Performance Tracking (SPT) 920 is a database (which operates as an Appchain) that tracks the perceived performance of various Deployed Strategies 916 within the Network 110, which enables OSSA 956 to select the one that is considered the Current Preferred Strategy 914 considering local vicinity Network 110 conditions.

On FIG. 65 Strategy Performance Interpretation (SPI) 3420 receives deployed strategies with field data which dictates the perceived performance of such strategies in varying environmental conditions. Queued Information Broadcast (QIB) 2700 relays Strategy Deployments 916 that have been active in the field to report back environmental conditions to SPI 3420. This leads to a correlation of cause and effect to be calculated within the DSA 772 module concerning Strategy Deployment 916 Criteria 992.

FIGS. 66-67 show the database structure of Strategy Performance Tracking (SPT) 920, which operates as a Data Segment 553 heavy Appchain 836. SPT 920 stores units of Strategies 916, as in Strategy D28 924 and Strategy K11 940. Each Strategy 916 has a base Strategy Criteria Composition 928, 944, which acts as the core identity of the Strategy 916 as all of the defining criteria are stored there. Therefore all of the other variances within the Strategy 916 unit act as logistical measurements of performance and time to enable OSSA 956 to choose what it considers to be the Current Preferred Strategy 914. Each Strategy 916 unit has an Expiration Timestamp 926, 942. Such an Expiration 926, 942 gets extended every time an update to the Strategy 916 is provided by Strategy Performance Interpretation (SPI) 3420. Therefore the Expiration Timestamp 926, 942 safeguards the SPT 920 database from retaining outdated and irrelevant performance data. Associated with each Strategy 924, 940 are multiple Performance Tracking Units 930, which are reported by SPT 920. A Tracking Unit 930 contains an NSS Makeup 932, 936, 948, 952 and a Performance Index 934, 938, 950, 954. The NSS Makeup captures the NSS 778 Variables 886, 888, 890, 892 that existed at the time this Tracking Unit 930 was captured. The Performance Index records performance measurements such as hops per second, megabytes per second etc. The data retained in the NSS 778 Makeups and Performance Indices allow for OSSA 956 to recognize what the Current Preferred Strategy 914 is according to the current NSS 778 variables that are being reported to OSSA 956. FIGS. 68-70 show the detailed working of Optimized Strategy Selection Algorithm (OSSA) 956.

FIG. 68 shows Strategy Performance Tracking (SPT) 920 indirectly connecting (via Logic Flow) to Multiple Variable Selection Algorithm (MVSA) 962. MVSA 962 selects the most appropriate Strategy 916 from data within SPT 920. Data from SPT 920 is used to derive a Strategy Performance Index 958 which is a composite average of all of the individual performance indices listed within a single Strategy 916. The Strategy Confidence Ranking 960 indicates how much precedence/evidence is available to justify the perception on the Strategy Performance Index 958. MVSA 962 makes reference to Static Hardcoded Policy (SHP) 488 to discern the criteria by which to select the appropriate Strategy 916. Hence MVSA 914 submits Current Preferred Strategy 914 as modular output, which is the final modular output of OSSA 956. Therefore MVSA 962 conducted the core decision in selecting the Strategy 914 that hoped to offer the best performance and efficiency considering the current NSS 778 variables.

FIG. 69 shows more detail within OSSA 956 thats leads from SPT 920 to MVSA 962. Stage 958 retrieves all of the Strategies 916 that haven't expired from SPT 920. Hence All Active Strategies 960 is assembled and contains Strategy D28 924 and Strategy K11 940 which were illustrated in detail on FIGS. 66 and 67. Stage 962 retrieves all of the NSS 778 makeups from All Active Strategies 960 that are within range of the Local NSS Makeup 970 as provided by a current instance of NSS 778 operation from Stage 968. The magnitude of such range is defined in Static Hardcoded Policy (SHP) 488. Therefore Stage 962 produces NSS 778 Makeups Within Range 964, which contain selected Performance Tracking Units 930 from various Strategies 916. Thereafter at Stage 966 the Performance Tracking Units 930 are organized according to Strategy 916 definition, which is the Strategy Criteria Composition 992.

FIG. 70 continues the logic flow of OSSA 956 from Stage 966. The output of Stage 966 is Strategy Containers 972, which contains selected Strategies 916 which contain the Performance Tracking Units 930 that were initially selected at Stage 930. Stage 974 makes reference to the Strategy Containers 972 to calculate the average Performance Index 930 per Strategy 916 which outputs as Strategy Performance Index 978. Therefore the Strategy Confidence Ranking 980 is calculated per Strategy 916. Such a Ranking 980 indicates how much precedence/evidence, from the data that has been extracted from SPT 920, is available to justify the perception on Strategy 916 performance. Thereafter Stage 982 selects the preferred strategy according to both Performance 978 and Assessment Confidence 980 via MVSA 962.

FIGS. 71-74 show the Strategy Creation Module (SCM) 984, which is invoked by Dynamic Strategy Adaptation (DSA) 772. SCM 984 intelligently varies compositions of Strategies 914 via the Creativity Module 112 to create low risk experimental Strategies 916 that build off of the strengths of prior iterations.

On FIG. 71 Field Chaos Interpretation (FCI) 918 submits it's Chaos Interpretation output to Stage 986, which submits it to Creativity 112 as an Input Form. Creativity's 112 Static Criteria 998 are based on the Agreed Upon Strategy Scope Limits 996 and the Watt Unit amount that has been pre-authorized in the Economic Authorization Token (EAT) 994 (hence the priority level). The EAT 994 token is provided by Priority Assignment and Proof 922. The Current Preferred Strategy 914 is received by OSSA 956 and is unpacked at Stage 990 to retrieve the Strategy Criteria Composition 992.

FIG. 72 shows the various Criteria 992 that makeup Strategy Criteria Composition 994. Every single Strategy Deployment 916 has a defined value for each of these criteria. Hop Witness Expiration 1001 indicates how much time must have passed for a Hop Witness Entry in Recent Hop History (RHH) 2354 to be ignored. This variable is used to remove potentially useless Parallel Hop Paths from being spawned. This is because if a CCR 2308 or CCF 2318 has already passed through this Node 786 a long time ago, there is an increasingly lower chance that spawning a new parallel CCR 2308 or CCF 2318 will catch up and surpass the prior one.

Parallel Hop Spread Criteria 1002 indicates how wide should the Parallel Hops be spread and at what trigger variable values. More Parallel Hops indicates higher reliability and quality of information transfer. Hence CCRs 2308 and CCFs 2318 that contain priority flags in their Economic Authorization Tokens (EAT) 994 will lead to a larger Hop Spread Criteria 1002.

Parallel Hop Reduction Criteria 1004 indicates when Parallel Hop Paths should be removed due to redundancy. An earlier removal of Parallel Hop Paths will lead to a lower reliability and quality of service. Hence CCRs 2308 and CCFs 2318 that contain priority flags in their Economic Authorization Tokens (EAT) 994 will lead to a smaller Hop Reduction Criteria 1004.

Content Saturation Required to Cache 1006 is the minimum amount of occurrences at which an Appchain 836 has been recently witnessed by this node in Recent Hop History (RHH) 2354. Therefore content that is frequently witnessed will be cached, which gradually and automatically optimizes cache locations amongst a chaotically distributed set of nodes.

Minimum Hop Travel Required to Cache 1008 is the minimum amount of progress that needs to have been completed for the node to cache the content. i.e. at least 50% of the Hop Journey needs to have been completed before caching is allowed. Hence only Nodes 786 that participate in the journey after the halfway point will be eligible to cache the content.

Demand Declaration Hop Point 1010 is the hop point along the CCR 2308 or CCF 2318 journey at which the Node 786 declares to the Metachain 834 the Appchain Demand 852 and Sector Demand 854. Appchain Demand 852 is tracked to decide Appchain 836 caching and locations, whilst Sector Demand 854 is tracked to calculate the different prices of different Sectors 884. Hence an efficient supply/demand economy is produced. Minimum Node Reliability for Path Deployment 1012 is the minimum reliability level of a Node 786 as adjudicated by the NSS 778 variables for a node to be included in a Hop Pathway. Such a pathway could be the most ideal pathway or less capable parallel pathways.

Self Imposed Mining Criteria 1014 is the minimum amount of relative computing resources required to mine an Appchain 836. Such an amount is proportional to the resource load of mining that Appchain 786, since some Appchains 836 are heavier than others, as well as the immediate urgency of that Appchain 836 requires new miners to preserve data integrity.

Chaotic Environment Avoidance Criteria 1016 defines characteristics of nodes that indicate them to be sporadic and unreliable as understood by the variables provided by NSS 786. Hence environments that involve unpredictable and sporadic movement and availability of Nodes 786 can be dealt with according with intelligently dynamic criteria. CCFs to Retain in Clash Cache 1018 defines the percentage amount of the local Node's 786 storage that should be allocated to retaining CCFs 2318 that do not exist in Primary Node Content Cache (PNCC) 1218. Hence if a CCR 2308 and it's correspondingly stored CCF 2318 cross each other's path prematurely, the content request can be duly fulfilled. There is a ‘sweet spot’ optimized amount of CCFs 2318 to retain to make efficient use of unintentionally chaotic clashes of information. Hence dynamic variance of Strategies 916 by Dynamic Strategy Adaptation (DSA) 772 attempt to discover and deploy the ‘sweet spot’ variable.

Route Reliability/Distance Tradeoff 1020 defines the perceived zone of efficiency concerning the selection tradeoff between reliability of selected Nodes 786 and expected distance travelled. The ideally tuned variable for maximal efficiency will depend according to surrounding environmental variables accounted for via NSS 778.

ITII Microchain Trigger 1022 defines the value of Information Transfer Isolation Index (ITII) 3218 required to merit a node voting to switch an Appchain 836 to a Microchain 838 format, which omits resource spending on the Metachain 834 and hence optimizes resource use for geographically isolated transfers of information.

Traffic Consensus Rounding Multiple 1024 is the multiple of which NVCI 4108 and performance variables are rounded upwards or downwards. If this value increases, the relative size of Sectors 884 that are influenced by this variable will gradually increase in size. If this value decreases, Sectors 884 will shrink in size and Node 786 count.

NSS Variable Pooling Interval 1026 defines how often should Nodes 786 announce to each other (within Sectors 884 they share an overlap with) the NSS 778 variables they perceive. Hence a Sector 884 will build consensus about its own NSS 778 characteristics. If this interval is smaller; there will be tighter integration and more synchronicity, yet more Network 110 resources depleted. If this interval is larger; there will be less synchronicity and less Network 110 resources depleted.

Work Payout Multiplier 1028 defines the intensity of discrepancy in payment between the lowest and highest paying Sectors 884. Therefore the economy can be more intense in rewarding work units to heavily saturated areas. When this variable increases, the desire to participate in heavily saturated areas increases, which leads to less motivation to participate in sparse areas. Hence when this variable is high, infrastructure tends to adapt faster and better to content demand fluctuations. Yet since consistency of demand can be chaotic, this would lead to a more chaotic fluctuation of infrastructure location. Minimum Cache Retention Time 1030 defines the minimum amount of time a Caching Node 785 is required to retain a cache it has elected to adopt. The usage of this variable is intended to prevent the BCHAIN Network 110 from having an overly chaotic turnover in Cache Location 848, which would lead to increased latency and reduced reliability concerning the delivery of content. If this variable were set too high, it would lead to the cache distribution network becoming over-rigid and unable to properly adapt to changes in content demand.

Mining to Caching Payment Ratio 1032 allocates a division of payment between Passive Work done via the Mining Selection Algorithm (MSA) 2484 and Passive Work done via the Cache Selection Algorithm (CSA) 2350. Therefore this Ratio 1032 decides between tradeoff of the finite resource dilemma that is inherent in the BCHAIN Network 110. Such a tradeoff is between maintaining sufficient redundancy of data integrity and adequate geographically distributed cache serving for optimal service.

Cache Part Deletion Threshold 1034 defines when it is safe for Miners in a Sector 884 that is rescuing data via Data Refuge Processing (DRP) 1984 to delete such Data in Danger. Node Cache Provider (NCP) 2080 provides parts of the Data in Danger from the Seed Cache Pool 2112 to Nodes 786 that are complying with the ultimatum set by Miners according to the Tax Consequence Unit 1852. Even though Cache Fulfillment may have already occurred, it may still not be appropriate to delete the Miner's copy of the Data in Danger. This is because some Nodes 786 may elect to adopt the Data regardless of wether Cache Fulfillment has occurred or not. It also acts as a safeguard in case of a Data Integrity attack vector of Rogue Nodes 806 immediately deleting the data they pretended to comply about as soon as Cache Fulfillment occurs. Therefore the event when the Miner's copies are deleted from Seed Cache Pool 2112 occurs after the event of Cache Fulfillment. Therefore a high value for Cache Part Deletion Threshold 1034 leads to added assurance that the Data in Danger has been rescued yet occupies the storage devices of the Miners for longer; hence removing the opportunity for other tasks that are productive for the BCHAIN Network 110 to make use of the space. It then follows that a smaller value for the Deletion Threshold 1034 increases the risk that the Data in Danger may not have been rescued, at the expense of increased storage resource relief.

Sector Tax Magnitude 1036 acts as a multiplier for the value size of the Tax Consequence Unit 1851 that is to be imposed onto the Node 786 of the relevant Sector 884. Therefore a higher value for Magnitude 1036 leads to a larger potential Tax Penalty to be imposed on the Nodes 786 of the Sector 884, and a lower value leads to a smaller potential Tax Penalty.

FIG. 73 shows how SCM 984 processes its modular input and out. It begins with the Current Preferred Strategy 914 as the initial input. Strategy 914 is unpacked at Stage 990, which means it is extracted into an intermediate format to make it available for manipulation and processing by the parent module SCM 984. Therefore Strategy Criteria Composition 992 is generated at Stage 990 from input Current Preferred Strategy 914. In parallel, logic that is shown on FIG. 74 updates the Strategy Criteria Composition 992 to a new low risk experimentation version of the Strategy 914 that ends up becoming the output Strategy Deployment 916. Upon completion of the update process illustrated on FIG. 74, the Strategy Syntax Assembly (SSA) 1132 module repacks the information into the format that is understandable to the other modules that operate the BCHAIN Protocol 794. Hence SSA 1132 performs the practical inverse of Stage 990. Therefore Strategy Deployment 916 is submitted as modular output of SCM 984 whilst containing all of the available Strategy Criteria Composition elements (only three are shown for illustration purposes: Hop Witness Expiration 1000, Parallel Hop Spread Criteria 1002, and Parallel Hop Reduction Criteria 1004).

FIG. 74 further shows how the Creativity Module 112 is used to update the Strategy Criteria Composition 992 in a direction that is expected to be more efficient and better performing whilst considering the NSS 778 variables reflecting the state of the local BCHAIN Network 110 environment. At Stage 1136, Creativity is given the Mode 1138 of the currently selected criteria from Strategy Creation, which is a Predefined Template to manage dynamic strategy creation and variation. Such a Predefined Template is produced at Predefined Mode Template Management (PMTM) 1134. Creativity 112 processes two inputs; Form A and Form B. Form A is defined at Stage 1146 and selected at Stage 1144. Therefore every single Criteria from the Strategy Criteria Composition 992 is selected for individual processes as Form A with Creativity 112. Form B is shown on FIG. 71 as the overall interpretation of Field Chaos at Stage 986 from Field Chaos Interpretation (FCI) 918. Therefore upon completion of Creativity 112 processing Output Form AB is produced as the new proposed variations of the Criteria 992 at Stage 1140. Thereafter the at Stage 1142 the new changes are committed to Strategy Criteria Composition 992.

FIGS. 75-79 show core elements of the UBEC Platform 100 and the BCHAIN Protocol 794 that deal with self monitoring of resource usage, operation efficacy and diagnostics. Program debugging is automatically operated by automatic gathering of relevant performance and/or crash/bug Logs that are processed and eventually sent to Self Programming Self Innovation (SPSI) 130 and SPSI Indirect Development (SID) 1190. Hence programming errors and generic faults in the UBEC Platform 100 and BCHAIN Network 110/Protocol 794 are automatically found, analyzed and fixed.

On FIG. 75 the UBEC User 106 accesses the UBEC Platform 100 via biometric recognition performed at User Node Interaction (UNI) 470. Hence an Authenticated User Session 522 is produced from which the Associated Nodes List 518 is extracted at Stage 1150. The Authenticated User Session 522 is also used to access the Front-End User Interface 1148 which leads to an Economic Personality Selection 740. At Stage 1152, the UBEC User 106 selects an Economic Personality 740 which is referenced by Computation and Network Resource Availability 1156 of the BCHAIN Protocol 794. In practical usage of the UBEC Platform 100; the UBEC User 106 selects an Economic Personality 740 at initial setup and login of the UBEC Application 118. Therefore it is not expected as practical usage for the UBEC User 106 to manually select an Economic Personality 740 every time the User 106 initiates a new session with the Front-End User Interface 1148. At Stage 1154; CNRA references the Economic Personality Selection 740 from the UBEC Platform 100 as a methodology of measuring any surplus available resource of a Node 786 that is associated with the UBEC User 106 via the Associated Nodes List 518.

On FIG. 76 Stage 1154 continues by invoking CNRA 1156 which grants reference to the Economic Incentive Selection (EIS) 1232 module. EIS 1232 may recommend for the Node 786 to perform Other Node Work 1158 or a work session of Diagnostic Log Submission (DLS) 1160. Hence the Node 786 that is operating this instance of the BCHAIN Protocol 794 is selfishly seeking work with the best possible return on investment via EIS 1232, which leads to a balance within the BCHAIN Network 110 of supply and demand of automated technical micro-services. Therefore at Stage 1162 the local execution of EIS 1232 on a Node 786 can trigger that Node 786 to become a self-imposed Diagnostic Node via the execution of DLS 1160. Thereafter at Stage 1164 the Node 786 declares itself to be a Diagnostic Node to Diagnostic Node Location 844 of the Metachain 834. Because of the initially declared status of the Node 786 from the execution of Stage 1164, the Node 786 is marked as unconfirmed until other Nodes 786 can corroborate that it is performing the declared function. This is done in accordance with the abiding principle of the BCHAIN Protocol 794 which is to achieve efficient collaboration via synchronized yet separate instances of algorithmic criteria. Therefore there exists harmonious collaboration without trust within the BCHAIN Network 110. Updates made to the Diagnostic Node Location 844 of the Metachain 834 are sent to Customchain Interface Module (CIM) 2470 to be mined and committed to the actual Metachain 834.

On FIG. 77 Stages 1162 and 1164, which were given context on FIG. 76, continue the logic flow to Stage 1166. At Stage 1166; due to the Node's 786 declaration on the Metachain 834 concerning being a Diagnostic Node, other Nodes 786 from within the same Sector 884 send it Diagnostic Logs via Jurisdictionally Implied CCF Submission (JIGS) 4194 and Jurisdictionally Accepted CCF Reception (JACR) 4208. Thereafter at Stage 1168 the Diagnostic Logs are validated for authenticity by the self-declared Diagnostic Node. This mitigates against spam and abuse attacks. Thereafter at Stage 1170 Log Units 1182 that are tagged with an Official System Token 1184 are submitted to SPSI Indirect Development (SID) 1190 via Management Console (MC) 1186 and (I2CM) 1188, all of which operate as Appchains 836 within the UBEC Platform 100 and are hosted by the BCHAIN Network 110. Sending the Log Units 1182 to SID 1190 enables the UBEC User 106 programmers to better guide the programming of Self Programming Self Innovation (SPSI) 130 via indirect methods. The Official System Token 1184 is cryptographic proof that the Log Unit 1182 originates from an Official Appchain such as LOM 132, LIZARD 120, MPG 114 etc. Appchains 836 are tagged as Official if they contribute core functionality to the UBEC Platform 110. A similitude is core programs in an Operating System that cannot be removed, such as a File Explorer, the Drivers for basic components such as RAM, a Terminal window for executing instructions etc. At Stage 1172 the same Log Units 1182 that were submitted at Stage 1170 are then submitted to LOM 132 via the Automated Research Mechanism (ARM) 134 that connects to the Self Programming Self Innovation (SPSI) 130 Appchain 836. The Log Units 1182 allow SPSI 130 itself to better program itself and other Appchains 836 within the UBEC Platform 100. Thereafter at Stage 1174 Proof of Diagnostic Work done is sent to Work Payment Claim Processing (WPCP) 1258 to redeem the resources that were put forth by the Node 786 into Watt Units.

On FIG. 78 details concerning the logic originally shown on FIG. 77 are expanded upon. Other BCHAIN Nodes in the Same Sector 1176 process the Diagnostic Log Collection (DLC) 1178 module to record relevant Logs that are intended to be submitted to the relevant locations via Diagnostic Log Submission (DLS) 1160. Such Logs from DLC 1179 are forwards to JICS 4194, which submits a CCF 2318 with no accompanying CCR 2308 to an instance of JACR 4208 that invoked DLS 1160 on the self-declared Diagnostic Node. Because of the Node's 786 declaration of being a Diagnostic Node on Diagnostic Node Location 844 of the Metachain 834, it has made explicit their jurisdiction and hence must implicitly accept such CCF 2318 packets sent by JICS 4194 due to the elected jurisdiction. Hence LIZARD 120 operating as an Appchain 836 within the UBEC Platform 100 can monitor and justify CCF 2318 packets without an accompanying CCR 2308. This may otherwise seem like spam since there is no explicit permission from the node to receive the CCFs 2318, only implicated due to their explicit self-imposed role. Therefore LIZARD's 120 jurisdiction tracking technology is implemented at the lowest layers of the BCHAIN Network 110 traffic. Stage 1168 validates Logs for authenticity via the Diagnostic Log Validation (DLV) 1180 module. Hence validating logs as authentic or inauthentic whilst aggregating them for submission to the correct source is the primary job of a Diagnostic Node. A Diagnostic Log Unit 1182 is produced by DLV 1180 if found to be authentic. An Official System Token 1184 is included if applicable.

FIG. 79 further illustrates the logic flow described on FIG. 77. At Stage 1170 the Diagnostic Log Unit 1182 is processed by Management Console (MC) 1186 and (I2CM) 1188. Such Log Units 1182 are then reviewed by UBEC Users 106 as Programmers to be a reference point on indirectly programming and enabling SPSI 130. The Diagnostic Log Unit 1182 along with a potentially applicable Official System Token 1184 are sent to SPSI 130 for direct and automated maintenance and fixing of Official Appchains 836.

FIGS. 80-83 shows Economic Incentive Selection (EIS) 1232 and Work Payment Claim Processing (WPCP) 1258.

On FIG. 80; EIS 1232 acts as a supply/demand arbitration mechanism for the BCHAIN Network 110. Nodes 786 seeking Active Node Work 1254 invoke EIS 1232 via Stage 1234 to select the best type of work available that is the most likely to yield that Node 786 the best return on investment. Thereafter Stage 1236 analyzes local and remote variables concerning the Metachain 834 to understand current supply demand trends. Therefore the Supply Demand Arbitration (SDA) 1238 module is invoked. SDA 1238 references the Metachain 834 to create a logical representation of supply/demand vectors within the BCHAIN Network 110. Hence it can be thereafter estimated what categories of Node Work are the most profitable. Hence SDA 1238 submits Supply Demand Makeup 1240 to represent the findings of it's calculations. Stage 1236 leads to Stage 1242, which checks if there is a surplus amount of computation and networking resources available whilst being in compliance with the selected Economic Personality 740. Stage 1242 checks for resource availability by invoking Computation and Network Resource Availability (CNRA) 1156. The Economic Personality 740 designation is designed from within the UBEC Platform Interface (UPI) 728. If Condition 1246 “No, resources not available” occurs, then Stage 1250 is invoked which terminates operation of EIS 1232 and submits a null output. If Condition 1248 “Yes, resources available” occurs, then EIS 1232 invokes Node Job Selection (NJS) 1252. NJS 1252 makes reference to Supply Demand Makeup 1240 and the availability of Node 786 resources in selecting an appropriately profitable work job.

FIG. 81 shows the transition between Economic Incentive Selection (EIS) 1232 and Work Payment Claim Processing (WPCP) 1258. Once Active 1254 or Passive 1256 work is completed, a claim to revenue is made to WPCP 1258 which verifies and processes payment to the Watt Economy 862 of the Metachain 834. Passive Node Work 1256 is work that is implicated by the BCHAIN Protocol 794 due to needs of the Network 220. For example, CCR 2308 or CCF 2318 routing is a need of the Network 220, where it becomes incumbent upon a Node 786 in the right place and at the right time to fulfill legitimate requests that are made according to the Protocol 794. Active Node Work 1254 is done out of selfish motives of the Node 786 on behalf of it's owner the UBEC User 106, whilst in accordance with the selected Economic Personality 740. Hence EIS 1232 only invokes Active Node Work 1254 via Node Job Selection 1252, whilst Passive Node Work 1256 is implicated due to compliance of the Protocol 794. Upon the Completion of Active 1254 or Passive 1256 work, Stage 1260 of receiving a Claim of Work Done is processed. Thereafter Stage 1262 identifies the type of Work that is being claimed was completed. Stage 1264 then performs a check to verify if the identified type of Work is defined in Static Hardcoded Policy (SHP) 488. Stage 1264 ensures that the Node Work Type is legitimate and officially recognized by the BCHAIN Protocol 794. Also shown on the resources and references that WPCP 1258 uses; Pending Yet Validated Work Payments 871 of the Appchain 836, Watt Economy 862 of the Metachain 834, and Solved Work New Block Announcement 2480 from the Customchain Interface Module (CIM) 2470. Pending Yet Validated Work Payments 871 is a means of achieving third party corroboration of real Work being done within the Official Work Types 1264 within the BCHAIN Network 110 at Static Hardcoded Policy (SHP) 488. The Watt Economy 862 tracks the allocation of Watt Units to Nodes 786. The Solved Work New Block Announcement 2480 is the second means of invoking a processing routine within WPCP 1258, whilst Stage 1260 is the first means of invoking a processing routine.

FIG. 82 shows more detail concerning the logical routine in WPCP 1258. If the identified type of work processed at stage 1264 is Not 96 defined in SHP 488, then the Work Claim is rejected and module execution of WPCP 1258 is terminated. If the Yes Condition 98 occurs for Stage 1264; the Work Claim is validated via Third Party Corroborative Proof processing via Corroborative Proof Verification (CPV) 1266 at Stage 1270. Therefore the Confirmed Work Category 1280 that was verified at Stage 1264 is submitted to CPV 1266 for processing. Upon completion of CPV 1266 processing, a result of Unverified 1274 leads to Stage 1268 which rejects the Work Claim and terminates module execution. A result of Verified 1272 leads to one of two potential Stages 1276, and 1278 being executed. If WPCP 1258 was invoked by a Node's 786 completion of Passive 1256 or Active 1254 Work; then Stage 1276 is invoked which Submits the Validated Work Payment to Pending Yet Validated Work Payments 871 of the Metachain 834. However, if WPCP 1258 was invoked by a Solved New Block Announcement 2480, Stage 1278 is executed which submits Pending Payments 1284 to the Watt Economy 862.

FIG. 83 shows more details concerning the logical routine in WPCP 1258. Upon modular invocation of WPCP 1258 via Solved Work New Block Announcement 2480; Stage 1282 is executed. Stage 1282 retrieves Pending Yet Validated Work Payments 871 from the Appchain 836 associated with the newly solved block. Hence Pending Payments 1284 is produced as output. Stage 1282 leads to Stage 1286 which independently verifies the included Third Party Corroborative Proof 1292, which is extracted from Pending Payments 1284, via CPV 1266. Therefore CPV 1266 checks for corroboration on the Metachain 834 for Pending Payments 1284 or Third Party Corroborative Proof 1292 with the Confirmed Work Category 1280.

FIGS. 84-169 demonstrate Data Integrity Management (DIM) 1204 functionality which operates with three major branches: Customchain Synchronization & Reconciliation (CSR) 1208, Mining Nodes Supplying Cache Seeding (MNSCS) 1850, and Mining Failure Data Reconstruction (MFDR) 1212. The purpose of DIM 1024 is to maintain and guarantee the data integrity of Appchains 836 in a decentralized fashion, and synchronization for nodes that performed operations whilst offline. Finality of legitimacy of data is considered in a computationally expensive way with Deep Client Decision Critique (DC2) 1506 which emulates what the protocol's expected behavior should have been. Therefore nodes are trusted or distrusted accordingly. Sector Tax Creation (STC) 1872 module creates a Tax Consequence Unit (TCU) 1852 which enumerates the positive or negative tax consequences that are to be enacted upon the variable time when Cache Fulfillment occurs. The factors that define the composition of a TCU 1852 include the amount of nodes in the sector, Sector Demand magnitude, Sector Emergency Funds magnitude etc. Sector Tax Enforcement (STE) 1924 Evaluates the Cache Fulfillment performance of the nodes in the sector. Upon the eventual achievement of Cache Fulfillment status within the sector, this module enforces the tax code as stipulated in the Tax Consequence Unit (TCU) 1852. TCU 1852 contains a Schedule Tax Plan that is Enacted Upon at the Time of Cache Fulfillment. The Tax Consequence Unit (TCU) 1852 enumerates the potential Tax break or Tax penalty that is to be enacted considering any potential amount of time it takes for the nodes of the respective sector to collectively accomplish Cache Fulfillment of the specific content delivered from the newly mined block. Sector Tax Announcement (STA) 1864 Broadcasts the Tax Consequence Unit (TCU) 1852 to all applicable nodes within the relevant sector jurisdiction. Node references are primarily made via Location Association in the Metachain. Sector Tax Reception (STR) 1904 has logic which is processed within an individual BCHAIN Node 786 that decides on the most effective time to comply with the Tax Consequence Unit (TCU) 1852. Such a decision is made without collaboration with other nodes in the same sector that received the same TCU 1852. Therefore the node estimates it's own factors such as Economic Personality, availability and profit margin of alternate work, local resources available etc. The logic is executed upon the understanding that if all of the nodes procrastinate the adoption of the announced cache to fulfill, then all of the nodes in that sector will have to equally pay the price in the form of taxes which are submitted to the Emergency Sector Funds of the Metachain 834. Therefore nodes within a sector need to collaborate without explicit communication on such a topic, which evokes a Prisoner's Dilemma like scenario. Mining Failure Data Reconstruction (MFDR) 1212 is utilized in the rare event of miners of an Appchain/Microchain losing partial integrity of the data they retain, nodes that have cached such data are able to submit it back to the Miners upon verification of such data.

FIG. 84 provides logic of DIM 1204 which consists of and interacts with Mining Selection Algorithm (MSA) 2484, Watt Economy 862, Appchain Cache Location 848, Solved Work New 1206, Work Payment Claim Processing (WPCP) 1258, Data Integrity Scanning (DIS) 1960, Data Refuge Processing (DRP) 1984, Content in Danger Report 1982, Customchain Synchronization & Reconciliation (CSR)/Appchain Merge Processing (AMP) 1740, Economic Incentive Selection (EIS), Mining Node Supplying Cache Seeding (MNSCS) 1850 & Mining Failure Data Reconstruction (MFDR) 1212. MNSCS 1850 provides an initial seed of data cache from a newly mined block. This ensures a proper distribution of data retention integrity, and efficient geographic distribution of such data. MNSCS 1850 consists of Sector Tax Creation (STC) 1872 Sector Tax Enforcement (STE) 1924 Sector Tax Announcement (STA) 1864 Tax Consequence Unit (TCU) 1852.

FIG. 85 provides additional logic for components of DIM 1204 and their interactions, which include Mining Cache Retention Time 1020, Mining to Caching Payment Ration 1032, Cache Selection Algorithm (CSA) 2350, Mining Selection Algorithm (MSA) 2484, Appchain Payment Logic 1214, BCHAIN Work Units 1216.

FIG. 86 provides logic of DIM 1204 algorithms MSA 2484 and CSA 2350 working with Appchain payment Logic 1214 and its components which include Appchain Administrators 12120/Due Payment to Infrastructure 1224, Appchain Users 1222/Due Payment to Infrastructure 1226, Appchain Administrators define payment policies for the Appchain 1228 which receives input from Appchain Administrators 1220 and feeds to Appchain Payment Policy 1230. Appchain Payment Policy provides input to both Appchain Administrators 1220 and Appchain Users 1222 both of which feed into BCHAIN Work Units 1216.

FIG. 87 Node Information Distribution 1294 demonstrates Block Overlap Strengthens Verification Consensus between BCHAIN Nodes 1296, 1298, 1300 and 1302. When a Metachain block is downloaded from another node, it is verified to be the correct and accurate block by referencing the known hash of the block, which every node retains (for all Metachain blocks). As a precautionary measure against hash collision attacks, legitimate nodes are able to reach consensus about the correct contents of a Metachain block due to their being a redundancy in legitimate copies. Thus the integrity of the Metachain is preserved.

FIG. 88 further expands on Node Information Distribution 1294 by demonstrating a Full Metachain Scope Available 1304 and Metachain Distribution Availability 1306 which highlights both Full Preservation of Mandatory Retention Zone due to the BCHAIN protocol 794 mandating the retention of the first 3 blocks, it has a constantly full distribution curve in every sector of the BCHAIN network and Exponentially Diminishing Availability Relative to Time Elapsed. The Metachain Retention Logic (MRL) 1658 module is hardcoded to select the retention of Metachain blocks upon an exponentially diminishing distribution curve. This is done because as time passes the likelihood that a Metachain block will be required for a protocol function exponentially decreases. For example, with Appchain Merging 1308, the likelihood of a merger being processed between two versions of an Appchain that separated three years ago is highly unlikely. Hence it is not economically profitable to retain a lot of old blocks and so MRL 1658 retains them exponentially less compared to newer blocks.

FIG. 89 Appchain Merging 1308 demonstrates Appchain Version A consisting of blocks 1314, 1320, 1326 and Appchain Version B consisting of blocks 1312, 1318 and 1324. Appchain Version Time Synchronization (AVTS) 1328 module compares the cryptographic timestamps of both versions of the Appchain to deduce which block from Appchain Version A is chronologically associated with what block from Appchain Version B. Altered Merkle Hash 1330 is defined in FIG. 90.

FIG. 90 continues the Appchain Merging 1308 from FIG. 89 with block 1324 and block 1326 being merged in block 1322. Altered Merkle Tree Hash 1330 is calculated with consideration of all prior blocks in the Appchain. Therefore any single hash identity of a block, or the addition or removal of a block, would lead to the final Merkle Tree Hash to completely change. Therefore the Merkle Tree Hash Is used between nodes to verify that they are in agreement with the contents of the Appchain and can depend on each other's versions for logistical distribution. Despite the process of Appchain Merge Processing leading to the potential insertion of blocks mid-Appchain, nodes will eventually reach a consensus on the new Merkle Tree Hash because they have the same criteria for the Proof of Work and Proof of Dilemma Acceptance. Merkle Tree Hash A 1336, Merkle Tree Hash B 1334 and Merkle Tree Hash AB 1332 are shown for the respective blocks along with Merkle Tree Calculator (MTC) 1338 and Cryptography Core (CC) 768.

FIG. 91 demonstrates Appchain Merging 1308 between Appchain Version A 1340 and Appchain Version B 1344 resulting in Merged Appchain AB 1342 and Appchain Version Time Synchronization (AVTS) 1328.

FIG. 92 highlights Customchain Ecosystem Version A 1346 and Customchain Ecosystem Version B 1348 reconciliation for BCHAIN Node A 1350, BCHAIN Node B 1352, BCHAIN Node C 1354 and Appchain Merge Processing (AMP) 1740 into the New Status Quo Interpretation of Customchain Ecosystem 1356. Identical Protocol/Algorithm Criteria Leads to Consensus on New Post-Merge Paradigm. Because each BCHAIN Node is running the legitimate version of the BCHAIN Protocol Client, they are able to reach a consensus on the merging process by having identical criteria. This also eliminates BCHAIN Node's that are running illegitimate versions of the Protocol Client, as their alternate criteria will lead to spurious results which are thereafter ignored by the majority of legitimate nodes.

FIG. 93 shows Customchain Ecosystem Version A 1346 and Customchain Ecosystem Version B 1348. Separate and Conflicting Customchain Ecosystem Due For Reconciliation. Because of a geographic separation between groups of nodes, synchronization between both groups was not possible. Therefore they carried on their transactions without consideration of each other, so that their Metachains and respective Appchains/Microchains are no longer identical. Matching Appchains from Differing Customchain Ecosystems are shown via dotted lines. Despite the differing version of the ecosystems, it is expected that there will be Appchains which match in identity, each version claiming to be the correct version. The interpretation of the geographic separation dilemma by Customchain Dilemma Interpretation (CDI) 1660 is able to resolve this conflict.

FIG. 94 provides details regarding the BCHAIN Nodes A/B/C 1350, 1352, 1354 with regards to Customchain Ecosystem A 1346, Customchain Ecosystem Version B 1348, Customchain Dilemma Interpretation (CDI) 1660, Entire Dilemma Interpretation 1360, Status Quo Interpretation of Customchain Ecosystem 1358 and Appchain Merge Processing (AMP) 1740. Prior and Defunct Consensus of Pre-Merge Paradigm (between BCHAIN Nodes 1350, 1352, 1354 and their respective Status Quo Interpretation of Customchain Ecosystems 1358). Each BCHAIN Node had a specific perception of the Customchain Ecosystem it was exposed to have. Since they have been shown a legitimate geographic separation dilemma, they are synchronized in their reaction to consider the current version of the Ecosystem as defunct until the Entire Dilemma Interpretation has been processed which will lead to the new and correct state of the Ecosystem.

FIG. 95 provides details on Reality of Customchain Ecosystem Manifestation 1362, Entire Dilemma 1360 Parts 1-5 1362, 1364, 1366, 1368, 1370, BCHAIN Node A 1350, BCHAIN Node B 1352, BCHAIN Node C 1354, and Customchain Dilemma Interpretation (CDI) 1660. Reality of Customchain Ecosystem Manifestation 1362, Entire Dilemma Interpretation 1360 is an interpretation of the actual complex state of the observable Customchain Ecosystem. That is to say that the BCHAIN Nodes' abstract interpretation via computation is in direct reference to the real manifestation of data in it's observable scope of perception. Full Dilemma Interpretation is Available From Field, Albeit Scattered in a Chaotic Distribution of Parts. This Dilemma Interpretation is an abstract representation of the existing geographic separation dilemma that caused their to be two versions of the same Appchain to be mined. Despite the dilemma existing entirely within the reality of the Customchain Ecosystem, an individual node's exposure to it may be gradual. Since a node cannot receive a conformation when it has received the entire interpretation of the dilemma, it assumes that every increment it receives represents the entirety of the dilemma. This may lead to an initial disagreement amongst node's about the new unified Appchain and hence it's Merkle Tree Root, but eventually they will reach consensus as each BCHAIN Node (1350, 1352, 1354) receives a consistent exposure to all the parts that define the entire Dilemma. Chaotically Staggered Interpretation of Dilemma Parts by Chain Nodes. Each individual BCHAIN Node (1350, 1352, 1354) is exposed to different aspects or ‘parts’ of the dilemma interpretation and in different orders. Therefore there is a period of transition of which there is a lacking on consensus, until each node has been sufficiently exposed to the Entire Dilemma Interpretation.

FIG. 96 continues from FIG. 95 BCHAIN Nodes A/B/C 1350/1352/1354, Customchain Dilemma Interpretation (CDI) and Staggered Interpretation of Ecosystem Dilemma Existing Reality 1372, 1374, 1376, 1378, 1380. Staggered Interpretation Eventually leads to Consensus Due To Synchronized Criteria. With the gradual passage of time, each node will be necessarily exposed to more and more parts of the Dilemma Interpretation. Upon each valid part it receives, it must assume that it is the last part and that it is already exposed to the entire dilemma. Yet it will readily adopt a new part upon verification of it's authenticity. Since each node is programmed with the same legitimate version of the BCHAIN Protocol Client, they will eventually reach a consensus on the entire state of the Dilemma Interpretation as shown in Part 1360.

FIG. 97 Merkle Tree Hash A 1336, Merkle Tree Hash B 1334, Differ 1383, Match 1385, Block 1382 and Block 1384. Appchain Split Point (dotted line) is the point in time at which the nodes involved with the Appchain physically separated so that they were unable to synchronize upon further additions to the Appchain. Hence before the Split Point all the blocks were identical, yet after the Split Point all the blocks are different. For an Appchain merger to occur, it is required that they were once synchronized. Even two Appchains that have identical identities and/or purposes can never merge if they don't have Identical Genesis. Blocks.

FIG. 98 to FIG. 100 provide further details on the entire process from Initial contact between two different versions of the same Appchain 1386 to Appchain Merge Processing (AMP) 1740 including Entire Dilemma Interpretation 1360.

FIG. 101 provides the logic for Conflicting Appchain Verification (CAV) 1438 process at Stage 1436, Initial contact between two different versions of the same Appchain 836. At Stage 1440, Has the node population of Version A (from LNT 2620) met the Mining Diversity and Stage 1442, Has the node population of Version B (from LNT 2620) met the Mining Diversity Requirement? At Stage 1444, Retrieves the Mining Diversity Requirement from both Appchains (which are in a conflict of data compatibility).

FIG. 102 continues the logic from FIG. 101 of CAV 1438 and highlights key components Version Master/Slave Affinity (VMSA) 1478, Appchain Reconcilement Appeal (ARA) 1452, Mining Diversity Requirement 1448 and Mining Node Cache 1456. VMSA 1478 determines which version of the Appchain is the original and which one branched out from the original. ARA 1452 is a procedure for manually approving an Appchain merger by Appchain administrators due to the inability of the BCHAIN protocol to automatically process a merger. Mining Diversity Requirement 1448 defines the variance in mining node makeup required for an Appchain merger to be initially approved.

FIG. 103 and FIG. 104 provide further details on CAV 1438 with details on the use of LMNV 1492, VMSA 1478, ARA 1452, Mining Node Cache 1456, etc.

FIG. 105 continues with CAV 1438, Mining Diversity Requirement 1446/1448 and Approve the Appchain 1476 feed into Version Master/Slave Affinity (VMSA) 1478. Verification Payment Burden (VPB) 1494 within Legitimate Mining Node Verification (LMNV) 1492 Adjudicates, according to the defined Appchain Policy, which nodes should bear the burden of paying for the Appchain Merger. Due to the relative complexity and heavy resource usage required to perform a successful Appchain merger, logistics for assigning payment burden become crucial to administrating organizations and individuals.

FIG. 106 provides additional details on CAV 1438 and LMNV 1492 where Deep Client Decision Critique (DC2) 1506 module receives relevant and fulfilled blocks of the Metachain to emulate what the correct BCHAIN Protocol response to a targeted node's former environmental situations. By analyzing BCHAIN Network environment factors, this module can perceive of the most correct and plausible (in situations concerning ambiguity) response to such factors. Therefore a node's prior actions can be checked to see if they are in accordance with the legitimate definition of the BCHAIN Protocol, or if the node's firmware/software is intentionally or unintentionally compromised. Therefore elements of node trust can be established which enables subsequent procedures within the BCHAIN Network such as Appchain Merging. Metachain Retention Download (MRD) 1560 module interact with other nodes in the BCHAIN network to retrieve the contents of targeted Metachain blocks. Verification Payment Burden (VPB) 1494 adjudicates, according to the defined Appchain Policy, which nodes should bear the burden of paying for the Appchain Merger. Due to the relative complexity and heavy resource usage required to perform a successful Appchain merger, logistics for assigning payment burden become crucial to administrating organizations and individuals.

FIG. 107 provides details on further processing within LMNV 1492, Appchain Policy 1502, Appchain 1504, block 1382 and block 1384 and AVIS 1328.

FIG. 108 continues from FIG. 107 on details within LMNV 1492 where Metachain Without Core Data 1498 shows the Block Request Sequence (dotted rectangle with Block 12, Block 13 and Block 14) where relevant Metachain block references are selected to be downloaded via Metachain Retention Download (MRD) 1560. Blocks are selected in batches moving backwards in time, with the starting point being the Appchain Split Point. MRD 1560 module interacts with other nodes in the BCHAIN network to retrieve the contents of targeted Metachain blocks. Output from Metachain With Core Data 1500 is fed into DC2 1506.

FIG. 109 to FIG. 112 provide the details on DC2 1506 from Appchain Policy 1502 and Selected Mining Node 1464 to Emulation Hypervisor with Virtual Interface 1554, BCHAIN Protocol (BP) 794 and Hypervisor Interface 1556. Emulation Hypervisor 1522 is an interface which submits specialized instructions to the CPU to allow for a virtually isolated environment to execute BCHAIN Protocol 794 modules without compromising nor affecting the main iteration of the BCHAIN Protocol 794 that is operating on the node. Hypervisor Interface 1556 Entire Module Replication. Emulation Hypervisor 1522 loads the entire module set for the BCHAIN Protocol, so that a wholistic virtualization of the correct BCHAIN Protocol 794 response can be measured. DC2 1506 module receives relevant and fulfilled blocks of the Metachain to emulate what the correct BCHAIN Protocol response to a targeted node's former environmental situations. By analyzing BCHAIN Network environment factors, this module can perceive of the most correct and plausible (in situations concerning ambiguity) response to such factors. Therefore a node's prior actions can be checked to see if they are in accordance with the legitimate definition of the BCHAIN Protocol 794, or if the node's firmware/software is intentionally or unintentionally compromised. Therefore elements of node trust can be established which enables subsequent procedures within the BCHAIN Network such as Appchain Merging.

FIG. 113 to FIG. 115 provide details on the Metachain Retention Download (MRD) 1560. Economic Fair Value Appraisal (EFVA) 1578 Receives input information concerning the supply/demand variables of multiple module scopes. Therefore an accurate fair market value of a specific task can be measured, which precedes to inform other nodes on their work deciding processes. FIG. 115 also starts the Information Search Sequence with 1586, 1590 and 1594.

FIG. 116 to FIG. 118 continue the Information Search Sequence from FIG. 115 with 1594 followed by 1602, 1606, 1608, 1612, 1620, 1626, 1632, followed by MRD 1560.

FIG. 119 provide an overview of the Information Search Sequence Node Map 1638 with BCHAIN Node (BN) 1640 (The Node that originated the Block Bounty request), BN 1642 (A node that denied the offer for finding the node), BN 1644 (A node that accepted the bounty but did not have the requested block), BN 1646 (A node that accepted the bounty and did have the requested block) and Exponential Transfer Growth of Block Bounty 1566. As a Block Bounty is passed throughout the BCHAIN network, its exposure and interaction with other nodes increases exponentially due to a single node having multiple neighbors.

FIG. 120 provides Illustration of Low Priced Economic Authorization Toke (EAT) 1648, Illustration of High Priced Economic Authorization Token (EAT) 1650. Finite Search Eventually Ends Despite Fee Level and Exponential Growth Mechanism 1642. To avoid a block bounty from permanently overloading a system due to perpetual and exponential growth, the appeal of a Block Bounty diminishes upon each hop due to the reward of the Block Bounty being shared with each node that passes it on. Therefore the Block Bounty eventually ceases to be passed on due to it being a non-appealing economic prospect with nodes that are proposed to interact with the Block Bounty. Therefore the proposed fee that is attached to the Block Bounty via an Economic Authorization Token (EAT) 1648 makes all the difference as to the magnitude of reach which the Block Bounty has across the BCHAIN network, and hence the prospects of the desired Metachain Block being found. Metachain Retention Logic (MRL) 1658 this module executes the decision making process for which Metachain blocks the node should retain. Therefore this module attempts to retain the most appropriate assortment of Metachain blocks to increase the likelihood of the node being able to successfully fulfill a Metachain Retention Download (MRD) 1560 request. Efficient fulfillment of such requests leads to a better economic outlook for the node serving the request, and a more efficient execution of BCHAIN Protocol processes (Such as an Appchain Merger). Appchain Merging Events and varying magnitudes of Metachian density 1652. Varying Magnitudes of Metachain Density due to Varying Merging Occurrences 1654. The Metachain Retention Logic (MRL) 1658 module will be executed in areas which vary in degrees of Appchain merger occurrences. Therefore in areas where there is a high magnitude of Appchain mergers, MRL 1658 will instruct the node to retain more of the Metachain in the Random Retention Zone. Appchain Merging Events 1656. When an Appchain successfully merges, the rudimentary information concerning the event is broadcasted to the network for statistical tracking purposes. Such statistics, in turn, inform modules such as MRL 1658 on their decision making process.

FIG. 121 to FIG. 124 provide details on Customchain Dilemma Interpretation (CDI) 1660. On FIG. 122 Miner/Cache Activity Detection (MCAD) 1688 determines which miners and cachers contributed to the Target Appchain on the slave version of the Metachain after the Metachain Split Point. Also on FIG. 122 Customchain Split Discovery (CSD) 1692 module calculates the point in time in which two versions of a Customchain began differing in composition.

FIG. 125 to FIG. 127 provide details on Proof of Dilemma Corroboration Sequence 1698. FIG. 128 to FIG. 129 provide details on Appchain merge Processing (AMP) 1740. FIG. 130 details the Block Unpacking Process (BUP) 1766. FIG. 131 details the Retrospective Block Scope Consensus (RBSC) 1784. FIG. 132 to FIG. 136 provide details on the Appchain Merge Processing (AMP) 1740.

FIG. 133 provides details on the Merged Mempool Stream 1770. Data Amount Vector 1816 illustrates the amount of content that a specific block contributes and plots across the Merged Mempool Stream 1770. Data Timespan Vector 1818 illustrates the magnitude of scope which the data within a specific block reaches. Linear Measurement of Time 1820 measures time on a consistent and linear basis, to which the contents of various blocks are plotted against. FIG. 134 provides details on Scoped and Merged Mempool Stream 1794. Classic Mining Logic for Retrospective Blocks is the same mining logic used by CIM 2470 to mine typical new blocks is used to retrospectively mine blocks that are inserted mid-Appchain/Microchain. The key difference is that typical new blocks only require Proof of Work, while retrospective mining requires Proof of Work and Proof of Dilemma. Consensus on New Retrospective Block Allocations. Due to all participating nodes execution the same legitimate specification of the BCHAIN Protocol, their criteria for where to draw scope lines concerning the Merged Mempool Stream leads to an eventual consensus on the retrospective mining of such blocks, which leads to an eventual consensus on the composition of the Appchain/Microchain despite the operation of complex procedures such as Appchain Merging.

FIG. 135 provides the merged Appchain 1828 with Appchain Version A Master 1812 and Appchain Version B Slave 1814. FIG. 136 demonstrates the Merge Event Tracking (MET) 1836 module which appends Merge Event Tags 1830 (which includes Time of Merger 1832, Master/Slave Affinity 1480 and Nodes Involved Record 1834) to a Merge Event Ledger 1838 which accompanies every single block that has ever undergone an Appchain Merger. This enables future iterations of advanced analytics and security operations concerning Customchain information injection attacks.

FIG. 137 details Mining nodes Supplying Cache Seeding (MNCS) 1850. Sector Tax Creation (STC) 1872 module creates a Tax Consequence Unit (TCU) 1852 which enumerates the positive or negative tax. consequences that are to be enacted upon the variable time when Cache Fulfillment occurs. The factors that define the composition of a TCU 1852 include the amount of nodes in the sector, Sector Demand magnitude, Sector Emergency Funds magnitude etc. Sector Tax Enforcement (STE) 1924 evaluates the Cache Fulfillment performance of the nodes in the sector. Upon the eventual achievement of Cache Fulfillment status within the sector, this module enforces the tax code as stipulated in the TAX Consequence Unit (TCU) 1852. Sector Tax Announcement (STA) 1864 broadcasts the Tax Consequence Unit (TCU) 1852 to all applicable nodes within the relevant sector jurisdiction. Node references are primarily made via Location Association in the Metachain.

FIG. 138 outlines the Tax Consequence Unit (TCU) Enforcement 1866 shows BCHAIN Nodes 786, BCHAIN Mining Nodes 1870, TCU 1852 in Sector J21 884 and Sector KL4 884. Initial Tax Consequence Consensus Amongst Miners of a Specific Sector. Tax Consequence creation, consensus, and application all occurs independently within any given sector. The BCHAIN Mining Nodes (BMNs) of any given sector first reach a consensus on the definition of the Tax Consequence Unit (TCU) before broadcasting the contents to nodes within the same sector via Sector Tax Announcement (STA).

FIG. 139 outlines details of Sector Tax Creation (STC) 1872. Variable Emulation Module (VEM) 1880 creates reliable uniform variables with any given dynamic input. Mining Node Consensus Protocol (MNCP) 1884 along with Raw Variables Pre-TCU 1882 allows miners to reach a consensus on Pre-TCU Raw Variables which produces an exactly unified final version of TCU amongst all the miners of the specific sector.

FIG. 140 concludes STC 1872 and details Tax Consequence Unit (TCU) 1852. TCU 1852 contains a Schedule Tax Plan that is enacted upon at the time of cache fulfillment. The Tax Consequence Unit (TCU) 1852 enumerates the potential Tax break or Tax penalty that is to be enacted considering any potential amount of time it takes for the nodes of the respective sector to collectively accomplish Cache Fulfillment of the specific content delivered from the newly mined block.

FIG. 141 details Sector Tax Announcement (STA) 1900 with Jurisdictionally Implied CCF Submission (JICS) 4194.

FIG. 142 and FIG. 143 provide details on Sector Tax Reception (STR) 1904. STR 1904 is logic which is processed within an individual BCHAIN Node that decides on the most effective time to comply with the Tax Consequence Unit (TCU) 1852. Such a decision is made without collaboration with other nodes in the same sector that received the same TCU 1852. Therefore the node estimates it's own factors such as Economic Personality 740, availability and profit margin of alternate work, local resources available etc. The logic is executed upon the understanding that if all of the nodes procrastinate the adoption of the announced cache to fulfill, then all of the nodes in that sector will have to equally pay the price in the form of taxes which are submitted to the Emergency Sector Funds of the Metachain. Therefore nodes within a sector need to collaborate without explicit communication on such a topic, which evokes a Prisoner's Dilemma like scenario (is a standard example of a game analyzed in game theory that shows why two completely “rational” individuals might not cooperate, even if it appears that it is in their best interests to do so). Node Cache Compliance (NCC) 2110 is logic execution that entails a node adopting and retaining the data which has been specified by the sector's miners upon an invocation of Sector Tax Announcement (STA) 1900. Cache Fulfillment is the instantaneous point in time when a sufficient amount of cache adoption has been undertaken by nodes within a sector. Cache Fulfillment only occurs upon claimed and verified adoption of such cache. Cache Compliance is the act of a node complying with the commands of it's sector's miners in caching the highlighted data. To counteract a rogue node lying about complying with the order, nodes are deterministically and randomly tested to see if they are truly retaining the data, or if they are pretending to have the data.

FIG. 144 and FIG. 145 outline Sector Tax Enforcement (STE) 1924. FIG. 145 1938 shows STA 1940, Node A Compliance 1942, Node B Compliance 1944, Node C Compliance 1946, Time Limit Reached 1954, No More Compliance Attempts 1950, Cache Fulfillment Achieved 1948 with Decrease in Tax (Tax Break) arrow going up and Increase in Tax (Tax Penalty) arrow going down. At the point where 1948 and 1946 meet, Cache Fulfillment Ends Demand of Node Compliance. Once Cache Fulfillment has occurred, the dynamic of Cache Compliance changes since there is no longer a penalty factor concerning when or if to comply. However, nodes are still able to volunteer to adopt such available caches due to their defined Economic Personality 740 and/or perception of adoption profitability. Time 1956, Time Limit Reached 1954, Cache Adoption (# of Nodes) 1958, Cache Fulfillment Achieved 1948.

FIG. 146 details Data Integrity Scanning (DIS) 1960. Content in Danger Report 1982 is a comprehensive report which enumerates the identity of the data which is claimed to be in danger of permanently losing integrity, with external references to evidence which indicates such a danger is a concerning reality to the system at large. Such external references are made via the Metachain so that alternate parties may verify such claims of data integrity dangers.

FIG. 147 to FIG. 150 detail Data Refuge Processing (DRP) 1984.

FIG. 148 Sector Refuge Discovery (SRD) 2002 locates a sector that has the best likelihood of adopting data with an accurately urgent Content in Danger Report. Sectors with higher sector Emergency Funds are more likely to adopt data in refuge. In addition, proximity to this finder node's (self's) is considered as to avoid an unnecessarily long migration path to attain data integrity safety. Sector Mining Node Locator (SMNL) 2004 searches for an appropriate Mining Node within the Target Sector which was selected in SRD 2002.

FIG. 149 Data Refuge Application Generator (DRAG) 2010 creates a container of information which enumerates the information listed in the original Content in Danger Report as well as Finder Node identification and payment information.

FIG. 150 Sector Refuge Application (SRA) 2014 is a verified miner within the target sector considers the situation enumerated in the Data Refuge Application 2006. Therefore it invokes it's own instance of Data Integrity Scanning (DIS) 1960 for independent verification of the data integrity scenario.

FIG. 151 to FIG. 155 detail the logic for Sector Refuge Application (SRA) 2014 which started on FIG. 150.

FIG. 156 to FIG. 158 outline the Self Node (Miner) process with Node Cache Provider 2080 details including Node Cache Compliance Recording (NCCR) 2230, Compliance Event Log 2250, Cache Fulfillment API 2108, Seed Cache Pool Deletion 2180, Seed Cache Pool 2112, etc.

FIG. 159 continues with Node Cache Compliance (NCC) 2110 process which started in FIG. 158. Node Cache Response (NCR) 2080 on FIG. 160 complies with the Node Cache Verification (NCV) 2152 request from the Verification Node 2150 by responding with the requested Challenge Hash.

FIG. 160 outlines Node Cache Verification (NCV) 2152 within the Verification Node 2150 utilizing Online Check Via Metachain (OVCM) 2160, Cache Verification Challenge 2170, Challenge Hash 2172.

FIG. 161 continues and concludes the Node Cache Verification (NCV) 2152 process with either Report as Confirmed 2178 to Compliance Event Log 2250 within NCP 2080 and Self Node (Miner) 2078 or End modular execution without reporting compliance event as confirmed 2176.

FIG. 162 outlines the Seed Cache Pool Deletion (SCPD) 2180 process which starts with Has Cache Fulfillment Occurred 2182 and ends with Delete the Cache Part Entry from the Seed Cache Pool 2192 if successful or Terminate module execution with null modular 2184 if unsuccessful.

FIG. 163 outlines the Node Cache Provider (NCP) 2080 details and interactions with Node Cache Fulfillment Check (NCFC) 2200.

FIG. 164 provides details on Node Cache Response (NCR) 2210 on its inner process with Primary Node Cache Content (PNCC) 1218, Challenge Hash 2172, NCV 2152, Challenge String 2224, etc.

FIG. 165 and FIG. 166 provides details on Node Cache Compliance Recording (NCCR) 2230.

FIG. 167 provides the details on Compliance Event Log 2250.

FIG. 168 provides details on the Node Cache Compliance Recording (NCCR) 2230. Challenge String 2224 is an eight byte length Challenge String 2272, Start of Part 2264, Random Value X 2266, End of Part 2268.

FIG. 169 shows Data Migration Patterns 2280 with Desired States Between Data Integrity and Content Serving and the BCHAIN Network, via the BCHAIN Protocol, attempts to constantly maximize the level of Data Integrity and Optimal configuration for fast and consistent content delivery. This is done considering the finite resources available amongst the nodes of the BCHAIN Network. Area of Initial Content Seeding 2282, Area of Content Integrity 2284 represents Integrity Optimal Locations: The BCHAIN protocol has a binary approach to data retention integrity. All data is treated as of vital importance, and no data is allowed to be lost unless an intentional data expiration event has been executed. Therefore the protocol guarantees the redundancy of the data despite the chaotic distribution and uptime of individual nodes. With Area of Initial Content Seeding 2282, confirmed mining nodes (nodes that have successfully mined a block) enforce tax policies that motivate nodes within a sector to cache content from a newly mined block. Area of High Content Demand 2286 is a Service Optimal Location—content demand is expected to culminate in specific pockets of the network. Therefore the Cache Selection Algorithm (CSA) will enable cache hosting of content in areas closer to the demand for such content. This leads to an overall relief to the network as routing packets (CCR/CCF) need to travel much less to accomplish the same data transfer. This also leads to lower latency and higher transfer speeds to consumers of information.

FIGS. 170-358 provide details on Routing Logic 774 which is the main core of BCHAIN (Base Connection Harmonization Attaching Integrated Nodes) Network 110 including the various algorithms it utilizes. The essence of BCHAIN is to route packets efficiently over a mesh in a decentralized fashion. Nodes take on different roles in a chaotic distribution of resources, some end up serving Content Claim Requests (CCRs) 2308, some receive Content Claim Fulfillments (CCFs) 2318. Main routing logic occurs around the PBHP 2322 creation, reference and updating. A very unique aspect of the routing logic is found in Optimized Section Route Discovery (OSRD) 3430 FIGS. 291-294, which is an intelligent caching system that automatically detects efficient routes throughout the node topology without spending significant resources. Two main aspects of the module are Edge Node detection (END) 3672, FIGS. 317-323 and the Boomerang Algorithm 3830 starting on FIG. 329. The boomerang sequence is an efficient method of determining the angle and area of packet traversal by taking advantage of the chaotic distribution of nodes. Therefore efficient packet routes become ‘self aware’ which leads to optimized highways of information along the node topology.

FIG. 170 Routing Logic (RL) 774, receives input from Customchain Storage (CS) 832 (which consists of Metachain 834, Appchain 836, and Microchain 838) through Customchain Recognition Module (CRM) 3060 which connects with Customchains (which can be Appchains or Microchains) that have been previously registered by the node. Hence the node has cryptographic access to read, write, and/or administrative abilities to such a function. This module informs the rest of the BCHAIN Protocol when an update has been detected on an Appchain's section in the Metachain or a Microchain's Metachain Emulator.

FIG. 171 continues from FIG. 170 on the process of RL 774. Content Claim Delivery (CCD) 3260 upon receiving a valid Content Claim Request (CCR) 2308, this module produces and sends the relevant Content Claim Fulfillment (CCF) 2318 to fulfill the request.

FIG. 172 continues from FIG. 171 on the process of RL 774. Content Claim Rendering (CCR) 3300 upon receiving a validated CCF 2318, this module renders the request content to the user via a frontend such as the UBEC Platform Interface.

FIG. 173 details the contents of CCR 2308 which consists of Claim Origination 2310, Perceived Content Location Plausibility 2312, Cryptographic Proof of Entitlement 2314, Trail Variable Suite (TVS) 2320, Proposed Baseline Hop Path (PBHP) 2322, Node Unique Identification 4304 and Target Type 2300. Target Type 2300 consists of Immediate Target 2302 is the node that is immediately sought in the next hop sequence of the journey pathway, Subsequent Targets 2304 which is a dynamically growing and shrinking list of nodes that are perceived to be the best short term path to facilitate an efficient journey towards Final Target 2306, and Final Target which is the intended destination node which is either expecting delivery content or is delivering content itself. Claim Origination 2310 includes a cryptographically signed block of information that indicates the identification details of the originating node that provided the content claim. Perceived content Location Plausibility 2312 is a dynamically varying set of variables that indicate the primary aspects of node hop routing. Cryptographic Proof of Entitlement 2314 contains a cryptographically signed block of information that indicates that the origination node has access to a valid key which can access the specified Appchain/Microchain. Such a key can be assigned read permission, write permissions, and/or administrative capabilities. Such keys can also be cryptographically revoked by Appchain/Microchain administrators on a per user or group level.

FIG. 174 details the contents of CCF 2318 which consists of Content Origination 2326, Perceived Content Delivery Plausibility 2313 (shown as 2312 in FIG. 174), Encrypted Part of Content 2314, Trail Variable Suite (TVS) 2320, Proposed Baseline Hop Path (PBHP) 2322, Node Unique Identification 4304 and Target Type 2300. Content Origination 2326 includes a cryptographically signed block of information that indicates the identification details of the originating node that provided the content fulfillment. Perceived Content Delivery Plausibility 2313 (shown as 2312 in FIG. 174) is a dynamically varying set of variables that indicate the primary aspects of node hop routing. Encrypted Part of Content 2314 has the requested information which is fulfilled by a cache node returning a relevant Part of information to the claimant of such information. The Part size is actively optimized by Strategy Deployment to find the optimal Part size for overall network performance.

FIG. 175 provides details on the Communications Gateway (CG) 2348 its components Node Interaction Logic (NIL) 2380, Cache Work Acceptance (CWA) 742 and its interworking with API Endpoints 792, Communication Bandwidth Saturation 2346, Outgoing CCR/CCF 2308, and PBHP 2322.

FIG. 176 to FIG. 180 primarily describe the Cache Selection Algorithm (CSA) 2350. Customchain Recent Saturation Evaluation (CRSE) 2351 module checks if the incoming CCF's 2318 Appchain has been recently witnessed in Recent Hop History (RHH) 2354.

FIG. 181 to FIG. 184 define the process within Node Interaction Logic (NIL) 2380 which is the primary logic for interacting and exchanging information with other nodes. This is the closest layer to the Hardware Interface 762 within the BCHAIN Protocol. Hardware Interface 762 consists of Cellular Antenna Microchip 2402 which has 5G/4G/LTE/3G Connectivity 2404 and GSM/CDMA 2406. It also has Wireless Antenna Microchip 2408 with both WIFI (i.e., Spec 802.11ac) 2410 and Bluetooth (i.e., Version 4.2) 2412 capabilities.

FIG. 185 to FIG. 190 describe the process for Legacy Network Bridging Mechanism (LNBM) 2410 and Node Interaction Logic (NIL) 2380. It concludes with Node statistical Survey (NSS) 778.

FIG. 191 to FIG. 193 describe the process within Customchain Interface Module (CIM) 2470 which interacts with Data Integrity Management (DIM) 1204, Communications Gateway 2348, Broadcast Processor (BP) 2704. Jurisdictionally Implied CCF Submission (JICF) 4134 has CCF's 2318 are sent to a node without an accompanying CCR 2308 due to the node's jurisdictionally implied responsibility of receiving such a CCF 2318. Broadcast Processor (BP) 2704 is an intermediate stage between hop routing logic and Communications Gateway (CG) 2348, this module cryptographically signs outgoing transactions as well as orders them in a first-come-first-serve basis until hardware congestion levels allow for more transactions to be broadcasted.

FIG. 194 to FIG. 198 describe the Mining Selection Algorithm (MSA) 2484. It interacts with CG 2348, CS 832, Appchain Traffic Trend Tracking Management (ATTTM) 2500 on FIG. 194. CIM 2470 contains rudimentary functions that facilitate the mining of Customchains.

FIG. 199 to FIG. 203 provide details on New Content Announcement (NCA) 2544. Jurisdictionally Implied CCF Submission (JICF) 4134 is where CCF's 2318 are sent to a node without an accompanying CCR 2308 due to that node's jurisdictionally implied responsibility of receiving such a CCF 2318.

FIG. 204 to FIG. 206 show details on Node Storage Processing (NSP) 2590. Node Statistical Survey (NSS) 778 provides input to NSS Variable Pooling (NVP) 4140. NVP 4140 is where Nodes from within the same sectors announce their perception of the Node Statistical Survey (NSS) 778 Variables to each other to build consensus on the sector's characteristics. Therefore the local and remote NSS 778 variables are pooled together to create a composite average known as NVCI. This composite is used to maintain consensus on the scope and definition of this sector, and hence where it's boundaries lie. Node information received via Jurisdictionally Accepted CCF Reception (JACR) 4208 and NVP 4140 is submitted to NSP 2390 where NSS variables are unpacked from remote nodes and the local NSS instance 2592. Local Node Tracking (LNT) 2620 stores information concerning currently allocated nodes in the local vicinity as defined by the scope of Node Statistical Survey (NSS) 778.

FIG. 207 to FIG. 209 show details on Proposed Baseline Hop Generator (PBHG) 2640. Local Node Awareness Supplement (LNR) 2642 replaces nodes that are within the hop scope of LNT with nodes that are proven to provide a reliable initial hop pathway. Final Target 2306 is the intended destination node which is either expecting delivery content or is delivering content itself. Immediate Target 2302 is the node that is immediately sought in the next hop sequence of the journey pathway. Subsequent Targets 2304 is a dynamically growing and shrinking list of nodes that are perceived to be the best short term path to facilitate an efficient journey towards Final Target 2306. Alternate Final Targets 2652 are proposed nodes that offer similar functionality as the Final Target 2306. This way a carrier node can easily switch to an alternative Final Target in case the original Final Target 2306 is unreachable. Node Stability Exchange (NSE) 2301 (not labeled on FIG. 208) replaces nodes that are considered unreliable with nodes that are in stable/reliable environments.

FIG. 210 to FIG. 212 show processes related to Shortest Route Detection (SRD) 2660.

FIG. 213 to FIG. 215 show details of Queued Information Broadcast (QIB) 2700. Sector Crossing Event Processing (SCEP) 3360 decommissions a completed Trail Variable Suite (TVS) 2320 upon a CCR 2308 or CCF 2318 transferring to a new sector and then commissions a new TVS 2320 for the packet's onward journey. Best Hop Perception (BHP) 2720 provides the primary logic for advancing a CCR 2308 or CCF 2318 to it's immediate and subsequent targets for its onward journey to it's Final Target 2306. Local Node Tracking (LNT) 2620 stores information concerning currently allocated nodes in the local vicinity as defined by the scope of Node Statistical Survey (NSS) 778.

FIG. 216 to FIG. 218 show details of Broadcast Processor (BP) 2704 which is an intermediate stage between hop routing logic and Communications Gateway (CG) 2348, this module cryptographically signs outgoing transactions as well as orders them in a first-come-first-serve basis until hardware congestion levels allow for more transactions to be broadcasted. Recent Hop History (RHH) 2354 is a temporary cache that stores CCR 2308 and CCF 2318 header information so that various algorithms can incorporate the implications of such entries into their logic. Recent Hop History Management Module (RHHMM) 2702 is where outgoing CCRs 2308 and CCFs 2318 are recorded in RHH 2354 to facilitate multiple other algorithms which refer to this cache of information. Once the system no longer considers a witness event from being ‘recent’, the entry is deleted from RHH 2354.

FIG. 219 to FIG. 221 show details of Best Hop Perception (BHP) 2720. Check if Self 2722 is the crucial stage at which a node will recognize that it has been made the intended target within a hop pathway. Recalculate Subsequent Targets 2732 such as next ten hops. Final Target 2306 is the intended destination node which is either expecting delivery content or is delivering content itself. Immediate Target 2302 is the node that is immediately sought in the next hop sequence of the journey pathway. Subsequent Targets 2304 is a dynamically growing and shrinking list of nodes that are perceived to be the best short term path to facilitate an efficient journey towards Final Target 2306.

FIG. 222 to FIG. 223 show details of Subsequent Target Advancement (STA) 2740. As the CCR 2308 or CCF 2318 is processed through the Routing Logic, this module interprets the Subsequent Targets 2304 field to produce the next Immediate Target 2302. This module checks if any of the Subsequent Targets 2304 are currently available for an immediate and direct transmission of information, even if this wasn't expected by the Proposed Baseline Hop Path (PBHP) 2322. This means that if chaotic movements of nodes affords a potential micro-optimization in the sequence (a shortcut), then this module will detect it and take it by altering the declared Immediate Target 2302. Subsequent Targets 2304 is a dynamically growing and shrinking list of nodes that are perceived to be the best short term path to facilitate an efficient journey towards Final Target 2306. LNT 2620 stores information concerning currently allocated nodes in the local vicinity as defined by the scope of Node Statistical Survey (NSS) 778.

FIG. 224 to FIG. 228 show details of Hop Strategy Calculation (HSC) 2770.

FIG. 229 to FIG. 232 show details of Proposed Baseline Hop Path Extraction (PBHPE) 2820.

FIG. 233 to FIG. 235 show details of Recalculate Path (RP) 2880. Perceived Content Location Plausibility 2312 provides input to Alternative Final Targets 2652 which proposes nodes that offer similar functionality as the Final Target 2306. This way a carrier node can easily switch to an alternative Final Target 2306 incase the original Final Target 2306 is unreachable. Alternate Final Target Discovery (AFTD) 2646 searches for targets that are similar in function and geography to the Final Target Destination.

FIG. 236 to FIG. 240 show details of Parallel Hop Logic (PHL) 2922. It starts with Final Target 2306 and ends with either No Parallel Hop Paths to Initiate 2948 or Hardware Interface 762.

FIG. 241 to FIG. 244 show details of Parallel Hop Initiation (PHI) 2960. Local Node Awareness Supplement (LNR) 2642 replaces nodes that are within the hop scope of Local Node Tracking (LNT) 2620 with nodes that are proven to provide a reliable initial hop pathway. LNT 2620 stores information concerning currently allocated nodes in the local vicinity as defined by the scope of Node Statistical Survey (NSS). Node Stability Exchange (NSE) 2982 replaces nodes that are considered unreliable with nodes that are in stable/reliable environments.

FIG. 245 to FIG. 247 show details of Over-Parallelized Hop Path Reduction (OPHPR) 3000.

FIG. 248 to FIG. 251 show details of Content Claim Generator (CCG) 3050.

FIG. 252 shows details of Customchain Recognition Module (CRM) 3060. Realtime Updates 3062 contains realtime Metachain updates as the local chain storage gets updated by CIM, any Appchain updates are pushed to CRM in realtime so that appropriate CCRs can be generated. Due Appchain Retrieval Detection (DARD) detects pending differences between the realtime-updated Metachain Appchain Updates and the locally known versions of the Appchains. This way if an Appchain gets updated, the differing timestamps will instruct this module to highlight that a CCR 2308 is due to be sent to fetch such information.

FIG. 253 and FIG. 254 show details of Cryptographic Entitlement Generator (CEG) 3080.

FIG. 255 and FIG. 256 show details of Excluded Node Connection Discovery (ENCD) 3100.

FIG. 256 to FIG. 258 show details of Best Node Selection (BNS) 3120. Potential Destination Node Results (PDNR) 3058 is a temporary list that is cached by the node to consider the best potential destination nodes

FIG. 259 to FIG. 261 show details of Location Association 840, Optimized Sector Routing 858 and Appchain Cache Location 848 which are all within the Metachain.

FIG. 262 to FIG. 264 show details of Preliminary Target Selection (PTS) 3170 which efficiently discovers nodes that fulfill the criteria of the Content Claim Generator (CCG) 3050 by using optimized node discovery data that is provided by the Metachain. It starts with Origination Node (self) 2582 and ends with Potential Destination Node 3196.

FIG. 265 to FIG. 267 show details of Microchain Bypass Consensus (MBC) 3200. It can have three potential starts which include: Appchain Self Imposed Miner 3211 (not labelled on FIG. 265), Appchain Cache Nodes 3210 or Appchain Consumer Nodes 3212.

FIG. 268 and FIG. 269 show details of Microchain Bypass Check (MBC) 3230. It starts with Request for Metachain and/or Appchain Information 3228 and ends with Return points of access of Metachain information with the Microchip-emulated version 3228. Static Hardcoded Policy (SHP) 488 provides criteria that is hardcoded into the BCHAIN Protocol. Such criteria is static as opposed to the usual dynamic strategy based criteria because this criteria is used to define strategy itself. Hence if mechanism used to produce strategies itself relied on strategies, the system is expected to eventually loop itself into an extreme state which has limited and/or abnormal functionality and effectiveness. Metachain Emulator 880 is a Metachain Emulator for Microchain Enabled Information Transfer—The Microchain is a localized and merged combination of the Metachain and an Appchain. Hence an algorithm's access to the Metachain is replaced with access to the Metachain Emulator upon the requested Appchain being a Microchain. Microchain implementation is seamless and transparent to the end user, it is solely a protocol routine that optimizes resource consumption efficiency.

FIG. 270 to FIG. 276 show details of Content Claim Request (CCR) 2308, Content Claim Delivery (CCD) 3260, Content Claim Fulfillment (CCF) 2318 (mislabeled as Content Claim Request on FIG. 274), Perceived Content Delivery Plausibility 2312 (mislabeled as Perceived Content Location Plausibility on FIG. 274), Trail Variable Suite (TVS) 2320 and Economic Authorization Reversal Processing (EARP) 3290. It starts with CCR 2308 and ends with Queued Information Broadcast (QIB) 2700.

FIG. 277 shows details of Economic Authorization Reversal Processing (EARP) 3290 which contains Logically Deduced Path Reversal (LDPR) 3292. LDPR 3292 receives the original PBHP 2322 which has been pre-authorized by the sender of the CCR 2308. The path is then reversed to indicate what scope of a pathway the CCR 2308 sender has pre-authorized for a return journey. The Reversed Pathway may not be an inverse mirror image of the Original Pathway due to complexity in the node layout. This is similar to one way roads which indicate that you cannot go back the way you came.

FIG. 278 to FIG. 282 show details of Content Claim Fulfillment 2318 (mislabled in FIG. 278 as Content Claim Request), Content Claim Rendering (CCR) 3330. It starts with CCF 2318 and ends with Content Download 3318 within the UBEC Platform Interface (UPI) 728. CCR 3330 represents the final stage in a CCF's 2318 journey and concludes the fulfillment of the original content request (whether explicitly or implicitly made). Hence for the last instance of this CCF's 2318 journey TVS Decommission Process (TDP) 3402 is called to return statistical results and to reward the work done by nodes in the hop pathway. Content Hashsum Check (CHC) 3302 validates that the transferred or stored content Part was not corrupted during transit by checking its hashsum output compared to the provided pre-generated hashsum. Stagger Release Content Cache (SRCC) 810 has content parts that are stored and held until a satisfactory amount of them have been collected (as indicated by Content Decoding Instructions). They are then compiled and released as Downloaded Content to the UBEC Platform Interface 728.

FIG. 283 to FIG. 285 show details of Sector Crossing Event Processing (SCEP) 3360 which includes Trail Variable Suite (TVS) 2320, TVS Creation Process (TCP) 3380, TVS Decommission Process (TDP) 3402. TCP 3380 creates and invokes a brand new array of variables to populate a new Trail Variable Suite (TVS) 2320. This includes a new Strategy Deployment interpretation from Dynamic Strategy Adaptation (DSA) 772 and a blank Hop ledger 3282. The only variable that is reused from the old TVS is the Economic Authorization Token (EAT) 994. TDP 3402 is a Trail Variable Suite (TVS) 2320 which is due to be replaced by a new one is processed for data-derived intelligence gathering purposes. This allows for a BCHAIN Work Unit (BWU) 1216 payout to be processed to all the nodes that participated in the transferring of the CCR 2308 or CCF 2318 as indicated in the Hop Ledger 3282. Performance information is gathered from the Strategy Deployment 916 to be stored in Strategy Performance Tracking (SPT) 920.

FIG. 286 to FIG. 290 show details of TVS Creation Process (TCP) 3380 and TVS Decommission Process (TDP) 3402. TVS 2320 is a collection of variables which are dynamically amended and referenced as a CCR 2308 or CCF 2318 as it traverses a sector. Work Settlement Mechanism (WSM) 3980 provides payment for work done by nodes in authorized and submitted to the Infrastructure Economy section of the Metachain 834. Hop Ledger 3282 is a cryptographically secure list of nodes that have participated in the transferring of a CCR 2308 or CCF 2318 within a specific sector. Since a node must exist at exactly two sectors at any given time, the Hop Ledger is reset during the decommission process upon the relevant TVS 2320 being received by a node that does not belong to either of the two sectors defined in Trail Sector Identification 3280. Sector Pricing Mechanism (SPM) determines the BCHAIN Work Unit (BWU) 1216 price of transferring information via a node hop for a specific sector by referenced information which has accumulated in Sector Demand 854 of the Metachain 834. Strategy Performance Interpretation (SPI) 3420 receives deployed strategies with field data which dictates the perceived performance of such strategies in varying environmental conditions.

FIG. 291 to FIG. 294 show details of Optimized Sector Route Discovery (OSRD) 3430. Inter-Sector Route Bridge Producer (Inter-SRBP) 3506 bridges a series of sectors via efficient Inter-Sector pathways (acronym in FIG. 291 is mislabeled as Inter-SRSP). Intra-Sector Route Segment Producer (Intra-SRSP) 3460 produces a proposed route segment which aims to provide an efficient pathway of content delivery from one edge of a sector to another. Wholistic Route Path Election (WRPE) 3480 proposes efficient Inter-Sector routes by joining multiple Route Segments together. Sector Route Segment Retention (SRSR) 3500 is a database that retains routes performed by decommissioned Hop Ledgers 3282. They are added directly when a node's instance of this database experiences a decommission event from TDP 3402, or when nodes from other sectors announce to this node about the decommission Hop Ledgers 3282 that they've received. Sector Makeup 3450 highlights Intra-Sector Route Segment (Intra-SRS) 3452 and Inter-Sector Route Segment (Inter-SRS) 3454 and Sector 884. Intra-SRS 3452 is able to discover Efficient Hop Pathways which encompass an edge to edge journey within a single sector. Such discoveries are performed by the Intra-SRSP 3460 module. Inter-SRS 3454 module finds efficient points of overlap that allows multiple Route Segments to be bridged together to eventually form Optimized Sector Routes which are stored and referenced in the Metachain 834.

FIG. 295 and FIG. 297 show details of Intra-Sector Route Segment Producer (ISRSP) 3460. Input is received from TVS 2320 into the Hop Ledger 3282 and Trail Sector Identification 3280.

FIG. 298 and FIG. 299 show details of Wholistic Route Path Election (WRPE) 3506 which receives input from Psuedo-Random Event Trigger Synchronization (PRETS) 3440 into the PRETS invokes module initiation 3484.

FIG. 300 to FIG. 301 show details of Inter-Sector Route Bridge Producer (Inter-SRBP) 3506 which bridges a series of sectors via efficient Inter-Sector pathways. Sector Route Segment Retention (SRSR) 3500 stores route segments which contain information concerning the Hop Pathway itself, reliability rank, and Direction Orientation 3520. Route Direction Orientation Designation (RDOD) 3582 module calculates the Direction Orientation 3520 of an intra-sector pathway according to it's relative proximity to the calculated position of the relevant Edge Nodes.

FIG. 302 shows Sector Interlacing Overview 3530. Route Segment Entry/Exit Stages 3534 are preliminary levels of node interaction complexity indicate that all traversable route segments are reversible. This primary tier of node management is sufficient due to the presumption of bidirectionally co-equal hop efficiency. A second tier of node management is deployable to optimize algorithm perceptions to consider nuances in node interaction that lead to a pathway not being perfectly reversible in regards to efficiency. Therefore the primary tier of node management entry and exit stages are synonymous with each other. Having determined the general direction of a route segment via Sector Width Intersection 3532, modules like Inter-SRSP can select the most befitting Route Segments considering it's Sector Level Hop Path. Sector Width Intersection 3532 is where the RDOD module 3582 measures the width at which two sectors intersect each other. Therefore a route segment's entry/exit stages can be attributed in increments towards specific sectors. Hence an accurate assessment of pathway direction, relative to other sectors, is calculated. Intra-Sector Route Segment (Intra-SRS) 3452 and Sector 884 are also shown.

FIG. 303 shows Sector Interlacing Specified View 3531 (not labeled in FIG. 303) where Edge Nodes 3536 are strategically selected to act as reference points for calculating Direction Orientation 3520. Sector Route Bridging on a Best-Effort Basis 3454 is where Inter-Sector segments are calculated to achieve the most efficient travel pathway possible between two agreed upon Intra-Sector Route Segments.

FIG. 304 shows Route Segment Prioritization Logic (RSPL) 3540. Route Reliability/Distance Tradeoff 1020 is a variable to define the perceived zone of efficiency concerning the selection tradeoff between reliability of selected Nodes and expected distance travelled. The ideally tuned variable for maximal efficiency will depend according to surrounding environmental variables accounted for via NSS 778. Database lookup conditions 3550 (Entry Stage Affinity of Sector M2V—Descending order, quantity limit of X and Exit Stage Affinity of Sector KL4—Descending order, quantity limit of X).

FIG. 305 and FIG. 306 show Route Segment Bridging Logic (RSBL) 3560. Execution processing with two connecting sectors at a time 3564 (e.g. A Route Segment from Sector M2V and a Route Segment from Sector J21 are processed together). Execution Flag 3492 indicates do not reference optimized sector routes.

FIG. 307 to FIG. 309 show Route Direction Orientation Designation (RDOD) 3582 which receives input from Hop Ledger 3282. Edge Node Detection (END) 3672 elects nodes to become Edge Nodes to act as a reference point within Sector Routing of the BCHAIN Protocol 794.

FIG. 310 shows Edge Node Barrier 3576 (label number not shown on FIG. 310) with Declared Edge Node Output 3536, Intra-Sector Route Segment (Intra-SRS) 3452. Crosses X (not labelled in FIG. 310) is where Edge Node Barrier Intersection Defines Orientation. FIG. 311 to FIG. 316 show Barrier Intersect Monitoring (BIM) 3610. Sector Edge Makeup Survey (SEMS) 3660 measures the exposure an Edge Node has to various surrounding sectors.

FIG. 317 shows Edge Node Detection (END) 3672 starting from Sector Intersect Area 3592 all the way through to Declared Edge Node Output 3596.

FIG. 318 shows Edge Node Detection Stage 1: Populate Detector Bubbles 3680 where the Detector Bubble Formation (DBF) 3740 module selects random nodes within the Sector Intersect Area to become seeds for expanding bubbles, which spread uniformly to surrounding nodes.

FIG. 319 shows Edge Node Detection Stage 2: Detector Bubble Saturation 3690 is where eventually the Bubbles will no longer have room to expand, or more technically they will no longer be any available nodes to claim towards a bubble's jurisdiction while the bubble maintains a uniform surface area expansion amongst it's circumference.

FIG. 320 shows Edge Node Detection Stage 3: Majority Neighbor Elimination 3700 is the top X bubbles are deleted according to surface area via the Bubble Neighbor Elimination (BNE) 3770 module. X is defined according to Static Hardcoded Policy (SHP) 488. This stage leads to only the smallest bubbles remaining, which will become a leading factor in finding the accurate location of the Edge Nodes.

FIG. 321 shows Edge Node Detection Stage 4: Direction Calibration 3710 is the orientation of the ideal Intra-Sector route direction is calculated via reference to the algorithmic Boomerang Sequence as referenced in the Travel Direction Calibration (TDC) 3800 module. This allows for stray small bubbles to be removed which are distracting the algorithm from finding the accurate location of the Edge Nodes.

FIG. 322 shows Edge Node Detection Stage 5: Section Width Dissection 3720 is where the Sector Width coordinates are calculated by the Sector Width Dissection (SWD) 3790 module. The Sector Width is defined as the longest possible distance between any of the remaining bubbles.

FIG. 323 shows Edge Node Detection Stage 6: Edge Node Discovery 3730 is where Sector Width Dissection (SWD) 3790 was performed after Travel Direction Calibration (TDC) 3800 removed all small sized bubbles that could have acted as false positive Edge Nodes. Therefore Edge Node Detection (END) 3672 can rely on the expectation that the two nodes that connect the Sector Width are correct and accurate Edge Nodes.

FIG. 324 shows Detector Bubble Formation (DBF) 3740 logic where Stage 3748 it Applies expansion strategy to each uniquely identifiable bubble to surrounding nodes which utilizes the following expansion strategy where: 1. Bubbles can expand contingent on prospective nodes being able to correlate each other for inclusion. This leads to a bubble growing in as circular of a pattern as allowable by the node makeup. Therefore a bubble does not act like a liquid which fills gaps independent of form, yet requires uniform expansion; 2. Bubble expansion maturation peaks as it's boundary reaches the boundaries of other competing bubbles. One part of a bubble's edge reaching an obstacle causes the entire bubble to cease expansion; and 3. A bubble can only expand by including nodes in it's jurisdiction that have not already been assigned by other bubbles, and belong within the Sector Intersect Area 3592.

FIG. 325 shows Detector Bubble Formation Stage 1: Plant Random Bubble Seeds 3758 and Detector Bubble Formation Stage 2: Bubble Maturation 3766. Detector Bubble Formation Stage 1: Plant Random Bubble Seeds 3758 nodes are randomly selected to become Bubble Seeds. By adopting the Detector Bubble Formation (DBF) 3740 Expansion Strategy, surrounding nodes are claimed to belong to the jurisdiction of a bubble. Once a node is claimed by one bubble, it can never be claimed by another bubble within the emulation session. Detector Bubbles as Node Collections 3762 where Detector Bubbles are clusters of nodes that have been claimed by it's relevant Bubble jurisdiction. Such jurisdiction claims occur within the emulation session of a single node, and is not an actual competition between nodes in the field. Detector Bubble Formation Stage 2: Bubble Maturation 3766 because the expansion strategy only permits Bubbles to grow uniformly amongst their circumference, a Bubble is prohibited from growing in all directions if it's walls reaches the walls of another bubble at only a single angle. Bubbles Stop Growing 3768 a Bubble's maturation in scope ceases when 1. It cannot find surrounding nodes that do not yet belong to a bubble; and 2. It cannot find surrounding nodes that belong to the correct sector overlap scope.

FIG. 326 shows Bubble Neighbor Elimination (BNE) 3770 sequence where it receives Bubble Map 3756 and provides Output as Reduced Bubble Map 3780 to Reduced Bubble Map 3782.

FIG. 327 shows Sector Width Dissection (SWD) 3790 receiving Reduced Bubble Map 3782 and providing Declared Edge Node Output 3596.

FIG. 328 shows Travel Direction Calibration (TDC) 3800 sequence from receiving Hop Ledgers 3282 to providing Output map containing all the nodes that were marked by a Boomerang Sequence 3810 to Boomerang Sequence Map 3812.

FIG. 329 shows the Boomerang Sequence Algorithm (BSA) 3820 logic from A node is selected (as input) to imitate the Boomerang Sequence 3822 to End the Boomerang Sequence 3820 where all nodes that were selected and are not a part of either of the two Hop Ledgers 3282 are marked as belonging to this boomerang sequence.

FIG. 330 shows the Boomerang Sequence 3832 where the perceiving node will emulate nodes, that do not belong to an Intra-Sector Segment, as succumbing to the jurisdiction of a randomly generated path named a Boomerang Sequence. Such Sequences always originate from any node that belongs to an Intra-Sector Route from within the relevant Sector Edges. Such sequences end either when they collide with a node that belongs to any Intra-Sector Route Segment, or once they've expired due to being too long 3836. Sector Edges 3834 are edges of the sectors which act as boundaries to cage the origination point of a boomerang sequence within the Sector Intersect Area 3592. BCHAIN Nodes 786 are shown within the Sector Edges 3834.

FIG. 331 and FIG. 332 show Physical Data Migration Layer (PDML) sequence 3850. Friction Link Generator (FLG) 3862 references the categorization of nodes in different Velocity Brackets to generate inter-node links which represent a differential in node escape velocity. Friction Zone Estimation (FZE) 3868 references the pre-made Friction Links to define a geographic boundary which is virtually known to the node as a logistical tool to accomplish physical data migration. Physical Data Migration Usage (PDMU) 3851 grants data in motion the ability to make functional use of physical migration pathways that have been constructed by Migration Path Construction (MPC) 3880. Migration Path Detection (MPD) 3875 (incorrectly labeled as 3874 on FIG. 332). Migration Path Construction (MPC) 3880 references incremental path traversal data from the Metachain 834 to construct new physical migration paths that are in demand.

FIG. 333 shows Friction Zone Define Migration Paths 3893 in which Friction Zones are strategic areas which are virtually defined within the Physical Data Migration Layer (PDML) 3850 algorithm. They are constructed by measuring the interaction space between two clusters of nodes that operate within different Node Escape Velocity Brackets. These friction zones become essential to orchestrating a successful migration sequence for a unit of data. They are used to facilitate the loading onto physically moving nodes, the logistics to remain on the correct nodes which are on an expected physical trajectory, and the landing sequence to correctly disengage from a migration node to a stationary node. Friction Links 3896 define Friction Zones 3893 where friction links are an abstract calculation within the algorithm that builds a geographic boundary which equates to a Friction Zone. Friction Links are bonds between two nodes each of which belong to different velocity clusters. It includes Velocity Cluster 3897, Friction Zones 3893, BCHAIN Node (BN) 786 and Migration Path 3894.

FIG. 334 and FIG. 335 show Hop Pathway Clash Optimization (HPCO) 3900 sequence. CCFs 2318 to Retain in Clash Cache 1018 is the percentage amount of the local node's storage that should be allocated to retaining CCFs 2318 that do not exist in PNCC 1218. Hence if a CCR and it's correspondingly stored CCF 2318 cross each other's path prematurely, the content request can be duly fulfilled. There is a ‘sweet spot’ optimized amount of CCFs 2318 to retain to make efficient use of unintentionally chaotic clashes of information.

FIG. 336 shows Abandoned Packet Journey 2318 which are all the nodes that were originally expected to participate in the journey of the content fulfillment are now relieved of their burden and are able to invest their resources and time into alternate jobs. Hence the supply/demand economy of the BCHAIN network at large has been affected by the Clash Event. Original Appchain Cache Location (which is the BN 786 shown on top right corner) is the original Cache Node which needed to fulfill the request of the CCR 2308 now does not need to serve the original request due to the Clash Event. Hence the supply/demand mechanics of the surrounding area are altered as more resources have been freed up to facilitate other requests. Hop Pathway Clash Event 2308 is a CCR 2308 that was originally moving towards a Cache Node (in Sector L22—top right sector) has now incidentally crossed paths with a node that has a copy of the content it is trying to retrieve. Hence this incidental clash event can be used to optimized routing efficiency in the BCHAIN network.

FIG. 337 shows Pathway Error Rectification (PER) 3940 sequence. Network Strength and Congruence Enhancement (NSCE) tracks node interaction behavior to detect areas of network isolation and redundancy weakness. Hence node routing and bridging prioritization can be made in a more efficient manner.

FIG. 338 shows Node Traffic Bottleneck at the two BN 786 within the Chaotic Environment (inner rectangle). The Chaotic Environment is defined by a bottleneck in throughput bandwidth due to a low density of nodes in the area. Hence the primary transfer of data is occurring between two key nodes which are riding the non-chaotic environments together. The same two BN 786 within the Chaotic Environment have a bidirectional arrow which indicates Metachain Synchronicity Prioritization—given the limited bandwidth between the two bottleneck nodes, information is prioritized according to Customchain type in a similar protocol to Voice over IP (VoIP). Metachain packets are given the highest priority to maintain integrity and efficiency of the BCHAIN network at large. Secondarily Appchain/Microchain packets are prioritized according to the payment fee provided by the Economic Authorization Token (EAT) 994 of that data transfer. Undeliverable CCR or CCF Packet (dotted rectangle within the Chaotic Environment) is a failed delivery attempt of a CCR 2308 or CCF 2318 leads to the invocation of the Pathway Error Rectification (PER) 3940 module. This enables Chaotic Environments to be tracked and marked in the Metachain 834 via Network Strength & Congruence Enhancement (NSCE) 2442 in the first place. Chaotic Environment Denotes Weakness With Inter-node Communications—Chaotic Environment Tracking from the Metachain 834 highlights a geographic area, relative to node location, which has a low density of active node availability. Hence the BCHAIN protocol 794 is able to preemptively avoid the routing inefficiency of data traversing a Chaotic Environment.

FIG. 339 shows the conclusion of Pathway Error Rectification (PER) 3940 sequence by submitting marked nodes to NCSE for consensus driven Chaotic Environment Tracking modification to the Metachain 3948.

FIG. 340 to FIG. 343 shows logic for Sector Pricing Mechanism (SPM) 3962 and Work Settlement Mechanism (WSM) 3980. Node Work Payout (NWP) 4000 module interacts with the Metachain 834 to submit payment of work to the nodes that contributed in the transferring of the CCR 2308 or CCF 2318. Signed Economic Output Verification (SEOV) 4016 verifies that the node which is paying for the information transfer has authorized the scope of the work (abuse prevention). Optionally Trail Variable Suite (TVS) 2320 can also provide input to Diagnostic History Submission (DHS) module (not shown in FIG. 340) for those who have a vested interest in refining and debugging the code and execution of BCHAIN (i.e. core developers) are able to install debugging enabled nodes within significant sectors which aggregate diagnostic information to further development of the BCHAIN Protocol. Nodes scan for self-declared and proven diagnostic nodes within a sector. Thereafter any CCR 2308 or CCF 2318 that passes through such a sector will have it's Trail Variable Suite (TVS) 2320 collect and submit diagnostic information to known diagnostic nodes.

FIG. 344 shows Node Work Payout (NWP) 4000 sequence. Node Work Payout (NWP) 4000 module interacts with the Metachain 834 to submit payment of work to the nodes that contributed in the transferring of the CCR 2308 or CCF 2318. The sequence starts with Current sectors' percentile of total network throughput 4004 providing input to Calculate payout per hop/node (each node performed one hop) with formula 4006 (see FIG. 344) which sends the information to Payout Per 4008 (i.e., 5 BCHAIN Work Units 1216) and ends at Direct Economy Interface 4012.

FIG. 345 to FIG. 346 shows Signed Economic Output Verification (SEOV) 4016 sequence. Signed Economic Output Verification (SEOV) 4016 verifies that the node which is paying for the information transfer has authorized the scope of the work (abuse prevention). Hop Path Divergence Calculation (HPDC) 4032 calculates the percentage in difference between the original PBHP as perceived by the sender and the actual PBHP 2322 that is being undertaken by the CCR 2308 or CCF 2318.

FIG. 347 to FIG. 349 show Hop Ledger Signing (HLS) 4040 sequence. HLS 4040 Starts with the Hop Ledger 3282 which contains Nodes 4042 and Node 4046 and Ends at Hop Ledger 3282. Terminate this module and abandon this Hop Ledger and hence block the outgoing CCR 2308 or CCF 2318 from proceeding 4974 is a double payment abuse prevention where a duplicate node representation indicates attempted payment abuse since the BCHAIN protocol 794 does not allow for the same node to participate in the hop path of a CCR 2308 or CCF 2318 more than once. This prohibition also prevents a CCR 2308 or CCF 2318 getting stuck in an infinite loop pathway in certain chaotic environments.

FIG. 350 to FIG. 353 show NSS Variable Pooling (NVP) 4140 sequence. In NVP 4140 nodes from within the same sectors announce their perception of the Node Statistical Survey (NSS) 778 Variables to each other to build consensus on the sector's characteristics. Therefore the local and remote NSS 778 variables are pooled together to create a composite average known as NVCI 4108. This composite is used to maintain consensus on the scope and definition of this sector, and hence where it's boundaries lie.

FIG. 351 continues the sequence from FIG. 350 where Strategy Deployment 916 determines NSS Variable Pooling Interval 1026 on how often should nodes announce to each other (within sectors that they share an overlap with) the NSS 778 variables they perceive. Hence a sector will build consensus about its own NSS 778 characteristics. If this interval is smaller, there will be tighter integration and more synchronicity, yet more resources depleted (Vice versa applies). NSS Remote Variables 4158 is where variables from other nodes are temporarily stored.

FIG. 352 continues from FIG. 351. Determine performance characteristics of the current sectors (i.e., hops per second, megabytes per second, etc.) 4160 for Performance Factor A 4112 and Performance Factor B 4114 within 4110 are analyzed at 4162. Static Hardcoded Policy (SHP) 488 provides criteria that is hardcoded into the BCHAIN Protocol 794. Such criteria is static as opposed to the usual dynamic strategy based criteria because these criteria are used to define strategy itself. Hence if the mechanism used to produce strategies itself relied on strategies, the system is expected to eventually loop itself into an extreme state which has limited and/or abnormal functionality and effectiveness.

FIG. 353 continues from FIG. 352 and shows the NVP 4140 executing the routine on an interval upon retrieving local NSS Variables 4142. NSS Variables Composite Average (NVCI) 4108 shows variables Node Escape Index 886, Node Saturation Index 888, Node Consistency Index 890, Node and Overlap Index 892.

FIG. 354 to FIG. 356 show the logic for Jurisdictionally Implied CCF Submission (JICS) 4194 sequence and Jurisdictionally Accepted CCF Reception (JACR) 4208.

FIG. 354 shows Generic System Event Triggering (GSET) 4188 which is an automated routine that invokes obligations of other nodes according to their jurisdiction category (Start No.1) within Category Invocation 4190 which provides input to Create cryptographic proof of origination by using Node Unique Identification 4196 within Jurisdictionally Implied CCF Submission (JICS) 4134 in which CCFs 2318 are sent to a node without an accompanying CCR 2308 due to that node's jurisdictionally implied responsibility of receiving such a CCF 2318. Category Invocation 4190 also gets input from Hardcoded Category Types 4170 which include Category A: New Content Submission to Miners 4172, Category B: NSS Variable Pooling & Sector Route Segment Sharing 4176, Category C: Appchain authenticated live streaming session 4180, Category D: Nodes within vicinity of Diagnostic Nodes 4184. Embedded within each of the categories is its specific information: Characteristic Criteria: Category A 4174, Characteristic Criteria: Category B 4178, Characteristic Criteria: Category C 4182, and Characteristic Criteria: Category D 4186. Category Recognition 4192 Check if the content matches the characteristic criteria of this category 4207 (label missing on FIG. 354 within the Jurisdictionally Accepted CCF Reception (JACR) 4208.

FIG. 355 continues the logic from FIG. 354 with the inner processes of JICS 4134. Content Upload 4202 occurs through Generic Content Upload Interface (GCUI) 4206 which is an input endpoint for content to be uploaded via Implied CCF Submission (i.e., audio packets for a live phone call). New Content Announcement (NCA) 2544 (is the End No.1 for Start No.1).

FIG. 356 shows the logic for JACR 4208 along where Content Claim Rendering (CCR) 3300 (is both Start No. 2 and End No. 2) and UBEC Platform Interface 728 (is End No. 3). FIG. 357 and FIG. 358 shows UBEC Live Calling Participants A and B making a call with details onCall Initiation Part1 4226 and Call Initiation Part 2 4240.

FIG. 357 Call Initiation Part1 4226 is similar to the dial tone on legacy Public Switched Telephone Network (PSTN) systems. Live Calling Participant A 4224 (connected to BN 786 with Voice Broadcast 4222 and Voice Reception 4220) initiates a phone call proposal (which includes an EAT 994) by issuing CCR 2308 to Participant B 4228. EAT 994 provides Flexible Payment Options (Men involving a live phone call, Participant A can elect to fully pay for the realtime information transfer session, to split the bill with Participant B, or to elect Participant B to pay for it fully. Participant B has the opportunity to reject or accept the call based on the proposed payment option). Live Calling Participant B 4234 (connected to BN 786 with Voice Broadcast 4238 and Voice Reception 4236) accepts the call with (phone call acceptance on behalf of Participant B is represented with a CCF 2318) 4320. Participant A verifies that Participant B's acceptance of the phone call 4232.

FIG. 358 continues from FIG. 357 where Nested Appchain that is running exclusively for Participants A and B 4246 within UBEC Live Calling Appchain 4244 utilizes Appchain Livestream Interaction Procedure (ALIP) 4242 module which serves an endpoint to connect the smart contract programming of an Appchain 836 with the livestream session. Hence an Appchain 836 can initiate, pause, or destroy a livestream session based on automated procedures and/or manual input from the user. UBEC Live Calling Appchain 4244 as an Example is a nested Appchain 836 structure can provide the information transfer abilities to manage and execute the live phone call. This includes authentication of the users, payment logistics, initiation policies such as waiting time, voice mail options, etc. Call Initiation Part 2 4240 shows Live Calling Participant A 4224 Submit the cryptographic phone call proposal details to the nested Appchain 4248 which verifies Has the phone call proposal been mined by an appchain miner? 4250 upon receiving an affirmative confirmation YES 98 it proceeds to Execute ALIP on both Participants A and B 4254. In case 4254 receives a NO 96 it Waits for a small period of time 4252.

FIGS. 359-365 show the structure of the Custom Processor designed from the UBEC/BCHAIN Microchip Architecture (UBMA) 4260 (also referred to as BCHAIN Optimized Microchip or BOM). It demonstrates a unique hardware security design for the protection of private seed keys. Private seed keys for the cryptography are guarded by the hardware so that the potential of a leaked or hacked seed key (which can potentially manipulate funds) is completely removed. Special channels to Legislated UBEC Independent Governing Intelligence (LUIGI) 116 within the UBEC platform 100 are established. The UBMA 4260 Processor is optimized to execute instructions pertaining to modules (as Appchains 836) that makeup the BCHAIN Protocol 794. The hardware design

On FIG. 359 Voltage Regulators A 4272 and B 4274 control the voltage input which leads to two separate subsections of the UBMA 4260 Processor: Subsection 4273 and Subsection 4275. Therefore two separate voltages can be adjusted in parallel. Because voltage has a linear relationship to clock frequency; the UBMA 4260 Processor can dynamically overclock one part of the chip whilst under clocking the other (and vice versa). This leads to dynamic prioritization of resources according to signals received from the BCHAIN Protocol 794. Built into the Processor are three wireless chips; the Wireless WiFi Chip 4266, the Wireless Bluetooth Chip 4268 and the High Gain Long Range Radio 4270. The Wireless WiFi Chip 4266 can be used for medium range communication between BCHAIN Nodes 786 with the highest throughput capacity. The WiFi Chip 4266 can also be used to connect to legacy WiFi hotspots which can grant access to the BCHAIN Network 110 via the Legacy Network Bridging Mechanism (LNBM) 2410. The Wireless Bluetooth Chip 4268 can be used for short range communication between BCHAIN Nodes 786 with a medium amount of throughput capacity. The Bluetooth Chip 4268 can be used to communicate with micro-sized IoT 102 Devices that operate as BCHAIN Nodes 786 but can only afford to operate and power a low-powered wireless technology such as Bluetooth. The High Gain Long Range Radio 4270 allows long distance communication between BCHAIN Nodes 786 with the smallest amount of throughput capacity. Radio 4270 operates under similar mechanics as AM radio. For BCHAIN Nodes 786 to be able to communicate with each other via Radio 4270 there are several meet up frequencies that each Node 786 occasionally broadcasts it's Identity, Hash Announcement and Personal Frequency to. Thereafter for two Nodes 786 to establish a peer-to-peer communication channel, they can meet at each others Personal Frequencies and exchange information. Each of the Wireless Technologies 4266, 4268, 4270 is equipped with Advanced Beamforming Direction Gain Technology 4262. This means that each of the technologies 4266, 4268, 4270 is able to concentrate the power through their antennae in a specific direction to maximize throughput with a specific Target Node 786 whilst minimizing power usage to areas that have no Intended Target Nodes 786. This increases overall efficiency and throughput between BCHAIN Nodes 786 that operate with the UBMA 4260 Processor. Therefore overall efficiency and throughput in the BCHAIN Network 110 is increased via adoption of the UBMA 4260 Processor. The Wireless Chips 4266, 4268, 4270 all operate on different frequencies to avoid collision and interference, and are diversified by short, medium and long range communication. The BCHAIN Protocol 794 prioritizes the information that should be transferred in situations of scarcity. For example, if only a weak peer-to-peer connection via the Radio 4270 is available, the Protocol 794 will prioritize synchronization of the Metachain 834 since it is the most important and logically prior information any Node 786 can retain. L2 Cache A 4276 and B 4278 are extremely fast units of non-persistent storage, each one being exclusively accessible by it's respective Subsection 4273, 4275. L3 Cache 4280 is similar to L2 Cache 4276, 4278 except that is larger in size, slower in speed, and available for access to the entire UBMA 4260 Processor. I/O Management 4262 recognizes Execution Segments 551 and General Processing Instructions and hence assigns them to the correct Microchip and returns the data to the rest of the Node 786 Hardware (i.e. persistent storage device of a Node 786).

FIG. 360 shows the structure of Subsection A 4273 which is controlled by Voltage Regulator A 4273. This Subsection 4273 is composed of Microchips that are specifically designed for efficiently processing the instructions required by the core components of the BCHAIN Protocol 794. Therefore the BCHAIN Protocol 794 operates faster and with less energy consumption on an UBMA 4260 Processor in comparison to a standard Central Processing Unit (CPU). Data Integrity Management as a Microchip 4282 is able to efficiently execute all of the routines that exist in Data Integrity Management (DIM) 1204. Therefore causing there to be better Data management/handling and rescuing of Data in Danger within the BCHAIN Network 110. Appchain Logistics as a Microchip 4284 is able to process retention and execution of Appchains 836 and Microchains 838 within the BCHAIN Network 110. LIZARD 120 is one of the most crucial, central and depended upon Appchains 836 within the UBEC Platform 100. LIZARD 120 does not rely on a database for operation and instead judges and estimates measures of risk and compliance in the moment due to it's complex a-priori intelligence (no prior reference). This allows the most static of elements and submodules of LIZARD 120 to be installed as Hardware Routines within LIZARD as a Microchip 4286. A future potential revision of the UBMA 4260 Processor is able to change its own microprocessor assembly dynamically via dynamic conductive structures. This would allow the entire LIZARD 120 Appchain 836 to operate as a Microchip 4286 including the Dynamic Shell (DS) of LIZARD 120. Routing Logic as a Microchip 4288 increases energy efficiency and lowers latency for Routing Logic (RL) 774 and it's submodules to operate. Thereby increasing the overall strength and efficacy of the BCHAIN Network 110. LOM 132 is one of the most crucial, central and depended upon of Appchains 836 within the UBEC Platform 100. Therefore the most repeatedly used of it's submodules, such as Assertion Construction (AC) 622 and Hierarchical Mapping (HM) 624, are made optimized in LOM Core Logic as a Microchip 4290. Therefore it is faster and takes less energy to execute LOM's 132 submodules (as Appchains 836) such as AC 622 and HM 624 at the Microchip 4290 in comparison to the Central Processing Unit (CPU) 4294. Therefore the entire Modular Manifestation of Execution Stream 616 of LOM 132 is made efficient to execute. Creativity Module as a Microchip 4292 optimizes the execution of the Creativity Module 112 within the UBEC Platform 100. This leads to a large increase in computational efficiency across the UBEC Platform 100 and BCHAIN Network 110 due to many Appchains 836 depending on Creativity 112 such as I2GE 122, CTMP 124, MPG 114, SPSI 130 etc. Only the Microchips 4282, 4284, 4286, 4288, 4290, 4292 of the Subsection 4273 have access to L2 Cache A 4276 and have their voltage and hence clock frequency governed by Voltage Regulator A 4273.

FIG. 361 shows Subsection 4275 of the UBMA 4260 Processor which houses generic Microchips 4292, 4294, 4296, 4300 that facilitate more generic tasks that need completion within the BCHAIN Protocol 794 in comparison to the Subsection A 4273 counterpart. The Central Processing Unit (CPU) 4294 is the default section of computation for a BCHAIN Node 786 with the UBMA 4260 Processor installed; unless a specialized instruction which can take benefit from another Microchip is found by I/O Management 4262. The Graphics Processing Unit (GPU) 4296 is mostly used for rendering Appchain 836 content in the UBEC Front-End User Interface 1148. The Cryptographic Processing Unit (CGPU) 4292 executes the functions that operate within Cryptography Core (CC) 768, which are invoked throughout the entire BCHAIN Protocol 794. The Secure Hardware Certificate Generating Unit (SHCG) 4300 securely retains the Security Sensitive Unique Private Key 4314 that is used to manipulate Node's 786 funds within the Watt Economy 862 of the Metachain 834. Therefore a Node Generated Public Address 4302 can be efficiently and quickly generated by SHCG 4300 without liability and risk of the Security Sensitive Unique Private Key 4314 becoming exposed. By forcefully coupling Watt Units on the Watt Economy 862 with the physical Hardware of a Node 786 via the UBMA 4260 Processor, management and manipulation of Watt Units becomes more predictable and safe within the UBEC Platform 100 and BCHAIN Network 110. The SHCGU 4300 Microchip also contains a hardcoded Node Unique Identification 4304 string that was randomly generated at the time of the manufacturing of the UBMA 4260 Processor. This Unique Identification 4304 is permanently coupled with the UBMA 4260 Processor which leads to confidence in Node Identification Tracking, primarily via the Metachain 834, within the BCHAIN Network 110. Only the Microchips 4292, 4294, 4296, 4300 of the Subsection 4275 have access to L2 Cache B 4278 and have their voltage and hence clock frequency governed by Voltage Regulator B 4275.

FIG. 362 shows additional details concerning the Secure Hardware Certificate Generating Unit (SHCGU) 4300. In this diagram, the SHCGU 4300 is in an UBMA 4260 Processor which is housed in a Node Belonging to the Associated Nodes List of the FRM Session 4306. The Permanent Identity Association with Hardware (PIAH) 4308 is a Subsection of SHCGU 4300 which produces the Node Unique Identification 4304 that was defined at the time of manufacturing. With Hardware Locked Private Key (HLPK) 4310, the Security Sensitive Unique Private Key 4314 is permanently observed behind a Hardware Lock Layer 4312. The only exception for a copy of the Private Key 4314 intentionally leaving the Hardware Lock Layer 4312 is via the Exclusive Backdoor Channel 4316 for submission to LUIGI 116. Public Address Generation (PAG) 4318 is the Subsection that generates a Public Address 4302 that is derived from the Private Key 4314 without transferring any instance of the Private Key 4314 outside of the Hardware Lock Layer 4312. According to Stage 4322; the Private Key Release Logic (PKRL) 4324 manages the release of the Private Key 4314 via the Exclusive Backdoor Channel 4316 upon verification of the Proof of Authority 402 and the Encryption Channel 4326 used. Stage 4322 is therefore invoked when LUIGI 116 provides Proof of Authority 402 to the HLPK 4310 Subsection of the SHCGU 4300 at Stage 4320.

FIG. 363 shows interaction between the SHCGU 4300, the BCHAIN Hosted Encrypted Channel 4326, and LUIGI 116. It is part of the LUIGI's 116 Official responsibility within the UBEC Platform 100 and BCHAIN Network 110 to keep backup versions of the Security Sensitive Unique Private Keys 4314 that control Watt Units on the Watt Economy 862 of the Metachain 834. This way if the Node 786 is stolen, lost or compromised; the Watt Units can be restored to the correct UBEC User 106 via operation of LUIGI's 116 advanced artificially intelligent capabilities. LUIGI 116 submits Proof of Authority 402 to the Node 786 to compel it to securely disclose the Security Sensitive Unique Private Key 4314. LUIGI 116 retains the Private Copy of the Proof of Authority 402 within the LUIGI Secure Enclave (LSE) 380, and submits a generated public version of the Proof of Authority 402 to the Node 786. Because it is programmed in the BCHAIN Protocol 794 for a Node 786 to comply with the Private Key 4314 secure disclosure request by LUIGI 116, every Legitimate Node 786 will comply. If the Node 786 fails to comply with an authorized request by LUIGI 116 with Proof of Authority 402; this indicates that the Node is Rogue and therefore can be easily banned from participation with the BCHAIN Network 116 by LUIGI 116. Upon verification of the authenticity of the Proof of Authority 402 and the BCHAIN Hosted Encrypted Channel 4326, the Legitimate Node 786 complies and securely submits the Security Sensitive Unique Private Key 4314 via the Encrypted Channel 4326 to LUIGI 116. LUIGI 116 thereafter stores the Private Key 4314 in an Empty Slot 4330 within the Encryption Layer 4312 that is only decrypt-able via the Retention Decryption Key 394 which is stored in the LUIGI Secure Enclave (LSE) 380. Thus the Private Key 4314 Backup Sequence is complete. Upon invocation and completion of a successful Recovery Session with the Fund Recovery Mechanism (FRM) 398, the Fund Manipulation Mechanism (FMM) 400 uses the Retention Decryption Key 394 to decrypt the relevant Security Sensitive Unique Private Key 4314 which allows LUIGI 116 to move the Watt Units in question to a Node 786 that belongs and is controlled by the correct UBEC User 106 (who rightfully owns the Watt Units).

FIG. 364 shows more details concerning the Fund Recovery Mechanism (FRM) 398. The UBEC User 106 authenticates themselves via User Node Interaction (UNI) 470 which produces an Authenticated User Session 522. Stage 4352, which represents the initiation of the process to recover lost funds, is invoked by the UBEC User 106 via the UBEC Front-End 1148. Stage 4352 leads to Stage 4354 which unpacks the Associated Nodes List 518 from the Authenticated User Session 522. Stage 4354 leads to Stage 4353 which initiates a Fund Recovery Verification Session 4342 with the UBEC User 106 via the UBEC Front-End 1148. Therefore the Fund Recovery Verification (FRV) 4340 module manages the Fund Recovery Verification Session 4342. Such a Session 4342 is conducted with the UBEC User 106 via the UBEC Front-End 1148, and involves questioning and additional layers of verification to consider either Approving 4346 or Rejecting 4344 the claim to the funds. If the Fund Recovery Verification Session 4342 was Rejected 4344, then the FRM 398 module terminates execution at Stage 4348. If the Session 4342 was Approved 4346, then Stage 4350 is invoked which decrypts the Private Key 4314 and uses it to manipulate the relevant funds in a way that resolves the recovery claim. This usually entails transferring the funds from the inaccessible Node 786 to a Node 786 that belongs to the Approved 4346 UBEC User 106.

FIG. 365 shows more elements of interaction between the Fund Recovery Mechanism (FRM) 398 and LUIGI 116. FRM 398 is a submodule that belongs within the jurisdiction of LUIGI 116. Upon Stage 4350 occurring, the Retention Decryption Key 394 is accessed from the LUIGI Secure Enclave (LSE) 380. The Retention Decryption Key 394 is used to decrypt and access the Security Sensitive Unique Private Key 4314 which is used to manipulate funds from the Watt Economy 862 of the Metachain 834 via Fund Manipulation Mechanism (FMM) 400. Therefore LUIGI 116 has access to the entire UBEC/BCHAIN Economy stored in the Watt Economy 862 due to it's duplicate copies of the Private Keys 4314 in the Encrypted Retention of Private Keys 4328. With a standard human programmed system, this would lead to an extremely large liability problem. This is due to the consideration that the programmers would theoretically have access to vast sums of wealth, and could potentially steal the funds by instructing LUIGI 116 to hand over the Retention Decryption Key 394, or for FMM 400 to manipulate the Funds in Rogue manner according to the programmer's instructions. LUIGI 116 is programmed once and the first time directly by humans. Once the UBEC Platform 100 and BCHAIN Network 110 are live and operational for the first time, all cryptographic access to modify LUIGI's 116 codebase is exclusively retained by Self Programming Self Innovation (SPSI) 130. SPSI 130 is an Appchain 836 that uses LIZARD 120 technology to program other Appchains 836 within the UBEC Platform 100. Such programming by SPSI 130 includes refining, bug/error fixing, scheduled maintenance, Diagnostic Log Unit 1182 analysis, new feature innovation etc. SPSI 130 is able to program itself, yet receives elements of Programming Guidance from SPSI Indirect Development (SID) 1190. Approved UBEC Users 106 that have proven programming/engineering/architectural skills are permitted by LUIGI 116 to participate in developing programming guidelines and Theory of Code as SID 1190. This leads to human induced improvements to SPSI 130 capabilities without ever given any human direct access. This is primarily done since direct programming access to SPSI 130 implies direct programming access to LUIGI 116, which would imply direct programming access to all the wealth stored in the Watt Economy 862 of the Metachain 834.

FIG. 366 shows details of Deployment Patch Assembly (DPA) 6260 module, details of Logistics Layer 582 and their interaction with Customchain Ecosystem Builder (CEB) 584. DPA 6260 consists of Principled Modification Actuation (PMA) 8620, Diagnostic Log Unit Analysis (DLUA) 8048, Automated Appchain Refinement (A2R) 8040, Innate Error Correction (IEC) 8050, Appchain Security Hardening (ASH) 8044, and Appchain Regulatory Compliance (ARC) 806 and it produces the Appchain Correction Patch 6270. CEB 584 receives the Appchain Correction Patch 6270 and performs the Appchain Swap Mechanism (ASM) in order to produce the Target Appchain 6060.

FIG. 367 shows the process for Correction Patch Block Addition (CPBA) 6062 where Appchain Correction Patch 6270 is received from Deployment Patch Assembly (DPA) 6260 module at Stage 6064 Appchain Correction Patch is applied as a new block to the Appchain 596 with Execution Segments 551 and 553 to Appchain 596.

FIG. 368 to FIG. 371 show Appchain Swap Mechanism (ASM) 6066 sequence. At Stage 6068 ASM 6066 Receives all of the blocks that makeup the Target Appchain 6060 and executes the various stages of ASM processes until New Content Announcement (NCA) 2544.

FIG. 372 to FIG. 373 show Logistics Layer Interpretation (L2I) 6144 sequence which receives input from Logistics Manager Interface (LMI) 580 and New Appchain Development (NAD) 8052 and provides output to Deployment Patch Assembly (DPA) and Raw Application Manipulation (RAM) 6146.

FIG. 374 to FIG. 375 show LIZARD process for converting the Logistics Layer of the Target Appchain into Appchain at Stage 6136.

FIG. 376 shows Raw Appchain Manipulation (RAM) 6146 process from Logistics Layer 582 input.

FIG. 377 to FIG. 378 show the process for LIZARD converts the Executable Logic Elements of the Logistics Layer into Execution at Stage 6162.

FIG. 379 to FIG. 380 show the process for LIZARD converts the Static Data Elements of the Logistics Layer into Data at Stage 6158.

FIG. 381 continues the Raw Appchain Manipulation (RAM) 6146 process from Stage 6158 where LLIZARD converts the static Data Elements of the Logistics Layer into Data. FIG. 382 shows the sequence for Stage 6172 The Execution Stream is processed by ESR 6400 in MCE 6174.

FIG. 383 shows Stage 6190 where a preliminary instance of ESR finds the Potential Environmental Scope.

FIG. 383 to FIG. 385 show Stage 6210 LIZARD converting Initial Rendering State to Stage 6212 Initial Rendering Purpose.

FIG. 386 to FIG. 387 show Stage 6214 LIZARD converts the Final Rendering State to Stage 6216 Final Rendering Purpose.

FIG. 388 to FIG. 402 show details of Stage 6190 where A Preliminary instance of ESR finds the Potential Environmental Scope utilizing CTMP 124 and LOM 132.

FIG. 403 and FIG. 404 show the logic for Raw Appchain Manipulation (RAM) 6146 Dependency Request Fulfillment (DRF) 6176 from Data Segments 6160 to Marked Data Segments 6224. I2GE 122 provides direct input to DRF 6176 and LIZARD 120 provides input through Need Map Matching (NMM) C114 to DRF 6176.

FIG. 405 to FIG. 407 show the logic for LIZARD 120 at Stage 6242 where LIZARD converts the Execution Request or Data Request into Purpose.

FIG. 408 shows logic for Raw Appchain Manipulation (RAW) with Dependency Request Fulfillment (DRF) 6176.

FIG. 409 shows Deployment Patch Assembly (DPA) 6260 with Upgraded Execution Stream A0 6264 and Original Execution Stream A0 6266.

FIG. 410 shows Execution and Data Stream Management (EDSM) 6272 with Execution Stream Collection (ESC) 6700 and Upgraded Execution Stream A0 6264.

FIG. 411 to FIG. 412 show Data Stream Differential Logic (DSDL) 6274 with Upgraded Data Stream A0 6276 and Original Data Stream A0 6278.

FIG. 413 to FIG. 416 show Execution Stream Differential Logic (ESDL) 6300 which receives Upgraded Execution Stream A0 6260 at Stage 6302 to Initiate counter loop starting from Genesis Execution Segment and Original Execution Stream A0 6266 at Stage 6304 to Initiate counter loop starting from Genesis Execution Segment to initiate the EDSL 6300 process ends at Stage 6348 where it Submits modular output of the Patch Container as the Appchain Correction Patch via API 6288 to Appchain Correction Patch 6270. FIG. 417 to FIG. 418 shows Execution Stream Rendering (ESR) 6400. ESR 6400 receives input from ESC 6700 and DSS 6800 at General Execution of Streams 6402 and provides R2P 6404 while providing and receiving Recognition and Reference of Command Types 6406. Command Types 6408 are listed.

FIG. 418 shows Execution Stream A0 556 interaction with Main Execution Logic (MEL) 6428.

FIG. 419 and FIG. 420 show Command Types 6408 with Conditional Command Reference 6410 and Execution Sequence 6466.

FIG. 421 to FIG. 424 show Main Execution Logic (MEL) 6428 Execution 556 based on Command Types 6408.

FIG. 421 shows Main Execution Logic (MEL) 6428 Execution 556 based on Command Types 6408 with Inherit Rendering Results of Specified Appchain 6412 at Stage 6516 Inherit Command Defined.

FIG. 422 continues from FIG. 421 with Main Execution Logic (MEL) 6428 Execution 556 based on Command Types 6408 with Inherit Rendering Results of Specified Appchain 6412. Data Stream AI 6524 receives input from Data Stream Sorting (DSS) and provides output to MEL 6428.

FIG. 423 shows Main Execution Logic (MEL) 6428 Execution 556 based on Command Types 6408 with Continue Thread Execution in Parallel to Alternate Appchain 6408. FIG. 424 shows Main Execution Logic (MEL) 6428 Execution 556 based on Command Types 6408 with Transfer Thread Execution to Alternate Appchain 6414.

FIG. 425 shows Data Stream A0 6550 processing with Command Types 6408 and Read Data Segment 6416.

FIG. 426 shows Data Stream A0 6550 processing with Command Types 6408 and Session Delete Data Segment 6424.

FIG. 427 shows Data Stream A0 6550 processing with Command Types 6408 and Session Write Data Segment 6420.

FIG. 428 shows Data Stream A0 6550 processing with Command Types 6408 and Persistent Delete Data Segment 6426.

FIG. 429 shows Data Stream A0 6550 processing with Command Types 6408 and Persistent Write Data Segment 6422.

FIG. 430 shows New Content Announcement (NCA) 2544 processing based on Command Types 6408 and Persistent Delete Data Segment 6426 at Stage 6586 Submit a Null Segment to NCA which nullifies the Selected Data Segment From the Target Appchain. FIG. 431 shows Execution Stream Rendering (ESR) 6400 and Rendered Result Processing (R2P) 6404 processing. It includes General Execution of Streams 6600.

FIG. 432 to FIG. 436 show Execution Stream Collection (ESC) 6700 sequence with Target Appchain 6060 through its various Stages until Diagnostic Log Submission (DLS) 1160 (label missing on FIG. 436) and Execution 556.

FIG. 437 to FIG. 439 show Data Stream Sorting (DSS) 6800 process based on Target Appchain 6060 where it processes each block within the Target Appchain 6060 until all the blocks are processed at Stage 6816 it Assigns Data Reference Calls to their corresponding Data Segment.

FIG. 440 to FIG. 442 show Null Segment Adjustment (NSA) 6900 which is a module that seeks to make the updating of new information efficient. NSA 6900 at Stage 6906 Receives either a Collection of Execution Segments (from ESC 6700) or Data Segments (from DSS) and stores them in Input Segment Collection Retention (ISCR) 6908. FIG. 443 to FIG. 445 show Purpose to Purpose Symmetry Processing (P2SP) 7000 logic. P2SP 7000 process produces Symmetry Processing Result 7034 which corresponds to the two inputs it received. Input A 7002, Purpose Hierarchy Map 7006 and Input B 7004, Purpose Hierarchy Map 7008.

FIG. 446 and FIG. 447 show Purpose Realignment Processing (PRP) 7050 is used to produce a Purpose Hierarchy Map Unification (PHMU) 7066 based on the two inputs it received. Input A 7002, Purpose Hierarchy Map 7006 and Input B 7004, Purpose Hierarchy Map 7008.

FIG. 448 shows the overview interpretation of Symbiotic Recursive Intelligence Advancement (SRIA), which is a theory concerning Artificial Intelligence that is primarily manifested in the operation of Self Programming Self Innovation (SPSI) 130. The peak of Artificial Intelligence is a triad relationship between three different algorithms that enable each other to grow in Intelligence. LIZARD 120 can improve an algorithm's Source Code by understanding Code Purpose, including itself at Stage 5002. I²GE 122 can emulate generations of virtual program iterations, hence selecting the strongest program version. Therefore this emulation technology benefits all of the other modules that participate in the SRIA process. BCHAIN is a vast Network 110 of chaotically connected Nodes 786 that can run complex data-heavy programs (Appchains 836) in a decentralized manner. SPSI 130 maintains the same Appchains 836 that grant it it's functionality and capabilities. The layout of the feedback-loop based system ensures that gradual incremental progress in Artificial Intelligence cognitive and problem solving capabilities increase. Therefore SPSI 130 becomes the key element to the recursive intelligence growth system known as SRIA. I²GE 122 provides Virtual Emulation 5000 to LIZARD 120 and the BCHAIN Network 110/Protocol 794. Virtual Emulation 5000 is when I²GE 122 executes the code of the Target Appchain 836 in a virtual environment which is hosted by the BCHAIN Network 110. Therefore BCHAIN 110 acts as a Hosting Resource Provider 5010 for I²GE 122, LIZARD 120, LOM 132, CTMP 124, NC 1186 and I2CM 1188. The BCHAIN Network 110 hosting with these various systems with it's adaptation intelligence allows for them to be more liberal and intense in the execution of their intelligence algorithms, therefore causing better understanding of efficiency, productivity, and functionality to exist in the system which eventually returns to benefit the operation of the BCHAIN Network 110/Protocol 794. Log Aggregation 5012 occurs to enable human observers to monitor the growth progress of SRIA.

FIG. 449 shows the theory of SRIA in regards to discovery of a new System Status Quo 5026. The Status Quo 5026 generically represents the overall functionality, efficiency and design of a target system. LOM 132 is invoked by the Design Principle Invocation Prompt (DPIP) to produce System Design Principles 5016 at Stage 5014. Such Principles 5016 have been produced via gradual research progress performed by LOM 132 and further enabled by CKR and CTMP 124. Therefore any changes, additions, or deletions to Principles 5016 are reflected in the refinement of the Status Quo at Stage 5018. Such a Refinement 5018 is enabled by LIZARD 120 which converts the relevant data into purpose format which acts as the crucial intermediate stage for accurately performing system modifications. Thereafter LIZARD 120 uses it's programming abilities to perform experimental modifications to the Refined Status Quo at Stage 5020. Such modifications are made with a reasonable expectation of a positive outcome that increases functionality, efficiency, security and stability. However because of it's unknown and experimental status, the new Status Quo is virtualized and evolved by I²GE 122 at Stage 5022. Such a stabilization process also confirms the stability of the refinement modifications made by LIZARD 120 at Stage 5018. Therefore the New Status Quo is formed at Stage 5024 which has caused the targeted system to be upgraded in every conceivable manner. Therefore the intelligence cycle has reset and potential of the next cycle becoming available increases as the relevant Appchain Algorithms discover new information, functionality, and techniques. FIG. 450 shows the theory of SRIA in regards to Intelligence Pooling. CTMP 124 acts as the central location of intelligence retention, as it gradually usurps the intelligence of algorithms at Stages 5032. CTMP 1224 interprets all artificially based decisions made by such Appchain Algorithms such as LIZARD 120, LOM 132, and I²GE 122 and also receives their raw processing logs which act as Objective Facts concerning the decision being made. Therefore CTMP 124 criticizes an Appchain Algorithm's decision according to intelligence that has been previously usurped 5032 from various Appchain Algorithms. Therefore the aggregate intelligence of multiple Appchain Algorithms is recycled at Stage 5028. Any collected/pooled intelligence eventually benefits all of the Appchain Algorithms that interact with CTMP 124 at Stages 5030.

FIG. 451 shows the theory of SRIA in regards to Hardware, Framework, and Functionality feedback and influence. An ideal system design is produced at Abstract Target System Generator (ATSG) 5040 which therefore enumerates the expected User Functionalities 5042 that are required for the conceptual ideal system. Therefore Required User Functionality 5042 is related to and informs the definition of New User Functionality 5044. The Syntax of Functionality 5044 is inherited by Application Functionality 5046, which in turn becomes a layer of Operation Enablement 5054 for New User Functionality 5044. The abstract concept of Application Functionality 5046 enhancement is practically manifested in SPSI's 130 submodule New Appchain Development (NAD) 8052. SPSI 130 is the overall practical manifestation of the SRIA concept of different layers of logistics inheriting from and enabling one another. Therefore the core practice of logistical layer tension is the enhancement of Code Efficiency, Quality, Security and Stability 5048. Such a Process 5048 is practically undertaken by SPSI 130 via it's submodules Appchain Security Hardening (ASH) 8044, Innate Error Correction (IEC) 8050, Automated Appchain Refinement (A2R) 8040, Automated Appchain Maintenance (A2M) 8042, Appchain Regulatory Compliance (ARC) 8046 and Diagnostic Log Unit Analysis (DLUA) 8048. Enhanced Code Quality 5048 enables the Operation 5054 of Application Functionality 5046, which in turn Enables 5054 New User Functionality 5044. All of the aforementioned aspects of the software are Enabled 5054 by Framework Adaption 5050. Such Adaption 5050 represents the changes performed to the underlying Framework (i.e. Operating System, System Kernel etc.) which allows for User Space Applications 5046, 5044 to Operate 5054. Such Framework Adaption 5050 is practically performed by SPSI's 130 Enhanced Framework Development (EFD). Therefore Hardware Changes are performed according to the Framework 5050 syntax that is Inherited 5056, which in turn enables the Framework 5050 and it's User Space 5046, 5044 to Operate 5054. Hardware Changes 5052 can occur due to typical cycles in industry manufacturing trends, or via SPSI's 130 Enhanced Hardware Development (EHD) 8056. Therefore this entire stack of layers represents an overall functional system that attempts to become the Ideal System that servers Required User Functionality 5042 according to ATSG 5040.

FIG. 452 shows the theory of SRIA regarding intelligence ‘trickling’ 5060 from interaction of the UBEC User 106 (or Generic User 5068 for Legacy Operations) across multi-tiered cycles. The Long Term Cycle 5062 represents large scale Guiding Principles of SPSI Direction 5070. Therefore capabilities, methodologies, and tendencies of SPSI 130 are gradually informed at a slow and Long Term 5062 basic via Human 106, 5068 interaction of LOM 132 and SPSI Indirect Development (SID) 1190. LOM 132 acts as a rational director of SPSI's 130 functionality and operation makeup due to it's objective reasoning which is enabled by built-in modular invocation of CTMP 124. Therefore changes that occur via LOM 132 and SID 1190 in the Long Term Cycle 5062 eventually Affect and Inform 5060 the Medium Term Cycle 5064 which represents the practical sustained operation of SPSI 130. Therefore all of SPSI's 130 Submodules 8040, 8042, 8044, 8046, 8048, 8050, 8052, 8054, 8056 are gradually affected by the Guiding Principles of SPSI Direction 5070. In turn, the operation of SPSI 130 within the Medium Term Cycle 5064 leads to the general enhancement of Appchains that exist within the UBEC Platform 100/BCHAIN Network 110 as well as Appchains/Legacy Programs operating within Legacy Systems (via Appchain Emulation Layer (AEL) 8058). Therefore Short Term 5066 adaption cycles of intelligence are enhanced by SPSI 130, which allows for sophisticated adaptation strategies to by deployed in the Short Term 5066. Therefore the Strategy Deployment 916 Unit that performs a crucial task within the BCHAIN Protocol 794 is influenced by the operation of SPSI 130 and therefore the operation of LOM 132 and SID 1190. SPSI 130 specifically enhances BCHAIN Protocol 794 modules such as Dynamic Strategy Adaptation (DSA) 772 and Strategy Creation Module (SCM) 984 which in-turn produce instances of Strategy Deployment 916 Units upon triggers invoked by Sector Crossing Event Processing (SCEP) 3360. Such Units 916 perform adaptation intelligence within the Short Term Cycle 5066 within operation of the BCHAIN Network 110.

### Self Programming Self Innovation (SPSI)

FIG. 600 to FIG. 603 show an overview of the core functionality of the Self Programming Self Innovation (SPSI) 130 module. SPSI 130 is an Appchain 836 that uses LIZARD 120 technology to program other Appchains 836 within the UBEC Platform 100. Such programming by SPSI 130 includes refining, bug/error fixing, scheduled maintenance, Diagnostic Log Unit 1182 analysis, new feature innovation etc. SPSI 130 is able to program itself, yet receives elements of Programming Guidance from SPSI Indirect Development (SID) 1190. Approved UBEC Users 106 that have proven programming/engineering/architectural skills are permitted by LUIGI 116 to participate in developing programming guidelines and Theory of Code as SID 1190 (as an option). This leads to human induced improvements to SPSI 130 capabilities without ever given any human direct access. SPSI 130 is granted, according to the permanent BCHAIN Protocol 794 which acts as a rudimentary base layer law, exclusive access to manipulate the codebase of all of the major functions of the UBEC Platform 100. Significant examples are the UBEC Application itself 118, LUIGI 116, Creativity 112, I²GE 122, SPSI 130 itself (self programming), LOM 132 (which is a base technology that powers SPSI 130), LIZARD 120 (which is a base technology that powers SPSI 130), CTMP 124, NMC 114, MC 1186, and I²CM 1188. The aforementioned Appchain Modules that Compose SPSI 130 are also Maintained by SPSI 130. SPSI 130 maintains the same Appchains 836 that grant it it's functionality and capabilities. The layout of the feedback-loop based system ensures that gradual incremental progress in Artificial Intelligence cognitive and problem solving capabilities increase. SPSI 130 becomes the key element to the recursive intelligence growth system Symbiotic Recursive Intelligence Advancement (SRIA) shown in FIGS. 448-452 is the peak of Artificial Intelligence (AI) which is a triad relationship between three different algorithms that enable each other to grow in Intelligence (LIZARD 120, I²GE 122, and BCHAIN 110). LIZARD 120 (Continually Increasing Programming Intelligence) can improve an algorithm's source code by understanding code purpose, including itself. I²GE 122 (Continually Increasing Emulation Intelligence), can emulate generations of virtual program iterations, hence selecting the strongest program version. BCHAIN 110 (Continually Increasing Adaptation Intelligence) is a vast network of chaotically connected nodes that can run complex data-heavy programs in a decentralized manner. The key impetus behind SPSI 130 is to have a mechanism for creating automated beneficial knowledge or intelligence with wisdom in order to Enjoin Good and Forbid Evil (EGFE). SPSI 130 deals heavily with the concept of Purpose, shown as Purpose Hierarchy Maps. The concept of Purpose structure originates from LIZARD 120, it builds on the LIZARD 120 functionality and enhances it in order to achieve SPSI. Purpose structure is essentially the justification behind any kind of syntax. Imagine a syntactical definition such as Type X in State Y with Metrics Z. Purpose definitions focus on the justification aspect, such as: State should exist as Y because Type X is needed with Metrics Z at Stage L. Purpose can be well understood by referencing the Need Map Matching (NMM) C42 module, which again originates and operates under LIZARD 120 which is the primary manipulator of Purpose as per the Purpose Module C36. LIZARD 120 hence is the baseline for self programming, to which SPSI 130 uses to perform more elaborate tasks as a second layer. Therefore SPSI makes heavy references to LIZARD 120 and it's association to purpose format. Dedicated modules that operate within SPSI 130 such as Purpose to Purpose Symmetry Processing (P2SP) 7000 and Purpose Realignment Processing (PRP) 7050 are invoked to interpret and manipulate purpose formats. P2SP 7000 and PRP 7050 shown in FIGS. 443-447 are part of the BCHAIN Protocol 794.

FIG. 601 shows more details concerning the internal operation of SPSI 130. LOM 132 receives Diagnostic Log Unit 1182 from it's submodule (as an Appchain 836) Automated Research Mechanism (ARM) 134. ARM 134 receives the Log Units 1182 from Diagnostic Log Submission (DLS) 1160. Reception of Log Units 1182 leads to Stage 8000; where LOM 132 characterizes and understands routine malfunctions with Currently Existing Features and proposes Solutions 8002 for them. Such Currently Existing Features are features of the selected Appchain 836 that has been targeted for programming/refinement/innovation. Therefore Stage 8000 outputs Proposed Solutions to Existing Feature Malfunctions 8006. At Stage 8000 LOM 132 thoroughly inspects the selected Appchain 836 and estimates proposed new features which it expects will enhance the Appchain's 836 ability and efficiency in performing it's primary function. Therefore Stage 8000 outputs Proposed New Features 8004. At Stage 8008 the Proposed Features 8004 and Proposed Solutions 8006 are defined in purpose, and are transferred to LIZARD 120 to be programmed into functional codes via the Purpose and Syntax Modules.

FIG. 602 shows further details concerning the internal operation of SPSI 130 in continuation of FIG. 601. If possible, LIZARD 120 outputs Executable Code Sets 8010 at Stage 8012 which represent the ideas originally conceived of by LOM 132 at Stages 8000 and 8002. Thereafter at Stage 4376 the Executable Code Sets 8018 are transferred to I²GE 122 along with Successful Execution 8014 and Failed Execution Scenarios 8016 from LIZARD 120. Such Scenarios 8014, 8016 act as frames of reference for if execution of the relevant code Succeeded 8014 or Failed 8016. Thereafter at Stage 8020 I²GE evolves and tweaks (tweaking via Creativity 112) the software over multiple evolutionary pathways by using the CPU and storage resources made available by the BCHAIN Network 110. By referencing the Successful 8014 and Failed 8016 Execution Scenarios I²GE 122 is able to distinguish variations of the Code Sets 8010 that are ultimately stable and functional with those that are not. Thereafter at Stage 8022 LOM 132 verifies that the resultant software is in accordance with it's perception of stability and means of achieving functionality. Hence LOM 132 is verifying that the resultant software matches it's original Proposals 8004, and 8006.

FIG. 603 shows an alternate scenario to FIG. 601 where both LOM 132 and LIZARD 120 receive Diagnostic Log Unit 1182 from it's submodule (as an Appchain 836) ARM 134. ARM 134 receives the Log Units 1182 from Diagnostic Log Submission (DLS) 1160. LOM 132 characterizes and understands routine malfunctions with Currently Existing Features and proposes Solutions 8024 for them. LIZARD characterizes and understands technical errors/bugs/crashes and resorts to fixing them using the iteration module 8026.

FIG. 604 shows Official Appchains 836 interacting with each other within a Customchain Ecosystem 6032. SPSI 130 depends on LOM 132, LIZARD 120, and I²GE 122 for operation. Creativity 112 supplements CTMP 124 and LOM 132, whilst CTMP 124 supplements LOM 132. Therefore Appchains 836 can depend on each other whilst retaining their own identity and jurisdiction within the UBEC Platform 100.

FIG. 605 shows an overview of the various sub-modules that operate within Self Programming Self Innovation (SPSI) 130. Automated Appchain Refinement (A2R) 8040 inspects Appchains 836 and Legacy Programs to improve the efficiency of their routines, and to improve their usability and reliability. Automated Appchain Maintenance (A2M) 8042 maintains the selected Appchain 836 or Legacy Program by deleting Expired Caches 8725, upgrading Depreciated Functions 8726 to Usable Functions, upgrading Depreciated Modules and Dependencies 8727 with usable Modules, deleting Expired Points of Reference 8728 (missing content etc.), and performing Economical Stability Calibration 8729. Appchain Security Hardening (ASH) 8044 automatically inspects points of intrusion and exploit in an Appchain 836 or Legacy Program. Appchain Regulatory Compliance (ARC) 8046 ensures that the selected Appchain 836 or Legacy Program is in compliance with various and specific regulations (e.g. compliance to REST API etc.). The Diagnostic Log Unit Analysis (DLUA) 8048 receives Diagnostic Log Units (DLU) from malfunctioning routines and enacts the appropriate provisions to attempt to fix such perceived malfunctions. Innate Error Correction (IEC) 8050 attempts to fix fundamental procedure flaws that can lead to a halted routine. New Appchain Development (NAD) 8052 finds uses for Applications within a specified Application ecosystem (like the UBEC Platform 100) that has a potential Application feature missing, which would perceivably benefit such an ecosystem. Enhanced Framework Development (EFD) 8054 inspects and potentially improves existing software frameworks (such as programming languages) for both the UBEC Platform 100/BCHAIN Network 110 and Legacy Systems. The Enhanced Hardware Development (EHD) 8056 modifies physical systems that contain Dynamic Liquid Conductive Boards (DLCB) 8856 and therefore can have their core hardware structure optimized and upgraded. The Appchain Targeting Mechanism (ATM) 8038 processing an intelligent selection algorithm that informs other modules for which Appchain 836 they should select in their processing. ATM 8038 informs modules A2R 8040, A2M 8042, ASH 8044, ARC 8046, DLUA 8048, and IEC 8050. Other modules have their own innate selection mechanism which differs in logic to ATM 8038.

FIGS. 606-609 show the operation and functionality of the Appchain Targeting Mechanism (ATM) 8038, which is a submodule of SPSI 130 that intelligently selects relevant Appchains 836 for processing for specified submodules of SPSI 130 (modules A2R 8040, A2M 8042, ASH 8044, ARC 8046, DLUA 8048, and IEC 8050).

FIG. 606 shows Appchain Targeting Mechanism (ATM) 8038 at Stage 8064, it determines if this instance of ATM 8038 being executed within Appchain Emulation Layer (AEL) 8058 or a Mining Node of Target Appchain 8062. If AEL 8066, at Stage 8070 follows execution Routine A 8074 with Receive Behavior Preferences from Legacy Administration 8076 and Submit the Appchain as Modular 8078 to Target Appchain 6060. And if Mining Node 8068 at Stage 8072 Follows Execution Routine B 8080 with Solved Work New Block Announcement 8082 and Submit the Appchain as modular 8084 to Target Appchain 6060.

FIG. 607 shows Appchain Targeting Mechanism (ATM) 8038 operation within Execution Routine A 8074. At Stage 8090, it Receives Behavior Preferences 8088 from Legacy Administration 8086. Behavior Preference Types 8092 include: Off Mode 8094, Manual Mode 8096, and Automatic Mode 8098. For Off Mode 8094, No further action is taken, therefore SPSI 130 is dormant until Behavior Preference 8088 changes are made by the Legacy Administration 8086 at Stage 8100. For Manual Mode 8096, it Retrieves the manual list of Appchain/Legacy Programs from the Legacy Administration 8086. For Automatic Mode 8098, at Stage 8104 Appchain/Legacy Program is delegated to Automated Program Selection (APS) 8102.

FIG. 608 continues the logic from FIG. 607 for Appchain Targeting Mechanism (ATM) 8038 within Execution Routine A 8074 at Stage 8106 it Retrieves the manual list 8108 of Appchain/Legacy Programs from the Legacy Administration 8086. At Stage 8110, A loop is engaged for the active Program List. At Stage 8112, Appchain/Legacy Program is delegated to Automated Program Selection (APS) 8114 within Automated Program List 8116. At Stage 8118, The Selected Program 8122 is submitted as modular output to Target Appchain 6060 for SPSI Processing 130. Upon completion of SPSI 130 processing, the next available Program in the Loop is engaged at Stage 8120.

FIG. 609 shows Appchain Targeting Mechanism (ATM) 8038 operation for Execution Routing B 8080 within Mining Node of Target Appchain 8062. At Stage 8124, Modular Invocation of ATM 8038 occurs on a Miner of a specified Appchain therefore SPSI 130 functions are performed to manipulate Appchains on the Mining Nodes that mine them at Stage 8126. Solved Work New Block Announcement 8082 Extract the identity of the Appchain at Stage 8128. At Stage 8130, Verifies the Appchain identity from Appchain Updates and from the Metachain. If Verified 8132, Retrieves the entire Appchain from the local Metachain 8134 and submits the Appchain as modular 8136 to Target Appchain 6060. If Unverified 8138, Submits a DLU with the Official System Token 5600 to DLS 1160.

FIGS. 610-616 Automated Appchain Refinement (A2R) 8040. FIG. 610 shows Automated Appchain Refinement (A2R) 8040 where LIZARD 120 interprets Syntax of Target Appchain 6060 via Syntax Module at Stage 8138. At Stage 8140, LIZARD 120 produces a Purpose Hierarchy Map 8142 of the Target Appchain 6060 via the Purpose Module. At Stage 8144 Extracts established Code Design Principles 8140 that yield greater efficiency from Central Knowledge Retention (CKR) 648. LIZARD 120 produces a Purpose Hierarchy Map 8150 of the Code Design Principles 8140 at Stage 8148.

FIG. 611 shows details concerning the operation of LIZARD 120 to convert the Execution Stream 556 of the Target Appchain 6060, that was selected by the Appchain Targeting Mechanism (ATM) 8038, into a Purpose Hierarchy Map 8142. The Execution Stream 556 of the Target Appchain 6060 that is produced by Execution Stream Collection (ESC) 6700 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The Target Appchain 6060 is received in Fulfilled Execution Stream 8189 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 612 continues the logic flow from FIG. 611 to illustrate the operation of LIZARD 120 to convert the Target Appchain 6060 into a Purpose Hierarchy Map 8142. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 8142 which is presented as the Complex Purpose Format C325 version of the Target Appchain 6060. The same definition and application of Inner Core (IC) C333 applies for the aforementioned functions and modules.

FIG. 613 shows details concerning the operation of LIZARD 120 to convert the Code Design Principles 8146 that were produced from Central Knowledge Retention (CKR) 648 into a Purpose Hierarchy Map 8150. The Code Design Principles 8146 are submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The Target Appchain 6060 is received in Principle Syntax 8147 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 614 continues the logic flow from FIG. 613 to illustrate the operation of LIZARD 120 to convert the Code Design Principles 8146 into a Purpose Hierarchy Map 8150. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in. Complex Purpose Format C325, which is submitted as modular output for PM C36, and therefore the Outer Core (OC) C329, and therefore LIZARD 120. The output is labeled as a Purpose Hierarchy Map 8150 which is presented as the Complex Purpose Format C325 version of the Code Design Principles 8146. The same definition and application of Inner Core (IC) C333 applies for the aforementioned functions and modules.

FIG. 615 Automated Appchain Refinement (A2R) 8040 inspects Appchains 836 and Legacy Programs to improve the efficiency of their routines, and to improve their usability and reliability. Code Design Principles 8146 and Execution Stream Collection (ESC) 6700 within Purpose Hierarchy Map 8150 and Purpose Hierarchy Map 8142 respectively are submitted to P2SP 7000. Symmetry Processing Result 8152 determines at Stage 8154 does the code purpose of the Target Appchain match the Code Design Principles in it's entirety if Yes, it matches 8156 no refinement is required, and module execution is terminated. However if it doesn't match 8158, the Purpose Hierarchy Map of the Target Appchain 6060 is adjusted to match the Map of the Design Principles 8146 with results submitted to Master/Slave Affinity 1480 and PRP 7050 which produces the Upgraded Purpose Map 8162.

FIG. 616 continues the logic flow from FIG. 615 to illustrate the operation of LIZARD 129 to convert the Upgraded Purpose map into Appchain Syntax 8164. The Upgraded Appchain 6262 is submitted to Deployment Patch Assembly (DPA) 6260 to produce the Appchain Correction Patch 6270. The Appchain Correction Patch 6270 is deployed to the Customchain Ecosystem Builder (CEB) 584, which manipulates the Target Appchain 6060 so that it converts its content to the Upgraded Appchain 6262.

FIG. 617 shows details concerning the operation of LIZARD 120 to convert the Upgraded Purpose Map 8162 into an Upgraded Appchain 6262 (shown being completed in FIG. 618). The Instruction Purpose Collection 9462 exists in Complex Purpose Format C325 and is submitted to Iterative Expansion C327 of the Purpose Module C36 within the Outer Core (OC) C329 of LIZARD 120. Iterative Expansion C327 adds detail and complexity to evolve a simple goal (indirectly defined within the Purpose Replacement 8258) into a specific complex purpose definition. Therefore the maximum Purpose Association C326 potential of the input is realized, and retained as a Complex Purpose Format C325, before it is submitted to Logical Derivation C320 of the Syntax Module (SM) C35. The Core Code C335 element of Inner Core (IC) C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 618 continues the logic flow from FIG. 617 to illustrate the operation of LIZARD 120 to convert the Upgraded Purpose Map 8162 (shown in FIG. 617) into an Upgraded Appchain 6262. The input data is received in Complex Purpose Format C325 from the Purpose Module (PM) C36 and is transferred to Logical Derivation C320 of the Syntax Module (SM) C35. Logic Derivation C320 derives logically necessary functions from initially simpler functions. This means that if a function can be formed as a derivative function due to implication from a simpler parent function; then it is formed by Logical Derivation C320. The produced result is a tree of function dependencies that are built according to the defined Complex Purpose Format C325 data. Logical Derivation C320 operates according to the Rules and Syntax C322 definitions which are inherited from the Core Code C335 element of Inner Core (IC) C333. Logical Derivation C320 submits it's output to Code Translation C321. Code Translation C321 converts arbitrary (generic) code which is recognized and understood by SM C35 to any known and chosen computation language. Code Translation C321 also performs the inverse function of translating known computation languages into arbitrary syntax types. Therefore PM C36 invokes SM C35 to produce the resultant Appchain Syntax version of the input Upgraded Purpose Map 8162 via Code Translation C321. The resultant Upgraded Appchain 6262 that is terminally produced by Code Translation C321 is the modular output of SM C35, Outer Core (OC) C329, and LIZARD 120.

FIGS. 619-652 show the operation and functionality of Innate Error Correction (IEC) 8050, which is a submodule of Self Programming Self Innovation (SPSI) 130 that attempts to fix fundamental procedure flaws that can lead to a halted routine.

FIG. 619 shows the operation and functionality of Innate Error Correction (IEC) 8050, which is a sub-module of SPSI 130. The Appchain Targeting Mechanism (ATM) 8038 selects a specified Target Appchain 6060 which is then submitted as modular input to an invoked Execution Stream Collection (ESC) 6700 instance. The Execution Stream that is produced as modular output from the ESC 6700 instance is submitted as modular input to Stage 8170 of IEC 8050. Stage 8170 separates the Execution Stream of the Appchain 836 to produce the Code Structure Blueprint 8172. At Stage 8174, each Selected Code Unit 8188 that exists within the Code Structure Blueprint 8174 is cycled through a programming Loop. Therefore at Stage 8178 LIZARD 120 is invoked to produce a Purpose Hierarchy Map 8180 from the Selected Code Unit. At Stage 8176 LIZARD 120 is invoked to produce a Purpose Hierarchy Map 8182 of the entire Code Structure Blueprint 8176. Therefore both Purpose Hierarchy Maps 8180 and 8182 are submitted as modular input to the Purpose to Purpose Symmetry Processing (P2SP) 7000 module. Upon completion of P2SP's 7000 processing, Symmetry Processing Result 8184 is produced as the modular output. Therefore Stage 8186 is executed which performs an internal consistency by interpreting the Symmetry Processing Result 8184 to evaluate if each of the Selected Code Unit's Purpose Hierarchy Map 8180 aligns with the greater purpose (Purpose Hierarchy Map 8182) of the entire Code Structure Blueprint 8172.

FIG. 620 shows details concerning the operation of LIZARD 120 to convert the Selected Code Unit 8188 into a Purpose Hierarchy Map 8180 (shown in FIG. 621). The Selected Code Unit 8188 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The Selected Code Unit 8188 is received in Fulfilled Execution Stream 8189 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 621 continues the logic flow from FIG. 620 to illustrate the operation of LIZARD 120 to convert the Selected Code Unit 8188 into a Purpose Hierarchy Map 8180. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 13242 which is presented as the Complex Purpose Format C325 version of the Claimed Neural Pattern 13238. The same definition and application of Inner Core (IC) C333 applies for the aforementioned functions and modules.

FIG. 622 shows details concerning the operation of LIZARD 120 to convert the Code Structure Blueprint 8172 into a Purpose Hierarchy Map 8182. The Code Structure Blueprint 8172 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The Code Structure Blueprint 8172 is received in Multiple Execution Streams 5626 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 623 continues the logic flow from FIG. 622 to illustrate the operation of LIZARD 120 to convert the Code Structure Blueprint 8172 into a Purpose Hierarchy Map 8182. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 8182 which is presented as the Complex Purpose Format C325 version of the Code Structure Blueprint 8172. The same definition and application of Inner Core (IC) C333 applies for the aforementioned functions and modules.

FIG. 624 expands on the operational details of Stage 8170 from Innate Error Correction (IEC) 8050. Stage 8170 separates the Execution Stream 556 of the Target Appchain 6060. Therefore once Execution Stream Collection (ESC) has submitted the Execution Stream 556 as modular input to Stage 8170 of IEC 8050, the Stream 556 is submitted as modular input to Stage 8190. Stage 8190 invokes Execution Stream Rendering 6400 to interpret and build all the relevant dependences from supplement Appchains 836, therefore producing the Fulfilled Execution Stream 8192. The Stream 8192 is submitted as modular input to Stage 8194, which loops through each Fulfilled Execution Segment 551 of the Fulfilled Execution Stream 8192/556.

FIG. 625 continues the logic flow of Stage 8170 of Innate Error Correction (IEC) 8050. The Fulfilled Execution Stream 8192 is submitted as modular input to Stage 8194, which initiates the Loop from FIG. 624. At Stage 8196 the selected Fulfilled Execution Segment 551 is isolated and stored in the Code Unit Buffer Pool (CUBP) 8198 whilst retaining (with metadata) it's relational context from within the Fulfilled Execution Stream 556. Prompt 8202 interprets if there are any unprocessed Fulfilled Execution Segments 551 left in the Loop that was initiated at Stage 8194. If the response to Prompt 8202 is Yes 8204, then Stage 8206 is activated which advanced the Loop from Stage 8194 to the next available Fulfilled Execution Segment 551. If the response to Prompt 8202 is No 8208, then Stage 8200 is activated which invoked LIZARD 120 to cover the entire contents of CUBP 8198 into a Purpose Hierarchy Map 8210.

FIG. 626 shows details concerning the operation of LIZARD 120 to convert the Code Unit Buffer Pool (CUBP) 8198 into a Purpose Hierarchy Map 8210. The CUBP 8198 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The CUBP 8198 is received in Execution Segments 5628 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 627 continues the logic flow from FIG. 626 to illustrate the operation of LIZARD 120 to convert the Code Unit Buffer Pool (CUBP) 8198 into a Purpose Hierarchy Map 8210. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 8210 which is presented as the Complex Purpose Format C325 version of the CUBP 8198. The same definition and application of Inner Core (IC) C333 applies for the aforementioned functions and modules.

FIG. 628 continues the logic flow of Innate Error Correction (IEC) 8050. The Code Unit Buffer Pool (CUBP) 8198 is processed in a Loop (of each potential Code Unit) at Stage 8212. The Purpose Hierarchy Map 8210 of the entire Code Unit Buffer Pool (CUBP) 8198 and the Purpose Hierarchy Map 8214 of the Selected Code Unit 8188 is submitted to Purpose to Purpose Symmetry Processing (P2SP) 7000, therefore producing the Symmetry Processing Result 8216. Stage 8218 performs an internal consistency check to evaluate if the Selected Code Unit's 8188 Purpose Hierarchy Map 8214 aligns with the greater purpose (Purpose Hierarchy Map 8210) of the entire Code Structure contained in CUBP 8189. Therefore at Stage 8220 any misaligned Code Units 8188 that do not have a purpose that aligns with the entire Code Structure (from CUBP 8198) are flagged. Therefore Stage 8220 submits it's modular output to Misaligned Code Unit Purpose Retention (MCUPR) 8222. At Stage 8224 each Misaligned Code Unit Purpose is iterated in a new Loop to derive a suitable purpose for each Unit that conforms with the Purpose Hierarchy Map 8182 of the Code Structure Blueprint 8172. The process of deriving a suitable purpose in Stage 8224 is processed by Suitable Purpose Replacement (SPR) 8252.

FIG. 629 elaborates on operational details concerning Stages 8218 and 8220 of IEC 8050. The modular output of the corresponding Purpose to Purpose Symmetry Processing (P2SP) 7000 instance is Symmetry Processing Result 8216. The result is submitted as modular input to Stage 8288 of the Symmetry Processing Result Validation (SPRV) 8226 module. Stage 8228 separates each Alignment Integration Detection (AID) 7040 instance (spawned from within the P2SP 7000 internal logic) result stored in the Symmetry Processing Result 8216. Thereafter Stage 8230 invokes a Loop for each AID 7040 instance result. Within the Loop Prompt 8232 interprets if the selected AID 7040 result is considered misaligned according to the Symmetry Processing Result 8232. If the response to Prompt 8232 is that it is not misaligned, then Stage 8234 is activated which advances the Loop to the next AID 7040 result. If the response to Prompt 8232 is Yes, Misaligned 8236 then Stage 8238 is activated which outputs the selected AID 7040 result as a Code Unit as modular output for SPRV 8226. Such output is submitted to Stage 8222 which flags the misaligned Code Unit by storing it in Misaligned Code Unit Purpose Retention (MCUPR) 8224. Therefore execution of the PSRV 8226 module flags any misaligned Code Units by validating the Symmetry Processing Result 8216.

FIG. 630 continues the logic flow of IEC 8050 from Stage 8224. Stage 8224 loops through each Misaligned Code Unit Purpose and derives a suitable purpose via invocation of Suitable Purpose Replacement (SPR) 8252 that conforms with the Purpose Hierarchy Map 8182 of the Code Structure Blueprint 8172. At Stage 8240 LIZARD 120 is invoked to convert the Purpose Replacements produced by the corresponding SPR 8252 instance into Execution Segments 551. This leads the activation of Stage 8242, which associates each Syntax Replacement Unit with it's relevant place in the Code Structure Blueprint 8172. Thereafter at Stage 8244 a Deployment Patch 6270 is created via invocation of the Deployment Patch Assembly (DPA) 6260 module. Such a Patch 6270 contains the Syntax Replacement Units and instructions for what part of the original Appchain 836 they are to replace.

FIG. 631 continues the logic flow of IEC 8050 from Stage 8240, which invokes LIZARD 120 to convert Purpose Replacements into Execution Segments 551 therefore producing and submitting results to Syntax Replacement Unit Retention (SRUR) 8246. Stage 8242 associates each Syntax Replacement Unit with it's corresponding place in the Code Structure Blueprint 8172. Stage 8242 accomplishes this my invoking the Unit Blueprint Lookup (UBL) 8248 module. The UBL 8248 module produces it's output to the Code Structure Streamline Processing (CSSP) 8250 module, which arranges the input data into an Upgraded Appchain 6262 output. Therefore CSSP 8250 invokes Stage 8244 which creates a Deployment Patch which contains the Syntax Replacement Units and instructions for what part of the Appchain 836 they will replace.

FIG. 632 shows the operation and functionality of the Suitable Purpose Replacement (SPR) 8252 module with regards to the invocation of Stage 8224 as part of the internal logic of the Innate Error Correction (IEC) 8050 module. The Misaligned Code Unit Purpose Retention (MCUPR) 8224 module is submitted as modular input to Stage 8254 of SPR 8252. Stage 8254 initiates a Loop through each Misaligned Code Unit Purpose from MCUPR 8224. At Stage 8256 LOM 132 is invoked to produce a Purpose Replacement 8258, for the Selected Misaligned Code Unit, which is congruent and compatible with the Code Structure Blueprint 8260. Therefore the Code Structure Blueprint 8172 is eventually modified to contain the Purpose Replacements 8258, therefore forming the more accurate Blueprint 8260. The individual Purpose Replacement 8258 within the Loop invoked by Stage 8254 is submitted to Stage 8240 to be processed by LIZARD 120. At Stage 8240 LIZARD 120 is invoked to convert the Purpose Replacements into Execution Segments 556.

FIG. 633 shows the internal operation procedure of LOM 132 and CTMP 124 in regards to Stage 8256 of Suitable Purpose Replacement (SPR) 8252. The Code Structure Blueprint 8260, Misaligned Code Unit 8264, and Compliance Design Principles 8262 are supplied as initial input to the Replacement Invocation Prompt (RIP) 8266. RIP 8266 produces a Prompt 8268 that interacts directly with LOM 132 to invoke the production of the Purpose Replacement 8258 with consideration of the input criteria Code Structure Blueprint 8260, Misaligned Code Unit 8264, and Compliance Design Principles 8262. The Prompt 8268 produced by RIP 8266 is submitted to the Initial Query Reasoning (IQR) C802A module of LOM 132. When LOM 132 is invoked directly within the UBEC Platform 100 by an UBEC User 106, IQR C802A receives the initial question/assertion provided by the UBEC User 106. However this instance of LOM 132 is automatically invoked by RIP 8266 instead. The provided Prompt 8268 is analyzed via invocation of Central Knowledge Retention (CKR) 648 to decipher Missing Details from the Prompt 8268 that are crucial to complete the correct ‘virtual understanding’ by LOM 132 for LOM 132 to fully address/respond to the Prompt 8268. The resultant Missing Details produced by IQR C802A are submitted as modular input to Survey Clarification (SC) C803A. SC C803A engages with the origin of the Prompt 8268 to retrieve supplemental information so that the Prompt 8268 can be analyzed objectively and with all the necessary context. When LOM 132 is invoked directly within the UBEC Platform 100 by an UBEC User 106, SC C803A engages with that User 106 as the origination of the question/answer. However this instance of LOM 132 is automatically invoked by RIP 8266 instead, therefore SC C803A engages with RIP 8266 to retrieve supplemental information concerning the Prompt 8268. The fully formed and refined version of the Prompt 8268 is produced from SC C803A and submitted as modular input to Assertion Construction (AC) C808A. AC C808A attempts to form a coherent response to the Prompt 8268 by referencing CKR 648 directly and also via Hierarchical Mapping (HM) C807A. Rational Appeal (RA) C811A is a container module that houses a logic flow interface with CTMP 124. RA C811A uses CTMP 124 to criticize assertions. Such criticisms can be in the form of self-criticisms (by criticizing the output of AC C808A), or external criticisms to the origin of the question/assertion processed by IQR C802A (UBEC User 106 or RIP 8266). If an assertion produced from AC C808A fails a significant measure of the self-criticism test processed by RA C811A; then a new instance of AC C808A is invoked to account for any valid criticisms. If a high confidence assertion is produced by AC C808A that consistently passes self-criticism tests processed by RA C811 A; then the assertion is produced as LOM's 132 modular output, referenced as the Ideal Investment Decision Makeup 12404 in context of the initial Prompt 8268 provided by RIP 8266.

FIG. 634 shows more detail of the internal operation procedure of Rational Appeal (RA) C811A of LOM 132 in regards to Stage 12402 of CSE 12400. Assertion Construction (AC) C808A provides a Response Presentation C843 to Rational Appeal (RA) C811A concerning the assertion produced by AC C808A in regards to the corresponding input Prompt 8268. At this stage of the logic flow, the produced assertion is classified as a PreCriticized Decision C847. This indicates that it is has yet to be processed via criticism by CTMP 124. Therefore the produced assertion is directly submitted to the CTMP 124 instance as a ‘Subjective Opinion’ C848 input, and also to Context Construction (CC) C817A which provides the ‘Objective Fact’ C850 input to the CTMP 124 instance. CC C817A references metadata from AC C808A and potential evidence provided via RIP 8266 to submit raw facts to CTMP 124 for critical thinking. Such input metadata is represented by the LOM Log Aggregate 5502 file. The LOM Log Aggregate 5502 contains a collection of relevant log files that are produced from the primary operating functions of LOM 132. After the CTMP 124 instance concludes it's operation, a Post-Criticized Decision C851 is produced as modular output. The initial Pre-Criticized Decision C847 and Post-Criticized Decision C851 are submitted to the Decision Comparison (DC) C818A module which determines the scope of potential overlap between the two inputs C847 and C851. The unified output provided by DC 818A can either indicate CTMP's 124 Concession C852 (of incorrectness) on behalf of the AC C808A produced assertion, or a perceived Improvement C853 on behalf of the AC C808A produced assertion. Both Argument Responses C852 and C853 can be classified as either Low Confidence Results C845 or High Confidence Results C846. A Low Confidence Result C845 indicates that the original assertion produced by AC C808A is flawed and should be reconstructed; therefore the logic flow continues to a new instance of AC C808A. A High Confidence Result C846 indicates that the original assertion produced by AC C808A has merit, therefore the drawn conclusions (coupled with any corresponding evidence, premises etc.) are submitted to Knowledge Validation (KV) C805A. Therefore the logic flow continues to a new instance of KV C805A so that CKR 846 and hence LOM 132 can benefit from the recently processed assertion.

FIG. 635 continues the logic flow of Stage 12402 from CSE 12400 to illustrate the production of the LOM Log Aggregate 5502 file. Modular outputs produced from Initial Query Reasoning (IQR) C802A, Survey Clarification (SC) C803A, Assertion Construction (AC) C808A, Hierarchical Mapping (HM) C807A and Knowledge Validation (KV) C805A are submitted to the LOM Modular Log Collection (LMLC) 5500 module. Therefore LMLC 5500 combines the input log data into a single readable file referenced as LOM Log Aggregate 5502. The File 5502 encompasses the overall operational state of the corresponding LOM 132 instance, hence providing information as to how the LOM 132 instance reached various conclusions. The LOM Log Aggregate 5502 is submitted to CC C817A of Rational Appeal (RA) C811A.

FIG. 636 expands on operational details concerning FIG. 634 to illustrate the internal operation of CTMP 124 in regards to the input and output channels defined in Rational Appeal (RA) C811A. The Pre-Criticized Decision C847 is Presented C843 as modular output from Assertion Construction (AC) C808A. The Decision C847 is then marked as a Subjective Opinion C848, therefore fulfilling one of the two major inputs of CTMP 124. The Subjective Opinion C848 is submitted to Input System Metadata C484, which acts as the primary modular input for CTMP 124 and an internal representation of the Selected Pattern Matching Algorithm (SPMA). For this instance configuration; the SPMA is LOM 132. Input System Metadata C484 is submitted for processing to Reason Processing C456 and to Raw Perception Production (RP²) C465. Reason Processing C456 will logically understand the assertions being made by comparing property attributes. RP² C465 parses the Input System Metadata C484 from LOM 132 to produce a perception in Perception Complex Format (PCF) that represents the algorithmic perception of LOM 132. Such a produced Perception is submitted to the Perception Observer Emulator (POE) C475 which emulates the algorithmic perception of LOM 132. Reason Processing C456 invokes Rule Processing which eventually produces rulesets that reflect the SPMA algorithm which in this instance is LOM 132. Therefore two modes of ‘thinking’ are executed, ‘analogue’ perception and ‘digital’ ruleset processing. These two Branches C461 and C475 represent similitudes with intuition and logic. The results produced by both thinking Branches C461 and C475 are transferred to Critical Decision Output (CDO) C462, which evaluates any fundamental elements of conflict or corroboration between the results. Upon finding a high magnitude of internal corroboration, and a low magnitude of internal conflict CTMP 124 provides a binary Approve or Block decision, in regards to the initial input Subjective Opinion C848, that is referenced as a High Confidence Result C846. If there is a low magnitude of internal corroboration and a high magnitude of internal conflict CTMP 124 submits a ‘vote of no confidence’ which is referenced as a Low Confidence Result C845. Therefore the resultant output of CTMP 124 is considered the Post-Criticized Decision C851.

FIG. 637 shows more details concerning the invocation of Raw Perception Production (RP²) C465 within CTMP 124. LOM 132 produces the Purpose Replacement 8258 by invoking Assertion Construction (AC) C808A. The Purpose Replacement 8258 is then submitted to Stage 5506 of RP² C465 which unpacks the data to produce instances of a Debugging Trace C485 and Algorithm Trace C486 within the Input System Metadata C484 which originates from the corresponding AC C808A instance. Debugging Trace C485 is a coding level trace that provides variables, functions, methods and classes that are used along with their corresponding input and out variable type and content. The full function call chain (function trace: functions calling other functions) is provided. The Algorithm Trace C486 is a software level trace that provides security data coupled with algorithm analysis. The resultant security decision (approve/block) is provided along with a logistics trail of how it reached the Decision C847. The appropriate weight concerning each factor that contributed to producing the Decision C847 is included. Thereafter RP² C465 transfers the data concerning the produced perception result to Perception Observer Emulator (POE) C475 for processing.

FIG. 638 elaborates on the operation of Raw Perception Production (RP²) C465 from within CTMP 124. Initially Stage 5506 occurs, as it does on FIG. 1209, to unpack the data to produce instances of a Debugging Trace C485 and Algorithm Trace C486 within the Input System Metadata C484 which originates from the corresponding AC C808A instance. At Stage 5508, Metric Processing C489 reverse engineers the variables from LOM 132 to extract perceptions from the artificial intelligence exhibited by LOM 132. Thereafter Input System Metadata C484 is processed by Stage 5510, which separates Metadata C484 into meaningful security cause-effect relationships via System Metadata Separation (SMS) C487. As also indicated by FIG. 1209, RP² C465 transfers the data concerning the produced perception result to Perception Observer Emulator (POE) C475 for processing.

FIG. 639 elaborates on the operation of Perception Observer Emulator (POE) C475, include it's and Raw Perception Production's (RP²) C465 relation to Perception Storage (PS) C478. The operation of Metric Processing C489 and System Metadata Separation (SMS) C487 both lead to the production of Perceptions 5512/5514/5516 that are thereafter stored in PS C478. The resulting Perceptions 5512/5514/5516 represent LOM's 132 modular response of producing the Purpose Replacement 8258 via Assertion Construction (AC) C808A. RP² C465 produces a Comparable Variable Format datapoint which is fed into Storage Search (SS) C480 as search criteria. Thereafter SS C480 performs a lookup of PS C478 to find matches with already existing Perceptions stored in PS C478. The Results C716 of the execution SS C480 are produced which leads to a Weight Calculation C718. Such a Calculation C718 attempts to find the correct distribution of corresponding Perceptions from PS C478 to replicate and match the Comparable Variable Format which represent's the execution of the LOM 132 algorithm that produced Purpose Replacement 8258.

FIG. 640 continues the Perception Observer Emulator (POE) C475 logic from FIG. 639. After the production of Results C716 from Storage Search (SS) C480, the Weight Calculation C718 completes to lead to the Application C729 of the Perceptions 5512/5514/5516 to make an active Approve C731 or Block C730 decision. The Purpose Replacement 8258 produced by LOM 132 and corresponding LOM Log Aggregate 5502 undergo Data Parsing C724 which causes Data Enhanced Logs C723 to be derived which are applied in the Application C729 to achieve an Interpretation Dichotomy 5518 of a Positive Sentiment (Approve) C731 or Negative Sentiment (Block) C730 with regards to the input Purpose Replacement 8258. Upon successful conclusion of the execution of Application C729 leads to an Override Corrective Action C476 which is processed by Critical Decision Output (CDO) C462 in parallel to the modular output of Rule Execution (RE) C461. The Self-Critical Knowledge Density (SCKD) C474 module estimates the scope and type of potential unknown knowledge that is beyond the reach of the reportable LOM Log Aggregate 5502. This way the subsequent critical thinking features of the processing CTMP 124 instance can leverage the potential scope of all involved knowledge, known and unknown directly by the instance.

FIG. 641 shows the Memory Web C460 process that operates in parallel to the execution of Perception Observer Emulator (POE) C475 in FIG. 639. The Purpose Replacement 8258 produced by LOM 132 is submitted as modular input to Reason Processing C456. Reason Processing C456 processes how LOM 132 achieved the decision to produce the Purpose Replacement 8258 in response to the Prompt 8268 provided by RIP 8266. The processing conclusion of Reason Processing C456 is the execution of Reason Processing C457, which defines the rules that are thirdly consistent with LOM's 132 execution behavior. If any inconsistencies are found in rule behavior with regards to LOM's 132 execution behavior, then currently existing rules are modified or new rules are added. Such rules are later used within the CTMP 124 instance to criticize decision making behaviors found within the corresponding LOM 132 instance. Critical Rule Scope Extender (CRSE) C458 then leverages known Perceptions to expand the ‘critical thinking’ scope of the rulesets, in effect enhancing the rulesets to produce Correct Rules C459. The Correct Rules C459 are then submitted as modular input to Rule Syntax Format Separation (RSFS) C499 from within the operating jurisdiction of Memory Web C460. RSFS C499 separates and organizes Correct Rules C459 by type. Therefore all actions, properties, conditions and objects are listed separately after RSFS C499 processing. This enables the CTMP 124 instance to discern what parts have been found in the Chaotic Field, and what parts have not. Chaotic Field Parsing (CFP) C535 combines and formats the LOM Log Aggregate 5502 into a single scannable unit referenced as the Chaotic Field. The Chaotic Field is submitted as modular input to Memory Recognition (MR) C501. MR C501 also receives the Original Rules C555 which is the execution result from RSFS C499. MR C501 scans the Chaotic Field provided by CFP C535 to recognize knowable concepts defined in Original Rules C555. This MR C501 instance execution produces Recognized Rule Segments C556. Thereafter Rule Fulfillment Parser (RFP) C498 receives individual parts of the Original Rules C555 that have been tagged according to their recognition or lack-thereof within the Chaotic Field by MR C501. RFP C498 can then logically deduce which whole ruleset (the combination of all of their parts) have been sufficiently recognized in the Chaotic Field to merit processing by Rule Execution (RE) C461. Upon successful conclusion of the execution of RE C461 leads to an Override Corrective Action C476 which is processed by Critical Decision Output (CDO) C462 in parallel to the modular output of Perception Observer Emulator (POE) C475.

FIG. 642 elaborates on the logic flow interaction between Perception Storage (PS) C478 and the Automated Perception Discovery Mechanism (APDM) C467. PS C478 contains four subsets of Perceptions: Deduced Unknown Angles of Perception C473, All Angles of Perception C472, Implied Angles of Perception C471, and Applied Angles of Perception C470. Applied Angles of Perception C470 are Perceptions that have been directly imported by studying algorithmic behavior of the Selected Pattern Matching Algorithm (SPMA), which in this instance is LOM 132. Implied Angles of Perception C471 are Perceptions that have been derived from Applied Angles of Perception C470 via modular execution of Implication Derivation (ID) C477 and APDM C467. All Angles of Perception C472 represents the entire scope of known Perceptions to the CTMP 124 instance that have not been included by Applied Angles of Perception C470 and Implied Angles of Perception C471. Deduced Unknown Angles of Perception C473 represents the scope of Perceptions that is expected to exist yet the CTMP 124 instance has yet to discover according to the Self-Critical Knowledge Density (SCKD) C474 module. ID C477 analyzes the individual metrics of Applied Angles of Perception C470 to deterministically derive Implied Angles of Perception C470, whilst APDM C467 creatively varies compositions of Angles of Perception C650 via the Creativity Module 112 to produce a New Iteration C653 that combines the initial two input Weights C652. Therefore all of the Angles of Perception C650 involved with APDM C467 processing correspond with and represent the Purpose Replacement 8258 that is produced by LOM's 132 Assertion Construction (AC) C808A module.

FIG. 643 elaborates on the operational details concerning the Critical Rule Scope Extender (CRSE) C458 of CTMP 124. A Rational Appeal (RA) C811A instance operates within LOM 132 and invokes Context Construction (CC) C817A to process the LOM Log Aggregate 5502 to Chaotic Field Parsing (CFP) C535. CFP produces a Chaotic Field from the modular output of CC C817A which is referenced by Memory Recognition (MR) C501. Current Rules C534 exhibits rulesets that are indicative of the current functioning state of the Selected Pattern Matching Algorithm (SPMA) which in this instance is LOM 132. Current Rules C534 is submitted as modular input to the Rule Syntax Derivation (RSD) C504 module, which is where logical ‘black and white’ rules are converted to metric based perceptions. Therefore the complex arrangement of multiple rules are converted into a single uniform perception that is expressed via multiple metrics of varying gradients. The modular output of RSD C504 is provided as modular input to Perception Matching (PM) C503. At PM C503; a Comparable Variable Format (CVF) unit is formed from the Perception received from RSD C504. The newly formed CVF is used to lookup relevant Perceptions in the Perception Storage (PS) C478 with similar indexes. The potential matches are submitted as modular input to Rule Syntax Generation (RSG) C505. RSG C505 receives previously confirmed perceptions which are stored in Perception format and accesses the Perception's internal metric makeup. The Perceptions are received from PS C478 which contains Previously Confirmed Perceptions C468. Such gradient-based measures of metrics are converted to binary and logical rulesets that emulate the input/output information flow of the original perception. Therefore RSG C505 produces Perceptive Rules C537 which are Perceptions that are considered relevant, popular and have been converted into logical rules. If a Perception (in it's original Perception Format) had many complex metric relationships that defined many ‘grey areas’, the ‘black and white’ local rules encompass such ‘grey’ areas by expanding on the ruleset complexity. Therefore the Perceptive Rules C537 are stored by a collection of Rule Syntax Format (RSF) definitions. Perceptive Rules C537 are submitted as modular input to Memory Recognition (MR) C501, where they are scanned against the Chaotic Field which was produced by CFP C535. Therefore MR C501 produces Extra Rules C536 which complete Correct Rules C533 in their validity.

FIG. 644 elaborates on the operational details concerning Implication Derivation (ID) C477 of CTMP 124. The Applied Angles of Perception C470 from Perception Storage (PS) C478 are submitted as modular input to ID C477 to produce more Perceptions that belong to Implied Angles of Perception C471. The Applied Angles of Perception C470 are specifically sent to Metric Combination C493 of ID C477. Metric Combination C493 separates the received Angles of Perception C650 into categories of metrics: Scope C739, Type C740, Consistency C741, Intensity C742. The Metric availability and reference within the system is not necessarily limited to these four types. The input Angles of Perception C650 are related to the Purpose Replacement 8258 that was produced by LOM's 132 Assertion Construction (AC) C808A module. The Metric Complexity Set A C736 is submitted as modular input to Metric Expansion (ME) C495. With ME C495 the metrics of multiple and varying Angles of Perception C650 are stored categorically in individual databases C739/C740/C741/C742. ME C495 enhances the current batch of received metrics with details/complexity extracted from previously known/encountered metrics. Upon enhancement and complexity enrichment completion, the metrics are returned as ME C495 modular output as Metric Complexity Set B C737 and thereafter converted back into Angles of Perception C650 to be stored in Implied Angles of Perception C471 as illustrated on FIG. 1217.

FIG. 645 continues the logic flow of Implication Derivation (ID) C477 from FIG. 644, illustrating the Metric Complexity Set B C737 being processed by Metric Conversion C494 which reverses individual metrics back into whole Angles of Perception C650. Despite the enrichment and conversion process performed by ID C477, the resultant Angles of Perception C650 still provide a reasonably accurate representation of the Purpose Replacement 8258 produced by LOM's 132 Assertion Construction (AC) C808A module. Therefore the Metric Conversion C494 process submits the newly derived/implied Angles of Perception C650 to Implied Angles of Perception C471 within Perception Storage (PS) C478.

FIG. 646 elaborates on the operational details concerning Critical Decision Output (CDO) C462 of CTMP 124. CDO C462 receives modular output from both major branches of CTMP 124: Perception Observer Emulator (POE) C475 (as the intuition branch) and Rule Execution (RE) C461 (as the logical branch). Each Branch C475/461 submits it's respective Critical Decision C521 (the main modular output) as well as corresponding the ‘Meta-metadata’ C521, which provides contextual variables that justify why the initial critical decision was reached. Both Decision Sets C521 that represent the Perceptions C516 of POE C475 and the Fulfilled Rules C517 of RE C461 are submitted to the Metadata Categorization Module (MCM) C488. MCM C488 separates the Debugging and Algorithm Traces into distinct categories using traditional syntax based information categorization. Such categories can then be used to organize and produce distinct security responses with a correlation to security risks and subjects. The Intuitive Decision C514, which represents Perceptions C526 from POE C475, and the Thinking Decision C515, which represents Fulfilled Rules C517 from RE C461 are submitted by MCM C488 to the Internal Processing Logic 5520 of Direction Decision Comparison (DDC) C512. The Internal Processing Logic 5520 of DDC C512 checks for corroboration or conflict between the Intuitive Decision C514 and the Thinking Decision C515. DDC C512 references a ‘cutoff’ variable from Static Hardcoded Policy (SHP) 488. If the ‘cutoff’ variable is not reached for similarity between the Intuitive Decision C514 and the Thinking Decision C515 (i.e. 90%+), then the Cancel Direct Comparison 5524 directive occurs, which might lead the Terminal Output Control (TOC) C513 to eventually submit a Vote of No Confidence 5544 as shown on FIG. 647. The Cancel Direct Comparison 5524 stage implies that CTMP 124 was unable to act internally consistent in regards to the input Prompt 8268 from RIP 8266. If the ‘cutoff’ variable was sufficiently met according to the Internal Processing Logic 5520, then the Final Decision Output 5522 stage is invoked which combines both Decisions C514/C515 into a single modular output which is received and processed by TOC C513.

FIG. 647 continues the logic flow of Critical Decision Output (CDO) C462 from FIG. 646 and elaborates on the operational details of Terminal Output Control (TOC) C513. TOC C513 initiates with Prompt 5526, which checks if Direct Decision Comparison (DDC) C512 was able to provide a Final Decision Output 5522 (instead of the Cancel Direct Comparison 5524 directive). If the response to Prompt 5526 is Yes 5528, then the combined final decision provided by DDC C512 at Final Decision Output 552 is submitted as modular output of TOC C513 and hence as modular output of the entire CTMP 124 instance as the Final Critical Decision 5542 output. If the response to Prompt 5526 is No 5530, then Stage 5532 is invoked which it itself invokes the execution of Perception Matching (PM) 5532 and fetches the corresponding results. Fulfilled Rules C517 are extracted from the Critical Decision+Meta-metadata C521 of Rule Execution (RE) C461. The Rules C517 are converted to Perceptions by Rule Syntax Derivation (RSD) C504. PM 5532 then references Meta-metadata to determine, at Prompt 5534, if there was a strong internal overlap and corroboration of Perceptions used. If the response to Prompt 5534 is Yes 5538 this indicates a Vote of No Confidence 5544 on behalf on CTMP 124 as modular output. If the response to Prompt 5534 is No 5536 then Stage 5540 is activated, which selects the perceived least risky decision between the Intuitive Decision C514 and Thinking Decision C515. Therefore the Final Critical Decision 5542 is subsequently submitted as modular output to CDO C462, TOC C513, and CTMP 124. The logic at Stage 5534 occurs to determine if the lack of unity between the Intuitive Decision C514 and Thinking Decision C515 occurs because of a general lack of algorithmic confidence, or due to highly opposing points of view between the two. Therefore if the latter were to occur, a potential Final Critical Decision 5542 is still discernible as modular output. A Vote of No Confidence 5544 always leads to the Low Confidence Result C845 logic pathway within Rational Appeal (RA) C811A. The Final Critical Decision 5542 can either lead to a High Confidence Result C846 or Low Confidence Result C845 logic pathway within RA C811A, depending on the algorithmic confidence behind the Final Critical Decision 5542.

FIG. 648 shows details concerning the operation of LIZARD 120 to convert the Purpose Replacement 8258 into Execution Segments 8270. The Purpose Replacement 8258 exists in Complex Purpose Format C325 and is submitted to Iterative Expansion C327 of the Purpose Module C36 within the Outer Core (OC) C329 of LIZARD 120. Iterative Expansion C327 adds detail and complexity to evolve a simple goal (indirectly defined within the Purpose Replacement 8258) into a specific complex purpose definition. Therefore the maximum Purpose Association C326 potential of the input is realized, and retained as a Complex Purpose Format C325, before it is submitted to Logical Derivation C320 of the Syntax Module (SM) C35. The Core Code C335 element of Inner Core (IC) C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 649 continues the logic flow from FIG. 648 to illustrate the operation of LIZARD 120 to convert the Purpose Replacement 8258 into Execution Segments 8270. The input data is received in Complex Purpose Format C325 from the Purpose Module (PM) C36 and is transferred to Logical Derivation C320 of the Syntax Module (SM) C35. Logic Derivation C320 derives logically necessary functions from initially simpler functions. This means that if a function can be formed as a derivative function due to implication from a simpler parent function; then it is formed by Logical Derivation C320. The produced result is a tree of function dependencies that are built according to the defined Complex Purpose Format C325 data. Logical Derivation C320 operates according to the Rules and Syntax C322 definitions which are inherited from the Core Code C335 element of Inner Core (IC) C333. Logical Derivation C320 submits it's output to Code Translation C321. Code Translation C321 converts arbitrary (generic) code which is recognized and understood by SM C35 to any known and chosen computation language. Code Translation C321 also performs the inverse function of translating known computation languages into arbitrary syntax types. Therefore PM C36 invokes SM C35 to produce the resultant Execution Segments 8270 version of the input Purpose Replacement 8258 via Code Translation C321. The resultant Execution Segments 8270 that is terminally produced by Code Translation C321 is the modular output of SM C35, Outer Core (OC) C329, and LIZARD 120. The Execution Segments 8270 are then stored in Syntax Replacement Unit Retention (SRUR) 8246.

FIG. 650 elaborates on the operation and functionality of the Unit Blueprint Lookup (UBL) 8248 module in regards to Stage 8242 of Innate Error Correction (IEC) 8050. Stage 8286 receives modular input from Syntax Replacement Unit Retention (SRUR) 8246, therefore initiated a Loop that cycles through all the Syntax Replacement Units 8288 form SRUR 8246. Stage 8284 retrieves the selected Syntax Replacement Unit 8288 from SRUR. The Associated Code Unit ID 8292 is unpacked from the Syntax Replacement Unit 8288 at Stage 8290. On a separate parallel thread within the same instance of UBL 8248 the Code Structure Blueprint 8260 is submitted as modular input to Stage 8280. Stage 8280 install the Code Structure Blueprint 8260 into the New Code Structure Blueprint Retention (NCSBR) 8282.

FIG. 651 continues the logic flow from FIG. 1222 concerning the Unit Blueprint Lookup (UBL) 8248 invocation from within the internal logic of Stage 8242. The logic flow resumes from FIG. 1222 at Stage 8294, which installs the selected Syntax Replacement Unit 8288 into New Code Structure Blueprint Retention (NCSBR) 8282. Stage 8296 is invoked once the iterative processing Loop invoked from Stage 8286 is completed. Stage 8296 reverses the Fulfilled status of the Execution Segments 551 via Code Structure Streamline Processing (CSSP) 8250. Therefore CSSP 8250 produces the Upgraded Appchain 6262 as modular output.

FIG. 652 continues the logic flow of Innate Error Correction (IEC) 8050 from the invocation of CSSP 8250 at FIG. 651. CSSP 8250 produces the Upgraded Appchain 6262, which represents the original syntactical structure but with the Misaligned Code Units replaced with Suitable Purpose Replacements. The Upgraded Appchain 6262 is submitted to Deployment Patch Assembly (DPA) 6260 to produce the Appchain Correction Patch 6270. The Target Appchain 6060 is processed by Execution Stream Collection (ESC) 6700, therefore submitting the original Execution Stream 556 to the DPA 6260 instance. This enables DPA 6260 to have access to the Target Appchain 6060 in it's original form. Because DPA 6260 has access to the differential between the Original 6060 and Upgraded Appchain 6262, it is able to produce the Appchain Correction Patch 6270 which contains the instructions to convert the Original Appchain 6060 to the Upgraded Appchain 6262. At Stage 8298 the Appchain Correction Patch 6270 is deployed to Customchain Ecosystem Builder (CEB) 584, which manipulates the Target Appchain 6060 so that it converts in content to the Upgraded Appchain 6262.

FIG. 653 shows the internal operation procedure of Appchain Security Hardening (ASH) 8044. ASH 8044 is a submodule within SPSI 130 which performs Code Efficiency, Quality, Security and Stability 5048. LOM 132 researches security threats, known cases and potential cases via ARM 134 at stage 8300. Resultant new and unconfirmed information is stored and processed in CKR 648 at Stage 8302. At Stage 8304 LOM 132 extracts meaningful assertions and conclusions concerning security, therefore produce Security Threat Knowledge 8306. At Stage 8308 Security Threat Knowledge is submitted to Artificial Security Threat (AST) 123 for reference.

FIG. 654 continues the logic flow of Appchain Security Hardening (ASH) 8044 from FIG. 653. At Stage 8310 ARM 134 retrieves unconfirmed information from public and private data archives and stores the unconfirmed information in CKR 648 at Stage 8312. At Stage 8314 LOM 132 and CTMP 124 verify the unconfirmed information and expand on it to produce truthful concepts, the confirmed knowledge is stored in CKR 648, for future retrieval by an invocation prompt.

FIG. 655 shows the internal operation procedure of LOM 132 and CTMP 124 in regards to Stage 8304 of Appchain Security Hardening (ASH) 8044. The Theory of Security 8312, Unconfirmed Security Information 8314, and Confirmed Security Knowledge 8310 are supplied as initial input to the Deduction Invocation Prompt (DIP) 8316. DIP 8316 produces a Prompt 8318 that interacts directly with LOM 132 to invoke the production of the Confident Security Assertion 8320 with consideration of the input criteria Theory of Security 8312, Unconfirmed Security Information 8314, and Confirmed Security Knowledge 8310. The Prompt 8318 produced by DIP 8316 is submitted to the Initial Query Reasoning (IQR) C802A module of LOM 132. When LOM 132 is invoked directly within the UBEC Platform 100 by an UBEC User 106, IQR C802A receives the initial question/assertion provided by the UBEC User 106. However this instance of LOM 132 is automatically invoked by DIP 8316 instead. The provided Prompt 8318 is analyzed via invocation of Central Knowledge Retention (CKR) 648 to decipher Missing Details from the Prompt 8268 that are crucial to complete the correct ‘virtual understanding’ by LOM 132 for LOM 132 to fully address/respond to the Prompt 8268. The resultant Missing Details produced by IQR C802A are submitted as modular input to Survey Clarification (SC) C803A. SC C803A engages with the origin of the Prompt 8318 to retrieve supplemental information so that the Prompt 8318 can be analyzed objectively and with all the necessary context. When LOM 132 is invoked directly within the UBEC Platform 100 by an UBEC User 106, SC C803A engages with that User 106 as the origination of the question/answer. However this instance of LOM 132 is automatically invoked by DIP 8316 instead, therefore SC C803A engages with DIP 8316 to retrieve supplemental information concerning the Prompt 8318. The fully formed and refined version of the Prompt 8318 is produced from SC C803A and submitted as modular input to Assertion Construction (AC) C808A. AC C808A attempts to form a coherent response to the Prompt 8318 by referencing CKR 648 directly and also via Hierarchical Mapping (HM) C807A. Rational Appeal (RA) C811A is a container module that houses a logic flow interface with CTMP 124. RA C811A uses CTMP 124 to criticize assertions. Such criticisms can be in the form of self-criticisms (by criticizing the output of AC C808A), or external criticisms to the origin of the question/assertion processed by IQR C802A (UBEC User 106 or DIP 8316). If an assertion produced from AC C808A fails a significant measure of the self-criticism test processed by RA C811A; then a new instance of AC C808A is invoked to account for any valid criticisms. If a high confidence assertion is produced by AC C808A that consistently passes self-criticism tests processed by RA C811A; then the assertion is produced as LOM's 132 modular output, referenced as the Confident Security Assertion 8320 in context of the initial Prompt 8318 provided by DIP 8316.

FIG. 656 shows more detail of the internal operation procedure of Rational Appeal (RA) C811A of LOM 132 in regards to Stage 8304 of ASH 8044. Assertion Construction (AC) C808A provides a Response Presentation C843 to Rational Appeal (RA) C811A concerning the assertion produced by AC C808A in regards to the corresponding input Prompt 8268. At this stage of the logic flow, the produced assertion is classified as a Pre-Criticized Decision C847. This indicates that it is has yet to be processed via criticism by CTMP 124. Therefore the produced assertion is directly submitted to the CTMP 124 instance as a ‘Subjective Opinion’ C848 input, and also to Context Construction (CC) C817A which provides the ‘Objective Fact’ C850 input to the CTMP 124 instance. CC C817A references metadata from AC C808A and potential evidence provided via RIP 8266 to submit raw facts to CTMP 124 for critical thinking. Such input metadata is represented by the LOM Log Aggregate 5502 file. The LOM Log Aggregate 5502 contains a collection of relevant log files that are produced from the primary operating functions of LOM 132. After the CTMP 124 instance concludes it's operation, a Post-Criticized Decision C851 is produced as modular output. The initial Pre-Criticized Decision C847 and Post-Criticized Decision C851 are submitted to the Decision Comparison (DC) C818A module which determines the scope of potential overlap between the two inputs C847 and C851. The unified output provided by DC 818A can either indicate CTMP's 124 Concession C852 (of incorrectness) on behalf of the AC C808A produced assertion, or a perceived Improvement C853 on behalf of the AC C808A produced assertion. Both Argument Responses C852 and C853 can be classified as either Low Confidence Results C845 or High Confidence Results C846. A Low Confidence Result C845 indicates that the original assertion produced by AC C808A is flawed and should be reconstructed; therefore the logic flow continues to a new instance of AC C808A. A High Confidence Result C846 indicates that the original assertion produced by AC C808A has merit, therefore the drawn conclusions (coupled with any corresponding evidence, premises etc.) are submitted to Knowledge Validation (KV) C805A. Therefore the logic flow continues to a new instance of KV C805A so that CKR 846 and hence LOM 132 can benefit from the recently processed assertion.

FIG. 657 continues the logic flow of Stage 8304 from ASH 8044 to illustrate the production of the LOM Log Aggregate 5502 file. Modular outputs produced from Initial Query Reasoning (IQR) C802A, Survey Clarification (SC) C803A, Assertion Construction (AC) C808A, Hierarchical Mapping (HM) C807A and Knowledge Validation (KV) C805A are submitted to the LOM Modular Log Collection (LMLC) 5500 module. Therefore LMLC 5500 combines the input log data into a single readable file referenced as LOM Log Aggregate 5502. The File 5502 encompasses the overall operational state of the corresponding LOM 132 instance, hence providing information as to how the LOM 132 instance reached various conclusions. The LOM Log Aggregate 5502 is submitted to CC C817A of Rational Appeal (RA) C811A.

FIG. 658 expands on operational details concerning FIG. 657 to illustrate the internal operation of CTMP 124 in regards to the input and output channels defined in Rational Appeal (RA) C811A. The Pre-Criticized Decision C847 is Presented C843 as modular output from Assertion Construction (AC) C808A. The Decision C847 is then marked as a Subjective Opinion C848, therefore fulfilling one of the two major inputs of CTMP 124. The Subjective Opinion C848 is submitted to Input System Metadata C484, which acts as the primary modular input for CTMP 124 and an internal representation of the Selected Pattern Matching Algorithm (SPMA). For this instance configuration; the SPMA is LOM 132. Input System Metadata C484 is submitted for processing to Reason Processing C456 and to Raw Perception Production (RP²) C465. Reason Processing C456 will logically understand the assertions being made by comparing property attributes. RP² C465 parses the Input System Metadata C484 from LOM 132 to produce a perception in Perception Complex Format (PCF) that represents the algorithmic perception of LOM 132. Such a produced Perception is submitted to the Perception Observer Emulator (POE) C475 which emulates the algorithmic perception of LOM 132. Reason Processing C456 invokes Rule Processing which eventually produces rulesets that reflect the SPMA algorithm which in this instance is LOM 132. Therefore two modes of ‘thinking’ are executed, ‘analogue’ perception and ‘digital’ ruleset processing. These two Branches C461 and C475 represent similitudes with intuition and logic. The results produced by both thinking Branches C461 and C475 are transferred to Critical Decision Output (CDO) C462, which evaluates any fundamental elements of conflict or corroboration between the results. Upon finding a high magnitude of internal corroboration, and a low magnitude of internal conflict CTMP 124 provides a binary Approve or Block decision, in regards to the initial input Subjective Opinion C848, that is referenced as a High Confidence Result C846. If there is a low magnitude of internal corroboration and a high magnitude of internal conflict CTMP 124 submits a ‘vote of no confidence’ which is referenced as a Low Confidence Result C845. Therefore the resultant output of CTMP 124 is considered the Post-Criticized Decision C851.

FIG. 659 shows more details concerning the invocation of Raw Perception Production (RP²) C465 within CTMP 124. LOM 132 produces the Confident Security Assertion 8320 by invoking Assertion Construction (AC) C808A. The Confident Security Assertion 8320 is then submitted to Stage 5506 of RP² C465 which unpacks the data to produce instances of a Debugging Trace C485 and Algorithm Trace C486 within the Input System Metadata C484 which originates from the corresponding AC C808A instance. Debugging Trace C485 is a coding level trace that provides variables, functions, methods and classes that are used along with their corresponding input and out variable type and content. The full function call chain (function trace: functions calling other functions) is provided. The Algorithm Trace C486 is a software level trace that provides security data coupled with algorithm analysis. The resultant security decision (approve/block) is provided along with a logistics trail of how it reached the Decision C847. The appropriate weight concerning each factor that contributed to producing the Decision C847 is included. Thereafter RP² C465 transfers the data concerning the produced perception result to Perception Observer Emulator (POE) C475 for processing.

FIG. 660 elaborates on the operation of Raw Perception Production (RP²) C465 from within CTMP 124. Initially Stage 5506 occurs, as it does on FIG. 659, to unpack the data to produce instances of a Debugging Trace C485 and Algorithm Trace C486 within the Input System Metadata C484 which originates from the corresponding AC C808A instance. At Stage 5508, Metric Processing C489 reverse engineers the variables from LOM 132 to extract perceptions from the artificial intelligence exhibited by LOM 132. Thereafter Input System Metadata C484 is processed by Stage 5510, which separates Metadata C484 into meaningful security cause-effect relationships via System Metadata Separation (SMS) C487. As also indicated by FIG. 659, RP² C465 transfers the data concerning the produced perception result to Perception Observer Emulator (POE) C475 for processing.

FIG. 661 elaborates on the operation of Perception Observer Emulator (POE) C475, include it's and Raw Perception Production's (RP²) C465 relation to Perception Storage (PS) C478. The operation of Metric Processing C489 and System Metadata Separation (SMS) C487 both lead to the production of Perceptions 5512/5514/5516 that are thereafter stored in PS C478. The resulting Perceptions 5512/5514/5516 represent LOM's 132 modular response of producing the Purpose Replacement 8258 via Assertion Construction (AC) C808A. RP² C465 produces a Comparable Variable Format datapoint which is fed into Storage Search (SS) C480 as search criteria. Thereafter SS C480 performs a lookup of PS C478 to find matches with already existing Perceptions stored in PS C478. The Results C716 of the execution SS C480 are produced which leads to a Weight Calculation C718. Such a Calculation C718 attempts to find the correct distribution of corresponding Perceptions from PS C478 to replicate and match the Comparable Variable Format which represent's the execution of the LOM 132 algorithm that produced Confident Security Assertion 8320.

FIG. 662 continues the Perception Observer Emulator (POE) C475 logic from FIG. 661. After the production of Results C716 from Storage Search (SS) C480, the Weight Calculation C718 completes to lead to the Application C729 of the Perceptions 5512/5514/5516 to make an active Approve C731 or Block C730 decision. The Purpose Replacement 8258 produced by LOM 132 and corresponding LOM Log Aggregate 5502 undergo Data Parsing C724 which causes Data Enhanced Logs C723 to be derived which are applied in the Application C729 to achieve an Interpretation Dichotomy 5518 of a Positive Sentiment (Approve) C731 or Negative Sentiment (Block) C730 with regards to the input Purpose Replacement 8258. Upon successful conclusion of the execution of Application C729 leads to an Override Corrective Action C476 which is processed by Critical Decision Output (CDO) C462 in parallel to the modular output of Rule Execution (RE) C461. The Self-Critical Knowledge Density (SCKD) C474 module estimates the scope and type of potential unknown knowledge that is beyond the reach of the reportable LOM Log Aggregate 5502. This way the subsequent critical thinking features of the processing CTMP 124 instance can leverage the potential scope of all involved knowledge, known and unknown directly by the instance.

FIG. 663 shows the Memory Web C460 process that operates in parallel to the execution of Perception Observer Emulator (POE) C475 in FIG. 661. The Confident Security Assertion 8320 produced by LOM 132 is submitted as modular input to Reason Processing C456. Reason Processing C456 processes how LOM 132 achieved the decision to produce the Confident Security Assertion 8320 in response to the Prompt 8318 provided by DIP 8316. The processing conclusion of Reason Processing C456 is the execution of Reason Processing C457, which defines the rules that are thirdly consistent with LOM's 132 execution behavior. If any inconsistencies are found in rule behavior with regards to LOM's 132 execution behavior, then currently existing rules are modified or new rules are added. Such rules are later used within the CTMP 124 instance to criticize decision making behaviors found within the corresponding LOM 132 instance. Critical Rule Scope Extender (CRSE) C458 then leverages known Perceptions to expand the ‘critical thinking’ scope of the rulesets, in effect enhancing the rulesets to produce Correct Rules C459. The Correct Rules C459 are then submitted as modular input to Rule Syntax Format Separation (RSFS) C499 from within the operating jurisdiction of Memory Web C460. RSFS C499 separates and organizes Correct Rules C459 by type. Therefore all actions, properties, conditions and objects are listed separately after RSFS C499 processing. This enables the CTMP 124 instance to discern what parts have been found in the Chaotic Field, and what parts have not. Chaotic Field Parsing (CFP) C535 combines and formats the LOM Log Aggregate 5502 into a single scannable unit referenced as the Chaotic Field. The Chaotic Field is submitted as modular input to Memory Recognition (MR) C501. MR C501 also receives the Original Rules C555 which is the execution result from RSFS C499. MR C501 scans the Chaotic Field provided by CFP C535 to recognize knowable concepts defined in Original Rules C555. This MR C501 instance execution produces Recognized Rule Segments C556. Thereafter Rule Fulfillment Parser (RFP) C498 receives individual parts of the Original Rules C555 that have been tagged according to their recognition or lack-thereof within the Chaotic Field by MR C501. RFP C498 can then logically deduce which whole ruleset (the combination of all of their parts) have been sufficiently recognized in the Chaotic Field to merit processing by Rule Execution (RE) C461. Upon successful conclusion of the execution of RE C461 leads to an Override Corrective Action C476 which is processed by Critical Decision Output (CDO) C462 in parallel to the modular output of Perception Observer Emulator (POE) C475.

FIG. 664 elaborates on the logic flow interaction between Perception Storage (PS) C478 and the Automated Perception Discovery Mechanism (APDM) C467. PS C478 contains four subsets of Perceptions: Deduced Unknown Angles of Perception C473, All Angles of Perception C472, Implied Angles of Perception C471, and Applied Angles of Perception C470. Applied Angles of Perception C470 are Perceptions that have been directly imported by studying algorithmic behavior of the Selected Pattern Matching Algorithm (SPMA), which in this instance is LOM 132. Implied Angles of Perception C471 are Perceptions that have been derived from Applied Angles of Perception C470 via modular execution of Implication Derivation (ID) C477 and APDM C467. All Angles of Perception C472 represents the entire scope of known Perceptions to the CTMP 124 instance that have not been included by Applied Angles of Perception C470 and Implied Angles of Perception C471. Deduced Unknown Angles of Perception C473 represents the scope of Perceptions that is expected to exist yet the CTMP 124 instance has yet to discover according to the Self-Critical Knowledge Density (SCKD) C474 module. ID C477 analyzes the individual metrics of Applied Angles of Perception C470 to deterministically derive Implied Angles of Perception C470, whilst APDM C467 creatively varies compositions of Angles of Perception C650 via the Creativity Module 112 to produce a New Iteration C653 that combines the initial two input Weights C652. Therefore all of the Angles of Perception C650 involved with APDM C467 processing correspond with and represent the Confident Security assertion 8320 that is produced by LOM's 132 Assertion Construction (AC) C808A module.

FIG. 665 elaborates on the operational details concerning the Critical Rule Scope Extender (CRSE) C458 of CTMP 124. A Rational Appeal (RA) C811A instance operates within LOM 132 and invokes Context Construction (CC) C817A to process the LOM Log Aggregate 5502 to Chaotic Field Parsing (CFP) C535. CFP produces a Chaotic Field from the modular output of CC C817A which is referenced by Memory Recognition (MR) C501. Current Rules C534 exhibits rulesets that are indicative of the current functioning state of the Selected Pattern Matching Algorithm (SPMA) which in this instance is LOM 132. Current Rules C534 is submitted as modular input to the Rule Syntax Derivation (RSD) C504 module, which is where logical ‘black and white’ rules are converted to metric based perceptions. Therefore the complex arrangement of multiple rules are converted into a single uniform perception that is expressed via multiple metrics of varying gradients. The modular output of RSD C504 is provided as modular input to Perception Matching (PM) C503. At PM C503; a Comparable Variable Format (CVF) unit is formed from the Perception received from RSD C504. The newly formed CVF is used to lookup relevant Perceptions in the Perception Storage (PS) C478 with similar indexes. The potential matches are submitted as modular input to Rule Syntax Generation (RSG) C505. RSG C505 receives previously confirmed perceptions which are stored in Perception format and accesses the Perception's internal metric makeup. The Perceptions are received from PS C478 which contains Previously Confirmed Perceptions C468. Such gradient-based measures of metrics are converted to binary and logical rulesets that emulate the input/output information flow of the original perception. Therefore RSG C505 produces Perceptive Rules C537 which are Perceptions that are considered relevant, popular and have been converted into logical rules. If a Perception (in it's original Perception Format) had many complex metric relationships that defined many ‘grey areas’, the ‘black and white’ local rules encompass such ‘grey’ areas by expanding on the ruleset complexity. Therefore the Perceptive Rules C537 are stored by a collection of Rule Syntax Format (RSF) definitions. Perceptive Rules C537 are submitted as modular input to Memory Recognition (MR) C501, where they are scanned against the Chaotic Field which was produced by CFP C535. Therefore MR C501 produces Extra Rules C536 which complete Correct Rules C533 in their validity.

FIG. 666 elaborates on the operational details concerning Implication Derivation (ID) C477 of CTMP 124. The Applied Angles of Perception C470 from Perception Storage (PS) C478 are submitted as modular input to ID C477 to produce more Perceptions that belong to Implied Angles of Perception C471. The Applied Angles of Perception C470 are specifically sent to Metric Combination C493 of ID C477. Metric Combination C493 separates the received Angles of Perception C650 into categories of metrics: Scope C739, Type C740, Consistency C741, Intensity C742. The Metric availability and reference within the system is not necessarily limited to these four types. The input Angles of Perception C650 are related to the Purpose Replacement 8258 that was produced by LOM's 132 Assertion Construction (AC) C808A module. The Metric Complexity Set A C736 is submitted as modular input to Metric Expansion (ME) C495. With ME C495 the metrics of multiple and varying Angles of Perception C650 are stored categorically in individual databases C739/C740/C741/C742. ME C495 enhances the current batch of received metrics with details/complexity extracted from previously known/encountered metrics. Upon enhancement and complexity enrichment completion, the metrics are returned as ME C495 modular output as Metric Complexity Set B C737 and thereafter converted back into Angles of Perception C650 to be stored in Implied Angles of Perception C471 as illustrated on FIG. 667.

FIG. 667 continues the logic flow of Implication Derivation (ID) C477 from FIG. 666, illustrating the Metric Complexity Set B C737 being processed by Metric Conversion C494 which reverses individual metrics back into whole Angles of Perception C650. Despite the enrichment and conversion process performed by ID C477, the resultant Angles of Perception C650 still provide a reasonably accurate representation of the Purpose Replacement 8258 produced by LOM's 132 Assertion Construction (AC) C808A module. Therefore the Metric Conversion C494 process submits the newly derived/implied Angles of Perception C650 to Implied Angles of Perception C471 within Perception Storage (PS) C478.

FIG. 668 elaborates on the operational details concerning Critical Decision Output (CDO) C462 of CTMP 124. CDO C462 receives modular output from both major branches of CTMP 124: Perception Observer Emulator (POE) C475 (as the intuition branch) and Rule Execution (RE) C461 (as the logical branch). Each Branch C475/461 submits it's respective Critical Decision C521 (the main modular output) as well as corresponding the ‘Meta-metadata’ C521, which provides contextual variables that justify why the initial critical decision was reached. Both Decision Sets C521 that represent the Perceptions C516 of POE C475 and the Fulfilled Rules C517 of RE C461 are submitted to the Metadata Categorization Module (MCM) C488. MCM C488 separates the Debugging and Algorithm Traces into distinct categories using traditional syntax based information categorization. Such categories can then be used to organize and produce distinct security responses with a correlation to security risks and subjects. The Intuitive Decision C514, which represents Perceptions C526 from POE C475, and the Thinking Decision C515, which represents Fulfilled Rules C517 from RE C461 are submitted by MCM C488 to the Internal Processing Logic 5520 of Direction Decision Comparison (DDC) C512. The Internal Processing Logic 5520 of DDC C512 checks for corroboration or conflict between the Intuitive Decision C514 and the Thinking Decision C515. DDC C512 references a ‘cutoff’ variable from Static Hardcoded Policy (SHP) 488. If the ‘cutoff’ variable is not reached for similarity between the Intuitive Decision C514 and the Thinking Decision C515 (i.e. 90%+), then the Cancel Direct Comparison 5524 directive occurs, which might lead the Terminal Output Control (TOC) C513 to eventually submit a Vote of No Confidence 5544 as shown on FIG. 669. The Cancel Direct Comparison 5524 stage implies that CTMP 124 was unable to act internally consistent in regards to the input Prompt 8268 from RIP 8266. If the ‘cutoff’ variable was sufficiently met according to the Internal Processing Logic 5520, then the Final Decision Output 5522 stage is invoked which combines both Decisions C514/C515 into a single modular output which is received and processed by TOC C513.

FIG. 669 continues the logic flow of Critical Decision Output (CDO) C462 from FIG. 668 and elaborates on the operational details of Terminal Output Control (TOC) C513. TOC C513 initiates with Prompt 5526, which checks if Direct Decision Comparison (DDC) C512 was able to provide a Final Decision Output 5522 (instead of the Cancel Direct Comparison 5524 directive). If the response to Prompt 5526 is Yes 5528, then the combined final decision provided by DDC C512 at Final Decision Output 552 is submitted as modular output of TOC C513 and hence as modular output of the entire CTMP 124 instance as the Final Critical Decision 5542 output. If the response to Prompt 5526 is No 5530, then Stage 5532 is invoked which it itself invokes the execution of Perception Matching (PM) 5532 and fetches the corresponding results. Fulfilled Rules C517 are extracted from the Critical Decision+Meta-metadata C521 of Rule Execution (RE) C461. The Rules C517 are converted to Perceptions by Rule Syntax Derivation (RSD) C504. PM 5532 then references Meta-metadata to determine, at Prompt 5534, if there was a strong internal overlap and corroboration of Perceptions used. If the response to Prompt 5534 is Yes 5538 this indicates a Vote of No Confidence 5544 on behalf on CTMP 124 as modular output. If the response to Prompt 5534 is No 5536 then Stage 5540 is activated, which selects the perceived least risky decision between the Intuitive Decision C514 and Thinking Decision C515. Therefore the Final Critical Decision 5542 is subsequently submitted as modular output to CDO C462, TOC C513, and CTMP 124. The logic at Stage 5534 occurs to determine if the lack of unity between the Intuitive Decision C514 and Thinking Decision C515 occurs because of a general lack of algorithmic confidence, or due to highly opposing points of view between the two. Therefore if the latter were to occur, a potential Final Critical Decision 5542 is still discernible as modular output. A Vote of No Confidence 5544 always leads to the Low Confidence Result C845 logic pathway within Rational Appeal (RA) C811A. The Final Critical Decision 5542 can either lead to a High Confidence Result C846 or Low Confidence Result C845 logic pathway within RA C811A, depending on the algorithmic confidence behind the Final Critical Decision 5542.

FIG. 670 shows Automated Research Mechanism (ARM) 134 processing based on Security Threat Scope 8322. ARM 134 which attempts to constantly supply CKR 648 with new knowledge to enhance LOM's 132 general estimation and decision making capabilities. Security Threat Scope 8322 is expected to eventually yield concepts that CKR 806 has low or no information regarding, as indicated by List of Requested Yet Unavailable Concepts C857B. With Concept Sorting & Prioritization (CSP) C821B; Concept definitions are received from three independent sources and are aggregated to prioritize the resources (bandwidth etc.) of Information Request (IR) C812B. Such a module IR C812B accesses relevant sources to obtain specifically defined information in this case Security Threat Scope 8322. Such information is defined according to concept type. Such source are indicated as Public News Source C857C (Public news articles i.e. Reuters, New York Times, Washington Post etc.), Public Data Archives C857D (Information aggregation collections i.e. Wikipedia, Quora etc.), and Social Media C857E (i.e. Facebook, Twitter feeds, etc.). The data provided by such information sources are received and parsed at Information Aggregator (IA) C821B according to what concept definition requested them. Relevant meta-data such as time of retrieval, source of retrieval are kept. Thereafter the information is sent to Cross-Reference Analysis (CRA) C814B where the information received is compared to and constructed considering pre-existing knowledge from CKR 648. This allows the new incoming information to be evaluated and validated according to what CKR 648 currently knows and doesn't know. Stylometric Scanning (SS) C808B is a supplemental module that allows CRA C814B to consider stylometric signatures will assimilating the new information with pre-existing knowledge from CKR 648. Missed Dependency Concepts C857F are concepts which are logically required to be understood as groundwork for comprehending an initial target concept. (i.e. to understand how trucks work, one must first research about and understand how diesel engines work). Such missing concepts are transferred to CSP C821B for processing. List of Active Concepts C857G are popular topics which are ranked as the most active within CKR 648. Such Concepts C857G are transferred to Creative Concept Generator (CCG) C820B and are then creatively matched (via Creativity Module 112) to produce new potential concepts. This mechanism depends on the possibility that one of these mixtures will yield new ranges of information from Sources C857C, C857D, C857E connected to IR C812B. Example of Stylometry Usage: The New Foreign Data C858A is marked as having come from a known CNN reporter. However, a very strong stylometric match with the signature of a military think tank is found. Therefore the content is primarily attributed within CKR 648 to the military think tank, and noted as having ‘claimed’ to be from CNN. This enables further pattern matching and conspiracy detection for later executions of the LOM logic (for example, distrusting future claims of content being from CNN). Assertion corroboration, conflicts and bias evaluations are thereafter assessed as if the content is from the think tank and not CNN.

FIG. 671 continues ASH 8044 from FIG. 670 at Stage 8302 Resultant new and unconfirmed information is stored and proceed in CKR 648. Central Knowledge Retention (CKR) 648, is where LOM's data-based intelligence is stored and merged. Units of information are stored in the Unit Knowledge Format (UKF) C854F. UKF C854F is composed of a chain of UKF variants linked to define jurisdictionally separate information (time and source are dynamically defined). Knowledge UKF Clusters C854F are processed by KCA C816D to form Security Threat Concept 8323. Knowledge Corroboration Analysis (KCA) 816D is where UKF Clustered information is compared for corroborating evidence concerning an opinionated stance. This algorithm takes into consideration the reliability of the attributed source, when such a claim was made, negating evidence etc. Therefore after processing of KCA C816D is complete, CKR 648 can output a concluded Opinionated stance on a topic 8322.

FIG. 672 continues ASH 8044 form FIG. 671 with elaboration of ARM 134 and CKR 648. List of Active Concepts C857G are popular topics which are ranked as the most active within CKR 648. Such Concepts C857G are transferred to Creative Concept Generator (CCG) C820B and are then creatively matched (via Creativity Module 112) to produce new potential concepts.

FIG. 673 shows Stage 8034 where LOM extracts meaningful assertions and conclusions concerning security, therefor producing Security Threat Knowledge which is submitted to AST 123 for reference at Stage 8308. AST 123 receives the Security Exploit Derivation (SED) 8324 (security ruleset) which is tested with an artificial exploit, wherein after the exploit is performed, result feedback module provides the result if the exploit worked and if it should be incorporated into the Exploit DB A192, wherein the information release module provides details to the Creativity 112 module for how the next exploit should look like, wherein information is merged between the information release module and the Exploit DB A192, wherein the exploit is performed as a Compiled Security Exploit Batch A193 and simultaneously with the same exploit, wherein the creativity module produces a hybrid exploit that uses the strengths of prior exploits and avoids known weaknesses in exploits based on result by the information release module.

FIG. 674 continues ASH 8044 from FIG. 673 where the Security Threat Knowledge 8306 received from LOM to AST 123. At Stage 8326 the latest version of AST 123, which has been enhanced by LOM 132, is referenced by I2GE 122 and LIZARD 120.

FIG. 675 continues ASH 8044 from FIG. 674 with details on LIZARD 120 processing AST 123.

The Static Core C315 is where predominantly fixed program modules have been hard coded by human programmers. The Iteration Module C314 intelligently modifies, creates and destroys modules on the Dynamic Shell C198. Uses Artificial Security Threat (AST) 123 for a reference of security performance and uses Iteration Core C347 to process the automatic code writing methodology. The Iteration Core C314 is the main logic for Iterating the Dynamic Shell C198 for security improvements. With Static Core Cloning C346 the Static Core C315, including the semi-dynamic Outer Core C329, is used as a criterion for iteration guidance. Malware behavior information is transferred via the Data Return Relay (DRR) C317 to the AST 123 to benefit future iterations.

FIG. 676 continues ASH 8044 from FIG. 675 with details on LIZARD processing AST 123. Within Static Core C315 Security Ruleset 5562 provides Result Feedback 5564 and Information Release 5566 back to AST 123. Artificial Security Threat (AST) 123 provides a hypothetical security scenario to test the efficacy of security rulesets. Security threats are consistent in severity and type in order to provide a meaningful comparison of security scenarios.

FIG. 677 continues ASH 8044 from FIG. 676 with details on I2GE processing AST 123. AST 123 is received at C867A which sends a report 5572 to Security Review Module 5568 and through Send More 5570 back to AST 123. I2GE 122 has Iterative evolution parallel evolutionary pathways that are matured and selected. Iterative generations adapt to the same Artificial Security Threats (AST) 123, and the pathway with the best personality traits ends up resisting the security threats the most. Evolutionary Pathway C867A: A virtually contained and isolated series of ruleset generation. Evolutionary characteristics and criterion are defined by such Pathway X Personality C867D.

FIG. 678 continues ASH 8044 processing with LIZARD 120 receiving the Execution Stream (code) of the Target Appchain 6060 from ESC 6700 at Stage 8328. At Stage 8330 LIZARD loops through invocations of the Iteration Module, which makes reference to AST 123. Stage 8332 once considered stable whilst under attack of AST 123, LIZARD 120 sends the Execution Stream (code) to I2GE 122 for Varied Emulation.

FIG. 679 continues ASH 8044 with LIZARD 120 performing Execution 556 of the Target Appchain 6060 received through ESC 6700. The Iteration Module (IM) C314 intelligently modifies, creates and destroys modules on the Dynamic Shell C198. Uses Artificial Security Threat (AST) 123 for a reference of security performance and uses Iteration Core C347 to process the automatic code writing methodology. The Iteration Core C347 is the main logic for Iterating the Dynamic Shell C198 for security improvements. The Iteration Module (IM) C314 uses the Static Core (SC) C315 to syntactically modify the code base according to the defined purpose in data.

FIG. 680 continues ASH 8044 with I2GE 122 performing Iterative Evolution (a subset of I²GE 122) which is the method in which parallel Evolutionary Pathways C867AA and C867AB are matured and selected. Evolutionary Pathways 34C867AA and C867AB are a virtually contained and isolated series of ruleset generations. Evolutionary characteristics and criterion are defined by such Pathway Personality C867DB and C867DA. Iterative generations adapt to the same AST 123, and the pathway with the best personality traits ends up resisting the concept threats the most. By using Virtual Isolation 390 both evolutionary pathways are virtually isolated to guarantee that their iterations are based solely from the criteria of their own personalities. The Monitoring/Interaction System C868D is the platform that injects conceptual data danger triggers from the AST 123.

FIG. 681 shows ASH 8044 at Stage 8332 Once considered stable whilst under attack of AST 123, LIZARD 120 sends the Execution Stream (code) to I2GE 122 for Varied Emulation. I2GE 122 receives the hardened Execution Stream (code) of the Target Appchain 6060 at Stage 8334 and I2GE 122 performs Varied Emulation of the code with AST 123 via Evolutionary Pathways at Stage 8336. At Stage 8338 it checks to see Does the Execution Stream (code) pass the Varied Emulation of I2GE? Passes 8348 and Does Not Pass 8342.

FIG. 682 continues ASH 8044 from FIG. 181 with I2GE 122 performing Iterative Evolution (a subset of I²GE 122) which is the method in which parallel Evolutionary Pathways C867AA and C867AB are matured and selected. Evolutionary Pathways 34C867AA and C867AB are a virtually contained and isolated series of ruleset generations. Evolutionary characteristics and criterion are defined by such Pathway Personality C867DB and C867DA. Iterative generations adapt to the same AST 123, and the pathway with the best personality traits ends up resisting the concept threats the most. By using Virtual Isolation 390 both evolutionary pathways are virtually isolated to guarantee that their iterations are based solely from the criteria of their own personalities. The Monitoring/Interaction System C868D is the platform that injects conceptual data danger triggers from the AST 123. Iteration Conclusion Processor 5554 provides the output results: Passes 8348 and Does Not Pass 8342 (FIG. 682 is missing labels 8348 and 8342).

FIG. 683 concludes the Appchain Security Hardening (ASH) 8044 process. At Stage 8338 Does the Execution Stream (code) pass the Varied Emulation of I2GE? 120. If it does not Pass 8342, Execution Stream (code) is recent to LIZARD to be reprogrammed according to LOM's 132 criteria as understood via AST 123 at Stage 8346. If it Passes 8340 at Stage 8344 Create a Deployment Patch that contains the hardened security configurations through Deployment Patch Assembly (DPA) 6260 and at Stage 8348 Deploy the Appchain Correction Patch 6270 to Customchain Ecosystem Builder (CEB) 584 for the Target Appchain 6060.

FIG. 684 shows Appchain Regulatory Compliance (ARC) 8046 which ensures that the selected Appchain 836 or Legacy Program is in compliance with various and specific regulations (e.g., compliance to REST API etc.). At Stage 8350 LIZARD 120 interprets Syntax of Target Appchain 6060 via Syntax Module C35 and it produces a Purpose Hierarchy Map (PHM) 8354 of the Target Appchain 6060 via the Purpose Module C36 at Stage 8352. At Stage 8358 LIZARD 120 interprets Syntax of System Regulations and Guidelines and produces a Purpose Hierarchy Map (PHM) 8362 of the System Regulations and Guidelines via the Purpose Module C36.

FIG. 685 shows details concerning the operation of LIZARD 120 to convert the System Regulations and Guidelines 8356 into a Purpose Hierarchy Map 8362. The System Regulations and Guidelines 8356 is submitted from LUIGI 116 to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The System Regulations and Guidelines 8356 is received in Data Stream A0 6550 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 686 continues the logic flow from FIG. 685 to illustrate the operation of LIZARD 120 to convert the System Regulations and Guidelines 8356 into a Purpose Hierarchy Map 8362. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 8362 which is presented as the Complex Purpose Format C325 version of the System Regulations and Guidelines 8356. The same definition and application of Inner Core (IC) C333 applies for the aforementioned functions and modules.

FIG. 687 continues the logic flow from FIG. 686 and at Stage 8364 utilizes Purpose Hierarchy Map 8362 (received from System Regulations and Guidelines 8356) and Purpose Hierarchy Map 8354 (received from Target Appchain 6060) to determine if any of the Purposes within the Map derived from the Target Appchain 6060 conflict with any of the System Regulations and Guidelines Purposes? within Purpose to Purpose Symmetry Processing (P2SP) 7000. If No Conflicts Found 8366, the Target Appchain 6060 is compliant with System Regulations and Guidelines 8356 at Stage 8370. If Conflicts Found 8368, at Stage 8372 LUIGI 116 is informed of Appchain violation of System Regulations and Guidelines 8356.

FIG. 688 continues the logic flow from FIG. 687 at Stage 8374 to determine if LUIGI 116 has independently confirmed that the Appchain in question is in violation of the System Regulations and Guidelines 8356. If Confirmed 8375, Adjust the Purpose Hierarchy Map 8354 of the Target Appchain 6060 to mach the Purpose Hierarchy Map 8362 of the System Regulations and Guidelines 8356. If Unconfirmed 8378, A review session is initiated to find out why ARC 8046 (hence SPSI 130) and LUIGI 116 don't agree about the Appchain's compliance.

FIG. 689 continues the logic flow from FIG. 688 at Stage 8380 Adjusting the Purpose Hierarchy Map 8354 of Target Appchain 6060 to match the Purpose Hierarchy Map 8362 of the System Regulations and Guidelines 8356 based on 8376 Confirmed within PRP 7050. PRP 7050 sends the Upgraded Purpose Map 8382 to LIZARD 120. LIZARD 120 converts the Upgraded Purpose map into Appchain Syntax for deployment to Upgraded Appchain 6262.

FIG. 690 shows details concerning the operation of LIZARD 120 to convert the Upgraded Purpose Map 8382 into an Upgraded Appchain 6262. The Upgraded Purpose Map 8382 exists in Complex Purpose Format C325 and is submitted to Iterative Expansion C327 of the Purpose Module C36 within the Outer Core (OC) C329 of LIZARD 120. Iterative Expansion C327 adds detail and complexity to evolve a simple goal into a specific complex purpose definition. Therefore the maximum Purpose Association C326 potential of the input is realized, and retained as a Complex Purpose Format C325, before it is submitted to Logical Derivation C320 of the Syntax Module (SM) C35. The Core Code C335 element of Inner Core (IC) C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 691 continues the logic flow from FIG. 690 to illustrate the operation of LIZARD 120 to convert the Upgraded Purpose Map 8382 into an Upgraded Appchain 6262. The input data is received in Complex Purpose Format C325 from the Purpose Module (PM) C36 and is transferred to Logical Derivation C320 of the Syntax Module (SM) C35. Logic Derivation C320 derives logically necessary functions from initially simpler functions. This means that if a function can be formed as a derivative function due to implication from a simpler parent function; then it is formed by Logical Derivation C320. The produced result is a tree of function dependencies that are built according to the defined Complex Purpose Format C325 data. Logical Derivation C320 operates according to the Rules and Syntax C322 definitions which are inherited from the Core Code C335 element of Inner Core (IC) C333. Logical Derivation C320 submits it's output to Code Translation C321. Code Translation C321 converts arbitrary (generic) code which is recognized and understood by SM C35 to any known and chosen computation language. Code Translation C321 also performs the inverse function of translating known computation languages into arbitrary syntax types. Therefore PM C36 invokes SM C35 to produce the resultant Appchain Syntax version of the input Upgraded Purpose Map 8382 via Code Translation C321. The resultant Upgraded Appchain 6262 that is terminally produced by Code Translation C321 is the modular output of SM C35, Outer Core (OC) C329, and LIZARD 120.

FIG. 692 continues the logic flow from FIG. 691 to illustrate the operation of LIZARD 120 to convert the Upgraded Purpose Map into Appchain Syntax 8384 to create the Upgraded Appchain 6262. Deployment Patch Assembly (DPA) 6260 module creates the Appchain Correction Patch 6270 and at Stage 8386 Deploy Appchain Correction Patch 6270 to CEB 584 its deployed to Customchain Ecosystem Builder (CEB) 584.

FIG. 693 shows the Diagnostic Log Unit Analysis (DLUA) 8048 which processes the diagnostic information found in the DLU 1160. At Stage 8388 Receive DLU 1160 from LOM's 132 submodule ARM 134 and store them in CKR 648 and Filter in the Logs that are related to crashes/bugs/errors/problems etc. at Stage 8390. At Stage 8396 Derive the context for all error related Logs via reference of other Logs found in CKR 648. LIZARD 120 derives a Purpose Hierarchy Map 8398 for the current contextualized behavior containing error at Stage 8397 (mislabled as 8396 on FIG. 693)

FIG. 694 continues the logic flow from FIG. 693 to illustrate Stage 8400 Receive DLU 1160 from LOM's 132 submodule ARM 134 and store them in DLU 1182 (typo DLUR). Automated Research Mechanism (ARM) 134, which attempts to constantly supply CKR 648 with new knowledge to enhance LOM's general estimation and decision making capabilities. Information Request (IR) C812B module accesses relevant sources to obtain specifically defined information. Such information is defined according to concept type. Such source are indicated as Public News Source C857C (Public news articles i.e. Reuters, New York Times, Washington Post etc.), Public Data Archives C857D (Information aggregation collections i.e. Wikipedia, Quora etc.), and Social Media C857E (i.e. Facebook, Twitter feeds, etc.). The data provided by such information sources are received and parsed at Information Aggregator (IA) C818B according to what concept definition requested them. Relevant meta-data such as time of retrieval, source of retrieval are kept. Thereafter the information is sent to Cross-Reference Analysis (CRA) C814B where the information received is compared to and constructed considering pre-existing knowledge from CKR 648. This allows the new incoming information (DLU 1182) to be evaluated and validated according to what CKR 648 currently knows and doesn't know. Stylometric Scanning (SS) 808B is a supplemental module that allows CRA C814B to consider stylometric signatures will assimilating the new information with pre-existing knowledge from CKR 648.

FIG. 695 continues the logic flow from FIG. 694 to illustrate Stage 8402 Filter in the Logs that are related to crashes/bugs/errors/problems, etc. At Stage 8404 it requests DLU based information that relates to crashes/bugs/errors/problem etc. via UKF Cluster Filtering 5578. UKF Cluster Retention C854F provides input to UKF Cluster Filtering 5578. Central Knowledge Retention (CKR) 648, which is where LOM's 132 data-based intelligence is stored and merged. Units of information are stored in the Unit Knowledge Format (UKF) of which there are three types: UKF1 5580, UKF2 5582, UKF3 5584. UKF2 5582B is the main format where the targeted information is stored in Rule Syntax Format (RSF) C538, highlighted as Value 5592. Index 5586 is a digital storage and processing compatible/complaint reference point which allows for resource efficient references of large collections of data. This main block of information references a Timestamp 5590, which is a reference to a separate unit of knowledge via Index 5586 known as UKF1 8550. Such a unit does not hold an equivalent Timestamp 5590 section as UKF2 5582 did, but instead stores a multitude of information about timestamps in the Value 5592 sector in RSF C538 format. Rule Syntax Format (RSF) C538 is a set of syntactical standards for keeping track of references rules. Multiple units of rules within the RSF C538 can be leveraged to describe a single object or action. UKF1 5580 contains a Source Attribution 5588 sector, which is a reference to the Index 5586 of a UKF3 5584 instance. Such a unit UKF3 5584 is the inverse of UKF1 5580 as it has a Timestamp section but not a Source Attribution section. This is because UKF3 5584 stored Source Attribution 5588 and 5588 content in it's Value 5592 sector in RSF C538. Source attribution is a collection of complex data that keeps track of claimed sources of information. Such sources are given statuses of trustworthiness and authenticity due to corroborating and negating factors as processed in Knowledge Corroboration Analysis (KCA) C816D. Therefore a UKF Cluster 5581 (not labeled on FIG. 695) is composed of a chain of UKF variants linked to define jurisdictionally separate information (time and source are dynamically defined). In summary: UKF2 5582 contains the main targeted information. UKF1 5580 contains Timestamp information and hence omits the timestamp field itself to avoid an infinite regress. UKF3 5584 contains Source Attribution information and hence omits the source field itself to avoid an infinite regress. Every UKF2 5582 must be accompanied by at least one UKF1 5580 and one UKF3 5584, or else the cluster (sequence) is considered incomplete and the information therein cannot be processed yet by LOM (Systemwide General Logic). In between the central UKF2 5582 (with the central targeted information) and it's corresponding UKF1 5580 and UKF3 5584 units there can be UKF2 5582 units that act as a linked bridge. Knowledge Corroboration Analysis (KCA) C816D is where UKF Clustered information is compared for corroborating evidence concerning an opinionated stance. This algorithm takes into consideration the reliability of the attributed source, when such a claim was made, negating evidence etc. CKR 648 never deletes information since even information determined to be false can be useful for future distinction making between truth and falsehood.

FIG. 696 continues the logic from FIG. 695 at Stage 8396 to Derive the context for all error related Logs via reference of other Logs found in CKR 648. Loops through all error related logs at Stage 8406 and retrieves Log based information from CKR 648 relating to the selected error log at Stage 8408. At Stage 8410 the contextualized behavior is added to Error Related Log Retention (ERLR) 8412.

FIG. 697 shows Diagnostic Log Unit Analysis (DLUA) 8048 at Stage 8414 where LIZARD 120 derives a Purpose Hierarchy Map 8416 for the current contextualized behavior containing errors and at Stage 8418 the part of the Execution Stream (code) that is producing the error is retrieved from the Target Appchain 6060. The selected part of the Execution Segment (code) is processed via a custom invocation of Innate Error Correction (IEC) 8050 at 8420. The Refined Execution Segment 8422 is executed in a virtualized environment of I2GE 122 within the entire Execution Stream to test for inanely correct execution at Stage 8424.

FIG. 698 shows details concerning the operation of LIZARD 120 to convert the full contents of Error Related Log Retention (ERLR) 8430 into a Purpose Hierarchy Map 8428. The contents of Error Related Log Retention (ERLR) 8430 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The Error Related Log Retention (ERLR) 8430 is received in Data Stream A0 6550 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 699 continues the logic flow from FIG. 698 to illustrate the operation of LIZARD 120 to convert the full contents of Error Related Log Retention (ERLR) 8430 into a Purpose Hierarchy Map 8428. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 8428 which is presented as the Complex Purpose Format C325 version of the Error Related Log Retention (ERLR) 8430. The same definition and application of Inner Core (IC) C333 applies for the aforementioned functions and modules.

FIG. 700 shows Diagnostic Log Unit Analysis (DLUA) 8048 Stage 8418 The part of the Execution Segment (code) that is producing the error is retrieved from the Target Appchain 6060. At Stage 8432 it Loops through all Contextualized Error Related Logs from Error Related Log Retention (ERLR) 8430 in order of Appchain and performs a check 8434 Has the associated Appchain of the selector Error Related Log been retrieved? If Yes 8438 it performs 8444 Is location information concerning the selected Error Related Log found in the Scanned. If No 8436, it retrieves the Appchain Location via Appchain Cache Location from the Metachain 8440 and generates request(s) for the contents of the Appchain via Content Claim Generator (CCG) 3050.

FIG. 701 continues the logic from FIG. 700 at Stage 8456 Scan the Execution Segment of the Execution Stream for details that relates to the information stored in the Logs from ERLR 8430 and Scanned Metadata Concerning Execution Stream 8458. At Stage 8450 check if location information concerning the selected Error Related Log found in the Scan? If Yes, 8452, proceed to Stage 8420 The selected part of the Execution Segment (code) is processed via a custom invocation of Innate Error Correction (IC) 8050. If No, 8454, proceed to Stage 8446 Advance the loop to the next available contextualized error and Loop through all Contextualized Error Related Logs from ERLR 8430 in order of Appchain at Stage 8448.

FIG. 702 continues the logic from FIG. 701 with Stage 8460 The Refined Execution Stream Segment 8462 is executed in a virtualized environment of I2GE 122 within the entire Execution Stream to test for innately correct execution. At Stage 8466 a check is made Did the Refined Execution Segment operate properly? If Yes, 8468, LIZARD derives a Purpose Hierarchy Map for the Refined Execution Segment 8462 at Stage 8464. If No, 8470 a check is made at Stage 8476 Was this instance of DLUA invoked by a DLU origination from DLUA? if Yes, 8474 at Stage 8477 (mislabled 8476 on FIG. 702) Terminate module execution with modular output of null. If No, 8472, Submit Meta-DLU to DLU 1182.

FIG. 703 continues the logic from FIG. 702 with Stage 8420 The selected part of the Execution Segment (code) is processed via a custom invocation of Innate Error Correction (IEC) 8050. The Refined Execution Stream Segment 8462 is installed in it's appropriate place within the Execution Stream 556. The Refined Execution Stream is sent to I2GE 122 for emulation processing at 8480.

FIG. 704 continues the logic from FIG. 703 with Stage 8460 The Refined Execution Stream Segment 8462 is executed in a virtualized environment of I2GE 122 within the entire Execution Stream to test for innately correct execution. Refined Execution Stream A0 8480 is received by Evolution Pathway A C867AA and Evolution Pathway B C867AB to initiate the process. I2GE 122 performs Iterative Evolution (a subset of I²GE 122) which is the method in which parallel Evolutionary Pathways C867AA and C867AB are matured and selected. Evolutionary Pathways 34C867AA and C867AB are a virtually contained and isolated series of ruleset generations. Evolutionary characteristics and criterion are defined by such Pathway Personality C867DB and C867DA. Iterative generations adapt to the same AST 123, and the pathway with the best personality traits ends up resisting the concept threats the most. By using Virtual Isolation 390 both evolutionary pathways are virtually isolated to guarantee that their iterations are based solely from the criteria of their own personalities. The Monitoring/Interaction System C868D is the platform that injects conceptual data danger triggers from the AST 123. Iteration Conclusion Processor 5554 provides the output results: Yes 8384 and No 8342.

FIG. 705 continue the logic from FIG. 704 with LIZARD 120 driving a Purpose Hierarchy Map 8488 for the current contextualized behavior containing errors at Stage 8486. Adjusting the Purpose Hierarchy Map 8488 of the Target Appchain to include the Map 8494 of the Refined Execution Segment at Stage 8490 within Purpose Realignment Processing (PRP) 7050 to produce the Upgraded Purpose Map 8496. LIZARD also derives a Purpose Hierarchy Map 8494 for the Refined Execution Segment 8462 at Stage 8492. Adjusting the Purpose Hierarchy Map 8488 of the Target Appchain to include the Map of the Refined Execution Segment at Stage 8490 within Purpose Realignment Processing (PRP) 7050 to produce the Upgraded Purpose Map 8496. LIZARD also derives a Purpose Hierarchy Map 8494 for the Refined Execution Segment 8462 at Stage 8492.

FIG. 706 shows details concerning the operation of LIZARD 120 to convert the Contextualized Error Log 8500 into a Purpose Hierarchy Map 8502. The Contextualized Error Log 8500 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The Contextualized Error Log 8500 is received in a mixed Execution/Data Stream 8501 format by Code Translation C321. Code Translation C321 converts arbitrary (generic) code which is recognized and understood by SM C35 to any known and chosen computation language. Code Translation C321 also performs the Inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 707 continues the logic flow from FIG. 706 to illustrate the operation of LIZARD 120 to convert the full contents of Contextualized Error Log 8500 into a Purpose Hierarchy Map 8502. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 8502 which is presented as the Complex Purpose Format C325 version of the Contextualized Error Log 8500. The same definition and application of Inner Core (IC) C333 applies for the aforementioned functions and modules.

FIG. 708 shows details concerning the operation of LIZARD 120 to convert the Refined Execution Segment 8462 into a Purpose Hierarchy Map 8494. The Refined Execution Segment 8462 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The Refined Execution Segment 8462 is received in Execution Stream format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 709 continues the logic flow from FIG. 708 to illustrate the operation of LIZARD 120 to convert the Refined Execution Segment 8462 into a Purpose Hierarchy Map 8494. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 8494 which is presented as the Complex Purpose Format C325 version of the Contextualized Error Log 8500. The same definition and application of Inner Core (IC) C333 applies for the aforementioned functions and modules.

FIG. 710 shows Diagnostic Log Unit Analysis (DLUA) 8048 at Stage 8490 Adjust the Purpose Hierarch Map of the Target Appchain to include the Map of the Refined Execution Segment at Purpose Realignment Processing (PRP) 7050. LIZARD converts the Upgraded Purpose Map 8496 into Appchain Syntax at Stage 8500. Upgraded Appchain 6262 is submitted to Deployment Patch Assembly (DPA) 6260 and at Stage 8502 Deploys Appchain Correction Patch to Customchain Ecosystem Builder (CEB) 584.

FIG. 711 shows New Appchain Development (NAD) 8052 where LIZARD 120 drives a Purpose Hierarchy Map for the entire Customchain Ecosystem of the UBEC Platform 8506. It interprets areas within the Purpose Hierarchy Map of potential overlap, co-operation, and conflict 8508. Overlap Co-operation and Conflict Check (OC-3) 8520 is sent to OC3 Map 8522. LOM receives the OC3 Map 8510. New Proposed Changes 8512 received from OC3 8520 by Appchain Sorting Mechanism (ASM) 6066 and submitted to Principled Modification Actuation (PMA) 8620.

FIG. 712 shows details concerning the operation of LIZARD 120 to convert the entire Customchain Ecosystem of the UBEC Platform 100 into a Purpose Hierarchy Map 8506. The UBEC Platform 100 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The UBEC Platform 100 is received in a mixed Execution/Data Stream 8501 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 713 continues the logic flow from FIG. 712 to illustrate the operation of LIZARD 120 to convert the entire Customchain Ecosystem of the UBEC Platform 100 into a Purpose Hierarchy Map 8506. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 8506 which is presented as the Complex Purpose Format C325 version of the UBEC Platform 100. The same definition and application of Inner Core (IC) C333 applies for the aforementioned functions and modules.

FIG. 714 shows Overlap Co-operation and Conflict Check (OC3) 8520 where LIZARD processes the entire Purpose Hierarchy Map to categorize individual Purpose Elements into Purpose Bands 8522. Purpose Bands 8524 consist of Band A 8526, Band B, 8528, Band C 8530, and Band D 8532. Purpose Band Zone Organization (PBZO) 8536 receives the Purpose Bands 8524 and Organizes Purpose Bands into Common Zones 8534.

FIG. 715 shows details concerning the operation of LIZARD 120 to convert the Purpose Hierarchy Map 8506 into a series of Purpose Bands 8524. The Purpose Hierarchy Map 8506 exists in Complex Purpose Format C325 and is submitted to Iterative Expansion C327 of the Purpose Module C36 within the Outer Core (OC) C329 of LIZARD 120. Iterative Expansion C327 adds detail and complexity to evolve a simple goal into a specific complex purpose definition. Therefore the maximum Purpose Association C326 potential of the input is realized, and retained as a Complex Purpose Format C325, before it is submitted to Logical Derivation C320 of the Syntax Module (SM) C35. The Core Code C335 element of Inner Core (IC) C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 716 continues the logic flow from FIG. 715 to illustrate the operation of LIZARD 120 to convert the Purpose Hierarchy Map 8506 into a series of Purpose Bands 8524. The input data is received in Complex Purpose Format C325 from the Purpose Module (PM) C36 and is transferred to Logical Derivation C320 of the Syntax Module (SM) C35. Logic Derivation C320 derives logically necessary functions from initially simpler functions. This means that if a function can be formed as a derivative function due to implication from a simpler parent function; then it is formed by Logical Derivation C320. The produced result is a tree of function dependencies that are built according to the defined Complex Purpose Format C325 data. Logical Derivation C320 operates according to the Rules and Syntax C322 definitions which are inherited from the Core Code C335 element of Inner Core (IC) C333 and the Target System Library Collection 9442 via the Target System Interpretation Detection (TSID). Logical Derivation C320 submits it's output to Code Translation C321. Code Translation C321 converts arbitrary (generic) code which is recognized and understood by SM C35 to any known and chosen computation language. Code Translation C321 also performs the inverse function of translating known computation languages into arbitrary syntax types. Therefore PM C36 invokes SM C35 to produce the resultant Band version of the input Purpose Hierarchy Map 8506 via Code Translation C321. The resultant Purpose Bands 8524 unit that is terminally produced by Code Translation C321 is the modular output of SM C35, Outer Core (OC) C329, and LIZARD 120.

FIG. 717 shows Overlap Co-operation and Conflict Check (OC3) 8520. Purpose Band Zone Organization (PBZO) 8536 organizes Purpose Bands into Common Zones 8534 utilizing Zone A 8538, Zone B 8540, Zone C 8542 and Zone D 8544 by looping through each zone 8546.

FIG. 718 continues the logic flow from FIG. 717 to illustrate the operation of CTMP 124, LOM 132 and I2GE 122 to develop the OC3 Map 8522. The series of steps starts with 8546 Loop through each Zone, 8548 Loop through each Band of the selected Zone, 8550 Find the Purpose Elements that match the most, and 8552 Find the Appchain Jurisdictions of the Purpose Elements. LOM surveys the selected Appchain Jurisdictions as a collective unit regarding Design Principles compliance 8554 and New Proposed Changes 8558 are produced according to the survey conducted 8556 based on input from LOM 132 and I2GE 122. CTMP 124 and LOM 132 interact directly as needed for all interactions.

FIG. 719 continues the logic flow from FIG. 718 to illustrate the operation of LIZARD 120 to develop the OC3 Map 8522. LIZARD derives a Purpose Hierarch Map 8564 for the New Proposed Changes 8560 (based on survey conducted 8558). At 8566 Produce OC3 Map via Master/Slave Affinity 1480 within Purpose Realignment Processing (PRP) 7050 which receives the Purpose Hierarchy Map 8564 and Purpose Hierarchy Map 8568 from UBEC Platform 100 in order to create OC3 Map 8522. New Proposed Changes 8560 all also sent to Principled Modification Actuation (PMA) 8620.

FIG. 720 shows details concerning the operation of LIZARD 120 to convert New Proposed Changes 8560 into a Purpose Hierarchy Map 8564. The New Proposed Changes 8560 unit is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The New Proposed Changes 8560 unit is received in a mixed Execution/Data Stream 8501 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 721 continues the logic flow from FIG. 720 to illustrate the operation of LIZARD 120 to convert New Proposed Changes 8560 into a Purpose Hierarchy Map 8564. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 8564 which is presented as the Complex Purpose Format C325 version of the New Proposed Changes 8560. The same definition and application of Inner Core (IC) C333 applies for the aforementioned functions and modules.

FIG. 722 shows Overlap Co-operation and Conflict Check (OC3) 8520 in order to Find the Purpose Elements that match the cost 8550. The process begins by initiating (Zone A 8538) the Zone for processing 8570. Followed by Select a Purpose Element types 8572 and Isolate them from the Zone 8574 as shown in 8576.

FIG. 723 continues the logic flow from FIG. 722 for Overlap Co-operation and Conflict Check (OC3) 8520 in order to Find the Appchain Jurisdictions of the Purpose Elements 8552. As the Purpose Element types 8572 and Isolate them from the Zone 8574 as shown in 8576. have already occurred, it Removes Category References 8578 (as shown in 8580). Next 8582 Organize by Appchain Jurisdiction (as shown in 8584).

FIG. 724 continues the logic flow from FIG. 723 for Overlap Co-operation and Conflict Check (OC3) 8520 where LOM 132 surveys the selected Appchain Jurisdictions 8588 as a collective unit regarding Design Principle compliance 8554. At Stage 8586 Receive Appchain Jurisdictions 8588 are shown in 8584. At stage 8590 LIZARD derives a Purpose Hierarchy Map 8592 for the System Design Principles 5016 received from LOM 132 and CKR as an Appchain 648. At Stage 8594 LIZARD 120 derives a Purpose Hierarchy Map 8596 for the Appchain Jurisdictions 8588.

FIG. 725 shows details concerning the operation of LIZARD 120 to convert System Design Principles 5016 into a Purpose Hierarchy Map 8592. The System Design Principles 5016 unit is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The System Design Principles 5016 unit is received in a mixed Execution/Data Stream 8501 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 726 continues the logic flow from FIG. 725 to illustrate the operation of LIZARD 120 to convert System Design Principles 5016 into a Purpose Hierarchy Map 8592. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 8592 which is presented as the Complex Purpose Format C325 version of System Design Principles 5016. The same definition and application of Inner Core (IC) C333 applies for the aforementioned functions and modules.

FIG. 727 shows details concerning the operation of LIZARD 120 to convert Appchain Jurisdictions 8588 into a Purpose Hierarchy Map 8596. The Appchain Jurisdictions 8588 unit is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The Appchain Jurisdictions 8588 unit is received in a mixed Execution/Data Stream 8501 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 728 continues the logic flow from FIG. 727 to illustrate the operation of LIZARD 120 to convert Appchain Jurisdictions 8588 into a Purpose Hierarchy Map 8596. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 8596 which is presented as the Complex Purpose Format C325 version of Appchain Jurisdictions 8588. The same definition and application of Inner Core (IC) C333 applies for the aforementioned functions and modules.

FIG. 729 shows Overlap Co-operation and Conflict Check (OC3) 8520 where LOM Surveys the selected Appchain Jurisdictions 8588 as a collective unit regarding Design Principle compliance 8554. Purpose to Purpose Symmetry Processing (P2SP) 7000 receives System Design Principles 5016 via Purpose Hierarchy Map 8592 from LOM 132 through CKR 648. P2SP 7000 also receives Purpose Hierarch Map 8596 of Appchain Jurisdictions 8588. P2SP submits to Symmetry Processing Result 8598 which determines Does the Purpose Map of the Appchain Jurisdictions match the System Design Principles in their entirety 8600. Yes, it matches 8602 or No, it doesn't match 8604.

FIG. 730 continues the logic flow from FIG. 729 Overlap Co-operation and Conflict Check (OC3) 8520 where New Proposed Changes are produced according to the survey conducted 8558. At Stage 8600 it checks, Does the Purpose Map of the Appchain Jurisdictions match the System Design Principles in their entirety 8600. Yes, it matches 8602, No changes needed, terminate module execution with null output 8606. If No, it doesn't match 8604, Adjust the Purpose Hierarchy Map of the Appchain Jurisdictions to match the Map of the System Design Principles 8608 within Purpose Realignment Processing (PRP) 7050. LIZARD 120 converts the Upgraded Purpose Map 8610 into Appchain Syntax that is referenced as New Proposed Changes 8050 in Appchain Sorting Mechanism 6066. The Appchain Syntax is sorted into three different categories of Appchains via ASM 6066.

FIG. 731 shows details concerning the operation of LIZARD 120 to convert the Upgraded Purpose Map 8610 into New Proposed Changes 8560. The Upgraded Purpose Map 8610 exists in Complex Purpose Format C325 and is submitted to Iterative Expansion C327 of the Purpose Module C36 within the Outer Core (OC) C329 of LIZARD 120. Iterative Expansion C327 adds detail and complexity to evolve a simple goal into a specific complex purpose definition. Therefore the maximum Purpose Association C326 potential of the input is realized, and retained as a Complex Purpose Format C325, before it is submitted to Logical Derivation C320 of the Syntax Module (SM) C35. The Core Code C335 element of Inner Core (IC) C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 732 continues the logic flow from FIG. 731 to illustrate the operation of LIZARD 120 to convert the Upgraded Purpose Map 8610 into New Proposed Changes 8560. The input data is received in Complex Purpose Format C325 from the Purpose Module (PM) C36 and is transferred to Logical Derivation C320 of the Syntax Module (SM) C35. Logic Derivation C320 derives logically necessary functions from initially simpler functions. This means that if a function can be formed as a derivative function due to implication from a simpler parent function; then it is formed by Logical Derivation C320. The produced result is a tree of function dependencies that are built according to the defined Complex Purpose Format C325 data. Logical Derivation C320 operates according to the Rules and Syntax C322 definitions which are inherited from the Core Code C335 element of Inner Core (IC) C333 and the Target System Library Collection 9442 via the Target System Interpretation Detection (TSID). Logical Derivation C320 submits it's output to Code Translation C321. Code Translation C321 converts arbitrary (generic) code which is recognized and understood by SM C35 to any known and chosen computation language. Code Translation C321 also performs the inverse function of translating known computation languages into arbitrary syntax types. Therefore PM C36 invokes SM C35 to produce the resultant Appchain Syntax version of the input Upgraded Purpose Map 8610 via Code Translation C321. The resultant New Proposed Changes 8560 unit that is terminally produced by Code Translation C321 is the modular output of SM C35, Outer Core (OC) C329, and LIZARD 120.

FIG. 733 shows Principled Modification Actuation (PMA) 8620 at 8614 where The Appchain Syntax is sorted into three different categories of Appchains via Appchain Sorting Mechanism (ASM) 6066. ASM 6066 provides categories: Appchains to Create 8622, Appchains to Modify 8624 (which go directly into CEB 584), and Appchains to Delete 8626 go through Appchain Deletion Mechanism (ADM) 8630 to Customchain Interface Module (CIM) 2470. LIZARD uses the Syntax Module to convert the new Appchain into Logistics Layer 582 format. All of the dependencies and supplement relationships that exist within the Upgraded Purpose Map have been preserved 8628. Logistics Layer 582 sends to Customchain Ecosystem Builder (CEB) 584.

FIG. 734 shows details concerning the operation of LIZARD 120 to convert Appchains to Create 8622 into a Logistics Layer 582. Appchains to Create 8622 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. Appchains to Create 8622 is received in a mixed Execution/Data Stream 8501 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 735 continues the logic flow from FIG. 734 to illustrate the operation of LIZARD 120 to convert Appchains to Create 8622 into a Logistics Layer 582. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Logistics Layer 582 which is presented as the Complex Purpose Format C325 version of Appchains to Create 8622 and further codified into a Logistics Layer 582 format. The Logistics Layer 582 is a macro arrangement of the syntax whilst the Complex Purpose Format C325 defines the micro arrangement of the syntax. The same definition and application of Inner Core (IC) C333 applies for the aforementioned functions and modules.

FIG. 736 shows Principled Modification Actuation (PMA) 8620 at 8614 The Appchain Syntax is sorted into three different categories of Appchains via ASM. ASM 6066 provides Appchains to Modify 8624 to PMA 8620 which loops through each Appchain 8632 and at 8634 Submits the selected Appchain to Advance the loop to the next available Appchain 8636 and Deployment Patch Assembly (DPA) 6260. DPA 6260 provides Appchain Correction Patch 6270 to Customchain Ecosystem Builder (CEB) 584 for the Target Appchain 6060.

FIG. 737 shows New Appchain Development (NAD) 8052 operation where LOM 132 receives the OC3 MAP 8522 at 8638 and LOM 132 references Creative Design Principles 8642 from CKR 648 at 8640. At Stage 8644 LOM 132 produces a Creative Potential Map 8646.

FIG. 738 continues the logic flow from FIG. 737 to illustrate New Appchain Development (NAD) 8052 operation where LOM 132 references Creative Design 8640 and LOM 132 produces a Creative Potential Map 8644. LOM 132 is invoked by the Design Principle Invocation Prompt (DPIP) 8648 to produce Creative Design Principles 8642. LOM 132 utilizes the CKR 648 to produce the Creative Design Principle 8642.

FIG. 739 continues the logic flow from FIG. 738 to illustrate New Appchain Development (NAD) 8052 operation where LOM 132 references Creative Design 8640 and LOM 132 produces a Creative Potential Map 8644. LOM 132 is invoked by the Creative Variance Invocation Prompt (CVIP) 8650 to produce Creative Design Principles 8642. The OC3 Map 8522 is split by LIZARD 120 into Processable Sections and stored in MSCR 8652.

FIG. 740 continues the logic flow from FIG. 739 to illustrate New Appchain Development (NAD) 8052 operation where The OC3 Map 8522 is split by LIZARD 120 into Processable Sections and stored in MSCR 8654. LIZARD converts the entire OC3 MAP 8522 from a Purpose Hierarchy Structure to Appchain Syntax 8658 at 8656. Appchains are highlighted according to their Execution Scope by Execution Scope Discovery (ESD) 8662 at Stage 8660. The Appchain Scope are stored in Execution Scope Cache Retention (ESCR) 8666 at Stage 8664. At Stage 8668 it Loops through each Execution Scope stored in ESCR 8666.

FIG. 741 shows details concerning the operation of LIZARD 120 to convert the OC3 Map 8522 into an Appchain Syntax Map 8658. The OC3 Map 8522 exists in Complex Purpose Format C325 and is submitted to Iterative Expansion C327 of the Purpose Module C36 within the Outer Core (OC) C329 of LIZARD 120. Iterative Expansion C327 adds detail and complexity to evolve a simple goal into a specific complex purpose definition.

Therefore the maximum Purpose Association C326 potential of the input is realized, and retained as a Complex Purpose Format C325, before it is submitted to Logical Derivation C320 of the Syntax Module (SM) C35. The Core Code C335 element of Inner Core (IC) C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 742 continues the logic flow from FIG. 741 to illustrate the operation of LIZARD 120 to convert the OC3 Map 8522 into an Appchain Syntax Map 8658. The input data is received in Complex Purpose Format C325 from the Purpose Module (PM) C36 and is transferred to Logical Derivation C320 of the Syntax Module (SM) C35. Logic Derivation C320 derives logically necessary functions from initially simpler functions. This means that if a function can be formed as a derivative function due to implication from a simpler parent function; then it is formed by Logical Derivation C320. The produced result is a tree of function dependencies that are built according to the defined Complex Purpose Format C325 data. Logical Derivation C320 operates according to the Rules and Syntax C322 definitions which are inherited from the Core Code C335 element of Inner Core (IC) C333. Logical Derivation C320 submits it's output to Code Translation C321. Code Translation C321 converts arbitrary (generic) code which is recognized and understood by SM C35 to any known and chosen computation language. Code Translation C321 also performs the inverse function of translating known computation languages into arbitrary syntax types. Therefore PM C36 invokes SM C35 to produce the resultant Appchain Syntax version of the input OC3 Map 8522 via Code Translation C321. The resultant Appchain Syntax Map 8658 unit that is terminally produced by Code Translation C321 is the modular output of SM C35, Outer Core (OC) C329, and LIZARD 120.

FIG. 743 shows New Appchain Development (NAD) 8052 where The OC3 Map is split by LIZARD 120 into Processable Sections and stored in MSCR 8652. Execution Scope Cache Retention (ESCR) 8672 Loops through each Execution Scope store in ESCR 8668. It extracts the Fulfilled Appchain 8686 from the Appchain syntax Map according to the Selected Execution Scope 8670. At Stage 8672 LIZARD converts the Fulfilled Appchain 8686 into a Purpose Hierarchy Map 8674 Format. At 8676 it stores the Purpose Hierarchy Map 8674 to MSCR 8652 and checks if there is an available Execution Scope left in the Loop? at Stage 8678. If No 8680, Terminates Look Execution 8684 and if Yes 8682, proceeds to Stage 8668.

FIG. 744 shows details concerning the operation of LIZARD 120 to convert Fulfilled Appchain 8686 into the Purpose Hierarchy Map 8688. Fulfilled Appchain 8686 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. Fulfilled Appchain 8686 is received in a mixed Execution/Data Stream 8501 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 745 continues the logic flow from FIG. 744 to illustrate the operation of LIZARD 120 to convert Fulfilled Appchain 8686 into the Purpose Hierarchy Map 8688. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Logistics Layer 582 which is presented as the Complex Purpose Format C325 version of Fulfilled Appchain 8686. The same definition and application of Inner Core (IC) C333 applies for the aforementioned functions and modules.

FIG. 746 shows New Appchain Development (NAD) 8052 where LOM produces a Creative Potential Map 8644. Overlap CO-operation and Conflict Check (OC3) 8520 inputs to OC3 Map 8522 within Map Segment Cache Retention (MSCR) 8652 which Loops through each Map Segment in Selected Map Segment 8691 at Stage 8690 and Submits the selected Map segment to Creative Variance Invocation Prompt (CVIP) 8650 at Stage 8692. At Stage 8693 LOM 132 and CTMP 124 produce a Creative Potential Unit 8694 as a modular.

FIG. 747 continues the logic flow from FIG. 746 to illustrate the operation of LOM 132 to produce a Creative Potential Map 8644. LOM 132 and CTMP 124 produce a Creative Potential Unit 8694 as modular at Stage 8693 and check to see 8695, Has a Creative Potential Map been initiated? If Yes 8696, it Finds the Section of the Creative Potential Map that corresponds with the Creative Potential Unit 8694 at Stage 8699. At 8700 it Replaces the corresponding Section in the Creative Potential Map 8646 with the Creative Potential Unit 8694. If No 8697, It Clones the OC3 Map 8522 into a Creative Potential Map 8646 at Stage 8698.

FIG. 748 continues the logic flow from FIG. 747 to illustrate the process of LOM 132 to produce a Creative Potential Map 8644. At Stage 8700 it Replaces the corresponding Section in the Creative Potential Map 8644 with the Creative Potential Unit 8694 and checks Are there any available Map Segments left in the loop? 8701. If No 8703, Submits the Creative Potential Map 8646 as modular output 8705. If Yes 8702, Advances the Loop to the next available Map Segment at 8704. At 8706 it Loops through each Map Segment in the Map at MSCR 8652.

FIG. 749 shows the internal operation procedure of LOM 132 and CTMP 124 in regards to Stage 8696 of New Appchain Development (NAD) 8052. The Creative Design Principles 8642, Selected Map Segment 8691, and OC3 Map 8522 are supplied as initial input to the Creative Variance Invocation Prompt (CVIP) 8650. CVIP 8650 produces a Prompt 8318 that interacts directly with LOM 132 to invoke the production of the Confident Security Assertion 8320 with consideration of the input criteria Theory of Security 8312, Unconfirmed Security Information 8314, and Confirmed Security Knowledge 8310. The Prompt 8651 produced by CVIP 8650 is submitted to the Initial Query Reasoning (IQR) C802A module of LOM 132. When LOM 132 is invoked directly within the UBEC Platform 100 by an UBEC User 106, IQR C802A receives the initial question/assertion provided by the UBEC User 106. However this instance of LOM 132 is automatically invoked by DIP 8316 instead. The provided Prompt 8318 is analyzed via invocation of Central Knowledge Retention (CKR) 648 to decipher Missing Details from the Prompt 8268 that are crucial to complete the correct ‘virtual understanding’ by LOM 132 for LOM 132 to fully address/respond to the Prompt 8268. The resultant Missing Details produced by IQR C802A are submitted as modular input to Survey Clarification (SC) C803A. SC C803A engages with the origin of the Prompt 8318 to retrieve supplemental information so that the Prompt 8318 can be analyzed objectively and with all the necessary context. When LOM 132 is invoked directly within the UBEC Platform 100 by an UBEC User 106, SC C803A engages with that User 106 as the origination of the question/answer. However this instance of LOM 132 is automatically invoked by DIP 8316 instead, therefore SC C803A engages with DIP 8316 to retrieve supplemental information concerning the Prompt 8651. The fully formed and refined version of the Prompt 8651 is produced from SC C803A and submitted as modular input to Assertion Construction (AC) C808A. AC C808A attempts to form a coherent response to the Prompt 8318 by referencing CKR 648 directly and also via Hierarchical Mapping (HM) C807A. Rational Appeal (RA) C811A is a container module that houses a logic flow interface with CTMP 124. RA C811A uses CTMP 124 to criticize assertions. Such criticisms can be in the form of self-criticisms (by criticizing the output of AC C808A), or external criticisms to the origin of the question/assertion processed by IQR C802A (UBEC User 106 or DIP 8316). If an assertion produced from AC C808A fails a significant measure of the self-criticism test processed by RA C811A; then a new instance of AC C808A is invoked to account for any valid criticisms. If a high confidence assertion is produced by AC C808A that consistently passes self-criticism tests processed by RA C811A; then the assertion is produced as LOM's 132 modular output, referenced as the Creative Potential Unit 8698 in context of the initial Prompt 8651 provided by CVIP 8650.

FIG. 750 shows more detail of the internal operation procedure of Rational Appeal (RA) C811A of LOM 132 in regards to Stage 8696 of NAD 8052. Assertion Construction (AC) C808A provides a Response Presentation C843 to Rational Appeal (RA) C811A concerning the assertion produced by AC C808A in regards to the corresponding input Prompt 8268. At this stage of the logic flow, the produced assertion is classified as a Pre-Criticized Decision C847. This indicates that it is has yet to be processed via criticism by CTMP 124. Therefore the produced assertion is directly submitted to the CTMP 124 instance as a ‘Subjective Opinion’ C848 input, and also to Context Construction (CC) C817A which provides the ‘Objective Fact’ C850 input to the CTMP 124 instance. CC C817A references metadata from AC C808A and potential evidence provided via CVIP 8650 to submit raw facts to CTMP 124 for critical thinking. Such input metadata is represented by the LOM Log Aggregate 5502 file. The LOM Log Aggregate 5502 contains a collection of relevant log files that are produced from the primary operating functions of LOM 132. After the CTMP 124 instance concludes it's operation, a Post-Criticized Decision C851 is produced as modular output. The initial Pre-Criticized Decision C847 and Post-Criticized Decision C851 are submitted to the Decision Comparison (DC) C818A module which determines the scope of potential overlap between the two inputs C847 and C851. The unified output provided by DC 818A can either indicate CTMP's 124 Concession C852 (of incorrectness) on behalf of the AC C808A produced assertion, or a perceived Improvement C853 on behalf of the AC C808A produced assertion. Both Argument Responses C852 and C853 can be classified as either Low Confidence Results C845 or High Confidence Results C846. A Low Confidence Result C845 indicates that the original assertion produced by AC C808A is flawed and should be reconstructed; therefore the logic flow continues to a new instance of AC C808A. A High Confidence Result C846 indicates that the original assertion produced by AC C808A has merit, therefore the drawn conclusions (coupled with any corresponding evidence, premises etc.) are submitted to Knowledge Validation (KV) C805A. Therefore the logic flow continues to a new instance of KV C805A so that CKR 846 and hence LOM 132 can benefit from the recently processed assertion.

FIG. 751 continues the logic flow of Stage 8696 from NAD 8052 to illustrate the production of the LOM Log Aggregate 5502 file. Modular outputs produced from Initial Query Reasoning (IQR) C802A, Survey Clarification (SC) C803A, Assertion Construction (AC) C808A, Hierarchical Mapping (HM) C807A and Knowledge Validation (KV) C805A are submitted to the LOM Modular Log Collection (LMLC) 5500 module. Therefore LMLC 5500 combines the input log data into a single readable file referenced as LOM Log Aggregate 5502. The File 5502 encompasses the overall operational state of the corresponding LOM 132 instance, hence providing information as to how the LOM 132 instance reached various conclusions. The LOM Log Aggregate 5502 is submitted to CC C817A of Rational Appeal (RA) C811A.

FIG. 752 expands on operational details concerning FIG. 751 to illustrate the internal operation of CTMP 124 in regards to the input and output channels defined in Rational Appeal (RA) C811A. The Pre-Criticized Decision C847 is Presented C843 as modular output from Assertion Construction (AC) C808A. The Decision C847 is then marked as a Subjective Opinion C848, therefore fulfilling one of the two major inputs of CTMP 124. The Subjective Opinion C848 is submitted to Input System Metadata C484, which acts as the primary modular input for CTMP 124 and an internal representation of the Selected Pattern Matching Algorithm (SPMA). For this instance configuration; the SPMA is LOM 132. Input System Metadata C484 is submitted for processing to Reason Processing C456 and to Raw Perception Production (RP²) C465. Reason Processing C456 will logically understand the assertions being made by comparing property attributes. RP² C465 parses the Input System Metadata C484 from LOM 132 to produce a perception in Perception Complex Format (PCF) that represents the algorithmic perception of LOM 132. Such a produced Perception is submitted to the Perception Observer Emulator (POE) C475 which emulates the algorithmic perception of LOM 132. Reason Processing C456 invokes Rule Processing which eventually produces rulesets that reflect the SPMA algorithm which in this instance is LOM 132. Therefore two modes of ‘thinking’ are executed, ‘analogue’ perception and ‘digital’ ruleset processing. These two Branches C461 and C475 represent similitudes with intuition and logic. The results produced by both thinking Branches C461 and C475 are transferred to Critical Decision Output (CDO) C462, which evaluates any fundamental elements of conflict or corroboration between the results. Upon finding a high magnitude of internal corroboration, and a low magnitude of internal conflict CTMP 124 provides a binary Approve or Block decision, in regards to the initial input Subjective Opinion C848, that is referenced as a High Confidence Result C846. If there is a low magnitude of internal corroboration and a high magnitude of internal conflict CTMP 124 submits a ‘vote of no confidence’ which is referenced as a Low Confidence Result C845. Therefore the resultant output of CTMP 124 is considered the Post-Criticized Decision C851.

FIG. 753 shows more details concerning the invocation of Raw Perception Production (RP²) C465 within CTMP 124. LOM 132 produces the Creative Potential Unit 8698 by invoking Assertion Construction (AC) C808A. The Creative Potential Unit 8698 is then submitted to Stage 5506 of RP² C465 which unpacks the data to produce instances of a Debugging Trace C485 and Algorithm Trace C486 within the Input System Metadata C484 which originates from the corresponding AC C808A instance. Debugging Trace C485 is a coding level trace that provides variables, functions, methods and classes that are used along with their corresponding input and out variable type and content. The full function call chain (function trace: functions calling other functions) is provided. The Algorithm Trace C486 is a software level trace that provides security data coupled with algorithm analysis. The resultant security decision (approve/block) is provided along with a logistics trail of how it reached the Decision C847. The appropriate weight concerning each factor that contributed to producing the Decision C847 is included. Thereafter RP² C465 transfers the data concerning the produced perception result to Perception Observer Emulator (POE) 0475 for processing.

FIG. 754 elaborates on the operation of Raw Perception Production (RP²) C465 from within CTMP 124. Initially Stage 5506 occurs, as it does on FIG. 753, to unpack the data to produce instances of a Debugging Trace C485 and Algorithm Trace C486 within the Input System Metadata C484 which originates from the corresponding AC C808A instance. At Stage 5508, Metric Processing C489 reverse engineers the variables from LOM 132 to extract perceptions from the artificial intelligence exhibited by LOM 132. Thereafter Input System Metadata C484 is processed by Stage 5510, which separates Metadata C484 into meaningful security cause-effect relationships via System Metadata Separation (SMS) C487. As also indicated by FIG. 753, RP² C465 transfers the data concerning the produced perception result to Perception Observer Emulator (POE) C475 for processing.

FIG. 755 elaborates on the operation of Perception Observer Emulator (POE) C475, include it's and Raw Perception Production's (RP²) C465 relation to Perception Storage (PS) C478. The operation of Metric Processing C489 and System Metadata Separation (SMS) C487 both lead to the production of Perceptions 5512/5514/5516 that are thereafter stored in PS C478. The resulting Perceptions 5512/5514/5516 represent LOM's 132 modular response of producing the Purpose Replacement 8258 via Assertion Construction (AC) C808A. RP² C465 produces a Comparable Variable Format datapoint which is fed into Storage Search (SS) C480 as search criteria. Thereafter SS C480 performs a lookup of PS C478 to find matches with already existing Perceptions stored in PS C478. The Results C716 of the execution SS C480 are produced which leads to a Weight Calculation C718. Such a Calculation C718 attempts to find the correct distribution of corresponding Perceptions from PS C478 to replicate and match the Comparable Variable Format which represent's the execution of the LOM 132 algorithm that produced Creative Potential Unit 8698.

FIG. 756 continues the Perception Observer Emulator (POE) C475 logic from FIG. 755. After the production of Results C716 from Storage Search (SS) C480, the Weight Calculation C718 completes to lead to the Application C729 of the Perceptions 5512/5514/5516 to make an active Approve C731 or Block C730 decision. The Creative Potential Unit 8698 produced by LOM 132 and corresponding LOM Log Aggregate 5502 undergo Data Parsing C724 which causes Data Enhanced Logs C723 to be derived which are applied in the Application C729 to achieve an Interpretation Dichotomy 5518 of a Positive Sentiment (Approve) C731 or Negative Sentiment (Block) C730 with regards to the input Creative Potential Unit 8698. Upon successful conclusion of the execution of Application C729 leads to an Override Corrective Action C476 which is processed by Critical Decision Output (CDO) C462 in parallel to the modular output of Rule Execution (RE) C461. The Self-Critical Knowledge Density (SCKD) C474 module estimates the scope and type of potential unknown knowledge that is beyond the reach of the reportable LOM Log Aggregate 5502. This way the subsequent critical thinking features of the processing CTMP 124 instance can leverage the potential scope of all involved knowledge, known and unknown directly by the instance.

FIG. 757 shows the Memory Web C460 process that operates in parallel to the execution of Perception Observer Emulator (POE) C475 in FIG. 756. The Creative Potential Unit 8698 produced by LOM 132 is submitted as modular input to Reason Processing C456. Reason Processing C456 processes how LOM 132 achieved the decision to produce the Creative Potential Unit 8698 in response to the Prompt 8651 provided by CVIP 8650. The processing conclusion of Reason Processing C456 is the execution of Reason Processing C457, which defines the rules that are thirdly consistent with LOM's 132 execution behavior. If any inconsistencies are found in rule behavior with regards to LOM's 132 execution behavior, then currently existing rules are modified or new rules are added. Such rules are later used within the CTMP 124 instance to criticize decision making behaviors found within the corresponding LOM 132 instance. Critical Rule Scope Extender (CRSE) C458 then leverages known Perceptions to expand the ‘critical thinking’ scope of the rulesets, in effect enhancing the rulesets to produce Correct Rules C459. The Correct Rules C459 are then submitted as modular input to Rule Syntax Format Separation (RSFS) C499 from within the operating jurisdiction of Memory Web C460. RSFS C499 separates and organizes Correct Rules C459 by type. Therefore all actions, properties, conditions and objects are listed separately after RSFS C499 processing. This enables the CTMP 124 instance to discern what parts have been found in the Chaotic Field, and what parts have not. Chaotic Field Parsing (CFP) C535 combines and formats the LOM Log Aggregate 5502 into a single scannable unit referenced as the Chaotic Field. The Chaotic Field is submitted as modular input to Memory Recognition (MR) C501. MR C501 also receives the Original Rules C555 which is the execution result from RSFS C499. MR C501 scans the Chaotic Field provided by CFP C535 to recognize knowable concepts defined in Original Rules C555. This MR C501 instance execution produces Recognized Rule Segments C556. Thereafter Rule Fulfillment Parser (RFP) C498 receives individual parts of the Original Rules C555 that have been tagged according to their recognition or lack-thereof within the Chaotic Field by MR C501. RFP C498 can then logically deduce which whole ruleset (the combination of all of their parts) have been sufficiently recognized in the Chaotic Field to merit processing by Rule Execution (RE) C461. Upon successful conclusion of the execution of RE C461 leads to an Override Corrective Action C476 which is processed by Critical Decision Output (CDO) C462 in parallel to the modular output of Perception Observer Emulator (POE) C475.

FIG. 758 elaborates on the logic flow interaction between Perception Storage (PS) C478 and the Automated Perception Discovery Mechanism (APDM) C467. PS C478 contains four subsets of Perceptions: Deduced Unknown Angles of Perception C473, All Angles of Perception C472, Implied Angles of Perception C471, and Applied Angles of Perception C470. Applied Angles of Perception C470 are Perceptions that have been directly imported by studying algorithmic behavior of the Selected Pattern Matching Algorithm (SPMA), which in this instance is LOM 132. Implied Angles of Perception C471 are Perceptions that have been derived from Applied Angles of Perception C470 via modular execution of Implication Derivation (ID) C477 and APDM C467. All Angles of Perception C472 represents the entire scope of known Perceptions to the CTMP 124 instance that have not been included by Applied Angles of Perception C470 and Implied Angles of Perception C471. Deduced Unknown Angles of Perception C473 represents the scope of Perceptions that is expected to exist yet the CTMP 124 instance has yet to discover according to the Self-Critical Knowledge Density (SCKD) C474 module. ID C477 analyzes the individual metrics of Applied Angles of Perception C470 to deterministically derive Implied Angles of Perception C470, whilst APDM C467 creatively varies compositions of Angles of Perception C650 via the Creativity Module 112 to produce a New Iteration C653 that combines the initial two input Weights C652. Therefore all of the Angles of Perception C650 involved with APDM C467 processing correspond with and represent the Creative Potential Unit 8698 that is produced by LOM's 132 Assertion Construction (AC) C808A module.

FIG. 759 elaborates on the operational details concerning the Critical Rule Scope Extender (CRSE) C458 of CTMP 124. A Rational Appeal (RA) C811A instance operates within LOM 132 and invokes Context Construction (CC) C817A to process the LOM Log Aggregate 5502 to Chaotic Field Parsing (CFP) C535. CFP produces a Chaotic Field from the modular output of CC C817A which is referenced by Memory Recognition (MR) C501. Current Rules C534 exhibits rulesets that are indicative of the current functioning state of the Selected Pattern Matching Algorithm (SPMA) which in this instance is LOM 132. Current Rules C534 is submitted as modular input to the Rule Syntax Derivation (RSD) C504 module, which is where logical ‘black and white’ rules are converted to metric based perceptions. Therefore the complex arrangement of multiple rules are converted into a single uniform perception that is expressed via multiple metrics of varying gradients. The modular output of RSD C504 is provided as modular input to Perception Matching (PM) C503. At PM C503; a Comparable Variable Format (CVF) unit is formed from the Perception received from RSD C504. The newly formed CVF is used to lookup relevant Perceptions in the Perception Storage (PS) C478 with similar indexes. The potential matches are submitted as modular input to Rule Syntax Generation (RSG) C505. RSG C505 receives previously confirmed perceptions which are stored in Perception format and accesses the Perception's internal metric makeup. The Perceptions are received from PS C478 which contains Previously Confirmed Perceptions C468. Such gradient-based measures of metrics are converted to binary and logical rulesets that emulate the input/output information flow of the original perception. Therefore RSG C505 produces Perceptive Rules C537 which are Perceptions that are considered relevant, popular and have been converted into logical rules. If a Perception (in it's original Perception Format) had many complex metric relationships that defined many ‘grey areas’, the ‘black and white’ local rules encompass such ‘grey’ areas by expanding on the ruleset complexity. Therefore the Perceptive Rules C537 are stored by a collection of Rule Syntax Format (RSF) definitions. Perceptive Rules C537 are submitted as modular input to Memory Recognition (MR) C501, where they are scanned against the Chaotic Field which was produced by CFP C535. Therefore MR C501 produces Extra Rules C536 which complete Correct Rules C533 in their validity.

FIG. 760 elaborates on the operational details concerning Implication Derivation (ID) C477 of CTMP 124. The Applied Angles of Perception C470 from Perception Storage (PS) C478 are submitted as modular input to ID C477 to produce more Perceptions that belong to Implied Angles of Perception C471. The Applied Angles of Perception C470 are specifically sent to Metric Combination C493 of ID C477. Metric Combination C493 separates the received Angles of Perception C650 into categories of metrics: Scope C739, Type C740, Consistency C741, Intensity C742. The Metric availability and reference within the system is not necessarily limited to these four types. The input Angles of Perception C650 are related to the Purpose Replacement 8258 that was produced by LOM's 132 Assertion Construction (AC) C808A module. The Metric Complexity Set A C736 is submitted as modular input to Metric Expansion (ME) C495. With ME C495 the metrics of multiple and varying Angles of Perception C650 are stored categorically in individual databases C739/C740/C741/C742. ME C495 enhances the current batch of received metrics with details/complexity extracted from previously known/encountered metrics. Upon enhancement and complexity enrichment completion, the metrics are returned as ME C495 modular output as Metric Complexity Set B C737 and thereafter converted back into Angles of Perception C650 to be stored in Implied Angles of Perception C471 as illustrated on FIG. 761.

FIG. 761 continues the logic flow of Implication Derivation (ID) C477 from FIG. 760, illustrating the Metric Complexity Set B C737 being processed by Metric Conversion C494 which reverses individual metrics back into whole Angles of Perception C650. Despite the enrichment and conversion process performed by ID C477, the resultant Angles of Perception C650 still provide a reasonably accurate representation of the Creative Potential Unit 8698 produced by LOM's 132 Assertion Construction (AC) C808A module. Therefore the Metric Conversion C494 process submits the newly derived/implied Angles of Perception C650 to Implied Angles of Perception C471 within Perception Storage (PS) C478.

FIG. 762 elaborates on the operational details concerning Critical Decision Output (CDO) C462 of CTMP 124. CDO C462 receives modular output from both major branches of CTMP 124: Perception Observer Emulator (POE) C475 (as the intuition branch) and Rule Execution (RE) C461 (as the logical branch). Each Branch C475/461 submits it's respective Critical Decision C521 (the main modular output) as well as corresponding the ‘Meta-metadata’ C521, which provides contextual variables that justify why the initial critical decision was reached. Both Decision Sets C521 that represent the Perceptions C516 of POE C475 and the Fulfilled Rules C517 of RE C461 are submitted to the Metadata Categorization Module (MCM) C488. MCM C488 separates the Debugging and Algorithm Traces into distinct categories using traditional syntax based information categorization. Such categories can then be used to organize and produce distinct security responses with a correlation to security risks and subjects. The Intuitive Decision C514, which represents Perceptions C526 from POE C475, and the Thinking Decision C515, which represents Fulfilled Rules C517 from RE C461 are submitted by MCM C488 to the Internal Processing Logic 5520 of Direction Decision Comparison (DDC) C512. The Internal Processing Logic 5520 of DDC C512 checks for corroboration or conflict between the Intuitive Decision C514 and the Thinking Decision C515. DDC C512 references a ‘cutoff’ variable from Static Hardcoded Policy (SHP) 488. If the ‘cutoff’ variable is not reached for similarity between the Intuitive Decision C514 and the Thinking Decision C515 (i.e. 90%+), then the Cancel Direct Comparison 5524 directive occurs, which might lead the Terminal Output Control (TOC) C513 to eventually submit a Vote of No Confidence 5544 as shown on FIG. 763. The Cancel Direct Comparison 5524 stage implies that CTMP 124 was unable to act internally consistent in regards to the input Prompt 8651 from CVIP 8650. If the ‘cutoff’ variable was sufficiently met according to the Internal Processing Logic 5520, then the Final Decision Output 5522 stage is invoked which combines both Decisions C514/C515 into a single modular output which is received and processed by TOC C513.

FIG. 763 continues the logic flow of Critical Decision Output (CDO) C462 from FIG. 762 and elaborates on the operational details of Terminal Output Control (TOC) C513. TOC C513 initiates with Prompt 5526, which checks if Direct Decision Comparison (DDC) C512 was able to provide a Final Decision Output 5522 (instead of the Cancel Direct Comparison 5524 directive). If the response to Prompt 5526 is Yes 5528, then the combined final decision provided by DDC C512 at Final Decision Output 552 is submitted as modular output of TOC C513 and hence as modular output of the entire CTMP 124 instance as the Final Critical Decision 5542 output. If the response to Prompt 5526 is No 5530, then Stage 5532 is invoked which it itself invokes the execution of Perception Matching (PM) 5532 and fetches the corresponding results. Fulfilled Rules C517 are extracted from the Critical Decision+Meta-metadata C521 of Rule Execution (RE) C461. The Rules C517 are converted to Perceptions by Rule Syntax Derivation (RSD) C504. PM 5532 then references Meta-metadata to determine, at Prompt 5534, if there was a strong internal overlap and corroboration of Perceptions used. If the response to Prompt 5534 is Yes 5538 this indicates a Vote of No Confidence 5544 on behalf on CTMP 124 as modular output. If the response to Prompt 5534 is No 5536 then Stage 5540 is activated, which selects the perceived least risky decision between the Intuitive Decision C514 and Thinking Decision C515. Therefore the Final Critical Decision 5542 is subsequently submitted as modular output to CDO C462, TOC C513, and CTMP 124. The logic at Stage 5534 occurs to determine if the lack of unity between the Intuitive Decision C514 and Thinking Decision C515 occurs because of a general lack of algorithmic confidence, or due to highly opposing points of view between the two. Therefore if the latter were to occur, a potential Final Critical Decision 5542 is still discernible as modular output. A Vote of No Confidence 5544 always leads to the Low Confidence Result C845 logic pathway within Rational Appeal (RA) C811A. The Final Critical Decision 5542 can either lead to a High Confidence Result C846 or Low Confidence Result C845 logic pathway within RA C811A, depending on the algorithmic confidence behind the Final Critical Decision 5542.

FIG. 764 shows New Appchain Development (NAD) 8052 starting at Stage 8644 where LOM produces a Creative Potential Map 8646. At Stage 8707 CDM 8708 processes the Creative Potential Map 8646 and forms different solutions via Creativity 112 and tests them with I2GE 122. Creative Design Manifestation (CDM) 8708 produces Syntactical Creative Solutions 8709.

FIG. 765 continues the logic for New Appchain Development (NAD) 8052 from FIG. 764 where CDM 8708 produces Syntactical Creative Solutions 8709. At Stage 8710 LIZARD 120 derives a Purpose Hierarchy Map 8711 for the Syntactical Creative Solutions 879 and Adjusts the Purpose Hierarchy Map 8711 of the UBEC Platform 100 to include the Map of Syntactical Creative Solutions 8709. LIZARD derives a Purpose Hierarchy Map 8713 for the entire Customchain Ecosystem of the UBEC Platform 100.

FIG. 766 shows details concerning the operation of LIZARD 120 to convert Syntactical Creative Solutions 8709 into a Purpose Hierarchy Map 8711. Syntactical Creative Solutions 8709 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. Appchains to Create 8622 is received in a mixed Execution/Data Stream 8501 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 767 continues the logic flow from FIG. 766 to illustrate the operation of LIZARD 120 to convert Syntactical Creative Solutions 8709 into a Purpose Hierarchy Map 8711. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Logistics Layer 582 which is presented as the Complex Purpose Format C325 version of Syntactical Creative Solutions 8709. The same definition and application of Inner Core (IC) C333 applies for the aforementioned functions and modules.

FIG. 768 shows New Appchain Development (NAD) 8052 process at Stage 8714 where it Adjusts the Purpose Hierarchy Map 8713 of the UBEC Platform 100 to include the Purpose Hierarchy Map 8711 of Syntactical Creative Solutions 8709. Purpose Realignment Processing (PRP) 7050 received input from Master/Slave Affinity 1480 to create the Upgraded Purpose Map 8715. At Stage 8716, LIZARD 120 selects the purpose structure of the Syntactical Creative Solutions' 8709 Purpose Hierarchy Map 8711 from within the Upgraded Purpose Map 8715. NAD 8052 in general finds uses for Applications within a specified Application ecosystem that has a potential Application feature missing, which would perceivable benefit such an ecosystem.

FIG. 769 continues the logic flow from FIG. 768 to illustrate the process at Stage 8717 where LIZARD 120 uses the Syntax Module C35 to convert the new Application into Logistics Layer 582 format. All of the dependencies and supplement relationships that exist within the Upgraded Purpose Map 8715 have been preserved. Customchain Ecosystem Builder (CEB) 584 receives the Logistics Layer 582 and builds an Appchain/Microchain 8719 that is congruent with the UBEC Platform 100 at Stage 8718.

FIG. 770 shows details concerning the operation of LIZARD 120 to convert the Upgraded Purpose Map 8715 into a Logistics Layer 582. The Upgraded Purpose Map 8715 exists in Complex Purpose Format C325 and is submitted to Iterative Expansion C327 of the Purpose Module C36 within the Outer Core (OC) C329 of LIZARD 120. Iterative Expansion C327 adds detail and complexity to evolve a simple goal into a specific complex purpose definition. Therefore the maximum Purpose Association C326 potential of the input is realized, and retained as a Complex Purpose Format C325, before it is submitted to Logical Derivation C320 of the Syntax Module (SM) C35. The Core Code C335 element of Inner Core (IC) C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 771 continues the logic flow from FIG. 770 to illustrate the operation of LIZARD 120 to convert the Upgraded Purpose Map 8715 into a Logistics Layer 582. The input data is received in Complex Purpose Format C325 from the Purpose Module (PM) C36 and is transferred to Logical Derivation C320 of the Syntax Module (SM) C35. Logic Derivation C320 derives logically necessary functions from initially simpler functions. This means that if a function can be formed as a derivative function due to implication from a simpler parent function; then it is formed by Logical Derivation C320. The produced result is a tree of function dependencies that are built according to the defined Complex Purpose Format C325 data. Logical Derivation C320 operates according to the Rules and Syntax C322 definitions which are inherited from the Core Code C335 element of Inner Core (IC) C333. Logical Derivation C320 submits it's output to Code Translation C321. Code Translation C321 converts arbitrary (generic) code which is recognized and understood by SM C35 to any known and chosen computation language. Code Translation C321 also performs the inverse function of translating known computation languages into arbitrary syntax types, Therefore PM C36 invokes SM C35 to produce the resultant Appchain Syntax version of the input Upgraded Purpose Map 8715 via Code Translation C321. The resultant Logistics Layer 582 unit that is terminally produced by Code Translation C321 is the modular output of SM C35, Outer Core (OC) C329, and LIZARD 120.

FIG. 772 shows Automated Appchain Maintenance (A2M) 8042 process starting at Stage 8721 where the Target Appchain 6060 is selected for inspection of it's maintenance needs by Application State Inspection (ASI) 8722. Innate Maintenance Needs 8723 which include: Expired Caches 8725, Depreciated Functions 8726, Depreciated Modules and Dependencies 8727, Expired Points of Reference 8728 and Economical Stability Calibration 8729.

FIG. 773 continues from FIG. 772 Automated Appchain Maintenance (A2M) 8042 process starting at Stage 8730 where the Appchain Maintenance Tracking (AMT) 8731 database is updated to include the latest state of Innate Maintenance Needs 8723 of the Target Appchain 6060. Upon every X new blocks of an Appchain, such an Appchain is processed by Appchain Maintenance Development (AMD) 8734 to perform the appropriate maintenance measures at Stage 8732. Arbitrary Appchain 8733 is submitted to Appchain Maintenance Deployment (AMD) 8734 and Customchain Interface Module (CIM) 2470 which submits Solved Work New Block Announcement 2480 to Stage 8732.

FIG. 774 shows Enhanced Framework Development (EFD) 8054 for producing the ideal Framework Structure based on the Hardware Purpose Map 8742 utilizing LOM 132 and CTMP 124. Enhanced Framework Development (EFD) 8054 inspects and potentially improves existing software frameworks (such as programming languages) for both the UBEC Platform 100/BCHAIN Network 110 and Legacy Systems. The Enhanced Hardware Development (EHD) 8056 modifies physical systems that contain Dynamic Liquid Conductive Boards (DLCB) 8856 and therefore can have their core hardware structure optimized and upgraded. Framework Interpretation Mechanism (FIM) 8795 provides the Framework Structure Interpretation 8736 to LIZARD 120. At Stage 8740, LIZARD 120 converts the Framework Structure Interpretation 8736 into purpose format which is referenced as Framework Purpose Map 8743. Hardware Structure Survey (HS2) 8793 (which contains the Hardware Interpretation Mechanism (HIM) 8794) provides Hardware Structure Interpretation 8735 to LIZARD 120. At Stage 8738, LIZARD 120 converts the Hardware Structure Interpretation 8735 into purpose format which is referenced as Hardware Purpose Map 8742. At Stage 8744, LOM 132 and CTMP 124 produce the Ideal Framework Structure according to the Hardware Purpose Map 8742.

FIG. 775 shows details concerning the operation of LIZARD 120 to convert Hardware Structure Interpretation 8732 into a Hardware Purpose Map 8736. Hardware Structure Interpretation 8732 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. Hardware Structure Interpretation 8732 is received in Hardware Specifications 8973 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 776 continues the logic flow from FIG. 775 to illustrate the operation of LIZARD 120 to convert Hardware Structure Interpretation 8732 into a Hardware Purpose Map 8736. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Hardware Purpose Map 8736 which is presented as the Complex Purpose Format C325 version of Hardware Structure Interpretation 8732. The same definition and application of Inner Core (IC) C333 applies for the aforementioned functions and modules.

FIG. 777 shows details concerning the operation of LIZARD 120 to convert Framework Structure Interpretation 8738 into a Framework Purpose Map 8742. Framework Structure Interpretation 8738 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. Framework Structure Interpretation 8738 is received in Framework Specifications 8975 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 778 continues the logic flow from FIG. 777 to illustrate the operation of LIZARD 120 to convert Framework Structure Interpretation 8738 into a Framework Purpose Map 8742. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Framework Purpose Map 8742 which is presented as the Complex Purpose Format C325 version of Framework Structure Interpretation 8738. The same definition and application of Inner Core (IC) C333 applies for the aforementioned functions and modules.

FIG. 779 shows Enhanced Framework Development (EFD) where LOM 132 and CTMP 124 produce the Ideal Framework Structure 8750 according to the Hardware Purpose Map 8736. At Stage 8746 LOM 132 receives the Hardware Purpose Map 8736 which contains the Hardware Structure Interpretation 8732. At Stage 8748 LOM 132 Produces Efficiency Principles 8814 from Central Knowledge Retention (CKR) 648. At Stage 8744, LOM 132 and CTMP 124 produce the Ideal Framework Structure 8750 according to the Hardware Purpose Map 8736.

FIG. 780 continues the logic flow from FIG. 779 to illustrate the operation of LOM 132 to Produce Efficiency Design Principles from CKR 648 based on Design Principle Invocation Prompt (DPIP) 8648. LOM builds concepts overtime within CKR 648 from data retrieved by ARM 134 that facilitates the determination process for Efficiency Design Principles 8814. CKR 648 builds a strong base of definitions via innate advanced reasoning, and is able to justify any conclusions 8814 that LOM outputs. With Cluster Building C854F CKR 648 reaches conceptual conclusions via ‘stacking’ building blocks of information known as Unit Knowledge Format (UKF) Clusters C854F. These clusters encompass a wide range of metadata concerning the targeted information such as attributable sources, times of suspected information creation, efficiency, design, etc. Each UKF Cluster C854F contains Rule Syntax Format (RSF) C538.

FIG. 781 shows the internal operation procedure of LOM 132 and CTMP 124 in regards to Stage 8744 of Enhanced Framework Development (EFD) 8054. The Efficiency Design Principles 8814, Stability Design Principles 8818, and Hardware Purpose Map 8736 are supplied as initial input to the Deduction Invocation Prompt (DIP) 8316. DIP 8316 produces a Prompt 8317 that interacts directly with LOM 132 to invoke the production of the Ideal Framework Structure 8750 with consideration of the input criteria Efficiency Design Principles 8814, Stability Design Principles 8818, and Hardware Purpose Map 8736. The Prompt 8317 produced by DIP 8316 is submitted to the Initial Query Reasoning (IQR) C802A module of LOM 132. When LOM 132 is invoked directly within the UBEC Platform 100 by an UBEC User 106, IQR C802A receives the initial question/assertion provided by the UBEC User 106. However this instance of LOM 132 is automatically invoked by DIP 8316 instead. The provided Prompt 8317 is analyzed via invocation of Central Knowledge Retention (CKR) 648 to decipher Missing Details from the Prompt 8317 that are crucial to complete the correct ‘virtual understanding’ by LOM 132 for LOM 132 to fully address/respond to the Prompt 8317. The resultant Missing Details produced by IQR C802A are submitted as modular input to Survey Clarification (SC) C803A. SC C803A engages with the origin of the Prompt 8317 to retrieve supplemental information so that the Prompt 8318 can be analyzed objectively and with all the necessary context. When LOM 132 is invoked directly within the UBEC Platform 100 by an UBEC User 106, SC C803A engages with that User 106 as the origination of the question/answer. However this instance of LOM 132 is automatically invoked by DIP 8316 instead, therefore SC C803A engages with DIP 8316 to retrieve supplemental information concerning the Prompt 8317. The fully formed and refined version of the Prompt 8317 is produced from SC C803A and submitted as modular input to Assertion Construction (AC) C808A. AC C808A attempts to form a coherent response to the Prompt 8317 by referencing CKR 648 directly and also via Hierarchical Mapping (HM) C807A. Rational Appeal (RA) C811A is a container module that houses a logic flow interface with CTMP 124. RA C811A uses CTMP 124 to criticize assertions. Such criticisms can be in the form of self-criticisms (by criticizing the output of AC C808A), or external criticisms to the origin of the question/assertion processed by IQR C802A (UBEC User 106 or DIP 8316). If an assertion produced from AC C808A fails a significant measure of the self-criticism test processed by RA C811A; then a new instance of AC C808A is invoked to account for any valid criticisms. If a high confidence assertion is produced by AC C808A that consistently passes self-criticism tests processed by RA C811A; then the assertion is produced as LOM's 132 modular output, referenced as the Ideal Framework Structure 8750 in context of the initial Prompt 8317 provided by DIP 8316.

FIG. 782 shows more detail of the internal operation procedure of Rational Appeal (RA) C811A of LOM 132 in regards to Stage 8304 of EFD 8054. Assertion Construction (AC) C808A provides a Response Presentation C843 to Rational Appeal (RA) C811A concerning the assertion produced by AC C808A in regards to the corresponding input Prompt 8317. At this stage of the logic flow, the produced assertion is classified as a Pre-Criticized Decision C847. This indicates that it is has yet to be processed via criticism by CTMP 124. Therefore the produced assertion is directly submitted to the CTMP 124 instance as a ‘Subjective Opinion’ C848 input, and also to Context Construction (CC) C817A which provides the ‘Objective Fact’ C850 input to the CTMP 124 instance. CC C817A references metadata from AC C808A and potential evidence provided via DIP 8316 to submit raw facts to CTMP 124 for critical thinking. Such input metadata is represented by the LOM Log Aggregate 5502 file. The LOM Log Aggregate 5502 contains a collection of relevant log files that are produced from the primary operating functions of LOM 132. After the CTMP 124 instance concludes it's operation, a Post-Criticized Decision C851 is produced as modular output. The initial Pre-Criticized Decision C847 and Post-Criticized Decision C851 are submitted to the Decision Comparison (DC) C818A module which determines the scope of potential overlap between the two inputs C847 and C851. The unified output provided by DC 818A can either indicate CTMP's 124 Concession C852 (of incorrectness) on behalf of the AC C808A produced assertion, or a perceived Improvement C853 on behalf of the AC C808A produced assertion. Both Argument Responses C852 and C853 can be classified as either Low Confidence Results C845 or High Confidence Results C846. A Low Confidence Result C845 indicates that the original assertion produced by AC C808A is flawed and should be reconstructed; therefore the logic flow continues to a new instance of AC C808A. A High Confidence Result C846 indicates that the original assertion produced by AC C808A has merit, therefore the drawn conclusions (coupled with any corresponding evidence, premises etc.) are submitted to Knowledge Validation (KV) C805A. Therefore the logic flow continues to a new instance of KV C805A so that CKR 846 and hence LOM 132 can benefit from the recently processed assertion.

FIG. 783 continues the logic flow of Stage 8744 from EFD 8054 to illustrate the production of the LOM Log Aggregate 5502 file. Modular outputs produced from Initial Query Reasoning (IQR) C802A, Survey Clarification (SC) C803A, Assertion Construction (AC) C808A, Hierarchical Mapping (HM) C807A and Knowledge Validation (KV) C805A are submitted to the LOM Modular Log Collection (LMLC) 5500 module. Therefore LMLC 5500 combines the input log data into a single readable file referenced as LOM Log Aggregate 5502. The File 5502 encompasses the overall operational state of the corresponding LOM 132 instance, hence providing information as to how the LOM 132 instance reached various conclusions. The LOM Log Aggregate 5502 is submitted to CC C817A of Rational Appeal (RA) C811A.

FIG. 784 expands on operational details concerning FIG. 783 to illustrate the internal operation of CTMP 124 in regards to the input and output channels defined in Rational Appeal (RA) C811A. The Pre-Criticized Decision C847 is Presented C843 as modular output from Assertion Construction (AC) C808A. The Decision C847 is then marked as a Subjective Opinion C848, therefore fulfilling one of the two major inputs of CTMP 124. The Subjective Opinion C848 is submitted to Input System Metadata C484, which acts as the primary modular input for CTMP 124 and an internal representation of the Selected Pattern Matching Algorithm (SPMA). For this instance configuration; the SPMA is LOM 132. Input System Metadata C484 is submitted for processing to Reason Processing C456 and to Raw Perception Production (RP²) C465. Reason Processing C456 will logically understand the assertions being made by comparing property attributes. RP² C465 parses the Input System Metadata C484 from LOM 132 to produce a perception in Perception Complex Format (PCF) that represents the algorithmic perception of LOM 132. Such a produced Perception is submitted to the Perception Observer Emulator (POE) C475 which emulates the algorithmic perception of LOM 132. Reason Processing C456 invokes Rule Processing which eventually produces rulesets that reflect the SPMA algorithm which in this instance is LOM 132. Therefore two modes of ‘thinking’ are executed, ‘analogue’ perception and ‘digital’ ruleset processing. These two Branches C461 and 0475 represent similitudes with intuition and logic. The results produced by both thinking Branches C461 and C475 are transferred to Critical Decision Output (CDO) C462, which evaluates any fundamental elements of conflict or corroboration between the results. Upon finding a high magnitude of internal corroboration, and a low magnitude of internal conflict CTMP 124 provides a binary Approve or Block decision, in regards to the initial input Subjective Opinion C848, that is referenced as a High Confidence Result C846. If there is a low magnitude of internal corroboration and a high magnitude of internal conflict CTMP 124 submits a ‘vote of no confidence’ which is referenced as a Low Confidence Result C845. Therefore the resultant output of CTMP 124 is considered the Post-Criticized Decision C851.

FIG. 785 shows more details concerning the invocation of Raw Perception Production (RP²) C465 within CTMP 124. LOM 132 produces the Ideal Framework Structure 8750 by invoking Assertion Construction (AC) C808A. The Ideal Framework Structure 8750 is then submitted to Stage 5506 of RP² C465 which unpacks the data to produce instances of a Debugging Trace C485 and Algorithm Trace C486 within the Input System Metadata C484 which originates from the corresponding AC C808A instance. Debugging Trace C485 is a coding level trace that provides variables, functions, methods and classes that are used along with their corresponding input and out variable type and content. The full function call chain (function trace: functions calling other functions) is provided. The Algorithm Trace C486 is a software level trace that provides security data coupled with algorithm analysis. The resultant security decision (approve/block) is provided along with a logistics trail of how it reached the Decision C847. The appropriate weight concerning each factor that contributed to producing the Decision C847 is included. Thereafter RP² C465 transfers the data concerning the produced perception result to Perception Observer Emulator (POE) C475 for processing.

FIG. 786 elaborates on the operation of Raw Perception Production (RP²) C465 from within CTMP 124. Initially Stage 5506 occurs, as it does on FIG. 785, to unpack the data to produce instances of a Debugging Trace C485 and Algorithm Trace C486 within the Input System Metadata C484 which originates from the corresponding AC C808A instance. At Stage 5508, Metric Processing C489 reverse engineers the variables from LOM 132 to extract perceptions from the artificial intelligence exhibited by LOM 132. Thereafter Input System Metadata C484 is processed by Stage 5510, which separates Metadata C484 into meaningful security cause-effect relationships via System Metadata Separation (SMS) C487. As also indicated by FIG. 785, RP² C465 transfers the data concerning the produced perception result to Perception Observer Emulator (POE) C475 for processing.

FIG. 787 elaborates on the operation of Perception Observer Emulator (POE) C475, include it's and Raw Perception Production's (RP²) C465 relation to Perception Storage (PS) C478. The operation of Metric Processing C489 and System Metadata Separation (SMS) C487 both lead to the production of Perceptions 5512/5514/5516 that are thereafter stored in PS C478. The resulting Perceptions 5512/5514/5516 represent LOM's 132 modular response of producing the Ideal Framework Structure 8750 via Assertion Construction (AC) C808A. RP² C465 produces a Comparable Variable Format datapoint which is fed into Storage Search (SS) C480 as search criteria. Thereafter SS C480 performs a lookup of PS C478 to find matches with already existing Perceptions stored in PS C478. The Results C716 of the execution SS C480 are produced which leads to a Weight Calculation C718. Such a Calculation C718 attempts to find the correct distribution of corresponding Perceptions from PS C478 to replicate and match the Comparable Variable Format which represent's the execution of the LOM 132 algorithm that produced Ideal Framework Structure 8750.

FIG. 788 continues the Perception Observer Emulator (POE) C475 logic from FIG. 787. After the production of Results C716 from Storage Search (SS) C480, the Weight Calculation C718 completes to lead to the Application C729 of the Perceptions 5512/5514/5516 to make an active Approve C731 or Block C730 decision. The Ideal Framework Structure 8750 produced by LOM 132 and corresponding LOM Log Aggregate 5502 undergo Data Parsing C724 which causes Data Enhanced Logs C723 to be derived which are applied in the Application C729 to achieve an Interpretation Dichotomy 5518 of a Positive Sentiment (Approve) C731 or Negative Sentiment (Block) C730 with regards to the input Ideal Framework Structure 8750. Upon successful conclusion of the execution of Application C729 leads to an Override Corrective Action C476 which is processed by Critical Decision Output (CDO) C462 in parallel to the modular output of Rule Execution (RE) C461. The Self-Critical Knowledge Density (SCKD) C474 module estimates the scope and type of potential unknown knowledge that is beyond the reach of the reportable LOM Log Aggregate 5502. This way the subsequent critical thinking features of the processing CTMP 124 instance can leverage the potential scope of all involved knowledge, known and unknown directly by the instance.

FIG. 789 shows the Memory Web C460 process that operates in parallel to the execution of Perception Observer Emulator (POE) C475 in FIG. 788. The Ideal Framework Structure 8750 produced by LOM 132 is submitted as modular input to Reason Processing C456. Reason Processing C456 processes how LOM 132 achieved the decision to produce the Ideal Framework Structure 8750 in response to the Prompt 8317 provided by DIP 8316. The processing conclusion of Reason Processing C456 is the execution of Reason Processing C457, which defines the rules that are thirdly consistent with LOM's 132 execution behavior. If any inconsistencies are found in rule behavior with regards to LOM's 132 execution behavior, then currently existing rules are modified or new rules are added. Such rules are later used within the CTMP 124 instance to criticize decision making behaviors found within the corresponding LOM 132 instance. Critical Rule Scope Extender (CRSE) C458 then leverages known Perceptions to expand the ‘critical thinking’ scope of the rulesets, in effect enhancing the rulesets to produce Correct Rules C459. The Correct Rules C459 are then submitted as modular input to Rule Syntax Format Separation (RSFS) C499 from within the operating jurisdiction of Memory Web C460. RSFS C499 separates and organizes Correct Rules C459 by type. Therefore all actions, properties, conditions and objects are listed separately after RSFS C499 processing. This enables the CTMP 124 instance to discern what parts have been found in the Chaotic Field, and what parts have not. Chaotic Field Parsing (CFP) C535 combines and formats the LOM Log Aggregate 5502 into a single scannable unit referenced as the Chaotic Field. The Chaotic Field is submitted as modular input to Memory Recognition (MR) C501. MR C501 also receives the Original Rules C555 which is the execution result from RSFS C499. MR C501 scans the Chaotic Field provided by CFP C535 to recognize knowable concepts defined in Original Rules C555. This MR C501 instance execution produces Recognized Rule Segments C556. Thereafter Rule Fulfillment Parser (RFP) C498 receives individual parts of the Original Rules C555 that have been tagged according to their recognition or lack-thereof within the Chaotic Field by MR C501. RFP C498 can then logically deduce which whole ruleset (the combination of all of their parts) have been sufficiently recognized in the Chaotic Field to merit processing by Rule Execution (RE) C461. Upon successful conclusion of the execution of RE C461 leads to an Override Corrective Action C476 which is processed by Critical Decision Output (CDO) C462 in parallel to the modular output of Perception Observer Emulator (POE) C476.

FIG. 790 elaborates on the logic flow interaction between Perception Storage (PS) C478 and the Automated Perception Discovery Mechanism (APDM) C467. PS C478 contains four subsets of Perceptions: Deduced Unknown Angles of Perception C473, All Angles of Perception C472, Implied Angles of Perception C471, and Applied Angles of Perception C470. Applied Angles of Perception C470 are Perceptions that have been directly imported by studying algorithmic behavior of the Selected Pattern Matching Algorithm (SPMA), which in this instance is LOM 132. Implied Angles of Perception C471 are Perceptions that have been derived from Applied Angles of Perception C470 via modular execution of Implication Derivation (ID) C477 and APDM C467. All Angles of Perception C472 represents the entire scope of known Perceptions to the CTMP 124 instance that have not been included by Applied Angles of Perception C470 and Implied Angles of Perception C471. Deduced Unknown Angles of Perception C473 represents the scope of Perceptions that is expected to exist yet the CTMP 124 instance has yet to discover according to the Self-Critical Knowledge Density (SCKD) C474 module. ID C477 analyzes the individual metrics of Applied Angles of Perception C470 to deterministically derive Implied Angles of Perception C470, whilst APDM C467 creatively varies compositions of Angles of Perception C650 via the Creativity Module 112 to produce a New Iteration C653 that combines the initial two input Weights C652. Therefore all of the Angles of Perception C650 involved with APDM C467 processing correspond with and represent the Ideal Framework Structure 8750 that is produced by LOM's 132 Assertion Construction (AC) C808A module.

FIG. 791 elaborates on the operational details concerning the Critical Rule Scope Extender (CRSE) C458 of CTMP 124. A Rational Appeal (RA) C811A instance operates within LOM 132 and invokes Context Construction (CC) C817A to process the LOM Log Aggregate 5502 to Chaotic Field Parsing (CFP) C535. CFP produces a Chaotic Field from the modular output of CC C817A which is referenced by Memory Recognition (MR) C501. Current Rules C534 exhibits rulesets that are indicative of the current functioning state of the Selected Pattern Matching Algorithm (SPMA) which in this instance is LOM 132. Current Rules C534 is submitted as modular input to the Rule Syntax Derivation (RSD) C504 module, which is where logical ‘black and white’ rules are converted to metric based perceptions. Therefore the complex arrangement of multiple rules are converted into a single uniform perception that is expressed via multiple metrics of varying gradients. The modular output of RSD C504 is provided as modular input to Perception Matching (PM) C503. At PM C503; a Comparable Variable Format (CVF) unit is formed from the Perception received from RSD C504. The newly formed CVF is used to lookup relevant Perceptions in the Perception Storage (PS) C478 with similar indexes. The potential matches are submitted as modular input to Rule Syntax Generation (RSG) C505. RSG C505 receives previously confirmed perceptions which are stored in Perception format and accesses the Perception's internal metric makeup. The Perceptions are received from PS C478 which contains Previously Confirmed Perceptions C468. Such gradient-based measures of metrics are converted to binary and logical, rulesets that emulate the input/output information flow of the original perception. Therefore RSG C505 produces Perceptive Rules C537 which are Perceptions that are considered relevant, popular and have been converted into logical rules. If a Perception (in it's original Perception Format) had many complex metric relationships that defined many ‘grey areas’, the ‘black and white’ local rules encompass such ‘grey’ areas by expanding on the ruleset complexity. Therefore the Perceptive Rules C537 are stored by a collection of Rule Syntax Format (RSF) definitions. Perceptive Rules C537 are submitted as modular input to Memory Recognition (MR) C501, where they are scanned against the Chaotic Field which was produced by CFP C535. Therefore MR C501 produces Extra Rules C536 which complete Correct Rules C533 in their validity.

FIG. 792 elaborates on the operational details concerning Implication Derivation (ID) C477 of CTMP 124. The Applied Angles of Perception C470 from Perception Storage (PS) C478 are submitted as modular input to ID C477 to produce more Perceptions that belong to Implied Angles of Perception C471. The Applied Angles of Perception C470 are specifically sent to Metric Combination C493 of ID C477. Metric Combination C493 separates the received Angles of Perception C650 into categories of metrics: Scope C739, Type C740, Consistency C741, Intensity C742. The Metric availability and reference within the system is not necessarily limited to these four types. The input Angles of Perception C650 are related to the Ideal Framework Structure 8750 that was produced by LOM's 132 Assertion Construction (AC) C808A module. The Metric Complexity Set A C736 is submitted as modular input to Metric Expansion (ME) C495. With ME C495 the metrics of multiple and varying Angles of Perception C650 are stored categorically in individual databases C739/C740/C741/C742. ME C495 enhances the current batch of received metrics with details/complexity extracted from previously known/encountered metrics. Upon enhancement and complexity enrichment completion, the metrics are returned as ME C495 modular output as Metric Complexity Set B C737 and thereafter converted back into Angles of Perception C650 to be stored in Implied Angles of Perception C471 as illustrated on FIG. 793.

FIG. 793 continues the logic flow of Implication Derivation (ID) C477 from FIG. 792, illustrating the Metric Complexity Set B C737 being processed by Metric Conversion C494 which reverses individual metrics back into whole Angles of Perception C650. Despite the enrichment and conversion process performed by ID C477, the resultant Angles of Perception C650 still provide a reasonably accurate representation of the Ideal Framework Structure 8750 produced by LOM's 132 Assertion Construction (AC) C808A module. Therefore the Metric Conversion C494 process submits the newly derived/implied Angles of Perception C650 to Implied Angles of Perception C471 within Perception Storage (PS) C478.

FIG. 794 elaborates on the operational details concerning Critical Decision Output (CDO) C462 of CTMP 124. CDO C462 receives modular output from both major branches of CTMP 124: Perception Observer Emulator (POE) C475 (as the intuition branch) and Rule Execution (RE) C461 (as the logical branch). Each Branch C476/461 submits it's respective Critical Decision C521 (the main modular output) as well as corresponding the ‘Meta-metadata’ C521, which provides contextual variables that justify why the initial critical decision was reached. Both Decision Sets C521 that represent the Perceptions C516 of POE C475 and the Fulfilled Rules C517 of RE C461 are submitted to the Metadata Categorization Module (MCM) C488. MCM C488 separates the Debugging and Algorithm Traces into distinct categories using traditional syntax based information categorization. Such categories can then be used to organize and produce distinct security responses with a correlation to security risks and subjects. The Intuitive Decision C514, which represents Perceptions C526 from POE C475, and the Thinking Decision C515, which represents Fulfilled Rules C517 from RE C461 are submitted by MCM C488 to the Internal Processing Logic 5520 of Direction Decision Comparison (DDC) C512. The Internal Processing Logic 5520 of DDC C512 checks for corroboration or conflict between the Intuitive Decision C514 and the Thinking Decision C515. DDC C512 references a ‘cutoff’ variable from Static Hardcoded Policy (SHP) 488. If the ‘cutoff’ variable is not reached for similarity between the Intuitive Decision C514 and the Thinking Decision C515 (i.e. 90%+), then the Cancel Direct Comparison 5524 directive occurs, which might lead the Terminal Output Control (TOC) C513 to eventually submit a Vote of No Confidence 5544 as shown on FIG. 795. The Cancel Direct Comparison 5524 stage implies that CTMP 124 was unable to act internally consistent in regards to the input Prompt 8268 from RIP 8266. If the ‘cutoff’ variable was sufficiently met according to the Internal Processing Logic 5520, then the Final Decision Output 5522 stage is invoked which combines both Decisions C514/C515 into a single modular output which is received and processed by TOC C513.

FIG. 795 continues the logic flow of Critical Decision Output (CDO) C462 from FIG. 794 and elaborates on the operational details of Terminal Output Control (TOC) C513. TOC C513 initiates with Prompt 5526, which checks if Direct Decision Comparison (DDC) C512 was able to provide a Final Decision Output 5522 (instead of the Cancel Direct Comparison 5524 directive). If the response to Prompt 5526 is Yes 5528, then the combined final decision provided by DDC C512 at Final Decision Output 552 is submitted as modular output of TOC C513 and hence as modular output of the entire CTMP 124 instance as the Final Critical Decision 5542 output. If the response to Prompt 5526 is No 5530, then Stage 5532 is invoked which it itself invokes the execution of Perception Matching (PM) 5532 and fetches the corresponding results. Fulfilled Rules C517 are extracted from the Critical Decision+Meta-metadata C521 of Rule Execution (RE) C461. The Rules C517 are converted to Perceptions by Rule Syntax Derivation (RSD) C504. PM 5532 then references Meta-metadata to determine, at Prompt 5534, if there was a strong internal overlap and corroboration of Perceptions used. If the response to Prompt 5534 is Yes 5538 this indicates a Vote of No Confidence 5544 on behalf on CTMP 124 as modular output. If the response to Prompt 5534 is No 5536 then Stage 5540 is activated, which selects the perceived least risky decision between the Intuitive Decision C514 and Thinking Decision C515. Therefore the Final Critical Decision 5542 is subsequently submitted as modular output to CDO C462, TOC C513, and CTMP 124. The logic at Stage 5534 occurs to determine if the lack of unity between the Intuitive Decision C514 and Thinking Decision C515 occurs because of a general lack of algorithmic confidence, or due to highly opposing points of view between the two. Therefore if the latter were to occur, a potential Final Critical Decision 5542 is still discernible as modular output. A Vote of No Confidence 5544 always leads to the Low Confidence Result C845 logic pathway within Rational Appeal (RA) C811A. The Final Critical Decision 5542 can either lead to a High Confidence Result C846 or Low Confidence Result C845 logic pathway within RA C811A, depending on the algorithmic confidence behind the Final Critical Decision 5542.

FIG. 796 shown Enhanced Framework Development (EFD) 8054 where CTMP 124 and LOM 132 produce the Ideal Framework Structure 8750 according to the Hardware Purpose Map 8742 at Stage 8744. At Stage 8752 I2GE 122 stress tests the Ideal Framework Structure 8750 with variations of the Hardware Interpretation and Framework Structure. At Stage 8754, Framework Structure has proven stable and at Stage 8756, Framework Structure has not proven stable. Hardware Interpretation Mechanism (HIM) 8798 interacts with Hardware Structure Survey (HS2) 8796 to provide the Hardware Structure Interpretation 8732 to I2GE 122. Static Hardcoded Policy (SHP) 488 provides input to Stage 8752 for I2GE 122 stress tests.

FIG. 797 continues the logic flow of Enhanced Framework Development (EFD) 8054 from FIG. 796 at Stage 8758 where Refined Ideal Framework Structure 8760 is submitted as modular output from I2GE 122 to LIZARD 120. LIZARD 120 converts the Refined Ideal Framework Structure 8760 to purpose format as Ideal Framework Purpose Map 8764. Framework Interpretation Mechanism (FIM) 8766 converts Framework Structure Interpretation 8768 into Framework Purpose Map 8770.

FIG. 798 shows details concerning the operation of LIZARD 120 to convert Refined Framework Structure Interpretation 8760 into an Ideal Framework Purpose Map 8764. Refined Framework Structure Interpretation 8760 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. Refined Framework Structure Interpretation 8760 is received in Framework Specifications 8975 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 799 continues the logic flow from FIG. 798 to illustrate the operation of LIZARD 120 to convert Refined Framework Structure Interpretation 8760 into an Ideal Framework Purpose Map 8764. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Refined Framework Purpose Map 8764 which is presented as the Complex Purpose Format C325 version of Refined Framework Structure Interpretation 8760. The same definition and application of Inner Core (IC) C333 applies for the aforementioned functions and modules.

FIG. 800 shows Enhanced Framework Development (EFD) 8054 where at Stage 8762, LIZARD 120 converts the Refined Ideal Framework Structure 8760 to purpose format as Ideal Framework Purpose Map 8794 within Purpose to Purpose Symmetry Processing (P2SP) 7000. P2SP 7000 also processes Framework Structure Interpretation 8768 into Framework Purpose Map 8770 and submits the Symmetry Processing Result 8772 at Stage 8774 to check if there are any conflicts between the Ideal Frame Purpose Map 8764 and the Framework Purpose Map 8770 in regards to purpose makeup? If a Conflict is Found 8776 it proceeds to Stage 8780 to check if there are additional Purpose Units that are causing the conflict justified according to Need Map Matching (NMM) C114? Resulting in Justified 8782 or Not Justified 8784. Alternative result at Stage 8774 is No conflicts found 8778.

FIG. 801 shows the operation and functionality of Need Map Matching (NMM) C114 operating as a submodule of LIZARD's 120 Dynamic Shell C198. The NMM C114 instance is spawned to serve the operation of Stage 8780 from Enhanced Framework Development (EFD) 8054. Upon the modular invocation of NMM C114, Initial Parsing C148 downloads each jurisdiction branch from Storage 5550 to temporarily retain for referencing within the ongoing NMM C114 instance. With Calculate Branch Needs C149: according to definitions associated with each branch, needs are associated with their corresponding department. This way, permission checks can be formed within the NMM C114 instance. For example: NMM C114 approved the request for the Human Resources department to download all employee CVs, because it was requested within the zone of the annual review of employee performance according to their capabilities. Therefore it was proven to be a valid need of the department jurisdiction. Therefore Need Index C145 is the main storage of Jurisdiction Branches and their respective needs. Because this internal reference is a resource bottleneck for the operation of NMM C114 and therefore all the modules it serves, it is pre-optimized for quick database querying to increase the overall efficiency of the system. The Symmetry Processing Result 8772 is provided as an Input Purpose C139 as modular input to the Search Algorithm C144 of NMM C114. The Search Algorithm C144 references and searches through the compiled Need Index C145, therefore determining if the Input Purpose C139 defines a valid need according to the jurisdiction branches initially defined in Need Access Development and Storage 5550. Therefore the completed execution of the Search Algorithm C144 via the Need Index C145 produces an Approve/Block C146 response which is submitted as modular output from NMM C114 and referenced as the Need Result C141. Therefore the Need Result C141 is returned back within EFD 8054 processing to Stage 8780.

FIG. 802 shows Enhanced Framework Development (EFD) 8054 process starting at Stage 8752 where I2GE 122 stress tests the Ideal Framework Structure with variations of the Hardware Interpretation and Framework Structure. Which leads to Framework Structure has proven stable 8754 or Framework Structure has not proven stable 8756 in which case in which case it submits a DLU 1182 with the Official System Token 1184 at Stage 5600 to Diagnostic Log Submission (DLS) 1160 of Automated Research Mechanism (ARM) for submission to SPSI 130. At Stage 8774 it checks to see if there are any conflicts between the Ideal Frame Purpose Map and the Framework Purpose Map in regards to purpose makeup? If conflicts are found 8776, it proceeds to Stage 8780 to check if there are additional Purpose Units that are causing the conflict justified according to NMM? If Not Justified 8782 it submits a DLU 1182 with the Official System Token 1184 at Stage 5600 to Diagnostic Log Submission (DLS) 1160 of Automated Research Mechanism (ARM) for submission to SPSI 130. Alternatively if the result of Stage 8780 is Justified 8784, it proceeds to Specification Rollout Mechanism (SRM) 8786. From Stage 8774 if No conflicts are found 8778 it proceeds to Specification Rollout Mechanism (SRM) 8786 as well.

FIG. 803 shows Enhanced Hardware Development (EFD) 8056 process for Abstract Target System 8800 using Abstract Target System Generator (ATSG) 5040 starting at Stage 8802 where LIZARD 120 interprets the usability of the Abstract Target System 8800. At Stage 8804 LIZARD 120 uses Need Map Matching (NMM) C114 to produce a Purpose Hierarchy Map 8806 definition concerning Required User Functionality 8810. LIZARD 120 converts the Purpose Hierarchy Map into Functionality Syntax at Stage 8808. At Stage 8828, LOM 132 and CTMP 124 produce the Ideal Hardware Configuration according to the Required User Functionality. Idealistic Configuration Invocation Prompt (ICIP) 8830 determines What is the most efficient and stable Hardware Configuration considering the Required User Functionality? 8832

FIG. 804 shows Enhanced Hardware Development (EHD) 8056 process where LIZARD 120 converts the Ideal Hardware Configuration 8824 into a Purpose Hierarchy Map 8826 at Stage 8834. Starting at Stage 8808 LIZARD 120 converts the Purpose Hierarchy Map 8826 into Functionality Syntax 8810 which leads LOM 132 to Produce the Efficiency Design Principles 8814 from CKR 648 at Stage 8812. At Stage 8816, LOM 132 produces Stability Design Principles 8818 from CKR 648 leading to Stage 8828 where LOM 132 and CTMP 124 produce the Ideal Hardware Configuration according to the Required User Functionality. LIZARD 120 converts the Ideal Hardware Configuration 8824 into a Purpose Hierarchy Map 8826 at Stage 8834.

FIG. 805 shows Enhanced Hardware Development (EFD) 8056 process where LOM 132 Produces Efficiency Design Principles 8814 from CKR 648 at Stage 8812 based on Design Principle Invocation Prompt (DPIP) 8648. LOM builds concepts overtime within CKR 648 from data retrieved by ARM 134 that facilitates the determination process for Efficiency Design Principles 8814. CKR 648 builds a strong base of definitions via innate advanced reasoning, and is able to justify any conclusions 8814 that LOM outputs. With Cluster Building C854F CKR 648 reaches conceptual conclusions via ‘stacking’ building blocks of information known as Unit Knowledge Format (UKF) Clusters C854F. These clusters encompass a wide range of metadata concerning the targeted information such as attributable sources, times of suspected information creation, efficiency, design, etc. Each UKF Cluster C854F contains Rule Syntax Format (RSF) C538.

FIG. 806 shows Enhanced Hardware Development (EFD) 8056 process where LOM 132 Produces Stability Design Principles 8818 from CKR 648 at Stage 8816 based on Design Principle Invocation Prompt (DPIP) 8648. LOM builds concepts overtime within CKR 648 from data retrieved by ARM 134 that facilitates the determination process for Stability Design Principles 8818. CKR 648 builds a strong base of definitions via innate advanced reasoning, and is able to justify any conclusions 8818 that LOM outputs. With Cluster Building C854F CKR 648 reaches conceptual conclusions via ‘stacking’ building blocks of information known as Unit Knowledge Format (UKF) Clusters C854F. These clusters encompass a wide range of metadata concerning the targeted information such as attributable sources, times of suspected information creation, stability, efficiency, design, etc. Each UKF Cluster C854F contains Rule Syntax Format (RSF) C538.

FIG. 807 shows the internal operation procedure of LOM 132 and CTMP 124 in regards to Stage 8828 of Enhanced Hardware Development (EHD) 8056. The Efficiency Design Principles 8814, Stability Design Principles 8818, and Required User Functionality 8810 are supplied as initial input to the Idealistic Configuration Invocation Prompt (ICIP) 8822. ICIP 8822 produces a Prompt 8823 that interacts directly with LOM 132 to invoke the production of the Ideal Hardware Configuration 8824 with consideration of the input criteria Efficiency Design Principles 8814, Stability Design Principles 8818, and Required User Functionality 8810. The Prompt 8823 produced by ICIP 8822 is submitted to the Initial Query Reasoning (IQR) C802A module of LOM 132. When LOM 132 is invoked directly within the UBEC Platform 100 by an UBEC User 106, IQR C802A receives the initial question/assertion provided by the UBEC User 106. However this instance of LOM 132 is automatically invoked by ICIP 8822 instead. The provided Prompt 8823 is analyzed via invocation of Central Knowledge Retention (CKR) 648 to decipher Missing Details from the Prompt 8823 that are crucial to complete the correct ‘virtual understanding’ by LOM 132 for LOM 132 to fully address/respond to the Prompt 8317. The resultant Missing Details produced by IQR C802A are submitted as modular input to Survey Clarification (SC) C803A. SC C803A engages with the origin of the Prompt 8317 to retrieve supplemental information so that the Prompt 8318 can be analyzed objectively and with all the necessary context. When LOM 132 is invoked directly within the UBEC Platform 100 by an UBEC User 106, SC C803A engages with that User 106 as the origination of the question/answer. However this instance of LOM 132 is automatically invoked by DIP 8316 instead, therefore SC C803A engages with ICIP 8822 to retrieve supplemental information concerning the Prompt 8823. The fully formed and refined version of the Prompt 8823 is produced from SC C803A and submitted as modular input to Assertion Construction (AC) C808A. AC C808A attempts to form a coherent response to the Prompt 8317 by referencing CKR 648 directly and also via Hierarchical Mapping (HM) C807A. Rational Appeal (RA) C811A is a container module that houses a logic flow interface with CTMP 124. RA C811A uses CTMP 124 to criticize assertions. Such criticisms can be in the form of self-criticisms (by criticizing the output of AC C808A), or external criticisms to the origin of the question/assertion processed by IQR C802A (UBEC User 106 or ICIP 8822). If an assertion produced from AC C808A fails a significant measure of the self-criticism test processed by RA C811A; then a new instance of AC C808A is invoked to account for any valid criticisms. If a high confidence assertion is produced by AC C808A that consistently passes self-criticism tests processed by RA C811A; then the assertion is produced as LOM's 132 modular output, referenced as the Ideal Hardware Configuration 8824 in context of the initial Prompt 8823 provided by ICIP 8822.

FIG. 808 shows more detail of the internal operation procedure of Rational Appeal (RA) C811A of LOM 132 in regards to Stage 8828 of EHD 8056. Assertion Construction (AC) C808A provides a Response Presentation C843 to Rational Appeal (RA) C811A concerning the assertion produced by AC C808A in regards to the corresponding input Prompt 8823. At this stage of the logic flow, the produced assertion is classified as a Pre-Criticized Decision C847. This indicates that it is has yet to be processed via criticism by CTMP 124. Therefore the produced assertion is directly submitted to the CTMP 124 instance as a ‘Subjective Opinion’ C848 input, and also to Context Construction (CC) C817A which provides the ‘Objective Fact’ C850 input to the CTMP 124 instance. CC C817A references metadata from AC C808A and potential evidence provided via ICIP 8822 to submit raw facts to CTMP 124 for critical thinking. Such input metadata is represented by the LOM Log Aggregate 5502 file. The LOM Log Aggregate 5502 contains a collection of relevant log files that are produced from the primary operating functions of LOM 132. After the CTMP 124 Instance concludes it's operation, a Post-Criticized Decision C851 is produced as modular output. The initial Pre-Criticized Decision C847 and Post-Criticized Decision C851 are submitted to the Decision Comparison (DC) C818A module which determines the scope of potential overlap between the two inputs C847 and C851. The unified output provided by DC 818A can either indicate CTMP's 124 Concession C852 (of incorrectness) on behalf of the AC C808A produced assertion, or a perceived Improvement C853 on behalf of the AC C808A produced assertion. Both Argument Responses C852 and C853 can be classified as either Low Confidence Results C845 or High Confidence Results C846. A Low Confidence Result C845 indicates that the original assertion produced by AC C808A is flawed and should be reconstructed; therefore the logic flow continues to a new instance of AC C808A. A High Confidence Result C846 indicates that the original assertion produced by AC C808A has merit, therefore the drawn conclusions (coupled with any corresponding evidence, premises etc.) are submitted to Knowledge Validation (KV) C805A. Therefore the logic flow continues to a new instance of KV C805A so that CKR 846 and hence LOM 132 can benefit from the recently processed assertion.

FIG. 809 continues the logic flow of Stage 8828 from EHD 8056 to illustrate the production of the LOM Log Aggregate 5502 file. Modular outputs produced from Initial Query Reasoning (IQR) C802A, Survey Clarification (SC) C803A, Assertion Construction (AC) C808A, Hierarchical Mapping (HM) C807A and Knowledge Validation (KV) C805A are submitted to the LOM Modular Log Collection (LMLC) 5500 module. Therefore LMLC 5500 combines the input log data into a single readable file referenced as LOM Log Aggregate 5502. The File 5502 encompasses the overall operational state of the corresponding LOM 132 instance, hence providing information as to how the LOM 132 instance reached various conclusions. The LOM Log Aggregate 5502 is submitted to CC C817A of Rational Appeal (RA) C811A.

FIG. 810 expands on operational details concerning FIG. 809 to illustrate the internal operation of CTMP 124 in regards to the input and output channels defined in Rational Appeal (RA) C811A. The Pre-Criticized Decision C847 is Presented C843 as modular output from Assertion Construction (AC) C808A. The Decision C847 is then marked as a Subjective Opinion C848, therefore fulfilling one of the two major inputs of CTMP 124. The Subjective Opinion C848 is submitted to Input System Metadata C484, which acts as the primary modular input for CTMP 124 and an internal representation of the Selected Pattern Matching Algorithm (SPMA). For this instance configuration; the SPMA is LOM 132. Input System Metadata C484 is submitted for processing to Reason Processing C456 and to Raw Perception Production (RP²) C465. Reason Processing C456 will logically understand the assertions being made by comparing property attributes. RP² C465 parses the Input System Metadata C484 from LOM 132 to produce a perception in Perception Complex Format (PCF) that represents the algorithmic perception of LOM 132. Such a produced Perception is submitted to the Perception Observer Emulator (POE) C475 which emulates the algorithmic perception of LOM 132. Reason Processing C456 invokes Rule Processing which eventually produces rulesets that reflect the SPMA algorithm which in this instance is LOM 132. Therefore two modes of ‘thinking’ are executed, ‘analogue’ perception and ‘digital’ ruleset processing. These two Branches C461 and C475 represent similitudes with intuition and logic. The results produced by both thinking Branches C461 and C475 are transferred to Critical Decision Output (CDO) C462, which evaluates any fundamental elements of conflict or corroboration between the results. Upon finding a high magnitude of internal corroboration, and a low magnitude of internal conflict CTMP 124 provides a binary Approve or Block decision, in regards to the initial input Subjective Opinion C848, that is referenced as a High Confidence Result C846. If there is a low magnitude of internal corroboration and a high magnitude of internal conflict CTMP 124 submits a ‘vote of no confidence’ which is referenced as a Low Confidence Result C845. Therefore the resultant output of CTMP 124 is considered the Post-Criticized Decision C851.

FIG. 811 shows more details concerning the invocation of Raw Perception Production (RP²) C465 within CTMP 124. LOM 132 produces the Ideal Framework Structure 8750 by invoking Assertion Construction (AC) C808A. The Ideal Framework Structure 8750 is then submitted to Stage 5506 of RP² C465 which unpacks the data to produce instances of a Debugging Trace C485 and Algorithm Trace C486 within the Input System Metadata C484 which originates from the corresponding AC C808A instance. Debugging Trace C485 is a coding level trace that provides variables, functions, methods and classes that are used along with their corresponding input and out variable type and content. The full function call chain (function trace: functions calling other functions) is provided. The Algorithm Trace C486 is a software level trace that provides security data coupled with algorithm analysis. The resultant security decision (approve/block) is provided along with a logistics trail of how it reached the Decision C847. The appropriate weight concerning each factor that contributed to producing the Decision C847 is included. Thereafter RP² C465 transfers the data concerning the produced perception result to Perception Observer Emulator (POE) C475 for processing.

FIG. 812 elaborates on the operation of Raw Perception Production (RP²) C465 from within CTMP 124. Initially Stage 5506 occurs, as it does on FIG. 811, to unpack the data to produce instances of a Debugging Trace C485 and Algorithm Trace C486 within the Input System Metadata C484 which originates from the corresponding AC C808A instance. At Stage 5508, Metric Processing C489 reverse engineers the variables from LOM 132 to extract perceptions from the artificial intelligence exhibited by LOM 132. Thereafter Input System Metadata C484 is processed by Stage 5510, which separates Metadata C484 into meaningful security cause-effect relationships via System Metadata Separation (SMS) C487. As also indicated by FIG. 811, RP² C465 transfers the data concerning the produced perception result to Perception Observer Emulator (POE) C475 for processing.

FIG. 813 elaborates on the operation of Perception Observer Emulator (POE) C475, include it's and Raw Perception Production's (RP²) C465 relation to Perception Storage (PS) C478. The operation of Metric Processing C489 and System Metadata Separation (SMS) C487 both lead to the production of Perceptions 5512/5514/5516 that are thereafter stored in PS C478. The resulting Perceptions 5512/5514/5516 represent LOM's 132 modular response of producing the Ideal Hardware Configuration 8824 via Assertion Construction (AC) C808A. RP² C465 produces a Comparable Variable Format datapoint which is fed into Storage Search (SS) C480 as search criteria. Thereafter SS C480 performs a lookup of PS C478 to find matches with already existing Perceptions stored in PS C478. The Results C716 of the execution SS C480 are produced which leads to a Weight Calculation C718. Such a Calculation C718 attempts to find the correct distribution of corresponding Perceptions from PS C478 to replicate and match the Comparable Variable Format which represent's the execution of the LOM 132 algorithm that produced Ideal Framework Structure 8750.

FIG. 814 continues the Perception Observer Emulator (POE) C475 logic from FIG. 813. After the production of Results C716 from Storage Search (SS) C480, the Weight Calculation C718 completes to lead to the Application C729 of the Perceptions 5512/5514/5516 to make an active Approve C731 or Block C730 decision. The Ideal Framework Structure 8750 produced by LOM 132 and corresponding LOM Log Aggregate 5502 undergo Data Parsing C724 which causes Data Enhanced Logs C723 to be derived which are applied in the Application C729 to achieve an Interpretation Dichotomy 5518 of a Positive Sentiment (Approve) C731 or Negative Sentiment (Block) C730 with regards to the input Ideal Hardware Configuration 8824. Upon successful conclusion of the execution of Application C729 leads to an Override Corrective Action C476 which is processed by Critical Decision Output (CDO) C462 in parallel to the modular output of Rule Execution (RE) C461. The Self-Critical Knowledge Density (SCKD) C474 module estimates the scope and type of potential unknown knowledge that is beyond the reach of the reportable LOM Log Aggregate 5502. This way the subsequent critical thinking features of the processing CTMP 124 instance can leverage the potential scope of all involved knowledge, known and unknown directly by the instance.

FIG. 815 shows the Memory Web C460 process that operates in parallel to the execution of Perception Observer Emulator (POE) C475 in FIG. 814. The Ideal Hardware Configuration 8824 produced by LOM 132 is submitted as modular input to Reason Processing C456. Reason Processing C456 processes how LOM 132 achieved the decision to produce the Ideal Hardware Configuration 8824 in response to the Prompt 8823 provided by ICIP 8822. The processing conclusion of Reason Processing C456 is the execution of Reason Processing C457, which defines the rules that are thirdly consistent with LOM's 132 execution behavior. If any inconsistencies are found in rule behavior with regards to LOM's 132 execution behavior, then currently existing rules are modified or new rules are added. Such rules are later used within the CTMP 124 instance to criticize decision making behaviors found within the corresponding LOM 132 instance. Critical Rule Scope Extender (CRSE) C458 then leverages known Perceptions to expand the ‘critical thinking’ scope of the rulesets, in effect enhancing the rulesets to produce Correct Rules C459. The Correct Rules C459 are then submitted as modular input to Rule Syntax Format Separation (RSFS) C499 from within the operating jurisdiction of Memory Web C460. RSFS C499 separates and organizes Correct Rules C459 by type. Therefore all actions, properties, conditions and objects are listed separately after RSFS C499 processing. This enables the CTMP 124 instance to discern what parts have been found in the Chaotic Field, and what parts have not. Chaotic Field Parsing (CFP) C535 combines and formats the LOM Log Aggregate 5502 into a single scannable unit referenced as the Chaotic Field. The Chaotic Field is submitted as modular input to Memory Recognition (MR) C501. MR C501 also receives the Original Rules C555 which is the execution result from RSFS C499. MR C501 scans the Chaotic Field provided by CFP C535 to recognize knowable concepts defined in Original Rules C555. This MR C501 instance execution produces Recognized Rule Segments C556. Thereafter Rule Fulfillment Parser (RFP) C498 receives individual parts of the Original Rules C555 that have been tagged according to their recognition or lack-thereof within the Chaotic Field by MR C501. RFP C498 can then logically deduce which whole ruleset (the combination of all of their parts) have been sufficiently recognized in the Chaotic Field to merit processing by Rule Execution (RE) C461. Upon successful conclusion of the execution of RE C461 leads to an Override Corrective Action C476 which is processed by Critical Decision Output (CDO) C462 in parallel to the modular output of Perception Observer Emulator (POE) C475.

FIG. 816 elaborates on the logic flow interaction between Perception Storage (PS) C478 and the Automated Perception Discovery Mechanism (APDM) C467. PS C478 contains four subsets of Perceptions: Deduced Unknown Angles of Perception C473, All Angles of Perception C472, Implied Angles of Perception C471, and Applied Angles of Perception C470. Applied Angles of Perception C470 are Perceptions that have been directly imported by studying algorithmic behavior of the Selected Pattern Matching Algorithm (SPMA), which in this instance is LOM 132. Implied Angles of Perception C471 are Perceptions that have been derived from Applied Angles of Perception C470 via modular execution of Implication Derivation (ID) C477 and APDM C467. All Angles of Perception C472 represents the entire scope of known Perceptions to the CTMP 124 instance that have not been included by Applied Angles of Perception C470 and Implied Angles of Perception C471. Deduced Unknown Angles of Perception C473 represents the scope of Perceptions that is expected to exist yet the CTMP 124 instance has yet to discover according to the Self-Critical Knowledge Density (SCKD) C474 module. ID C477 analyzes the individual metrics of Applied Angles of Perception C470 to deterministically derive Implied Angles of Perception C470, whilst APDM C467 creatively varies compositions of Angles of Perception C650 via the Creativity Module 112 to produce a New Iteration C653 that combines the initial two input Weights C652. Therefore all of the Angles of Perception C650 involved with APDM C467 processing correspond with and represent the Confident Security Assertion 8320 that is produced by LOM's 132 Assertion Construction (AC) C808A module.

FIG. 817 elaborates on the operational details concerning the Critical Rule Scope Extender (CRSE) C458 of CTMP 124. A Rational Appeal (RA) C811A instance operates within LOM 132 and invokes Context Construction (CC) C817A to process the LOM Log Aggregate 5502 to Chaotic Field Parsing (CFP) C535. CFP produces a Chaotic Field from the modular output of CC C817A which is referenced by Memory Recognition (MR) C501. Current Rules C534 exhibits rulesets that are indicative of the current functioning state of the Selected Pattern Matching Algorithm (SPMA) which in this instance is LOM 132. Current Rules C534 is submitted as modular input to the Rule Syntax Derivation (RSD) C504 module, which is where logical ‘black and white’ rules are converted to metric based perceptions. Therefore the complex arrangement of multiple rules are converted into a single uniform perception that is expressed via multiple metrics of varying gradients. The modular output of RSD C504 is provided as modular input to Perception Matching (PM) C503. At PM C503; a Comparable Variable Format (CVF) unit is formed from the Perception received from RSD C504. The newly formed CVF is used to lookup relevant Perceptions in the Perception Storage (PS) C478 with similar indexes. The potential matches are submitted as modular input to Rule Syntax Generation (RSG) C505. RSG C505 receives previously confirmed perceptions which are stored in Perception format and accesses the Perception's internal metric makeup. The Perceptions are received from PS C478 which contains Previously Confirmed Perceptions C468. Such gradient-based measures of metrics are converted to binary and logical rulesets that emulate the input/output information flow of the original perception. Therefore RSG C505 produces Perceptive Rules C537 which are Perceptions that are considered relevant, popular and have been converted into logical rules. If a Perception (in it's original Perception Format) had many complex metric relationships that defined many ‘grey areas’, the ‘black and white’ local rules encompass such ‘grey’ areas by expanding on the ruleset complexity. Therefore the Perceptive Rules C537 are stored by a collection of Rule Syntax Format (RSF) definitions. Perceptive Rules C537 are submitted as modular input to Memory Recognition (MR) C501, where they are scanned against the Chaotic Field which was produced by CFP C535. Therefore MR C501 produces Extra Rules C536 which complete Correct Rules C533 in their validity.

FIG. 818 elaborates on the operational details concerning Implication Derivation (ID) C477 of CTMP 124. The Applied Angles of Perception C470 from Perception Storage (PS) C478 are submitted as modular input to ID C477 to produce more Perceptions that belong to Implied Angles of Perception C471. The Applied Angles of Perception C470 are specifically sent to Metric Combination C493 of ID C477. Metric Combination C493 separates the received Angles of Perception C650 into categories of metrics: Scope C739, Type C740, Consistency C741, Intensity C742. The Metric availability and reference within the system is not necessarily limited to these four types. The input Angles of Perception C650 are related to the Purpose Replacement 8258 that was produced by LOM's 132 Assertion Construction (AC) C808A module. The Metric Complexity Set A C736 is submitted as modular input to Metric Expansion (ME) C495. With ME C495 the metrics of multiple and varying Angles of Perception C650 are stored categorically in individual databases C739/C740/C741/C742. ME C495 enhances the current batch of received metrics with details/complexity extracted from previously known/encountered metrics. Upon enhancement and complexity enrichment completion, the metrics are returned as ME C495 modular output as Metric Complexity Set B C737 and thereafter converted back into Angles of Perception C650 to be stored in Implied Angles of Perception C471 as illustrated on FIG. 819.

FIG. 819 continues the logic flow of Implication Derivation (ID) C477 from FIG. 818, illustrating the Metric Complexity Set B C737 being processed by Metric Conversion C494 which reverses individual metrics back into whole Angles of Perception C650. Despite the enrichment and conversion process performed by ID C477, the resultant Angles of Perception C650 still provide a reasonably accurate representation of the Purpose Replacement 8258 produced by LOM's 132 Assertion Construction (AC) C808A module. Therefore the Metric Conversion C494 process submits the newly derived/implied Angles of Perception C650 to Implied Angles of Perception C471 within Perception Storage (PS) C478.

FIG. 820 elaborates on the operational details concerning Critical Decision Output (CDO) C462 of CTMP 124. CDO C462 receives modular output from both major branches of CTMP 124: Perception Observer Emulator (POE) C475 (as the intuition branch) and Rule Execution (RE) C461 (as the logical branch). Each Branch C475/461 submits it's respective Critical Decision C521 (the main modular output) as well as corresponding the ‘Meta-metadata’ C521, which provides contextual variables that justify why the initial critical decision was reached. Both Decision Sets C521 that represent the Perceptions C516 of POE C475 and the Fulfilled Rules C517 of RE C461 are submitted to the Metadata Categorization Module (MCM) C488. MCM C488 separates the Debugging and Algorithm Traces into distinct categories using traditional syntax based information categorization. Such categories can then be used to organize and produce distinct security responses with a correlation to security risks and subjects. The Intuitive Decision C514, which represents Perceptions C526 from POE C475, and the Thinking Decision C515, which represents Fulfilled Rules C517 from RE C461 are submitted by MCM C488 to the Internal Processing Logic 5520 of Direction Decision Comparison (DDC) C512. The Internal Processing Logic 5520 of DDC C512 checks for corroboration or conflict between the Intuitive Decision C514 and the Thinking Decision C515. DDC C512 references a ‘cutoff’ variable from Static Hardcoded Policy (SHP) 488. If the ‘cutoff’ variable is not reached for similarity between the Intuitive Decision C514 and the Thinking Decision C515 (i.e. 90%+), then the Cancel Direct Comparison 5524 directive occurs, which might lead the Terminal Output Control (TOC) C513 to eventually submit a Vote of No Confidence 5544 as shown on FIG. 821. The Cancel Direct Comparison 5524 stage implies that CTMP 124 was unable to act internally consistent in regards to the input Prompt 8268 from RIP 8266. If the ‘cutoff’ variable was sufficiently met according to the Internal Processing Logic 5520, then the Final Decision Output 5522 stage is invoked which combines both Decisions C514/C515 into a single modular output which is received and processed by TOC C513.

FIG. 821 continues the logic flow of Critical Decision Output (CDO) C462 from FIG. 794 and elaborates on the operational details of Terminal Output Control (TOC) C513. TOC C513 initiates with Prompt 5526, which checks if Direct Decision Comparison (DDC) C512 was able to provide a Final Decision Output 5522 (instead of the Cancel Direct Comparison 5524 directive). If the response to Prompt 5526 is Yes 5528, then the combined final decision provided by DDC C512 at Final Decision Output 552 is submitted as modular output of TOC C513 and hence as modular output of the entire CTMP 124 instance as the Final Critical Decision 5542 output. If the response to Prompt 5526 is No 5530, then Stage 5532 is invoked which it itself invokes the execution of Perception Matching (PM) 5532 and fetches the corresponding results. Fulfilled Rules C517 are extracted from the Critical Decision+Meta-metadata C521 of Rule Execution (RE) C461. The Rules C517 are converted to Perceptions by Rule Syntax Derivation (RSD) C504. PM 5532 then references Meta-metadata to determine, at Prompt 5534, if there was a strong internal overlap and corroboration of Perceptions used. If the response to Prompt 5534 is Yes 5538 this indicates a Vote of No Confidence 5544 on behalf on CTMP 124 as modular output. If the response to Prompt 5534 is No 5536 then Stage 5540 is activated, which selects the perceived least risky decision between the Intuitive Decision C514 and Thinking Decision C515. Therefore the Final Critical Decision 5542 is subsequently submitted as modular output to CDO C462, TOC C513, and CTMP 124. The logic at Stage 5534 occurs to determine if the lack of unity between the Intuitive Decision C514 and Thinking Decision C515 occurs because of a general lack of algorithmic confidence, or due to highly opposing points of view between the two. Therefore if the latter were to occur, a potential Final Critical Decision 5542 is still discernible as modular output. A Vote of No Confidence 5544 always leads to the Low Confidence Result C845 logic pathway within Rational Appeal (RA) C811A. The Final Critical Decision 5542 can either lead to a High Confidence Result C846 or Low Confidence Result C845 logic pathway within RA C811A, depending on the algorithmic confidence behind the Final Critical Decision 5542.

FIG. 822 shows details concerning the operation of LIZARD 120 to convert Ideal Hardware Configuration 8824 into a Purpose Hierarchy Map 8826. Ideal Hardware Configuration 8824 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. Ideal Hardware Configuration 8824 is received in Hardware Syntax 8825 format by Code Translation C321. Code Translation C321 converts arbitrary (generic) code which Is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 823 continues the logic flow from FIG. 822 to illustrate the operation of LIZARD 120 to convert Ideal Hardware Configuration 8824 into a Purpose Hierarchy Map 8826. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as Purpose Hierarchy Map 8826 which is presented as the Complex Purpose Format C325 version of Ideal Hardware Configuration 8824. The same definition and application of Inner Core (IC) C333 applies for the aforementioned functions and modules.

FIG. 824 shows Enhanced Hardware Development (EHD) 8056 process where Idealistic Configuration Invocation Prompt (ICIP) 8830 provides with Ideal Hardware Configuration 8824. LIZARD 120 converts the Ideal Hardware Configuration 8824 into a Purpose Hierarchy Map 8826 at Stage 8834. At Stage 8836 LOM 132 Produces Electrical Engineering Principles 8838 from CKR 648 and send them to LIZARD 120. LIZARD 120 converts the Electrical Engineering Principles 8838 into Purpose Hierarchy Map 8842 at Stage 8840. Purpose to Purpose Symmetry Processing (P2SP) 7000 utilizes Purpose Hierarchy Map 8842 and Purpose Hierarchy Map 8826 and creates a Symmetry Processing Result 8844 which determines if the Purpose Hierarchy Map 8826 of the Ideal Hardware Configuration 8824 is compatible with the Purpose Hierarchy Map 8842 of the Electrical Engineering Principles? 8838 at Stage 8846.

FIG. 825 shows Enhanced Hardware Development (EHD) 8056 process where LOM 132 produces Electrical Engineering Principles 8838 from Central Knowledge Retention CKR 648 at Stage 8836 based on Design Principle Invocation Prompt (DPIP) 8648. LOM builds concepts overtime within CKR 648 from data retrieved by ARM 134 that facilitates the determination process for Electrical Engineering Principles 8838. CKR 648 builds a strong base of definitions via innate advanced reasoning, and is able to justify any conclusions 8838 that LOM outputs. With Cluster Building C854F CKR 648 reaches conceptual conclusions via ‘stacking’ building blocks of information known as Unit Knowledge Format (UKF) Clusters C854F. These clusters encompass a wide range of metadata concerning the targeted information such as attributable sources, times of suspected information creation, efficiency, design, etc. Each UKF Cluster C854F contains Rule Syntax Format (RSF) C538.

FIG. 826 shows details concerning the operation of LIZARD 120 to convert Electrical Engineering Principles 8838 into a Purpose Hierarchy Map 8842. Electrical Engineering. Principles 8838 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. Electrical Engineering Principles 8838 is received in Principle Syntax 8147 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120

FIG. 827 continues the logic flow from FIG. 826 to illustrate the operation of LIZARD 120 to convert Electrical Engineering Principles 8838 into a Purpose Hierarchy Map 8842. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as Purpose Hierarchy Map 8842 which is presented as the Complex Purpose Format C325 version of Electrical Engineering Principles 8838. The same definition and application of Inner Core (IC) C333 applies for the aforementioned functions and modules.

FIG. 828 shows Enhanced Hardware Development (EHD) 8056 process for Dynamic Hardware Deployment Mechanism (DHDM) 8860. Symmetry Processing Result 8844 is determined at Stage 8846 to check if the Purpose Hierarchy Map of the Ideal Hardware Configuration compatible with the Purpose Hierarchy Map of the Electrical Engineering Design Principles? If No, not compatible 8850, it submits a DLU 1182 with the Official System Token 1184 to the Diagnostic Log Submission (DLS) 1160 of Automated Research Mechanism (ARM) 134. If the Result from Stage 8846 is Yes, compatible 8848 it Submits the Ideal Hardware Configuration to DHDM 8860 at Stage 8852.

FIG. 829 continues the logic flow from FIG. 828 for the Enhanced Hardware Development (EHD) 8056 process for Dynamic Hardware Deployment Mechanism (DHDM) 8860 with Dynamic Liquid Conductive Board (DLCB) 8856 targets DLCB Collection 8858 to survey the DLCB 8862. At Stage 8864 it Accesses the Dynamic Modification Invocation Chips (DMIC) of the DLCB Target Collection and at Stage 8866 Categorizes DLCBs between those that have a locked DMIC and those with an unlocked DMIC. At Stage 8872, submits all of the DLCBs from the Unlocked DMIC Cache Retention (UDCR) 8870 to Specification Rollout Mechanism (SRM) 8786 for installation of the Ideal Hardware Configuration. At Stage 8874 enacts Manufacturer Negotiation Settlement (MNS) for all of the DLCBs from Locked DMIC Cache Retention (LDCR) 8868. DLCB Original Manufacturer 8854 interacts with MNS 8876 which inputs to Specification Rollout Mechanism (SRM) 8786.

FIG. 830 to FIG. 832 show the process for UBEC Automated Deployment (UAD) 8900 which starts at Stage 188 where SPSI 130 submits software, firmware, and hardware updates to the core code structure of UBEC 192. Deployment Targeting Mechanism (DTM) 8902 forwards the received updates to Deployment Target 8904. At Stage 8906 An instance of the UBEC/BCHAIN Hybridized Core Logic 190 is prepared for deployment in the Deployment Target 8904. The Interface Drivers 212 are updated to be in full compliance with the relevant up to date specifications of the Deployment Target 8904 at Stage 8908. At Stage 8910, the Interface Drivers are installed into the selected instance of the UBEC/BCHAIN Hybridized Core Logic 190. The updated Application, that has been assembled from the instance of the UBEC/BCHAIN Hybridized Core Logic 190, is submitted to the Deployment Target 8904, at Stage 8912.

FIG. 831 continues the process from FIG. 830 for UBEC Automated Deployment (UAD) 8900 Stage 8906, An instance of the UBEC/BCHAIN Hybridized Core Logic 190 is prepared for deployment in the Deployment Target. At Stage 8914, The authorized repository Appchain for storing the UBEC/BCHAIN Hybridized Core Logic 190 is looked up on Appchain Updates 846 of the Metachain 834 according to the Appchain Identity provided by Registered Appchains 776. At Stage 8916, A request for the UBEC/BCHAIN Hybridized Core Logic 190 content is made via Content Claim Generator (CCG) 3050 of the BCHAIN 196.

FIG. 832 continues the process from FIG. 831 for UBEC Automated Deployment (UAD) 8900 Stage 8908, The Interface Drivers are updated to be in full compliance with the relevant up to date specifications of the deployment Target. At Stage 8918, The Interface Specifications 8920 are referenced from definitions within the Deployment Target 8904. At Stage 8922, A generic Interface Drivers 212 base is referenced for modification to become compliant with the Interface Specification 8920. LIZARD 120 converts the Interface Drivers 212 Base into a Purpose Hierarchy Map 8928 at Stage 8924. LIZARD converts the Interface Specifications 8920 into a Purpose Hierarchy Map 8930 at Stage 8926.

FIG. 833 shows details concerning the operation of LIZARD 120 to convert Interface Drivers 212 into a Purpose Hierarchy Map 8928. Interface Drivers 212 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. Interface Drivers 212 is received in Driver Specifications 8925 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 834 continues the logic flow from FIG. 833 to illustrate the operation of LIZARD 120 to convert Interface Drivers 212 into a Purpose Hierarchy Map 8928. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as Purpose Hierarchy Map 8928 which is presented as the Complex Purpose Format C325 version of Interface Drivers 212. The same definition and application of Inner Core (IC) C333 applies for the aforementioned functions and modules.

FIG. 835 shows details concerning the operation of LIZARD 120 to convert Interface Specifications 8920 into a Purpose Hierarchy Map 8930. Interface Specifications 8920 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. Interface Specifications 8920 is received in Framework Specifications 8975 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 836 continues the logic flow from FIG. 835 to illustrate the operation of LIZARD 120 to convert Interface Specifications 8920 into a Purpose Hierarchy Map 8930. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as Purpose Hierarchy Map 8930 which is presented as the Complex Purpose Format C325 version of Interface Specifications 8920. The same definition and application of Inner Core (IC) C333 applies for the aforementioned functions and modules.

FIG. 837 shows UBEC Automated Deployment 8900 details at Stage 8908, The Interface Drivers are updated to be in full compliance with the relevant up to date specifications of the Deployment Target. At Stage 8932, Both Purpose Hierarchy Maps 8930 and 8932 are submitted to Purpose Realignment Processing (PRP) 7050, with the Map derived from Interface Drivers 8928 as the Slave and the Map derived from the Interface Specifications 8920 as the Master to Master/Slave Affinity 1480. At Stage 8936, An Upgraded Purpose Map 8934 is produced which represents the Interface Drivers 212 made compatible with the Interface Specifications 8920. LIZARD 120 converts the upgraded Purpose Map 8934 into Interface Drivers 212 at Stage 8938.

FIG. 838 shows UBEC Automated Deployment 8900 details at Stage 8910, The Interface Drivers are installed into the selected instance of the Hybridized Core. At Stage 8940, The Modular Interface Plugin 194 is selected within the Hybridized Core Logic Instance 8918. LIZARD 120 installs the Interface Drivers 212 into the Modular Interface Plugin 194 using predefined API Hook References 8944, at Stage 8942.

FIG. 839 shows UBEC Automated Deployment 8900 details at Stage 8942, LIZARD installs the Interface Drivers into the Modular Interface Plugin using predefined API hooks. At Stage 8942, LIZARD 120 installs the Interface Drivers 212 into the Modular Interface Plugin 194 using predefined API Hook References 8944. At Stage 8946 it Loops through all of the defined API Hook References 8944. At Stage 8950, verify that the Selected API Hook Reference Unit 8948 exists in the Modular Interface Plugin 194. If Unit Does Not Exist 8952, it Submits a DLU with the Official System 5600. If Unit Exists 8954 it proceeds to Stage 8956 where it Stores a reference of the part of Modular Interface Plugin 194 that corresponds with the Selected API Hook Reference Unit 8948 in Hook Location Cache Retention (HLCR) 8958. At Stage 8960, verifies that the Selected API Hook Reference Unit 8948 exists in the Interface. If Unit Does Not Exist 8964, it Submits a DLU with the Official System at 5600. If the Unit Exists 8962, Stores a reference of the part of Interface Drivers that corresponds with the Selected API Hook Unit 8948.

FIG. 840 continues the logic from FIG. 839 to show UBEC Automated Deployment 8900 details at Stage 8942, LIZARD installs the Interface Drivers into the Modular Interface Plugin using predefined API hooks. At Stage 8966, it Retrieves the parts from Interface Drivers 212 and Modular Interface Plugin 194 that are referenced with the API Hook Reference Unit 8964 from Hook Location Cache Retention (HLCR) 8958. At Stage 8970, LIZARD 120 converts the Modular Interface Plugin 194 Referenced Part to Purpose Hierarchy Map 8972 and at Stage 8976, LIZARD 120 converts the Interface Drivers 212 Referenced Part to Purpose Hierarch Map 8978.

FIG. 841 shows details concerning the operation of LIZARD 120 to convert Modular Interface Plugin Referenced Part 8968 into a Purpose Hierarchy Map 8972. Modular Interface Plugin Referenced Part 8968 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. Modular Interface Plugin Referenced Part 8968 is received in Driver Specifications 8925 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 842 continues the logic flow from FIG. 841 to illustrate the operation of LIZARD 120 to convert Modular Interface Plugin Referenced Part 8968 into a Purpose Hierarchy Map 8972. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as Purpose Hierarchy Map 8972 which is presented as the Complex Purpose Format C325 version of Modular Interface Plugin Referenced Part 8968. The same definition and application of Inner Core (IC) C333 applies for the aforementioned functions and modules.

FIG. 843 shows details concerning the operation of LIZARD 120 to convert Interface Drivers Referenced Part 8974 into a Purpose Hierarchy Map 8978. Interface Drivers Referenced Part 8974 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. Interface Drivers Referenced Part 8974 is received in Framework Specifications 8975 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load. Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 844 continues the logic flow from FIG. 843 to illustrate the operation of LIZARD 120 to convert Interface Drivers Referenced Part 8974 into a Purpose Hierarchy Map 8978. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as Purpose Hierarchy Map 8978 which is presented as the Complex Purpose Format C325 version of Interface Drivers Referenced Part 8974. The same definition and application of Inner Core (IC) C333 applies for the aforementioned functions and modules.

FIG. 845 shows UBEC Automated Deployment (UAD) 8900 details at Stage 8942, LIZARD 120 installs the Interface Drivers into the Modular Interface Plugin using predefined API hooks. Purpose to Purpose Symmetry (P2SP) 7000 analyzes the Purpose Hierarchy Map 8972 with Modular Interface Plugin Referenced Part 8968 and Purpose Hierarchy Map 8978 with Interface Drivers Referenced Part 8974. The Symmetry Processing Result 8980 in reviewed at Stage 8982 to see if the Purpose Hierarchy Map 8972 of Modular Interface Plugin Referenced Part 8968 is congruent with the Purpose Hierarchy Map 8978 of the Interface Drivers Referenced Part 8974? It Yes, congruent 8984, it proceeds to Stage 8988 where Using the Syntax Module (SM) C35 via LIZARD 120, the Modular Interface Plugin Referenced Part is modified to become fulfilled by the corresponding Interface Drivers Referenced. If No, not congruent 8986, it Submits a DLU with the Official System 5600.

FIG. 846 shows UBEC Automated Deployment (UAD) 8900 details at Stage 8912, where the updated Application, that has been assembled from the instance of the Hybridized Core Logic, is submitted to the Deployment Target. LIZARD 120 installs the Interface Drivers 212 into the Modular Interface Plugin 194 using predefined API hooks at Stage 8942. At Stage 8990 LIZARD 120 alters the container references of the modified Hybridized Core Logic Instance 8918 so that it manifests as a containing Application Package. At Stage 8992, checks to see Does the Deployment Target 8904 require that the Application be submitted in Raw Source Code 8994 or in a Binary 8996.

FIG. 847 continues the logic from FIG. 846 for UBEC Automated Deployment (UAD) 8900 details at Stage 8912, where the updated Application, that has been assembled from the instance of the Hybridized Core Logic, is submitted to the Deployment Target. At Stage 9001 (mislabeled as 9000), checks to see Does the Deployment Target 8904 define an up-to-date Deployment Strategy Routine 9000. If Yes 9004, proceeds to Stage 9006 where The UBEC/BCHAIN Application is submitted to the Deployment Target 8904 via the defined Deployment Strategy Routine 9000. If No 9002, submits a DLU 1182 with the official system Token 1184 at Stage 5000 to Diagnostic Log Submission (DLS) 1160 of ARM 134.

FIG. 848 shows Stages of Appchain Adoption (SA2) 9100 with Stage 1—Full Legacy 9102 containing Legacy System 9104 which consists of Legacy API and Framework 9106. At 9112 it Converts Program from Legacy Operation 9108 to Appchain 9118. SPSI performs efficiency and functionality upgrades, maintenance, and general modifications to the Program as a Legacy 9110. Stage 2—Emulated Appchain Over Legacy 9116 contains the Legacy System 9104 which consists of Legacy API and Framework 9106 which contains the Appchain Emulation Layer (AEL) 8058. SPSI performs efficiency and functionality upgrades, maintenance, and general modifications to the Program as an Appchain 9120.

FIG. 849 shows Stages of Appchain Adoption (SA2) 9100 with Stage 2—Emulated Appchain over Legacy 9116 contains the Legacy System 9104 which consists of Legacy API and Framework 9106 which contains the Appchain Emulation Layer (AEL) 8058. SPSI performs efficiency and functionality upgrades, maintenance, and general modifications to the Program as an Appchain 9120. At Stage 9122 it Deploys Program as an Appchain 9126 to BCHAIN Network for increased availability, reliability, speed, efficiency, security, etc. SPSI performs efficiency and functionality upgrades, maintenance, and general modifications to the Program as an Appchain 9128.

FIG. 850 shows Legacy to BCHAIN Deployment (LBD) 9200 with Stages of Appchain Adoption (SA2) 9100 with Deploy Program as an Appchain to BCHAIN Network for increased availability, reliability, speed, etc. 9122. The Legacy Administration 8086 explicitly opts for the Target Appchain to be deployed to the BCHAIN Network at 9202. At 9204, the Legacy Administration 8086 engages in authentication with User Node Interaction (UNI) 470 of the BCHAIN Protocol via an Authenticated User Session 522. At 9208, The appropriate funds are credited to the corresponding UPFA 718 which is related to the Associated Nodes List 518 which is unpacked from the Authenticated User Session 522. The Targeted Program as an Appchain 9126 is deployed to the BCHAIN Network.

FIG. 851 continues the logic from FIG. 850 which shows Legacy to BCHAIN Deployment (LBD) 9200 at The Targeted Program as an Appchain is deployed to the BCHAIN Network. At Stage 9212, Program as an Appchain 9126 is submitted to the BCHAIN Network via New Content Announcement (NCA) 2544. At 606, The content is submitted to the Mempool Data Storage (MDS) of the miners, where it is eventually mined into the next block of the Appchain via Customchain Interface Module (CIM) 2470. At 608, The content of the newly mined block is cut into cache parts and is transferred to caching nodes via Mining Nodes Supplying Cache Seeding (MNSCS) 1850. At 610, The cache parts gradually and automatically migrate to service optimized areas which ensures the best uptime and download speed possible to nodes requesting the data using Cache Selection Algorithm (CSA) 2350. At 612, Nodes claim the content from the caching nodes CCG 3050. Once downloaded such nodes can execute the execution stream via ESR which leads to manifestation of the intended application.

FIG. 852 shows Emulation Layer Deployment (ELD) 9250 where the Legacy Administration 8086 interacts with the Deployment Interface 9272 at Stage 9252. At Stage 9252 The Legacy Administration send the Target System Type 9256 to Deployment Interface (DI) 9272. At Stage 9260, DI 9272 responds with a Pre-compiled Binary 9258 that is compatible with the Target System Type 9256. At Stage 9262, The Signature of the Pre-compiled Binary 9258 is verified to ensure it originate from DI 9272. At Stage 9266, Legacy Administration grants the Pre-Compiled Binary Persistent Root Permissions 9264. The Pre-Compiled Binary is executed in the intended Target System which leads to the execution of Appchain Emulation Layer (AEL) 8058.

FIG. 853 shows Deployment Interface (DI) 9272 operation. At Stage 9274 it loops through all of the available System Types 9270. LIZARD 120 converts the Modular Appchain Dependencies 9284 into Purpose Hierarchy Map 9286 and Purpose Hierarchy Map 9288 at Stage 9278. At Stage 9290, The Purpose Hierarchy Maps of the Modular Appchain Dependencies 9284 are integrated into the Purpose Hierarchy Map 9282 of the AEL Source Code 9280 via PRP 7050 for Upgraded Purpose Map 9292.

FIG. 854 shows details concerning the operation of LIZARD 120 to convert Modular Appchain Dependencies 9284 concerning LIZARD 120 into a Purpose Hierarchy Map 9286. Modular Appchain Dependencies 9284 concerning LIZARD 120 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. Modular Appchain Dependencies 9284 concerning LIZARD 120 is received in Appchain Syntax 9285 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 855 continues the logic flow from FIG. 854 to illustrate the operation of LIZARD 120 to convert Modular Appchain Dependencies 9284 concerning LIZARD 120 into a Purpose Hierarchy Map 9286. Logical Reduction C323 from the Syntax Module (SM) C35 submits it's output to Iterative Interpretation C328 from the Purpose Module (PM) C36. Iterative Interpretation C328 loops through all Interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as Purpose Hierarchy Map 9286 which is presented as the Complex Purpose Format C325 version of Modular Appchain Dependencies 9284 concerning LIZARD 120. The same definition and application of Inner Core (IC) C333 applies for the aforementioned functions and modules.

FIG. 856 shows details concerning the operation of LIZARD 120 to convert Modular Appchain Dependencies 9284 concerning I2GE 122 into a Purpose Hierarchy Map 9288. Modular Appchain Dependencies 9284 concerning I2GE 122 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. Modular Appchain Dependencies 9284 concerning I2GE 122 is received in Appchain Syntax 9285 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 857 continues the logic flow from FIG. 856 to illustrate the operation of LIZARD 120 to convert Modular Appchain Dependencies 9284 concerning I2GE 122 into a Purpose Hierarchy Map 9288. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as Purpose Hierarchy Map 9288 which is presented as the Complex Purpose Format C325 version of Modular Appchain Dependencies 9284 concerning I2GE 122. The same definition and application of Inner Core (IC) C333 applies for the aforementioned functions and modules.

FIG. 858 shows Deployment Interface (DI) 9272 operation where at Stage 9290, The Purpose Hierarchy Maps of the Modular Appchain Dependencies 9284 are integrated into Purpose Hierarchy Map 9292 of the AEL Source Code via PRP 7050. At Stage 9294, LIZARD 120 converts Upgraded Purpose Map 9292 into appropriate ate Syntax concerning the Selected System Type 9296. At Stage 9298, the resultant Pre-Compiled Binary 9296 is stored in Pre-Compiled Binary Cache Retention (PBCR) 9302, and replaces an Old Binary for the System Type if one exists. At Stage 9300 it advances the loop to the next available System and Loops through all of the available system types 9274 to identify the Selected System Type 9296.

FIG. 859 shows details concerning the operation of LIZARD 120 to convert the Upgraded Purpose Map 9292 into a Pre-Compiled Binary 9296. The Upgraded Purpose Map 9292 exists in Complex Purpose Format C325 and is submitted to Iterative Expansion C327 of the Purpose Module C36 within the Outer Core (OC) C329 of LIZARD 120. Iterative Expansion C327 adds detail and complexity to evolve a simple goal into a specific complex purpose definition. Therefore the maximum Purpose Association C326 potential of the input is realized, and retained as a Complex Purpose Format C325, before it is submitted to Logical Derivation C320 of the Syntax Module (SM) C35. The Core Code C335 element of Inner Core (IC) C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 860 continues the logic flow from FIG. 859 to illustrate the operation of LIZARD 120 to convert the Upgraded Purpose Map 9292 into a Pre-Compiled Binary 9296. The input data is received in Complex Purpose Format C325 from the Purpose Module (PM) C36 and is transferred to Logical Derivation C320 of the Syntax Module (SM) C35. Logic Derivation C320 derives logically necessary functions from initially simpler functions. This means that if a function can be formed as a derivative function due to implication from a simpler parent function; then it is formed by Logical Derivation C320. The produced result is a tree of function dependencies that are built according to the defined Complex Purpose Format C325 data. Logical Derivation C320 operates according to the Rules and Syntax C322 definitions which are inherited from the Core Code C335 element of Inner Core (IC) C333. Logical Derivation C320 submits it's output to Code Translation C321. Code Translation C321 converts arbitrary (generic) code which is recognized and understood by SM C35 to any known and chosen computation language. Code Translation C321 also performs the inverse function of translating known computation languages into arbitrary syntax types. Therefore PM C36 invokes SM C35 to produce the resultant Syntax version of the input Upgraded Purpose Map 9292 via Code Translation C321. The resultant Pre-Compiled Binary 9296 unit that is terminally produced by Code Translation C321 is the modular output of SM C35, Outer Core (OC) C329, and LIZARD 120.

FIG. 861 shows Deployment Interface (DI) 9272 starting at Stage 9298, the resultant Pre-Compiled Binary 9296 is stored in PBCR 9302, and replaces Old Binary for the System Type if one already exists. At Stage 9304, A request for Pre-Compiled Binary 9296 is sent to PBCR 9302. At Stage 9305 (mislabeled as 9304 on FIG. 861), The corresponding Pre-compiled Binary 9296 that matches the requested Target System Type 9256 is sent to the Legacy Administration 8086 via ELD 9250 from PBCR 9302. At Stage 9260 DI 9272 responds with a Pre-compiled Binary 9296 that is compatible with the Target System Type 9256. The Legacy Administration 8086 sends the Target System Type 9256 at Stage 9254.

FIGS. 862-879 show the operation and functionality of the Appchain Emulation Layer (AEL) 8058, which enables Appchains 836 to be executed in Legacy Environments that do not participate in the BCHAIN Network 110.

FIG. 862 shows production of a Precompiled Application Stack (PAS) 9400 instance via Static Appchain Processing (SAP) 9480. SAP 9480 interprets the corresponding Appchain 836 contents, therefore producing Static Appchain Retention 9402 and submitting it as modular input to PAS 9400. The Application Emulation Layer (AEL) 8058 is compiled and embedded into PAS 9400, therefore giving the PAS 9400 instance autonomy within Legacy Systems. A submodule of AEL 8058 is Target System Interpretation and Detection (TSID) 9404. Therefore if this PAS 9400 were to be invoked on an arbitrary system, AEL 8058 would execute in a preliminarily basic instruction-set and seek to detect the Operating System 9408, Device Drivers 9410 and Hardware 9412 of the Target System 9406. Therefore AEL 8058 would invoke the adequate translation mechanism to run complex code on the Target System 9406, therefore enabling the Static Appchain Retention 9402 to be fully executed. The Retention 9402 contains the Appchain 836 Execution Segments 551 and Data 553 Segments for the targeted Appchain 836, along with other Appchains 836 the targeted Appchain 836 depends on for operation, such as LOM 132 and LIZARD 120.

FIG. 863 shows the operation and functionality of the Appchain Emulation Layer (AEL) 8058. Static Appchain Processing (SAP) 9480 produces a Static Appchain Retention 9402 instance that contains the targeted Appchain 836. The Static Appchain Retention 9402 is submitted as modular input to the Execution and Data Segment Extraction (EDSE) 9430 module of AEL 8058. EDSE 9430 is a container module for the invocation of Execution Stream Collection (ESC) 6700 at Stage 9432, and for the invocation of Data Stream Sorting (DSS) 6800 at Stage 9434. The Target System 9406 is interpreted by the Target System Interpretation and Detection (TSID) 9404 module via consideration of the static Target System Library Collection 9442. The Collection 9442 defines the appropriate Instruction Sets 9444 that are applicable to various System 9406 types. Therefore TSID 9404 produces the Target System Instruction Set 9444 which enables the internal operation of AEL 8058 to submit the correct computational instructions to the Target System 9406. Execution Segment Translation (EST) 9436 is invoked from Stage 9432 to interpret the Target System Instruction Set 9444 which therefore translates the Appchain 836 Syntax into the appropriate legacy instructions. Data Segment Translation (DST) 9438 is invoked from Stage 9434 to interpret the Target System Instruction Set 9444 which therefore therefore translates the Appchain 836 Syntax into the appropriate legacy segments of data. The modular outputs of EST 9436 and DST 9438 are both submitted to Legacy Instruction Unification (LIU) 9440, which invokes a live instance of Execution Stream Rendering (ESR) 6400 to render the Static Appchain Retention 9402 according to the defined Target System Instruction Set 9444. Any attempts to manipulate elements outside of the AEL's 8058 jurisdiction and within the Target System 9408 (like writing a file to the legacy file system of the Target System 9406) are handled by the External Instruction Middleware (EIM) 9450. Therefore the modular output of LIU 9440 is a Deployable Instruction Stream 9446 which is understood and executed by the Target System 9406 and implies the practical manifestation of the Static Appchain Retention's 9402 execution, therefore implying the execution of the targeted Appchain 836 on a legacy system.

FIG. 864 shows the operation and functionality of the External Instruction Middleware (EIM) 9450. The operation of the Static Appchain Retention 9402 within the Execution Stream Rendering (ESR) 6400 instance of the Legacy Instruction Unification (LIU) 9440 module causes LIU 9440 to produce the External Instruction Proposition 9452 and the Instruction Isolation Readiness 9454 index as modular output. Such Outputs 9452 and 9454 are submitted as modular input to EIM 9450, therefore Output 9452 is received at Stage 9456. Stage 9458 invokes LIZARD 120 to convert the External Instruction Proposition 9452 into a Purpose Hierarchy Map 9462. Thereafter Stage 9466 is executed which invokes the Purpose Realignment Processing (PRP) 7050 module for modular inputs Instruction Purpose Collection 9460 and Purpose Hierarchy Map 9462. Master/Slave Affinity 1480 defines the Instruction Purpose Collection 9460 as the slave. Therefore PRP 7050 produces the new iteration of the Instruction Purpose Collection 9464 as modular output. At Stage 9468 LIU is invoked to produce Instruction Isolation Readiness 9454 via the Need Map Matching (NMM) C114 sub-module of LIZARD 120. The applicability of Instruction Isolation Readiness 9454 is illustrated on FIG. 1230.

FIG. 865 shows details concerning the operation of LIZARD 120 to convert the External Instruction Proposition 9452 into a Purpose Hierarchy Map 9462. The External Instruction Proposition 9452 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The External Instruction Proposition 9452 is received in ESR Instruction/Command Syntax 5630 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 866 continues the logic flow from FIG. 865 to illustrate the operation of LIZARD 120 to convert the External Instruction Proposition 9452 into a Purpose Hierarchy Map 9462. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 9462 which is presented as the Complex Purpose Format C325 version of the External Instruction Proposition 9452. The same definition and application of Inner Core (IC) C333 applies for the aforementioned functions and modules.

FIG. 867 continues the logic flow of External Instruction Middleware (EIM) 9450 from FIG. 864 at Stage 9468, which invokes Legacy Instruction Unification (LIU) 9440 to produce the Instruction Isolation Readiness 9454 variable. The Readiness 9454 variable defines if the Instruction Purpose Collection 9460 is isolated enough within the Target System 9406 to be executed without interference of alternate execution syntaxes. Therefore Prompt 9470 is activated which evaluates if the Instruction Isolation Readiness 9454 variable indicates that the Instruction Purpose Collection 9470 can be deployed to the Target System 9406 yet. If the response to Prompt 9470 is Deployment Not Ready 9474, then Stage 9478 is activated which suspends execution of EIM 9450 until the next External Instruction Proposition 9464 is produced by Executed Stream Rendering (ESR) 6400 via Legacy Instruction Unification (LIU) 9440. If the response to Prompt 9470 is Deployment Ready 9472, then Stage 9476 invokes LIZARD 120 to convert the Instruction Purpose Collection 9464 to the corresponding Syntax defined by Target System Interpretation and Detection (TSID) 9404. Therefore Stage 9476 produces a Deployable Instruction Stream 9446 which is modular output for EIM 9450 and is executed natively within the Target System 9406.

FIG. 868 shows the operation and functionality of Need Map Matching (NMM) C114 operating as a submodule of LIZARD's 120 Dynamic Shell C198. The NMM C114 instance is spawned to serve the operation of Stage 9468 of the Legacy Instruction Unification (LIU) 9440 module. The Target System Interpretation and Detection (TSID) 9404 is submitted for storage in Need Access and Development and Storage 5550. Therefore the TSID 9404 is broken down into sub-categories and retained in Storage 5550 as a series of hierarchal branches and layers. Upon the modular invocation of NMM C114, Initial Parsing C148 downloads each jurisdiction branch from Storage 5550 to temporarily retain for referencing within the ongoing NMM C114 instance. With Calculate Branch Needs C149: according to definitions associated with each branch, needs are associated with their corresponding department. This way, permission checks can be formed within the NMM C114 instance. For example: NMM C114 approved the request for the Human Resources department to download all employee CVs, because it was requested within the zone of the annual review of employee performance according to their capabilities. Therefore it was proven to be a valid need of the department jurisdiction. Therefore Need Index C145 is the main storage of Jurisdiction Branches and their respective needs. Because this internal reference is a resource bottleneck for the operation of NMM C114 and therefore all the modules it serves, it is pre-optimized for quick database querying to increase the overall efficiency of the system. Stage 9468 provides an Input Purpose C139 as modular input to the Search Algorithm C144 of NMM C114. The Search Algorithm C144 references and searches through the compiled Need Index C145, therefore determining if the Input Purpose C139 defines a valid need according to the jurisdiction branches initially defined in Need Access Development and Storage 5550. Therefore the completed execution of the Search Algorithm C144 via the Need Index C145 produces an Approve/Block C146 response which is submitted as modular output from NMM C114 and referenced as the Need Result C141. Therefore the Need Result C141 is returned back to the internal logic of External Instruction Middleware (EIM) 9450 as the Instruction Isolation Readiness 9454 variable.

FIG. 869 shows details concerning the operation of LIZARD 120 to convert the Instruction Purpose Collection 9462 into a Deployable Instruction Stream 9446. The Instruction Purpose Collection 9462 exists in Complex Purpose Format C325 and is submitted to Iterative Expansion C327 of the Purpose Module C36 within the Outer Core (OC) C329 of LIZARD 120. Iterative Expansion C327 adds detail and complexity to evolve a simple goal (indirectly defined within the Instruction Purpose Collection 9462) into a specific complex purpose definition. Therefore the maximum Purpose Association C326 potential of the input is realized, and retained as a Complex Purpose Format C325, before it is submitted to Logical Derivation C320 of the Syntax Module (SM) C35. The Core Code C335 element of Inner Core (IC) C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 870 continues the logic flow from FIG. 869 to illustrate the operation of LIZARD 120 to convert the Instruction Purpose Collection 9462 into a Deployable Instruction Stream 9446. The input data is received in Complex Purpose Format C325 from the Purpose Module (PM) C36 and is transferred to Logical Derivation C320 of the Syntax Module (SM) C35. Logic Derivation C320 derives logically necessary functions from initially simpler functions. This means that if a function can be formed as a derivative function due to implication from a simpler parent function; then it is formed by Logical Derivation C320. The produced result is a tree of function dependencies that are built according to the defined Complex Purpose Format C325 data. Logical Derivation C320 operates according to the Rules and Syntax C322 definitions which are inherited from the Core Code C335 element of Inner Core (IC) C333 and the Target System Library Collection 9442 via the Target System Interpretation Detection (TSID). Logical Derivation C320 submits it's output to Code Translation C321. Code Translation C321 converts arbitrary (generic) code which is recognized and understood by SM C35 to any known and chosen computation language. Code Translation C321 also performs the inverse function of translating known computation languages into arbitrary syntax types. Therefore PM C36 invokes SM C35 to produce the resultant version of the input Instruction Purpose Collection 9462 via Code Translation C321. The syntax of such a version is defined as modular output of Target System Interpretation and Detection (TSID) 9404. The resultant Deployable Instruction Stream 9446 that is terminally produced by Code Translation C321 is the modular output of SM C35, Outer Core (OC) C329, and LIZARD 120.

FIG. 871 shows the operation and functionality of Static Appchain Processing (SAP) 9480, which converts live and active Appchains 836 into a deployable Static Appchain Retention 9402. Execution of SAP 9480 is typically manually invoked, by an UBEC 106 or Generic 5068 User and via an Administrative Interface 9482. At Stage 9482 a Proposed Appchain Collection 9488 is produced from the Administrative Interface 9482, therefore defining the scope of Appchain(s) 836 the UBEC User 106/Generic User 5068 wants to include in the final modular output Static Appchain Retention 9402. At Stage 9484 Execution and Data Segment Collections 6902/6904 are produced from the references of the Proposed Appchain Collection 9484. At Stage 9486 the Proposed Appchain Collection 9488 is processed by a spawned Execution Stream Rendering (ESR) 6400 instance from within the Modified Catch Environment (MCE) 6174. MCE 6174 is a custom execution environment that installs trigger points for various events, so that way dependency and debugging information can be derived from the execution session. Thereafter the Dependency Request Fulfillment (DRF) 6176 module is invoked within the SAP 9480 instance in conjunction with the MCE 6174 instance. At Stage 9490 an Execution or Data Request is made by the ESR 6400 instance. Prompt 9492 evaluates the Execution 6902 and Data 6904 Segment Collections to determine if the Execution or Data Request made by ESR 6400 exists in such Collections 6902/6904. If the response to Prompt 9492 is Does Exist 9494, then Prompt 9498 is invoked which evaluates if the corresponding Execution or Data Segment (from ESR 6400) is justified according to the Need Map Matching (NMM) C114 submodule from LIZARD 120. The response of Does Not Exist 9496 for Prompt 9492 is evaluated on FIG. 875.

FIG. 872 elaborates on the operational details concerning Stage 9498 of the Static Appchain Processing (SAP) 9480 module. The Proposed Appchain Collection 9488 is submitted as modular input to Stage 9500, which separates the Collection 9500 into independent Appchain 836 References that are subsequently stored in Appchain Reference Cache Retention (ARCR) 9502. Stage 9504 spawns a Loop that cycles through all of the Appchain 836 Instances within ARCR 9502. Stage 9508 retrieves the selected Appchain Instance 9506 from a relevant Cache Node 786 from the BCHAIN Network 110 and via the BCHAIN Protocol 794. Therefore Stage 9508 (which is detailed on FIG. 1236) produces the Fulfilled Appchain Instance 9510, which is processed at Stage 9512 via invocations of Execution Stream Collection (ESC) 6700 and Data Stream Sorting (DSS) 6800. ESC 6700 produces an Execution Stream 9514 which is submitted as modular input to Stage 9518, and DSS 6800 produces a Data Stream 9516 which is also submitted as modular input to Stage 9518. Therefore Stage 9518 collects the various Execution 9514 and Data 9516 Streams into Execution Segment Collection 6902 and Data Segment Collection 6904. Stage 9519 is subsequently processed which advances the Loop initiated by Stage 9504 to the next available Appchain Instance 9506.

FIG. 873 elaborates on the operational details concerning Stage 9508 of the Static Appchain Processing (SAP) 9480 module. Stage 9508 invokes the BCHAIN Protocol 794 function Content Claim Generator (CCG) 3050. Therefore a Content Claim Request (CCR) 2308 with a Proposed Baseline Hop Pathways (PBHP) 2322 is produced. The CCR 2308 is submitted on the BCHAIN Network 110 so that it eventually reached a corresponding Cache Node 3260 that contains parts of the requested Appchain Instance 9506. The Cache Node 6526 fulfills the CCR 2322, thereby getting eventually compensated economically via BCHAIN Protocol 794 and by leveraging the Watt Economy of the Metachain 834. The Cache Node 6526 produces a corresponding Content Claim Fulfillment (CCF) 2318 unit in response to the corresponding CCR 2308. The newly produced CCF 2318 travels along the BCHAIN Network 110 to reach the Content Claim Rendering (CCR) 3300 module of the Node 786 that is processing the SAP 9480 instance. Content Decoding Instructions 3316 are referenced to render the CCF 2318 response, which therefore produces the Fulfilled Appchain Instance 9510. Therefore the Execution 551 and Data Segments 553 of the targeted Appchain 836 have been retrieved.

FIG. 874 elaborates on the logic flow of the Dependency Request Fulfillment (DRF) 6176 submodule within the Static Appchain Processing (SAP) 9480 instance, therefore resuming from FIG. 871. The Does Exist 9494 response to Prompt 9492 invokes Stage 9498 which checks if the corresponding Execution or Data Segment is Justified 9520 according to NMM C114. If the Justified 9520 response to Prompt 9498 occurs, then Stage 9524 is invoked which marks the Execution or Data segment for inclusion in the Marked Segment Cache Retention (MSCR) 8652. The logic flow for the Not Justified 9522 response to Prompt 9498 is shown on FIG. 875. The conclusion of Stage 9524 implies the conclusion of the DARF 6176 instance processing. Therefore after Stage 9524, Stage 9526 is invoked which associates the Fulfilled Appchain Instance 9510 with it's corresponding Marked Segments that are found in MSCR 8652. Stage 9508 retrieves the Selected Appchain Instance 9506 from a relevant Cache Node 786 via the BCHAIN Protocol 794, therefore producing the Fulfilled Appchain Instance 9510, as illustrated on FIG. 873.

FIG. 875 elaborates on the logic flow of the Dependency Request Fulfillment (DRF) 6176 submodule within the Static Appchain Processing (SAP) 9480 instance with regards to Stage 9486 of the Modified Catch Environment (MCE) 6174. The Does Not Exist 9496 response to Prompt 9492, and the Not Justified 9522 response to Prompt 9498 both lead to the activation of Stage 5600, which generates and submits a Diagnostic Log Unit (DLU) 1182 that contains an Official System Token 1184. This Token 1184 is included to indicate that the corresponding function or program has reached a non-ideal state if an official function within the UBEC Platform 100. The DLU 1182 is submitted to the Diagnostic Log Submission (DLS) 1160 module, which is invoked by LOM's 132 Automated Research Mechanism (ARM) 134 to supply the DLU 1182 to SPSI 130. Therefore SPSI 130 is able to process the diagnostic information found in the DLU 1160 with the Diagnostic Log Unit Analysis (DLUA) 8048 module. This leads to Stage 13005 which represents DLUA 8048 being invoked to perform corresponding modifications to I2GE 122 and/or MCE 6174 to avoid the initial reason the specified responses were invoked for Prompts 9492 and 9498. The Justified 9520 response to Prompt 9498 invokes Thread Blocking Management (TBM) 6240 for the Execution Stream Rendering (ESR) 6400 instance that is being emulated in I2GE 122. Therefore TBM 6240 allows the I2GE 122 evolutionary variance process to continue whilst the original thread of DRF 6176 is being processed. This is done to achieve operational efficiency.

FIG. 876 shows the operation and functionality of Need Map Matching (NMM) C114 operating as a submodule of LIZARD's 120 Dynamic Shell C198. The NMM C114 instance is spawned to serve the operation of Stage 9528 of the Data Request Fulfillment (DRF) 6176 module from the Static Appchain Processing (SAP) 9480. The Execution Segment Collection 6902 and Data Segment Collection 6904 are submitted for storage in Need Access and Development and Storage 5550. Therefore the Collections 6902/6904 are broken down into sub-categories and retained in Storage 5550 as a series of hierarchal branches and layers. Upon the modular invocation of NMM C114, Initial Parsing C148 downloads each jurisdiction branch from Storage 5550 to temporarily retain for referencing within the ongoing NMM C114 instance. With Calculate Branch Needs C149: according to definitions associated with each branch, needs are associated with their corresponding department. This way, permission checks can be formed within the NMM C114 instance. For example: NMM C114 approved the request for the Human Resources department to download all employee CVs, because it was requested within the zone of the annual review of employee performance according to their capabilities. Therefore it was proven to be a valid need of the department jurisdiction. Therefore Need Index C145 is the main storage of Jurisdiction Branches and their respective needs. Because this internal reference is a resource bottleneck for the operation of NMM C114 and therefore all the modules it serves, it is pre-optimized for quick database querying to increase the overall efficiency of the system. Stage 9530 provides an Input Purpose C139 as modular input to the Search Algorithm C144 of NMM C114. The Search Algorithm C144 references and searches through the compiled Need Index C145, therefore determining if the Input Purpose C139 defines a valid need according to the jurisdiction branches initially defined in Need Access Development and Storage 5550. Therefore the completed execution of the Search Algorithm C144 via the Need Index C145 produces an Approve/Block C146 response which is submitted as modular output from NMM C114 and referenced as the Need Result C141. Therefore the Need Result C141 is returned back to the Stage 9498 of DRF 6176 and SAP 9480.

FIG. 877 shows details concerning the operation of LIZARD 120 to convert Execution 9532 and Data 9534 Requests, from the Execution Stream Rendering (ESR) 6400 instance of the Modified Catch Environment (MCE) 6174, into a Purpose Hierarchy Map 9536. The External Instruction Proposition 9452 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The External Instruction Proposition 9452 is received in ESR Instruction/Command Syntax 5630 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 878 continues the logic flow from FIG. 877 to illustrate the operation of LIZARD 120 to convert Execution 9532 and Data 9634 Requests into a Purpose Hierarchy Map 9536. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 9536 which is presented as the Complex Purpose Format C325 version of the Execution 9532 and Data 9534 Requests. The same definition and application of Inner Core (IC) C333 applies for the aforementioned functions and modules.

FIG. 879 shows a final overview of the macro aspects of Static Appchain Processing's (SAP) 9480 processing. SAP 9480 is manually invoked by an UBEC User 106 or Generic User 5068 via an Administrative Interface 9482. Stage 9482 receives a Proposed Appchain Collection 9488 as modular input. A Loop is initiated at Stage 9504 which cycles through all of the Appchain Instances 9506 from Appchain Reference Cache Retention (ARCR) 9502. At Stage 9538 the Fulfilled Appchain Instance 9510 is retrieved from Marked Segment Cache Retention (MSCR) 8652, therefore leading to Stage 9540. Fulfilled Appchain Instances 9510 contain the full set of Execution 551 and Data 553 Segments required to execute the chosen Appchain 836, including any modular dependencies such as the full Appchain 836 for LOM 132, CTMP 124, and LIZARD 120. Stage 9540 incrementally installs all of the Fulfilled Appchain Instances into the Static Appchain Retention 9402, which each outgoing Execution 551 or Data 553 Segment being verified for having Marked status by MSCR 8652. Therefore Static Appchain Retention 9402 is produced as the final modular output of SAP 9480, and is thereafter submitted as modular input to the Execution and Data Segment Extraction (EDSE) 9430 module of the Appchain Emulation Layer (AEL) 8058.

### Neuroeconomic Metaphysical Contentment (NMC)

FIGS. 1000-1001 show an Endowment Structure (ES) 12008 which manages funds that are operated by either a Board of Directors (BD) 12018 or an Independent Director (ID) 12020.

FIG. 1000 shows Board of Directors (BD) 12018 as a collection of registered Directors 12006 that operate within the UBEC Platform 100 as UBEC Users 106. A Director's 12006 personal funds are stored in the Watt Economy 862 of the Metachain 834. At Stage 12014 Directors 12006 are able to cryptographically pledge their funds to the Investment Capital (IC) 12012 instance of the ES 12008 via Watt Unit Pledge Procedure (WUP2) 12016. The cryptographic functions that operate within WUP2 12016 are enabled by Cryptography Core (CC) 786. Therefore a virtual allocation of pledged funds are registered at IC 12012, whilst the hardware based cryptographic assignment of such funds occurs at UPFA 718 within BCHAIN Nodes 786. Within the structure of BD 12018; Stake Tracking Retention (STR) 12000 keeps a digital record of all current and past investments made, therefore indicating the current portfolio stake of BD 12018. The digital record of STR 12000 can be made public to UBEC Users 106 that are non-directors, or can be made exclusively private for the Directors 12006 of the Board 12018. Such a distinction concerning information access is defined in Established Policy Retention (EPR) 12002, which records the variables that define the investment characteristics of the Board 12018. Proposal Tracking Retention (PTR) 12004 keeps a recorded ledger of proposals made by Directors 12006. Proposals tracked in PTR 12004 are typically references to policy definitions in EPR 12002. Such proposals are voted on by Directors 12006 via Director Voting Mechanism (DVM) 12030.

FIG. 1001 shows Independent Director (ID) 12020 operating within the Endowment Structure (ES) 12008. The functionality scope of ID 12020 is the same as BD 12018 except there is a sole exclusive Director 12022 that manipulates policy at EPR 12002, and submits and votes on Proposals at PTR 12004 via Director Voting Mechanism (DVM) 12030.

FIGS. 1002-1008 shows Cryptographic Digital Economic Exchange (CDEE) 705 and details concerning it's dependency module LUIGI 116.

FIG. 1002 shows the security oversight functionality of CDEE 705. The core module of NMC is Comprehensive State Evaluation (CSE) 12400. Operation of CSE 12400 triggers Stage 12024 of CDEE 705. Stage 12024 includes monitoring and regulation, conducted via Fund Movement Oversight (FMO) 392, of funds moving to an App Public Funds Allocation (APFA) 720 instance. The APFA 720 instance belongs to the designated UBEC App that has been selected for investment by the relevant ES 12008. Cryptographic access to the funds held in APFA 720 are maintained via BCHAIN Nodes 786. Such Nodes 706 belong to the maintainers of the relevant UBEC App. BD 12018 and ID 12020 from the ES 12008 have access to the Fund Recovery Mechanism (FRM) 398 of LUIGI 116. The final balance of the APFA 720 instance, and profit information from the App Profit Distribution (APD) 726, are forwarded to Digital Exchange Status Reporting (DESR) 12418. Such forwarded information is processed by DESR 12418 and sent to CSE 12400. Therefore CSE 12400 has access to more financial information which leads to CSE 12400 intelligently calculating the most optimal investment decisions. When a BD 12018 or ID 12020 makes an investment into an UBEC App; their identification is recorded in that UBEC App's App Investment Registrar (AIR) 722. This enables the correct distribution of profits by APD 726.

FIG. 1003 shows LUIGI 116 operating as an Appchain 836 within the UBEC Platform 100. LUIGI 116 is invoked by the Fund Movement Oversight (FMO) 392 and Fund Recovery Mechanism (FRM) 398 modules within CDEE 705. Such invocations of LUIGI 116 regulates Watt Unit movement and provides assurance of Watt Unit allocation safety within CDEE 705. UBEC Passthrough 368 receives data transfer information from Appchains 836 that operate within the UBEC Platform 100. Therefore traffic and activity within CDEE 705 is inherently linked to the UBEC Passthrough 368 hook. LUIGI Task Delegation (LTD) 370 determines if the incoming data from the UBEC Passthrough 368 should be processed by LIZARD 120, LOM 132, or both. An invocation of the LIZARD 120 Appchain 836 indicates the ‘Jurisdictional Enforcement and Intention Reader’ 376 processing mode has been selected. An invocation of the LOM 132 Appchain 836 indicates the ‘Knowledge Inquiries and Judicial Arbitration’ 372 processing mode has been selected. Thereafter the logic flow continues to Dynamic API Customization (DAC) 384. The function of DAC 384 is to interpret the Task Type 372/376 and therefore customize the interface of the selected API to the selected Task Type 372/376. The corresponding algorithms LOM 132 and LIZARD 120 are executed as they are invoked, therefore producing analytical results which are sent to Intelligent Conclusion Unification (ICU) 374. ICU 374 reconciles any interpretive/subjective conclusions between LOM 132 and LIZARD 120, assuming both modules were invoked in parallel.

FIG. 1004 continues to show the operation and application of LUIGI 116 in regards to NMC 13300 and more specifically the Comprehensive State Evaluation (CSE) 12400 module. As indicated by Stage 12026, the CSE 12400 output Ideal Investment Decision Makeup 12404 is received via the UBEC Passthrough 368. LUIGI 116 perceives that the Makeup 12404 acts as a Container 12590 of numerous sub-element Investment Allocations 12592, Investment Withdrawals 12594, Profit Allocations 12596, and Director Notification 12598. Thereafter at Stage 12028 the LUIGI Task Delegation (LTD) 370 module is invoked to delegate the corresponding data output Makeup 12404 to be analyzed by the appropriate LUIGI 116 branches of analysis: Knowledge Inquiries and Judicial Arbitration 372 (LOM 132), and Jurisdictional Enforcement and Intention Reader 376 (LIZARD 120).

FIG. 1005 shows various Appchains 836 interacting with LUIGI 116 (as an Appchain) to enable it's functionality. The UBEC Platform 100 is manifested as an Appchain 836 with the UBEC Appchain 118, which links to the UBEC Passthrough 368 to provide modular data input to LUIGI 116. Upon LUIGI's 116 processing conclusion, the UBEC Comprehensive Return 388 sends the data back to the UBEC Appchain 118 so that it may continue along it's original logic flow. LOM 132 acts as the core Appchain 836 to enable processing within the Knowledge Inquires and Judicial Arbitration 372 branch. LOM 132 and LIZARD 120 also feed API customization information to Dynamic API Customization (DAC) 384. Therefore DAC 384 has access to the appropriate API information to perform the relevant customizations of the logic process as needed (depending on which Appchain 132/120 is invoked). SPSI 130 periodically and consistently monitors, maintains and upgrades the composition and operation of LUIGI 116.

FIG. 1006 elaborates on operational details concerning the Dynamic API Customization (DAC) 384 module in relation to it's interface with the Jurisdictional Enforcement and Intention Reader 376 Branch. Because the selected Branch 376 invokes LIZARD 120, the LIZARD Usage API 402 is provided within the operation of DAC 384. The LUIGI Task Delegation (LTD) 370 determines the Task Type which is defined in Task Reception 410. Therefore the Task Type is forwarded to Stage 408 ‘Interpret the Task Type’ within DAC 384. Therefore the provided Task Type indicates the customization scope to Stage 406 within DAC 384. This produces the Modular Instruction-Set 416 which is provided to the selected Branch 376. The Modular Instruction-Set 416 is programmed in accordance with the LIZARD Usage API 402, and is therefore sent as modular input to LIZARD Input 414. Therefore Input 414 receives the data concerning the task with Task Data-Set 412 and the instructions to process it with the Modular Instruction-Set 416. This leads to the actual Modular Execution 418 of LIZARD 120 to fulfill the two inputs 412/416. Successful and complete Execution 418 of the LIZARD 120 instance produces LIZARD Output 420. The Output 420 is forwarded to the Intelligent Conclusion Unification (ICU) 374 module. ICU 374 reconciles multiple outputs from different Module Executions 418/423 (LOM 132/LIZARD 120) to guarantee a singular unified output of the Branches 372/376. This allows for simplified input reception of LUIGI Corrective Action (LCA) 378.

FIG. 1007 elaborates on operational details concerning the DAC 384 module in relation to it's interface with the Knowledge Inquiries and Judicial Arbitration 372 Branch. Because the selected Branch 372 invokes LOM 132, the LOM Usage API 402 is provided within the operation of DAC 384. LTD 370 determines the Task Type which is defined in Task Reception 410, thus operating the same logic from FIG. 1006 for Branch 376. The Task Type is forwarded to Stage 408 ‘Interpret the Task Type’ within DAC 384. This produces the Modular Instruction-Set 416 which is provided to the selected Branch 372. The Modular Instruction-Set 416 is programmed in accordance with the LOM Usage API 404, and is therefore sent as modular input to LOM Input 422. Therefore Input 422 receives the data concerning the task with Task Data-Set 412 and the instructions to process it with the Modular Instruction-Set 416. This leads to the actual Modular Execution 423 of LOM 132 to fulfill the two inputs 412/416. Successful and complete Execution 423 of the LOM 132 instance produces LOM Output 424. The Output 424 is forwarded to ICU 374, which reconciles multiple outputs from different Module Executions 418/423 (LOM 132/LIZARD 120) to guarantee a singular unified output of the Branches 372/376. This allows for simplified input reception of LCA 378. The simplified input reception becomes needed if both Modular Executions 418 and 423 are invoked by LTD 370.

FIG. 1008 shows currency liquidity manipulation functions that belong exclusively to LUIGI 116 in Financial Liquidity Manipulation 382. The LUIGI Secure Enclave (LSE) 380 is a secure zone of information retention that only LUIGI 116 can access. Therefore there are no theoretically possible human observers of the contents of the LSE 380, as the permissions to write LUIGI's 116 code belongs exclusively to SPSI 130 and the permissions to execute LUIGI's 116 code belongs exclusively to LUIGI 116 itself. Inside the LSE 380 is a Retention Decryption Key 394 which allows LUIGI 116 to decrypt the Encrypted Retention of Private Keys 396. This allows the Fund Manipulation Mechanism (FMM) 400 to manipulate funds on the Watt Economy 862 of the Metachain 834 in a fund recovery session. Watt Liquidity Governor (WLG) 390 is a subset module of LUIGI 116 that monitors for and potentially blocks excessive spikes in liquidity movements going in and out of UBEC 100. This ensures a gradual and predictable economy within UBEC 100. Fund Movement Oversight (FMO) 392 is a subset module of LUIGI 116 that monitors and potentially blocks movements of liquidity that are correlated with fraud. Fund Recovery Mechanism (FRM) 398 is a subset module of LUIGI 116 that allows for the rightful owners of —U— (Watt Unit) funds to claim them from the Watt Economy 862 of the Metachain 834 if they were lost, stolen or otherwise mishandled. Proof of Authority 402 is a unique cryptographic key that is cryptographically guaranteed to be only produceable by LUIGI 116 due to LSE 380 logistics. Therefore Proof of Authority 402 is used to invoke an UBMA Chip 4260 to supply it's Security Sensitive Unique Private Key 4314 as illustrated in FIGS. 362 and 363.

FIGS. 1009-1011 show the functionality and usage of the Director Voting Mechanism (DVM) 12030.

FIG. 1009 shows Directors 12006/12022 of the Board of Directors (BD) 12018 and Independent Director (ID) 12020 interacting with DVM 12030 via the Proposal Voting Interface (PVI) 12010. At Stage 12034 an Authorized Proposal 12036 is submitted by a Director 12006/12022. Various types of Potential Authorized Proposals 12036 can be made by the Director 12006/12022. With an Independent Director (ID) 12020; Proposals 12036 are effectively treated as commands within the Endowment Structure (ES) 12008, due to their being only a sole Director 12022 and no consensus dilemma. New Director Admission 12038 entails the Board's 12018 potential acceptance of a new Director 12006. Therefore currently existing Directors 12006 vote on whether a new Potential Director 12006 should be approved or not. This Proposal 12036 is only applicable to BD 12018 and not ID 12020. The applicability of New Director Admission 12038 depends on policy defined in Established Policy Retention (EPR) 12002. Therefore the Board 12018 can accept new Directors 12006 either with or without consensus verification via New Director Admission 12038 according to policy definitions in EPR 12002. Director Withdrawal With Stake 12044 entails a Director 12006 resigning their membership from Board 12018 whilst immediately withdrawing their investment stake from Investment Capital (IC) 12012. A Board 12018 can opt to prevent a Director 12006 from withdrawing their entire investment immediately via Policy enforcement of EPR 12002. This ensures commitment to the investment project and improves trust relations between Directors 12006 if opted for. Policy Rule Addition 12042 entails the Board's 12018 potential acceptance of a new Policy that is retained and referenced at EPR 12002. Such policies govern the overall behavior of Board 12018 functions and hence Investment Allocations 12592 made by Comprehensive State Evaluation (CSE) 12400. Such policies can be deleted via the corresponding Policy Rule Deletion 12048 proposal 12036. Therefore an action initiated by Directors 12006/12022 to modify a pre-existing Policy in EPR 12002 will lead to a Policy Rule Deletion 12048 occurring immediately before a Policy Rule Addition 12042 event. Therefore votes performed by the Directors 12006 via DVM 12030 to modify a pre-existing Policy are effective votes towards a coupled pair of Proposals 12036 Policy Rule Addition 12042 and Policy Rule Deletion 12048 that are treated like a single unit. Manual Override Measure Addition 12040 introduces a new custom rule to Override Measure Retention (OMR) 12064, which influences the Ideal Investment Decision Makeup 12404 produced by CSE 12400. Such Override Measures 12064 define custom characteristics that make a specific BD 12018 or ID 12020 unique in regards to it's corresponding Investment Makeups 12404. Any ES 12008 that have no defined Override Measures in OMR 12064 will receive often similar Ideal Investment Decision Makeups 12404 from CSE 12400. If two Endowment Structures (ES) 12008 were generated at the exact same time, both with an identical OMR 12064 (which can include no Measures defined), then they will theoretically receive the exact same Ideal Investment Decision Makeups 12404 from CSE 12400. When an Authorized Proposal 12034 is submitted by a Director 12006/12022 at Stage 12034, Stage 12050 is invoked which interprets Proposal compliance via Proposal Compliance Procedure (PCP) 12220. Execution of PCP 12220 via Stage 12050 occurs to ensure that the new Authorized Proposal 12034 is compatible with past proposals from PTR 12004 and pre-established policies from EPR 12002. An example of a potential conflict in compliance is a Director Withdrawal With Stake 12044 Proposal 12036 that is submitted by a Director 12006 whilst the EPR 12002 of the relevant BD 12018 defines that no such Proposal 12044/12036 is mandated nor applicable for a Director 12006 to immediately withdraw their entire investment stake from the Investment Capital (IC) 12012 Instance. Another example of a non-complaint Proposal 12036 is a Policy Rule Deletion 12048 Proposal 12036 that references a Policy that doesn't exist in EPR 12002. An additional example of a non-compliant Proposal 12036 is a Manual Override Measure Deletion 12046 Proposal 12036 that references an Override Measure that isn't found in OMR 12064.

FIG. 1010 shows the logical conclusion of Stage 12050 with a Yes, in Compliance 12054 scenario. If PCP 12220 finds the Potential Authorized Proposal 12036 to be in compliance with past proposals and pre-established policies, the Proposal 12036 is submitted to the Proposal Voting Interface (PVI) 12010. With PVI 12010 Directors 12006 are able to vote for or against a Potential Authorized Proposal 12036. If Voting Indicates Approval 12058 for a Proposal 12036 that is either a Manual Override Measure Addition 12040 or a Manual Override Measure Deletion 12046, the Proposal 12060 is forwarded to Manual Override Measure Manipulation (MOM2) 12062 via Stage 12060. This leads to the Proposal 12036 concerning Manual Override Measure Alterations 12040/12046 to become manifest in the Override Measure Retention (OMR) 12064.

FIG. 1011 shows the logical flow of the Yes, in Compliance 12054 scenario that was highlighted in FIG. 1010, as well as the No, Not in Compliance 12074. If Scenario 12074 occurs, then Stage 12078 is enacted; which rejects the Proposal Submission 12036, and informs the Director 12006 (that submitted the Proposal 12036) via PVI 12010 of the requirements needed to submit a compliant Proposal. Such requirements can be customized to be relevant to the specific Proposal 12036 that was rejected. This way, the submitting Director 12006 is made aware of the exact aspects that made the Proposal 12036 rejected, and the exact modifications to the Proposal 12036 required to make it compliant. Also illustrated on FIG. 1011 is how PCP 12220 makes requests to and receives requests from Proposal Tracking Retention (PTR) 12004. Proposals from the past are recorded in PTR 12004, which enables PCP 12220 to determine compliance of the current Proposal Submission 12036 from Stage 12034. Director 12022 of Independent Director (ID) 12020 does not have access to the Proposal Voting Interface (PVI) 12010 like Director 12006 of Board of Directors (BD) 12018 does. This is because all measures enacted by Director 12022 are immediately accepted and implemented within the Endowment Structure (ES) 12008 because of the absence of the need to reach consensus amongst multiple Directors 12006 with potentially conflicting ideals.

FIGS. 1012-1014 show the functionality and usage of Preliminary Thread Initiation (PTI) 12080, which acts as an initiation sequence to prepare for the proper execution of Comprehensive State Evaluation (CSE) 12400.

FIG. 1012 shows the initial operation of PTI 12080 at Stage 12082. At Stage 12082 the CSE Invocation Interval 12084 is retrieved from the Established Policy Retention (EPR) 12002 of the selected Board of Directors (BD) 12018 or Independent Director (ID) 12020. The Interval 12084 defines how often the relevant Endowment Structure (ES) 12008 intends for a CSE 12400 instance to be spawned. A smaller Interval 12084 implies that the EPR 12002 of the ES 12008 indicates that more Watt Units should be spent on BCHAIN Fees to host more iterations of CSE 12400 instances to achieve a rendering of Ideal Investment Decision Makeup 12404 that is more up to date with market and corporate data. Thereafter at Stage 12086 the time of the CSE Last Invocation 12088 is retrieved from a store of value defined in EPR 12002. The CSE Last Invocation 12088 value is a specific variable that is related to the specified BD 12018 or ID 12020 instance. Thereafter Stage 12090 is executed which checks if the time between the current time and the Last Invocation 12088 is greater than the Invocation Interval 12084. If the calculated time difference is Greater Than 12092 the Invocation Interval 12084, then CSE 12400 is invoked from Stage 12094. If the calculated time difference is Lesser Than 12096 the Invocation Interval 12084, then CSE 12400 is not invoked as per Stage 12098. The operation of Stage 12094 leads to the execution of Target Investment Circumstances Interpretation (TICI) 12380. The operation of TICI 12380 and CSE 12400 implies the fulfillment of Stage 12100, which describes the transfer of liquidity from the relevant Investment Capital (IC) 12012 instance to the BCHAIN Nodes 786 that host the instances of TICI 12380 and CSE 12400. Therefore the Endowment Structure (ES) 12008 is effectively renting out the service of intelligent investment analysis performed by CSE 12400 via the BCHAIN Network 110, with BCHAIN Fees being paid to the relevant BCHAIN Nodes 786. The execution of TICI 12380 produces Target Investment Circumstances 12160, which is interpreted by CSE 12400 to produce an accurate Ideal Investment Decision Makeup 12404 that correctly reflects the current state of markets and businesses. The TICI Results Cache 12112 is a compressed clone of Target Investment Circumstances 12160, which may be potentially referenced at a later stage by Automated Override Measure Manipulation (AOM2) 12140. The Cache 12112 is produced and referenced to avoid having to invoke a separate instance of TICI 12380, which would cost more computational resources whilst producing the same results.

FIG. 1013 shows further operational logic concerning Preliminary Threat Initiation (PTI) 12080, which resumes from Stage 12100. Upon the successful funding of the relevant BCHAIN Nodes 786 from the corresponding Investment Capital (IC) 12012, as per Stage 12100, Stage 12102 is invoked which assesses wether Automated Override Measure Manipulation (AOM2) 12140 has been flagged for invocation in the corresponding EPR 12002 of the relevant Endowment Structure (ES) 12008. An Endowment Structure (ES) 12008 can opt to have AOM2 12140 enabled if a specified Target Mind 12702 is intended to guide the investment decisions performed by CSE 12400. If EPR 12002 indicates that operation of AOM2 12102 has been disabled 12106, then Stage 12110 is executed which indicates that modular execution of PTI 12080, and therefore the TICI Results Cache 12112 can be safely deleted as to increase efficiency in the system. If EPR 12002 indicates that the operation of AOM2 12104 is enabled, then Stage 12108 is executed to retrieve the defined AOM2 Invocation Interval 12114 from EPR 12002. Thereafter at Stage 12116, the corresponding BD 12018 or ID 12020 that has invoked this instance of Preliminary Thread Initiation (PTI) 12080 retrieves the time of the AOM2 Last Invocation 12118. Subsequent operation enacts Stage 12120 which checks if the calculated time difference between the current time and the AOM2 Last Invocation 12118 is greater than the AOM2 Invocation Interval 12114. If the calculated time difference is Lesser Than 12130 the AOM2 Invocation Interval 12114, then Stage 12132 is enacted which deletes the TICI Results Cache 12112 and implies the lack of AOM2 12140 invocation. If the calculated time difference is Greater Than 12122 the AOM2 Invocation Interval 12114, the AOM2 Target Mind Identity 12130 is retrieved at Stage 12124 which leads to the invocation of AOM2 12140 at Stage 12126. Thereafter at Stage 12128 the funds to host/run/execute AOM2 12140 on the BCHAIN Network 110 are withdrawn from the corresponding Investment Capital (IC) 12012 to the relevant BCHAIN Nodes 786 that host the AOM2 12140 instance.

FIG. 1014 shows further details concerning logic previously illustrated in FIG. 1013, beginning from Stage 12124. Stage 12124 retrieves the AOM2 Target Mind Identity 12130 from Established Policy Retention (EPR) 12002 and submits it to Automated Override Measure Manipulation (AOM2) 12140. Thereafter Stage 12124 leads to Stage 12126 which entails the invocation of AOM2 12140 itself. The invocation of AOM2 12140 at Stage 12126 is what leads to the transfer of BCHAIN Fees to occur at Stage 12128 to facilitate the execution of AOM2 12140. Digital Mind Tracking (DMT) 12700 is able to emulate the Target Mind 12702 associated with the AOM2 Target Mind Identity 12130. The TICI Results Cache 12112 are produced from Target Investment Circumstances Interpretation (TICI) 12380 and are sent as modular input to AOM2 12140 to provide the relevant Target Investment Circumstances 12160 that should be considered by the Target Mind 12702. Therefore the fulfilled execution of AOM2 12140 leads to modifications performed by AOM2 12140 on Override Measure Retention (OMR) 12064. Such modifications require reading of the pre-existing Override Measures that exist in OMR 12064, therefore a bi-directional arrow is shown between AOM2 12140 and the OMR 12064 of the relevant BD 12018 or 12020.

FIGS. 1015-1026 show the functionality and operation of Automated Override Measure Manipulation (AOM2) 12140. AOM2 12140 emulates the reactionary criteria of a Target Mind 12702, which has been identified via AOM2 Target Mind Identity 12130, to enact, modify, or remove Override Measures enacted from the Override Measure Retention (OMR) 12064 of a relevant Endowment Structure (ES) 12008. The practical effect of the operation of AOM2 12140 is that the relevant ES 12008 contains an OMR 12064 that is conducive to the reactions and tendencies expected of the Target Mind 12702 as identified by the AOM2 Target Mind Identity 12130. The resultant makeup of OMR 12064 influences the Target Investment Circumstances 12160 produced by Target Investment Circumstances Interpretation (TICI) 12380 and therefore the Ideal Investment Decision Makeup 12404 produced by CSE 12400.

FIG. 1015 shows the initial operation of AOM2 12140 as starting from Stage 12152 which receives the TICI Results Cache 12112 from TICI 12380. Thereafter the TICI Results Cache 12112 is decompressed and extracted at Stage 12150 to produce the Target Investment Circumstances 12160 as originally processed by TICI 12380. Thereafter Stage 12148 is processed which retrieves the Current Stake Position 12146 from Portfolio Stake Retention (PSR) 12003. The Current Stake Position 12146 represents the various active investments that the ES 12008 is currently involved with. Thereafter Stage 12142 is processed which retrieves all of the currently active Override Measures from OMR 12064 and produces them as Active Override Measures 12144. Thereafter Stage 12154 is processed which accumulates all of the previously processed variables Active Override Measures 12144, Current Stake Position 12146, Target Investment Circumstances 12160, and AOM2 Target Mind Identity 12130. Upon accumulation, the aforementioned variables are supplied to Mind Emulation Request Module (MERM) 12952 so as to properly invoke instances of Digital Mind Tracking (DMT) 12700.

FIG. 1016 continues the logic flow of AOM2 12140 from Stage 12154. The subsequent Stage 12164 highlights the operation of MERM 12952 and DMT 12700 which produces Preferred Override Measures 12162. Stage 12154 invokes MERM 12952 which in turn produces a Mind Emulation Request 12910 that is sent to DMT 12700. DMT uses CTMP 124 technology to emulate the Target Mind 12702 represented by the AOM2 Target Mind Identity 12130, therefore producing the Mind Perception Result 12950 that is associated with that specified Target Mind 12702. The Mind Perception Result 12950 is sent back to MERM 12952 which is where the original DMT 12700 was invoked. Therefore MERM 12952 invokes multiple instances of DMT 12700 as needed to accurately produce the final result Preferred Override Measures 12162. Preferred Override Measures 12162 represents Override Measures that are expected to be selected and hence preferred by the specified Target Mind 12702. Therefore upon production of Preferred Override Measures 12162, Stage 12164 is complete and Stage 12166 is subsequently processed. Stage 12166 invokes LIZARD 120 to convert the Preferred Override Measures 12162 into a Purpose Hierarchy Map 12168. Thereafter LIZARD 120 is also invoked to convert the Active Override Measures 12170 into a Purpose Hierarchy Map 12174 at Stage 1272.

FIG. 1017 shows details concerning the operation of LIZARD 120 to convert Preferred Override Measures 12162 into a Purpose Hierarchy Map 12166. The Preferred Override Measures 12161 are submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The Measures 12162 are received in Override Measure Syntax 12161 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1018 continues the logic flow from FIG. 1017 to illustrate the operation of LIZARD 120 to convert Preferred Override Measures 12162 into a Purpose Hierarchy Map 12166. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 12168 which is presented as the Complex Purpose Format C325 version of the Preferred Override Measures 12162. The same definition and application of Inner Core (IC) C333 applies for the aforementioned functions and modules.

FIG. 1019 shows details concerning the operation of LIZARD 120 to convert Active Override Measures 12170 into a Purpose Hierarchy Map 12174. The Active Override Measures 12170 are submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The Measures 12162 are received in Override Measure Syntax 12161 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1020 continues the logic flow from FIG. 1019 to illustrate the operation of LIZARD 120 to convert Active Override Measures 12170 into a Purpose Hierarchy Map 12166. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 12174 which is presented as the Complex Purpose Format C325 version of the Active Override Measures 12170. The same definition and application of Inner Core (IC) C333 applies for the aforementioned functions and modules.

FIG. 1021 continues the logic flow from FIG. 1016. The Purpose Hierarchy Map 12174 of the Active Override Measures 12170 is submitted to Stage 12180 which invokes LIZARD 120 to convert the Map 12174 into Appchain Syntax 9285 which is referenced as the Original Appchain Retention 12184. The Purpose Hierarchy Map 12168 of the Preferred Override Measures 12162 is submitted to Stage 12186 which invokes LIZARD 120 to convert the Map 12162 into Appchain Syntax 9285 which is referenced as the Upgraded Appchain Retention 12188. The Purpose Hierarchy Maps 12174 and 12168 are converted into Appchain Syntax 9285 so that Stage 12190 can invoke Deployment Patch Assembly (DPA) 6260 to create an Appchain Correction Patch 12192. Such a Patch 12192 contains the differences between both Appchain Retentions 12184 which practically correlates to the Active (original) Override Measures 12170 and the new Preferred override Measures 12162 that were proposed by the Target Mind 12702 as emulated via AOM2 12140.

FIG. 1022 shows details concerning the operation of LIZARD 120 to convert the Purpose Hierarchy Map 12174 of Active Override Measures 12170 into Appchain Syntax. The Map 12174 exists in Complex Purpose Format C325 and is submitted to Iterative Expansion C327 of the Purpose Module C36 within the Outer Core (OC) C329 of LIZARD 120. Iterative Expansion C327 adds detail and complexity to evolve a simple goal (indirectly defined within the Map 12174) into a specific complex purpose definition. Therefore the maximum Purpose Association C326 potential of the input is realized, and retained as a Complex Purpose Format C325, before it is submitted to Logical Derivation C320 of the Syntax Module (SM) C35. The Core Code C335 element of Inner Core (IC) C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1023 continues the logic flow from FIG. 1022 to illustrate the operation of LIZARD 120 to convert Active Override Measures 12170 into Appchain Syntax that is referenced as the Original Appchain Retention 12184. The input data is received in Complex Purpose Format C325 from the Purpose Module (PM) C36 and is transferred to Logical Derivation C320 of the Syntax Module (SM) C35. Logic Derivation C320 derives logically necessary functions from initially simpler functions. This means that if a function can be formed as a derivative function due to implication from a simpler parent function; then it is formed by Logical Derivation C320. The produced result is a tree of function dependencies that are built according to the defined Complex Purpose Format C325 data. Logical Derivation C320 operates according to the Rules and Syntax C322 definitions which are inherited from the Core Code C335 element of Inner Core (IC) C333. Logical Derivation C320 submits it's output to Code Translation C321. Code Translation C321 converts arbitrary (generic) code which is recognized and understood by SM C35 to any known and chosen computation language. Code Translation C321 also performs the inverse function of translating known computation languages into arbitrary syntax types. Therefore PM C36 invokes SM C35 to produce the resultant Appchain Syntax Version 12184 of the input Active Override Measures 12170 via Code Translation C321. The resultant Original Appchain Retention 12184 that is terminally produced by Code Translation C321 is the modular output of SM C35, Outer Core (OC) C329, and LIZARD 120.

FIG. 1024 shows details concerning the operation of LIZARD 120 to convert the Purpose Hierarchy Map 12168 of Preferred Override Measures 12170 into Appchain Syntax. The Map 12168 exists in Complex Purpose Format C325 and is submitted to Iterative Expansion C327 of the Purpose Module C36 within the Outer Core (OC) C329 of LIZARD 120. Iterative Expansion C327 adds detail and complexity to evolve a simple goal (indirectly defined within the Map 12168) into a specific complex purpose definition. Therefore the maximum Purpose Association C326 potential of the input is realized, and retained as a Complex Purpose Format C325, before it is submitted to Logical Derivation C320 of the Syntax Module (SM) C35. The Core Code C335 element of Inner Core (IC) C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1025 continues the logic flow from FIG. 1024 to illustrate the operation of LIZARD 120 to convert Preferred Override Measures 12162 into Appchain Syntax that is referenced as the Upgraded Appchain Retention 12188. The input data is received in Complex Purpose Format C325 from the Purpose Module (PM) C36 and is transferred to Logical Derivation C320 of the Syntax Module (SM) C35. Logic Derivation C320 derives logically necessary functions from initially simpler functions. This means that if a function can be formed as a derivative function due to implication from a simpler parent function; then it is formed by Logical Derivation C320. The produced result is a tree of function dependencies that are built according to the defined Complex Purpose Format C325 data. Logical Derivation C320 operates according to the Rules and Syntax C322 definitions which are inherited from the Core Code C335 element of Inner Core (IC) C333. Logical Derivation C320 submits it's output to Code Translation C321. Code Translation C321 converts arbitrary (generic) code which is recognized and understood by SM C35 to any known and chosen computation language. Code Translation C321 also performs the inverse function of translating known computation languages into arbitrary syntax types. Therefore PM C36 invokes SM C35 to produce the resultant Appchain Syntax Version 12188 of the input Preferred Override Measures 12162 via Code Translation C321. The resultant Appchain Syntax Version 12188 that is terminally produced by Code Translation C321 is the modular output of SM C35, Outer Core (OC) C329, and LIZARD 120.

FIG. 1026 summarizes and continues the logic shown on FIG. 1021. At Stage 12194: upon DPA 6260 successfully producing the Appchain Correction Patch 12192 via Stage 12190, it is committed to persistent Override Measure Retention (OMR) 12064 of the relevant BD 12018 or ID 12020 via Customchain Ecosystem Builder (CEB) 584. CEB 584 modifies the underlying Appchain that represents the relevant OMR 12064 instance, therefore installing the Appchain Correction Patch 12192.

FIG. 1027 shows the Concept of Liquidity Injection 12200 which illustrates further details concerning the economic concepts displayed in Stage 12100 of FIG. 1012 and Stage 12128 of FIG. 1013. The Concept 12200 initiates with Stage 12202, where consensus based decisions to invest in intelligent investment prediction services are made an Endowment Structure (ES) 12008. The ES 12008 funds the prediction service, Comprehensive State Evaluation (CSE) 12400, via the Investment Capital (IC) 12012. Thereafter Stage 12204 is executed, which invokes instances of CSE 12400 according to the CSE Invocation Interval 12084 which is defined in the Established Policy Retention (EPR) 12002 of the relevant ES 12008. A larger Interval 12084 implies less money is to be spent, which achieves a less accurate investment prediction from CSE 12400. whilst the inverse also applies. Upon invocation of CSE 12400 by Stage 12204, the operation of Stage 12206 is activated which implies that computational work is done across BCHAIN Nodes 786 that operate the BCHAIN Protocol 794, thus forming the BCHAIN Network 110. The operation of Stage 12206 implies the operation of Stage 12208, which indicates the manipulation of funds that are strategically allocated within the relevant Investment Capital (IC) 12012 instance accrues the Watt Economy 862 of the Metachain 834. Funds never cryptographically exist directly within the IC 12012 instance itself, but instead are pledged via WUP2 12016 by BCHAIN Nodes 786 that hold the funds. Therefore all Watt Units are managed by the Watt Economy 862 whilst cryptographically residing on physical BCHAIN Nodes 786. Therefore the Concept of Liquidity Injection 12200 indicates that the demand for Investors/Directors 12006/12022 initiates transfers of Watt Units within the Watt Economy 862 from BCHAIN Nodes 786 (that have pledged funds via WUP2 12016 to the relevant Investment Capital (IC) 12012 instance) to other BCHAIN Nodes 786 (that have performed the computational work to host the corresponding Target Investment Circumstances Interpretation (TICI) 12380, Comprehensive State Evaluation (CSE) 12400, and Automated Override Measure Manipulation (AOM2) 12140 instances).

FIGS. 1028-1030 shows the functionality and operation of Proposal Compliance Procedure (PCP) 12220, and it's corresponding interaction with Proposal Voting Interface (PVI) 12010.

FIG. 1028 shows how the logic initiates at Stage 12034 of PVI 12010, which indicates the submission of an Authorized Proposal 12222 (of the various Potential Authorized Proposals 12036) by a Director 12006/12022 to PCP 12220. Therefore Stage 12228 of PCP's 12220 justification is activated, which checks if the Authorized Proposal 12222 is submitted by a Board of Directors 12018/12230 or an Independent Director 12020/12232. If Option 12230 is incurred, then Stage 12234 is subsequently activated which determines the Investment Stake of the relevant Investment Capital (IC) 12012 Instance that is held by the Director 12006 according to the information stored in Stake Tracking retention 12000. Therefore Investment Stake 12236 is produced. If Option 12232 is incurred then the logic skips to Stage 12224 which Option 12230 also leads to. Upon the retrieval of Investment Stake 12236 via Stage 12234, Stage 12238 subsequently retrieves the Proposal Record 12242 of the relevant Director 12238 according to Proposal Tracking Retention (PTR) 12004. Such a Proposal Record 12242 contains all past proposals made by the specified Director 12238 as recorded within the ES 12008 via PTR 12004. Thereafter Stage 12240 calculates how often the specified Director 12006 is allowed to submit a Proposal via Director Proposal Allowance (DPA) 12260. Logic that is executed after Stage 12240, that is not illustrated on FIG. 1028, eventually leads to the activation of Stage 12224 if the Authorized Proposal 12222 is found to be compliant. This leads to the Compliant Proposal 12226 being submitted as modular output of PCP 12220 to Stage 12012 of PVI 12010. Stage 12012 entails the Compliant Proposal 12226 being submitted to the relevant Directors 12006 (of the Board of Directors (BD) 12018) or Director 12022 (of the Independent Director (ID) 12020). The multiple Directors 12006 are able to cast a vote for or against the Proposal 12226, therefore ensuring consensus amongst the Board 12018. For the sole Director 12022, the Compliant Proposal 12226 is automatically accepted by the Endowment Structure 12008 and therefore added to the relevant Proposal Tracking Retention (PTR) 12004 instance.

FIG. 1029 shows the Proposal Voting Interface (PVI) 12010 operating as a subset of the Director Voting Mechanism (DVM) 12030; hence showing added integration with the Proposal Compliance Procedure (PCP) 12220. The logic resumes from Stage 12240; which invokes Director Proposal Allowance (DPA) 12260 to calculate the Director Allowance 12244 of the specified Director 12006. Stage 12250 is subsequently processed considers if the Authorized Proposal 12222 submission is Compliant 12246 or Not Compliant 12248 according to the Director Allowance 12244 and the Proposal Record 12242. If the recent frequency of proposals made by the Director 12006, as indicated by the Proposal Record 122242, surpasses the Director Allowance 12244; then the Proposal 12222 is considered Not Compliant 12248. Upon the Not Compliant 12248 scenario, PCP 12220 reports to DVM 12030 that the Proposal 12222 submission should be rejected according to Stage 12078. The Compliant 12246 scenario is enacted if the frequency of the proposals indicated by the Proposal Record 122242 is within the threshold defined in Director Allowance 12244. Thus Compliant 12246 scenario leads to Stage 12224, which submits the now Compliant Proposal 12226 to Stage 12012 of PVI 12010. Therefore Stage 12056 of DVM 12030 submits the Compliant Proposal 12226 for voting to the other Directors 12006 via PVI 12010.

FIG. 1030 shows additional details concerning the operation of Stage 12240 which produces the Director Allowance 12244 variable via the operation of Director Proposal Allowance (DPA) 12260. At Stage 12262 the Director Allowance Multiplier 12264 is retrieved from the Established Policy Retention (EPR) 12002 of the relevant Board of Directors (BD) 12018 instance. The Multiplier 12264 represents a selected ratio that represents the intended Director Allowance 12244 in correlation with that Director's Investment Stake 12236. Therefore the proposal Allowance 12244 of the Director 12006 is correlated with the magnitude of investments they've made on behalf of the Endowment Structure (ES) 12008. Thereafter at Stages 12266 and 12268 the Director Allowance 12244 is produced by multiplying the Multiplier 12264 with the Investment Stake 12236. As indicated by Stage 12268, the Director Allowance 12244 represents the time window in hours that the Director 12006 is permitted to submit one Proposal. Therefore if the Allowance 12244 is twenty-four hours, the Director 12006 can submit one proposal in that twenty-four hour period but not anymore (until the Allowance 12244 period resets). This Allowance 12244 implementation acts as a spam abuse prevention mechanism, which can prove especially useful for Boards 12002 that contain large amounts of Directors 12006 that can easily attain membership (i.e. Crowdfunding). Therefore the Director Allowance 12244 is forwarded to Stage 12250 which is illustrated in detail. Stage 12268 indirectly leads to the activation of Stage 12270; which inspects the Proposal Record 12274 to discern when the Last Compliant Proposal 12272 was submitted by the Director 12006. Non-compliant Proposals 12222 do not count towards the Director's 12006 quota. Therefore the Last Compliant Proposal 12272 is produced and interpreted at Stage 12276. Stage 12276 checks if the calculated time since the Last Compliant Proposal 12272 is Greater Than 12276 or Lesser Than 12280 the Director Allowance 12244. If the calculated time is Greater Than 12276, then the Authorized Proposal 12222 is considered Compliant 12278. If the calculated time is Lesser Than 12280, then the Authorized Proposal 12222 is considered Not Compliant 12282.

FIG. 1031 shows the operation and functionality of Corporate Status Reporting (CSR) 12304. CSR 12304 manages information reports performed by registered corporate entities that submit operational information to their corresponding Corporate Entity Tracking Appchain. This in turn enables Comprehensive State Evaluation (CSE) 12400 to consider the operational activity of all registered corporate entities in processing an Endowment Structure's (ES) 12008 corresponding Ideal Investment Decision Makeup 12404. A corporate entity is ‘registered’ in the sense that it has opted to announce key elements of recorded data relating to it's operational activities (such as inventory, sales, employee makeup etc.) to the Corporate Entity Tracking Appchain 12302. CSR 12304 initiated by CSE 12400 at Stage 12288 which loops through all of the tracked Corporate Entities 12286 from Corporate Entity Tracking (CET) 12284. Thereafter at Stage 12290 the Corporate Entity Identity 1286 is retrieved from the Selected Unit of the Loop that was initiated at Stage 12288. Thereafter at Stage 12292 the BCHAIN Node 786 that is hosting this executing instance of CSR 12304 checks if the Corporate Entity Tracking Appchain 12302 that correlates with the Corporate Entity Identity 12286 exists and is update locally (on the Node 786). If not, then the ‘No, not up to date’ 12296 scenario has occurred which subsequently retrieves the relevant Corporate Entity Tracking Appchain 12302 by referencing the Metachain 834 via Content Claim Generator (CCG) 3050. CCG 3050 is a key function of the BCHAIN Protocol 794 that enables content to be retrieved from various BCHAIN Nodes 786 in the BCHAIN Network 110. The Customchain Recognition Module (CRM) 3060 is another key function of the BCHAIN Protocol 794, which automatically maintains Appchains 836 (and by extension, Microchains 838) that are defined in Registered Appchains 776. Therefore Realtime Updates 3062 are sourced from Appchain Updates 846 of the Metachain 834 to indicate if new content is available upon the specified Appchain 836. Therefore CRM 3060 will calculate if the specified Appchain 836 is locally retained (registered via Registered Appchains 776) and inform Stage 12292 if the local retention of the specified Appchain 836 is up to date 12294 or not up to date 12296. If CCG 3050 is invoked to update the specified Appchain 836, then various elements from the Metachain 834 are supplied to CCG 3050 such as Optimized Sector Routing 858, Appchain Cache Location 848, Chaotic Environment Tracking 856 and Location Association 840. This enables CCG 3050 to properly invoke the BCHAIN Network 110 for the requested content which eventually leads to Content Claim Rendering (CCR) 3300 receiving and validating the updated version of the Corporate Entity Tracking Appchain 12302. Therefore both Scenarios 1294 and 12296 will both eventually lead to Stage 12300 which checks if a reference to the Corporate Entity Identity 12286 exists in the Corporate Entity Tracking Appchain 12302.

FIG. 1032 continues from FIG. 1031 to describe Corporate Status Reporting (CSR) 12304, continuing from Stage 12300. If a reference concerning the Corporate Entity Identity 12286 exists in the Corporate Entity Tracking Appchain 12302, then the ‘Yes, reference exists’ 12303 Scenario is activated. Scenario 12303 leads to the reference of the corresponding Corporate Identity Appchain 12310; which holds the reported operations information from the Corporate Entity itself. With a ‘No, reference does not exist’ 12306 Scenario, the execution of CSR 12304 reaches an Error State, which implies a Diagnostic Log Unit (DLU) 1182 is submitted to the Diagnostic Log Submission (DLS) 1160 via Stage 5602. Thereafter the Error Report in the form of a DLU 1182 is forwarded by the Automated Research Mechanism (ARM) 134 to Self Programming Self Innovation (SPSI) 130 which processes the Error Report via the Diagnostic Log Unit Analysis (DLUA) 8048 sub module. This Error Reporting feedback loop with SPSI 130 leads to the programming of CSR 12304 to eventually change, to accommodate proven solution to the initial Error Report demonstrated by the DLU 1182. This follows the concept of SRIA illustrated in Figs. XYZ. In continuation of the Scenario 12303 logic branch the retrieved Corporate Identity Appchain 12310, which is specific to the Corporate Entity Identity 12286, is rendered from Stage 12308 via the BCHAIN Protocol 794 modules Execution Stream Collection (ESC) 6700, Data Stream Sorting (DSS) 6800, and Execution Stream Rendering (ESR) 6400. The logic is therefore continued on FIG. 1033.

FIG. 1033 continues the logic branch from Scenario 12303. The successful rendering of the Corporate Identity Appchain 12310 in ESR 6400 produces the Appchain Rendering Results 12314. The Appchain Rendering Results 12314 contains all the necessary API points of access to the Corporate Entity that corresponds with Corporate Identity Appchain 12310 and therefore the Corporate Entity Identity 12286. Such API points are submitted as modular input to the Corporate Entity API Report (CEAR) 12316 module, which is operated at Stage 12312. The API invocation that is performed at GEAR 12316 is done via the BCHAIN Network 110. Therefore it is required that the registered Corporate Entity has an active BCHAIN Node 786 in their jurisdiction, so as to properly publish the API to CEAR 12316. Therefore CEAR 12316 produces the corresponding Corporate Entity API Results 12318. Subsequently, Stage 12320 associates the API Results 12318 with it's corresponding Corporate Entity Identity 12322 and submits the pair to Corporate Collection Cache Retention (C3R) 12324 for temporary session storage. Thereafter the Loop logic is maintained by Prompt 12326, which checks if there are any Corporate Entities left in the Loop that was initiated by Stage 12288. If the response to Prompt 12326 is Yes 12328; then the flow of logic is returned to Stage 12332 which continues to iterate through the Tracked Corporate Entities 12286 from Corporate Entity Tracking (CET) 12284. FIG. 1034 continues the flow of logic and details the scenario of a No 12330 response to Prompt 12326.

FIG. 1034 overlaps with some of the logic of FIG. 1033 to continue the flow of logic from Stage 12320 and Prompt 12326. If the Response to Prompt 12326 is No 12330, then Stage 12334 is activated which commits the Execution Stream Rendering (ESR) 6400 session results from Corporate Collection Cache Retention (C3R) 12324 to Central Knowledge Retention (CKR) 648 of LOM 132. The data storage performed by C3R 12324 is maintained by temporary session storage in BCHAIN Nodes 786 across the BCHAIN Network 110. Such temporary session storage is typically in the form of Random Access Memory (RAM); which is an efficient medium for holding temporary storage results yet is unable to maintain the information past a system reboot. Therefore when C3R 12324 is operating within the BCHAIN Protocol 794; ESR 6400 uses the Session Write Data Segment 6420 Command Type to operate data instructions for C3R 12324. The definition of the Session Write 6420 Command 6408 is defined by the Execution Segments 551 that exist in the Appchain 836 that represents CSR 12304. Therefore in contrast to the temporary Session Write Data Segment 6420 Command 6408 usage, the Persistent Write Data Segment 6422 Command 6408 is used for Stage 12334 which commits the temporary ESR 6400 session results to Persistent 6422 CKR 648 storage. There the section of Appchain 836 that specifically defines Stage 12334 contains Execution Segments 551 which indicate a Persistent Write 6422 Command 6408. Stage 12326 perceives of any Corporate Entities left in the Loop via information coming from Stage 12332 which initiates the Loop itself. Therefore the Loop counter is maintained in Stage 12332.

FIG. 1035 shows the functionality and operation of Market Research Procedure (MRP) 12340. MRP 12340 is initiated by the operation of Comprehensive State Evaluation (CSE) 12400 via the sub-module Research Invocation Prompt (RIP) 12338. RIP 12338 invokes an instance of LOM 132 which researches Market Activity and Events via the Automated Research Mechanism (ARM) 134 at Stage 12342. The results of the research performed by ARM 134 are processed at Stage 12344 which stores new and unconfirmed information to Central Knowledge Retention (CKR) 12344. Thereafter at Stage 12346, within a large time scale, LOM 132 gradually interacts with the new and unconfirmed information stored in CKR 648 to produce meaningful and usable assertions and conclusions relating to Market Activity and Events. Therefore LOM 132 produces Market Activity Knowledge 12348 at Stage 12346, and the Knowledge 12348 is subsequently stored in CKR 648 for later reference by CSE 12400.

FIG. 1036 elaborates on execution details concerning Stage 12346 of MRP 12340. Initially ARM 134 retrieves unconfirmed information from public and private sources at Stage 12350. Thereafter at Stage 12354 LOM 132 and CTMP 124 verify the unconfirmed information and expand on it to produce truthful concepts. The element of truth found within a concept/assertion is determined by LOM's 132 objectivity-seeking programming, which is enabled by the critical thinking abilities of CTMP 124. Therefore at Stage 12356 the confirmed knowledge which LOM 132 claims to be in accord with objective truth-seeking is produced as Market Activity Knowledge 12348 and subsequently stored in CKR 648 for later reference by CSE 12400.

FIG. 1037 shows the functionality and operation of Regulatory/Tax Research Procedure (RTRP) 12360. RTRP 12360 is initiated by the operation of Comprehensive State Evaluation (CSE) 12400 via the sub-module Research Invocation Prompt (RIP) 12338. RIP 12338 invokes an instance of LOM 132 which researches Tax and Regulatory Codes via the Automated Research Mechanism (ARM) 134 at Stage 12362. The results of the research performed by ARM 134 are processed at Stage 12364 which stores new and unconfirmed information to Central Knowledge Retention (CKR) 12344. Thereafter at Stage 12366, within a large time scale, LOM 132 gradually interacts with the new and unconfirmed information stored in CKR 648 to produce meaningful and usable assertions and conclusions relating to Tax and Regulatory codes. Therefore LOM 132 produces Tax Liability Knowledge 12364 and Regulatory Compliance Knowledge 12370 at Stage 12366, which are subsequently stored in CKR 648 for later reference by CSE 12400.

FIG. 1038 elaborates on execution details concerning Stage 12366 of RTRP 12360. Initially ARM 134 retrieves unconfirmed information from public and private sources at Stage 12350. Thereafter at Stage 12376 LOM 132 and CTMP 124 verify the unconfirmed information and expand on it to produce truthful concepts. The element of truth found within a concept/assertion is determined by LOM's 132 objectivity-seeking programming, which is enabled by the critical thinking abilities of CTMP 124. Therefore at Stage 12378 the confirmed knowledge which LOM 132 claims to be in accord with objective thrush-seeking is produced as Tax Liability Knowledge 12364 and Regulatory Compliance Knowledge 12370 and subsequently stored in CKR 648 for later reference by CSE 12400.

FIGS. 1039-1087 show the operation and functionality of the Comprehensive State Evaluation (CSE) 12400 module, which is the core program that performs intelligent investment research/calculations on behalf of NMC 114 as a whole.

FIG. 1039 shows how CSE 12400 is initialized by Target Investment Circumstances Interpretation (TICI) 12380, which provides Target Investment Circumstances 12160 as modular input to CSE 12400 (at Stage 12402). TICI 12380 begins with Stage 12382, which extracts the Portfolio Stake Makeup 12384 of the relevant Portfolio Stake Retention (PSR) 12003 instance of the corresponding Endowment Structure (ES) 12008. Thereafter at Stage 12386 Override Measures 12388 are extracted from the relevant Override Measure Retention (OMR) 12064 of the corresponding Endowment Structure (ES) 12008. Override Measures 12388 induce an intended customization effect to the resultant Ideal Investment Decision Makeup 12404 via criteria chosen and vote on by Directors 12006/12022 via the Director Voting Mechanism (DVM) 12030. Such Measures 12388 can be manually chosen investment customizations (such as: do not make any investment in value that is dependent on a healthy automative industry/market), or automatically chosen by specified personalities via emulations performed at Digital Mind Tracking (DMT) 12700. At Stage 12390 the information contained in Portfolio Stake Makeup 12384 and Override Measures 12388 are merged in an Abstraction Container which becomes Target Investment Circumstances 12160. Therefore the Abstraction Container 12160 is submitted to CSE 12400 as modular input, and is subsequently processed generally at Stage 12402. Upon completed invocation of LOM 132 and CTMP 124 by Stage 12402; Ideal Investment Decision Makeup 12404 is eventually produced. Makeup 12404 is the final modular output of CSE 12400.

FIG. 1040 continues the initiation logic flow of CSE 12400. Stage 12406 invokes Market Research Procedure (MRP) 12340 so that CKR 846 via LOM 132 will produce Market Activity Knowledge 12348 (see FIG. 1035) for CSE 12400 processing. The subsequent Stage 12408 continues the logic flow once instantaneous processing of MRP 12340 is complete. MRP 12340 instantaneous processing completion is defined as the completion of Stage 12352, where/when the initial unconfirmed information is stored in CKR 648. Subsequent Stages 12354 and 12356 within MRP 12340 are considered post-instantaneous processing. This is because these Stages 12354 and 12356 occur over a significantly long period of time where LOM 132 and CTMP 124 gradually process the unconfirmed information and derive truthful assertions and conclusions relating to such information. Therefore the thread management of CSE 12400 at Stage 12408 blocks continuation to Stage 12410 until Stage 12352 of MRP 12340 is complete. Upon continuation to and operation of Stage 12410, Regulatory/Tax Research Procedure (RTRP) 12360 is invoked so that CKR 846 via LOM 132 will produce Tax Liability Knowledge 12364 and Regulatory Compliance Knowledge 12370 for CSE 12400 processing. The subsequent Stage 12410 continues the logic flow once instantaneous processing of RTRP 12360 is complete. RTRP 12360 instantaneous processing completion is defined as the completion of Stage 12374, where/when the initial unconfirmed information is stored in CKR 648. Subsequent Stages 12376 and 12378 within RTRP 12360 are considered post-instantaneous processing. Therefore the thread management of CSE 12400 at Stage 12412 blocks continuation to Stage 12414 until Stage 12374 of RTRP 12360 is complete. Upon continuation to and operation of Stage 12414, Corporate Status Report (CSR) 12304 is invoked so that CKR 846 via LOM 132 will produce Corporate Status API Results for CSE 12400 processing. The subsequent Stage 12410 continues the logic flow once instantaneous processing of CSR 12304 is complete. CSR 12304 instantaneous processing completion is defined as the initiation of the Loop of Stage 12288. The entire operation of the Loop from Stage 12288 within CSR 12304 is considered post-instantaneous processing. Therefore the thread management of CSE 12400 at Stage 12416 blocks continuation to Stage 12422 until Stage 12288 of CSR 12304 has been initiated.

FIG. 1041 continues the logic flow from Stage 12416, which receives input from Market Research Procedure (MRP) 12340, Regulatory/Tax Research Procedure (RTRP) 12360, and Corporate Status Report (CSR) 12304. Thereafter at Stage 12422 Digital Exchange Status Report (DESR) 12418 is invoked so that CKR 648 via LOM 132 will obtain information updates from UBEC Platform 100 Apps from the Cryptographic Digital Economic Exchange (CDEE) 705. Stage 12424 continues the logic flow once DESR 12418 instantaneous processing is complete. Thereafter, Stage 12426 halts the execution logic until an execution condition has been met. Such a condition is defined as when MRP 12340, RTRP 12360, CSR 12304, and DESR 12418 have all completed their long term processing execution logic operations. This correlates with each one's final modular output, confirmed knowledge, being submitted to CKR 648.

FIG. 1042 continues the logic flow from Stage 12426. A ratio labelled magnitude X is defined in Static Hardcoded Policy (SHP) 488 is factored in the condition check of Stage 12426. Therefore if magnitude X is of higher value, it will take exponentially longer for Stage 12426 to achieve it's condition trigger. The inverse correlation applies. If the instantaneous execution of Stage 12426 indicates a No 12430 response to the condition check, then Stage 12432 is activated which halts the execution of CSE 12400 for Y amount of time, Y being defined in SHP 488. After Y amount of time has passed, Stage 12426 is reexecuted as a subsequent attempt to achieve a Yes 12428 response. A Yes 12428 response to Stage 12426 indicates that the condition trigger in Stage 12426 has been met. Therefore Stage 12434 is executed which produces Market Activity Knowledge 12348 from CKR 648. Thereafter Stage 12436 processed similar logic to Stage 12434 which produces Tax Liability Knowledge 12368. Market Activity Knowledge 12348 and Tax Liability Knowledge 12368 are proceeded at Stage 12402. Stage 12402 is a large scale operation which invokes LOM 132 and CTMP 124 to produce the final output of CSE 12400: Ideal Investment Decision Makeup 12404. Stage 12402 receives Target Investment Circumstances 12160 as input, as it it the main modular input into CSE 12400 that is provided by Target Investment Circumstances Interpretation (TICI) 12380.

FIG. 1043 illustrates the same logic as FIG. 1042 but with the added detail of Stages 12440 and 12442 being executed prior to Stage 12402. Stage 12440 produces Regulatory Compliance Knowledge 12370 from CKR 648 and submits it to Stage 12402. Stage 12442 produces Corporate Operations Knowledge 12444 from CKR 648 and also submits it to Stage 12402. This facilitates the operation of invoked instances of LOM 132 and CTMP 124 via Stage 12402 to produce the Ideal Investment Decision Makeup 12404. Whilst CSE 12400 is the core module of NMC, Stage 12402 is the core operations container of CSE 12400, with terminal inputs and outputs of Target Investment Circumstances 12160 and Ideal Investment Decision Makeup 12404 respectively.

FIG. 1044 shows details concerning Stage 12434 of CSE 12400, where LOM 132 produces Market Activity Knowledge 12348 from CKR 648. LOM 132 is invoked to produce such Knowledge 12348 by the NMC Knowledge Invocation Prompt (NKIP) 12446 module. Market Activity Knowledge 12348 is illustrated as being built of multiple instances of UKF Clusters C854F. The individual element of the UKF Cluster C854F is elaborated in detail as being made up of UKF1, UKF2, and UKF3 sub-units that are stored in Rule Syntax Format C538.

FIG. 1045 shows details concerning Stage 12436 of CSE 12400, where LOM 132 produces Tax Liability Knowledge 12368 from CKR 648. LOM 132 is invoked to produce such Knowledge 12368 by the NMC Knowledge Invocation Prompt (NKIP) 12446 module. Tax Activity Knowledge 12368 is illustrated as being built of multiple instances of UKF Clusters C854F. The individual element of the UKF Cluster C854F is elaborated in detail as being made of UKF1, UKF2, and UKF3 sub-units that are stored in Rule Syntax Format C538.

FIG. 1046 shows details concerning Stage 12440 of CSE 12400, where LOM 132 produces Regulatory Compliance Knowledge 12370 from CKR 648. LOM 132 is invoked to produce such Knowledge 12370 by the NMC Knowledge Invocation Prompt (NKIP) 12446 module. Regulatory Compliance Knowledge 12370 is illustrated as being built of multiple instances of UKF Clusters C854F. The individual element of the UKF Cluster C854F is elaborated in detail as being made of UKF1, UKF2, and UKF3 sub-units that are stored in Rule Syntax Format C538.

FIG. 1047 shows details concerning Stage 12442 of CSE 12400, where LOM 132 produces Corporate Operations Knowledge 12444 from CKR 648. LOM 132 is invoked to produce such Knowledge 12444 by the NMC Knowledge Invocation Prompt (NKIP) 12446 module. Corporate Operations Knowledge 12370 is illustrated as being built of multiple instances of UKF Clusters C854F. The individual element of the UKF Cluster C854F is elaborated in detail as being made of UKF1, UKF2, and UKF3 sub-units that are stored in Rule Syntax Format C538.

FIG. 1048 shows the internal operation procedure of LOM 132 and CTMP 124 in regards to Stage 12402 of CSE 12400. The Target Investment Circumstances 12160 are supplied as initial input to the Idealistic Configuration Invocation Prompt (ICIP) 12403. ICIP 12403 produces a Prompt 12448 that interacts directly with LOM 132 to invoke the production of the Ideal Investment Decision Makeup 12404 with consideration of the input criteria Target Investment Circumstances 12160. The Prompt 12448 produced by ICIP 12403 is submitted to the Initial Query Reasoning (IQR) C802A module of LOM 132. When LOM 132 is invoked directly within the UBEC Platform 100 by an UBEC User 106, IQR C802A receives the initial question/assertion provided by the UBEC User 106. However this instance of LOM 132 is automatically invoked by ICIP 12403 instead. The provided Prompt 12448 is analyzed via invocation of Central Knowledge Retention (CKR) 648 to decipher Missing Details from the Prompt 12448 that are crucial to complete the correct ‘virtual understanding’ by LOM 132 for LOM 132 to fully address/respond to the Prompt 12448. The resultant Missing Details produced by IQR C802A are submitted as modular input to Survey Clarification (SC) C803A. SC C803A engages with the origin of the Prompt 12448 to retrieve supplemental information so that the Prompt 12448 can be analyzed objectively and with all the necessary context. When LOM 132 is invoked directly within the UBEC Platform 100 by an UBEC User 106, SC C803A engages with that User 106 as the origination of the question/answer. However this instance of LOM 132 is automatically invoked by ICIP 12403 instead, therefore SC C803A engages with ICIP 12403 to retrieve supplemental information concerning the Prompt 12448. The fully formed and refined version of the Prompt 12448 is produced from SC C803A and submitted as modular input to Assertion Construction (AC) C808A. AC C808A attempts to form a coherent response to the Prompt 12448 by referencing CKR 648 directly and also via Hierarchical Mapping (HM) C807A. Rational Appeal (RA) C811A is a container module that houses a logic flow interface with CTMP 124. RA C811A uses CTMP 124 to criticize assertions. Such criticisms can be in the form of self-criticisms (by criticizing the output of AC C808A), or external criticisms to the origin of the question/assertion processed by IQR C802A (UBEC User 106 or ICIP 12403). If an assertion produced from AC C808A fails a significant measure of the self-criticism test processed by RA C811A; then a new instance of AC C808A is invoked to account for any valid criticisms. If a high confidence assertion is produced by AC C808A that consistently passes self-criticism tests processed by RA C811A; then the assertion is produced as LOM's 132 modular output, referenced as the Ideal Investment Decision Makeup 12404 in context of the initial Prompt 12448 provided by ICIP 12403.

FIG. 1049 shows more detail of the internal operation procedure of Rational Appeal (RA) C811A of LOM 132 in regards to Stage 12402 of CSE 12400. Assertion Construction (AC) C808A provides a Response Presentation C843 to Rational Appeal (RA) C811A concerning the assertion produced by AC C808A in regards to the corresponding input Prompt 12448. At this stage of the logic flow, the produced assertion is classified as a Pre-Criticized Decision C847. This indicates that it is has yet to be processed via criticism by CTMP 124. Therefore the produced assertion is directly submitted to the CTMP 124 instance as a ‘Subjective Opinion’ C848 input, and also to Context Construction (CC) C817A which provides the ‘Objective Fact’ C850 input to the CTMP 124 instance. CC C817A references metadata from AC C808A and potential evidence provided via ICIP 12403 to submit raw facts to CTMP 124 for critical thinking. Such input metadata is represented by the LOM Log Aggregate 5502 file. The LOM Log Aggregate 5502 contains a collection of relevant log files that are produced from the primary operating functions of LOM 132. After the CTMP 124 instance concludes it's operation, a Post-Criticized Decision C851 is produced as modular output. The initial Pre-Criticized Decision C847 and Post-Criticized Decision C851 are submitted to the Decision Comparison (DC) C818A module which determines the scope of potential overlap between the two inputs C847 and C851. The unified output provided by DC 818A can either indicate CTMP's 124 Concession C852 (of incorrectness) on behalf of the AC C808A produced assertion, or a perceived Improvement C853 on behalf of the AC C808A produced assertion. Both Argument Responses C852 and C853 can be classified as either Low Confidence Results C845 or High Confidence Results C846. A Low Confidence Result C845 indicates that the original assertion produced by AC C808A is flawed and should be reconstructed; therefore the logic flow continues to a new instance of AC C808A. A High Confidence Result C846 indicates that the original assertion produced by AC C808A has merit, therefore the drawn conclusions (coupled with any corresponding evidence, premises etc.) are submitted to Knowledge Validation (KV) C805A. Therefore the logic flow continues to a new instance of KV C805A so that CKR 846 and hence LOM 132 can benefit from the recently processed assertion.

FIG. 1050 continues the logic flow of Stage 12402 from CSE 12400 to illustrate the production of the LOM Log Aggregate 5502 file. Modular outputs produced from Initial Query Reasoning (IQR) C802A, Survey Clarification (SC) C803A, Assertion Construction (AC) C808A, Hierarchical Mapping (HM) C807A and Knowledge Validation (KV) C805A are submitted to the LOM Modular Log Collection (LMLC) 5500 module. Therefore LMLC 5500 combines the input log data into a single readable file referenced as LOM Log Aggregate 5502. The File 5502 encompasses the overall operational state of the corresponding LOM 132 instance, hence providing information as to how the LOM 132 instance reached various conclusions. The LOM Log Aggregate 5502 is submitted to CC C817A of Rational Appeal (RA) C811A.

FIG. 1051 expands on operational details concerning FIG. 1049 to illustrate the internal operation of CTMP 124 in regards to the input and output channels defined in Rational Appeal (RA) C811A. The Pre-Criticized Decision C847 is Presented C843 as modular output from Assertion Construction (AC) C808A. The Decision C847 is then marked as a Subjective Opinion C848, therefore fulfilling one of the two major inputs of CTMP 124. The Subjective Opinion C848 is submitted to Input System Metadata C484, which acts as the primary modular input for CTMP 124 and an internal representation of the Selected Pattern Matching Algorithm (SPMA). For this instance configuration; the SPMA is LOM 132. Input System Metadata C484 is submitted for processing to. Reason Processing C456 and to Raw Perception Production (RP²) C465. Reason Processing C456 will logically understand the assertions being made by comparing property attributes. RP² C465 parses the Input System Metadata C484 from LOM 132 to produce a perception in Perception Complex Format (PCF) that represents the algorithmic perception of LOM 132. Such a produced Perception is submitted to the Perception Observer Emulator (POE) C475 which emulates the algorithmic perception of LOM 132. Reason Processing C456 invokes Rule Processing which eventually produces rulesets that reflect the SPMA algorithm which in this instance is LOM 132. Therefore two modes of ‘thinking’ are executed, ‘analogue’ perception and ‘digital’ ruleset processing. These two Branches C461 and C475 represent similitudes with intuition and logic. The results produced by both thinking Branches C461 and C475 are transferred to Critical Decision Output (CDO) C462, which evaluates any fundamental elements of conflict or corroboration between the results. Upon finding a high magnitude of internal corroboration, and a low magnitude of internal conflict CTMP 124 provides a binary Approve or Block decision, in regards to the initial input Subjective Opinion C848, that is referenced as a High Confidence Result C846. If there is a low magnitude of internal corroboration and a high magnitude of internal conflict CTMP 124 submits a ‘vote of no confidence’ which is referenced as a Low Confidence Result C845. Therefore the resultant output of CTMP 124 is considered the Post-Criticized Decision C851.

FIG. 1052 shows more details concerning the invocation of Raw Perception Production (RP²) C465 within CTMP 124. LOM 132 produces the Ideal Investment Decision Makeup 12404 by invoking Assertion Construction (AC) C808A. The Makeup 12404 is then submitted to Stage 5506 of RP² C465 which unpacks the data to produce instances of a Debugging Trace C485 and Algorithm Trace C486 within the Input System Metadata C484 which originates from the corresponding AC C808A instance. Debugging Trace C485 is a coding level trace that provides variables, functions, methods and classes that are used along with their corresponding input and out variable type and content. The full function call chain (function trace: functions calling other functions) is provided. The Algorithm Trace C486 is a software level trace that provides security data coupled with algorithm analysis. The resultant security decision (approve/block) is provided along with a logistics trail of how it reached the Decision C847. The appropriate weight concerning each factor that contributed to producing the Decision C847 is included. Thereafter RP² C465 transfers the data concerning the produced perception result to Perception Observer Emulator (POE) C475 for processing.

FIG. 1053 elaborates on the operation of Raw Perception Production (RP²) C465 from within CTMP 124. Initially Stage 5506 occurs, as it does on FIG. 1052, to unpack the data to produce instances of a Debugging Trace C485 and Algorithm Trace C486 within the Input System Metadata C484 which originates from the corresponding AC C808A instance. At Stage 5508, Metric Processing C489 reverse engineers the variables from LOM 132 to extract perceptions from the artificial intelligence exhibited by LOM 132. Thereafter Input System Metadata C484 is processed by Stage 5510, which separates Metadata C484 into meaningful security cause-effect relationships via System Metadata Separation (SMS) C487. As also indicated by FIG. 1052, RP² C465 transfers the data concerning the produced perception result to Perception Observer Emulator (POE) C475 for processing.

FIG. 1054 elaborates on the operation of Perception Observer Emulator (POE) C475, include it's and Raw Perception Production's (RP²) C465 relation to Perception Storage (PS) C478. The operation of Metric Processing C489 and System Metadata Separation (SMS) C487 both lead to the production of Perceptions 5512/5514/5516 that are thereafter stored in PS C478. The resulting Perceptions 5512/5514/5516 represent LOM's 132 modular response of producing the Ideal Investment Decision Makeup 12404 via Assertion Construction (AC) C808A. RP² C465 produces a Comparable Variable Format datapoint which is fed into Storage Search (SS) C480 as search criteria. Thereafter SS C480 performs a lookup of PS C478 to find matches with already existing Perceptions stored in PS C478. The Results C716 of the execution SS C480 are produced which leads to a Weight Calculation C718. Such a Calculation C718 attempts to find the correct distribution of corresponding Perceptions from PS C478 to replicate and match the Comparable Variable Format which represent's the execution of the LOM 132 algorithm that produced Ideal Investment Decision Makeup 12404.

FIG. 1055 continues the Perception Observer Emulator (POE) C475 logic from FIG. 1054. After the production of Results C716 from Storage Search (SS) C480, the Weight Calculation C718 completes to lead to the Application C729 of the Perceptions 5512/5514/5516 to make an active Approve C731 or Block C730 decision. The Ideal Investment Decision Makeup 12404 produced by LOM 132 and corresponding LOM Log Aggregate 5502 undergo Data Parsing C724 which causes Data Enhanced Logs C723 to be derived which are applied in the Application C729 to achieve an Interpretation Dichotomy 5518 of a Positive Sentiment (Approve) C731 or Negative Sentiment (Block) C730 with regards to the input Ideal Investment Decision Makeup 12404. Upon successful conclusion of the execution of Application C729 leads to an Override Corrective Action C476 which is processed by Critical Decision Output (CDO) C462 in parallel to the modular output of Rule Execution (RE) C461. The Self-Critical Knowledge Density (SCKD) C474 module estimates the scope and type of potential unknown knowledge that is beyond the reach of the reportable LOM Log Aggregate 5502. This way the subsequent critical thinking features of the processing CTMP 124 instance can leverage the potential scope of all involved knowledge, known and unknown directly by the instance.

FIG. 1056 shows the Memory Web C460 process that operates in parallel to the execution of Perception Observer Emulator (POE) C475 in FIG. 1055. The Ideal Investment Decision Makeup 12404 produced by LOM 132 is submitted as modular input to Reason Processing C456. Reason Processing C456 processes how LOM 132 achieved the decision to produce the Makeup 12404 in response to the Prompt 12448 provided by ICIP 12403. The processing conclusion of Reason Processing C456 is the execution of Reason Processing C457, which defines the rules that are thirdly consistent with LOM's 132 execution behavior. If any inconsistencies are found in rule behavior with regards to LOM's 132 execution behavior, then currently existing rules are modified or new rules are added. Such rules are later used within the CTMP 124 instance to criticize decision making behaviors found within the corresponding LOM 132 instance. Critical Rule Scope Extender (CRSE) C458 then leverages known Perceptions to expand the ‘critical thinking’ scope of the rulesets, in effect enhancing the rulesets to produce Correct Rules C459. The Correct Rules C459 are then submitted as modular input to Rule Syntax Format Separation (RSFS) C499 from within the operating jurisdiction of Memory Web C460. RSFS C499 separates and organizes Correct Rules C459 by type. Therefore all actions, properties, conditions and objects are listed separately after RSFS C499 processing. This enables the CTMP 124 instance to discern what parts have been found in the Chaotic Field, and what parts have not. Chaotic Field Parsing (CFP) C535 combines and formats the LOM Log Aggregate 5502 into a single scannable unit referenced as the Chaotic Field. The Chaotic Field is submitted as modular input to Memory Recognition (MR) C501. MR C501 also receives the Original Rules C555 which is the execution result from RSFS C499. MR C501 scans the Chaotic Field provided by CFP C535 to recognize knowable concepts defined in Original Rules C555. This MR C501 instance execution produces Recognized Rule Segments C556. Thereafter Rule Fulfillment Parser (RFP) C498 receives individual parts of the Original Rules C555 that have been tagged according to their recognition or lack-thereof within the Chaotic Field by MR C501. RFP C498 can then logically deduce which whole ruleset (the combination of all of their parts) have been sufficiently recognized in the Chaotic Field to merit processing by Rule Execution (RE) C461. Upon successful conclusion of the execution of RE C461 leads to an Override Corrective Action C476 which is processed by Critical Decision Output (CDO) C462 in parallel to the modular output of Perception Observer Emulator (POE) C475.

FIG. 1057 elaborates on the logic flow interaction between Perception Storage (PS) C478 and the Automated Perception Discovery Mechanism (APDM) C467. PS C478 contains four subsets of Perceptions: Deduced Unknown Angles of Perception C473, All Angles of Perception C472, Implied Angles of Perception C471, and Applied Angles of Perception C470. Applied Angles of Perception C470 are Perceptions that have been directly imported by studying algorithmic behavior of the Selected Pattern Matching Algorithm (SPMA), which in this instance is LOM 132. Implied Angles of Perception C471 are Perceptions that have been derived from Applied Angles of Perception C470 via modular execution of Implication Derivation (ID) C477 and APDM C467. All Angles of Perception C472 represents the entire scope of known Perceptions to the CTMP 124 instance that have not been included by Applied Angles of Perception C470 and Implied Angles of Perception C471. Deduced Unknown Angles of Perception C473 represents the scope of Perceptions that is expected to exist yet the CTMP 124 instance has yet to discover according to the Self-Critical Knowledge Density (SCKD) C474 module. ID C477 analyzes the individual metrics of Applied Angles of Perception C470 to deterministically derive Implied Angles of Perception C470, whilst APDM C467 creatively varies compositions of Angles of Perception C650 via the Creativity Module 112 to produce a New Iteration C653 that combines the initial two input Weights C652. Therefore all of the Angles of Perception C650 involved with APDM C467 processing correspond with and represent the Ideal Investment Decision Makeup 12404 that is produced by LOM's 132 Assertion Construction (AC) C808A module.

FIG. 1058 elaborates on the operational details concerning the Critical Rule Scope Extender (CRSE) C458 of CTMP 124. A Rational Appeal (RA) C811A instance operates within LOM 132 and invokes Context Construction (CC) C817A to process the LOM Log Aggregate 5502 to Chaotic Field Parsing (CFP) C535. CFP produces a Chaotic Field from the modular output of CC C817A which is referenced by Memory Recognition (MR) C501. Current Rules C534 exhibits rulesets that are indicative of the current functioning state of the Selected Pattern Matching Algorithm (SPMA) which in this instance is LOM 132. Current Rules C534 is submitted as modular input to the Rule Syntax Derivation (RSD) C504 module, which is where logical ‘black and white’ rules are converted to metric based perceptions. Therefore the complex arrangement of multiple rules are converted into a single uniform perception that is expressed via multiple metrics of varying gradients. The modular output of RSD C504 is provided as modular input to Perception Matching (PM) C503. At PM C503; a Comparable Variable Format (CVF) unit is formed from the Perception received from RSD C504. The newly formed CVF is used to lookup relevant Perceptions in the Perception Storage (PS) C478 with similar indexes. The potential matches are submitted as modular input to Rule Syntax Generation (RSG) C505. RSG C505 receives previously confirmed perceptions which are stored in Perception format and accesses the Perception's internal metric makeup. The Perceptions are received from PS C478 which contains Previously Confirmed Perceptions C468. Such gradient-based measures of metrics are converted to binary and logical rulesets that emulate the input/output information flow of the original perception. Therefore RSG C505 produces Perceptive Rules C537 which are Perceptions that are considered relevant, popular and have been converted into logical rules. If a Perception (in it's original Perception Format) had many complex metric relationships that defined many ‘grey areas’, the ‘black and white’ local rules encompass such ‘grey’ areas by expanding on the ruleset complexity. Therefore the Perceptive Rules C537 are stored by a collection of Rule Syntax Format (RSF) definitions. Perceptive Rules C537 are submitted as modular input to Memory Recognition (MR) C501, where they are scanned against the Chaotic Field which was produced by CFP C535. Therefore MR C501 produces Extra Rules C536 which complete Correct Rules C533 in their validity.

FIG. 1059 elaborates on the operational details concerning Implication Derivation (ID) C477 of CTMP 124. The Applied Angles of Perception C470 from Perception Storage (PS) C478 are submitted as modular input to ID C477 to produce more Perceptions that belong to Implied Angles of Perception C471. The Applied Angles of Perception C470 are specifically sent to Metric Combination C493 of ID C477. Metric Combination C493 separates the received Angles of Perception C650 into categories of metrics: Scope C739, Type C740, Consistency C741, Intensity C742. The Metric availability and reference within the system is not necessarily limited to these four types. The input Angles of Perception C650 are related to the Ideal Investment Decision Makeup 12404 that was produced by LOM's 132 Assertion Construction (AC) C808A module. The Metric Complexity Set A C736 is submitted as modular input to Metric Expansion (ME) C495. With ME C495 the metrics of multiple and varying Angles of Perception C650 are stored categorically in individual databases C739/C740/C741/C742. ME C495 enhances the current batch of received metrics with details/complexity extracted from previously known/encountered metrics. Upon enhancement and complexity enrichment completion, the metrics are returned as ME C495 modular output as Metric Complexity Set B C737 and thereafter converted back into Angles of Perception C650 to be stored in Implied Angles of Perception C471 as illustrated on FIG. 1060.

FIG. 1060 continues the logic flow of Implication Derivation (ID) C477 from FIG. 1059, illustrating the Metric Complexity Set B C737 being processed by Metric Conversion C494 which reverses individual metrics back into whole Angles of Perception C650. Despite the enrichment and conversion process performed by ID C477, the resultant Angles of Perception C650 still provide a reasonably accurate representation of the Ideal Investment Decision Makeup 12404 produced by LOM's 132 Assertion Construction (AC) C808A module. Therefore the Metric Conversion C494 process submits the newly derived/implied Angles of Perception C650 to Implied Angles of Perception C471 within Perception Storage (PS) C478.

FIG. 1061 elaborates on the operational details concerning Critical Decision Output (CDO) C462 of CTMP 124. CDO C462 receives modular output from both major branches of CTMP 124: Perception Observer Emulator (POE) C475 (as the intuition branch) and Rule Execution (RE) C461 (as the logical branch). Each Branch C475/461 submits it's respective Critical Decision C521 (the main modular output) as well as corresponding the ‘Meta-metadata’ C521, which provides contextual variables that justify why the initial critical decision was reached. Both Decision Sets C521 that represent the Perceptions C516 of POE C475 and the Fulfilled Rules C517 of RE C461 are submitted to the Metadata Categorization Module (MCM) C488. MCM C488 separates the Debugging and Algorithm Traces into distinct categories using traditional syntax based information categorization. Such categories can then be used to organize and produce distinct security responses with a correlation to security risks and subjects. The Intuitive Decision C514, which represents Perceptions C526 from POE C475, and the Thinking Decision C515, which represents Fulfilled Rules C517 from RE C461 are submitted by MCM C488 to the Internal Processing Logic 5520 of Direction Decision Comparison (DDC) C512. The Internal Processing Logic 5520 of DDC C512 checks for corroboration or conflict between the Intuitive Decision C514 and the Thinking Decision C515. DDC C512 references a ‘cutoff’ variable from Static Hardcoded Policy (SHP) 488. If the ‘cutoff’ variable is not reached for similarity between the Intuitive Decision C514 and the Thinking Decision C515 (i.e. 90%+), then the Cancel Direct Comparison 5524 directive occurs, which might load the Terminal Output Control (TOC) C513 to eventually submit a Vote of No Confidence 5544 as shown on FIG. 1062. The Cancel Direct Comparison 5524 stage implies that CTMP 124 was unable to act internally consistent in regards to the input Prompt 12448 from ICIP 12403. If the ‘cutoff’ variable was sufficiently met according to the Internal Processing Logic 5520, then the Final Decision Output 5522 stage is invoked which combines both Decisions C514/C515 into a single modular output which is received and processed by TOC C513.

FIG. 1062 continues the logic flow of Critical Decision Output (CDO) C462 from FIG. 1061 and elaborates on the operational details of Terminal Output Control (TOC) C513. TOC C513 initiates with Prompt 5526, which checks if Direct Decision Comparison (DDC) C512 was able to provide a Final Decision Output 5522 (instead of the Cancel Direct Comparison 5524 directive). If the response to Prompt 5526 is Yes 5528, then the combined final decision provided by DDC C512 at Final Decision Output 552 is submitted as modular output of TOC C513 and hence as modular output of the entire CTMP 124 instance as the Final Critical Decision 5542 output. If the response to Prompt 5526 is No 5530, then Stage 5532 is invoked which it itself invokes the execution of Perception Matching (PM) 5532 and fetches the corresponding results. Fulfilled Rules C517 are extracted from the Critical Decision+Meta-metadata C521 of Rule Execution (RE) C461. The Rules C517 are converted to Perceptions by Rule Syntax Derivation (RSD) C504. PM 5532 then references Meta-metadata to determine, at Prompt 5534, if there was a strong internal overlap and corroboration of Perceptions used. If the response to Prompt 5534 is Yes 5538 this indicates a Vote of No Confidence 5544 on behalf of CTMP 124 as modular output. If the response to Prompt 5534 is No 5536 then Stage 5540 is activated, which selects the perceived least risky decision between the Intuitive Decision C514 and Thinking Decision C515. Therefore the Final Critical Decision 5542 is subsequently submitted as modular output to CDO C462, TOC C513, and CTMP 124. The logic at Stage 5534 occurs to determine if the lack of unity between the Intuitive Decision C514 and Thinking Decision C515 occurs because of a general lack of algorithmic confidence, or due to highly opposing points of view between the two. Therefore if the latter were to occur, a potential Final Critical Decision 5542 is still discernible as modular output. A Vote of No Confidence 5544 always leads to the Low Confidence Result C845 logic pathway within Rational Appeal (RA) C811A. The Final Critical Decision 5542 can either lead to a High Confidence Result C846 or Low Confidence Result C845 logic pathway within RA C811A, depending on the algorithmic confidence behind the Final Critical Decision 6642.

FIG. 1063 continues the summary logic of CSE 12400 from FIGS. 1042 and 1043. The core part functionality of CSE 12400 as an algorithm resides in Stage 12402; where the primary invocations of LOM 132 and CTMP 124 are made. The completed execution of Stage 12402 produces the Ideal Investment Decision Makeup 12404. Subsequently, the Makeup 12404 is sent to Stage 12450 where it is stress tested and tweaked via I²GE 122. Stage 12450 invokes I²GE 122 to spawn various evolutionary pathways which emulate the performance of the Ideal Investment Decision Makeup 12404 in an environment defined by the variables: Tax Liability Knowledge 12368, Market Activity Knowledge 12348, Regulatory Compliance Knowledge 12370, and Corporate Operations Knowledge 12444. The results of the operation of Stage 12450 are sent to Prompt 12452, which discerns if the Ideal Investment Decision Makeup 12404 is able to pass stability requirements that are defined in Static Hardcoded Policy (SHP) 488. The two potential responses to Prompt 12452 are that the Ideal Investment Decision Makeup 12404 is Sufficiently Stable 12454 or Not Sufficiently Stable 12456. The Sufficiently Stable 12454 response leads to the eventual production of Refined Investment Decision Makeup 12458 as modular output for CSE 12400.

FIG. 1064 elaborates on the operation of Stage 12450 of CSE 12400. Initially Stage 12460 is executed which invokes LIZARD 120 to convert the Target Investment Circumstances 12160 into a Purpose Hierarchy Map 12462. The Map 12462 is subsequently forwarded to Stage 12464; which creates a blank Wholistic Situation State 12466. The State 12466 is a practical clone of the Map 12464 at this Stage 12464 of the logic flow, which is later referenced as a single variable to encapsulate the entire range of variables that define the ‘environment’ for which the Ideal Investment Decision Makeup 12458 is measured against via I²GE 122. At Stage 12468 LIZARD 120 is invoked to convert Market Activity Knowledge 12348 to a Purpose Hierarchy Map 12472. At Stage 12470 LIZARD 120 is invoked to convert Tax Liability Knowledge 12368 to a Purpose Hierarchy Map 12474.

FIG. 1065 shows details concerning the operation of LIZARD 120 to convert Target Investment Circumstances 12160 into a Purpose Hierarchy Map 12462. The Target Investment Circumstances 12160 are submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The Target Investment Circumstances 12160 are received in Knowledge Syntax 5620 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1066 continues the logic flow from FIG. 1065 to illustrate the operation of LIZARD 120 to convert Target Investment Circumstances 12160 Into a Purpose Hierarchy Map 12462. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 12462 which is presented as the Complex Purpose Format C325 version of the Target Investment Circumstances 12160. The same definition and application of Inner Core (IC) C333 applies for the aforementioned functions and modules.

FIG. 1067 shows details concerning the operation of LIZARD 120 to convert Market Activity Knowledge 12348 into a Purpose Hierarchy Map 12472. Market Activity Knowledge 12348 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. Market Activity Knowledge 12348 is received in Knowledge Syntax 5620 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C326 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1068 continues the logic flow from FIG. 1067 to illustrate the operation of LIZARD 120 to convert Market Activity Knowledge 12348 into a Purpose Hierarchy Map 12472. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 12472 which is presented as the Complex Purpose Format C325 version of the Market Activity Knowledge 12348. The same definition and application of Inner Core (IC) C333 applies for the aforementioned functions and modules.

FIG. 1069 continues the logic flow of Stage 12450 from CSE 12400. The logic continues from FIG. 1064 and is resumed at Stage 12470, which produces a Purpose Hierarchy Map 12474 from Tax Liability Knowledge 12368. At Stage 12476 LIZARD 120 is invoked to convert Regulatory Compliance Knowledge 12370 to a Purpose Hierarchy Map 12478. At Stage 12480 LIZARD 120 is invoked to convert Corporate Operations Knowledge 1244 to a Purpose Hierarchy Map 12482. Subsequently, Stage 12484 is executed which invokes the Purpose to Purpose Symmetry Processing (P2SP) 7000 to process the Wholistic Situation State 12466 and the Purpose Hierarchy Map 12472 of Market Activity Knowledge 12348. At this Stage 12484; Wholistic Situation State 12466 contains the equivalent contents of the Purpose Hierarchy Map 12462 of the Target Investment Circumstances 12160. The execution of P2SP 7000 produces a compatibility/congruency measurement of the two input variables.

FIG. 1070 shows details concerning the operation of LIZARD 120 to convert Tax Liability Knowledge 12368 into a Purpose Hierarchy Map 12474. Tax Liability Knowledge 12368 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. Tax Liability Knowledge 12368 is received in Knowledge Syntax 5620 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1071 continues the logic flow from FIG. 1070 to illustrate the operation of LIZARD 120 to convert Tax Liability Knowledge 12368 into a Purpose Hierarchy Map 12474. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 12474 which is presented as the Complex Purpose Format C325 version of Tax Liability Knowledge 12368. The same definition and application of Inner Core (IC) C333 applies for the aforementioned functions and modules.

FIG. 1072 shows details concerning the operation of LIZARD 120 to convert Regulatory Compliance Knowledge 12370 into a Purpose Hierarchy Map 12478. Regulatory Compliance Knowledge 12370 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. Regulatory Compliance Knowledge 12370 is received in Knowledge Syntax 5620 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1073 continues the logic flow from FIG. 1072 to illustrate the operation of LIZARD 120 to convert Regulatory Compliance Knowledge 12370 into a Purpose Hierarchy Map 12478. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 12478 which is presented as the Complex Purpose Format C325 version of Regulatory Compliance Knowledge 12370. The same definition and application of Inner Core (IC) C333 applies for the aforementioned functions and modules.

FIG. 1074 shows details concerning the operation of LIZARD 120 to convert Corporate Operations Knowledge 12444 into a Purpose Hierarchy Map 12482. Corporate Operations Knowledge 12444 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. Regulatory Compliance Knowledge 12370 is received in Knowledge Syntax 5620 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1075 continues the logic flow from FIG. 1074 to illustrate the operation of LIZARD 120 to convert Corporate Operations Knowledge 12444 into a Purpose Hierarchy Map 12482. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 12478 which is presented as the Complex Purpose Format C325 version of Corporate Operations Knowledge 12444. The same definition and application of Inner Core (IC) C333 applies for the aforementioned functions and modules.

FIG. 1076 continues the logic flow of Stage 12450 from CSE 12400. The logic continues from FIG. 1069 and is resumed at Stage 12484. Stage 12484 invokes P2SP 7000 to produce a Symmetry Processing Result 12486 which corresponds with the two inputs Wholistic Situation State 12466 and the Purpose Hierarchy Map 12472 of Market Activity Knowledge 12348. The Symmetry Processing Result 12486 is sent to Prompt 12488, which evaluates if the Purpose Hierarchy Map 12472 of Market Activity Knowledge 12348 is congruent/compatible with the Wholistic Situation State 12466. The expected result by the system is that they are congruent, because the variables defined in the Target Investment Circumstances 12160 should not contain any incompatibilities with Market Activity Knowledge 12348. Target Investment Circumstances 12160 is referenced because at Stage 12484 it is identical in contents to the Wholistic Situation State 12466. Continued execution of Stage 12450 requires Market Activity Knowledge 12348 to not contain variables that contradict established variables of Target Investment Circumstances 12160. This is because Market Activity Knowledge 12348 is categorically an element of the circumstances which influence the ideal investment behavior/response. Therefore if the response to Prompt 12488 is Not Congruent 12492, then Diagnostic Log Submission (DLS) 1160 is invoked with a Diagnostic Log Unit (DLU) 1182 which acts as an Error Report Submission. If the response to Prompt 12488 is considered Congruent 12490, then Stage 12496 is invoked which adjusts the Wholistic Situation State 12466 to match the Purpose Hierarchy Map 12472 of Market Activity Knowledge 12348 via Purpose Realignment Processing (PRP) 7050. The Master/Slave Affinity 12494 is supplied to Stage 12496 to define the Wholistic Situation State 12466 as the Master and the Purpose Hierarchy Map 12472 of the Market Activity Knowledge 12348 is treated as the slave. This implies that any differential changes to be made between the two inputs 12466 and 12472 are carried over to the Wholistic Situation State 12466, which is then submitted as the resultant output of Stage 12496. Therefore the Wholistic Situation State 12466 is carried over to FIG. 1077 and subsequently processed by Stage 12500.

FIG. 1077 continues the logic flow of Stage 12450 from CSE 12400. The logic continues from FIG. 1076 and is resumed at Stage 12500. Stage 12500 invokes P2SP 7000 to produce a Symmetry Processing Result 12502 which corresponds with the two inputs Wholistic Situation State 12466 and the Purpose Hierarchy Map 12474 of Tax Liability Knowledge 12368. The Symmetry Processing Result 12502 is sent to Prompt 12504, which evaluates if the Purpose Hierarchy Map 12474 of Tax Liability Knowledge 12368 is congruent/compatible with the Wholistic Situation State 12466. The expected result by the system is that they are congruent, because the variables defined in the Target Investment Circumstances 12160 and Market Activity Knowledge 12348 should not contain any incompatibilities with Tax Liability Knowledge 12368. Target Investment Circumstances 12160 and Market Activity Knowledge 12348 are referenced because at Stage 12500 they are contained and represented in the contents of the Wholistic Situation State 12466. Continued execution of Stage 12450 requires Tax Liability Knowledge 12368 to not contain variables that contradict established variables of Target Investment Circumstances 12160. This is because Tax Liability Knowledge 12368 is categorically an element of the circumstances which influence the ideal investment behavior/response. Therefore if the response to Prompt 12504 is Not Congruent 12508, then Diagnostic Log Submission (DLS) 1160 is invoked with a Diagnostic Log Unit (DLU) 1182 which acts as an Error Report Submission. If the response to Prompt 12504 is considered Congruent 12506, then Stage 12512 is invoked which adjusts the Wholistic Situation State 12466 to match the Purpose Hierarchy Map 12474 of Tax Liability Knowledge 12368 via Purpose Realignment Processing (PRP) 7050. The Master/Slave Affinity 12510 is supplied to Stage 12496 to define the Wholistic Situation State 12466 as the Master and the Purpose Hierarchy Map 12474 of the Tax Liability Knowledge 12368 is treated as the slave. This implies that any differential changes to be made between the two inputs 12466 and 12474 are carried over to the Wholistic Situation State 12466, which is then submitted as the resultant output of Stage 12512. Therefore the Wholistic Situation State 12466 is carried over to FIG. 1078 and subsequently processed by Stage 12520.

FIG. 1078 continues the logic flow of Stage 12450 from CSE 12400. The logic continues from FIG. 1077 and is resumed at Stage 12500. Stage 12500 invokes P2SP 7000 to produce a Symmetry Processing Result 12522 which corresponds with the two inputs Wholistic Situation State 12466 and the Purpose Hierarchy Map 12478 of Regulatory Compliance Knowledge 12370. The Symmetry Processing Result 12522 is sent to Prompt 12524, which evaluates if the Purpose Hierarchy Map 12478 of Regulatory Compliance Knowledge 12370 is congruent/compatible with the Wholistic Situation State 12466. The expected result by the system is that they are congruent, because the variables defined in the Target Investment Circumstances 12160, Market Activity Knowledge 12348 and Tax Liability Knowledge 12368 should not contain any incompatibilities with Regulatory Compliance Knowledge 12370. Target Investment Circumstances 12160, Market Activity Knowledge 12348 and Tax Liability Knowledge 12368 are referenced because at Stage 12520 they are contained and represented in the contents of the Wholistic Situation State 12466. Continued execution of Stage 12450 requires Regulatory Compliance Knowledge 12370 to not contain variables that contradict established variables of Target Investment Circumstances 12160. This is because Regulatory Compliance Knowledge 12370 is categorically an element of the circumstances which influence the ideal investment behavior/response. Therefore if the response to Prompt 12524 is Not Congruent 12528, then Diagnostic Log Submission (DLS) 1160 is invoked with a Diagnostic Log Unit (DLU) 1182 which acts as an Error Report Submission. If the response to Prompt 12524 is considered Congruent 12526, then Stage 12532 is invoked which adjusts the Wholistic Situation State 12466 to match the Purpose Hierarchy Map 12478 of Regulatory Compliance Knowledge 12370 via Purpose Realignment Processing (PRP) 7050. The Master/Slave Affinity 12530 is supplied to Stage 12532 to define the Wholistic Situation State 12466 as the Master and the Purpose Hierarchy Map 12478 of the Regulatory Compliance Knowledge 12370 is treated as the slave. This implies that any differential changes to be made between the two inputs 12466 and 12478 are carried over to the Wholistic Situation State 12466, which is then submitted as the resultant output of Stage 12532. Therefore the Wholistic Situation State 12466 is carried over to FIG. 1079 and subsequently processed by Stage 12540.

FIG. 1079 continues the logic flow of Stage 12450 from CSE 12400. The logic continues from FIG. 1078 and is resumed at Stage 12540. Stage 12540 invokes P2SP 7000 to produce a Symmetry Processing Result 12542 which corresponds with the two inputs Wholistic Situation State 12466 and the Purpose Hierarchy Map 12482 of Corporate Operations Knowledge 12444. The Symmetry Processing Result 12542 is sent to Prompt 12544, which evaluates if the Purpose Hierarchy Map 12482 of Corporate Operations Knowledge 12444 is congruent/compatible with the Wholistic Situation State 12466. The expected result by the system is that they are congruent, because the variables defined in the Target Investment Circumstances 12160, Market Activity Knowledge 12348, Tax Liability Knowledge 12368 and Regulatory Compliance Knowledge 12370 should not contain any incompatibilities with Corporate Operations Knowledge 12444. Target Investment Circumstances 12160, Market Activity Knowledge 12348, Tax Liability Knowledge 12368, and Regulatory Compliance Knowledge 12370 are referenced because at Stage 12540 they are contained and represented in the contents of the Wholistic Situation State 12466. Continued execution of Stage 12450 requires Corporate Operations Knowledge 12444 to not contain variables that contradict established variables of Target Investment Circumstances 12160. This is because Corporate Operations Knowledge 12444 is categorically an element of the circumstances which influence the ideal investment behavior/response. Therefore if the response to Prompt 12544 is Not Congruent 12548, then Diagnostic Log Submission (DLS) 1160 is invoked with a Diagnostic Log Unit (DLU) 1182 which acts as an Error Report Submission. If the response to Prompt 12544 is considered Congruent 12546, then Stage 12552 is invoked which adjusts the Wholistic Situation State 12466 to match the Purpose Hierarchy Map 12482 of Corporate Operations Knowledge 12444 via Purpose Realignment Processing (PRP) 7050. The Master/Slave Affinity 12550 is supplied to Stage 12552 to define the Wholistic Situation State 12466 as the Master and the Purpose Hierarchy Map 12482 of the Corporate Operations Knowledge 12444 is treated as the slave. This implies that any differential changes to be made between the two inputs 12466 and 12482 are carried over to the Wholistic Situation State 12466, which is then submitted as the resultant output of Stage 12552. Therefore the Wholistic Situation State 12466 is carried over to FIG. 1080 and subsequently processed by Stage 12554.

FIG. 1080 continues the logic flow of Stage 12450 from CSE 12400. The Wholistic Situation State 12466 is received by Stage 12552 of FIG. 1079. Therefore Stage 12554 supplies the State 12466 to Need Map Matching (NMM) C114, which is a submodule that exists in the Dynamic Shell (DS) C198 of LIZARD 120. NMM C114 dissects the State 12466 into jurisdictional branches which categorize the various elements found within the State 12466. Therefore Stage 12556 invokes Artificial Security Threat (AST) 123 to make reference to potential scenarios as defined by the jurisdictional branches formed within the corresponding NMM C114 instance. Thereafter at Stage 12558 the results of AST's 123 processing is that the scenarios defined by the NMM C114 jurisdictional branches are creatively varied via the Creativity Module 112.

FIG. 1081 shows the operation and functionality of Need Map Matching (NMM) C114 operating as a submodule of LIZARD's 120 Dynamic Shell C198. The NMM C114 instance is spawned to serve the operation of Stage 12450 of the Comprehensive State Evaluation (CSE) 12400. The Wholistic Situation State 12466 is submitted for storage in Need Access and Development and Storage 5550. Therefore the Wholistic Situation State 12466 is broken down into sub-categories and retained in Storage 5550 as a series of hierarchal branches and layers. Upon the modular invocation of NMM C114, Initial Parsing C148 downloads each jurisdiction branch from Storage 5550 to temporarily retain for referencing within the ongoing NMM C114 instance. With Calculate Branch Needs C149: according to definitions associated with each branch, needs are associated with their corresponding department. This way, permission checks can be formed within the NMM C114 instance. For example: NMM C114 approved the request for the Human Resources department to download all employee CVs, because it was requested within the zone of the annual review of employee performance according to their capabilities. Therefore it was proven to be a valid need of the department jurisdiction. Therefore Need Index C145 is the main storage of Jurisdiction Branches and their respective needs. Because this internal reference is a resource bottleneck for the operation of NMM C114 and therefore all the modules it serves, it is pre-optimized for quick database querying to increase the overall efficiency of the system. The Artificial Security Threat (AST) 123 provides an Input Purpose C139 as modular input to the Search Algorithm C144 of NMM C114. The Search Algorithm C144 references and searches through the compiled Need Index C145, therefore determining if the Input Purpose C139 defines a valid need according to the jurisdiction branches initially defined in Need Access Development and Storage 5550. Therefore the completed execution of the Search Algorithm C144 via the Need Index C145 produces an Approve/Block C146 response which is submitted as modular output from NMM C114 and referenced as the Need Result C141. Therefore the Need Result C141 is returned back to AST 123 in response to it's Input Purpose C139 submission.

FIG. 1082 continues the logic flow of Stage 12450 from CSE 12400. The logic is resumed at Stage 12558. Subsequently, Stage 12560 is executed which receives the Ideal Investment Decision Makeup 12404 as modular input. The Makeup 12404 is interpreted by Input Creative Variance (ICV) 12405 to create slight Variations 12562 in whatever scope of ambiguity may exist in the set of variables that define the Makeup 12404. Therefore the produced Makeup Variations 12562 are sent to Stage 12564 so that they can be used as Pathway Personalities C867D with corresponding Evolution Pathways C867A that are emulated by I²GE 122.

FIG. 1083 expands on Stage 12564 from CSE 12400. Part of the logic flow from FIG. 1082 is summarized here, to show Ideal Investment Decision Makeup 12404 getting processed by ICV 12405 to produce Makeup Variations 12562. The Variations 12562 are logistically unpacked at Stage 12565, which implies that any layers of encryption, compression, and optimization are reversed to enable execution access. Thereafter at Stage 12566; the Makeup Variations 12562 are installed as Pathway Personalities C867DA/C867DB via the Monitoring Interaction System C868D. The Monitoring Interaction System C868D acts as an API layer for external functions to watch and manipulate the emulation performed by I²GE 122. The installed Variations 12562 each correlate to an individual Pathway Personality C867D which defines the direction the Evolution Pathway C867A evolves in. Therefore, due to the multiple Variations 12562, it is probabilistically expected that at least one of the Evolution Pathways C867A will successfully achieve the makeup that is sought by the system. The specific makeup that is sought in this specific instance is a Variation 12562 of the Ideal Investment Decision Makeup 12404 that is most compatible with the provided NMM C114 jurisdictional branches of the Wholistic Situation State 12466. Independent instances of Evolution Pathways C867A are separated by Virtual Isolation 390, which guarantees data independence and an absence of cross-contamination. Therefore the result is logistically guaranteed to be a derivative of the corresponding Pathway Personality C867D.

FIG. 1084 continues the logic flow that was provided on FIG. 1083, yet in context of Stage 12450 from CSE 12400. The same logic concerning I²GE 122 is shown, yet with the Monitoring Interaction System C868D providing production output concerning the results of the Evolution Pathway C867A emulation to the Iteration Conclusion Processor 5554. The Processor 5554 reaches meaningful conclusions concerning the results of the I²GE 122 emulation, hence leading to the Prompt 12568 which checks if the Ideal Investment Decision Makeup 12404 was to able to pass stability requirements defined in Static Hardcoded Processing (SHP) 488. The two potential conclusions/responses that could have been considered by the Iteration Conclusion Processor 5554 are Sufficiently Stable 12570 and Not Sufficiently Stable 12572.

FIG. 1085 elaborates on the logic flow shown in FIG. 1084, by showing specific generational iterations of the Ideal Investment Decision Makeup 12404 being iterated within a single Evolution Pathway C867A. Therefore the Pathway C867A conforms to the metrics defined in the Pathway Personality C867D. Hence the evolutionary direction is defined. The Pathway Designation 12407 determines the state of any given Evolution Pathway C867A. Such states can be designated as Passed as Stable, Pending Evolution, or Abandoned/Deleted.

FIG. 1086 continues the main logic flow of CSE 12400, which resume from Prompt 12568. Stage 12450 is the main Stage that invokes I²GE 122, which leads to Prompt 12568. If the response to Prompt 12568 is that the emulation was Not Sufficiently Stable 12584, then I²GE 122 receives the response code at will most likely, at it's discretion, rerun the emulation with a variance of variables that define a distinction with the previous failed emulation. If the response to the Prompt 12568 is Sufficiently Stable 12582; then Stage 12586 is invoked which produces the emulation results as the Refined Investment Decision Makeup 12458. Thereafter at Stage 12588 the Refined Investment Decision Makeup 12458 is logistically unpacked to produce it's individual elements: Investment Allocations 12592, Investment Withdrawals 12594, Profit Allocations 12596, and Director Notification 12598.

FIG. 1087 shows a final overview summary of the Comprehensive State Evaluation (CSE) 12400. The Preliminary Thread Initiation (PTI) 12080 module initiates an instance of the Target Investment Circumstances Interpretation (TICI) 12380. TICI 12380 produces the Target Investment Circumstances 12160 to the Internal Processing 12600 mechanism of CSE 12400. The entire processing of CSE 12400 leads to Stage 12602, which unpacks the Refined Investment Decision Makeup 12458 to it's individual elements listed in Section 12590. Investment Allocations 12592 indicates which corporations the requesting Endowment Structure (ES) 12008 should invest in. Investment Withdrawals 12594 indicates what pre-existing investments of the specified Endowment Structure (ES) 12008 should be withdrawn. Such pre-existing investments are initially defined by the Portfolio Stake Makeup 12384 which is extracted from the relevant Portfolio Stake Retention (PSR) 12003 instance. Therefore the Stake Makeup 12384 gets assimilated into the Target Investment Circumstances 12160 which is received and considered by CSE 12400. Profit Allocations 12596 indicates where should profits from such corporations be withdrawn to (i.e. into the relevant Investment Capital (IC) 12012 instance, or directly to the private funds of a relevant Director 12006/12022 etc). Director Notification 12598 indicates that a message is sent to the intended Director 12006/12022 recipient to recommend certain investment actions to perform that may be too complex or in excess of permission for Investment Decision Actuation (IDA) 12604 to perform directly. Therefore IDA 12604 executes the provided Individual Elements 12590 to perform the intended consequences towards the relevant Endowment Structure (ES) 12008 instance; Board of Directors (BD) 12018 or Independent Director (ID) 12020.

FIGS. 1088-1115 show the operation and functionality of Digital Mind Tracking (DMT) 12700, which emulates the ‘perceptions’ and ‘thoughts’ of a digital reaction mechanism that poses to emulate specified human targets.

FIG. 1088 shows details concerning the operation of Digital Mind Tracking (DMT) 12700. The Target Behavior Recording (TBR) 12704 module receives Behavior Data Set (BDS) 12706 information directly from the specified Target Mind 12702, and also neurological mapping associations made by the Neurologic Mapping Enhancement (NME) 13090 module. The BDS 12706 contains information concerning Actions 12708, Statements 12710 and Metadata 12712 concerning the Target Mind 12702. The BDS 12706 instance is supplied as modular input to DMT 12700 and received at Stage 12714. Stage 12714 leads to Stage 12718 where the BDS 12706 information is normalized via LIZARD 120 which converts it from it's syntax format to purpose format. Therefore a Behavior Purpose Map 12720 is constructed from the BDS 12706 instance via modular execution of LIZARD 120. Thereafter at Stage 12722 the Behavior Purpose Map 12720 is stored and retained in a Personal Intelligence Profile (PIP) 136 instance that is logistically associated with the Target Mind 12702. Thereafter LOM 132 is invoked at Stage 12724 to produce Personality Template Types 12726, which are collections that classify various type of human personalities with complex psychological definitions (e.g. introverted, judgmental, cynical, narcissistic etc).

FIG. 1089 expands on the operational details concerning Stage 12724 of Digital Mind Tracking (DMT) 12700 which defines LOM 132 and it's sub-modules (as Appchains 836) being invoked to produce Personality Template Types 12724. The logic flow initiates at Stage 12728 which describes LOM 132 regularly invoking the Automated Research Mechanism (ARM) 134 to research personality types via it's sources (e.g. psychology research papers etc). At Stage 12730 the resultant research information produced by ARM 134 is stored in Central Knowledge Retention (CKR) 648 as unconfirmed knowledge. Thereafter Stage 12732 is executed, where LOM 132 and CTMP 124 extract meaningful assertions and conclusions concerning Personality Types from unconfirmed knowledge stored in CKR 648 (that was submitted at Stage 12730). When LOM 132 and CTMP 124 conclude their analysis on the unconfirmed knowledge, any meaningful assertions and conclusions are submitted for retention in CKR 648. Subsequently, Stage 12734 is invoked to produce Personality Template Types 12726 from CKR 648 which represents the meaningful assertions and conclusions derived at Stage 12732.

FIG. 1090 continues the logic flow of Digital Mind Tracking (DMT) 12700 from FIG. 1088. After LOM 132 produces Personality Template Types 12726 at Stage 12724, Stage 12736 is invoked to produce a Personality Template Makeup 12738 from the Personality Template Fulfillment (PTF) 12760. A Personality Template Makeup 12738 captures personality elements that exists from Personality Template Types 12726 according to the Personality Template Criteria 12752 of the Target Mind 12702. At Stage 12742 LOM 132 is invoked to produce the Personality Nuance Definition that corresponds with the Target Mind 12702 from the corresponding PIP 136 instance.

FIG. 1091 elaborates on the operational details of Stage 12736 from Digital Mind Tracking (DMT) 12700. At Stage 12734 LOM 132 is invoked to produce Personality Template Types 12726 from CKR 648. This leads to Stage 12750 being invoked, where the Personality Template Criteria 12752 of the Target Mind is produced from the corresponding PIP 136 instance via LOM 132. The Personality Template Criteria 12752 represents individual data concerning the Target Mind that have potential to activate certain Personality Template 12726 classifications which would enable the production of a Personality Template Makeup 12738.

FIG. 1092 shows details concerning Stage 12734 of DMT 12700, where LOM 132 produces Personality Template Types 12726 from CKR 648. LOM 132 is invoked to produce such Knowledge 12370 by the Personality Template Invocation Prompt (PTIP) 12754 module. Regulatory Compliance Knowledge 12370 is illustrated as being built of multiple instances of UKF Clusters C854F. The individual element of the UKF Cluster C854F is elaborated in detail as being made of UKF1, UKF2, and UKF3 sub-units that are stored in Rule Syntax Format C538.

FIG. 1093 elaborates on the operation of Personality Template Fulfillment (PTF) 12760 within Stage 12736 of DMT 12700. At Stage 12750 the Personality Template Criteria 12752 of the Target Mind 12702 is produced from the corresponding PIP 136 instance LOM 132. Thereafter Stage 12756 is executed which invokes PTF 12760 to fulfill the definitions from Personality Template Criteria 12752 with Personality Template Types 12726. Therefore PTF 12760 is invoked at Stage 12762 which initiates a Loop to cycle through each of the Personality Template Criteria 12752. The Selected Personality Template Criteria 12764 from the Loop Iteration is processed by Stage 12766 which retrieves the corresponding Personality Template Types 12726 according to the Personality Template Types 12726 that are referenced within the Selected Personality Template Criteria 12764. Therefore the Selected Personality Template Type 12768 is produced from Stage 12766. At Stage 12770 the Selected Personality Template Type 12768 is assigned according the Magnitude of presence defined in the Selected Personality Template Criteria 12764. Therefore such assignments cause Stage 12770 to produce the Personality Template Makeup 12738.

FIG. 1094 continues the logic flow of Personality Template Fulfillment (PTF) 12760 from FIG. 1093. Stage 12770 produces Personality Template Makeup 12738 as modular output by processing two modular inputs: Selected Personality Template Criteria 12764 and Selected Personality Template Type 12768. Prompt 12772 is subsequently processed, which checks if there are any unprocessed units left from the Personality Template Criteria 12752 from the Loop that was initiated at Stage 12762. If the response to the Prompt 12772 is No 12776, then Stage 12780 is activated which submits the Personality Template Makeup 12738 as modular output for PTF 12760. Stage 12756 is the original invoker of PTF 12760 that caused Personality Template Makeup 12738 to be produced.

FIG. 1095 continues the main logic flow of Digital Mind Tracking (DMT) 12700, and resumes from FIG. 1090 At Stage 12742. The Personality Nuance Definition 12744 is produced from Stage 12742 and transferred to Stage 12784, which invokes LIZARD 120 to convert the Personality Nuance Definition 12744 into a Purpose Hierarchy Map 12786, At Stage 12788 LIZARD converts the Personality Template Makeup 12738 into a Purpose Hierarchy Map 12790. At Stage 12792 both Purpose Hierarchy Maps 12790 and 12786 are processed by the Purpose to Purpose Symmetry Processing (P2SP) 7000 module at Stage 12792. P2SP 7000 determines the congruency/compatibility between both inputs, therefore producing the Symmetry Processing Result 12794.

FIG. 1096 shows details concerning the operation of LIZARD 120 to convert Personality Nuance Definition 12744 into a Purpose Hierarchy Map 12786. Personality Nuance Definition 12744 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. Personality Nuance Definition 12744 is received in State Syntax 5624 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1097 continues the logic flow from FIG. 1096 to illustrate the operation of LIZARD 120 to convert Personality Nuance Definition 12744 into a Purpose Hierarchy Map 12786. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 12786 which is presented as the Complex Purpose Format C325 version of Personality Nuance Definition 12744. The same definition and application of Inner Core (IC) C333 applies for the aforementioned functions and modules.

FIG. 1098 shows details concerning the operation of LIZARD 120 to convert Personality Template Makeup 12738 into a Purpose Hierarchy Map 12790. Personality Nuance Definition 12744 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. Personality Nuance Definition 12744 is received in State Syntax 5624 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1099 continues the logic flow from FIG. 1098 to illustrate the operation of LIZARD 120 to convert Personality Template Makeup 12738 into a Purpose Hierarchy Map 12790. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 12490 which is presented as the Complex Purpose Format C325 version of Personality Template Makeup 12738. The same definition and application of Inner Core (IC) C333 applies for the aforementioned functions and modules.

FIG. 1100 continues the logic flow from FIG. 1095 concerning the operation of the invoked Purpose to Purpose Symmetry Processing (P2SP) 7000 instance to process the Purpose Hierarchy Map 12790 of the Personality Template Makeup 12738 and the Purpose Hierarchy Map 12786 of the Personality Nuance Definition 12744. After Stage 12792 completes it's operational process, Prompt 12796 checks if Map 12790 is congruent and compatible with the Map 12786. If the response to Prompt 12796 is Yes, Congruent 12798, then Stage 12802 is invoked which produces the Personality Purpose Map 12804 as a clone of the Purpose Hierarchy Map 12790 of the Personality Template Makeup 12738. This is done because it is perceived that the Purpose Hierarchy Map 12786 of the Personality Nuance Definition 12744 would not contribute any meaningful information to the Personality Purpose Map 12804 due to the high degree of congruency/compatibility between both Maps 12790/12786. If the response to Prompt 12796 is No, not Congruent 12800, then the Purpose Realignment Processing (PRP) 7050 module is invoked to produce the Personality Purpose Map 12804 (as shown on FIG. 1101).

FIG. 1101 elaborates on the logic flow of FIG. 1100 concerning the No, Not Congruent 12800 response of Prompt 12796. Stage 12806 invokes Purpose Realignment Processing (PRP) 7050 to adjust the Purpose Hierarchy Map 12790 of the Personality Template Makeup 12738 to match the Purpose Hierarchy Map 12786 of the Personality Nuance Definition 12744. Therefore any elements that are represented in Map 12786 are inserted into Map 12790. The result of Stage 12806 is processed at Stage 12808 to produce the Personality Purpose Map 12804. At Stage 12810 LIZARD converts the Personality Purpose Map 12804 into Personality Reactionary Syntax which is referenced as the Personality Reaction System 12812.

FIG. 1102 shows details concerning the operation of LIZARD 120 to convert Personality Purpose Map 12804 into Personality Reaction Syntax. The Map 12804 exists in Complex Purpose Format C325 and is submitted to Iterative Expansion C327 of the Purpose Module C36 within the Outer Core (OC) C329 of LIZARD 120. Iterative Expansion C327 adds detail and complexity to evolve a simple goal (indirectly defined within the Map 12804) into a specific complex purpose definition. Therefore the maximum Purpose Association C326 potential of the input is realized, and retained as a Complex Purpose Format C325, before it is submitted to Logical Derivation C320 of the Syntax Module (SM) C35. The Core Code C335 element of Inner Core (IC) C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1103 continues the logic flow from FIG. 1102 to illustrate the operation of LIZARD 120 to convert Personality Purpose Map 12804 into Personality Reaction Syntax that is referenced as the Personality Reaction System 12812. The input data is received in Complex Purpose Format C325 from the Purpose Module (PM) C36 and is transferred to Logical Derivation C320 of the Syntax Module (SM) C35. Logic Derivation C320 derives logically necessary functions from initially simpler functions. This means that if a function can be formed as a derivative function due to implication from a simpler parent function; then it is formed by Logical Derivation C320. The produced result is a tree of function dependencies that are built according to the defined Complex Purpose Format C325 data. Logical Derivation C320 operates according to the Rules and Syntax C322 definitions which are inherited from the Core Code C335 element of Inner Core (IC) C333. Logical Derivation C320 submits it's output to Code Translation C321. Code Translation C321 converts arbitrary (generic) code which is recognized and understood by SM C35 to any known and chosen computation language. Code Translation C321 also performs the inverse function of translating known computation languages into arbitrary syntax types. Therefore PM C36 invokes SM C35 to produce the resultant Appchain Syntax Version 12184 of the input Active Override Measures 12170 via Code Translation C321. The resultant Personality Reaction Syntax Version 12812 that is terminally produced by Code Translation C321 is the modular output of SM C35, Outer Core (OC) C329, and LIZARD 120.

FIG. 1104 shows the operation and logic flow of Digital Mind Tracking (DMT) 12700 being resumed at Stage 12810 from FIG. 1101. After Stage 12810 produces the Personality Reaction System 12812 via LIZARD 120, Stage 12814 is invoked to retrieve the Target Mind Identity 12816 of the Target Mind 12702. Stage 12818 retrieves the Personality Snapshot Cache Retention (PSCR) 12822 instance which is associated with the Target Mind Identity 12816. Prompt 12820 checks if there is a previous iteration of the Personality Reaction System 12812 that is stored in the PSCR 12822 instance that matches the Defined Time Era. The Defined Time Era is referenced from the Target Mind Identity 12816, as it defines the time period which represents the composition on the Target Mind. For example: people typically undergo changes of maturity, understanding, experience, and personality throughout their life. This way the Defined Time Era can make distinctions between older and newer versions of people as they were. If the response to Prompt 12820 is Yes 12824, then Stage 12828 is activated which deletes the previous iteration of the Personality Reaction System 12812 from the PSCR 12822 instance. This way there is only one PSCR 12822 per Defined Time Era. Stage 12828 and response No 12826 to the Prompt 12820 both lead to the activation of Stage 12830, which converts stores and retains the current Personality Reaction System 12812 into the PSCR 12822 instance that is associated with the Target Mind 12702 of the Defined Time Era according to the Target Mind Identity 12816.

FIG. 1105 elaborates on Stage 12830 of DMT 12700, which converts the Personality Reaction System 12812 and stores it in the corresponding PSCR 12822 instance. At Stage 12832 a Customized Command Set 12834 is submitted to ESR 6400 which instructs it to extract the Appchain 836 contents of CTMP 124 without any pre-existing data. At Stage 12836 an Empty CTMP Execution Base 12838 is produced, which is a snapshot capture of the ESR 6400 instance. Because the CTMP 124 instance within the ESR 6400 instance has not yet processed nor retained any data, the snapshot is considered ‘empty’. At Stage 12840 the Empty CTMP Execution Base 12838 is rendered in a new instance of ESR 6400. Hence Stage 12840 performs the inverse function of Stage 12836. At Stage 12844 the rendered Custom CTMP Appchain 12842 interacts with the Personality Reaction System 12812, therefore effectively capturing the Personality of the Target Mind 12702 in the Custom CTMP instance 12842.

FIG. 1106 continues the logic flow of Stage 12830 of DMT 12700 from FIG. 1105. After Stage 12844 has finished processing, a Customized Command Set 12834 is submitted as an instruction to the ESR 6400 instance to commit all changes to persistent storage. The Customized Command Set 12834 instruction contains the Persistent Write Data Segment 6422 Command Type 6408. Once ESR 6400 has processed the Persistent Write Data Segment 6422 Commands 12834, the Custom CTMP Instance 12842 is effectively captured to a CTMP Snapshot Appchain Retention 12850 file.

FIG. 1107 elaborates on the operational details of Stage 12846 of Digital Mind Tracking (DMT) 12700. The Personality Reaction System 12812 is transferred to Stage 12852 as modular input, which produces a set of Relevant Emulation Scenarios 12854 via the Emulation Scenario Production (ESP) 12856. ESP 12856 produces Relevant Emulation Scenarios 12854 that are relevant towards the scope, jurisdiction and capabilities of the Personality Reaction System 12812. For example, a personality with an electrical engineering background would derive scenarios concerning house electric wiring etc. At Stage 12858 a Loop is initiated which iterates through the Relevant Emulation Scenarios 12854, hence producing a single unit Selected Emulation Scenario 12860 per iteration of the Loop. At Stage 12862 the Selected Emulation Scenario 12860 is unpacked to produce the two main variables it contains: the Emulation Proposition 12864 and the Emulation Environment 12866. Emulation Proposition 12864 acts as a scenario assertion, for example: the electrical socket in a wall might not be properly grounded. Emulation Environment 12866 defines variables which may affect the reaction of the Custom CTMP 12842 instance relating to the Personality Reaction System 12812, such as the time and location of the event.

FIG. 1108 continues the logic flow from FIG. 1107, which details the operation of Stage 12846 of DMT 12700. Stage 12862 unpacks the Emulation Proposition 12864 and Emulation Environment 12866 from the Selected Emulation Scenario 12860. At Stage 12868 the Emulation Proposition 12864 is submitted to the Custom CTMP 12842 instance as Input System Metadata C484. This indicates that the Emulation Proposition 12864 is submitted as modular input to the Custom CTMP 12842 instance with the Subjective Opinion classification. Stage 12870 submits the Emulation Environment 12866 as Logs to the Custom CTMP 12842 instance with the Objective Fact classification. Therefore the two primary modular inputs of the CTMP 124 specification have been been fulfilled for this Custom CTMP 12842 instance, which allows for it to enact critical thinking towards the input and output what is classified as Objective Fact.

FIG. 1109 continues the logic flow from FIG. 1108, illustrating the two modular inputs for the Custom CTMP 12842 instance while also showing the two major branches for the CTMP 124 operation: Rule Execution (RE) C461 (Logical thinking) and Perception Observer Emulator (POE) C475 (Intuitive thinking). At this stage of operation the Custom CTMP 12842 instance is operating without bias nor affinity towards the corresponding Personality Reaction System 12812. Critical Decision Output (CDO) C462 processes both Branches C461/C475 of the CTMP 124 specification. The aspect of highlight for this figure is that the Angles of Perception C473/C472/C471/C470 enable both Branches C461/C475 of the CTMP 124 specification.

FIG. 1110 continues the logic flow from FIG. 1109, therefore elaborating on the details concerning the operation of Stage 12846 of DMT 12700. The Custom CTMP 12842 instance operates within an Execution Stream Rendering (ESR) 6400 instance, therefore producing the CTMP Decision Result 12874 as modular output. Both modular inputs to the Custom CTMP 12842 instance are represented in Stages 12868 (Emulation Proposition 12864) and 12870 (Emulation Environment 12866). Both Stages 12868 and 12870 lead to the actualization and completion of Stage 12872, which represents the internal execution of Critical Decision Output (CDO) C462 to produce the CTMP Decision Result 12874. Thereafter Stage 12876 is executed which unpacks the corresponding Selected Emulation Scenario 12878 instance to produce the defined Acceptable Result Scope 12880. This Scope 12880 defines a range, with an upper and lower bound, to what CTMP Decision Result 12874 would be considered compatible with the personality of the corresponding Personality Reaction System 12812. Therefore Prompt 12882 is activated which checks if the CTMP Decision Result 12882 belongs within the Acceptable Result Scope 12880.

FIG. 1111 continues the logic flow from FIG. 1110, therefore elaborating on the details concerning the operation of Stage 12846 of DMT 12700. A Yes 12884 response to Prompt 12882 leads to Stage 12888 being executed. Stage 12888 commits the Angles of Perception C473/C472/C471/C470 instance of the Custom CTMP 12842 instance to persistent storage via the ESR 6400 Persistent Write Data Segment 6422 Command Type 6408. This causes any CTMP 124 specification perceptions that are associated and compatible with the Personality Reaction System 12812 to be retained permanently within the Custom CTMP 124 instance. If the response to Prompt 12882 is No 12886 then the corresponding perceptions from the Angles of Perception C473/C472/C471/C470 instance of the Custom CTMP 12842 are deleted via the ESR 6400 Session Delete Data Segment 6424 Command Type 6408. Therefore any CTMP 124 specification perceptions that not confirm via compatibility measures with the Personality Reaction System 12812 are deleted and hence not retained in the Custom CTMP 12842 instance.

FIG. 1112 continues the logic flow from FIG. 1111, therefore elaborating on the details concerning the operation of Stage 12846 of DMT 12700. If Stage 12890 occurs, then Stage 5602 also occurs which submits a Diagnostic Log Unit (DLU) 1182 to the Diagnostic Log Submission (DLS) 1160 module. This allows for the SPSI module to make potential modifications to the structure and operation of DMT 12700 and/or CTMP 124 to enable more efficient functionality and result production in future instances of the programs. Both Stage 12888 and 12890 invoke Prompt 12892, which checks if there are any Relevant Emulation Scenarios 12854 left in the Loop initiated by Stage 12858. If the response to Prompt 12892 is Yes 12894, then Stage 12898 is invoked which iterates the Loop of Stage 12858 to the next available Selected Emulation Scenario 12860. If the response to prompt 12892 is No 12896, then Stage 12900 is activated which terminates the Loop sequence of Stage 12858. Therefore activation of Stage 12900 implies the conclusion of the operation of Stage 12846.

FIG. 1113 elaborates on the functionality and operation of Stage 12830 of DMT 12700. Stage 12902 submits a Customized Command Set 12904 to the corresponding ESR 6400 instance which records the active Custom CTMP 12842 instance into a CTMP Snapshot Appchain Retention 12850. Therefore at Stage 12906 all of the perceptions from the Angles of Perception C473/C472/C471/C470 instance within the Custom CTMP 12842 instance are retained in the newly recorded Snapshot Retention 12850. At Stage 12908 the CTMP Snapshot Appchain Retention 12850 is associated with the corresponding Target Mind Identity 12816 and stored in the Personality Snapshot Cache Retention (PSCR) 12822 module. Therefore the Snapshot Retention 12850 can be later retrieved in correlation with the Target Mind Identity 12816.

FIG. 1114 continues the logic flow of Digital Mind Tracking (DMT) 12700, therefore illustrating means of invocation, main processing, and modular output production of the DMT 12700 module. At Stage 12912 a Mind Emulation Request 12910 is received from an invoking UBEC User 106 via the Mind Emulation Request Module (MERM) 12952. At Stage 12914 the Mind Emulation Request 12910 is unpacked to reveal it's stored variables: Plausible Emulation Scenario 12916 and Target Mind Identity 12816. The Target Mind Identity 12816 refers to identification information concerning the emulation of the Target Mind 12702 that the UBEC User 106 is directly or indirectly seeking. The Plausible Emulation Scenario 12916 is a variable produced by MERM 12952 to provide an emulation scenario to the rendered version of the Target Mind 12702. Each time MERM 12952 is directly or indirectly invoked by an UBEC User 106, MERM 12952 invokes multiple instance of DMT 12700, each with a different Plausible Emulation Scenario 12916. Therefore the sum of all the invoked DMT 12700 instances leads to an adequate reconstruction of the Target Mind 12702 at the MERM 12952 processing layer, which leads to an adequate unified response to the request by the UBEC User 106. Stage 12918 retrieves the Appchain 836 that lists all of the available Personality Snapshot Cache Retention (PSCR) 12822 instances 12918 on the BCHAIN Network 110. Thereafter Prompt 12920 is activated which checks if there is a PSCR 12822 instance that exists in the retrieved Appchain 836 from Stage 12918 that matches the Target Mind Identity 12816. A No 12922 response to Stage 12920 leads to the termination of the DMT 12700 instance's modular execution at Stage 12926 due to Emulation Request Fulfillment being unavailable. A Yes 12924 response to Prompt 12920 leads to the execution of Stage 12928 which retrieves the corresponding PSCR 12822 instance that was found at Prompt 12920. Stage 12928 leads to the activation of Prompt 12930 which checks if a Personality Snapshot 12850 exists in the corresponding PSCR 12822 instance for the Defined Time Era (Time Era is defined in Target Mind Identity 12816). If the response to Prompt 12930 is No 12932, then Stage 12926 is activated which terminated modular execution of the current DMT 12700 instance. A Yes 12934 response to Prompt 12930 leads to the execution of Stage 12936, which invokes Personality Reaction Rendering (PR2) 12942 to process the corresponding Personality Snapshot 12850 and the Plausible Emulation Scenario 12916 that was produced by the corresponding MERM 12952 instance. Therefore PR2 12942 invokes the interpretation of the Target Mind 12702 via the corresponding PSCR 12822 instance, which retains an executable Custom CTMP 12842 instance.

FIG. 1115 continues the logic flow of Digital Mind Tracking (DMT) 12700 with regards to the invocation of Personality Reaction Rendering (PR2) 12942. DMT 12700 resumes from FIG. 1114 at Stage 12936 where the Personality Snapshot 12850 and Plausible Emulation Scenario 12916 are processed by Personality Reaction Rendering (PR2) 12942. This leads to the execution of Stage 12938 which extracts the relevant CTMP Snapshot Appchain Retention 12850 from the corresponding Personality Snapshot Cache Retention (PSCR) 12822 instance and submits the Appchain Retention 12850 as modular input to PR2 12942. Therefore PR2 12942 is invoked at Stage 12944 which submits the Appchain Retention 12850 to processing by Data Stream Sorting (DSS) 6800, Execution Stream Collection (ESC) 6700 and therefore Execution Stream Rendering (ESR) 6400. The Custom CTMP 12842 instance that corresponds with the CTMP Snapshot Appchain Retention 12850 is now being actively rendered in ESR 6400. Stage 12946 invokes the main thread of the corresponding DMT 12700 instance to provide the relevant Plausible Emulation Scenario 12916 to PR2 12942 as modular input. Therefore the Plausible Emulation Scenario 12916 is submitted to the rendered Custom CTMP 12842 instance as it represents the Angles of Perception C473/C472/C471/C470 that represent the emulation of the Target Mind 12702. At Stage 12948 the Custom CTMP 12842 instance produces the Mind Perception Result 12950 which is submitted as modular output for the PR2 12942 instance and is returned back to the main thread of the corresponding DMT 12700 instance. Therefore the Mind Perception Result 12950 is processed at Stage 12940 of DMT 12700 which submits it to the corresponding MERM 12952 instance in response to the original Mind Emulation Request 12910.

FIGS. 1116-1145 show the operation and functionality of the Mind Emulation Request Module (MERM) 12952, which operates as a thread invocation mechanism for Digital Mind Tracking (DMT) 12700.

FIG. 1116 shows the operation and functionality of the Mind Emulation Request Module (MERM) 12952. An UBEC User 106 can either directly invoke MERM 12952 (and therefore DMT 12700) via a simple Intermediate Platform 12954 (user interface), or indirectly via a complex and autonomous Intermediate Platform 12954. An example of an Intermediate Platform 12954 is an Endowment Structure (ES) 12008 for NMC which invokes MERM 12952 and hence DMT 12700 to emulate a specified Target Mind 12700 to enact specified Override Measures 12388. The Intermediate Platform 12954 produces a Complex Scenario Definition 12956 which is processed at Stage 12958 so that it is supplied to a Need Map Matching (NMM) C114 instance to create jurisdictional branches concerning potential scenarios that are derived by such a Definition 12956. Thereafter Stage 12960 is executed which processes various Execution Sequences 12964 of the Complex Scenario Definition 12956 via I2GE 122 and from the jurisdictional branches which were formed by the corresponding NMM C114 instance. The Execution Sequences 12964 represent various different ways the Complex Scenario Definition 12956 can play out. The Saturation Criteria 12962 that is submitted as modular input to the corresponding Artificial Security Threat (AST) 123 instance is later referenced to evaluate if a sufficient amount of Execution Sequences 12964 were produced. Therefore the I2GE 122 can discern the amount of processing that needs to occur to produce a sufficiently stable amount of Execution Sequences 12964.

FIG. 1117 shows the operation and functionality of Need Map Matching (NMM) C114 operating as a submodule of LIZARD's 120 Dynamic Shell C198. The NMM C114 instance is spawned to serve the operation of Stage 12960 of the Mind Emulation Request Module (MERM) 12952. The Complex Scenario Definition 12956 is submitted for storage in Need Access and Development and Storage 5550. Therefore the Complex Scenario Definition 12956 is broken down into sub-categories and retained in Storage 5550 as a series of hierarchal branches and layers. Upon the modular invocation of NMM C114, Initial Parsing C148 downloads each jurisdiction branch from Storage 5550 to temporarily retain for referencing within the ongoing NMM C114 instance. With Calculate Branch Needs C149: according to definitions associated with each branch, needs are associated with their corresponding department. This way, permission checks can be formed within the NMM C114 instance. For example: NMM C114 approved the request for the Human Resources department to download all employee CVs, because it was requested within the zone of the annual review of employee performance according to their capabilities. Therefore it was proven to be a valid need of the department jurisdiction. Therefore Need Index C145 is the main storage of Jurisdiction Branches and their respective needs. Because this internal reference is a resource bottleneck for the operation of NMM C114 and therefore all the modules it serves, it is pre-optimized for quick database querying to increase the overall efficiency of the system. The I2GE 122 provides an Input Purpose C139 as modular input to the Search Algorithm C144 of NMM C114. The Search Algorithm C144 references and searches through the compiled Need Index C145, therefore determining if the Input Purpose C139 defines a valid need according to the jurisdiction branches initially defined in Need Access Development and Storage 5550. Therefore the completed execution of the Search Algorithm C144 via the Need Index C145 produces an Approve/Block C146 response which is submitted as modular output from NMM C114 and referenced as the Need Result C141. Therefore the Need Result C141 is returned back to I2GE 122 in response to it's Input Purpose C139 submission.

FIG. 1118 elaborates on the operational details concerning Stage 12960 of MERM 12952. The Complex Scenario Definition 21956 is submitted to LIZARD's 120 Need Map Matching (NMM) C114 module to produce jurisdictional categorization branches. Such branches are unpacked at Stage 12966, which leads to the execution of Stage 12968. At Stage 12968 jurisdictional branches of the Complex Scenario Definition 12956 are installed as the base generation (Ni) of each Evolution Pathway C867A of the newly invoked I2GE 122 instance. Such an installation occurs via the Monitoring Interaction System C868D of I2GE 122. Once the I2GE 122 emulation has started, the Evolution Pathways C867A evolve according to their corresponding Pathway Personality C867D definitions. Such Pathway Personalities C867D are installed at the subsequent Stage 12970, which receives the Sequence Interpretation Methodologies 12972 variable collection and installs them as corresponding Personalities C867D in the I2GE 122 instance. The Methodologies 12972 variable is produced and retained within the jurisdiction of MERM 12952, therefore MERM 12952 is already equipped in it's composition to contemplate various methods and styles to interpreting scenario sequences. Each Evolution Pathway C867A is logistically separated by the others via Virtual Isolation 390 within the I2GE 122 instance. Therefore there is an implied guarantee that results produced from Evolution Pathways C867A are unbiased and unaffected by other potential factors.

FIG. 1119 elaborates on the functionality and operation of Stage 12960 of MERM 12952. The Complex Scenario Definition 12956 is being emulated by multiple parallel Evolution Pathways C867A which receive environmental tests by the Artificial Security Threat (AST) 123 module. Once I2GE 122 emulation processing is completed, the results are processed by the Iteration Conclusion processor 5554, which submits modular output to Prompt 12974. Prompt 12974 evaluates the quantity of stabilized Execution Sequences 12964 that were produced by the I2GE 122 emulation session. The response to Prompt 12974 is considered Yes, Sufficiently Stable 12976 is the Saturation Criteria 12962 is met for Execution Sequence 12964 variance and stability.

FIG. 1120 elaborates on the functionality of FIGS. 1118 and 1119, showing the multiple Generations 5658 that are sequentially built within the Evolution Pathway C867. The jurisdictional branches which represent the Complex Scenario Definition 12956 and are produced by LIZARD's 120 Need Map Matching (NMM) C114 module correlate and represent the sequential Generations 5658 that are produced in the I2GE 122 emulation session. As the session continues, whilst being hosted on the BCHAIN Network 110, Pathway Designation 5650 represents the three states which can become of an Evolution Pathway C867: Passed as Stable 5652, Pending Evolution 5654, and Abandoned/Deleted 5656. A Pathway C867 may be Deleted 5656 if the corresponding Pathway Personality C867D displays an inherit flaw in composition and/or an inherit incompatibility with the initial Pathway C867 state.

FIG. 1121 continues the logic flow of the Mind Emulation Request Module (MERM) 12952. Stage 12960 produces various Execution Sequences 12964 that are derived from the Complex Scenario Definition 12956. At Stage 12980 LIZARD 120 is invoked to convert the Complex Scenario Definition 12956 into a Purpose Hierarchy Map 12982. At Stage 12984 the Execution Sequences 12984 are iterated in a newly invoked Loop. At Stage 12986 the Purpose Hierarchy Map 12982 is cloned in content and referenced as a separate instance which is labelled the Base Purpose Hierarchy Map 12988. Such a Map 12988 is later used as an individual instance within a single iteration of the Loop initiated at Stage 12984. Therefore at the beginning of each iteration of the Stage 12984 Loop, the Base Purpose Hierarchy Map 12988 is reset to the contents of the Purpose Hierarchy Map 12982. At Stage 12992, LIZARD 120 converts the Selected Execution Sequence 12990 to a Purpose Hierarchy Map 12994.

FIG. 1122 shows details concerning the operation of LIZARD 120 to convert the Complex Scenario Definition 12956 into a Purpose Hierarchy Map 12982. The Complex Scenario Definition 12956 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The Complex Scenario Definition 12956 is received in Scenario Syntax 12957 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1123 continues the logic flow from FIG. 1122 to illustrate the operation of LIZARD 120 to convert Complex Scenario Definition 12956 into a Purpose Hierarchy Map 12982. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 12786 which is presented as the Complex Purpose Format C325 version of the Complex Scenario Definition 12956. The same definition and application of Inner Core (IC) C333 applies for the aforementioned functions and modules.

FIG. 1124 shows details concerning the operation of LIZARD 120 to convert the Selected Execution Sequence 12990 into a Purpose Hierarchy Map 12994. The Selected Execution Sequence 12990 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The Complex Scenario Definition 12956 is received in Scenario Syntax 12957 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1125 continues the logic flow from FIG. 1124 to illustrate the operation of LIZARD 120 to convert the Selected Execution Sequence 12990 into a Purpose Hierarchy Map 12994. Logical Reduction C323 from the Syntax Module (SM) C35 submits it's output to Iterative Interpretation C328 from the Purpose Module (PM) C36. Iterative Interpretation C320 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 12994 which is presented as the Complex Purpose Format C325 version of the Selected Execution Sequence 12990. The same definition and application of Inner Core (IC) C333 applies for the aforementioned functions and modules.

FIG. 1126 elaborates on the operational details of the Mind Emulation Request Module (MERM) 12952 by continuing the logic flow from FIG. 1121. Therefore the logic flow resume at Stage 12992 which is where LIZARD 120 converts the Selected Execution Sequence 12990 to a Purpose Hierarchy Map 12994. At Stage 12996 the Purpose Hierarchy Map 12982 of the Complex Scenario Definition 12956 and the Purpose Hierarchy Map 12994 of the Selected Execution Sequence 12990 are processed via an invoked instance of Purpose to Purpose Symmetry Processing (P2SP) 7000, therefore produces the Symmetry Processing Result 12998. This leads to the activation of Prompt 13000, which interprets the Symmetry Processing Result 12998 by checking if the two Purpose Hierarchy Maps 12982 and 12994 are congruent and compatible with each other. A response to Prompt 13000 indicating No, Not Congruent 13004 is illustrated on FIG. 1127. A Yes, Congruent 13002 response leads to the activation of Stage 13006, which invokes the Purpose Realignment Processing (PRP) 7050 module to readjust the Purpose Hierarchy Map 12994 of the Selected Execution Sequence 129990 to match the Purpose Hierarchy Map 12982 of the Complex Scenario Definition 12956. Therefore the Master/Slave Affinity 13008 variable is provided to the corresponding PRP 7050 instance as' modular input to indicate that Map 12982 is the Slave and Map 12994 is the Master. Such an Affinity 13008 is defined as a fixed variable according to the logic flow structure. Therefore the completion of Stage 13006 produces the Plausible Emulation Scenario 12916, which is referenced for usage at Stage 13012 of FIG. 1128.

FIG. 1127 continues the logic flow from FIG. 1126 to illustrate the logic flow concerning the response of No, Not Congruent 13004 towards Prompt 13000. Subsequently, Stage 5600 occurs which submits a Diagnostic Log Unit (DLU) 1182 that contains the Official System Token 1184. This Token 1184 is included to indicate that the corresponding function or program has reached a non-ideal state if an official function within the UBEC Platform 100. The DLU 1182 is submitted to the Diagnostic Log Submission (DLS) 1160 module, which is invoked by LOM's 132 Automated Research Mechanism (ARM) 134 to supply the DLU 1182 to SPSI 130. Therefore SPSI 130 is able to process the diagnostic information found in the DLU 1160 with the Diagnostic Log Unit Analysis (DLUA) 8048 module. This leads to Stage 13005 which represents DLUA 8048 being invoked to perform corresponding modifications to I2GE 122 and/or MERM 12952 to avoid the initial reason the No, Not Congruent 13004 response was invoked to Prompt 13000.

FIG. 1128 continues the logic Flow of the Mind Emulation Request Module (MERM) 12952, which is resumed at Stage 13006 from FIG. 1126. After Stage 13006 completes invoking the Purpose Realignment Processing (PRP) 7050 module to Map 12994, Stage 13010 is executed which receives the Target Mind Identity 12816 as modular input to the MERM 12952 instance by the UBEC User 106 via the Intermediate Platform 12954. Stage 13012 is then processed to pack the Target Mind Identity 12816 and Plausible Emulation Scenario 12916 into a Mind Emulation Request 12910. At Stage 13014 the Mind Emulation Request 12910 is submitted to the corresponding Digital Mind Tracking (DMT) 12700 instance. Therefore the DMT 12700 enacts it's procedure to produce the Mind Perception Result 12950 as modular output. At Stage 130016 the Mind Perception Result 12950 is received from the DMT 12700 instance and is submitted as module input to Stage 13018, which invokes LIZARD to convert it to a Purpose Hierarchy Map 13020.

FIG. 1129 continues the logic flow of MERM 12952 by resuming at Stage 13018 from FIG. 1128. Stage 13018 produces the Purpose Hierarchy Map 13020 from the Mind Perception Result 12950. At Stage 13022 LIZARD 120 converts the Plausible Emulation Scenario 12916 into a Purpose Hierarchy Map 13024. Stage 13026 invokes Purpose to Purpose Symmetry Processing (P2SP) 7000 to process both Maps 13020 and 13024, therefore producing the Symmetry Processing Result 13028. At Prompt 13030 the Result 13028 is analyzed to interpret if the Purpose Hierarchy Map 13020 of the Mind Perception Result 12950 is congruent/compatible with the Purpose Hierarchy Map 13024 of the Plausible Emulation Scenario 12916. If the response to Prompt 13030 is No, Not Congruent 13034, then the logic flow follows the same procedure as shown with the No, Not Congruent 13004 response from FIG. 1127 which indicates that at Stage 5602 a DLU 1182 is submitted to the Diagnostic Log Submission (DLS) 1160 module. The logic flow concerning the Yes, Congruent 13032 response to Prompt 13030 is shown on FIG. 1134.

FIG. 1130 shows details concerning the operation of LIZARD 120 to convert the Mind Perception Result 12950 into a Purpose Hierarchy Map 13020. The Mind Perception Result 12950 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The Complex Scenario Definition 12956 is received in Scenario Syntax 12957 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts that are relevant in the field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1131 continues the logic flow from FIG. 1130 to illustrate the operation of LIZARD 120 to convert the Mind Perception Result 12950 into a Purpose Hierarchy Map 13020. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 13020 which is presented as the Complex Purpose Format C325 version of the Mind Perception Result 12950. The same definition and application of Inner Core (IC) C333 applies for the aforementioned functions and modules.

FIG. 1132 shows details concerning the operation of LIZARD 120 to convert the Plausible Emulation Scenario 12916 into a Purpose Hierarchy Map 13024. The Plausible Emulation Scenario 12916 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The Complex Scenario Definition 12956 is received in Scenario Syntax 12957 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1133 continues the logic flow from FIG. 1132 to illustrate the operation of LIZARD 120 to convert the Plausible Emulation Scenario 12916 into a Purpose Hierarchy Map 13024. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 13024 which is presented as the Complex Purpose Format C325 version of the Plausible Emulation Scenario 12916. The same definition and application of Inner Core (IC) C333 applies for the aforementioned functions and modules.

FIG. 1134 continues the logic flow of the Mind Emulation Request Module (MERM) 12952 from FIG. 1129. A Yes, Congruent 13032 response to Prompt 13030 leads to the execution of Stage 13036. Stage 13036 adjusts the Purpose Hierarchy Map 13024 of the Plausible Emulation Scenario 12916 to match the Purpose Hierarchy Map 13024 of the Mind Perception Result 13036 via the Purpose Realignment Processing (PRP) 7050 module. The Master/Slave Affinity 13038 is submitted to the corresponding PRP 7050 instance as modular input to incite that MAP 13024 is the designated Slave and Map 13020 is the designated Master. Therefore Stage 13036 produces the Fulfilled Emulation Scenario 13040 which represents the Target Mind's 12702 fulfillment of the potential scenario that existed in the Plausible Emulation Scenario 12916 variable. At Stage 13042 the. Base Purpose Hierarchy Map 12988 of the Complex Scenario Definition 12956 and the Fulfilled Emulation Scenario 13040 are processed by Purpose to Purpose Symmetry Processing (P2SP) 7000 to produce the Symmetry Processing Result 13044.

FIG. 1135 continues the logic flow of MERM 12952 from FIG. 1134 at Stage 13042. After Stage 12042 produces the Symmetry Processing Result 13044, the Result 13044 is submitted to Prompt 13046. Prompt 13046 interprets the congruency and compatibility between the Fulfilled Emulation Scenario 13040 and the Base Purpose Hierarchy Map 12988 of the Complex Scenario Definition 12956. If the response to Prompt 13046 is No, Not Congruent 13050, then the logic flow follows the same procedure as shown with the No, Not Congruent 13004 response from FIG. 1127 which indicates that at Stage 5602 a DLU 1182 is submitted to the Diagnostic Log Submission (DLS) 1160 module. If the response to Prompt 13046 is Yes, Congruent 13048 then Stage 13052 occurs which invokes Purpose Realignment Processing (PRP) 7050 to adjust the Base Purpose Hierarchy Map 12988 of the Complex Scenario Definition 12956 to match the Fulfilled Emulation Scenario. Therefore the Master/Slave Affinity 13054 is supplied to the corresponding PRP 7050 instance as modular input to define the Base Purpose Hierarchy Map 1988 as the Slave and the Fulfilled Emulation Scenario 13040 as the Master.

FIG. 1136 continues the logic flow of MERM 12952 from FIG. 1135 at Stage 13052. The execution of Stage 13052, as demonstrated on FIG. 1135, produces the Upgraded Purpose Map 13056 as modular output. At Stage 13058 the Upgraded Purpose Map 13056 replaces the Base Purpose Hierarchy Map 12988 of the Complex Scenario Definition 12956. Therefore the iteration of the Loop is completed, so Prompt 12060 interprets if the Loop from Stage 12984 has any remaining Execution Sequences left that have not yet been processed. A Yes 13062 response to Prompt 13060 causes Stage 13066 to advance the Loop to the next available Execution Sequence at Stage 12984. A No 13064 response to Prompt 13060 leads to Stage 13068 invoking LIZARD 120 to convert the Base Purpose Hierarchy Map 12988 into Appchain Syntax (and hence no longer in Purpose Format).

FIG. 1137 shows details concerning the operation of LIZARD 120 to convert the Base Purpose Hierarchy Map 12988 of Complex Scenario Definition 12956 into Appchain Syntax. The Map 12988 exists in Complex Purpose Format C325 and is submitted to Iterative Expansion C327 of the Purpose Module C36 within the Outer Core (OC) C329 of LIZARD 120. Iterative Expansion C327 adds detail and complexity to evolve a simple goal (indirectly defined within the Map 12174) into a specific complex purpose definition. Therefore the maximum Purpose Association C326 potential of the input is realized, and retained as a Complex Purpose Format C325, before it is submitted to Logical Derivation C320 of the Syntax Module (SM) C35. The Core Code C335 element of Inner Core (IC) C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1138 continues the logic flow from FIG. 1137 to illustrate the operation of LIZARD 120 to convert the Base Purpose Hierarchy Map 12988 into Appchain Syntax that is referenced as Upgraded Appchain Retention 12188. The input data is received in Complex Purpose Format C325 from the Purpose Module (PM) C36 and is transferred to Logical Derivation C320 of the Syntax Module (SM) C35. Logic Derivation C320 derives logically necessary functions from initially simpler functions. This means that if a function can be formed as a derivative function due to implication from a simpler parent function; then it is formed by Logical Derivation C320. The produced result is a tree of function dependencies that are built according to the defined Complex Purpose Format C325 data. Logical Derivation C320 operates according to the Rules and Syntax C322 definitions which are inherited from the Core Code C335 element of Inner Core (IC) C333. Logical Derivation C320 submits it's output to Code Translation C321. Code Translation C321 converts arbitrary (generic) code which is recognized and understood by SM C35 to any known and chosen computation language. Code Translation C321 also performs the inverse function of translating known computation languages into arbitrary syntax types. Therefore PM C36 invokes SM C35 to produce the resultant Appchain Syntax Version 12188 of the input Complex Scenario Definition 12988 via Code Translation C321. The resultant Upgraded Appchain Retention 12188 that is terminally produced by Code Translation C321 is the modular output of SM C35, Outer Core (OC) C329, and LIZARD 120.

FIG. 1139 continues the logic flow of MERM 12952 from FIG. 1136 at Stage 13068. Stage 12068 produces the Upgraded Appchain Retention 12188, which is submitted as modular input to Deployment Patch Assembly (DPA) 6260 for later reference at Stage 13078. At Stage 12070 LIZARD 120 converts the Purpose Hierarchy Map 13072 into Appchain Syntax, therefore producing the Original Appchain Retention 13074 as modular output. The Original Appchain Retention 13074 is also submitted to DPA 6260 as modular input. Stage 13078 is then processed to invoke DPA 6260 to produce the Appchain Correction Patch 13076 as modular output from the modular inputs 12188 and 13074. The Appchain Correction Patch 13076 is then converted into Scenario Syntax by LIZARD 120 at Stage 13080. Therefore at Stage 13082 the Mind Emulation Response 13084 is submitted to the UBEC User 106 via the Intermediate Platform 12954.

FIG. 1140 shows details concerning the operation of LIZARD 120 to convert convert the Purpose Hierarchy Map 13072 of Complex Scenario Definition 12956 into Appchain Syntax. The Map 13072 exists in Complex Purpose Format C325 and is submitted to Iterative Expansion C327 of the Purpose Module C36 within the Outer Core (OC) C329 of LIZARD 120. Iterative Expansion C327 adds detail and complexity to evolve a simple goal (indirectly defined within the Map 12174) into a specific complex purpose definition. Therefore the maximum Purpose Association C326 potential of the input is realized, and retained as a Complex Purpose Format C325, before it is submitted to Logical Derivation C320 of the Syntax Module (SM) C35. The Core Code C335 element of Inner Core (IC) C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1141 continues the logic flow from FIG. 1140 to illustrate the operation of LIZARD 120 to convert the Purpose Hierarchy Map 13072 into Appchain Syntax that is referenced as Original Appchain Retention 13074. The input data is received in Complex Purpose Format C325 from the Purpose Module (PM) C36 and is transferred to Logical Derivation C320 of the Syntax Module (SM) C35. Logic Derivation C320 derives logically necessary functions from initially simpler functions. This means that if a function can be formed as a derivative function due to implication from a simpler parent function; then it is formed by Logical Derivation C320. The produced result is a tree of function dependencies that are built according to the defined Complex Purpose Format C325 data. Logical Derivation C320 operates according to the Rules and Syntax C322 definitions which are inherited from the Core Code C335 element of Inner Core (IC) C333. Logical Derivation C320 submits it's output to Code Translation C321. Code Translation C321 converts arbitrary (generic) code which is recognized and understood by SM C35 to any known and chosen computation language. Code Translation C321 also performs the inverse function of translating known computation languages into arbitrary syntax types. Therefore PM C36 invokes SM C35 to produce the resultant Appchain Syntax Version 13074 of the input Complex Scenario Definition 12988 via Code Translation C321. The resultant Original Appchain Retention 13074 that is terminally produced by Code Translation C321 is the modular output of SM C35, Outer Core (OC) C329, and LIZARD 120.

FIG. 1142 shows details concerning the operation of LIZARD 120 to convert the Appchain Correction Patch 13076 into a Purpose Hierarchy Map 13086. The Appchain Correction Patch 13076 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The Appchain Correction Patch 13076 is received in Perception Syntax 5638 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose. Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1143 continues the logic flow from FIG. 1132 to illustrate the operation of LIZARD 120 to convert the Appchain Correction Patch 13076 into a Purpose Hierarchy Map 13086. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 13086 which is presented as the Complex Purpose Format C325 version of the Appchain Correction Patch 13076. The same definition and application of Inner Core (IC) C333 applies for the aforementioned functions and modules.

FIG. 1144 shows details concerning the operation of LIZARD 120 to convert convert the Purpose Hierarchy Map 13086 of the Appchain Correction Patch 13076 into Scenario Syntax. The Map 13086 exists in Complex Purpose Format C325 and is submitted to Iterative Expansion C327 of the Purpose Module C36 within the Outer Core (OC) C329 of LIZARD 120. Iterative Expansion C327 adds detail and complexity to evolve a simple goal (indirectly defined within the Map 13086) into a specific complex purpose definition. Therefore the maximum Purpose Association C326 potential of the input is realized, and retained as a Complex Purpose Format C325, before it is submitted to Logical Derivation C320 of the Syntax Module (SM) C35. The Core Code C335 element of Inner Core (IC) C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1145 continues the logic flow from FIG. 1144 to illustrate the operation of LIZARD 120 to convert the Purpose Hierarchy Map 13086 into Scenario Syntax that is referenced as the Mind Emulation Response 13084. The input data is received in Complex Purpose Format C325 from the Purpose Module (PM) C36 and is transferred to Logical Derivation C320 of the Syntax Module (SM) C35. Logic Derivation C320 derives logically necessary functions from initially simpler functions. This means that if a function can be formed as a derivative function due to implication from a simpler parent function; then it is formed by Logical Derivation C320. The produced result is a tree of function dependencies that are built according to the defined Complex Purpose Format C325 data. Logical Derivation C320 operates according to the Rules and Syntax C322 definitions which are inherited from the Core Code C335 element of Inner Core (IC) C333. Logical Derivation C320 submits it's output to Code Translation C321. Code Translation C321 converts arbitrary (generic) code which is recognized and understood by SM C35 to any known and chosen computation language. Code Translation C321 also performs the inverse function of translating known computation languages into arbitrary syntax types. Therefore PM C36 invokes SM C35 to produce the resultant Scenario Syntax Version 13084 of the input Appchain Correction Patch 13076 via Code Translation C321. The resultant Mind Emulation Response 13084 that is terminally produced by Code Translation C321 is the modular output of SM C35, Outer Core (OC) C329, and LIZARD 120.

FIGS. 1146-1183 show the operation and functionality of the Neuroeconomic Mapping Enhancement (NME) 13090 module, which associates Neural Patterns 13094 of the Target Mind 12702 with physical states of existence that are captured in Target Circumstantial State 13100.

FIG. 1146 introduces the Neuroeconomic Mapping Enhancement (NME) 13090 module. The Unobtrusive Neural Scanning Device (UNSD) 13092 receives a Raw Neural Pattern 13094 from the Target Mind 12702 that is acting in it's capacity as an UBEC User 106. The Target Mind 12702 being an UBEC User 106 enables internal standardized API communications to be made via the BCHAIN Network 110 to the UNSD 13092 module. Therefore at Stage 13096 the Raw Neural Pattern 13094 of the UBEC User 106 is received via UNSD 13092. At Stage 13098 LOM 132 reports on the Target Circumstantial State 13100 and Confidence 13102 of the UBEC User 106 via the corresponding Personal Intelligence Profile (PIP) 136 and the Life Administration Automation (LAA) 138. Therefore LOM 132 produces the Target Circumstantial State 13100 based on data provided by PIP 136, which retains personal information concerning the target UBEC User 106, and LAA 138, which connects the digital lifestyle of the UBEC User 106 via interaction of the Internet of Things (IoT). For example: the IoT enabled car which the UBEC User 106 own is reporting via LAA 138 that the UBEC User 106 is driving and is currently stuck in traffic. Therefore this example information is included in the Target Circumstantial State 13100 as produced by LOM 132. Target Circumstantial State Confidence 13102 represents the degree of confidence LOM 132 had generating such variables concerning there Circumstantial State 13100. For example: how confident is LOM 132, and by extension LAA 138, that the UBEC User 106 is really the driver of the car and that the car is really stuck in traffic. At Stage 13104 LOM produces Neural State Association Knowledge 13108, which represents learned correlations between potential Neural State and potential Circumstantial State. Neural State Association Knowledge Confidence 13106 correlates with the algorithmic confidence LOM 132 has in regards to the accuracy and reliability of Neural State Association Knowledge 13108. At Stage 13110 LIZARD 120 converts Neural State Association Knowledge 13108 into a Purpose Hierarchy Map 13112.

FIG. 1147 shows details concerning Stage 13104 of NME 13090, where LOM 132 produces Neural State Association Knowledge 13108 from CKR 648. LOM 132 is invoked to produce such Knowledge 12370 by the Knowledge Invocation Prompt (KIP) 5640 module. Regulatory Compliance Knowledge 12370 is illustrated as being built of multiple instances of UKF Clusters C854F. The individual element of the UKF Cluster C854F is elaborated in detail as being made of UKF1, UKF2, and UKF3 sub-units that are stored in Rule Syntax Format C538.

FIG. 1148 shows details concerning the operation of LIZARD 120 to convert the Neural State Association Knowledge 13108 into a Purpose Hierarchy Map 13112. The Neural State Association Knowledge 13108 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The Appchain Correction Patch 13076 is received in Perception Syntax 5638 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1149 continues the logic flow from FIG. 1148 to illustrate the operation of LIZARD 120 to convert the Neural State Association Knowledge 13108 into a Purpose Hierarchy Map 13112. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 13112 which is presented as the Complex Purpose Format C325 version of the Neural State Association Knowledge 13108. The same definition and application of Inner Core (IC) C333 applies for the aforementioned functions and modules.

FIG. 1150 continues the logic flow of Neuroeconomic Mapping Enhancement (NME) 13090 from FIG. 1146 at Stage 13104. At Stage 13104 invokes LOM 132 to produce Neural State Association Knowledge 13108, as shown on FIG. 1147. Stage 13114 produces Pathway Personalities and hence Evolution Pathways from the resulting slight variations that exist within the Neural State Association Knowledge 13114 variable. Stage 13116 invokes I2GE 122 to stress test and tweak Neural State Association Knowledge 13108 to ensure that it is internally consistent. Stage 13118 receives modular output from the I2GE 122 instance that was invoked at Stage 13116 in the form of the Refined Neural State Association Knowledge 13120. At Stage 13110 LIZARD 120 converts Neural State Association Knowledge 13108 into a Purpose Hierarchy Map 13112. Stage 13122 invokes LIZARD 120 to convert the Refined Neural State Association Knowledge 13120 into a Purpose Hierarchy Map 13124. Purpose to Purpose Symmetry Processing (P2SP) 7000 is then invoked to process both Maps 13124 and 13112, the logic flow of which is shown on FIG. 1156.

FIG. 1151 elaborates on the operational details concerning Stage 13114 of NME 13090. The Neural State Association Knowledge 13108 is submitted to the Input Creative Variance (ICV) 12405 module to produce Makeup Variations 13128. Such Variations 13128 are unpacked at Stage 13130, which leads to the execution of Stage 13132. The base generation (Ni) of each Evolution Pathway C867A of the newly invoked I2GE 122 instance is initiated as blank. Once the I2GE 122 emulation has started, the Evolution Pathways C867A evolve according to their corresponding Pathway Personality C867D definitions. Such Pathway Personalities C867D are installed at the subsequent Stage 13132, which receives the Makeup Variations 13128 variable collection and installs them as corresponding Personalities C867D in the I2GE 122 instance. Each Evolution Pathway C867A is logistically separated by the others via Virtual Isolation 390 within the I2GE 122 instance. Therefore there is an implied guarantee that results produced from Evolution Pathways C867A are unbiased and unaffected by other potential factors.

FIG. 1152 elaborates on the functionality and operation of Stage 13116 of NME 13090. The Complex Scenario Definition 12956 is being emulated by multiple parallel Evolution Pathways C867A which receive environmental tests by the Artificial Security Threat (AST) 123 module. Once I2GE 122 emulation processing is completed, the results are processed by the Iteration Conclusion processor 5554, which submits modular output to Prompt 13134. Prompt 13134 evaluates the quantity of stabilized Neural State Association Knowledge 13134 that were produced by the I2GE 122 emulation session. The response to Prompt 13134 is considered Yes, Sufficiently Stable 13136 is the Saturation Criteria 12962 is met for Refined Neural State Association Knowledge 13120 variance and stability.

FIG. 1153 elaborates on the functionality of FIGS. 1151 and 1152, showing the multiple Generations 5658 that are sequentially built within the Evolution Pathway C867. The Makeup Variations 13128 that are produced from Neural State Association Knowledge 13108 and are produced by LIZARD's 120 Need Map Matching (NMM) C114 module correlate and represent the sequential Generations 5658 that are produced in the I2GE 122 emulation session. As the session continues, whilst being hosted on the BCHAIN Network 110, Pathway Designation 5650 represents the three states which can become of an Evolution Pathway C867: Passed as Stable 5652, Pending Evolution 5654, and Abandoned/Deleted 5656. A Pathway C867 may be Deleted 5656 if the corresponding Pathway Personality C867D displays an inherit flaw in composition and/or an inherit incompatibility with the initial Pathway C867 state.

FIG. 1154 shows details concerning the operation of LIZARD 120 to convert Refined Neural State Association Knowledge 13120 into a Purpose Hierarchy Map 13124. The Refined Neural State Association Knowledge 13120 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The Refined Neural State Association Knowledge 13120 is received in Perception Syntax 5638 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1155 continues the logic flow from FIG. 1154 to illustrate the operation of LIZARD 120 to convert Refined Neural State Association Knowledge 13120 into a Purpose Hierarchy Map 13124. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 13112 which is presented as the Complex Purpose Format C325 version of the Refined Neural State Association Knowledge 13120. The same definition and application of Inner Core (IC) C333 applies for the aforementioned functions and modules.

FIG. 1156 continues the logic flow from FIG. 1150 to illustrate the operation and functionality of the Neuroeconomic Mapping Enhancement (NME) 13090 module. At Stage 13140 Purpose to Purpose Symmetry Processing (P2SP) 7000 is invoked to process the Purpose Hierarchy Map 13112 of Neural State Association Knowledge 13208 and the Purpose Hierarchy Map 13124 of the Refined Neural State Association Knowledge 13120, therefore producing the Symmetry Processing Result 13142. This processing of Stage 13140 leads to the activation of Prompt 13144, which interprets the Symmetry Processing Result 13142 to evaluate if the Purpose Hierarchy Map 13124 is congruent and compatible with the Purpose Hierarchy Map 13112. A No, Not Congruent 13148 response to Prompt 13144 is realized at FIG. 1162, which follows the same termination/diagnostic logic of FIG. 1127. A Yes, Congruent 13146 response to Prompt 13144 leads to Stages 13150 and 13154. Stage 13150 invokes LIZARD 120 to convert the Purpose Hierarchy Map 13112 of Neural State Association Knowledge 13108 into Appchain Syntax, therefore producing the Original Appchain Retention 13152 as modular output. Likewise, Stage 13154 invokes LIZARD 120 to convert the Purpose Hierarchy Map 13124 of Refined Neural State Association Knowledge 13120 into Appchain Syntax, therefore producing the Upgraded Appchain Retention 13156. Both Retentions 13151 and 13156 are used as modular input to the Deployment Patch Assembly (DPA) 6260 module, as illustrated on FIG. 1161.

FIG. 1157 shows details concerning the operation of LIZARD 120 to convert convert the Purpose Hierarchy Map 13112 of the Neural State Association Knowledge 13108 into Appchain Syntax. The Map 13112 exists in Complex Purpose Format C325 and is submitted to Iterative Expansion C327 of the Purpose Module C36 within the Outer Core (OC) C329 of LIZARD 120. Iterative Expansion C327 adds detail and complexity to evolve a simple goal (indirectly defined within the Map 13112) into a specific complex purpose definition. Therefore the maximum Purpose Association C326 potential of the input is realized, and retained as a Complex Purpose Format C325, before it is submitted to Logical Derivation C320 of the Syntax Module (SM) C35. The Core Code C335 element of Inner Core (IC) C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1158 continues the logic flow from FIG. 1157 to illustrate the operation of LIZARD 120 to convert the Purpose Hierarchy Map 13112 into Appchain Syntax that is referenced as the Original Appchain Retention 13152. The input data is received in Complex Purpose Format C325 from the Purpose Module (PM) C36 and is transferred to Logical Derivation C320 of the Syntax Module (SM) C35. Logic Derivation C320 derives logically necessary functions from initially simpler functions. This means that if a function can be formed as a derivative function due to implication from a simpler parent function; then it is formed by Logical Derivation C320. The produced result is a tree of function dependencies that are built according to the defined Complex Purpose Format C325 data. Logical Derivation C320 operates according to the Rules and Syntax C322 definitions which are inherited from the Core Code C335 element of Inner Core (IC) C333. Logical Derivation C320 submits it's output to Code Translation C321. Code Translation C321 converts arbitrary (generic) code which is recognized and understood by SM C35 to any known and chosen computation language. Code Translation C321 also performs the inverse function of translating known computation languages into arbitrary syntax types. Therefore PM C36 invokes SM C35 to produce the resultant Appchain Syntax Version 13152 of the input Neural State Association Knowledge 13108 via Code Translation C321. The resultant Original Appchain Retention 13152 that is terminally produced by Code Translation C321 is the modular output of SM C35, Outer Core (OC) C329, and LIZARD 120.

FIG. 1159 shows details concerning the operation of LIZARD 120 to convert convert the Purpose Hierarchy Map 13124 of the Refined Neural State Association Knowledge 13120 into Appchain Syntax. The Map 13124 exists in Complex Purpose Format C325 and is submitted to Iterative Expansion C327 of the Purpose Module C36 within the Outer Core (OC) C329 of LIZARD 120. Iterative Expansion C327 adds detail and complexity to evolve a simple goal (indirectly defined within the Map 13112) into a specific complex purpose definition. Therefore the maximum Purpose Association C326 potential of the input is realized, and retained as a Complex Purpose Format C325, before it is submitted to Logical Derivation C320 of the Syntax Module (SM) C35. The Core Code C335 element of Inner Core (IC) C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1160 continues the logic flow from FIG. 1159 to illustrate the operation of LIZARD 120 to convert the Purpose Hierarchy Map 13112 into Appchain Syntax that is referenced as the Upgraded Appchain Retention 13156. The input data is received in Complex Purpose Format C325 from the Purpose Module (PM) C36 and is transferred to Logical Derivation C320 of the Syntax Module (SM) C35. Logic Derivation C320 derives logically necessary functions from initially simpler functions. This means that if a function can be formed as a derivative function due to implication from a simpler parent function; then it is formed by Logical Derivation C320. The produced result is a tree of function dependencies that are built according to the defined Complex Purpose Format C325 data. Logical Derivation C320 operates according to the Rules and Syntax C322 definitions which are inherited from the Core Code C335 element of Inner Core (IC) C333. Logical Derivation C320 submits it's output to Code Translation C321. Code Translation C321 converts arbitrary (generic) code which is recognized and understood by SM C35 to any known and chosen computation language. Code Translation C321 also performs the inverse function of translating known computation languages into arbitrary syntax types. Therefore PM C36 invokes SM C35 to produce the resultant Appchain Syntax Version 13156 of the input Refined Neural State Association Knowledge 13120 via Code Translation C321. The resultant Upgraded Appchain Retention 13156 that is terminally produced by Code Translation C321 is the modular output of SM C35, Outer Core (OC) C329, and LIZARD 120.

FIG. 1161 shows the operation and functionality of Neuroeconomic Mapping Enhancement (NME) 13090 by resuming the logic flow at Stage 13158 from FIG. 1156. The Original 13152 and Upgraded 13156 Appchain Retentions are sent to Stage 13158 as modular input so that they can be processed by the Deployment Patch Assembly (DPA) 6260 module, therefore producing the Appchain Correction Patch 13160. DPA 6260 measures and defines the differences between both inputs 13152 and 13156 in Appchain Syntax, therefore producing Appchain Syntax instructions for converting the Original Appchain Retention 13152 into the Upgraded Appchain Retention 13156. Such Instructions are referenced as the Appchain Correction Patch 13160, which is initially stored as a session (temporary/non-persistent) variable of the corresponding NME 13090 instance. Therefore the Session Write Data Segment 6420 Command Type 6408 is used within the Execution Stream Rendering (ESR) 6400 instance that is hosting the NME 13090 instance. At Stage 13162 the Appchain Correction Patch 13160 is committed to persistent Central Knowledge Retention (CKR) 648 Storage via the invocation of the Customchain Ecosystem Builder (CEB) 584 module. The operation performed at Stage 13162 causes the hosting ESR 6400 instance to invoke the Persistent Write Data Segment 6422 Command Type 6408.

FIG. 1162 continues the logic flow from FIG. 1156 to illustrate the logic flow concerning the response of No, Not Congruent 13004 towards Prompt 13144. Subsequently, Stage 5600 occurs which submits a Diagnostic Log Unit (DLU) 1182 that contains the Official System Token 1184. This Token 1184 is included to indicate that the corresponding function or program has reached a non-ideal state if an official function within the UBEC Platform 100. The DLU 1182 is submitted to the Diagnostic Log Submission (DLS) 1160 module, which is invoked by LOM's 132 Automated Research Mechanism (ARM) 134 to supply the DLU 1182 to SPSI 130. Therefore SPSI 130 is able to process the diagnostic information found in the DLU 1160 with the Diagnostic Log Unit Analysis (DLUA) 8048 module. This leads to Stage 13005 which represents DLUA 8048 being invoked to perform corresponding modifications to I2GE 122 and/or NME 13090 to avoid the initial reason the No, Not Congruent 13004 response was invoked to Prompt 13144.

FIG. 1163 continues the logic flow of NME 13090 from Stage 13110 of FIG. 1146. Stage 13110 invokes LIZARD 120 to convert Neural State Association Knowledge 13108 into a Purpose Hierarchy Map 13112. At Stage 13162 LIZARD 120 is invoked to convert the Raw Neural Pattern 13094 into a Purpose Hierarchy Map 13164. At Stage 13168 LIZARD 120 is invoked to convert the Target Circumstantial State 13100 into a Purpose Hierarchy Map 13168. At Stage 13170, Purpose to Purpose Symmetry Processing (P2SP) 7000 is invoked to process Purpose Hierarchy Map 13112 and Purpose Hierarchy Map 13164, therefore producing the Symmetry Processing Result 13172. Prompt 13174 is then invoked to interpret the Symmetry Processing Result 13172, of which the logic flow is shown on FIG. 1168.

FIG. 1164 shows details concerning the operation of LIZARD 120 to convert the Raw Neural Pattern 13094 into a Purpose Hierarchy Map 13164. The Raw Neural Pattern 13094 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The Raw Neural Pattern 13094 is received in Neural Syntax 13095 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1165 continues the logic flow from FIG. 1164 to illustrate the operation of LIZARD 120 to convert the Raw Neural Pattern 13094 into a Purpose Hierarchy Map 13164. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 13164 which is presented as the Complex Purpose Format C325 version of the Raw Neural Pattern 13094. The same definition and application of Inner Core (IC) C333 applies for the aforementioned functions and modules.

FIG. 1166 shows details concerning the operation of LIZARD 120 to convert the Target Circumstantial State 13100 into a Purpose Hierarchy Map 13168. The Target Circumstantial State 13100 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The Target Circumstantial State 13100 is received in State Syntax 5624 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1167 continues the logic flow from FIG. 1166 to illustrate the operation of LIZARD 120 to convert the Target Circumstantial State 13100 into a Purpose Hierarchy Map 13168. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 13168 which is presented as the Complex Purpose Format C325 version of the Target Circumstantial State 13100. The same definition and application of Inner Core (IC) C333 applies for the aforementioned functions and modules.

FIG. 1168 continues the logic flow from FIG. 1163 at Prompt 13174 to illustrate the operation and functionality of Neuroeconomic Mapping Enhancement (NME) 13090. Prompt 13174 interprets the Symmetry Processing Result 13172 to determine if the Purpose Hierarchy Map 13164 of the Raw Neural Pattern 13094 is congruent and compatible with the Purpose Hierarchy Map 13112 of the Neural State Association Knowledge 13108. A response to Prompt 13174 of No, Not Congruent 13178 has it's logic flow shown on FIG. 1169. A Yes, Congruent 13176 response to Prompt 13174 leads to the activation of Stage 13180, which invokes the Neural State Association Lookup (NSAL) 13194 module to process the Raw Neural Pattern 13094 in order to produce the Claimed Circumstantial State 13182 of the Target Mind 12702. NSAL 13194 makes reference to Neural State Association Knowledge 13108 (which was produced from LOM 132) to interpret the Raw Neural Pattern 13094 and submit the perceived association implication that exists, as the Claimed Circumstantial State 13182. For example: according to Neural State Association Knowledge 13108, the composition of Raw Neural Pattern 13094 indicates with a strong degree of confidence that the Target Mind 12702 is currently stuck in traffic (thus represented in the Claimed Circumstantial State 13182). At Stage 13184, LIZARD 120 is invoked to convert the Claimed Circumstantial State 13182 into a Purpose Hierarchy Map 13186. At Stage 13188 the Purpose Hierarchy Maps 13186 and 13192 are processed by Purpose to Purpose Symmetry Processing (P2SP) 7000, with the subsequent logic flow shown at FIG. 1172.

FIG. 1169 continues the logic flow from FIGS. 1156 and 1162 to illustrate the logic flow concerning the response of No, Not Congruent 13178 towards Prompt 13174. Subsequently, Stage 5600 occurs which submits a Diagnostic Log Unit (DLU) 1182 that contains the Official System Token 1184. This Token 1184 is included to indicate that the corresponding function or program has reached a non-ideal state if an official function within the UBEC Platform 100. The DLU 1182 is submitted to the Diagnostic Log Submission (DLS) 1160 module, which is invoked by LOM's 132 Automated Research Mechanism (ARM) 134 to supply the DLU 1182 to SPSI 130. Therefore SPSI 130 is able to process the diagnostic information found in the DLU 1160 with the Diagnostic Log Unit Analysis (DLUA) 8048 module. This leads to Stage 13005 which represents DLUA 8048 being invoked to perform corresponding modifications to I2GE 122 and/or NME 13090 to avoid the initial reason the No, Not Congruent 13004 response was invoked to Prompt 13144.

FIG. 1170 shows details concerning the operation of LIZARD 120 to convert the Claimed Circumstantial State 13182 into a Purpose Hierarchy Map 13186. The Claimed Circumstantial State 13182 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The Claimed Circumstantial State 13182 is received in State Syntax 5624 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1171 continues the logic flow from FIG. 1170 to illustrate the operation of LIZARD 120 to convert the Claimed Circumstantial State 13182 into a Purpose Hierarchy Map 13186. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 13186 which is presented as the Complex Purpose Format C325 version of the Claimed Circumstantial State 13182. The same definition and application of Inner Core (IC) C333 applies for the aforementioned functions and modules.

FIG. 1172 shows the operation and functionality of Neuroeconomic Mapping Enhancement (NME) 13090, having resumed the logic flow from FIG. 1168. At Stage 13194, Purpose to Purpose Symmetry Processing 7000 (P2SP) is invoked to process the Purpose Hierarchy Map 13186 of the Claimed Circumstantial State 13182 and Purpose Hierarchy Map 13192 of the Target Circumstantial State 13100, therefore producing the Symmetry Processing Result 13196. At Prompt 13198 the Result 13196 is interpreted as to whether it interprets that Purpose Hierarchy Map 13186 is congruent and compatible with the Purpose Hierarchy Map 13192. The logic flow concerning the No, Not Congruent 13202 response is shown on FIG. 1174. If the response to Prompt 13198 is Yes, Congruent 13200, then Prompt 13204 is invoked which interprets if Target Circumstantial State Confidence 13102 is high or low. A High Confidence 13206 response to Prompt 13204 leads to the activation of Conclusion 13208, which states that corresponding sector of Neural State Association Knowledge 13108 is proven to indicate high confidence in association claims.

FIG. 1173 resumes the logic flow of FIG. 1172 from Prompt 13204 with a Yes, Congruent 13200 response. Upon the activation of Conclusion 13208, Stage 13210 is invoked to forward the evidence of high confidence to LOM 132 and CTMP 124, therefore affecting future iterations of Neural State Association Knowledge 13108 as retained in CKR 648. Therefore the gradual self-learning loop that invokes LOM 132 and CTMP 124 has come full circle. If the response to Prompt 13204 is Low Confidence 13212, then Stage 13214 is invoked which increases the Accuracy Confidence of the Target Circumstantial State 13100. Therefore at Stage 13216, the Target Circumstantial State 13100 is submitted to Target Behavior recording (TBR) 12704 with reference made to the Target Mind 12702. This causes the Personal Intelligence Profile (PIP) 136 instance that correlates with the Target Mind 12702 to record and retain new information concerning Target Circumstantial State 13110.

FIG. 1174 resumes the logic flow of FIG. 1172 from Prompt 13204 with a No, Not Congruent 13202 response. Prompt 13218 interprets if the value of Target Circumstantial State Confidence 13102 is High 13220 or Low 13222. A High Confidence 13220 response invokes Conclusion 13224, which defines that a new Raw Neural Pattern 13094 has been found for LOM 132 and CTMP 124 to learn. Conclusion 13224 leads to Stage 13226 which submits the Raw Neural Pattern 13094 along with the corresponding Target Circumstantial State 13100 variable to LOM 132 and CTMP 124, therefore affecting future iterations of Neural State Association Knowledge 13108 as retained in CKR 648. Therefore the gradual self-learning loop that invokes LOM 132 and CTMP 124 has come full circle. If the response to Prompt 13218 is Low Confidence 13222, then Stage 13228 is invoked which increases the Accuracy Confidence of the Target Circumstantial State 13100. Therefore at Stage 13216, the Target Circumstantial State 13100 is submitted to Target Behavior recording (TBR) 12704 with reference made to the Target Mind 12702. This causes the Personal Intelligence Profile (PIP) 136 instance that correlates with the Target Mind 12702 to record and retain new information concerning Target Circumstantial State 13110.

FIG. 1175 resumes the logic flow of FIG. 1172 from Prompt 13198. Whilst Responses 13200 and 13202 of Prompt 13198 each lead to their own independent paths of logic flow, Prompt 13198 spawns it's own Parallel Thread Invocation 13232 which is independent from the progress or completion status of the other two threads 13200 and 13202. The Parallel Thread Invocation 13232 leads to Prompt 13234 which evaluates if the Target Circumstantial State Confidence 13102 is high or low. If the response to Prompt 13234 is High Confidence 13236 then Stage 13238 is invoked. Stage 13238 invokes the Neural State Association Lookup (NSAL) 13194 modulate produce the Claimed Neural Pattern 13238 by referencing the Target Circumstantial State 13100 and the Neural State Association Knowledge 13108. Therefore Stage 13238 performs the inverse function of Stage 13180 from FIG. 1168. An example of the procedure within Stage 13238 is as such: the Target Circumstantial State 13100 defines that the Target Mind 12702 is currently stuck in traffic and late to work. Therefore the State 13100 and Neural State Association Knowledge 13108 are submitted to NSAL 13194 as modular input. Therefore NSAL 13194 produces the Claimed Neural Pattern 13238 which defines a best estimate representation of the current neural patterns existing in the Target Mind 12702 as they are experiencing Target Circumstantial State 13100. At Stage 13240 LIZARD 120 is invoked to convert the Claimed Neural Pattern into a Purpose Hierarchy Map 13242, as shown on FIG. 1178.

FIG. 1176 shows details concerning the operation of LIZARD 120 to convert the Claimed Neural Pattern 13238 into a Purpose Hierarchy Map 13242. The Claimed Neural Pattern 13238 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The Claimed Neural Pattern 13238 is received in Neural Syntax 13095 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1177 continues the logic flow from FIG. 1176 to illustrate the operation of LIZARD 120 to convert the Claimed Neural Pattern 13238 into a Purpose Hierarchy Map 13242. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 13242 which is presented as the Complex Purpose Format C325 version of the Claimed Neural Pattern 13238. The same definition and application of Inner Core (IC) C333 applies for the aforementioned functions and modules.

FIG. 1178 continues the operation and functionality of Neuroeconomic Mapping Enhancement (NME) 13090, resuming the logic flow at Stage 13240 from FIG. 1175. Stage 13240 invokes LIZARD 120 to convert the Claimed Neural Pattern 13238 into a Purpose Hierarchy Map 13242. Stage 13244 invokes Purpose to Purpose Symmetry (P2SP) 7000 to processes both Purpose Hierarchy Maps 13242 and 13164, therefore producing the Symmetry Processing Result 13246. Prompt 13248 interprets the Symmetry Processing Result 13246 to evaluate if Purpose Hierarchy Map 13248 is congruent and compatible with Purpose Hierarchy Map 13164. Both potential responses to Prompt 13248 are Yes, Congruent 13250 and No, Not Congruent 13252, the logic of which is shown on FIG. 1179.

FIG. 1179 continues the logic flow from FIG. 1178. Prompt 13248 interprets the Symmetry Processing Result 13246 which can lead to a Response 13250/13252. A logic flow for a No, Not Congruent 13252 response is evaluated on FIG. 1181. A Yes, Congruent 13250 response leads to the activation of Prompt 13254 which interprets the current value of the Neural State Association Knowledge Confidence 13106 value. A High Confidence 13256 response to Prompt 13254 activates Conclusion 13260 which indicates that the algorithmic confidence relating to the Target Circumstantial State 13100 and Neural State Association Knowledge 13108 has increased. Therefore Stage 13262 is invoked which forwards the new evidence of increased algorithmic confidence to LOM 132 and CTMP 124, therefore affecting future iterations of Neural State Association Knowledge 13108 as retained in CKR 648. Therefore the gradual self-learning loop that invokes LOM 132 and CTMP 124 has come full circle. The logic flow for a Low Confidence 13258 response is shown on FIG. 1180.

FIG. 1180 continues the logic flow from FIG. 1179 at Prompt 13254, displaying the operation concerning the Low Confidence 13258 response. Such a Response 13258 activates Conclusion 13264, which dictates that the Neural State Association Knowledge Confidence 13106 is strengthened/increased in accordance with the magnitude of the corresponding Target Circumstantial State Confidence 13102. Conclusion 13264 leads to Stage 13266, which forwards the corresponding evidence of increased algorithmic confidence to LOM 132 and CTMP 124, therefore affecting future iterations of Neural State Association Knowledge 13108 as retained in CKR 648. Therefore the gradual self-learning loop that invokes LOM 132 and CTMP 124 has come full circle.

FIG. 1181 continues the logic flow of NME 13090 at Prompt 13248 from FIG. 1179. The No, Not Congruent 13252 response activates Prompt 13268, which evaluates if the value of Neural State Association Knowledge Confidence 13106 is high or low. The logic flow concerning the Low Confidence 13272 response is shown on FIG. 1183. A High Confidence 13270 response leads to the activation of Prompt 13274, which compares the algorithmic confidence ranking between the values Neural State Association Knowledge Confidence 13106 and Target Circumstantial State Confidence 13102. The responses of Prompt 13274 are evaluated on FIG. 1182.

FIG. 1182 continues the logic flow of NME 13090 at Prompt 13274 from FIG. 1181. Prompt 13274 interprets if Neural State Association Knowledge Confidence 13106 or Target Circumstantial State Confidence 13102 is greater in algorithmic confidence. If the response to Prompt 13274 is Near State Association knowledge 13276, then Stage 13280 is invoked which marks Target Circumstantial State Confidence 13102 as less confident. If the response to Prompt 13274 is Target Circumstantial State, then Stage 13282 is invoked which marks Neural State Association Knowledge Confidence as less confident. Therefore this confidence algorithm seeks to find the stable frame of reference, in regards to algorithmic confidence, therefore punishing the weaker link with a decrease in confidence rating. Both potential Responses 13280 and 13282 lead to Stage 13284 being invoked, which forwards the corresponding evidence of increased algorithmic confidence to LOM 132 and CTMP 124, therefore affecting future iterations of Neural State Association Knowledge 13108 as retained in CKR 648. Therefore the gradual self-learning loop that invokes LOM 132 and CTMP 124 has come full circle.

FIG. 1183 continues the logic flow of NME 13090 at Prompt 13268 from FIG. 1181. Prompt 13268 interprets if Neural State Association Knowledge Confidence 13106 is a high or low value. The logic for the Low Confidence 13272 response is shown, which invokes Stage 13286 which marks the algorithmic confidence level of Neural State Association Knowledge Confidence 13106. Therefore Stage 13288 forwards the corresponding evidence of increased algorithmic confidence to LOM 132 and CTMP 124, therefore affecting future iterations of Neural State Association Knowledge 13108 as retained in CKR 648. Therefore the gradual self-learning loop that invokes LOM 132 and CTMP 124 has come full circle.

FIG. 1184 shows the operation and application of Log Aggregation within the Endowment Structure (ES) 12008. Log Aggregation is a jurisdiction of information management that is composed of two main modules: Management Console (MC) 1186 and Intelligent Information and Configuration Management (I2CM) 1188. All log information outputs are submitted as modular input to the Configuration and Deployment Service C153 of I2CM 1188. A Board of Directors (BD) 12018 instance or Independent Director (ID) 12020 instance interacts with the whole of Log Aggregation, this way Directors 12006/12022 are able to interact with various ES 12008 functions such as the Proposal Voting Interface (PVI) 12010 via MC 1186. The Configuration and Deployment Service C153 is an interface for deploying new enterprise assets (computers, laptops, mobile phones) with the correct security configuration and connectivity setup. After a device is added and setup, they can be tweaked via the MC 1186 with the Feedback Controls as a middleman. Service C153 also manages the deployment of new user accounts (like for UBEC Users 106). Such a deployment may include the association of hardware with user accounts, customization of interface (for different usage purposes), listing of customer/client variables (eg. Business type, product type etc). With Separation by Jurisdiction C154, the tagged pool of information is separated exclusively according to the relevant jurisdiction of the Management Console User. With Separation by Event 5572, the information is organized according to individual events. Every type of data is either correlated with an event, which add verbosity, or is removed. With Intelligent Contextualization C156 the remaining data now looks like a cluster of islands, each island being an event incident. Correlations are made interplatform to mature the event analysis. Historical data is accessed (from I2GE 122 as opposed to LIZARD 120) to understand event patterns, and CTMP 124 is used for critical thinking analysis. With Graphics Presentation/Visual Management 5570, ongoing and historical event incidents are presented without consideration for information source (which platform) despite that this information is available if needed. Direct Management C161 within MC 1186 implies direct access to specified controls by the relevant UBEC User 106. Therefore Direct Management C161 from MC 1186 connects with Manual Controls C160 of I2CM 1188. With Category and Jurisdiction C162, the UBEC User 106 authenticates via User Node Interaction (UNI) 470 which therefore defines their jurisdiction and scope of information category access.

FIGS. 1185-1189 illustrate usability examples of Self Programming Self Innovation (SPSI) 130 with regards to the operation of Appchains 836 and Legacy Programs on Legacy and BCHAIN 110 systems.

FIG. 1185 illustrates the concept of Self Programming Self Innovation (SPSI) 130, in addition to the Appchain Emulation Layer (AEL) 6058, programming and reconfiguring the old legacy application Methodology of Perpetual Giving (MPG) 113 into the new and improved Neuroeconomic Metaphysical Contentment (NMC) 13300 module. The entire operation occurs within a Legacy (non-BCHAIN Protocol 794 enabled) System 13304 and within the Legacy API and Framework 13306. Therefore SPSI 130 is an Appchain 836 that would normally be exclusively executed within the BCHAIN Network 110. Therefore SPSI 130 runs in the Legacy System 13304 via the Appchain Emulation Layer (AEL) 6058. Therefore AEL 6058 enables SPSI 130 to access and manipulate elements that exist and operate within the Legacy API and Framework 13306. At Stage 13308 SPSI 130 performs efficiency and functionality upgrades, maintenance, and general modifications to MPG 113. At Stage 13310 NMC 13300 is produced as a result of SPSI's 130 processing.

FIG. 1186 illustrates the concept of Self Programming Self Innovation (SPSI) 130, in addition to the Appchain Emulation Layer (AEL) 6058, improving the already existing iteration of NMC 13300 into a Future Theoretical Version of NMC 13316. The entire operation occurs within a Legacy (non-BCHAIN Protocol 794 enabled) System 13304 and within the Legacy API and Framework 13306. Therefore SPSI 130 is an Appchain 836 that would normally be exclusively executed within the BCHAIN Network 110. Therefore SPSI 130 runs in the Legacy System 13304 via the Appchain Emulation Layer (AEL) 6058. Therefore AEL 6058 enables SPSI 130 to access and manipulate elements that exist and operate within the Legacy API and Framework 13306. At Stage 13308 SPSI 130 performs efficiency and functionality upgrades, maintenance, and general modifications to MPG 113. At Stage 13314 Future NMC 13316 is produced as a result of SPSI's 130 processing.

FIG. 1187 illustrates the concept of Self Programming Self Innovation (SPSI) 130, in addition to the Appchain Emulation Layer (AEL) 6058, converting a legacy version of NMC 13300 into an Appchain 836 as NMC as an Appchain 114. The entire operation occurs within a Legacy (non-BCHAIN Protocol 794 enabled) System 13304 and within the Legacy API and Framework 13306. Therefore SPSI 130 is an Appchain 836 that would normally be exclusively executed within the BCHAIN Network 110. Therefore SPSI 130 runs in the Legacy System 13304 via the Appchain Emulation Layer (AEL) 6058. Therefore AEL 6058 enables SPSI 130 to access and manipulate elements that exist and operate within the Legacy API and Framework 13306. At Stage 13318 SPSI 130 converts NMC as a Legacy Program 13300 to NMC as an Appchain 114 via invocation of the Customchain Ecosystem Builder (CEB) 584. At Stage 13320 NMC as an Appchain is produced 114 as a result of SPSI's 130 operation processing. Therefore the final NMC as an Appchain 114 rendition operates from within AEL 6058.

FIG. 1188 illustrates the concept of Self Programming Self Innovation (SPSI) 130, in addition to the Appchain Emulation Layer (AEL) 6058, upgrading the efficiency and functionality of NMC as an Appchain 114 from within the Legacy System 13304. The initial NMC 114 version exists as an Appchain 836 within the Appchain Emulation Layer (AEL) 6058. At Stage 13324 SPSI 130 performs efficiency and functionality upgrades, maintenance and general modifications to NMC 114. This leads to Stage 13326, which defines the production by SPSI 130 of the Future Theoretical Version of NMC 13328 as an Appchain 836. Therefore Appchains 836 can directly run within Legacy Systems 13304 and even be upgraded from within Legacy Systems 13304.

FIG. 1189 illustrates the concept of Self Programming Self Innovation (SPSI) 130 upgrading the efficiency and functionality of NMC as an Appchain 114 from within the BCHAIN Network 110. The initial NMC 114 version exists as an Appchain 836 within the BCHAIN Protocol 794. At Stage 13332 SPSI 130 performs efficiency and functionality upgrades, maintenance and general modifications to NMC 114. This leads to Stage 13334, which defines the production by SPSI 130 of the Future Theoretical Version of NMC 13328 as an Appchain 836. Therefore Appchains 836 can directly run within the BCHAIN Network 110 and even be upgraded from within the BCHAIN Network 110.

FIG. 1190 shows an overview of the various sub-modules that operate within Self Programming Self Innovation (SPSI) 130. Automated Appchain Refinement (A2R) 8040 inspects Appchains 836 and Legacy Programs to improve the efficiency of their routines, and to improve their usability and reliability. Automated Appchain Maintenance (A2M) 8042 maintains the selected Appchain 836 or Legacy Program by deleting Expired Caches 8725, upgrading Depreciated Functions 8726 to Usable Functions, upgrading Depreciated Modules and Dependencies 8727 with usable Modules, deleting Expired Points of Reference 8728 (missing content etc.), and performing Economical Stability Calibration 8729. Appchain Security Hardening (ASH) 8044 automatically inspects points of intrusion and exploit in an Appchain 836 or Legacy Program. Appchain Regulatory Compliance (ARC) 8046 ensures that the selected Appchain 836 or Legacy Program is in compliance with various and specific regulations (e.g. compliance to REST API etc.). The Diagnostic Log Unit Analysis (DLUA) 8048 receives Diagnostic Log Units (DLU) from malfunctioning routines and enacts the appropriate provisions to attempt to fix such perceived malfunctions. Innate Error Correction (IEC) 8050 attempts to fix fundamental procedure flaws that can lead to a halted routine. IEC 8050 is highlighted to indicate that it is used as a use case in the following figures in relation to NMC 13300. New Appchain Development (NAD) 8052 finds uses for Applications within a specified Application ecosystem (like the UBEC Platform 100) that has a potential Application feature missing, which would perceivably benefit such an ecosystem. Enhanced Framework Development (EFD) 8054 inspects and potentially improves existing software frameworks (such as programming languages) for both the UBEC Platform 100/BCHAIN Network 110 and Legacy Systems. The Enhanced Hardware Development (EHD) 8056 modifies physical systems that contain Dynamic Liquid Conductive Boards (DLCB) 8856 and therefore can have their core hardware structure optimized and upgraded. The Appchain Targeting Mechanism (ATM) 8038 processing an intelligent selection algorithm that informs other modules for which Appchain 836 they should select in their processing. ATM 8038 informs modules A2R 8040, A2M 8042, ASH 8044, ARC 8046, DLUA 8048, and IEC 8050. Other modules have their own innate selection mechanism which differs in logic to ATM 8038.

FIGS. 1191-1224 show the operation and functionality of Innate Error Correction (IEC) 8050, which is a submodule of Self Programming Self Innovation (SPSI) 130 that attempts to fix fundamental procedure flaws that can lead to a halted routine.

FIG. 1191 shows the operation and functionality of Innate Error Correction (IEC) 8050, which is a sub-module of SPSI 130. The Appchain Targeting Mechanism (ATM) 8038 selects a specified Target Appchain 6060 which is then submitted as modular input to an invoked Execution Stream Collection (ESC) 6700 instance. The Execution Stream that is produced as modular output from the ESC 6700 instance is submitted as modular input to Stage 8170 of IEC 8050. Stage 8170 separates the Execution Stream of the Appchain 836 to produce the Code Structure Blueprint 8172. At Stage 8174, each Selected Code Unit 8188 that exists within the Code Structure Blueprint 8174 is cycled through a programming Loop. Therefore at Stage 8178 LIZARD 120 is invoked to produce a Purpose Hierarchy Map 8180 from the Selected Code Unit. At Stage 8176 LIZARD 120 is invoked to produce a Purpose Hierarchy Map 8182 of the entire Code Structure Blueprint 8176. Therefore both Purpose Hierarchy Maps 8180 and 8182 are submitted as modular input to the Purpose to Purpose Symmetry Processing (P2SP) 7000 module. Upon completion of P2SP's 7000 processing, Symmetry Processing Result 8184 is produced as the modular output.

Therefore Stage 8186 is executed which performs an internal consistency by interpreting the Symmetry Processing Result 8184 to evaluate if each of the Selected Code Unit's Purpose Hierarchy Map 8180 aligns with the greater purpose (Purpose Hierarchy Map 8182) of the entire Code Structure Blueprint 8172.

FIG. 1192 shows details concerning the operation of LIZARD 120 to convert the Selected Code Unit 8188 into a Purpose Hierarchy Map 8180. The Selected Code Unit 8188 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The Selected Code Unit 8188 is received in Fulfilled Execution Stream 8189 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1193 continues the logic flow from FIG. 1192 to illustrate the operation of LIZARD 120 to convert the Selected Code Unit 8188 into a Purpose Hierarchy Map 8180. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 13242 which is presented as the Complex Purpose Format C325 version of the Claimed Neural Pattern 13238. The same definition and application of Inner Core (IC) C333 applies for the aforementioned functions and modules.

FIG. 1194 shows details concerning the operation of LIZARD 120 to convert the Code Structure Blueprint 8172 into a Purpose Hierarchy Map 8182. The Code Structure Blueprint 8172 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The Code Structure Blueprint 8172 is received in Multiple Execution Streams 5626 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1195 continues the logic flow from FIG. 1194 to illustrate the operation of LIZARD 120 to convert the Code Structure Blueprint 8172 into a Purpose Hierarchy Map 8182. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 8182 which is presented as the Complex Purpose Format C325 version of the Code Structure Blueprint 8172. The same definition and application of Inner Core (IC) C333 applies for the aforementioned functions and modules.

FIG. 1196 expands on the operational details of Stage 8170 from Innate Error Correction (IEC) 8050. Stage 8170 separates the Execution Stream 556 of the Target Appchain 6060. Therefore once Execution Stream Collection (ESC) has submitted the Execution Stream 556 as modular input to Stage 8170 of IEC 8050, the Stream 556 is submitted as modular input to Stage 8190. Stage 8190 invokes Execution Stream Rendering 6400 to interpret and build all the relevant dependences from supplement Appchains 836, therefore producing the Fulfilled Execution Stream 8192. The Stream 8192 is submitted as modular input to Stage 8194, which loops through each Fulfilled Execution Segment 551 of the Fulfilled Execution Stream 8192/556.

FIG. 1197 continues the logic flow of Stage 8170 of Innate Error Correction (IEC) 8050. The Fulfilled Execution Stream 8192 is submitted as modular input to Stage 8194, which initiates the Loop from FIG. 1196. At Stage 8196 the selected Fulfilled Execution Segment 551 is isolated and stored in the Code Unit Buffer Pool (CUBP) 8198 whilst retaining (with metadata) it's relational context from within the Fulfilled Execution Stream 556. Prompt 8202 interprets if there are any unprocessed Fulfilled Execution Segments 551 left in the Loop that was initiated at Stage 8194. If the response to Prompt 8202 is Yes 8204, then Stage 8206 is activated which advanced the Loop from Stage 8194 to the next available Fulfilled Execution Segment 551. If the response to Prompt 8202 is No 8208, then Stage 8200 is activated which invoked LIZARD 120 to cover the entire contents of CUBP 8198 into a Purpose Hierarchy Map 8210.

FIG. 1198 shows details concerning the operation of LIZARD 120 to convert the Code Unit Buffer Pool (CUBP) 8198 into a Purpose Hierarchy Map 8210. The CUBP 8198 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The CUBP 8198 is received in Execution Segments 5628 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1199 continues the logic flow from FIG. 1197 to illustrate the operation of LIZARD 120 to convert the Code Unit Buffer Pool (CUBP) 8198 into a Purpose Hierarchy Map 8210. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 8210 which is presented as the Complex Purpose Format C325 version of the CUBP 8198. The same definition and application of Inner Core (IC) C333 applies for the aforementioned functions and modules.

FIG. 1200 continues the logic flow of Innate Error Correction (IEC) 8050. The Code Unit Buffer Pool (CUBP) 8198 is processed in a Loop (of each potential Code Unit) at Stage 8212. The Purpose Hierarchy Map 8210 of the entire Code Unit Buffer Pool (CUBP) 8198 and the Purpose Hierarchy Map 8214 of the Selected Code Unit 8188 is submitted to Purpose to Purpose Symmetry Processing (P2SP) 7000, therefore producing the Symmetry Processing Result 8216. Stage 8218 performs an internal consistency check to evaluate if the Selected Code Unit's 8188 Purpose Hierarchy Map 8214 aligns with the greater purpose (Purpose Hierarchy Map 8210) of the entire Code Structure contained in CUBP 8189. Therefore at Stage 8220 any misaligned Code Units 8188 that do not have a purpose that aligns with the entire Code Structure (from CUBP 8198) are flagged. Therefore Stage 8220 submits it's modular output to Misaligned Code Unit Purpose Retention (MCUPR) 8222. At Stage 8224 each Misaligned Code Unit Purpose is iterated in a new Loop to derive a suitable purpose for each Unit that conforms with the Purpose Hierarchy Map 8182 of the Code Structure Blueprint 8172. The process of deriving a suitable purpose in Stage 8224 is processed by Suitable Purpose Replacement (SPR) 8252.

FIG. 1201 elaborates on operational details concerning Stages 8218 and 8220 of IEC 8050. The modular output of the corresponding Purpose to Purpose Symmetry Processing (P2SP) 7000 instance is Symmetry Processing Result 8216. The result is submitted as modular input to Stage 8288 of the Symmetry Processing Result Validation (SPRV) 8226 module. Stage 8228 separates each Alignment Integration Detection (AID) 7040 instance (spawned from within the P2SP 7000 internal logic) result stored in the Symmetry Processing Result 8216. Thereafter Stage 8230 invokes a Loop for each AID 7040 instance result. Within the Loop Prompt 8232 interprets if the selected AID 7040 result is considered misaligned according to the Symmetry Processing Result 8232. If the response to Prompt 8232 is that it is not misaligned, then Stage 8234 is activated which advances the Loop to the next AID 7040 result. If the response to Prompt 8232 is Yes, Misaligned 8236 then Stage 8238 is activated which outputs the selected AID 7040 result as a Code Unit as modular output for SPRV 8226. Such output is submitted to Stage 8222 which flags the misaligned Code Unit by storing it in Misaligned Code Unit Purpose Retention (MCUPR) 8224. Therefore execution of the PSRV 8226 module flags any misaligned Code Units by validating the Symmetry Processing Result 8216.

FIG. 1202 continues the logic flow of IEC 8050 from Stage 8224. Stage 8224 loops through each Misaligned Code Unit Purpose and derives a suitable purpose via invocation of Suitable Purpose Replacement (SPR) 8252 that conforms with the Purpose Hierarchy Map 8182 of the Code Structure Blueprint 8172. At Stage 8240 LIZARD 120 is invoked to convert the Purpose Replacements produced by the corresponding SPR 8252 instance into Execution Segments 551. This leads the activation of Stage 8242, which associates each Syntax Replacement Unit with it's relevant place in the Code Structure Blueprint 8172. Thereafter at Stage 8244 a Deployment Patch 6270 is created via invocation of the Deployment Patch Assembly (DPA) 6260 module. Such a Patch 6270 contains the Syntax Replacement Units and instructions for what part of the original Appchain 836 they are to replace.

FIG. 1203 continues the logic flow of IEC 8050 from Stage 8240, which invokes LIZARD 120 to convert Purpose Replacements into Execution Segments 551 therefore producing and submitting results to Syntax Replacement Unit Retention (SRUR) 8246. Stage 8242 associates each Syntax Replacement Unit with it's corresponding place in the Code Structure Blueprint 8172. Stage 8242 accomplishes this my invoking the Unit Blueprint Lookup (UBL) 8248 module. The UBL 8248 module produces it's output to the Code Structure Streamline Processing (CSSP) 8250 module, which arranges the input data into an Upgraded Appchain 6262 output. Therefore CSSP 8250 invokes Stage 8244 which creates a Deployment Patch which contains the Syntax Replacement Units and instructions for what part of the Appchain 836 they will replace.

FIG. 1204 shows the operation and functionality of the Suitable Purpose Replacement (SPR) 8252 module with regards to the invocation of Stage 8224 as part of the internal logic of the Innate Error Correction (IEC) 8050 module. The Misaligned Code Unit Purpose Retention (MCUPR) 8224 module is submitted as modular input to Stage 8254 of SPR 8252. Stage 8254 initiates a Loop through each Misaligned Code Unit Purpose from MCUPR 8224. At Stage 8256 LOM 132 is invoked to produce a Purpose Replacement 8258, for the Selected Misaligned Code Unit, which is congruent and compatible with the Code Structure Blueprint 8260. Therefore the Code Structure Blueprint 8172 is eventually modified to contain the Purpose Replacements 8258, therefore forming the more accurate Blueprint 8260. The individual Purpose Replacement 8258 within the Loop invoked by Stage 8254 is submitted to Stage 8240 to be processed by LIZARD 120. At Stage 8240 LIZARD 120 is invoked to convert the Purpose Replacements into Execution Segments 556.

FIG. 1205 shows the internal operation procedure of LOM 132 and CTMP 124 in regards to Stage 8256 of Suitable Purpose Replacement (SPR) 8252. The Code Structure Blueprint 8260, Misaligned Code Unit 8264, and Compliance Design Principles 8262 are supplied as initial input to the Replacement Invocation Prompt (RIP) 8266. RIP 8266 produces a Prompt 8268 that interacts directly with LOM 132 to invoke the production of the Purpose Replacement 8258 with consideration of the input criteria Code Structure Blueprint 8260, Misaligned Code Unit 8264, and Compliance Design Principles 8262. The Prompt 8268 produced by RIP 8266 is submitted to the Initial Query Reasoning (IQR) C802A module of LOM 132. When LOM 132 is invoked directly within the UBEC Platform 100 by an UBEC User 106, IQR C802A receives the initial question/assertion provided by the UBEC User 106. However this instance of LOM 132 is automatically invoked by RIP 8266 instead. The provided Prompt 8268 is analyzed via invocation of Central Knowledge Retention (CKR) 648 to decipher Missing Details from the Prompt 8268 that are crucial to complete the correct ‘virtual understanding’ by LOM 132 for LOM 132 to fully address/respond to the Prompt 8268. The resultant Missing Details produced by IQR C802A are submitted as modular input to Survey Clarification (SC) C803A. SC C803A engages with the origin of the Prompt 8268 to retrieve supplemental information so that the Prompt 8268 can be analyzed objectively and with all the necessary context. When LOM 132 is invoked directly within the UBEC Platform 100 by an UBEC User 106, SC C803A engages with that User 106 as the origination of the question/answer. However this instance of LOM 132 is automatically invoked by RIP 8266 instead, therefore SC C803A engages with RIP 8266 to retrieve supplemental information concerning the Prompt 8268. The fully formed and refined version of the Prompt 8268 is produced from SC C803A and submitted as modular input to Assertion Construction (AC) C808A. AC C808A attempts to form a coherent response to the Prompt 8268 by referencing CKR 648 directly and also via Hierarchical Mapping (HM) C807A. Rational Appeal (RA) C811A is a container module that houses a logic flow interface with CTMP 124. RA C811A uses CTMP 124 to criticize assertions. Such criticisms can be in the form of self-criticisms (by criticizing the output of AC C808A), or external criticisms to the origin of the question/assertion processed by IQR C802A (UBEC User 106 or RIP 8266). If an assertion produced from AC C808A fails a significant measure of the self-criticism test processed by RA C811A; then a new instance of AC C808A is invoked to account for any valid criticisms. If a high confidence assertion is produced by AC C808A that consistently passes self-criticism tests processed by RA C811A; then the assertion is produced as LOM's 132 modular output, referenced as the Ideal Investment Decision Makeup 12404 in context of the initial Prompt 8268 provided by RIP 8266.

FIG. 1206 shows more detail of the internal operation procedure of Rational Appeal (RA) C811A of LOM 132 in regards to Stage 12402 of CSE 12400. Assertion Construction (AC) C808A provides a Response Presentation C843 to Rational Appeal (RA) C811A concerning the assertion produced by AC C808A in regards to the corresponding input Prompt 8268. At this stage of the logic flow, the produced assertion is classified as a Pre-Criticized Decision C847. This indicates that it is has yet to be processed via criticism by CTMP 124. Therefore the produced assertion is directly submitted to the CTMP 124 instance as a ‘Subjective Opinion’ C848 input, and also to Context Construction (CC) C817A which provides the ‘Objective Fact’ C850 input to the CTMP 124 instance. CC C817A references metadata from AC C808A and potential evidence provided via RIP 8266 to submit raw facts to CTMP 124 for critical thinking. Such input metadata is represented by the LOM Log Aggregate 5502 file. The LOM Log Aggregate 5502 contains a collection of relevant log files that are produced from the primary operating functions of LOM 132. After the CTMP 124 instance concludes it's operation, a Post-Criticized Decision C851 is produced as modular output. The initial Pre-Criticized Decision C847 and Post-Criticized Decision C851 are submitted to the Decision Comparison (DC) C818A module which determines the scope of potential overlap between the two inputs C847 and C851. The unified output provided by DC 818A can either indicate CTMP's 124 Concession C852 (of incorrectness) on behalf of the AC C808A produced assertion, or a perceived Improvement C853 on behalf of the AC C808A produced assertion. Both Argument Responses C852 and C853 can be classified as either Low Confidence Results C845 or High Confidence Results C846. A Low Confidence Result C845 indicates that the original assertion produced by AC C808A is flawed and should be reconstructed; therefore the logic flow continues to a new instance of AC C808A. A High Confidence Result C846 indicates that the original assertion produced by AC C808A has merit, therefore the drawn conclusions (coupled with any corresponding evidence, premises etc.) are submitted to Knowledge Validation (KV) C805A. Therefore the logic flow continues to a new instance of KV C805A so that CKR 846 and hence LOM 132 can benefit from the recently processed assertion.

FIG. 1207 continues the logic flow of Stage 12402 from CSE 12400 to illustrate the production of the LOM Log Aggregate 5502 file. Modular outputs produced from Initial Query Reasoning (IQR) C802A, Survey Clarification (SC) C803A, Assertion Construction (AC) C808A, Hierarchical Mapping (HM) C807A and Knowledge Validation (KV) C805A are submitted to the LOM Modular Log Collection (LMLC) 5500 module. Therefore LMLC 5500 combines the input log data into a single readable file referenced as LOM Log Aggregate 5502. The File 5502 encompasses the overall operational state of the corresponding LOM 132 instance, hence providing information as to how the LOM 132 instance reached various conclusions. The LOM Log Aggregate 5502 is submitted to CC C817A of Rational Appeal (RA) C811A.

FIG. 1208 expands on operational details concerning FIG. 1206 to illustrate the internal operation of CTMP 124 in regards to the input and output channels defined in Rational Appeal (RA) C811A. The Pre-Criticized Decision C847 is Presented C843 as modular output from Assertion Construction (AC) C808A. The Decision C847 is then marked as a Subjective Opinion C848, therefore fulfilling one of the two major inputs of CTMP 124. The Subjective Opinion C848 is submitted to Input System Metadata C484, which acts as the primary modular input for CTMP 124 and an internal representation of the Selected Pattern Matching Algorithm (SPMA). For this instance configuration; the SPMA is LOM 132. Input System Metadata C484 is submitted for processing to Reason Processing C456 and to Raw Perception Production (RP²) C465. Reason Processing C456 will logically understand the assertions being made by comparing property attributes. RP² C465 parses the Input System Metadata C484 from LOM 132 to produce a perception in Perception Complex Format (PCF) that represents the algorithmic perception of LOM 132. Such a produced Perception is submitted to the Perception Observer Emulator (POE) C475 which emulates the algorithmic perception of LOM 132. Reason Processing C456 invokes Rule Processing which eventually produces rulesets that reflect the SPMA algorithm which in this instance is LOM 132. Therefore two modes of ‘thinking’ are executed, ‘analogue’ perception and ‘digital’ ruleset processing. These two Branches C461 and C475 represent similitudes with intuition and logic. The results produced by both thinking Branches C461 and C475 are transferred to Critical Decision Output (CDO) C462, which evaluates any fundamental elements of conflict or corroboration between the results. Upon finding a high magnitude of internal corroboration, and a low magnitude of internal conflict CTMP 124 provides a binary Approve or Block decision, in regards to the initial input Subjective Opinion C848, that is referenced as a High Confidence Result C846. If there is a low magnitude of internal corroboration and a high magnitude of internal conflict CTMP 124 submits a ‘vote of no confidence’ which is referenced as a Low Confidence Result C845. Therefore the resultant output of CTMP 124 is considered the Post-Criticized Decision C851.

FIG. 1209 shows more details concerning the invocation of Raw Perception Production (RP²) C465 within CTMP 124. LOM 132 produces the Purpose Replacement 8258 by invoking Assertion Construction (AC) C808A. The Purpose Replacement 8258 is then submitted to Stage 5506 of RP² C465 which unpacks the data to produce instances of a Debugging Trace C485 and Algorithm Trace C486 within the Input System Metadata C484 which originates from the corresponding AC C808A instance. Debugging Trace C485 is a coding level trace that provides variables, functions, methods and classes that are used along with their corresponding input and out variable type and content. The full function call chain (function trace: functions calling other functions) is provided. The Algorithm Trace C486 is a software level trace that provides security data coupled with algorithm analysis. The resultant security decision (approve/block) is provided along with a logistics trail of how it reached the Decision C847. The appropriate weight concerning each factor that contributed to producing the Decision C847 is included. Thereafter RP² C465 transfers the data concerning the produced perception result to Perception Observer Emulator (POE) C475 for processing.

FIG. 1210 elaborates on the operation of Raw Perception Production (RP²) C465 from within CTMP 124. Initially Stage 5506 occurs, as it does on FIG. 1209, to unpack the data to produce instances of a Debugging Trace C485 and Algorithm Trace C486 within the Input System Metadata C484 which originates from the corresponding AC C808A instance. At Stage 5508, Metric Processing C489 reverse engineers the variables from LOM 132 to extract perceptions from the artificial intelligence exhibited by LOM 132. Thereafter Input System Metadata C484 is processed by Stage 5510, which separates Metadata C484 into meaningful security cause-effect relationships via System Metadata Separation (SMS) C487. As also indicated by FIG. 1209, RP² C465 transfers the data concerning the produced perception result to Perception Observer Emulator (POE) C475 for processing.

FIG. 1211 elaborates on the operation of Perception Observer Emulator (POE) C475, include it's and Raw Perception Production's (RP²) C465 relation to Perception Storage (PS) C478. The operation of Metric Processing C489 and System Metadata Separation (SMS) C487 both lead to the production of Perceptions 5512/5514/5516 that are thereafter stored in PS C478. The resulting Perceptions 5512/5514/5516 represent LOM's 132 modular response of producing the Purpose Replacement 8258 via Assertion Construction (AC) C808A. RP² C465 produces a Comparable Variable Format datapoint which is fed into Storage Search (SS) C480 as search criteria. Thereafter SS C480 performs a lookup of PS C478 to find matches with already existing Perceptions stored in PS C478. The Results C716 of the execution SS C480 are produced which leads to a Weight Calculation C718. Such a Calculation C718 attempts to find the correct distribution of corresponding Perceptions from PS C478 to replicate and match the Comparable Variable Format which represent's the execution of the LOM 132 algorithm that produced Purpose Replacement 8258.

FIG. 1212 continues the Perception Observer Emulator (POE) C475 logic from FIG. 1211. After the production of Results C716 from Storage Search (SS) C480, the Weight Calculation C718 completes to lead to the Application C729 of the Perceptions 5512/5514/5516 to make an active Approve C731 or Block C730 decision. The Purpose Replacement 8258 produced by LOM 132 and corresponding LOM Log Aggregate 5502 undergo Data Parsing C724 which causes Data Enhanced Logs C723 to be derived which are applied in the Application C729 to achieve an Interpretation Dichotomy 5518 of a Positive Sentiment (Approve) C731 or Negative Sentiment (Block) C730 with regards to the input Purpose Replacement 8258. Upon successful conclusion of the execution of Application C729 leads to an Override Corrective Action C476 which is processed by Critical Decision Output (CDO) C462 in parallel to the modular output of Rule Execution (RE) C461. The Self-Critical Knowledge Density (SCKD) C474 module estimates the scope and type of potential unknown knowledge that is beyond the reach of the reportable LOM Log Aggregate 5502.

This way the subsequent critical thinking features of the processing CTMP 124 instance can leverage the potential scope of all involved knowledge, known and unknown directly by the instance.

FIG. 1213 shows the Memory Web C460 process that operates in parallel to the execution of Perception Observer Emulator (POE) C475 in FIG. 1211. The Purpose Replacement 8258 produced by LOM 132 is submitted as modular input to Reason Processing C456. Reason Processing C456 processes how LOM 132 achieved the decision to produce the Purpose Replacement 8258 in response to the Prompt 8268 provided by RIP 8266. The processing conclusion of Reason Processing C456 is the execution of Reason Processing C457, which defines the rules that are thirdly consistent with LOM's 132 execution behavior. If any inconsistencies are found in rule behavior with regards to LOM's 132 execution behavior, then currently existing rules are modified or new rules are added. Such rules are later used within the CTMP 124 instance to criticize decision making behaviors found within the corresponding LOM 132 instance. Critical Rule Scope Extender (CRSE) C458 then leverages known Perceptions to expand the ‘critical thinking’ scope of the rulesets, in effect enhancing the rulesets to produce Correct Rules C459. The Correct Rules C459 are then submitted as modular input to Rule Syntax Format Separation (RSFS) C499 from within the operating jurisdiction of Memory Web C460. RSFS C499 separates and organizes Correct Rules C459 by type. Therefore all actions, properties, conditions and objects are listed separately after RSFS C499 processing. This enables the CTMP 124 instance to discern what parts have been found in the Chaotic Field, and what parts have not. Chaotic Field Parsing (CFP) C535 combines and formats the LOM Log Aggregate 5502 into a single scannable unit referenced as the Chaotic Field. The Chaotic Field is submitted as modular input to Memory Recognition (MR) C501. MR C501 also receives the Original Rules C555 which is the execution result from RSFS C499. MR C501 scans the Chaotic Field provided by CFP C535 to recognize knowable concepts defined in Original Rules C555. This MR C501 instance execution produces Recognized Rule Segments C556. Thereafter Rule Fulfillment Parser (RFP) C498 receives individual parts of the Original Rules C555 that have been tagged according to their recognition or lack-thereof within the Chaotic Field by MR C501. RFP C498 can then logically deduce which whole ruleset (the combination of all of their parts) have been sufficiently recognized in the Chaotic Field to merit processing by Rule Execution (RE) C461. Upon successful conclusion of the execution of RE C461 leads to an Override Corrective Action C476 which is processed by Critical Decision Output (CDO) C462 in parallel to the modular output of Perception Observer Emulator (POE) C475.

FIG. 1214 elaborates on the logic flow interaction between Perception Storage (PS) C478 and the Automated Perception Discovery Mechanism (APDM) C467. PS C478 contains four subsets of Perceptions: Deduced Unknown Angles of Perception C473, All Angles of Perception C472, Implied Angles of Perception C471, and Applied Angles of Perception C470. Applied Angles of Perception C470 are Perceptions that have been directly imported by studying algorithmic behavior of the Selected Pattern Matching Algorithm (SPMA), which in this instance is LOM 132. Implied Angles of Perception C471 are Perceptions that have been derived from Applied Angles of Perception C470 via modular execution of Implication Derivation (ID) C477 and APDM C467. All Angles of Perception C472 represents the entire scope of known Perceptions to the CTMP 124 instance that have not been included by Applied Angles of Perception C470 and Implied Angles of Perception C471. Deduced Unknown Angles of Perception C473 represents the scope of Perceptions that is expected to exist yet the CTMP 124 instance has yet to discover according to the Self-Critical Knowledge Density (SCKD) C474 module. ID C477 analyzes the individual metrics of Applied Angles of Perception C470 to deterministically derive Implied Angles of Perception C470, whilst APDM C467 creatively varies compositions of Angles of Perception C650 via the Creativity Module 112 to produce a New Iteration C653 that combines the initial two input Weights C652. Therefore all of the Angles of Perception C650 involved with APDM C467 processing correspond with and represent the Purpose Replacement 8258 that is produced by LOM's 132 Assertion Construction (AC) C808A module.

FIG. 1215 elaborates on the operational details concerning the Critical Rule Scope Extender (CRSE) C458 of CTMP 124. A Rational Appeal (RA) C811A instance operates within LOM 132 and invokes Context Construction (CC) C817A to process the LOM Log Aggregate 5502 to Chaotic Field Parsing (CFP) C535. CFP produces a Chaotic Field from the modular output of CC C817A which is referenced by Memory Recognition (MR) C501. Current Rules C534 exhibits rulesets that are indicative of the current functioning state of the Selected Pattern Matching Algorithm (SPMA) which in this instance is LOM 132. Current Rules C534 is submitted as modular input to the Rule Syntax Derivation (RSD) C504 module, which is where logical ‘black and white’ rules are converted to metric based perceptions. Therefore the complex arrangement of multiple rules are converted into a single uniform perception that is expressed via multiple metrics of varying gradients. The modular output of RSD C504 is provided as modular input to Perception Matching (PM) C503. At PM C503; a Comparable Variable Format (CVF) unit is formed from the Perception received from RSD C504. The newly formed CVF is used to lookup relevant Perceptions in the Perception Storage (PS) C478 with similar indexes. The potential matches are submitted as modular input to Rule Syntax Generation (RSG) C505. RSG C505 receives previously confirmed perceptions which are stored in Perception format and accesses the Perception's internal metric makeup. The Perceptions are received from PS C478 which contains Previously Confirmed Perceptions C468. Such gradient-based measures of metrics are converted to binary and logical rulesets that emulate the input/output information flow of the original perception. Therefore RSG C505 produces Perceptive Rules C537 which are Perceptions that are considered relevant, popular and have been converted into logical rules. If a Perception (in it's original Perception Format) had many complex metric relationships that defined many ‘grey areas’, the ‘black and white’ local rules encompass such ‘grey’ areas by expanding on the ruleset complexity. Therefore the Perceptive Rules C537 are stored by a collection of Rule Syntax Format (RSF) definitions. Perceptive Rules C537 are submitted as modular input to Memory Recognition (MR) C501, where they are scanned against the Chaotic Field which was produced by CFP C535. Therefore MR C501 produces Extra Rules C536 which complete Correct Rules C533 in their validity.

FIG. 1216 elaborates on the operational details concerning Implication Derivation (ID) C477 of CTMP 124. The Applied Angles of Perception C470 from Perception Storage (PS) C478 are submitted as modular input to ID C477 to produce more Perceptions that belong to Implied Angles of Perception C471. The Applied Angles of Perception C470 are specifically sent to Metric Combination C493 of ID C477. Metric Combination C493 separates the received Angles of Perception C650 into categories of metrics: Scope C739, Type C740, Consistency C741, Intensity C742. The Metric availability and reference within the system is not necessarily limited to these four types. The input Angles of Perception C650 are related to the Purpose Replacement 8258 that was produced by LOM's 132 Assertion Construction (AC) C808A module. The Metric Complexity Set A C736 is submitted as modular input to Metric Expansion (ME) C495. With ME C495 the metrics of multiple and varying Angles of Perception C650 are stored categorically in individual databases C739/C740/C741/C742. ME C495 enhances the current batch of received metrics with details/complexity extracted from previously known/encountered metrics. Upon enhancement and complexity enrichment completion, the metrics are returned as ME C495 modular output as Metric Complexity Set B C737 and thereafter converted back into Angles of Perception C650 to be stored in Implied Angles of Perception C471 as illustrated on FIG. 1217.

FIG. 1217 continues the logic flow of Implication Derivation (ID) C477 from FIG. 1216, illustrating the Metric Complexity Set B C737 being processed by Metric Conversion C494 which reverses individual metrics back into whole Angles of Perception C650. Despite the enrichment and conversion process performed by ID C477, the resultant Angles of Perception C650 still provide a reasonably accurate representation of the Purpose Replacement 8258 produced by LOM's 132 Assertion Construction (AC) C808A module. Therefore the Metric Conversion C494 process submits the newly derived/implied Angles of Perception C650 to Implied Angles of Perception C471 within Perception Storage (PS) C478.

FIG. 1218 elaborates on the operational details concerning Critical Decision Output (CDO) C462 of CTMP 124. CDO C462 receives modular output from both major branches of CTMP 124: Perception Observer Emulator (POE) C475 (as the intuition branch) and Rule Execution (RE) C461 (as the logical branch). Each Branch C475/461 submits it's respective Critical Decision C521 (the main modular output) as well as corresponding the ‘Meta-metadata’ C521, which provides contextual variables that justify why the initial critical decision was reached. Both Decision Sets C521 that represent the Perceptions C516 of POE C475 and the Fulfilled Rules C517 of RE C461 are submitted to the Metadata Categorization Module (MCM) C488. MCM C488 separates the Debugging and Algorithm Traces into distinct categories using traditional syntax based information categorization. Such categories can then be used to organize and produce distinct security responses with a correlation to security risks and subjects. The Intuitive Decision C514, which represents Perceptions C526 from POE C475, and the Thinking Decision C515, which represents Fulfilled Rules C517 from RE C461 are submitted by MCM C488 to the Internal Processing Logic 5520 of Direction Decision Comparison (DDC) C512. The Internal Processing Logic 5520 of DDC C512 checks for corroboration or conflict between the Intuitive Decision C514 and the Thinking Decision C515 DDC C512 references a ‘cutoff’ variable from Static Hardcoded Policy (SHP) 488. If the ‘cutoff’ variable is not reached for similarity between the Intuitive Decision C514 and the Thinking Decision C515 (i.e. 90%+), then the Cancel Direct Comparison 5524 directive occurs, which might lead the Terminal Output Control (TOC) C513 to eventually submit a Vote of No Confidence 5544 as shown on FIG. 1219. The Cancel Direct Comparison 5524 stage implies that CTMP 124 was unable to act internally consistent in regards to the input Prompt 8268 from RIP 8266. If the ‘cutoff’ variable was sufficiently met according to the Internal Processing Logic 5520, then the Final Decision Output 5522 stage is invoked which combines both Decisions C514/C515 into a single modular output which is received and processed by TOC C513.

FIG. 1219 continues the logic flow of Critical Decision Output (CDO) C462 from FIG. 1218 and elaborates on the operational details of Terminal Output Control (TOC) C513. TOC C513 initiates with Prompt 5526, which checks if Direct Decision Comparison (DDC) C512 was able to provide a Final Decision Output 5522 (instead of the Cancel Direct Comparison 5524 directive). If the response to Prompt 5526 is Yes 5528, then the combined final decision provided by DDC C512 at Final Decision Output 552 is submitted as modular output of TOC C513 and hence as modular output of the entire CTMP 124 instance as the Final Critical Decision 5542 output. If the response to Prompt 5526 is No 5530, then Stage 5532 is invoked which it itself invokes the execution of Perception Matching (PM) 5532 and fetches the corresponding results. Fulfilled Rules C517 are extracted from the Critical Decision+Meta-metadata C521 of Rule Execution (RE) C461. The Rules C517 are converted to Perceptions by Rule Syntax Derivation (RSD) C504. PM 5532 then references Meta-metadata to determine, at Prompt 5534, if there was a strong internal overlap and corroboration of Perceptions used. If the response to Prompt 5534 is Yes 5538 this indicates a Vote of No Confidence 5544 on behalf on CTMP 124 as modular output. If the response to Prompt 5534 is No 5536 then Stage 5540 is activated, which selects the perceived least risky decision between the Intuitive Decision C514 and Thinking Decision C515. Therefore the Final Critical Decision 5542 is subsequently submitted as modular output to CDO C462, TOC C513, and CTMP 124. The logic at Stage 5534 occurs to determine if the lack of unity between the Intuitive Decision C514 and Thinking Decision C515 occurs because of a general lack of algorithmic confidence, or due to highly opposing points of view between the two. Therefore if the latter were to occur, a potential Final Critical Decision 5542 is still discernible as modular output. A Vote of No Confidence 5544 always leads to the Low Confidence Result C845 logic pathway within Rational Appeal (RA) C811A. The Final Critical Decision 5542 can either lead to a High Confidence Result C846 or Low Confidence Result C845 logic pathway within RA C811A, depending on the algorithmic confidence behind the Final Critical Decision 5542.

FIG. 1220 shows details concerning the operation of LIZARD 120 to convert the Purpose Replacement 8258 into Execution Segments 8270. The Purpose Replacement 8258 exists in Complex Purpose Format C325 and is submitted to Iterative Expansion C327 of the Purpose Module C36 within the Outer Core (OC) C329 of LIZARD 120. Iterative Expansion C327 adds detail and complexity to evolve a simple goal (indirectly defined within the Purpose Replacement 8258) into a specific complex purpose definition. Therefore the maximum Purpose Association C326 potential of the input is realized, and retained as a Complex Purpose Format C325, before it is submitted to Logical Derivation C320 of the Syntax Module (SM) C35. The Core Code C335 element of Inner Core (IC) C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1221 continues the logic flow from FIG. 1220 to illustrate the operation of LIZARD 120 to convert the Purpose Replacement 8258 into Execution Segments 8270. The input data is received in Complex Purpose Format C325 from the Purpose Module (PM) C36 and is transferred to Logical Derivation C320 of the Syntax Module (SM) C35. Logic Derivation C320 derives logically necessary functions from initially simpler functions. This means that if a function can be formed as a derivative function due to implication from a simpler parent function; then it is formed by Logical Derivation C320. The produced result is a tree of function dependencies that are built according to the defined Complex Purpose Format C325 data. Logical Derivation C320 operates according to the Rules and Syntax C322 definitions which are inherited from the Core Code C335 element of Inner Core (IC) C333. Logical Derivation C320 submits it's output to Code Translation C321. Code Translation C321 converts arbitrary (generic) code which is recognized and understood by SM C35 to any known and chosen computation language. Code Translation C321 also performs the inverse function of translating known computation languages into arbitrary syntax types. Therefore PM C36 invokes SM C35 to produce the resultant Execution Segments 8270 version of the input Purpose Replacement 8258 via Code Translation C321. The resultant Execution Segments 8270 that is terminally produced by Code Translation C321 is the modular output of SM C35, Outer Core (OC) C329, and LIZARD 120. The Execution Segments 8270 are then stored in Syntax Replacement Unit Retention (SRUR) 8246.

FIG. 1222 elaborates on the operation and functionality of the Unit Blueprint Lookup (UBL) 8248 module in regards to Stage 8242 of Innate Error Correction (IEC) 8050. Stage 8286 receives modular input from Syntax Replacement Unit Retention (SRUR) 8246, therefore initiated a Loop that cycles through all the Syntax Replacement Units 8288 form SRUR 8246. Stage 8284 retrieves the selected Syntax Replacement Unit 8288 from SRUR. The Associated Code Unit ID 8292 is unpacked from the Syntax Replacement Unit 8288 at Stage 8290. On a separate, parallel thread within the same instance of UBL 8248 the Code Structure Blueprint 8260 is submitted as modular input to Stage 8280. Stage 8280 install the Code Structure Blueprint 8260 into the New Code Structure Blueprint Retention (NCSBR) 8282.

FIG. 1223 continues the logic flow from FIG. 1222 concerning the Unit Blueprint Lookup (UBL) 8248 invocation from within the internal logic of Stage 8242. The logic flow resumes from FIG. 1222 at Stage 8294, which installs the selected Syntax Replacement Unit 8288 into New Code Structure Blueprint Retention (NCSBR) 8282. Stage 8296 is invoked once the iterative processing Loop invoked from Stage 8286 is completed. Stage 8296 reverses the Fulfilled status of the Execution Segments 551 via Code Structure Streamline Processing (CSSP) 8250. Therefore CSSP 8250 produces the Upgraded Appchain 6262 as modular output.

FIG. 1224 continues the logic flow of Innate Error Correction (IEC) 8050 from the invocation of CSSP 8250 at FIG. 1223. CSSP 8250 produces the Upgraded Appchain 6262, which represents the original syntactical structure but with the Misaligned Code Units replaced with Suitable Purpose Replacements. The Upgraded Appchain 6262 is submitted to Deployment Patch Assembly (DPA) 6260 to produce the Appchain Correction Patch 6270. The Target Appchain 6060 is processed by Execution Stream Collection (ESC) 6700, therefore submitting the original Execution Stream 556 to the DPA 6260 instance. This enables DPA 6260 to have access to the Target Appchain 6060 in it's original form. Because DPA 6260 has access to the differential between the Original 6060 and Upgraded Appchain 6262, it is able to produce the Appchain Correction Patch 6270 which contains the instructions to convert the Original Appchain 6060 to the Upgraded Appchain 6262. At Stage 8298 the Appchain Correction Patch 6270 is deployed to Customchain Ecosystem Builder (CEB) 584, which manipulates the Target Appchain 6060 so that it converts in content to the Upgraded Appchain 6262.

FIGS. 1225-1242 show the operation and functionality of the Appchain Emulation Layer (AEL) 8058 within context of usage and applicability concerning the Neuroeconomic Metaphysical Contentment (NMC) module. AEL 8058 enables Appchains 836 to be executed in Legacy Environments that do not participate in the BCHAIN Network 110.

FIG. 1225 shows the Neuroeconomic Metaphysical Contentment (NMC) 13300 module being installed in a Precompiled Application Stack (PAS) 9400 instance via Static Appchain Processing (SAP) 9480. SAP 9480 interprets the Appchain 836 contents of NMC 13300, therefore producing Static Appchain Retention 9402 and submitting it as modular input to PAS 9400. The Application Emulation Layer (AEL) 8058 is compiled and embedded into PAS 9400, therefore giving the PAS 9400 instance autonomy within Legacy Systems. A submodule of AEL 8058 is Target System Interpretation and Detection (TSID) 9404. Therefore if this PAS 9400 were to be invoked on an arbitrary system, AEL 8058 would execute in a preliminarily basic instruction-set and seek to detect the Operating System 9408, Device Drivers 9410 and Hardware 9412 of the Target System 9406. Therefore AEL 8058 would invoke the adequate translation mechanism to run complex code on the Target System 9406, therefore enabling the Static Appchain Retention 9402 to be fully executed. The Retention 9402 contains the Appchain 836 Execution Segments 551 and Data 553 Segments for NMC 13300, along with other Appchains 836 NMC 13300 depends on for operation, such as LOM 132 and LIZARD 120.

FIG. 1226 shows the operation and functionality of the Appchain Emulation Layer (AEL) 8058. Static Appchain Processing (SAP) 9480 produces a Static Appchain Retention 9402 instance that contains the NMC 13300 Appchain 836. The Static Appchain Retention 9402 is submitted as modular input to the Execution and Data Segment Extraction (EDSE) 9430 module of AEL 8058. EDSE 9430 is a container module for the invocation of Execution Stream Collection (ESC) 6700 at Stage 9432, and for the invocation of Data Stream Sorting (DSS) 6800 at Stage 9434. The Target System 9406 is interpreted by the Target System Interpretation and Detection (TSID) 9404 module via consideration of the static Target System Library Collection 9442. The Collection 9442 defines the appropriate Instruction Sets 9444 that are applicable to various System 9406 types. Therefore TSID 9404 produces the Target System Instruction Set 9444 which enables the internal operation of AEL 8058 to submit the correct computational instructions to the Target System 9406. Execution Segment Translation (EST) 9436 is invoked from Stage 9432 to interpret the Target System Instruction Set 9444 which therefore translates the Appchain 836 Syntax into the appropriate legacy instructions. Data Segment Translation (DST) 9438 is invoked from Stage 9434 to interpret the Target System Instruction Set 9444 which therefore therefore translates the Appchain 836 Syntax into the appropriate legacy segments of data. The modular outputs of EST 9436 and DST 9438 are both submitted to Legacy Instruction Unification (LIU) 9440, which invokes a live instance of Execution Stream Rendering (ESR) 6400 to render the Static Appchain Retention 9402 according to the defined Target System Instruction Set 9444. Any attempts to manipulate elements outside of the AEL's 8058 jurisdiction and within the Target System 9408 (like writing a file to the legacy file system of the Target System 9406) are handled by the External Instruction Middleware (EIM) 9450. Therefore the modular output of LIU 9440 is a Deployable Instruction Stream 9446 which is understood and executed by the Target System 9406 and implies the practical manifestation of the Static Appchain Retention's 9402 execution, therefore implying the execution of the NMC 13300 Appchain 836 on a legacy system.

FIG. 1227 shows the operation and functionality of the External Instruction Middleware (EIM) 9450. The operation of the Static Appchain Retention 9402 within the Execution Stream Rendering (ESR) 6400 instance of the Legacy Instruction Unification (LIU) 9440 module causes LIU 9440 to produce the External Instruction Proposition 9452 and the Instruction Isolation Readiness 9454 index as modular output. Such Outputs 9452 and 9454 are submitted as modular input to EIM 9450, therefore Output 9452 is received at Stage 9456. Stage 9458 invokes LIZARD 120 to convert the External Instruction Proposition 9452 into a Purpose Hierarchy Map 9462. Thereafter Stage 9466 is executed which invokes the Purpose Realignment Processing (PRP) 7050 module for modular inputs Instruction Purpose Collection 9460 and Purpose Hierarchy Map 9462. Master/Slave Affinity 1480 defines the Instruction Purpose Collection 9460 as the slave. Therefore PRP 7050 produces the new iteration of the Instruction Purpose Collection 9464 as modular output. At Stage 9468 LIU is invoked to produce Instruction Isolation Readiness 9454 via the Need Map Matching (NMM) C114 sub-module of LIZARD 120. The applicability of Instruction Isolation Readiness 9454 is illustrated on FIG. 1230.

FIG. 1228 shows details concerning the operation of LIZARD 120 to convert the External Instruction Proposition 9452 into a Purpose Hierarchy Map 9462. The External Instruction Proposition 9452 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The External Instruction Proposition 9452 is received in ESR Instruction/Command Syntax 5630 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1229 continues the logic flow from FIG. 1228 to illustrate the operation of LIZARD 120 to convert the External Instruction Proposition 9452 into a Purpose Hierarchy Map 9462. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 9462 which is presented as the Complex Purpose Format C325 version of the External Instruction Proposition 9452. The same definition and application of Inner Core (IC) C333 applies for the aforementioned functions and modules.

FIG. 1230 continues the logic flow of External Instruction Middleware (EIM) 9450 from FIG. 1227 at Stage 9468, which invokes Legacy Instruction Unification (LIU) 9440 to produce the Instruction Isolation Readiness 9454 variable. The Readiness 9454 variable defines if the Instruction Purpose Collection 9460 is isolated enough within the Target System 9406 to be executed without interference of alternate execution syntaxes. Therefore Prompt 9470 is activated which evaluates if the Instruction Isolation Readiness 9454 variable indicates that the Instruction Purpose Collection 9470 can be deployed to the Target System 9406 yet. If the response to Prompt 9470 is Deployment Not Ready 9474, then Stage 9478 is activated which suspends execution of EIM 9450 until the next External Instruction Proposition 9464 is produced by Executed Stream Rendering (ESR) 6400 via Legacy Instruction Unification (LIU) 9440. If the response to Prompt 9470 is Deployment Ready 9472, then Stage 9476 invokes LIZARD 120 to convert the Instruction Purpose Collection 9464 to the corresponding Syntax defined by Target System Interpretation and Detection (TSID) 9404. Therefore Stage 9476 produces a Deployable Instruction Stream 9446 which is modular output for EIM 9450 and is executed natively within the Target System 9406.

FIG. 1231 shows the operation and functionality of Need Map Matching (NMM) C114 operating as a submodule of LIZARD's 120 Dynamic Shell C198. The NMM C114 instance is spawned to serve the operation of Stage 9468 of the Legacy Instruction Unification (LIU) 9440 module. The Target System Interpretation and Detection (TSID) 9404 is submitted for storage in Need Access and Development and Storage 5550. Therefore the TSID 9404 is broken down into sub-categories and retained in Storage 5550 as a series of hierarchal branches and layers. Upon the modular invocation of NMM C114, Initial Parsing C148 downloads each jurisdiction branch from Storage 5550 to temporarily retain for referencing within the ongoing NMM C114 instance. With Calculate Branch Needs C149: according to definitions associated with each branch, needs are associated with their corresponding department. This way, permission checks can be formed within the NMM C114 instance. For example: NMM C114 approved the request for the Human Resources department to download all employee CVs, because it was requested within the zone of the annual review of employee performance according to their capabilities. Therefore it was proven to be a valid need of the department jurisdiction. Therefore Need Index C145 is the main storage of Jurisdiction Branches and their respective needs. Because this internal reference is a resource bottleneck for the operation of NMM C114 and therefore all the modules it serves, it is pre-optimized for quick database querying to increase the overall efficiency of the system. Stage 9468 provides an Input Purpose C139 as modular input to the Search Algorithm C144 of NMM C114. The Search Algorithm C144 references and searches through the compiled Need Index C145, therefore determining if the Input Purpose C139 defines a valid need according to the jurisdiction branches initially defined in Need Access Development and Storage 5550. Therefore the completed execution of the Search Algorithm C144 via the Need Index C145 produces an Approve/Block C146 response which is submitted as modular output from NMM C114 and referenced as the Need Result C141. Therefore the Need Result C141 is returned back to the internal logic of External Instruction Middleware (EIM) 9450 as the Instruction Isolation Readiness 9454 variable.

FIG. 1232 shows details concerning the operation of LIZARD 120 to convert the Instruction Purpose Collection 9462 into a Deployable Instruction Stream 9446. The Instruction Purpose Collection 9462 exists in Complex Purpose Format C325 and is submitted to Iterative Expansion C327 of the Purpose Module C36 within the Outer Core (OC) C329 of LIZARD 120. Iterative Expansion C327 adds detail and complexity to evolve a simple goal (indirectly defined within the Purpose Replacement 8258) into a specific complex purpose definition. Therefore the maximum Purpose Association C326 potential of the input is realized, and retained as a Complex Purpose Format C325, before it is submitted to Logical Derivation C320 of the Syntax Module (SM) C35. The Core Code C335 element of Inner Core (IC) C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1233 continues the logic flow from FIG. 1232 to illustrate the operation of LIZARD 120 to convert the Instruction Purpose Collection 9462 into a Deployable Instruction Stream 9446. The input data is received in Complex Purpose Format C325 from the Purpose Module (PM) C36 and is transferred to Logical Derivation C320 of the Syntax Module (SM) C35. Logic Derivation C320 derives logically necessary functions from initially simpler functions. This means that if a function can be formed as a derivative function due to implication from a simpler parent function; then it is formed by Logical Derivation C320. The produced result is a tree of function dependencies that are built according to the defined Complex Purpose Format C325 data. Logical Derivation C320 operates according to the Rules and Syntax C322 definitions which are inherited from the Core Code C335 element of Inner Core (IC) C333 and the Target System Library Collection 9442 via the Target System Interpretation Detection (TSID). Logical Derivation C320 submits it's output to Code Translation C321. Code Translation C321 converts arbitrary (generic) code which is recognized and understood by SM C35 to any known and chosen computation language. Code Translation C321 also performs the inverse function of translating known computation languages into arbitrary syntax types. Therefore PM C36 invokes SM C35 to produce the resultant Execution Segments 8270 version of the input Purpose Replacement 8258 via Code Translation C321. The resultant Execution Segments 8270 that is terminally produced by Code Translation C321 is the modular output of SM C35, Outer Core (OC) C329, and LIZARD 120. The Execution Segments 8270 are then stored in Syntax Replacement Unit Retention (SRUR) 8246.

FIG. 1234 shows the operation and functionality of Static Appchain Processing (SAP) 9480, which converts live and active Appchains 836 into a deployable Static Appchain Retention 9402. Execution of SAP 9480 is typically manually invoked, by an UBEC 106 or Generic 5068 User and via an Administrative Interface 9482. At Stage 9482 a Proposed Appchain Collection 9488 is produced from the Administrative Interface 9482, therefore defining the scope of Appchain(s) 836 the UBEC User 106/Generic User 5068 wants to include in the final modular output Static Appchain Retention 9402. At Stage 9484 Execution and Data Segment Collections 6902/6904 are produced from the references of the Proposed Appchain Collection 9484. At Stage 9486 the Proposed Appchain Collection 9488 is processed by a spawned Execution Stream Rendering (ESR) 6400 instance from within the Modified Catch Environment (MCE) 6174. MCE 6174 is a custom execution environment that installs trigger points for various events, so that way dependency and debugging information can be derived from the execution session. Thereafter the Dependency Request Fulfillment (DRF) 6176 module is invoked within the SAP 9480 instance in conjunction with the MCE 6174 instance. At Stage 9490 an Execution or Data Request is made by the ESR 6400 instance. Prompt 9492 evaluates the Execution 6902 and Data 6904 Segment Collections to determine if the Execution or Data Request made by ESR 6400 exists in such Collections 6902/6904. If the response to Prompt 9492 is Does Exist 9494, then Prompt 9498 is invoked which evaluates if the corresponding Execution or Data Segment (from ESR 6400) is justified according to the Need Map Matching (NMM) C114 submodule from LIZARD 120. The response of Does Not Exist 9496 for Prompt 9492 is evaluated on FIG. 1238.

FIG. 1235 elaborates on the operational details concerning Stage 9498 of the Static Appchain Processing (SAP) 9480 module. The Proposed Appchain Collection 9488 is submitted as modular input to Stage 9500, which separates the Collection 9500 into independent Appchain 836 References that are subsequently stored in Appchain Reference Cache Retention (ARCR) 9502. Stage 9504 spawns a Loop that cycles through all of the Appchain 836 Instances within ARCR 9502. Stage 9508 retrieves the selected Appchain Instance 9506 from a relevant Cache Node 786 from the BCHAIN Network 110 and via the BCHAIN Protocol 794. Therefore Stage 9508 (which is detailed on FIG. 1236) produces the Fulfilled Appchain Instance 9510, which is processed at Stage 9512 via invocations of Execution Stream Collection (ESC) 6700 and Data Stream Sorting (DSS) 6800. ESC 6700 produces an Execution Stream 9514 which is submitted as modular input to Stage 9518, and DSS 6800 produces a Data Stream 9516 which is also submitted as modular input to Stage 9518. Therefore Stage 9518 collects the various Execution 9514 and Data 9516 Streams into Execution Segment Collection 6902 and Data Segment Collection 6904. Stage 9519 is subsequently processed which advances the Loop initiated by Stage 9504 to the next available Appchain Instance 9506.

FIG. 1236 elaborates on the operational details concerning Stage 9508 of the Static Appchain Processing (SAP) 9480 module. Stage 9508 invokes the BCHAIN Protocol 794 function Content Claim Generator (CCG) 3050. Therefore a Content Claim Request (CCR) 2308 with a Proposed Baseline Hop Pathways (PBHP) 2322 is produced. The CCR 2308 is submitted on the BCHAIN Network 110 so that it eventually reached a corresponding Cache Node 3260 that contains parts of the requested Appchain Instance 9506 (in this case it being the NMC 13300 Appchain 836). The Cache Node 6526 fulfills the CCR 2322, thereby getting eventually compensated economically via BCHAIN Protocol 794 and by leveraging the Watt Economy of the Metachain 834. The Cache Node 6526 produces a corresponding Content Claim Fulfillment (CCF) 2318 unit in response to the corresponding CCR 2308. The newly produced CCF 2318 travels along the BCHAIN Network 110 to reach the Content Claim Rendering (CCR) 3300 module of the Node 786 that is processing the SAP 9480 instance. Content Decoding Instructions 3316 are referenced to render the CCF 2318 response, which therefore produces the Fulfilled Appchain Instance 9510. Therefore the Execution 551 and Data Segments 553 of the NMC 13300 Appchain 836 have been retrieved.

FIG. 1237 elaborates on the logic flow of the Dependency Request Fulfillment (DRF) 6176 submodule within the Static Appchain Processing (SAP) 9480 instance, therefore resuming from FIG. 1234. The Does Exist 9494 response to Prompt 9492 invokes Stage 9498 which checks if the corresponding Execution or Data Segment is Justified 9520 according to NMM C114. If the Justified 9520 response to Prompt 9498 occurs, then Stage 9524 is invoked which marks the Execution or Data segment for inclusion in the Marked Segment Cache Retention (MSCR) 8652. The logic flow for the Not Justified 9522 response to Prompt 9498 is shown on FIG. 1238. The conclusion of Stage 9524 implies the conclusion of the DARF 6176 instance processing. Therefore after Stage 9524, Stage 9526 is invoked which associates the Fulfilled Appchain Instance 9510 with it's corresponding Marked Segments that are found in MSCR 8652. Stage 9508 retrieves the Selected Appchain Instance 9506 from a relevant Cache Node 786 via the BCHAIN Protocol 794, therefore producing the Fulfilled Appchain Instance 9510, as illustrated on FIG. 1236.

FIG. 1238 elaborates on the logic flow of the Dependency Request Fulfillment (DRF) 6176 submodule within the Static Appchain Processing (SAP) 9480 instance with regards to Stage 9486 of the Modified Catch Environment (MCE) 6174. The Does Not Exist 9496 response to Prompt 9492, and the Not Justified 9522 response to Prompt 9498 both lead to the activation of Stage 5600, which generates and submits a Diagnostic Log Unit (DLU) 1182 that contains an Official System Token 1184. This Token 1184 is included to indicate that the corresponding function or program has reached a non-ideal state if an official function within the UBEC Platform 100. The DLU 1182 is submitted to the Diagnostic Log Submission (DLS) 1160 module, which is invoked by LOM's 132 Automated Research Mechanism (ARM) 134 to supply the DLU 1182 to SPSI 130. Therefore SPSI 130 is able to process the diagnostic information found in the DLU 1160 with the Diagnostic Log Unit Analysis (DLUA) 8048 module. This leads to Stage 13005 which represents DLUA 8048 being invoked to perform corresponding modifications to I2GE 122 and/or MCE 6174 to avoid the initial reason the specified responses were invoked for Prompts 9492 and 9498. The Justified 9520 response to Prompt 9498 invokes Thread Blocking Management (TBM) 6240 for the Execution Stream Rendering (ESR) 6400 instance that is being emulated in I2GE 122. Therefore TBM 6240 allows the I2GE 122 evolutionary variance process to continue whilst the original thread of DRF 6176 is being processed. This is done to achieve operational efficiency.

FIG. 1239 shows the operation and functionality of Need Map Matching (NMM) C114 operating as a submodule of LIZARD's 120 Dynamic Shell C198. The NMM C114 instance is spawned to serve the operation of Stage 9528 of the Data Request Fulfillment (DRF) 6176 module from the Static Appchain Processing (SAP) 9480. The Execution Segment Collection 6902 and Data Segment Collection 6904 are submitted for storage in Need Access and Development and Storage 5550. Therefore the Collections 6902/6904 are broken down into sub-categories and retained in Storage 5550 as a series of hierarchal branches and layers. Upon the modular invocation of NMM C114, Initial Parsing C148 downloads each jurisdiction branch from Storage 5550 to temporarily retain for referencing within the ongoing NMM C114 instance. With Calculate Branch Needs C149: according to definitions associated with each branch, needs are associated with their corresponding department. This way, permission checks can be formed within the NMM C114 instance. For example: NMM C114 approved the request for the Human Resources department to download all employee CVs, because it was requested within the zone of the annual review of employee performance according to their capabilities. Therefore it was proven to be a valid need of the department jurisdiction. Therefore Need Index C145 is the main storage of Jurisdiction Branches and their respective needs. Because this internal reference is a resource bottleneck for the operation of NMM C114 and therefore all the modules it serves, it is pre-optimized for quick database querying to increase the overall efficiency of the system. Stage 9530 provides an Input Purpose C139 as modular input to the Search Algorithm C144 of NMM C114. The Search Algorithm C144 references and searches through the compiled Need Index C145, therefore determining if the Input Purpose C139 defines a valid need according to the jurisdiction branches initially defined in Need Access Development and Storage 5550. Therefore the completed execution of the Search Algorithm C144 via the Need Index C145 produces an Approve/Block C146 response which is submitted as modular output from NMM C114 and referenced as the Need Result C141. Therefore the Need Result C141 is returned back to the Stage 9498 of DRF 6176 and SAP 9480.

FIG. 1240 shows details concerning the operation of LIZARD 120 to convert Execution 9532 and Data 9534 Requests, from the Execution Stream Rendering (ESR) 6400 instance of the Modified Catch Environment (MCE) 6174, into a Purpose Hierarchy Map 9536. The External Instruction Proposition 9452 is submitted to the Syntax Module (SM) C35 which belongs to the jurisdiction of the Outer Core (OC) C329. SM C35 provides a framework for reading and writing computer code. For code writing; it receives Complex Purpose Format C325 from the Purpose Module (PM) C36. The Complex Purpose Format C325 is then written in arbitrary code syntax, also known as ‘pseudocode’. Pseudocode contains basic implementations of the computation operations that are most common amongst all programming languages such as if/else statements, while loops etc. Thereafter a helper function converts the pseudocode into real executable code depending on the desired target computation syntax (computer language). For code reading; SM C35 provides a syntactical interpretation of computer code for PM C36 to derive a purpose for the functionality of such code. The External Instruction Proposition 9452 is received in ESR Instruction/Command Syntax 5630 format by Code Translation C321. Code Translation C321 converts arbitrary (generic) code which is recognized and understood by SM C35 to any known and chosen computation language. Code Translation C321 also performs the inverse function of translating known computation languages into arbitrary syntax types. The output of the completed execution of Code Translation C321 is transferred as input to Logical Reduction C323. Logical Reduction C323 reduces code logic to simpler forms to produce a map of interconnected functions in accordance with the definitions of Rules and Syntax C322. Therefore upon the completed execution of Logical Reduction C323 the execution of the corresponding SM C35 instance is complete and the modular output of SM C35 is sent to Iterative Interpretation C328 of the Purpose Module (PM) C36. PM C36 uses SM C35 to derive a purpose in Complex Purpose Format C325 from computer code. Such a purpose definition adequately describes the intended functionality of the relevant code section as interpreted by SM C35. The PM C36 is also able to detect code fragments that are covertly submerged within data (binary/ASCII etc). Iterative Interpretation C328 loops through all interconnected functions to produce an interpreted purpose definition (in Complex Purpose Format C325) by referring to Purpose Associations C326. The Inner Core (IC) C333 is the area of LIZARD 120 that does not undergo automated maintenance/self programming and is directly and exclusively programmed by experts in the relevant field. The Core Code C335 element of IC C333 contains Fundamental Frameworks and Libraries, Thread Management and Load Balancing scripts, Communication and Encryption protocols, and Memory Management systems. Therefore Core Code C335 enables general operation and functionality to SM C35 and PM C36 by providing standardized libraries and scripts which enable basic functionality. The System Objectives C336 element of IC C333 defines Security Policy and Enterprise Goals. These definitions operate as static policy variables to guide various dynamic and static functions within LIZARD 120.

FIG. 1241 continues the logic flow from FIG. 1240 to illustrate the operation of LIZARD 120 to convert Execution 9532 and Data 9534 Requests into a Purpose Hierarchy Map 9536. Logical Reduction C323 from the Syntax Module (SM) C35 submits it's output to Iterative Interpretation C328 from the Purpose Module (PM) C36. Iterative Interpretation C328 loops through all interconnected functions to produce an interpreted purpose definition by referring to Purpose Associations C326. The purpose definition output exists in Complex Purpose Format C325, which is submitted as modular output for PM C36, and therefore the Outer Core (OC) C329, and therefore LIZARD 120. The output is labeled as a Purpose Hierarchy Map 9536 which is presented as the Complex Purpose Format C325 version of the Execution 9532 and Data 9534 Requests. The same definition and application of Inner Core (IC) C333 applies for the aforementioned functions and modules.

FIG. 1242 shows a final overview of the macro aspects of Static Appchain Processing's (SAP) 9480 processing. SAP 9480 is manually invoked by an UBEC User 106 or Generic User 5068 via an Administrative Interface 9482. Stage 9482 receives a Proposed Appchain Collection 9488 as modular input, which in this example contains references to the NMC 13300 Appchain 836. A Loop is initiated at Stage 9504 which cycles through all of the Appchain Instances 9506 from Appchain Reference Cache Retention (ARCR) 9502. At Stage 9538 the Fulfilled Appchain Instance 9510 is retrieved from Marked Segment Cache Retention (MSCR) 8652, therefore leading to Stage 9540. Fulfilled Appchain Instances 9510 contain the full set of Execution 551 and Data 553 Segments required to execute the chosen Appchain 836 (like NMC 13300 in this case), including any modular dependencies such as the full Appchain 836 for LOM 132, CTMP 124, and LIZARD 120. Stage 9540 incrementally installs all of the Fulfilled Appchain Instances into the Static Appchain Retention 9402, which each outgoing Execution 551 or Data 553 Segment being verified for having Marked status by MSCR 8652. Therefore Static Appchain Retention 9402 is produced as the final modular output of SAP 9480, and is thereafter submitted as modular input to the Execution and Data Segment Extraction (EDSE) 9430 module of the Appchain Emulation Layer (AEL) 8058.

1. A Universal BCHAIN Everyone/Everything/Everywhere Connections (UBEC) system comprising:
a) UBEC applications that operate in accordance with the BCHAIN Protocol;
b) BCHAIN network that comprises a plurality of BCHAIN Nodes, which operate software in accordance with the BCHAIN Protocol;
c) Appchains, which comprise data storing, serving and computational programs that operate directly upon the BCHAIN Network;
d) Legislated UBEC Independent Governing Intelligence (LUIGI) that comprise an artificially intelligent control mechanism in a UBEC Platform,
wherein in the paradigm of Node interaction that exists within the BCHAIN Network, the Metachain is a Customchain which contains metadata that all nodes on the BCHAIN Network connect to for essential and primary referencing, wherein the Metachain tracks fundamental information which contains node/sector locations, content demand tendencies and hop routing to streamline the infrastructure setup, wherein it is required for every single BCHAIN Node to participate in reading the Metachain, wherein Appchains are Customchains which act as advanced smart contracts for delivering information via the infrastructure that has been organized by the Metachain, wherein Appchains can reference each other for input/output in parallel and nested Customchain Ecosystem, wherein Microchains are Appchains that are automatically converted to a Customchain that does not depend nor connect to the Metachain.

2. The system of claim 1, wherein in BCHAIN Protocol, Queued Information Broadcast (QIB) manages Content claim Requests (CCRs) or Content claim Fulfillment (CCFs) that are due for broadcasting to other nodes, wherein packets of information CCR and CCF are forwarded to Communications Gateway (CG) which is the exclusive layer of interface between the BCHAIN Protocol (BP) and the Node's Hardware Interface, wherein CG forwards information concerning surrounding Nodes to Node Statistical Survey (NSS), wherein NSS tracks surrounding Node behavior which causes the formation of four indexes to be calculated: Node Escape Index, Node Saturation Index, Node Consistency Index, Node Overlap Index, wherein the Node Escape Index tracks the likelihood that a Node neighbor will escape a Perceiving Node's vicinity, wherein the Node Saturation Index tracks the amount of Nodes in a Perceiving Node's range of detection, wherein the Node Consistency Index tracks the quality of Nodes services as interpreted by a Perceiving Node, wherein the Node Overlap Index tracks the amount of overlap Nodes have with one another as interpreted by a Perceiving Node, wherein the Perceiving Node is the one that executes the instance of NSS.

3. The system of claim 2, wherein the resultant four variables are sent to Strategy Corroboration System (SCS), which enforces Protocol consensus amongst the Nodes, wherein Dynamic Strategy Adaptation (DSA) receives the NSS variables to dynamically alter the Strategy Deployment which are based off of the calculated Strategy Criteria Composition, wherein the Strategy Criteria Composition contains a wide array of variables that inform core, important, and supplemental elements of the BCHAIN Protocol how to operate, wherein Registered Appchains contain cryptographic access keys of various Appchains, wherein when an update to an Appchain is announced on the Metachain's Appchain Updates, their device will download the newest updates to the Appchain, which will manifest as a Cryptographic Proof of Entitlement which originates from the cryptographic keys stored in Registered Appchains

4. The system of claim 1, wherein LUIGI is granted a hardcoded permanent and irrevocable level of administrative and executive privilege from within the UBEC Platform; LUIGI is programmed and maintained exclusively by SPSI; LUIGI is exclusively hosted on the distributed BCHAIN Network; wherein Self Programming Self Innovation (SPSI) is an Appchain that automatically programs itself and other Appchains within the UBEC Platform that are granted official designation.

5. The system of claim 1, wherein Lexical Objectivity Mining (LOM) attempts to reach as close as possible to the objective answer to a wide range of questions and/or assertions, LOM engages with the UBEC User to allow them to concede or improve their argument against the stance of LOM, wherein Automated Research Mechanism (ARM) attempts to constantly supply CKR with new knowledge to enhance LOM's general estimation and decision making capabilities.

6. The system of claim 5, wherein LOM Container Appchain houses the core modules in the format of an Appchain, wherein the Appchain has it's Execution Segments extracted via ESC to output the Execution Stream, which manifests as the core modules that operate LOM, wherein Initial Query Reasoning (IQR) receives the initial question/assertion provided by the UBEC User and subsequently leverages Central Knowledge Retention (CKR) to decipher missing details that are crucial in understanding and answering/responding to the question/assertion, wherein Assertion Construction (AC) receives a proposition in the form of an assertion or question and provides output of the concepts related to such proposition, wherein Hierarchical Mapping (HM) maps associated concepts to find corroboration or conflict in question/assertion consistency and calculates the benefits and risks of having a certain stance on the topic, wherein Rational Appeal (RA) criticizes assertions whether it be self-criticism or criticism of human responses by using CTMP technology, wherein Knowledge Validation (KV) receives highly confident and pre-criticized knowledge which needs to be logically separated for query capability and assimilation into CKR, wherein with Cross Reference Analysis (CRA), information received is compared to and constructed considering pre-existing knowledge from CKR, wherein the Execution Stream manifests in reality once executed by ESE, wherein Data Segments arrive from UBEC Systemwide Logic to the LOM Container Appchain, wherein the Data Segments are processed by ESE in conjunction with the core logic of LOM defined by the Execution Stream and enumerated as the Modular Manifestation of Execution Stream, wherein the input Data Segments manifest as LOM Question/Assertion Input, wherein the execution of ESE outputs Data Segments which are returned back to the UBEC Systemwide Logic as LOM's formal response to the LOM Question/Assertion Input.

7. The system of claim 1, wherein Personal Intelligence Profile (PIP) stores, the UBEC User's personal information via multiple potential end-points and front-ends.

8. The system of claim 4, wherein automated deployment mechanism is adapted to deploy the UBEC Platform as an Application to hardware devices, wherein SPSI submits software, firmware and hardware updates to UBEC/BCHAIN Hybridized Core Logic, in which the UBEC Platform has its own distinct Codebase, which collaborates with the BCHAIN Protocol Codebase, wherein both Codebases directly connect to the Modular Interface Plugin, which ensures compatible execution of Codebases upon differing hardware and operating system makeups of BCHAIN Nodes, wherein the Hybridized Core Logic is thereafter deployed via one of different Deployment Routines, which is selected in accordance with the correlating hardware and operating system makeup of the selected BCHAIN Node.

9. The system of claim 1, wherein UBEC Passthrough receives information traffic that is occurring from UBEC as an Appchain, wherein upon analysis of the passing information, the information is returned to UBEC as an Appchain via UBEC Comprehensive Return to continue it's onwards journey and to reach it's intended destination within the UBEC Platform, wherein the incoming information from UBEC Passthrough is forwarded to LUIGI Task Delegation (LTD) which determines if the data should be processed by LOM, LIZARD or both, wherein LUIGI Corrective Action (LCA) is invoked to appropriately manage information access events and transactions that are occurring within the UBEC Platform.

10. The system of claim 4, wherein when a new application, or an update to an already existing, application, is submitted LUIGI uses LIZARD technology to identify correct jurisdiction patterns so that it can understand if an application is needed in UBEC or not, wherein LUIGI either Blocks or Approves the application submission, which is an execution which manifests in LUIGI Corrective Action (LCA).

11. The system of claim 1, wherein User Node Interaction (UNI) uses direct biometric data for authentication and does not reference any user names nor account containers, wherein Nodes, data and services are directly tied to the user's, biometric data, wherein biometric data is then transferred to Biometric Band Categorization (BBC), which creates, a rounded off version of the data which eliminates variations of biometric data measurement due to error margins in biometric data measuring equipment, wherein for each biometric data input into BBC a corresponding Band Authorization Token (BAT) is produced as output, wherein comparison is made between the newly generated BATS and Authentication Tokens stored in the Band Association Appchain, wherein the amount of biometric data provided is measured and checked if sufficient for the authentication process.

12. The system of claim 11, wherein within BBC, Granular Separation of the received Generic Biometric Input is created, wherein the Granulator Separation represents the Generic Biometric Input in a format that quantifies scopes of magnitude found within the input, wherein varying compositions of Biometric Data are assembled in the same format which highlights data points of high and low magnitude, wherein the scope of the data points are broadened to create a Format that is intended to be greater than the expected error of margin, wherein Band Categories produced in the Format is stored as a Band Authorization Token (BAT).

13. The system of claim 1, wherein Customchain Ecosystem is a complex interaction of Appchains, Microchains, along with the single Metachain to produce a dynamically adaptable system of data retention and service along with program/routine execution which makes up the BCHAIN Network, wherein the UBEC App Store exists within the Customchain Ecosystem to host, list and service UBEC Applications, wherein the UBEC Enabled Device selects and downloads UBEC Application A from the UBEC App Store, wherein the Execution Segments are collected from the Appchain A0 which correlates with the UBEC Application A, wherein the Execution Segments collected are sent to Execution Stream Collection (ESC) which assembles them into Execution Stream A0, wherein the assembly performed by ESC considers the correct order which the Execution Segments need to be aligned into, wherein the execution of the Execution Segments of Execution Stream A0 occurs at the module Execution Stream Execution (ESE), wherein in parallel to the processing and assembly of the Execution Stream A0 is the processing and assembly of Data Streams A0 and Z3, which is accomplished via Stage which collects the Data Segments from Appchain A0 and submits them for sorting at Data Stream Sorting (DSS), wherein the Data Streams A0 and Z3 are referenced by ESE to correctly execute the commands listed in Execution Stream A0.

14. The system of claim 13, wherein multiple Customchain Ecosystems make up the BCHAIN Network, wherein UBEC Application A and UBEC Application B each makeup their own Customchain Ecosystem, wherein or each Customchain Ecosystem that correlates with an application, there is a Container Appchain, wherein the Container Appchain makes reference to Execution Streams and Data Streams that are stored in Supplement Appchains.

15. The system of claim 13, wherein Customchain Ecosystems contain Independent Appchains that do not belong nor represent a specific UBEC Application, wherein separate Execution Streams or Data Streams can be extracted from Independent Appchains.

16. The system of claim 13, wherein UBEC User inputs Creativity and decision to the Logistics Manager Interface (LMI), wherein LMI outputs Logistics Layer, which is a generic information format that defines the Application logistics designed by UBEC User via LMI, wherein the Logistics Layer is sent as input to the Customchain Ecosystem Builder (CEB), wherein the CEB automatically constructs the Logistical Application, as perceived by the UBEC User, by using the fundamental building blocks that consist of a Customchain Ecosystem, wherein within Customchain Ecosystem Builder Logic Flow, initially the Current State of the Appchain is interpreted to interpret the relevant positions that Execution Segments and Data Segments exist in, wherein the Execution Segments are assembled into an Execution Stream, in the correct order to ensure the correct execution of the program by ESE, wherein the Data Segments are collected and assembled into a Data Stream via DSS processing, wherein the Internal CEB Logic Processing outputs Execution+Data Supplements, which become stored in the newest block of the Appchain, wherein new Execution and Data Supplements to the Appchain begin processing within BCHAIN Network via New Content Announcement (NCA), wherein the content is submitted to the Mempool Data Storage (MDS) of the miners, where it is eventually mined into the next block of the Appchain 602 via the Customchain Interface Module (CIM), wherein the content of the newly mined block is cut into cache parts and is transferred to caching nodes via Mining Nodes Supplying Cache Seeding, wherein the cache parts gradually and automatically migrate to service optimized areas which ensures the best uptime and download speed possible to nodes requesting the data, wherein nodes claim the content from the caching nodes via Content claim Generator, wherein once downloaded the nodes execute the Execution Stream via ESE which leads to the manifestation of the intended application.

17. The system of claim 1, wherein a Watt Unit is a cryptographic currency that is algorithmically pegged to the value of electricity, wherein Watt Units are directly created and destroyed by LUIGI as liquidity enters and exits the UBEC Economy, wherein Distributed Energy Price Survey (DEPS) surveys BCHAIN Nodes that can authentically report the current fiat currency price of electricity, wherein Third Party Currency Exchange (TPCE) acts as the logistical layer to manage buying and selling of fiat currency that allows liquidity to flow into and out of the Watt Economy of the Metachain, wherein in TPCE, UBEC Users that are seeking to selling and buying Watt Units are essentially paired together in an exchange, wherein the fiat currency value of a Watt Unit is pegged to the value reported by DEPS, wherein upon an UBEC User buying an amount of Watt Units, a Verified Transaction Report that details the amount purchased is sent to LUIGI, wherein upon LUIGI's approval of the transaction, a User buying Watt Units leads to Watt Unit Creation in the LUIGI Economy Interface (LEI), wherein upon an UBEC User selling an amount of Watt Units, a Verified Transaction Report that details the amount purchased is sent to LUIGI, wherein upon LUGI's approval of the transaction, a User buying Watt Units leads to Watt Unit Destruction in the LUIGI Economy Interface, wherein the functions of LEI require knowledge and access to the User Private Fund Allocation (UPFA), wherein Allocation of funds in UPFA are intelligently distributed across nodes according to their type whereby mitigating risk of a node getting damaged/stolen.

18. The system of claim 1, wherein the UBEC User can selects Economic Personalities, wherein Economic Personality (Equalizer) is when node resources are consumed to only match what the UBEC User consumes, wherein Personality B (Profit) is when the node consumes as many local resources as possible as long as the profit margin is greater than X, wherein Personality C (Consumer) is when the UBEC User pays for work units via a traded currency so that content can be consumed while spending less node resources, wherein Personality D (Altruistic) when node resources are spent as much as possible and without any restriction of expecting anything in return, wherein Economically Considered Work Imposition (ECWI) references the Watt Economy of the Metachain to determine the current Surplus/Deficit of this node with regards to work done credit, wherein Current Work Surplus/Deficit is forwarded to ECWI, which considers the selected Economic Personality and the Surplus/Deficit to evaluate if more work should currently be performed.

19. The system of claim 1, wherein if the criteria defined in Strategy Deployment known as Parallel Hop Spread Criteria has been met, then the Node invokes Parallel Hop Logic (PHL), wherein this leads to the specific Nodes initiating more Parallel Hop Paths than they received, which leads to a redundancy in Hop Paths concerning the traveling CCR or CCF, wherein Redundant Parallel Hop Pathways mitigates the risk presented by chaos by increasing the chances that at least the minimum amount of required pathways reaches the Final Target without a significant interruption from chaos, wherein the Final Target can receive a confirmation originating from a decentralized consensus due to the redundant Parallel Hop Paths being initiated by PHL, wherein for a CCR or CCF packet to be accepted at it's destination Node, it must arrive from at least predetermined number of separate Parallel Hop Paths, wherein Over-Parallelized Hop Path Reduction (OPHPR) detects Parallel Hop Pathways that have become an inefficient burden on the system and should be ceased from continuing their onwards journey, wherein the amount of redundant Parallel Hop Pathways that are spawned depends on the size of the Watt Unit fee that was preauthorized for the OCR's or CCF's Economic Authorization Token (EAT), wherein functionality of leveraging the physical movement of Nodes is processed by the modules Physical Data Migration Layer (PDML) and Physical Data Migration Usage (PDMU), wherein Physical Migration functionality allows for overall increased throughput in the system, as physical movements of Nodes are made to work in favor of the efficiency of the Network rather than against it.

20. The system of claim 1, wherein Sectors are clusters of BCHAIN Nodes that logistically facilitate orientation and travel routing within the BCHAIN Network, wherein at any given time any BCHAIN Node falls under the jurisdiction of exactly two Sectors, wherein definitions of Sectors are derived from the Dual Scope Hash generated by Traffic Scope Consensus (TSC), wherein Optimized Sector Route Discovery (OSRD) interprets the geographical state of the BCHAIN Network as defined on the Metachain and produces Optimized Sector Routes which are effectively highways of information, wherein the information is submitted to Optimized Sector Routing of the Metachain, Statistical information including Pathway Strength (effectiveness) and Pathway Saturation (demand/usage) are included in Optimized Sector Routing of the Metachain.
